(19) United States
(12) Patent Application Publication
(10) Pub. No.: US 2026/0014403 A1
(43) Pub. Date: Jan. 15, 2026

(54) ENVIRONMENTALLY-CLEAN WATER-BASED FIRE INHIBITING BIOCHEMICAL COMPOSITIONS, SOLUTIONS, POWDERS AND METHODS OF AND APPARATUS FOR PRODUCING FIRE PROTECTED WOOD AND ENGINEERED WOOD PRODUCTS

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 19/082,106

(22) Filed: Mar. 17, 2025

Related U.S. Application Data
(63) Continuation-in-part of application No. 18/669,077, filed on May 20, 2024.
(63) Continuation-in-part of application No. 18/964,428, filed on Nov. 30, 2024.
Application No. 18/964,428 is a continuation-in-part of application No. 18/814,508, filed on Aug. 24, 2024.
Application No. 18/814,508 is a continuation-in-part of application No. 18/669,077, filed on May 20, 2024.
Application No. 18/669,077 is a continuation-in-part of application No. 18/496,862, filed on Oct. 28, 2023.
Application No. 18/496,862 is a continuation of application No. 17/167,084, filed on Feb. 4, 2021, now Pat. No. 11,865,390.
(63) Continuation-in-part of application No. 18/814,508, filed on Aug. 24, 2024.
(63) Continuation-in-part of application No. 18/420,717, filed on Jan. 23, 2024.
(63) Continuation-in-part of application No. 18/329,979, filed on Jun. 6, 2023.

(51) Int. Cl. A62D 1/00; A62C 3/02; A62C 27/00; C09K 21/02

(52) U.S. Cl. CPC A62D 1/0035; A62C 3/02; C09K 21/02; A62C 3/0242; A62C 3/0271; A62C 27/00; A62D 1/005

(57) ABSTRACT

Environmentally-clean fire-inhibiting chemical compositions are used to biochemically treat wood furnish material and polymer resin binder material during composite wood product manufacture so that alkali metal (i.e. potassium) ions and/or micro-particles associated with the fire inhibiting biochemical treatment compositions are freely available throughout the entire composite wood product so as to inhibit fire ignition, flame spread, smoke development, as well as optionally, inhibit mold, mildew, microbial life and/or moisture. By embodying the environmentally-clean fire inhibiting biochemical compositions of the present invention into the lignocellulosic-based wood furnish material of a composite wood product, and preferably its polymeric resin binder material, during composite product manufacture, it is now possible to safely treat substantially the entire physical structure of the finished composite wood product and its structural components, with environmentally-clean fire inhibiting biochemical composition(s). By doing so, it is possible to provide the entire finished composite wood product with alkali metal ions and/or micro-particles thereof, that are freely available to inhibit fire ignition, flame spread and smoke development in accordance with ASTM Class-A fire-protected standards, as well as, optionally, inhibit metal corrosion, mold/mildew and moisture in a significantly new and improved manner.

### RELATED CASES

The present Patent Application is a Continuation-in-Part (CIP) of: copending U.S. patent application Ser. No. 18/669,077 filed May 20, 2024, which is a Continuation-in-Part of co-pending U.S. patent application Ser. No. 18/496,862 filed Oct. 28, 2023, which is a Continuation of U.S. patent application Ser. No. 17/167,084 filed Feb. 4, 2021, now U.S. Pat. No. 11,865,390; copending U.S. patent application Ser. No. 18/964,428 filed Nov. 3, 2024; copending U.S. patent application Ser. No. 18/814,508 filed Aug. 24, 2024; copending U.S. patent application Ser. No. 18/420,717 filed Jan. 23, 2024; and copending U.S. patent application Ser. No. 18/329,979 filed Jun. 6, 2023; wherein each said US Patent Application is commonly owned by Mighty Fire Breaker LLC and incorporated herein by reference as if fully set forth herein.

### BACKGROUND OF INVENTION

### Field of Invention

The present invention is directed to improvements in environmentally-clean fire inhibitors, flame retardants and resin binder compositions suitable for treating materials used in the manufacture and production of solid, composite and engineered wood products (EWPs) including cellulose fiber boards, lignocellulosic panels, and wood-based structural members providing protection against fire, metal-corrosion, mold/mildew and moisture; and further, the present invention is directed to improvements in solid, composite and engineered wood products, and methods of production involving the treatment of lignocellulosic materials using environmentally-clean biochemical compositions that provide protection against fire, metal-corrosion, mold/mildew and moisture while functioning in a high performance manner in diverse applications across the building, construction, and home improvement industries.

### Brief Description of the State of Knowledge in the Art

In recent years, the production of wood based composite panel products has increased dramatically. In order to support new building starts across the economy, there is a great need for safe and affordable composite and engineered wood products for building. These composite and engineered wood products include: oriented strand board (OSB), medium density fiber board (MDF), high density fiber board (HDF), wood fiber insulation (WFI) panels, and other types of engineered wood products (EWPs) such as cross-laminated timber (CLT),and laminated veneer lumber (LVL).

Such composite wood products and engineered wood products (EWPs) have application in many fields, namely: construction of residential housing and commercial buildings; roof sheathing; wall sheathing; flooring, structural insulated panels; and engineered wood components such as I-joists. With the expanding production of wood based composite products, there is also a growing need to find additional applications for composite wood products having resistance to fire, metal-corrosion, mold/mildew and moisture.

At this juncture, it will be helpful to survey a number of prior art references over the past 25 years which should provide a good overview of the prior art efforts of other to advance the state of the art in providing fire, metal corrosion, mildew, mold and moisture production to solid and composition wood products alike in the building and construction industry.

FIG. 1 shows various kinds of prior art solid, composite and engineered wood products (EWPs) used extensively in building construction and home improvement, namely: plywood panels; oriented strand board (OSB) panels; medium density fiber (MDF) board and high density fiber (HDF) board; finger-jointed lumber; composite wood products (e.g. chipboard, etc.); and various engineered wood products (EWPs).

FIG. 1A shows a prior art plywood panel produced from wood laminates and polymeric resins, without providing Class-A fire protection, mold/mildew protection, and/or moisture protection.

FIG. 1B shows a prior art oriented strand board (OSB) panel produced from wood strands (i.e. wood furnish) and polymeric resins, without providing Class-A fire protection, mold/mildew protection, and/or moisture protection. Currently, five grades of OSB are defined in the European Panel Federation's EN 300 (2025), defined in terms of mechanical performance and relative resistance to moisture: OSB/0—No added formaldehyde; OSB/1 —General-purpose boards and boards for interior fitments (including furniture) for use in dry conditions; OSB/2-Load-bearing boards for use in dry conditions; OSB/3-Load-bearing boards for use in humid conditions; and OSB/4-Heavy-duty load-bearing boards for use in humid conditions. U.S. Pat. Nos. 3,164,511 and 3,478,861 by inventor, Armin Elmendorf, describes the basic nature and structure of oriented strand board (OSB) and how in principle and practice it can be successfully made.

FIG. 1C shows a prior art medium density fiber (MDF) board panel and high density fiber (HDF) board produced from wood fiber and polymeric resins, without providing Class-A fire protection, mold/mildew protection, and/or moisture protection.

FIG. 1D shows a prior art finger-jointed lumber product (e.g. 2×4 lumber piece) produced from lumber and polymeric resins, without providing Class-A fire protection, mold/mildew protection, and/or moisture protection.

FIG. 1E shows a prior art composite wood (fiber & chips) panel produced from wood fiber and pieces and polymeric resins, without providing Class-A fire protection, mold/mildew protection, and/or moisture protection.

FIG. 1F shows prior art bamboo wood products (e.g. plywood panels, cross-laminated panels, etc.).

While each of the above-described engineering wood products (EWPs) requires Class-A fire protection, mold/mildew protection, and/or moisture protection, this requirement has generally not been successfully met across the wood construction industry.

While chemical preservatives and fire retardant treatments are readily available for solid lumber and plywood, many methods of chemical treatment are applied to lumber and plywood using vacuum pressure processes to ensure uniform distribution of the active chemical ingredients throughout the wood components, in effort to guarantee optimum performance. Historically, attempts to incorporate chemical treatments into wood based composites using similar technology have failed for economic reasons, and also because of technical problems associated with irreversible and excessive swelling of the treated panels and severe loss of structural integrity (due to degradation of wood fiber strength).

As an alternative to chemical pressure treatment, various methods and technologies have been proposed for treating wood to provide protection against fire, metal corrosion, mold/mildew and moisture, having minimal or no negative impact, on wood fiber strength, board structural properties, and the natural environment. A survey of these alternative methods will be described below.

FIG. 2 represents prior art U.S. Pat. No. 6,811,731 (assigned to Chemical Specialties, Inc.) which discloses compositions and methods for protecting OSB panels against fire and mold by incorporating phosphate/borate salt formulations into wood-based composite products. As disclosed in this prior art patent, green wood furnishes, containing a relatively high amount of moisture content, is treated with an amount of phosphate/borate fire retardant that is effective to increase the fire retardancy of the resulting wood-based composite, compared to the fire retardancy of the corresponding wood-based composite lacking the fire retardant. The treated wood furnish is then dried so that the moisture content is suitable for fabrication of the wood-based composite. The treated green wood furnish is then blended with a resin binder, and then the wood furnish is bonded together as a finished molded product, by pressing the treated wood furnish under pressure so as to form a fire-retardant wood based composite product. Related U.S. Pat. No. 4,725,383 by Lewchalermwong (assigned to Chemical Specialties, Inc.) discloses a fire retardant composition that utilizes pH control to lower corrosion. As disclosed, the fire retardant composition contains B₂O₃ (Boron trioxide), P₂O₅ (phosphorus pentoxide) and NH₃ (ammonia).

FIG. 3 represents prior art U.S. Pat. No. 7,585,566 (assigned to Houston Advanced Research Center, i.e. HARC) which discloses compositions and methods for producing OSB panels with fire, fungus, and insect protection by impregnating wood compositions with polyisocynate chemical compounds.

FIG. 4 represents prior art U.S. Pat. No. 8,084,523 which discloses compositions and methods for producing OSB panels using fire retardant polymeric adhesive compositions containing methylene diphenyl diisocyanate (MDI) and melamine phosphates.

FIG. 5A represents prior art U.S. Pat. No. 9,314,947 (assigned to Huntsman International) which discloses compositions and methods for producing OSB panels from lignocellulosic materials using polymeric resin binders and adhesives, but is silent on how to provide fire protection to the OSB panels when using such binders and resins.

FIG. 5B represents prior art U.S. Pat. No. 8,891,005 (assigned to Huntsman International) which discloses compositions and methods for producing OSB panels from lignocellulosic materials using binder compositions containing an isocyanate compound, a metal catalyst and an acid compound, but is also silent how to provide fire protection to the OSB panels when using such isocyanate compounds.

FIG. 5C represents prior art European Patent (EP) U.S. Pat. No. 2,505,326 BH1 (assigned to Ecochem International) which discloses compositions and methods for producing fire resistant OSB panels using guanidine salts in the middle and outer layers of the OSB panels.

FIG. 5D represents prior art U.S. Pat. No. 10,995,221 (issued to Ziqiang Lu) which discloses compositions and methods for producing fire, moisture and mold resistant OSB panels using PVA-based coatings.

FIG. 5E represents prior art U.S. Pat. No. 10,919,178 (assigned to Applicant/Mighty Fire Breaker LLC) which discloses compositions and methods for producing fire-protected OSB panels using tripotassium citrate chemistry applied using dip-coating and spray coating methods.

FIG. 5F represents prior art US Patent Application Publication No. US2019/0330531 A1 (assigned to Ecochem International NV) disclosing compositions and methods for producing fire-retardant wood-composite panels using MAP and DAP based fire retarding and intumescent formulations and compositions.

FIG. 5G represents prior art US Patent Application Publication No. US2022/0017772 A1 (assigned to Dow Global Technologies LLC) which discloses compositions and methods producing OSB panels provided with fire-resistant polyurethane coating compositions containing an aromatic isocyanate component, a polyol component, and an intumescent component.

FIG. 5H represents prior art US Patent Application Publication No. 2021/0189245A1 by Rodriguez et al (assigned to BURNBLOCK HOLDINGS APS and issued as U.S. Pat. No. 12,221,576) which discloses a flame retardant and latent hardener composition. As disclosed, the flame retardant/hardener composition includes: a blend of 30-100% (by weight based on total solids) of diammonium hydrogen phosphate (DAP), and dihydrogen phosphate, 0-50% (by weight based on total solids) of monoammonium, functioning as fire retardant chemicals; as well as additives such as citrate (in range of 1.5-5% by wt) functioning as an acidic hardener, and sodium benzoate or potassium benzoate (e.g. 2-6% by wt) functioning as a mold inhibitor during transport of the flame-retardant/hardener composition. The flame-retardant/hardener composition can be prepared as a solid blend or a liquid composition. As disclosed in US Patent Application Publication No. 2021/0189245A1, the production sequence for oriented strandboard (“OSB”), like particle board (PB) involves debarking wood, and then feeding the debarked wood into a “Strander” which uses knives to create wood strands. The strands are then paced in a rotary drier, and the semi-dried strands are then sprayed or mixed with liquid resin and other additives, or blended with solid resin and additives. The resinated strands are then oriented by feeding to a continuous belt, and sections are hot-pressed to produce the OSB product. As with other board products, a water-borne or even a solid, powder base, flame retardant formulation, is added which also functions as a latent hardener, whilst retaining its fire-retarding properties in the finished board.

FIG. 5I represents prior art US Patent Application Publication No. 2021/0387376A1 by Trefes (assigned to Panda Industries, Inc.) which discloses a system and method for manufacturing bamboo dimensional lumber that contains cross-hatched fiber layers covered with glue, to form a rough lumber board composed of cross-hatched bamboo fiber layers.

FIG. 5J represents prior art U.S. Pat. No. 11,578,487 (assigned to Louisiana-Pacific Corporation) which discloses compositions and methods for producing fire-protected OSB panels using magnesium-based concrete coatings that are factory applied to wood surfaces, such as plywood or OSB panels, to provide a fire resistance layer, and a water resistant barrier laid over the fire resistance layer.

FIG. 5K represents the 2018 Master's Thesis of Che Zheng at the University of Waterloo, Chemical Engineering Department, Waterloo, Ontario, Canada, titled “Evaluation of Bio/pMDI Wood Adhesives”, which discloses that citric acid (CA) can be effectively used as a wood modifying agent and a binding agent for wood composite materials.

FIG. 5L represents a 2020 paper titled “A Review on Citric Acid as Green Modifying Agent and Binder for Wood” by Seng Hua Lee, et al, which discloses a review on using citric acid (CA) as a wood modifying agent and binder by forming ester linkages to provide adhesivity and good bonding characteristics.

FIG. 5M represents a 2020 paper titled “Wood Surface Modification-Classic and Modern Approaches in Wood Chemical Treatment by Esterification Reactions” by Carmen-Alice Teaca and Fuiga Tanasa, which discloses methods and compositions including polycarboxylic acids, such as citric acid (CA) and tartaric acid (TA), for use in modifying the physical properties and characteristics of wood products by treating lignocellulosic material with the polycarboxylic acids. In general, natural forms of lignocellulosic fiber material can be found in wood, bamboo, wheat and many other forms of plant life.

FIG. 5N represents a 2024 paper titled “Nanotechnology in Wood Science: Innovations and Applications” by Richa Bansal, Harish C. Barshilia, and Krishna K. Pandey, which discloses a review of highlights of some of the advancements in the use of nanotechnology in wood science, and its potential impact on the industry, including the use of nanomaterials in improving the properties of wood and wood-based materials and protecting them from weathering, biodegradation, and other deteriorating agents. UV-resistant, self-cleaning (superhydrophobic) surfaces with anti-microbial properties have been developed using the extraordinary features of nanomaterials. As disclosed, in recent years, application of nanotechnology has offered innovative solutions to overcome the shortcomings of wood and wood-based composites along with other lignocellulosic materials. Because the cell wall in wood exhibits a molecular-sized porosity, small size, nanoparticles (NPs) can easily penetrate into the wood pores and can improve the properties of the material and result in a high-performance superior quality product. The key and distinguishing aspect of nanoparticle materials is their high surface area-to-volume ratio, which provides them with greater reactivity in surface-related phenomena when compared to their bulk counterparts. Improving the characteristics of wood and wood-based composites requires ensuring the uniform dispersion of NPs. As disclosed, nanomaterials are often incorporated into wood coatings using aqueous, organic or polymeric dispersion mediums or they are impregnated inside the wood using appropriate methods. Wood and wood-composites can benefit from nanotechnology in terms of photostability, resistance against decay fungi and termites, good scratch and abrasion resistance, self-cleaning ability, flame retardancy and improved physical and mechanical properties.

FIG. 50 represents the prior art chemical compound cupric (copper) citrate which, when dissolved in water, produces copper ions that can be infused into the lignocellulosic material of treated wood furnish so as to inhibit and control a wide range molds, fungi, algae, and harmful microbes.

At this juncture, it should prove instructive to discuss the nature and types of resin binders that are currently known and commercially available for use in producing solid and composite types of wood based products (WBPs) and engineered wood products (EWPs), and the ways in which others have treated resin binders using chemicals during the manufacture of composite wood products over the past 25 years or so.

In the world of conventional polymers or base materials (provided in solid or liquid form and that can be converted into a polymer), there are two principle types of polymers (i.e. polymeric resins) namely: (1) thermoplastic (i.e. thermosoftening) polymers (i.e. polymeric resins) which are plastics that will soften when heated and can be reshaped; and (2) thermosetting polymers (i.e. polymeric resins) often called thermosets, that are obtained by irreversibly hardening (i.e. “curing”) a soft solid or viscous liquid prepolymer.

Thermoplastic (i.e. thermosoftening) polymers include, for example, the following compositions: (i) acrylic; (ii) Acrylonitrile butadiene styrene (ABS); (iii) Polyamide (Nylon) (naturally occurring proteins/polypeptides (polymers of amino acids) such as wool and silk); (iv) polylactic acid (PLA); (v) Polybenzimidazole; (vi) Polycarbonate (Lexan); (vii) Polyether sulfone (PES); (viii) Polyoxymethylene (POM); (ix) Polyether ether ketone (PEEK); (x) Polyetherimide (PEI); (xi) Polyethylene (PE and UHMWPE, HDPE, MDPE, LDPE)); (xii) Polyphenylene sulfide (PPS); (xiii) Polypropylene (PP); (xiv) Polystyrene (PS or xPS); (Xv) Polyvinyl chloride (PVC); (xvi) Polyvinylidene fluoride (PVDF); (xvii) Polytetrafluoroethylene (PTFE or Teflon); and (xviii) Thermoplastic Composites (TPCs).

Thermosetting polymers include, for example, the following compositions: (i) polyester, characterized by brittleness requiring the reaction of a resin with a (polyester) hardener (e.g. 1.0% to 4.0% by wt.) optionally in the presence of a catalyst; (ii) epoxy, characterized as being stronger, requiring the reaction of a resin and a (epoxy) hardener (e.g. 25% to 50% by wt.), optionally in the presence of a catalyst, producing a stiff plastic, and coming in different species; and (iii) polyurethane, characterized by versatility and allowing for production of foams by reacting resin and water (optionally in the presence of a catalyst).

Predominantly used thermosetting adhesives for wood based products are: (i) phenol-formaldehyde (PF), (ii) formaldehyde-based adhesives, such as urea-formaldehyde (UF), and melamine-formaldehyde (MF); and (ii) isocyanate-based resins, such as polymeric Methylene Diphenyl diIsocyanate (pMDI) resin, which are moisture curable.

Based on their different properties, each kind of polymeric resin has been applied to fabricate different kinds of wood based products (i.e. plywood, PB, OSB, MDF, etc.).

Phenol-formaldehyde (PF) resins are the oldest of synthetic polymers, and widely used to bind both laminations and composites such as OSB, softwood plywood, and exterior grade panels, because of outstanding durability, good wood adhesion, high strength, and excellent thermal stability.

Around the world, urea-formaldehyde (UF) resins are probably the most widely used thermosetting resin for fabricating wood-based products, such as MDF and particleboard products, while a smaller percentage of UF resins are used manufacturing interior grade plywood. Traditional methods of manufacturing medium density fiberboard (MDF) involve the use of urea-formaldehyde (UF) resin as a binder material. Based on scientific study, the formaldehyde emissions from UF resins have been found to cause negative health effects, including cancer, in humans and animals.

Melamine-formaldehyde (MF) resins are commonly used as adhesives for exterior and semi-exterior wood panels because of their excellent water and weather resistance properties.

Finally, Isocyanate-based resins (and polyurethane resins) are generally based on the family of products called methylene diphenyl di-isocyanate, or MDI for short. These materials are characterized as moisture-curable aromatic polyisocyanates. Increasingly, polymeric Methylene Diphenyl diIsocyanate resins (pMDI) are being used in the wood based products industry due to their high reactivity and efficiency. Commercially available pMDI resin is usually a mixture of di-, tri-, tetra-etc. isocyanates of specific molar ratios.

Since 1970's, the composite wood products industry has been using pMDI resins, most notably in the production of oriented strand board (OSB) products. pMDI resins have many benefits that outweigh their higher cost, namely: high internal bond strength (IBS); better MOE and MOR; additional moisture resistance; and less formaldehyde testing and monitoring when using p-MDI. When using pMDI polymeric resin binders for manufacturing composite wood products, the process in general comprises: (i) combining wood furnish particles with a pMDI polymeric resin binder material; (ii) followed by molding; and (iii) compressing the combination of wood furnish material and pDMI polymeric resin binder material.

Understanding how pMDI polymeric resin reacts with wood furnish material is important to gaining an understanding on whether the urethane linkage will strengthen the board to be more durable under different environmental conditions. Theoretically, isocyanate groups of pMDI resin can react with the hydroxyl groups in wood furnish and moisture, to form irreversible urethane linkages.

Because water is needed to start the crosslinking, pMDI can then be applied to wood furnish with higher moisture content, which reduces the energy needed to dry raw wood fiber material. This also means the composite wood board will be pressed closer to the equilibrium moisture content of the environment in which the board will be used, thereby minimizing internal stresses in the board. In contrast to UF resin, pMDI's thermosetting linkage is irreversible, giving pMDI boards a degree of moisture resistance. This irreversible urethane linkage is also what makes the MDF board perform very well in both interior and exterior applications.

When comparing pMDI and other resins (e.g. UL resins), it is important to understand that pMDI polymeric resin binder material is far more efficient and highly effective in lower doses, so a significantly pMDI resin binder can be used (during dosing) when binding wood furnish material into composite wood products using pMDI resin binder. However, currently, pMDI resin is one of the most expensive adhesives for use in making composite wood panels and currently costs over three times as much as UF resin. Thus, any financially logical decision by a manufacturing plant to choose the use of pMDI resin material(s), over another synthetic resin binder technologies, should demand a logical analysis of (i) the advantages and benefits of using pMDI resin against (ii) the disadvantages and costs associated with using pMDI resin on any planned composite wood product production line in any composite wood products factory or plant.

Advantages and Benefits of Using pMDI Resin Binder Material

Significantly, pDMI resin enjoys many advantages over other traditional synthetic polymeric resins. First, pMDI resins do not emit formaldehyde or subject end users to VOCs, enabling manufacturers to produce formaldehyde free products and setting new industry standards. Second, as pMDI resin lacks pre-cure stickiness, it minimizes resin-fiber buildup in the blenders and therefore minimizes maintenance and cleaning costs. Third, pMDI resin can tolerate a wider variety of wood species with different chemical composition because pMDI bonding strength does not primarily come from chemical reaction to the wood, but its ability to penetrate and plasticize the wood furnish cell walls. Fourth, provided that pMDI resin is stored at the recommended temperature range and without any contact with water or condensation, it has a longer shelf life of at least 6 months. Fifth, pMDI resin is not sensitive to pH changes in raw material, and thus can significantly cut down on buffer capacity testing on raw materials. Sixth, during blending with wood furnish material, pMDI resin does not require any mechanical turbulence to improve resin distribution as opposed to UF resin, and thus pMDI resin has a wider operating window during manufacturing. Seventh, pMDI resin produces a colorless bond that makes composite wood panels look more natural and more appealing to customers than the dark bond lines produced by other synthetic resins. Eighth, when using pMDI resin binder, one can expect to observe improvements in (i) the internal bond strength and modulus of rupture (MOR) in composite fiberboards manufactured using pDMI resin binder. Nineth, because pMDI resin binder material cures at low temperatures, it is expected that energy requirements will be lowered during manufacturing, enabling a plant to operate high speed production lines. Tenth, pMDI resin is a certified no-added-formaldehyde resin which makes the pMDI-resinated boards CARB Phase 2 compliant, representing cost savings to the manufacturer in reduced testing, less rejected boards, and less claims from formaldehyde emissions.

Disadvantages and Costs of Using pMDI Resin Binder Material

While pMDI resin has many advantages over traditional synthetic resins, as listed above, pMDI resin has a few disadvantages and costs which must be considered and addressed when used in any manufacturing production.

First, the chemical structure of pMDI resin binders makes it adhere strongly to nearly all surfaces, including steel and metal oxide surfaces. Therefore, pMDI resin binder material cannot be used in the top and bottom face-sided furnish material processed/handled by the forming and pressing machines, without the use of external release agents (based on waxes or soaps), so as to prevent the boards from sticking to the press belts and/or press platens. Thus, successful composite wood product production line using pMDI resin are hugely dependent upon proper and complete application of release agents on all press belts and press platens.

Second, while pMDI rein is sprayed in sealed ducts because most if not all MDF-based manufacturing plants are closed systems, it is important to note that the isocyanates present in pMDI resin binder material, (i) irritate the skin, (ii) can cause dermatitis and eczema, (iii) irritate the eyes, mucous membranes, and respiratory tract, and (iv) has a high acute toxicity when inhaled. Also, long term exposure to isocyanates in pMDI resin material can create chronic effects, including asthma and sensitization in human's respiratory system.

Third, when running uncatalyzed pMDI resins, productivity for certain products may drop as slower cure times led to slower line speeds, especially when running production lines for thinner dimensioned composite wood products.

Fourth, catalyzed pMDI resins often demonstrate pre-curing of the pMDI polymer resin, because pre-curing of pMDI resin occurs when moisture and the polymer resin reacts prior to wood furnish material pressing, and pre-curing often manifests itself by a buildup on the mat forming rollers, and clumping along the bin sidewalls and low board properties. Also, since a catalyzed pMDI polymer resin binder system can be exposed to heat (e.g. 100 to 130° F.) and moisture (humidity) in the forming bins or on the forming line, the potential for pre-curing exists. Typically, it can take 10 to 20 minutes to turn treated and formed wood furnish/resin-binder material over to the pressing machine, and any delays (and/or line stoppage) can increase the pre-curing potential of the pMDI resin binder being used. With prolonged line stoppages, resinated wood product materials may have to be dumped, which costs the manufacturer in terms of wasted resin and wood furnish materials.

Despite some disadvantages associated with using pMDI resin material during composite wood product manufacture, the advantages of pMDI resin seem to be winning out-especially in view of current formaldehyde emission reduction initiatives being given a high priority in North America. The result is that manufacturers in the industry are choosing pMDI resins more often as the best alternative to UF resins, when all things are considered, and the trend is for pMDI resins to continue moving strongly into the OSB panel, particle board (PB), and medium density fiberboard (MDF) markets, as consumer demand grows for no-added-formaldehyde (NAF) composite wood products.

Meanwhile, the industry continues its search for better and faster curing pMDI resin binder materials that are capable of competing against catalyzed urea/melamine (UM and UF) resins, and offering manufacturers reduced pressing times, lowered resin dosage, reduced wood drying requirements, and increased throughput and productivity.

It should be pointed out that pMDI prepolymers are useful as single component resin binders because these polymeric resins do not require separate catalyst (or polyol) streams to be metered into the resin stream at the mill facilities, which would require additional personnel to monitor the composite wood product manufacturing process. An advantage of pMDI prepolymer resin binders may reduce press times without the addition of a catalyst, and may be run with higher wood furnish moisture content, and provide longer shelf life (when stored properly) when compared to the other commonly known catalyzed wood resin binder systems.

FIGS. 5P-1 and 5P-2 show an exemplary table of prior art pMDI polymeric resin binders that are produced and marketed by Huntsman International under the I-BOND® brand, and prior art pMDI release agents produced and marketed by Huntsman International under the I-RELEASE® brand. As represented in the table, Huntsman's pMDI resin binders include: standard polymeric MDI resin, fast cure MDI resin (FC1), enhanced fast cure MDI resin, emulsifiable MDI resin (EFC1), fast cure MDI resin (EFC2), polymeric fast cure MDI resin (dry blending), low temperature curing MDI resin, and emulsifiable low temperature curing MDI. As disclosed, Huntsman's pMDI release agents include: internal release agent for multi-daylight and continuous pressing lines (synthetic wax) with 40% content; and external release agent for continuous pressing lines (wax free) with 20% solid content. Huntsman's family of pDMI resins and pDMI release agents can be used when producing different types of composite wood products, such as oriented strand board (OSB), medium density board (MDF), high density board (HDF), particle board (PB), and wood fiber insulation board (WFI), in multi-daylight and continuous production lines, using pressing machines well known in the art.

While many advances have been made with polymeric resin binders for use in the field of composite wood product manufacturing, there is a clear need in the art for new and improved environmentally-clean fire inhibiting (i.e. flame retarding) biochemical compositions and formulations, in both liquid and dry powder format. There is also a growing need for new and improved methods that can be used to apply these environmentally-clean biochemicals to solid wood or lumber, and lignocellulosic-based wood furnish material used during composite board production processes, for the purpose of improving the inhibition to fire ignition, flame spread and smoke development, as well as providing enhanced protection against metal-corrosion, mold/mildew and moisture, while overcoming the shortcomings and drawbacks of prior art compositions, apparatus, and methodologies.

### OBJECTS AND SUMMARY OF THE PRESENT INVENTION

Accordingly, a primary object of the present is to provide new and improved methods, apparatus and biochemical compositions for treating solid, composite and engineered wood products so as to provide protection and defense against fire, metal-corrosion, mold/mildew and moisture, while overcoming the shortcomings and drawbacks of prior art methods, compositions and apparatus.

Another object of the present invention is to provide new and improved biochemical-based fire inhibiting/retardant treatments for use on solid wood products including finger-jointed and dimensional lumber, and incorporation into composite wood products such as oriented strand board (OSB), medium density fiberboard (MDF), high density fiberboard (HDF) and particle board (PB).

Another object of the present invention is to provide novel methods of manufacturing wood based composite products, whereby novel fire inhibiting biochemical compositions are added to lignocellulosic-based wood furnish materials (i.e. wood strands, fibers and/or particles) for biochemical treatment prior to drying, forming and pressing into finished composite wood board or panel products, wherein “wood furnish” material shall be defined as wood strands, chips, particles, flakes or fibers, and “wood particles” are defined broadly to include webs of wood fibers formed by crushing and twisting pieces of wood, as well as other forms of wood particle powder.

Another object of the present invention is to provide environmentally-clean and non-toxic fire inhibiting biochemical formulations and resin binders adapted for use in the manufacture of solid and composite wood products around the world.

Another object of the present invention is to provide new and improved methods of and biochemical compositions for safely integrating and embodying within the lignocellulosic-based wood furnish material of the OSB panel, as well as its polymeric resin binder material, so as to biochemically treat, during the composite wood product manufacturing process, so as to provide fire inhibition/resistance to substantially the entire physical structure of the finished composite wood product, and its structural components, thereby providing the entire finished composite wood product with alkali metal ions and/or particles that are freely available to inhibit fire ignition, flame spread and smoke development, as well as metal corrosion, mold/mildew and moisture in the finished composite wood product.

Another object of the present invention is to provide a new and improved family of environmentally-clean aqueous-based fire inhibiting biochemical compositions comprising an aqueous mixture of (i) major amount of alkali metal salt derived from a non-polymerized saturated carboxylic acid characterized by having less than 8 carbon atoms (C1-C7), and dissolved in (ii) a major amount of water (H2O) along with (iii) a minor amount of dispersing and coalescing agent, dissolved in the water and realized as an ester of a non-polymerized saturated carboxylic acid, promoting dispersion and coalescing of metal alkali ions in lignocellulosic furnish material during the production of composite wood products, and forming alkali metal salt crystalline structures in the lignocellulosic furnish material and/or alkali metal salt crystalline coatings on the surfaces of the wood furnish material and/or the exterior surfaces of treated wood material, when and as water molecules evaporate during drying operations during composite wood production manufacture, thereby depositing alkali metal ions that inhibit fire ignition, flame spread and smoke development.

Another object of the present invention is to provide new and improved environmentally-clean fire inhibitors, flame retardants and resin binder compositions suitable for treating lignocellulosic-based wood furnish materials used in the manufacture and production of solid, composite and engineered wood products (EWPs) including cellulose fiber boards, lignocellulosic panels, and wood-based structural members offering protection against fire, metal-corrosion, mold/mildew and moisture.

Another object of the present invention is to provide new and improved environmentally-clean fire-inhibiting biochemical compositions for treating lignocellulosic wood-furnish material used in production of a wood composite panel provided with protection against fire, metal-corrosion, mold/mildew and moisture while functioning in a high performance manner, wherein the environmentally-clean fire-inhibiting biochemical compositions comprises (i) a major amount of water, (ii) a major amount of alkali metal salt dissolved in the quantity of water for producing alkali metal ions, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F, and (iii) a minor amount of one or more esters dissolved in the water and derived from the saturated non-polymerized carboxylic acid and/or another saturated non-polymerized carboxylic acid, promoting dispersion and coalescing of metal alkali ions in the lignocellulosic furnish material, and forming alkali metal salt crystalline structures in the lignocellulosic furnish material and/or alkali metal salt crystalline coatings on the surfaces of the wood furnish material, when and as water molecules evaporate during drying operations and/or reactions with polymeric resin binders during composite wood product manufacture operations, thereby providing alkali metal ions that inhibit fire ignition, flame spread and smoke development.

Another object of the present invention is to provide a new and improved family of environmentally-clean fire inhibiting liquid biochemical solutions (i.e. compositions) for fire-protecting combustible wood furnish material used in the production of composite wood products, comprising (i) a major amount of water, (ii) a major amount of metal alkali salt dissolved in the quantity of water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F, and (iii) a minor amount of one or more esters dissolved in the water and derived from the saturated non-polymerized carboxylic acid and/or another saturated non-polymerized carboxylic acid, promoting dispersion and coalescing of metal alkali ions in the lignocellulosic furnish material, and forming alkali metal salt crystalline structures in the lignocellulosic furnish material and/or alkali metal salt crystalline coatings on the surfaces of the wood furnish material when and as water molecules evaporate during drying operations curing composite wood manufacturing operations, thereby depositing alkali metal ions in finished composite wood products that inhibit fire ignition, flame spread and smoke development.

Another object of the present invention is to provide, consistent with the teachings of Applicant's U.S. Pat. No. 11,865,390, new and additional families of environmentally-clean aqueous-based fire inhibiting biochemical compositions and solutions designed for the biochemical treatment of combustible materials, wherein each aqueous-based biochemical composition is formed by (i) mixing a major amount of a metal alkali salt of a saturated non-polymerized carboxylic acid, that is dissolvable in a major amount of a water, wherein the metal alkali atom is selected from the group consisting of (ecologically-friendly metals) including potassium, calcium, sodium and magnesium, and wherein the carbon chain length of the carboxylic acid is less than eight (C1-C7), and the resulting water-based liquid solution is stable when mixed and its chemical components do not precipitate in the aqueous solution when stored in a storage container, making the aqueous solution ready for use in diverse temperature environments (e.g. 120 F to 34 F), and (ii) then mixing into the solution, a minor amount of an ester derived from a saturated non-polymerized carboxylic acid carboxylic acid and/or another saturated non-polymerized carboxylic acid, promoting dispersion and coalescing of metal alkali ions in lignocellulosic-based wood furnish material during composite wood product manufacture, and forming alkali metal salt crystalline structures in the lignocellulosic furnish material and/or forming alkali metal salt crystalline coatings on the surfaces of the wood furnish material, when and as water molecules evaporate during drying operations and/or disassociate during composite wood manufacturing operations, thereby depositing alkali metal ions in finished composite wood products that inhibit fire ignition, flame spread and smoke development.

Another object of the present invention is to provide a new and improved environmentally-clean fire inhibitors, flame retardants and polymeric resin binder materials and compositions, based on different kinds of alkali metal salt, and suitable for treating lignocellulosic materials and/or polymeric resin binder materials (e.g. polymeric methylene diphenyl diisocyanate resins-pMDI or PMDI) used in during the manufacture and production of solid, composite and engineered wood products (EWPs) including cellulose fiber boards, lignocellulosic-based panels, and wood-based structural members providing protection against fire, metal-corrosion, mold/mildew and moisture.

Another object of the present invention is to provide new and improved solid, composite and engineered wood products, and new and improved methods of production involving the treatment of lignocellulosic-based materials using environmentally-clean biochemical compositions that provide protection against fire, metal-corrosion, mold/mildew and moisture while functioning in a high performance manner in diverse applications across the building, construction, and home improvement industries.

Another object of the present invention is to provide a new and improved method of producing Class-A fire-protected/resistant wood based composite panels by integrally treating the panels using the environmentally-clean fire inhibiting biochemical compositions of the present invention, along with surface treatment by spray-atomization or dip-coating application using the environmentally-clean fire inhibiting biochemical formulations of the present invention.

Another object of the present invention is to provide a new and improved aqueous-based fire inhibiting biochemical composition for treating lignocellulosic-based wood furnish material during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved aqueous-based fire inhibiting biochemical composition for treating lignocellulosic-based wood furnish material during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide a new and improved aqueous-based fire inhibiting biochemical composition for treating lignocellulosic-based wood furnish material during the production of fire-protected composite wood products, using alkali metal salts derived from the C1 carboxylic acid (R—COOH), called formic acid (i.e. methanoic acid), specifically: potassium formate; calcium formate; sodium formate; and magnesium formate (dihydrate).

Another object of the present invention is to provide a new and improved aqueous-based fire inhibiting biochemical composition for treating lignocellulosic-based wood furnish material during the production of fire-protected composite wood products, using alkali metal salts derived from the C1 carboxylic acid (R—COOH), carbonic acid (i.e. hydroxymethanoic acid); specifically: potassium carbonate K₂CO₃; sodium bicarbonate Na₂CO₃; and magnesium carbonate MgCO₃.

Another object of the present invention is to provide a new and improved aqueous-based fire inhibiting biochemical composition for treating lignocellulosic-based wood furnish material during the production of fire-protected composite wood products, and produced using alkali metal salts derived from the C2 carboxylic acid (R—COOH), called acetic acid (ethanoic acid), specifically: potassium acetate; calcium acetate; sodium acetate; and magnesium acetate.

Another object of the present invention is to provide a new and improved aqueous-based fire inhibiting biochemical composition for treating lignocellulosic-based wood furnish material during the production of fire-protected composite wood products, using alkali metal salts derived from the C2 carboxylic acid (R—COOH), called glycolic acid (hydroxyacetic acid) C₂H₄O₃; specifically: potassium glycolate C₂H3KO3; calcium glycolate C₄H₆CaO₆; and sodium glycolate C₂H₃NaO₃.

Another object of the present invention is to provide a new and improved aqueous-based fire inhibiting biochemical composition for treating lignocellulosic-based wood furnish material during the production of fire-protected composite wood products, and produced using alkali metal salts derived from the C2 carboxylic acid (R—COOH), called glyoxylic acid, specifically: potassium glyoxylate; calcium glyoxylate; and sodium glyoxylate (monohydrate).

Another object of the present invention is to provide a new and improved aqueous-based fire inhibiting biochemical composition for treating lignocellulosic-based wood furnish material during the production of fire-protected composite wood products, using alkali metal salts derived from the C2 carboxylic acid (R—COOH), called oxalic acid, specifically: potassium oxalate; calcium oxalate; and sodium oxalate.

Another object of the present invention is to provide a new and improved aqueous-based fire inhibiting biochemical composition for treating lignocellulosic-based wood furnish material during the production of fire-protected composite wood products, using alkali metal salts derived from the C3 carboxylic acid (R—COOH), called propionic acid, specifically: potassium propionate; calcium propionate; sodium propionate; and magnesium propionate.

Another object of the present invention is to provide a new and improved aqueous-based fire inhibiting biochemical composition for treating lignocellulosic-based wood furnish material during the production of fire-protected composite wood products, using alkali metal salts derived from the C3 carboxylic acid (R—COOH), called lactic acid, specifically: potassium lactate; calcium lactate; sodium lactate; and magnesium lactate.

Another object of the present invention is to provide a new and improved aqueous-based fire inhibiting biochemical composition for treating lignocellulosic-based wood furnish material and/or polymeric resin binder material during the production of fire-protected composite wood products, using alkali metal salts derived from the C3 carboxylic acid (R—COOH), called glyceric acid specifically: potassium glycerate; calcium glycerate; and sodium glycerate.

Another object of the present invention is to provide a new and improved aqueous-based fire inhibiting biochemical composition for treating lignocellulosic-based wood furnish material during the production of fire-protected composite wood products, using alkali metal salts derived from the C3 carboxylic acid (R—COOH), called pyruvic acid, specifically: potassium pyruvate; calcium pyruvate; sodium pyruvate; and magnesium pyruvate.

Another object of the present invention is to provide a new and improved aqueous-based fire inhibiting biochemical composition for treating lignocellulosic-based wood furnish material during the production of fire-protected composite wood products, using alkali metal salts derived from alkali metal salts produced from the C3 carboxylic acid (R—COOH), called tartaric acid, specifically: potassium tartrate (potassium bitartrate); calcium tartrate, sodium tartrate; and magnesium tartrate.

Another object of the present invention is to provide a new and improved aqueous-based fire inhibiting biochemical composition for treating lignocellulosic-based wood furnish material during the production of fire-protected composite wood products, using alkali metal salts derived from the C4 carboxylic acid (R—COOH), called butyric acid, specifically: potassium butyrate (or butanoate); calcium butyrate; sodium butyrate; and magnesium butyrate.

Another object of the present invention is to provide a new and improved aqueous-based fire inhibiting biochemical composition for treating lignocellulosic-based wood furnish material during the production of fire-protected composite wood products, using alkali metal salts derived from the C4 carboxylic acid (R—COOH), called malic acid, specifically: potassium malate; calcium malate; sodium malate; and magnesium malate.

Another object of the present invention is to provide a new and improved aqueous-based fire inhibiting biochemical composition for treating lignocellulosic-based wood furnish material during the production of fire-protected composite wood products, and produced using alkali metal salts derived from the C4 carboxylic acid (R—COOH), called malonic acid, specifically: potassium malonate; calcium malonate; sodium malonate; and di-magnesium malonate.

Another object of the present invention is to provide a new and improved aqueous-based fire inhibiting biochemical composition for treating lignocellulosic-based wood furnish material during the production of fire-protected composite wood products, using alkali metal salts derived from the C5 carboxylic acid (R—COOH), called pivalic acid, specifically: potassium pivalate; calcium pivalate; sodium pivalate; and magnesium pivalate.

Another object of the present invention is to provide a new and improved aqueous-based fire inhibiting biochemical composition for treating lignocellulosic-based wood furnish material during the production of fire-protected composite wood products, and produced using alkali metal salts derived from the C6 carboxylic acid (R—COOH), called caproic acid, specifically: potassium caproate (hexanoate); calcium caproate; sodium caproate; and magnesium caproate.

Another object of the present invention is to provide a new and improved aqueous-based fire inhibiting biochemical composition for treating lignocellulosic-based wood furnish material during the production of fire-protected composite wood products, using alkali metal salts derived from the C6 carboxylic acid (R—COOH), called adipic (hexanedioic) acid, specifically: potassium adipate; calcium adipate; sodium adipate; and magnesium adipate.

Another object of the present invention is to provide a new and improved aqueous-based fire inhibiting biochemical composition for treating lignocellulosic-based wood furnish material during the production of fire-protected composite wood products, using alkali metal salts derived from the C6 carboxylic acid (R—COOH), called citric acid, specifically: (tri) potassium citrate; calcium citrate; sodium citrate; and magnesium citrate.

Another object of the present invention is to provide a new and improved aqueous-based fire inhibiting biochemical composition for treating lignocellulosic-based wood furnish material during the production of fire-protected composite wood products, using alkali metal salts derived from the C6 carboxylic acid (R—COOH), called d-gluconic acid, specifically: potassium gluconate; calcium gluconate; sodium gluconate; and magnesium gluconate.

Another object of the present invention is to provide a new and improved aqueous-based fire inhibiting biochemical composition for treating lignocellulosic-based wood furnish material during the production of fire-protected composite wood products, using alkali metal salts derived from the C7 carboxylic acid (R—COOH), benzoic acid C7H60, specifically: potassium benzoate; calcium benzoate; sodium benzoate; and magnesium benzoate.

Another object of the present invention is to provide a new and improved family of environmentally-clean dry powder fire inhibiting biochemical compositions for treating polymeric resin binder material, including pMDI resin binder material, during the production of fire-protected composite wood products, comprising:

(i) a major amount of first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and

(ii) a minor amount of second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys;

(iii) wherein said major amount of first alkali metal salt powder particles are mixed with said minor amount of second alkali metal salt powder particles, and blended with a major amount of pMDI-based polymeric resin binder material for biochemical treatment of said pMDI-based polymeric resin binder material, prior to use in binding together lignocellulosic-based wood furnish material used in the production of composite wood products during a composite wood product manufacturing process, whereby after the treated pMDI-based polymeric resin binder material is cured during the composite wood product manufacturing process, each finished composite wood product contains cured pMDI-based polymeric resin binder material, binding together lignocellulosic-based wood furnish material, and supporting said first alkali metal salt powder particles that are freely available to inhibit fire ignition, flame spread and smoke development, and said second alkali metal salt powder particles that are freely available to inhibit metal-corrosion of said selected metals and/or metallic alloys.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide a new and improved environmentally-clean aqueous-based fire inhibiting biochemical solution for treating lignocellulosic-based wood furnish material during the production of fire-protected composite wood products, comprising:
(i) a major amount of water (H2O) as a solvent and dispersant;
(ii) major amount of alkali metal salt dissolved in the major amount of water (H2O), and derived from a non-polymerized saturated carboxylic acid characterized by having less than 8 carbon atoms (C1-C7), wherein the alkali metal from which said alkali metal salt is derived is selected from the group consisting of potassium, calcium, sodium and magnesium; and
(iii) a minor amount of dispersing and coalescing agent, dissolved in the water and realized as an ester of a non-polymerized saturated carboxylic acid, promoting dispersion and coalescing of metal alkali ions in lignocellulosic furnish material during the production of composite wood products, and forming alkali metal salt structures in the lignocellulosic-based wood furnish material and/or alkali metal salt crystalline coatings on the exterior surfaces of the treated wood furnish material, when and as water molecules evaporate during drying operations during composite wood production manufacture, thereby producing fire-protected composite wood products having alkali metal ions that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, using alkali metal salts derived from a carboxylic acid (R—COOH), selected from the group consisting of: alkali metal salts of nonpolymeric saturated carboxylic acids for inclusion in the biochemical composition comprises: alkali metal salts of formic acid (i.e. methanoic acid); alkali metal salts of carbonic acid (i.e. hydroxymethanoic acid); alkali metal salts of acetic acid (i.e. ethanoic acid); alkali metal salts of glycolic acid (i.e. hydroxyacetic acid); alkali metal salts of glyoxylic acid; alkali metal salts of propionic acid; alkali metal salts of lactic acid; alkali metal salts of glyceric acid; alkali metal salts of tartaric acid, alkali metal salts of malic acid; alkali metal salts of malonic acid; alkali metal salts of caproic acid; alkali metal salts of adipic (hexanedioic) acid; alkali metal salts of citric acid; and alkali metal salts of benzoic acid.

Another object of the present invention is to provide a new and improved environmentally-clean aqueous-based fire inhibiting biochemical solution for treating lignocellulosic-based wood furnish material during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii)

Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate, sodium tartrate, and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri) potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

Another object of the present invention is to provide a new and improved aqueous-based fire inhibiting biochemical composition for treating lignocellulosic-based wood furnish material during the production of fire-protected composite wood products, wherein the aqueous-based fire inhibiting biochemical composition contains alkali metal salts derived from C1 Class of Carboxylic Acids having 1 carbon atom, specifically, the C1 carboxylic acid, called formic acid (i.e. methanoic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium formate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and a minor amount of ethyl formate or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated lignocellulosic material, and potassium salt structures form in the treated lignocellulosic material and/or potassium salt crystalline coatings form on the surfaces of treated lignocellulosic material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium formate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium formate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium formate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide new and improved environmentally-clean aqueous-based fire inhibiting biochemical solution for treating lignocellulosic-based wood furnish material during the production of fire-protected composite wood products, wherein each said liquid fire inhibitor solution contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9):

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium carbonate (or bicarbonate) for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide new and improved environmentally-clean aqueous-based fire inhibiting biochemical solution for treating lignocellulosic-based wood furnish material during the production of fire-protected composite wood products, comprising:
a major amount of water;
a major amount of sodium carbonate (or bicarbonate) for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium acetate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium acetate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium acetate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium acetate for producing magnesium ions when dissolved in water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium glycolate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium, and a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium glycolate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium glycolate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

Another object of the present invention is to provide new and improved environmentally-clean aqueous-based fire inhibiting biochemical solution for treating lignocellulosic-based wood furnish material during the production of fire-protected composite wood products, comprising:
a major amount of water;
a major amount of potassium glyoxylate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having alkali potassium inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium glyoxylate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium glyoxylate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide new and improved environmentally-clean aqueous-based fire inhibiting biochemical solution for treating lignocellulosic-based wood furnish material during the production of fire-protected composite wood products, wherein each said liquid fire inhibitor solution contains alkali metal salts derived from C2 Class of Carboxylic Acids having 2 carbon atoms, specifically, the C2 carboxylic acid, called oxalic acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium oxalate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl oxalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium oxalate for producing calcium ions when dissolved in the water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
a minor amount of dimethyl oxalate or triethyl citrate dissolved in the water to form the aqueous-based fire inhibiting biochemical solution for treating lignocellulosic-based wood furnish material during the production of fire-protected composite wood products, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium oxalate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl oxalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H60 (CAS RN: 79-09-04):

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium propionate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium propionate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium propionate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium propionate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium lactate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium lactate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting solution for treating lignocellulosic-based wood furnish material during the production of fire-protected composite wood products, comprising:
a major amount of water;
a major amount of sodium lactate for producing sodium ions when dissolved in the water;
a minor amount of alkali metal salt derived from benzoic acid and producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium lactate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

Another object of the present invention is to provide new and improved environmentally-clean aqueous-based fire inhibiting biochemical solution for treating lignocellulosic-based wood furnish material during the production of fire-protected composite wood products, comprising:
a major amount of water;
a major amount of potassium glycerate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of dimethyl glycerate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide new and improved environmentally-clean aqueous-based fire inhibitor solution for treating lignocellulosic-based wood furnish material during the production of fire-protected composite wood products, comprising:
a major amount of water;
a major amount of calcium glycerate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl glycerate or triethyl citrate dissolved in the water to form the aqueous-based fire inhibiting biochemical solution for treating lignocellulosic-based wood furnish material during the production of fire-protected composite wood products, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium glycerate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl glycerate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

Another object of the present invention is to provide new and improved environmentally-clean aqueous-based fire inhibiting biochemical solution for treating lignocellulosic-based wood furnish material during the production of fire-protected composite wood products, comprising:
a major amount of water;
a major amount of potassium pyruvate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium pyruvate for producing calcium ions when dissolved in the water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium pyruvate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium pyruvate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium tartrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium tartrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium tartrate for producing sodium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium tartrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium butyrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having magnesium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium butyrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium butyrate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium butyrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic, called malic acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium malate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium malate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium malate for producing sodium ions when dissolved in the water; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium malate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic acid, called malonic acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium malonate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium malonate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium malonate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of di-magnesium malonate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium pivalate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium pivalate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide new and improved environmentally-clean aqueous-based fire inhibiting biochemical solution for treating lignocellulosic-based wood furnish material during the production of fire-protected composite wood products, comprising:
a major amount of water;
a major amount of sodium pivalate for producing sodium ions when dissolved in the water; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium pivalate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium caproate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium caproate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium caproate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium caproate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium adipate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium adipate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium adipate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium adipate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called citric acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium citrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium citrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium citrate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium citrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium gluconate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate (d-gluconic acid, methyl ester) or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium gluconate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium gluconate for producing sodium ions when dissolved in the water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having gluconate ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of magnesium gluconate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

Another object of the present invention is to provide a new and improved aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of potassium benzoate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of calcium benzoate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

Another object of the present invention is to provide a new and improved environmentally-clean aqueous-based fire inhibiting biochemical solution for treating lignocellulosic-based wood furnish material during the production of fire-protected composite wood products, comprising:
a major amount of water;
a major amount of sodium benzoate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
(i) a major amount of a first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium;
(ii) a minor amount of a second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys; and
(iii) wherein said major amount of first alkali metal salt powder particles are mixed with said minor amount of second alkali metal salt powder particles, and blended together with a fluidizing agent and milled into a dry biochemical treatment powder consisting of fine powder or granular particles, wherein during biochemical treatment of said lignocellulosic-based wood furnish material, said dry biochemical treatment powder is sprayed over wet/green lignocellulosic-based wood furnish material retaining water molecules, whereby the first and second alkali metal salt powder particles are dissolved in the presence of the water molecules retained in the water molecules, producing first alkali metal ions that are available to inhibit fire, flame spread and smoke development, and benzoate ions that are available to form a protective coating on the surface of selected metals and/or metallic alloys that protects against corrosion of said selected metals and/or metallic alloys.

Another object of the present invention is to provide a new and improved environmentally-clean dry powder fire inhibiting biochemical composition for treating lignocellulosic-based wood furnish material during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved environmentally-clean dry powder fire inhibiting biochemical composition for treating lignocellulosic-based wood furnish material during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid;

(ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide a new and improved environmentally-clean dry powder fire inhibiting biochemical composition for treating lignocellulosic-based wood furnish material during the production of fire-protected composite wood products, wherein the dry powder-based fire inhibiting biochemical composition contains alkali metal salts derived from C1 Class of Carboxylic Acids having 1 carbon atom, specifically, the C1 carboxylic acid, called formic acid (i.e. methanoic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium formate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium formate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium formate for producing sodium ions when dissolved in the presence of water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sod salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium formate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium formate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein each said dry powder-based fire inhibiting composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9):

Another object of the present invention is to provide a new and improved environmentally-clean dry powder fire inhibiting biochemical composition for treating lignocellulosic-based wood furnish material during the production of fire-protected composite wood products, comprising:
a major amount of potassium carbonate (or bicarbonate) for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium carbonate (or bicarbonate) for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said aqueous-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved environmentally-clean dry powder fire inhibiting biochemical composition for treating lignocellulosic-based wood furnish material during the production of fire-protected composite wood products, comprising:
a major amount of potassium acetate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium acetate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the calcium salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium acetate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium acetate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium formate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium glycolate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium glycolate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium glycolate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development. Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium glyoxylate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium glyoxylate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame

Another object of the present invention is to provide a new and improved environmentally-clean dry powder fire inhibiting biochemical composition for treating lignocellulosic-based wood furnish material during the production of fire-protected composite wood products, comprising:
a major amount of calcium glyoxylate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium glyoxylate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium glyoxylate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali wherein when said environmentally-clean dry powder-based fire inhibiting biochemical composition is used to treat lignocellulosic-based wood furnish material during the production of fire-protected composite wood products, said sodium glyoxylate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein each said dry powder-based fire inhibiting composition contains alkali metal salts derived from C2 Class of Carboxylic Acids having 2 carbon atoms, specifically, the C2 carboxylic acid, called oxalic acid.

Another object of the present invention is to provide a new and improved environmentally-clean dry powder-based fire inhibiting biochemical composition for treating lignocellulosic-based wood furnish material during the production of fire-protected composite wood products, comprising:
a major amount of potassium oxalate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium oxalate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium oxalate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium oxalate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium oxalate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium oxalate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H60 (CAS RN: 79-09-04):

Another object of the present invention is to provide a new and improved environmentally-clean dry powder fire inhibiting biochemical composition for treating lignocellulosic-based wood furnish material during the production of fire-protected composite wood products, comprising:
a major amount of potassium propionate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium propionate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium propionate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium wherein when said environmentally-clean dry powder-based fire inhibiting biochemical composition is used to treat lignocellulosic-based wood furnish material during the production of fire-protected composite wood products, said calcium propionate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium propionate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium propionate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium propionate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium propionate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry powder-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium lactate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium lactate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium lactate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali wherein when said environmentally-clean dry powder-based fire inhibiting biochemical composition is used to treat lignocellulosic-based wood furnish material during the production of fire-protected composite wood products, said calcium lactate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium lactate for producing sodium ions when dissolved in the presence of water;
a minor amount of alkali metal salt derived from benzoic acid and producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium lactate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium lactate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium lactate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C3 Class of Carboxylic Acids having 3 carbon atoms, specifically, the C3 carboxylic acid, called glyceric acid (2,3-dihydroxypropanoic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium glycerate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium glycerate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium glycerate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium glycerate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium glycerate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium glycerate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

Another object of the present invention is to provide a new and improved environmentally-clean dry powder-based fire inhibiting biochemical composition for treating lignocellulosic-based wood furnish material during the production of fire-protected composite wood products, comprising:
a major amount of potassium pyruvate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium pyruvate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke

Another object of the present invention is to provide a new and improved environmentally-clean dry powder fire inhibiting biochemical composition for treating lignocellulosic-based wood furnish material during the production of fire-protected composite wood products, comprising:
a major amount of calcium pyruvate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium pyruvate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium pyruvate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali and magnesium;
wherein when said environmentally-clean dry powder-based fire inhibiting biochemical composition is used to treat lignocellulosic-based wood furnish material during the production of fire-protected composite wood products, said sodium pyruvate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium pyruvate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium pyruvate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium tartrate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium tartrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke

Another object of the present invention is to provide a new and improved environmentally-clean dry powder fire inhibiting biochemical composition for treating lignocellulosic-based wood furnish material during the production of fire-protected composite wood products, comprising:
a major amount of calcium tartrate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium tartrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium tartrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali and magnesium;
wherein when said environmentally-clean dry powder-based fire inhibiting biochemical composition is used to treat lignocellulosic-based wood furnish material during the production of fire-protected composite wood products, said sodium tartrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium tartrate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium tartrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium butyrate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium butyrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke

Another object of the present invention is to provide a new and improved environmentally-clean dry powder fire inhibiting biochemical composition for treating lignocellulosic-based wood furnish material during the production of fire-protected composite wood products, comprising:
a major amount of calcium butyrate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium butyrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium butyrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali and magnesium;
wherein when said environmentally-clean dry powder-based fire inhibiting biochemical composition is used to treat lignocellulosic-based wood furnish material during the production of fire-protected composite wood products, said sodium butyrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having solid ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium butyrate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium butyrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic, called malic acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium malate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium malate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke

Another object of the present invention is to provide a new and improved environmentally-clean dry powder fire inhibiting biochemical composition for treating lignocellulosic-based wood furnish material during the production of fire-protected composite wood products, comprising:
a major amount of calcium malate for producing calcium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium malate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium malate for producing sodium ions when dissolved in the water; and
wherein when said environmentally-clean dry powder-based fire inhibiting biochemical composition is used to treat lignocellulosic-based wood furnish material during the production of fire-protected composite wood products, said sodium malate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium malate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium malate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic acid, called malonic acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium malonate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium malonate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium malonate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium malonate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium malonate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium malonate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of di-magnesium malonate for producing magnesium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium malonate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean aqueous-based fire inhibiting biochemical solution for treating lignocellulosic-based wood furnish material during the production of fire-protected composite wood products, comprising:
a major amount of potassium pivalate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium pivalate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium pivalate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium pivalate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium pivalate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium pivalate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium pivalate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium pivalate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean dry powder-based fire inhibiting biochemical composition for treating lignocellulosic-based wood furnish material during the production of fire-protected composite wood products, comprising:
a major amount of potassium caproate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium caproate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium caproate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium caproate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium caproate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium caproate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium caproate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium caproate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium adipate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium adipate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium adipate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium adipate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium adipate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium adipate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium adipate for producing magnesium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium adipate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C6 Class of Carboxylic Acids having 6 carbon atoms, specifically, the C6 carboxylic acid, called citric acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium citrate for producing potassium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium citrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium citrate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium citrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium citrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium citrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium citrate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium citrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean dry powder fire inhibiting biochemical composition for treating lignocellulosic-based wood furnish material during the production of fire-protected composite wood products, comprising:
a major amount of potassium gluconate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium gluconate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium gluconate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium gluconate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium gluconate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium gluconate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of magnesium gluconate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and wherein when said environmentally-clean dry powder-based fire inhibiting biochemical composition is used to treat lignocellulosic-based wood furnish material during the production of fire-protected composite wood products, said magnesium gluconate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean dry powder fire inhibiting biochemical composition for treating lignocellulosic-based wood furnish material during the production of fire-protected composite wood products, comprising:
a major amount of potassium benzoate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium benzoate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of calcium benzoate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium benzoate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

Another object of the present invention is to provide a new and improved environmentally-clean dry powder fire inhibiting biochemical composition for treating lignocellulosic-based wood furnish material during the production of fire-protected composite wood products, comprising:
a major amount of sodium benzoate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium benzoate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

TREATING PMDI-BASED POLYMERIC RESIN BINDER MATERIAL DURING COMPOSITE WOOD PRODUCT MANUFACTURE-USING BIOCHEMICALS COMPOSITIONS-PROVIDING BOTH FIRE AND CORROSION PROTECTION

Another object of the present invention is to provide a new and improved environmentally-clean fire inhibiting biochemical composition for treating pDMI polymeric resin binder material used to bind together lignocellulosic-based wood furnish material during composite wood product manufacturing operations,
(i) a major amount of first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and
(ii) a minor amount of second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys;

(iii) a minor amount of water for reacting/catalyzing with a predetermined amount of pMDI resin binder material during composite wood product manufacturing operations;
wherein said major amount of first alkali metal salt powder particles are mixed with said minor amount of second alkali metal salt powder particles and said minor amount of water for reacting/catalyzing, and blended with a major amount of pMDI-based polymeric resin binder material for biochemical treatment of said pMDI-based polymeric resin binder material, prior to use in binding together lignocellulosic-based wood furnish material used in the production of composite wood products during a composite wood product manufacturing process, whereby after the treated pMDI-based polymeric resin binder material is cured during the composite wood product manufacturing process, each finished composite wood product contains cured pMDI-based polymeric resin binder material, binding together lignocellulosic-based wood furnish material, and supporting said first alkali metal salt powder particles that are freely available to inhibit fire ignition, flame spread and smoke development, and said second alkali metal salt powder particles that are freely available to inhibit metal-corrosion of said selected metals and/or metallic alloys.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: alkali metal salts of nonpolymeric saturated carboxylic acids for inclusion in the biochemical composition comprises: alkali metal salts of formic acid (i.e. methanoic acid); alkali metal salts of carbonic acid (i.e. hydroxymethanoic acid); alkali metal salts of acetic acid (i.e. ethanoic acid); alkali metal salts of glycolic acid (i.e. hydroxyacetic acid); alkali metal salts of glyoxylic acid; alkali metal salts of propionic acid; alkali metal salts of lactic acid; alkali metal salts of glyceric acid; alkali metal salts of tartaric acid, alkali metal salts of malic acid; alkali metal salts of malonic acid; alkali metal salts of caproic acid; alkali metal salts of adipic (hexanedioic) acid; alkali metal salts of citric acid; and alkali metal salts of benzoic acid.

Another object of the present invention is to provide a new and improved family of environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate, sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri) potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

Another object of the present invention is to provide a new and improved fire inhibiting biochemical composition for treating polymeric resin binder material used to bind together lignocellulosic-based wood furnish material during the production of fire-protected composite wood products, wherein the fire inhibiting biochemical composition contains alkali metal salts derived from C1 Class of Carboxylic Acids having 1 carbon atom, specifically, the C1 carboxylic acid, called formic acid (i.e. methanoic acid).

Another object of the present invention is to provide a new and improved environmentally-clean fire inhibiting biochemical composition for treating polymeric resin binder material used to bind together lignocellulosic-based wood furnish material during composite wood product manufacturing operations, comprising:
a major amount of potassium formate in the form of dry powder consisting of potassium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium formate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium formate in the form of dry powder consisting of calcium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium formate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium formate in the form of dry powder consisting of sodium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium formate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium formate in the form of dry powder consisting of magnesium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium formate powder particles freely available in said cured polymeric resin binder material to inhibit fire ignition, flame spread and smoke development in the finished composite wood product.

Another object of the present invention is to provide new and improved environmentally-clean fire inhibiting biochemical composition for treating polymeric resin binder material used to bind together lignocellulosic-based wood furnish material during composite wood product manufacture, wherein each said fire inhibiting biochemical composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium formate in the form of dry powder consisting of potassium carbonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium carbonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium carbonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium carbonate powder particles freely available in said cured polymeric resin binder material to inhibit fire ignition, flame spread and smoke development in the finished composite wood product.

Another object of the present invention is to provide new and improved environmentally-clean fire inhibiting biochemical composition for treating polymeric resin binder material used to bind together lignocellulosic-based wood furnish material during composite wood product manufacture, comprising:
a major amount of sodium formate in the form of dry powder consisting of carbonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium carbonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium carbonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium carbonate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium acetate in the form of dry powder consisting of potassium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium acetate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium acetate in the form of dry powder consisting of calcium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium acetate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium acetate in the form of dry powder consisting of sodium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium acetate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium acetate in the form of dry powder consisting of magnesium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium acetate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium glycolate in the form of dry powder consisting of glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glycolate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium glycolate in the form of dry powder consisting of calcium glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glycolate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium glycolate in the form of dry powder consisting of sodium glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glycolate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

Another object of the present invention is to provide new and improved environmentally-clean fire inhibiting biochemical composition for treating polymeric resin binder material used to bind together lignocellulosic-based wood furnish material during composite wood product manufacture, comprising:
a major amount of potassium glyoxylate in the form of dry powder consisting of potassium glyoxylate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glyoxylate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium glyoxylate in the form of dry powder consisting of calcium glyoxylate powder particles;
a minor amount of alkali metal salt in the form of dry powder consisting of alkali metal salt powder particles, mixed and blended with said major amount of calcium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glyoxylate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium glyoxylate in the form of dry powder consisting of sodium glyoxylate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glyoxylate powder particles freely available in said cured polymeric resin binder material to inhibit fire ignition, flame spread and smoke development in the finished composite wood product.

Another object of the present invention is to provide new and improved environmentally-clean fire inhibiting biochemical composition for treating polymeric resin binder material used to bind together lignocellulosic-based wood furnish material during composite wood product manufacture, wherein each said liquid fire inhibiting biochemical composition contains alkali metal salts derived from C2 Class of Carboxylic Acids having 2 carbon atoms, specifically, the C2 carboxylic acid, called oxalic acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium oxalate in the form of dry powder consisting of potassium oxalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium oxalate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium oxalate in the form of dry powder consisting of calcium oxalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium oxalate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium oxalate in the form of dry powder consisting of sodium oxalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium oxalate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H60 (CAS RN: 79-09-04).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium propionate in the form of dry powder consisting of potassium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium propionate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium propionate in the form of dry powder consisting of calcium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium propionate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium propionate in the form of dry powder consisting of sodium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium propionate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium propionate in the form of dry powder consisting of magnesium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium propionate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium lactate in the form of dry powder consisting of potassium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium lactate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium lactate in the form of dry powder consisting of calcium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium lactate powder particles freely available in said cured polymeric resin binder material to inhibit fire ignition, flame spread and smoke development in the finished composite wood product.

Another object of the present invention is to provide a new and improved environmentally-clean fire inhibiting composition for treating polymeric resin binder material used to bind together lignocellulosic-based wood furnish material during composite wood product manufacture, comprising:
a major amount of sodium lactate in the form of dry powder consisting of sodium lactate powder particles;
a minor amount of alkali metal salt in the form of dry powder consisting of alkali metal salt powder particles, mixed and blended with said major amount of sodium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium lactate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium lactate in the form of dry powder consisting of magnesium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium lactate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

Another object of the present invention is to provide new and improved environmentally-clean fire inhibiting biochemical composition for treating polymeric resin binder material used to bind together lignocellulosic-based wood furnish material during composite wood product manufacture, comprising:
a major amount of potassium glycerate in the form of dry powder consisting of potassium glycerate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glycerate powder particles freely available in said cured polymeric resin binder material to inhibit fire ignition, flame spread and smoke development in the finished composite wood product.

Another object of the present invention is to provide new and improved environmentally-clean fire inhibitor solution for treating polymeric resin binder material used to bind together lignocellulosic-based wood furnish material during composite wood product manufacture, comprising:
a major amount of calcium glycerate in the form of dry powder consisting of calcium glycerate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glycerate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium glycerate in the form of dry powder consisting of sodium glycerate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glycerate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

Another object of the present invention is to provide new and improved environmentally-clean fire inhibiting biochemical composition for treating polymeric resin binder material used to bind together lignocellulosic-based wood furnish material during composite wood product manufacture, comprising:
a major amount of potassium pyruvate in the form of dry powder consisting of potassium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium pyruvate powder particles freely available in said cured polymeric resin binder material to inhibit fire ignition, flame spread and smoke development in the finished composite wood product.

Another object of the present invention is to provide a new and improved environmentally-clean fire inhibiting biochemical solution for treating polymeric resin binder material used to bind together lignocellulosic-based wood furnish material during composite wood product manufacture, comprising:
a major amount of calcium pyruvate in the form of dry powder consisting of calcium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium pyruvate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium pyruvate in the form of dry powder consisting of sodium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium pyruvate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium pyruvate in the form of dry powder consisting of magnesium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium pyruvate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium tartrate in the form of dry powder consisting of potassium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium tartrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium tartrate in the form of dry powder consisting of calcium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium tartrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium tartrate in the form of dry powder consisting of sodium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium tartrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium tartrate in the form of dry powder consisting of magnesium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium tartrate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium butyrate in the form of dry powder consisting of potassium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium butyrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium butyrate in the form of dry powder consisting of calcium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium butyrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium butyrate in the form of dry powder consisting of sodium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium butyrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium butyrate in the form of dry powder consisting of magnesium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium butyrate powder particles freely available in said cured polymeric resin binder material to inhibit fire ignition, flame spread and smoke development in the finished composite wood product.

Another object of the present invention is to provide a new and improved fire inhibiting biochemical composition for treating lignocellulosic-based wood furnish material during the production of fire-protected composite wood products, wherein said fire inhibiting biochemical composition contains alkali metal salts derived from C4 Class of Carboxylic Acids having 4 carbon atoms, specifically, the C4 carboxylic, called malic acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium malate in the form of dry powder consisting of potassium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium malate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium malate in the form of dry powder consisting of calcium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium malate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium malate in the form of dry powder consisting of sodium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium malate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium malate in the form of dry powder consisting of magnesium malate powder particles;
a minor amount of alkali metal salt in the form of dry powder consisting of alkali metal salt powder particles, mixed and blended with said major amount of magnesium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium malate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C4 Class of Carboxylic Acids having 4 carbon atoms, specifically, the C4 carboxylic acid, called malonic acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium malonate in the form of dry powder consisting of potassium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium malonate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium malonate in the form of dry powder consisting of calcium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium malonate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium malonate in the form of dry powder consisting of sodium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium malonate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of (di) magnesium malonate in the form of dry powder consisting of magnesium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium malonate powder particles freely available in said cured polymeric resin binder material to inhibit fire ignition, flame spread and smoke development in the finished composite wood product.

Another object of the present invention is to provide a new and improved aqueous-based fire inhibiting biochemical composition for treating polymeric resin binder material used to bind together lignocellulosic-based wood furnish material during composite wood product manufacture, wherein said fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium pivalate in the form of dry powder consisting of potassium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium pivalate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium pivalate in the form of dry powder consisting of calcium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium pivalate powder particles freely available in said cured polymeric resin binder material to inhibit fire ignition, flame spread and smoke development in the finished composite wood product.

Another object of the present invention is to provide new and improved environmentally-clean fire inhibiting biochemical composition for treating polymeric resin binder material used to bind together lignocellulosic-based wood furnish material during composite wood product manufacture, comprising:
a major amount of sodium pivalate in the form of dry powder consisting of sodium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium pivalate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium pivalate in the form of dry powder consisting of magnesium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium pivalate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium caproate in the form of dry powder consisting of potassium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium caproate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium caproate in the form of dry powder consisting of calcium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium caproate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium caproate in the form of dry powder consisting of sodium pivalate powder particles;
a minor amount of alkali metal salt in the form of dry powder consisting of alkali metal salt powder particles, mixed and blended with said major amount of sodium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium caproate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium caproate in the form of dry powder consisting of magnesium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium caproate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean fire inhibiting biochemical solution for treating polymeric resin binder material used to bind together lignocellulosic-based wood furnish material during composite wood product manufacture, comprising:
a major amount of potassium adipate in the form of dry powder consisting of potassium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium adipate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium adipate in the form of dry powder consisting of calcium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium adipate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium adipate in the form of dry powder consisting of sodium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium adipate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium adipate in the form of dry powder consisting of magnesium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium adipate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C6 Class of Carboxylic Acids having 6 carbon atoms, specifically, the C6 carboxylic acid, called citric acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium citrate in the form of dry powder consisting of potassium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium citrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium citrate in the form of dry powder consisting of calcium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium citrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium citrate in the form of dry powder consisting of sodium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium citrate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium citrate in the form of dry powder consisting of magnesium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium citrate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium gluconate in the form of dry powder consisting of potassium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium gluconate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium gluconate in the form of dry powder consisting of calcium gluconate powder particles;
a minor amount of alkali metal salt in the form of dry powder consisting of alkali metal salt powder particles, mixed and blended with said major amount of calcium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium gluconate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium gluconate in the form of dry powder consisting of sodium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium gluconate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium gluconate in the form of dry powder consisting of magnesium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium gluconate and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium gluconate powder particles freely available in said cured polymeric resin binder material to inhibit fire ignition, flame spread and smoke development in the finished composite wood product.

Another object of the present invention is to provide a new and improved fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of potassium benzoate in the form of dry powder consisting of potassium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium benzoate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of calcium benzoate in the form of dry powder consisting of calcium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium benzoate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of sodium benzoate in the form of dry powder consisting of sodium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium benzoate powder particles freely available in said cured polymeric resin binder material to inhibit fire ignition, flame spread and smoke development in the finished composite wood product.

Another object of the present invention is to provide a new and improved environmentally-clean fire inhibiting biochemical composition for treating polymeric resin binder material used to bind together lignocellulosic-based wood furnish material during composite wood product manufacture, comprising:
a major amount of magnesium benzoate in the form of dry powder consisting of magnesium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium benzoate powder particles freely available in said cured polymeric resin binder material to inhibit fire ignition, flame spread and smoke development in the finished composite wood product.

Another object of the present invention is to provide a new and improved dry-powder-based fire inhibiting biochemical composition for treating polymeric resin binder material used to bind together lignocellulosic-based wood furnish material during the production of fire-protected composite wood products, comprising:
a major amount of alkali metal salt in dry powder form consisting of alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium;
wherein said alkali metal salt powder particles are in dry powder form adapted for blending with a major amount of polymeric resin binder material, that is capable of binding lignocellulosic-based wood furnish material when cured during composite wood product manufacture; and
wherein when said polymeric resin binder material is cured to bind said lignocellulosic-based wood furnish material during composite wood product manufacture, the alkali metal salt powder particles are well dispersed within the cured polymeric resin binder material, and available to inhibit fire ignition, flame spread and smoke development.

Another object of the present invention is to provide a new and improved dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide a new and improved dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate), calcium tartrate; sodium tartrate, and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri) potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

Another object of the present invention is to provide a new and improved dry-powder-based fire inhibiting biochemical composition for treating polymeric resin binder material used to bind together lignocellulosic-based wood furnish material during the production of fire-protected composite wood products, wherein the dry powder fire inhibiting biochemical composition contains alkali metal salts derived from C1 Class of Carboxylic Acids having 1 carbon atom, specifically, the C1 carboxylic acid, called formic acid (i.e. methanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium formate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium formate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium formate powder particles are well dispersed within the cured polymeric resin

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium formate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein each said dry-powder fire inhibitor composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9):

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium carbonate (bicarbonate) in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium carbonate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium (bi) carbonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium (bi) carbonate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium acetate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium acetate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium acetate powder particles are well dispersed within the cured polymeric resin furnish material during composite wood product manufacture, comprising:
a minor amount of magnesium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium acetate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycolate powder particles are well dispersed within the cured polymeric resin binder material, and available to inhibit fire ignition, flame spread and smoke

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycolate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glycolate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic glyoxylic acid (i.e. oxoacetic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycolate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycolate powder particles are well dispersed within the cured polymeric resin
a minor amount of sodium glyoxylate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glyoxylate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein each said dry-powder fire inhibiting composition contains alkali metal salts derived from C2 Class of Carboxylic Acids having 2 carbon atoms, specifically, the C2 carboxylic acid, called oxalic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium oxalate powder particles are well dispersed within the cured polymeric resin
a minor amount of potassium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium oxalate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium oxalate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H6O (CAS RN: 79-09-04).
a minor amount of potassium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium propionate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium propionate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium propionate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium propionate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium lactate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium lactate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium lactate powder particles are well dispersed within the cured polymeric resin

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium lactate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
minor amount of potassium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycerate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycerate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glycerate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3

Class of Carboxylic Acids having 3 carbon atoms, specifically, the C3 carboxylic acid, called pyruvic acid (i.e. 2-oxopropanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium pyruvate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium pyruvate powder particles are well dispersed within the cured polymeric resin
a minor amount of sodium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium pyruvate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium pyruvate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid). furnish material during composite wood product manufacture, comprising:
a minor amount of potassium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium tartrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium tartrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium tartrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium tartrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium butyrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium butyrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium butyrate powder particles are well dispersed within the cured polymeric resin

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium butyrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic, called malic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium butyrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium malate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium malate powder particles are well dispersed within the cured polymeric resin
a minor amount of magnesium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium malate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called malonic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium malonate powder particles are well dispersed within the cured polymeric resin binder material, and available to inhibit fire ignition, flame spread and smoke furnish material during composite wood product manufacture, comprising:
a minor amount of calcium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium malonate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium malonate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of dimagnesium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the dimagnesium malonate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium pivalate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium pivalate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium pivalate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium pivalate powder particles are well dispersed within the cured polymeric resin binder material, and available to inhibit fire ignition, flame spread and smoke

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium caproate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium caproate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium caproate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium caproate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium adipate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium adipate powder particles are well dispersed within the cured polymeric resin
a minor amount of sodium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium adipate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium adipate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid. furnish material during composite wood product manufacture, comprising:
a minor amount of potassium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium citrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium citrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium citrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium citrate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium gluconate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium gluconate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium gluconate powder particles are well dispersed within the cured polymeric resin furnish material during composite wood product manufacture, comprising:
a minor amount of magnesium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium gluconate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium benzoate powder particles are well dispersed within the cured polymeric resin binder material, and available to inhibit fire ignition, flame spread and smoke

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium benzoate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium benzoate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium benzoate powder particles are well dispersed within the cured polymeric resin binder material, and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
(i) a major amount of a first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and
(ii) a minor amount of a second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys; and
wherein said major amount of first alkali metal salt powder particles are mixed with said minor amount of second alkali metal salt powder particles, and blended together into a dry biochemical treatment powder consisting of fine powder or granular particles;
wherein when said dry biochemical treatment powder is blended with a major amount of polymeric resin binder material, for binding lignocellulosic-based wood furnish material during composite wood product manufacture, the first alkali metal salt powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting first alkali metal salt powder particles that are freely available to inhibit fire ignition, flame spread and smoke development, and second alkali metal salt powder particles that are freely available to form a protective coating on the surface of selected metals and/or metallic alloys that protects against corrosion of said selected metals and/or metallic alloys.

Another object of the present invention is to provide a new and improved environmentally-clean dry powder-based fire inhibiting biochemical composition for treating polymeric resin binder material used to bind together lignocellulosic-based wood furnish material during composite wood product manufacture, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid. furnish material during composite wood product manufacture, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate, sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate;

sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri) potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium formate in dry powder form; and
a minor amount of an alkali metal salt of benzoic acid in dry powder form, mixed with said calcium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium formate and said alkali metal salt of benzoic acid, are blended with a major amount of polymeric resin binder material, for binding lignocellulosic-based wood furnish material during composite wood product manufacture, the calcium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium formate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium formate in dry powder form; and
a minor amount of an alkali metal salt of benzoic acid in dry powder form, mixed with said sodium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium formate and said alkali metal salt of benzoic acid, are blended with a major amount of polymeric resin binder material, for binding lignocellulosic-based wood furnish material during composite wood product manufacture, the sodium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium formate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium formate in dry powder form; and
a minor amount of an alkali metal salt of benzoic acid in dry powder form, mixed with said magnesium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium formate and said alkali metal salt of benzoic acid, are blended with a major amount of polymeric resin binder material, for binding lignocellulosic-based wood furnish material during composite wood product manufacture, the magnesium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium formate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein each said dry-powder fire inhibitor composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium carbonate (bicarbonate) in dry powder form; and
a minor amount of an alkali metal salt of benzoic acid in dry powder form, mixed with said potassium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium carbonate and said alkali metal salt of benzoic acid, are blended with a major amount of polymeric resin binder material, for binding lignocellulosic-based wood furnish material during composite wood product manufacture, the potassium carbonate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium carbonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium carbonate (bicarbonate) in dry powder form; and
a minor amount of an alkali metal salt of benzoic acid in dry powder form, mixed with said sodium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium carbonate and said alkali metal salt of benzoic acid, are blended with a major amount of polymeric resin binder material, for binding lignocellulosic-based wood furnish material during composite wood product manufacture, the sodium carbonate powder particles are well dispersed within the wood product contains cured polymeric resin binder material binding together lignocellulosic-based wood furnish material, and supporting sodium carbonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium acetate in dry powder form; and
a minor amount of an alkali metal salt of benzoic acid in dry powder form, mixed with said potassium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium acetate and said alkali metal salt of benzoic acid, are blended with a major amount of polymeric resin binder material, for binding lignocellulosic-based wood furnish material during composite wood product manufacture, the potassium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium acetate powder development and available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium acetate in dry powder form; and
a minor amount of an alkali metal salt of benzoic acid in dry powder form, mixed with said calcium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium acetate and said alkali metal salt of benzoic acid, are blended with a major amount of polymeric resin binder material, for binding lignocellulosic-based wood furnish material during composite wood product manufacture, the calcium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium acetate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium acetate in dry powder form; and
a minor amount of an alkali metal salt of benzoic acid in dry powder form, mixed with said sodium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium acetate and said alkali metal salt of benzoic acid, are blended with a major amount of polymeric resin binder material, for binding lignocellulosic-based wood furnish material during composite wood product manufacture, the sodium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium acetate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium acetate in dry powder form; and
a minor amount of an alkali metal salt of benzoic acid in dry powder form, mixed with said magnesium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium acetate and said alkali metal salt of benzoic acid, are blended with a major amount of polymeric resin binder material, for binding lignocellulosic-based wood furnish material during composite wood product manufacture, the magnesium acetate powder particles are well dispersed within the treated polymeric resin binder material, and after the treated polymeric resin binder wood product contains cured polymeric resin binder material binding together lignocellulosic-based wood furnish material, and supporting magnesium acetate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glycolate in dry powder form; and
a minor amount of an alkali metal salt of benzoic acid in dry powder form, mixed with said potassium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glycolate and said alkali metal salt of benzoic acid, are blended with a major amount of polymeric resin binder material, for binding lignocellulosic-based wood furnish material during composite wood product manufacture, the potassium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glycolate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form; and
a minor amount of an alkali metal salt of benzoic acid in dry powder form, mixed with said calcium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glycolate and said alkali metal salt of benzoic acid, are blended with a major amount of polymeric resin binder material, for binding lignocellulosic-based wood furnish material during composite wood product manufacture, the calcium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glycolate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form; and
a minor amount of an alkali metal salt of benzoic acid in dry powder form, mixed with said sodium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycolate and said alkali metal salt of benzoic acid, are blended with a major amount of polymeric resin binder material, for binding lignocellulosic-based wood furnish material during composite wood product manufacture, the sodium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium glycolate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glyoxylate in dry powder form; and
a minor amount of an alkali metal salt of benzoic acid in dry powder form, mixed with said powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glyoxylate and said alkali metal salt of benzoic acid, are blended with a major amount of polymeric resin binder material, for binding lignocellulosic-based wood furnish material during composite wood product manufacture, the potassium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glyoxylate in dry powder form; and
a minor amount of an alkali metal salt of benzoic acid in dry powder form, mixed with said calcium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glyoxylate and said alkali metal salt of benzoic acid, are blended with a major amount of polymeric resin binder material, for binding lignocellulosic-based wood furnish material during composite wood product manufacture, the calcium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glyoxylate in dry powder form; and
a minor amount of an alkali metal salt of benzoic acid in dry powder form, mixed with said sodium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxylate and said alkali metal salt of benzoic acid, are blended with a major amount of polymeric resin binder material, for binding lignocellulosic-based wood furnish material during composite wood product manufacture, the sodium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein each said dry-powder fire inhibiting composition contains alkali metal salts derived from C2 Class of

Carboxylic Acids having 2 carbon atoms, specifically, the C2 carboxylic acid, called oxalic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form; and
a minor amount of an alkali metal salt of benzoic acid in dry powder form, mixed with said potassium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium oxalate and said alkali metal salt of benzoic acid, are blended with a major amount of polymeric resin binder material, for binding lignocellulosic-based wood furnish material during composite wood product manufacture, the potassium oxalate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium oxalate in dry powder form; and
a minor amount of an alkali metal salt of benzoic acid in dry powder form, mixed with said calcium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium oxalate and said alkali metal salt of benzoic acid, are blended with a major amount of polymeric resin binder material, for binding lignocellulosic-based wood furnish material during composite wood product manufacture, the calcium oxalate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium oxalate in dry powder form; and
a minor amount of an alkali metal salt of benzoic acid in dry powder form, mixed with said sodium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxalate and said alkali metal salt of benzoic acid, are blended with a major amount of polymeric resin binder material, for binding lignocellulosic-based wood furnish material during composite wood product manufacture, the sodium oxalate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H60 (CAS RN: 79-09-04):

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium propionate in dry powder form; and
a minor amount of an alkali metal salt of benzoic acid in dry powder form, mixed with said potassium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium propionate and said alkali metal salt of benzoic acid, are blended with a major amount of polymeric resin binder material, for binding lignocellulosic-based wood furnish material during composite wood product manufacture, the potassium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium propionate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form; and
a minor amount of an alkali metal salt of benzoic acid in dry powder form, mixed with said calcium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium propionate and said alkali metal salt of benzoic acid, are blended with a major amount of polymeric resin binder material, for binding lignocellulosic-based wood furnish material during composite wood product manufacture, the calcium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form; and
a minor amount of an alkali metal salt of benzoic acid in dry powder form, mixed with said sodium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium propionate and said alkali metal salt of benzoic acid, are blended with a major amount of polymeric resin binder material, for binding lignocellulosic-based wood furnish material during composite wood product manufacture, the sodium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium propionate in dry powder form; and
a minor amount of an alkali metal salt of benzoic acid in dry powder form, mixed with said magnesium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium propionate and said alkali metal salt of benzoic acid, are blended with a major amount of polymeric resin binder material, for binding lignocellulosic-based wood furnish material during composite wood product manufacture, the magnesium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form; and
a minor amount of an alkali metal salt of benzoic acid in dry powder form, mixed with said potassium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium lactate and said alkali metal salt of benzoic acid, are blended with a major amount of polymeric resin binder material, for binding lignocellulosic-based wood furnish material during composite wood product manufacture, the potassium lactate powder particles are well dispersed within the wood product contains cured polymeric resin binder material binding together lignocellulosic-based wood furnish material, and supporting potassium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium lactate in dry powder form; and
a minor amount of an alkali metal salt of benzoic acid in dry powder form, mixed with said calcium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium lactate and said alkali metal salt of benzoic acid, are blended with a major amount of polymeric resin binder material, for binding lignocellulosic-based wood furnish material during composite wood product manufacture, the calcium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium lactate in dry powder form; and
a minor amount of an alkali metal salt of benzoic acid in dry powder form, mixed with said sodium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium lactate and said alkali metal salt of benzoic acid, are blended with a major amount of polymeric resin binder material, for binding lignocellulosic-based wood furnish material during composite wood product manufacture, the sodium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium lactate in dry powder form; and
a minor amount of an alkali metal salt of benzoic acid in dry powder form, mixed with said magnesium powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium lactate and said alkali metal salt of benzoic acid, are blended with a major amount of polymeric resin binder material, for binding lignocellulosic-based wood furnish material during composite wood product manufacture, the magnesium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glycerate in dry powder form; and
a minor amount of an alkali metal salt of benzoic acid in dry powder form, mixed with said potassium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glycerate and said alkali metal salt of benzoic acid, are blended with a major amount of polymeric resin binder material, for binding lignocellulosic-based wood furnish material during composite wood product manufacture, the potassium glycerate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glycerate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form; and
a minor amount of an alkali metal salt of benzoic acid in dry powder form, mixed with said calcium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glycerate and said alkali metal salt of benzoic acid, are blended with a major amount of polymeric resin binder material, for binding lignocellulosic-based wood furnish material during composite wood product manufacture, the calcium glycerate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glycerate powder
a minor amount of sodium glycerate in dry powder form; and
a minor amount of an alkali metal salt of benzoic acid in dry powder form, mixed with said sodium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycerate and said alkali metal salt of benzoic acid, are blended with a major amount of polymeric resin binder material, for binding lignocellulosic-based wood furnish material during composite wood product manufacture, the sodium glycerate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium glycerate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form; and
a minor amount of an alkali metal salt of benzoic acid in dry powder form, mixed with said potassium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium pyruvate and said alkali metal salt of benzoic acid, are blended with a major amount of polymeric resin binder material, for binding lignocellulosic-based wood furnish material during composite wood product manufacture, the potassium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form; and
a minor amount of an alkali metal salt of benzoic acid in dry powder form, mixed with said calcium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium pyruvate and said alkali metal salt of benzoic acid, are blended with a major amount of polymeric resin binder material, for binding lignocellulosic-based wood furnish material during composite wood product manufacture, the calcium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium pyruvate in dry powder form; and
a minor amount of an alkali metal salt of benzoic acid in dry powder form, mixed with said pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium pyruvate and said alkali metal salt of benzoic acid, are blended with a major amount of polymeric resin binder material, for binding lignocellulosic-based wood furnish material during composite wood product manufacture, the sodium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium pyruvate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form; and
a minor amount of an alkali metal salt of benzoic acid in dry powder form, mixed with said magnesium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium pyruvate and said alkali metal salt of benzoic acid, are blended with a major amount of polymeric resin binder material, for binding lignocellulosic-based wood furnish material during composite wood product manufacture, the magnesium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid). furnish material during composite wood product manufacture, comprising:
a minor amount of potassium tartrate in dry powder form; and
a minor amount of an alkali metal salt of benzoic acid in dry powder form, mixed with said potassium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium tartrate and said alkali metal salt of benzoic acid, are blended with a major amount of polymeric resin binder material, for binding lignocellulosic-based wood furnish material during composite wood product manufacture, the potassium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form; and
a minor amount of an alkali metal salt of benzoic acid in dry powder form, mixed with said calcium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium tartrate and said alkali metal salt of benzoic acid, are blended with a major amount of polymeric resin binder material, for binding lignocellulosic-based wood furnish material during composite wood product manufacture, the calcium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form; and
a minor amount of an alkali metal salt of benzoic acid in dry powder form, mixed with said sodium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium tartrate and said alkali metal salt of benzoic acid, are blended with a major amount of polymeric resin binder material, for binding lignocellulosic-based wood furnish material during composite wood product manufacture, the sodium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form; and
a minor amount of an alkali metal salt of benzoic acid in dry powder form, mixed with said magnesium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium tartrate and said alkali metal salt of benzoic acid, are blended with a major amount of polymeric resin binder material, for binding lignocellulosic-based wood furnish material during composite wood product manufacture, the magnesium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form; and
a minor amount of an alkali metal salt of benzoic acid in dry powder form, mixed with said potassium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium butyrate and said alkali metal salt of benzoic acid, are blended with a major amount of polymeric resin binder material, for binding lignocellulosic-based wood furnish material during composite wood product manufacture, the potassium butyrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form; and
a minor amount of an alkali metal salt of benzoic acid in dry powder form, mixed with said calcium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium butyrate and said alkali metal salt of benzoic acid, are blended with a major amount of polymeric resin binder material, for binding lignocellulosic-based wood furnish material during composite wood product manufacture, the calcium butyrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium butyrate in dry powder form; and
a minor amount of an alkali metal salt of benzoic acid in dry powder form, mixed with said sodium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium butyrate and said alkali metal salt of benzoic acid, are blended with a major amount of polymeric resin binder material, for binding lignocellulosic-based wood furnish material during composite wood product manufacture, the sodium butyrate powder particles are well dispersed within the wood product contains cured polymeric resin binder material binding together lignocellulosic-based wood furnish material, and supporting sodium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form; and
a minor amount of an alkali metal salt of benzoic acid in dry powder form, mixed with said magnesium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium butyrate and said alkali metal salt of benzoic acid, are blended with a major amount of polymeric resin binder material, for binding lignocellulosic-based wood furnish material during composite wood product manufacture, the magnesium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4

Class of Carboxylic Acids having 4 carbon atoms, specifically, the C4 carboxylic, called malic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium malate in dry powder form; and
a minor amount of an alkali metal salt of benzoic acid in dry powder form, mixed with said potassium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium malate and said alkali metal salt of benzoic acid, are blended with a major amount of polymeric resin binder material, for binding lignocellulosic-based wood furnish material during composite wood product manufacture, the potassium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form; and
a minor amount of an alkali metal salt of benzoic acid in dry powder form, mixed with said calcium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium malate and said alkali metal salt of benzoic acid, are blended with a major amount of polymeric resin binder material, for binding lignocellulosic-based wood furnish material during composite wood product manufacture, the calcium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form; and
a minor amount of an alkali metal salt of benzoic acid in dry powder form, mixed with said sodium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium malate and said alkali metal salt of benzoic acid, are blended with a major amount of polymeric resin binder material, for binding lignocellulosic-based wood furnish material during composite wood product manufacture, the sodium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium malate in dry powder form; and
a minor amount of an alkali metal salt of benzoic acid in dry powder form, mixed with said magnesium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium malate and said alkali metal salt of benzoic acid, are blended with a major amount of polymeric resin binder material, for binding lignocellulosic-based wood furnish material during composite wood product manufacture, the magnesium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4

Class of Carboxylic Acids having 4 carbon atoms, specifically, the C4 carboxylic acid, called malonic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form; and
a minor amount of an alkali metal salt of benzoic acid in dry powder form, mixed with said potassium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium malonate and said alkali metal salt of benzoic acid, are blended with a major amount of polymeric resin binder material, for binding lignocellulosic-based wood furnish material during composite wood product manufacture, the potassium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium malonate in dry powder form; and
a minor amount of an alkali metal salt of benzoic acid in dry powder form, mixed with said calcium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium malonate and said alkali metal salt of benzoic acid, are blended with a major amount of polymeric resin binder material, for binding lignocellulosic-based wood furnish material during composite wood product manufacture, the calcium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium malonate in dry powder form; and
a minor amount of an alkali metal salt of benzoic acid in dry powder form, mixed with said sodium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium malonate and said alkali metal salt of benzoic acid, are blended with a major amount of polymeric resin binder material, for binding lignocellulosic-based wood furnish material during composite wood product manufacture, the sodium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of dimagnesium malonate in dry powder form; and
a minor amount of an alkali metal salt of benzoic acid in dry powder form, mixed with said dimagnesium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said dimagnesium malonate and said alkali metal salt of benzoic acid, are blended with a major amount of polymeric resin binder material, for binding lignocellulosic-based wood furnish material during composite wood product manufacture, the dimagnesium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malonate powder furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form; and
a minor amount of an alkali metal salt of benzoic acid in dry powder form, mixed with said potassium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium pivalate and said alkali metal salt of benzoic acid, are blended with a major amount of polymeric resin binder material, for binding lignocellulosic-based wood furnish material during composite wood product manufacture, the potassium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form; and
a minor amount of an alkali metal salt of benzoic acid in dry powder form, mixed with said calcium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium pivalate and said alkali metal salt of benzoic acid, are blended with a major amount of polymeric resin binder material, for binding lignocellulosic-based wood furnish material during composite wood product manufacture, the calcium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form; and
a minor amount of an alkali metal salt of benzoic acid in dry powder form, mixed with said sodium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium pivalate and said alkali metal salt of benzoic acid, are blended with a major amount of polymeric resin binder material, for binding lignocellulosic-based wood furnish material during composite wood product manufacture, the sodium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form; and
a minor amount of an alkali metal salt of benzoic acid in dry powder form, mixed with said magnesium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium pivalate and said alkali metal salt of benzoic acid, are blended with a major amount of polymeric resin binder material, for binding lignocellulosic-based wood furnish material during composite wood product manufacture, the magnesium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium pivalate powder furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form; and
a minor amount of an alkali metal salt of benzoic acid in dry powder form, mixed with said potassium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium caproate and said alkali metal salt of benzoic acid, are blended with a major amount of polymeric resin binder material, for binding lignocellulosic-based wood furnish material during composite wood product manufacture, the potassium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium caproate powder
a minor amount of calcium caproate in dry powder form; and
a minor amount of an alkali metal salt of benzoic acid in dry powder form, mixed with said calcium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium caproate and said alkali metal salt of benzoic acid, are blended with a major amount of polymeric resin binder material, for binding lignocellulosic-based wood furnish material during composite wood product manufacture, the calcium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium caproate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form; and
a minor amount of an alkali metal salt of benzoic acid in dry powder form, mixed with said sodium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium caproate and said alkali metal salt of benzoic acid, are blended with a major amount of polymeric resin binder material, for binding lignocellulosic-based wood furnish material during composite wood product manufacture, the sodium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium caproate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form; and
a minor amount of an alkali metal salt of benzoic acid in dry powder form, mixed with said magnesium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium caproate and said alkali metal salt of benzoic acid, are blended with a major amount of polymeric resin binder material, for binding lignocellulosic-based wood furnish material during composite wood product manufacture, the magnesium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium caproate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form; and
a minor amount of an alkali metal salt of benzoic acid in dry powder form, mixed with said potassium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium adipate and said alkali metal salt of benzoic acid, are blended with a major amount of polymeric resin binder material, for binding lignocellulosic-based wood furnish material during composite wood product manufacture, the potassium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium adipate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form; and
a minor amount of an alkali metal salt of benzoic acid in dry powder form, mixed with said calcium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium adipate and said alkali metal salt of benzoic acid, are blended with a major amount of polymeric resin binder material, for binding lignocellulosic-based wood furnish material during composite wood product manufacture, the calcium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium adipate in dry powder form; and
a minor amount of an alkali metal salt of benzoic acid in dry powder form, mixed with said sodium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium adipate and said alkali metal salt of benzoic acid, are blended with a major amount of polymeric resin binder material, for binding lignocellulosic-based wood furnish material during composite wood product manufacture, the sodium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form; and
a minor amount of an alkali metal salt of benzoic acid in dry powder form, mixed with said magnesium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium adipate and said alkali metal salt of benzoic acid, are blended with a major amount of polymeric resin binder material, for binding lignocellulosic-based wood furnish material during composite wood product manufacture, the magnesium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium adipate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium citrate in dry powder form; and
a minor amount of an alkali metal salt of benzoic acid in dry powder form, mixed with said potassium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium citrate and said alkali metal salt of benzoic acid, are blended with a major amount of polymeric resin binder material, for binding lignocellulosic-based wood furnish material during composite wood product manufacture, the potassium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium citrate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form; and
a minor amount of an alkali metal salt of benzoic acid in dry powder form, mixed with said calcium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium citrate and said alkali metal salt of benzoic acid, are blended with a major amount of polymeric resin binder material, for binding lignocellulosic-based wood furnish material during composite wood product manufacture, the calcium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium citrate in dry powder form; and
a minor amount of an alkali metal salt of benzoic acid in dry powder form, mixed with said sodium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium citrate and said alkali metal salt of benzoic acid, are blended with a major amount of polymeric resin binder material, for binding lignocellulosic-based wood furnish material during composite wood product manufacture, the sodium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form; and
a minor amount of an alkali metal salt of benzoic acid in dry powder form, mixed with said magnesium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium citrate and said alkali metal salt of benzoic acid, are blended with a major amount of polymeric resin binder material, for binding lignocellulosic-based wood furnish material during composite wood product manufacture, the magnesium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium citrate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium gluconate in dry powder form; and
a minor amount of an alkali metal salt of benzoic acid in dry powder form, mixed with said potassium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium gluconate and said alkali metal salt of benzoic acid, are blended with a major amount of polymeric resin binder material, for binding lignocellulosic-based wood furnish material during composite wood product manufacture, the potassium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium gluconate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form; and
a minor amount of an alkali metal salt of benzoic acid in dry powder form, mixed with said calcium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium gluconate and said alkali metal salt of benzoic acid, are blended with a major amount of polymeric resin binder material, for binding lignocellulosic-based wood furnish material during composite wood product manufacture, the calcium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form; and
a minor amount of an alkali metal salt of benzoic acid in dry powder form, mixed with said sodium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium gluconate and said alkali metal salt of benzoic acid, are blended with a major amount of polymeric resin binder material, for binding lignocellulosic-based wood furnish material during composite wood product manufacture, the sodium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium gluconate in dry powder form; and
a minor amount of an alkali metal salt of benzoic acid in dry powder form, mixed with said magnesium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium gluconate and said alkali metal salt of benzoic acid, are blended with a major amount of polymeric resin binder material, for binding lignocellulosic-based wood furnish material during composite wood product manufacture, the magnesium gluconate powder particles are well dispersed within the treated polymeric resin binder material, and after the treated polymeric resin binder lignocellulosic-based wood furnish material, and supporting magnesium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form; and
a minor amount of an alkali metal salt of benzoic acid in dry powder form, mixed with said potassium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium benzoate and said alkali metal salt of benzoic acid, are blended with a major amount of polymeric resin binder material, for binding lignocellulosic-based wood furnish material during composite wood product manufacture, the potassium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium benzoate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form; and
a minor amount of an alkali metal salt of benzoic acid in dry powder form, mixed with said calcium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium benzoate and said alkali metal salt of benzoic acid, are blended with a major amount of polymeric resin binder material, for binding lignocellulosic-based wood furnish material during composite wood product manufacture, the calcium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium benzoate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form; and
a minor amount of an alkali metal salt of benzoic acid in dry powder form, mixed with said sodium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium benzoate and said alkali metal salt of benzoic acid, are blended with a major amount of polymeric resin binder material, for binding lignocellulosic-based wood furnish material during composite wood product manufacture, the sodium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium benzoate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium benzoate in dry powder form; and
a minor amount of an alkali metal salt of benzoic acid in dry powder form, mixed with said magnesium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium benzoate and said alkali metal salt of benzoic acid, are blended with a major amount of polymeric resin binder material, for binding lignocellulosic-based wood furnish material during composite wood product manufacture, the magnesium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium benzoate powder particles that are freely available to inhibit fire ignition, flame spread and smoke development.

Another object of the present invention is to provide a new and improved fire inhibiting pMDI resin binder material used to bind together lignocellulosic-based wood furnish material during the production of fire-protected composite wood products, wherein the fire inhibiting pMDI resin binder material contains alkali metal salts derived from C1 Class of Carboxylic Acids having 1 carbon atom, specifically, the C1 carboxylic acid, called formic acid (i.e. methanoic acid).

Another object of the present invention is to provide a new and improved fire inhibiting pMDI resin binder material for binding together lignocellulosic-based wood furnish material during composite wood product manufacture, comprising:
a minor amount of potassium formate in dry powder form; and
a minor amount of an alkali metal salt of benzoic acid in dry powder form, mixed with said potassium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium formate and said alkali metal salt of benzoic acid, are blended with a major amount of polymeric resin binder material, for binding lignocellulosic-based wood furnish material during composite wood product manufacture, the potassium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium formate powder

Another object of the present invention is to provide a new and improved fire inhibiting pMDI resin binder material for binding together lignocellulosic-based wood furnish material during composite wood product manufacture, comprising:
a minor amount of calcium formate in dry powder form; and
a minor amount of an alkali metal salt of benzoic acid in dry powder form, mixed with said calcium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium formate and said alkali metal salt of benzoic acid, are blended with a major amount of polymeric resin binder material, for binding lignocellulosic-based wood furnish material during composite wood product manufacture, the calcium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium formate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, comprising:
a minor amount of sodium formate in dry powder form; and
a minor amount of an alkali metal salt of benzoic acid in dry powder form, mixed with said sodium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium formate and said alkali metal salt of benzoic acid, are blended with a major amount of polymeric resin binder material, for binding lignocellulosic-based wood furnish material during composite wood product manufacture, the sodium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium formate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, comprising:
a minor amount of magnesium formate in dry powder form; and
a minor amount of an alkali metal salt of benzoic acid in dry powder form, mixed with said magnesium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium formate and said alkali metal salt of benzoic acid, are blended with a major amount of polymeric resin binder material, for binding lignocellulosic-based wood furnish material during composite wood product manufacture, the magnesium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium formate powder

Another object of the present invention is to provide a new and improved fire inhibiting pMDI resin binder material for binding together lignocellulosic-based wood furnish material during composite wood product manufacture, which contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

Another object of the present invention is to provide a new and improved fire inhibiting pMDI resin binder material for binding together lignocellulosic-based wood furnish material during composite wood product manufacture, comprising:
a minor amount of potassium carbonate (bicarbonate) in dry powder form; and
a minor amount of an alkali metal salt of benzoic acid in dry powder form, mixed with said potassium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium carbonate and said alkali metal salt of benzoic acid, are blended with a major amount of polymeric resin binder material, for binding lignocellulosic-based wood furnish material during composite wood product manufacture, the potassium carbonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium carbonate powder

Another object of the present invention is to provide a new and improved fire inhibiting pMDI resin binder material for binding together lignocellulosic-based wood furnish material during composite wood product manufacture, comprising:
a minor amount of sodium carbonate (bicarbonate) in dry powder form; and
a minor amount of an alkali metal salt of benzoic acid in dry powder form, mixed with said sodium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium carbonate and said alkali metal salt of benzoic acid, are blended with a major amount of polymeric resin binder material, for binding lignocellulosic-based wood furnish material during composite wood product manufacture, the sodium carbonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium carbonate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, which contains alkali metal salts derived from C1 Class of Carboxylic Acids having 1 carbon atom, specifically, the C1 carboxylic acid (R—COOH), called acetic acid (i.e. ethanoic acid), CH3CO2H (CAS RN: 64-19-7).

Another object of the present invention is to provide a new and improved fire inhibiting pMDI resin binder material for binding together lignocellulosic-based wood furnish material during composite wood product manufacture, comprising:
a minor amount of potassium acetate in dry powder form; and
a minor amount of an alkali metal salt of benzoic acid in dry powder form, mixed with said potassium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium acetate and said alkali metal salt of benzoic acid, are blended with a major amount of polymeric resin binder material, for binding lignocellulosic-based wood furnish material during composite wood product manufacture, the potassium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium acetate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of calcium acetate in dry powder form; and
a minor amount of an alkali metal salt of benzoic acid in dry powder form, mixed with said calcium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium acetate and said alkali metal salt of benzoic acid, are blended with a major amount of polymeric resin binder material, for binding lignocellulosic-based wood furnish material during composite wood product manufacture, the calcium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium acetate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, comprising:
a minor amount of sodium acetate in dry powder form; and
a minor amount of an alkali metal salt of benzoic acid in dry powder form, mixed with said sodium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium acetate and said alkali metal salt of benzoic acid, are blended with a major amount of polymeric resin binder material, for binding lignocellulosic-based wood furnish material during composite wood product manufacture, the sodium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium acetate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, comprising:
a major amount of magnesium acetate in dry powder form; and
a minor amount of an alkali metal salt of benzoic acid in dry powder form, mixed with said magnesium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium acetate and said alkali metal salt of benzoic acid, are blended with a major amount of polymeric resin binder material, for binding lignocellulosic-based wood furnish material during composite wood product manufacture, the magnesium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium acetate powder particles that are freely available to inhibit fire ignition, flame spread and smoke development.

Another object of the present invention is to provide a new and improved fire inhibiting pMDI resin binder material for binding together lignocellulosic-based wood furnish material during composite wood product manufacture, which contains alkali metal salts derived from C2 Class of Carboxylic Acids having 2 carbon atoms, specifically, the C2 carboxylic acid, called glycolic acid (hydroxyacetic acid).

Another object of the present invention is to provide a new and improved fire inhibiting pMDI resin binder material for binding together lignocellulosic-based wood furnish material during composite wood product manufacture, comprising:
a minor amount of potassium glycolate in dry powder form; and
a minor amount of an alkali metal salt of benzoic acid in dry powder form, mixed with said potassium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glycolate and said alkali metal salt of benzoic acid, are blended with a major amount of polymeric resin binder material, for binding lignocellulosic-based wood furnish material during composite wood product manufacture, the potassium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glycolate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form; and
a minor amount of an alkali metal salt of benzoic acid in dry powder form, mixed with said calcium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glycolate and said alkali metal salt of benzoic acid, are blended with a major amount of polymeric resin binder material, for binding lignocellulosic-based wood furnish material during composite wood product manufacture, the calcium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glycolate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form; and
a minor amount of an alkali metal salt of benzoic acid in dry powder form, mixed with said sodium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycolate and said alkali metal salt of benzoic acid, are blended with a major amount of polymeric resin binder material, for binding lignocellulosic-based wood furnish material during composite wood product manufacture, the sodium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium glycolate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic glyoxylic acid (i.e. oxoacetic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium glyoxylate in dry powder form; and
a minor amount of an alkali metal salt of benzoic acid in dry powder form, mixed with said powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glyoxylate and said alkali metal salt of benzoic acid, are blended with a major amount of polymeric resin binder material, for binding lignocellulosic-based wood furnish material during composite wood product manufacture, the potassium glyoxylate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glyoxylate in dry powder form; and
a minor amount of an alkali metal salt of benzoic acid in dry powder form, mixed with said calcium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glyoxylate and said alkali metal salt of benzoic acid, are blended with a major amount of polymeric resin binder material, for binding lignocellulosic-based wood furnish material during composite wood product manufacture, the calcium glyoxylate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glyoxylate in dry powder form; and
a minor amount of an alkali metal salt of benzoic acid in dry powder form, mixed with said sodium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium glyoxylate and said alkali metal salt of benzoic acid, are blended with a major amount of polymeric resin binder material, for binding lignocellulosic-based wood furnish material during composite wood product manufacture, the sodium glyoxylate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium glyoxylate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein each said dry-powder fire inhibiting composition contains alkali metal salts derived from C2 Class of Carboxylic Acids having 2 carbon atoms, specifically, the C2 carboxylic acid, called oxalic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form; and
a minor amount of an alkali metal salt of benzoic acid in dry powder form, mixed with said potassium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium oxalate and said alkali metal salt of benzoic acid, are blended with a major amount of polymeric resin binder material, for binding lignocellulosic-based wood furnish material during composite wood product manufacture, the potassium oxalate powder particles are well dispersed within the lignocellulosic-based wood furnish material, and supporting potassium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of calcium oxalate in dry powder form; and
a minor amount of an alkali metal salt of benzoic acid in dry powder form, mixed with said calcium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium oxalate and said alkali metal salt of benzoic acid, are blended with a major amount of polymeric resin binder material, for binding lignocellulosic-based wood furnish material during composite wood product manufacture, the calcium oxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium oxalate in dry powder form; and
a minor amount of an alkali metal salt of benzoic acid in dry powder form, mixed with said sodium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxalate and said alkali metal salt of benzoic acid, are blended with a major amount of polymeric resin binder material, for binding lignocellulosic-based wood furnish material during composite wood product manufacture, the sodium oxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium oxalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H60 (CAS RN: 79-09-04):

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium propionate in dry powder form; and
a minor amount of an alkali metal salt of benzoic acid in dry powder form, mixed with said potassium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium propionate and said alkali metal salt of benzoic acid, are blended with a major amount of polymeric resin binder material, for binding lignocellulosic-based wood furnish material during composite wood product manufacture, the potassium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form; and
a minor amount of an alkali metal salt of benzoic acid in dry powder form, mixed with said calcium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium propionate and said alkali metal salt of benzoic acid, are blended with a major amount of polymeric resin binder material, for binding lignocellulosic-based wood furnish material during composite wood product manufacture, the calcium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form; and
a minor amount of an alkali metal salt of benzoic acid in dry powder form, mixed with said sodium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium propionate and said alkali metal salt of benzoic acid, are blended with a major amount of polymeric resin binder material, for binding lignocellulosic-based wood furnish material during composite wood product manufacture, the sodium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium propionate powder
a minor amount of magnesium propionate in dry powder form; and
a minor amount of an alkali metal salt of benzoic acid in dry powder form, mixed with said magnesium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium propionate and said alkali metal salt of benzoic acid, are blended with a major amount of polymeric resin binder material, for binding lignocellulosic-based wood furnish material during composite wood product manufacture, the magnesium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium propionate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form; and
a minor amount of an alkali metal salt of benzoic acid in dry powder form, mixed with said potassium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium lactate and said alkali metal salt of benzoic acid, are blended with a major amount of polymeric resin binder material, for binding lignocellulosic-based wood furnish material during composite wood product manufacture, the potassium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of calcium lactate in dry powder form; and
a minor amount of an alkali metal salt of benzoic acid in dry powder form, mixed with said calcium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium lactate and said alkali metal salt of benzoic acid, are blended with a major amount of polymeric resin binder material, for binding lignocellulosic-based wood furnish material during composite wood product manufacture, the calcium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of sodium lactate in dry powder form; and
a minor amount of an alkali metal salt of benzoic acid in dry powder form, mixed with said sodium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium lactate and said alkali metal salt of benzoic acid, are blended with a major amount of polymeric resin binder material, for binding lignocellulosic-based wood furnish material during composite wood product manufacture, the sodium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium lactate powder particles that are freely available to inhibit fire ignition, flame spread and smoke development. furnish material during composite wood product manufacture, comprising:
a minor amount of magnesium lactate in dry powder form; and
a minor amount of an alkali metal salt of benzoic acid in dry powder form, mixed with said magnesium powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium lactate and said alkali metal salt of benzoic acid, are blended with a major amount of polymeric resin binder material, for binding lignocellulosic-based wood furnish material during composite wood product manufacture, the magnesium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium lactate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).
a minor amount of potassium glycerate in dry powder form; and
a minor amount of an alkali metal salt of benzoic acid in dry powder form, mixed with said potassium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glycerate and said alkali metal salt of benzoic acid, are blended with a major amount of polymeric resin binder material, for binding lignocellulosic-based wood furnish material during composite wood product manufacture, the potassium glycerate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glycerate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form; and
a minor amount of an alkali metal salt of benzoic acid in dry powder form, mixed with said calcium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glycerate and said alkali metal salt of benzoic acid, are blended with a major amount of polymeric resin binder material, for binding lignocellulosic-based wood furnish material during composite wood product manufacture, the calcium glycerate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glycerate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium glycerate in dry powder form; and
a minor amount of an alkali metal salt of benzoic acid in dry powder form, mixed with said sodium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycerate and said alkali metal salt of benzoic acid, are blended with a major amount of polymeric resin binder material, for binding lignocellulosic-based wood furnish material during composite wood product manufacture, the sodium glycerate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium glycerate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form; and
a minor amount of an alkali metal salt of benzoic acid in dry powder form, mixed with said potassium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium pyruvate and said alkali metal salt of benzoic acid, are blended with a major amount of polymeric resin binder material, for binding lignocellulosic-based wood furnish material during composite wood product manufacture, the potassium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pyruvate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form; and
a minor amount of an alkali metal salt of benzoic acid in dry powder form, mixed with said calcium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium pyruvate and said alkali metal salt of benzoic acid, are blended with a major amount of polymeric resin binder material, for binding lignocellulosic-based wood furnish material during composite wood product manufacture, the calcium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of sodium pyruvate in dry powder form; and
a minor amount of an alkali metal salt of benzoic acid in dry powder form, mixed with said pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium pyruvate and said alkali metal salt of benzoic acid, are blended with a major amount of polymeric resin binder material, for binding lignocellulosic-based wood furnish material during composite wood product manufacture, the sodium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form; and
a minor amount of an alkali metal salt of benzoic acid in dry powder form, mixed with said magnesium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium pyruvate and said alkali metal salt of benzoic acid, are blended with a major amount of polymeric resin binder material, for binding lignocellulosic-based wood furnish material during composite wood product manufacture, the magnesium pyruvate powder particles are well dispersed within the treated polymeric resin binder material, and after the treated polymeric resin binder lignocellulosic-based wood furnish material, and supporting magnesium pyruvate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium tartrate in dry powder form; and
a minor amount of an alkali metal salt of benzoic acid in dry powder form, mixed with said potassium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium tartrate and said alkali metal salt of benzoic acid, are blended with a major amount of polymeric resin binder material, for binding lignocellulosic-based wood furnish material during composite wood product manufacture, the potassium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium tartrate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form; and
a minor amount of an alkali metal salt of benzoic acid in dry powder form, mixed with said calcium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium tartrate and said alkali metal salt of benzoic acid, are blended with a major amount of polymeric resin binder material, for binding lignocellulosic-based wood furnish material during composite wood product manufacture, the calcium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form; and
a minor amount of an alkali metal salt of benzoic acid in dry powder form, mixed with said sodium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium tartrate and said alkali metal salt of benzoic acid, are blended with a major amount of polymeric resin binder material, for binding lignocellulosic-based wood furnish material during composite wood product manufacture, the sodium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form; and
a minor amount of an alkali metal salt of benzoic acid in dry powder form, mixed with said magnesium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium tartrate and said alkali metal salt of benzoic acid, are blended with a major amount of polymeric resin binder material, for binding lignocellulosic-based wood furnish material during composite wood product manufacture, the magnesium tartrate powder particles are well dispersed within the treated polymeric resin binder material, and after the treated polymeric resin binder lignocellulosic-based wood furnish material, and supporting magnesium tartrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form; and
a minor amount of an alkali metal salt of benzoic acid in dry powder form, mixed with said potassium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium butyrate and said alkali metal salt of benzoic acid, are blended with a major amount of polymeric resin binder material, for binding lignocellulosic-based wood furnish material during composite wood product manufacture, the potassium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium butyrate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form; and
a minor amount of an alkali metal salt of benzoic acid in dry powder form, mixed with said calcium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium butyrate and said alkali metal salt of benzoic acid, are blended with a major amount of polymeric resin binder material, for binding lignocellulosic-based wood furnish material during composite wood product manufacture, the calcium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium butyrate in dry powder form; and
a minor amount of an alkali metal salt of benzoic acid in dry powder form, mixed with said sodium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium butyrate and said alkali metal salt of benzoic acid, are blended with a major amount of polymeric resin binder material, for binding lignocellulosic-based wood furnish material during composite wood product manufacture, the sodium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form; and
a minor amount of an alkali metal salt of benzoic acid in dry powder form, mixed with said magnesium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium butyrate and said alkali metal salt of benzoic acid, are blended with a major amount of polymeric resin binder material, for binding lignocellulosic-based wood furnish material during composite wood product manufacture, the magnesium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium butyrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic, called malic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium malate in dry powder form; and
a minor amount of an alkali metal salt of benzoic acid in dry powder form, mixed with said potassium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium malate and said alkali metal salt of benzoic acid, are blended with a major amount of polymeric resin binder material, for binding lignocellulosic-based wood furnish material during composite wood product manufacture, the potassium malate powder particles are well dispersed within the lignocellulosic-based wood furnish material, and supporting potassium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form; and
a minor amount of an alkali metal salt of benzoic acid in dry powder form, mixed with said calcium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium malate and said alkali metal salt of benzoic acid, are blended with a major amount of polymeric resin binder material, for binding lignocellulosic-based wood furnish material during composite wood product manufacture, the calcium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form; and
a minor amount of an alkali metal salt of benzoic acid in dry powder form, mixed with said sodium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium malate and said alkali metal salt of benzoic acid, are blended with a major amount of polymeric resin binder material, for binding lignocellulosic-based wood furnish material during composite wood product manufacture, the sodium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium malate in dry powder form; and
a minor amount of an alkali metal salt of benzoic acid in dry powder form, mixed with said magnesium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium malate and said alkali metal salt of benzoic acid, are blended with a major amount of polymeric resin binder material, for binding lignocellulosic-based wood furnish material during composite wood product manufacture, the magnesium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called malonic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form; and
a minor amount of an alkali metal salt of benzoic acid in dry powder form, mixed with said potassium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium malonate and said alkali metal salt of benzoic acid, are blended with a major amount of polymeric resin binder material, for binding lignocellulosic-based wood furnish material during composite wood product manufacture, the potassium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium malonate in dry powder form; and
a minor amount of an alkali metal salt of benzoic acid in dry powder form, mixed with said calcium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium malonate and said alkali metal salt of benzoic acid, are blended with a major amount of polymeric resin binder material, for binding lignocellulosic-based wood furnish material during composite wood product manufacture, the calcium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malonate powder
a minor amount of sodium malonate in dry powder form; and
a minor amount of an alkali metal salt of benzoic acid in dry powder form, mixed with said sodium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium malonate and said alkali metal salt of benzoic acid, are blended with a major amount of polymeric resin binder material, for binding lignocellulosic-based wood furnish material during composite wood product manufacture, the sodium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of dimagnesium malonate in dry powder form; and
a minor amount of an alkali metal salt of benzoic acid in dry powder form, mixed with said dimagnesium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said dimagnesium malonate and said alkali metal salt of benzoic acid, are blended with a major amount of polymeric resin binder material, for binding lignocellulosic-based wood furnish material during composite wood product manufacture, the dimagnesium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting dimagnesium malonate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form; and
a minor amount of an alkali metal salt of benzoic acid in dry powder form, mixed with said potassium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium pivalate and said alkali metal salt of benzoic acid, are blended with a major amount of polymeric resin binder material, for binding lignocellulosic-based wood furnish material during composite wood product manufacture, the potassium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form; and
a minor amount of an alkali metal salt of benzoic acid in dry powder form, mixed with said calcium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium pivalate and said alkali metal salt of benzoic acid, are blended with a major amount of polymeric resin binder material, for binding lignocellulosic-based wood furnish material during composite wood product manufacture, the calcium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium pivalate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form; and
a minor amount of an alkali metal salt of benzoic acid in dry powder form, mixed with said sodium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium pivalate and said alkali metal salt of benzoic acid, are blended with a major amount of polymeric resin binder material, for binding lignocellulosic-based wood furnish material during composite wood product manufacture, the sodium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form; and
a minor amount of an alkali metal salt of benzoic acid in dry powder form, mixed with said magnesium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium pivalate and said alkali metal salt of benzoic acid, are blended with a major amount of polymeric resin binder material, for binding lignocellulosic-based wood furnish material during composite wood product manufacture, the magnesium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium pivalate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form; and
a minor amount of an alkali metal salt of benzoic acid in dry powder form, mixed with said potassium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium caproate and said alkali metal salt of benzoic acid, are blended with a major amount of polymeric resin binder material, for binding lignocellulosic-based wood furnish material during composite wood product manufacture, the potassium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium caproate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium caproate in dry powder form; and
a minor amount of an alkali metal salt of benzoic acid in dry powder form, mixed with said calcium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium caproate and said alkali metal salt of benzoic acid, are blended with a major amount of polymeric resin binder material, for binding lignocellulosic-based wood furnish material during composite wood product manufacture, the calcium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium caproate powder

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form; and
a minor amount of an alkali metal salt of benzoic acid in dry powder form, mixed with said sodium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium caproate and said alkali metal salt of benzoic acid, are blended with a major amount of polymeric resin binder material, for binding lignocellulosic-based wood furnish material during composite wood product manufacture, the sodium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium caproate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form; and
a minor amount of an alkali metal salt of benzoic acid in dry powder form, mixed with said magnesium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium caproate and said alkali metal salt of benzoic acid, are blended with a major amount of polymeric resin binder material, for binding lignocellulosic-based wood furnish material during composite wood product manufacture, the magnesium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium caproate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form; and
a minor amount of an alkali metal salt of benzoic acid in dry powder form, mixed with said potassium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium adipate and said alkali metal salt of benzoic acid, are blended with a major amount of polymeric resin binder material, for binding lignocellulosic-based wood furnish material during composite wood product manufacture, the potassium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form; and
a minor amount of an alkali metal salt of benzoic acid in dry powder form, mixed with said calcium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium adipate and said alkali metal salt of benzoic acid, are blended with a major amount of polymeric resin binder material, for binding lignocellulosic-based wood furnish material during composite wood product manufacture, the calcium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium adipate in dry powder form; and
a minor amount of an alkali metal salt of benzoic acid in dry powder form, mixed with said sodium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium adipate and said alkali metal salt of benzoic acid, are blended with a major amount of polymeric resin binder material, for binding lignocellulosic-based wood furnish material during composite wood product manufacture, the sodium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form; and
a minor amount of an alkali metal salt of benzoic acid in dry powder form, mixed with said magnesium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium adipate and said alkali metal salt of benzoic acid, are blended with a major amount of polymeric resin binder material, for binding lignocellulosic-based wood furnish material during composite wood product manufacture, the magnesium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium adipate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium citrate in dry powder form; and
a minor amount of an alkali metal salt of benzoic acid in dry powder form, mixed with said potassium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium citrate and said alkali metal salt of benzoic acid, are blended with a major amount of polymeric resin binder material, for binding lignocellulosic-based wood furnish material during composite wood product manufacture, the potassium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form; and
a minor amount of an alkali metal salt of benzoic acid in dry powder form, mixed with said calcium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium citrate and said alkali metal salt of benzoic acid, are blended with a major amount of polymeric resin binder material, for binding lignocellulosic-based wood furnish material during composite wood product manufacture, the calcium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium citrate in dry powder form; and
a minor amount of an alkali metal salt of benzoic acid in dry powder form, mixed with said sodium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium citrate and said alkali metal salt of benzoic acid, are blended with a major amount of polymeric resin binder material, for binding lignocellulosic-based wood furnish material during composite wood product manufacture, the sodium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form; and
a minor amount of an alkali metal salt of benzoic acid in dry powder form, mixed with said magnesium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium citrate and said alkali metal salt of benzoic acid, are blended with a major amount of polymeric resin binder material, for binding lignocellulosic-based wood furnish material during composite wood product manufacture, the magnesium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium citrate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a major amount of potassium gluconate in dry powder form;
a minor amount of an alkali metal salt of benzoic acid in dry powder form, mixed with said potassium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium gluconate and said alkali metal salt of benzoic acid, are blended with a major amount of polymeric resin binder material, for binding lignocellulosic-based wood furnish material during composite wood product manufacture, the potassium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form;
a minor amount of an alkali metal salt of benzoic acid in dry powder form, mixed with said calcium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium gluconate and said alkali metal salt of benzoic acid, are blended with a major amount of polymeric resin binder material, for binding lignocellulosic-based wood furnish material during composite wood product manufacture, the calcium gluconate powder particles are well dispersed within the lignocellulosic-based wood furnish material, and supporting calcium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form;
a minor amount of an alkali metal salt of benzoic acid in dry powder form, mixed with said sodium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium gluconate and said alkali metal salt of benzoic acid, are blended with a major amount of polymeric resin binder material, for binding lignocellulosic-based wood furnish material during composite wood product manufacture, the sodium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of magnesium gluconate in dry powder form;
a minor amount of an alkali metal salt of benzoic acid in dry powder form, mixed with said magnesium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium gluconate and said alkali metal salt of benzoic acid, are blended with a major amount of polymeric resin binder material, for binding lignocellulosic-based wood furnish material during composite wood product manufacture, the magnesium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium gluconate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form;
a minor amount of an alkali metal salt of benzoic acid in dry powder form, mixed with said potassium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium benzoate and said alkali metal salt of benzoic acid, are blended with a major amount of polymeric resin binder material, for binding lignocellulosic-based wood furnish material during composite wood product manufacture, the potassium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium benzoate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form;
a minor amount of an alkali metal salt of benzoic acid in dry powder form, mixed with said calcium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium benzoate and said alkali metal salt of benzoic acid, are blended with a major amount of polymeric resin binder material, for binding lignocellulosic-based wood furnish material during composite wood product manufacture, the calcium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium benzoate powder particles that are freely available to inhibit fire ignition, flame spread and smoke development.

Another object of the present invention is to provide a new and improved environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form;
a minor amount of an alkali metal salt of benzoic acid in dry powder form, mixed with said sodium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium benzoate and said alkali metal salt of benzoic acid, are blended with a major amount of polymeric resin binder material, for binding lignocellulosic-based wood furnish material during composite wood product manufacture, the sodium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium benzoate powder furnish material during composite wood product manufacture, comprising:
a minor amount of magnesium benzoate in dry powder form;
a minor amount of an alkali metal salt of benzoic acid in dry powder form, mixed with said magnesium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium benzoate and said alkali metal salt of benzoic acid, are blended with a major amount of polymeric resin binder material, for binding lignocellulosic-based wood furnish material during composite wood product manufacture, the magnesium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium benzoate powder particles that are freely available to inhibit fire ignition, flame spread and smoke development.

Another object of the present invention is to provide a new and improved environmentally-clean aqueous-based fire inhibiting biochemical composition for treating lignocellulosic-based wood furnish material used during the production of composite wood products to be protected against fire ignition, comprising: (a) a dispersing agent realized in the form of a quantity of water, for dispersing alkali metal ions dissolved in water; (b) a fire inhibiting agent in the form of at least one alkali metal salt of a nonpolymeric saturated carboxylic acid, for providing metal ions dispersed in the water when the at least one alkali metal salt is dissolved in the water; and (c) a dispersing and coalescing agent in the form of an organic compound containing three carboxylic acid groups (or salt/ester derivatives thereof), such as triethyl citrate, an ester of citric acid, for dispersing and coalescing the metal ions when the fire inhibiting liquid composition is applied to lignocellulosic-based wood furnish surfaces during the production of composite wood products, while water molecules in the water evaporate during drying, and the alkali metal ions cooperate to form an alkali metal salt crystalline structure on the lignocellulosic-based wood furnish surfaces.

Another object of the present invention is to provide a new and improved environmentally-clean aqueous-based fire inhibiting biochemical composition for treating lignocellulosic-based wood furnish material used during the production of composite wood products to be protected against fire ignition, flame spread and smoke production, wherein the composite wood products are products selected from the group consisting of: oriented strand board (OSB) panels produced from long, slender strands that are aligned crosswise for a higher flexural strength than particleboard; oriented strands longer (OSL) panels with strands up to two times longer than for classic OSB are used for the production of OSL; Container OSB with a high-density, low-cost OSB core; Fine Surface OSB panels, wherein a OSB core layer is coated on both sides with a particleboard surface layer; and OSB panel with advanced core layer.

Another object of the present invention is to provide a new and improved environmentally-clean biochemical wood treatment composition (i.e. solution) for treating lignocellulosic-based (wood) furnish material, as well as solid wood materials such as lumber, during the manufacture of solid, composite and/or engineering wood based products used in the building, construction and/or home improvement industry, so as to provide fire inhibiting or fire resistant performance characteristics, comprising (i) a major amount of water, (ii) a major amount of metal alkali salt dissolved in the water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, (iii) a minor amount of alkali metal salt derived from of benzoic acid, wherein the alkali metal is selected from group consisting of potassium, sodium, calcium and magnesium, (iv) a minor amount of one or more esters derived from the saturated non-polymerized carboxylic acid and/or another saturated non-polymerized carboxylic acid, promoting dispersing and/or coalescing properties of metal alkali ions in the aqueous solution and formation of alkali metal salt crystalline structures and/or coatings on and/or within combustible materials upon the evaporation of water molecules from applied aqueous solution, and esterification of the lignocellulosic material being treated, and (iv) minor amount of metal salt derived from carboxylic acid for inhibiting metal corrosion, mold and microbial life.

Another object of the present invention is to provide a new and improved environmentally-clean biochemical wood treatment composition (i.e. solution) for treating lignocellulosic-based (wood) furnish material, as well as solid wood materials such as lumber, during the manufacture of solid, composite and/or engineering wood based products used in the building, construction and/or home improvement industry, so as to provide fire inhibiting or fire resistant performance characteristics, comprising (i) a major amount of water, (ii) a major amount of metal alkali salt dissolved in the water, and derived from a saturated non-polymerized carboxylic acid, wherein the carbon chain length of the carboxylic acid is C=6 (C6), and the resulting water-based liquid solution is stable when mixed so that its chemical components do not precipitate in the aqueous solution when stored in a storage container, (iii) a minor amount of alkali metal salt derived from of benzoic acid, wherein the alkali metal is selected from group consisting of potassium, sodium, calcium and magnesium, specifically potassium benzoate (SB), (iv) a minor amount of one or more esters derived from the saturated non-polymerized carboxylic acid and/or another saturated non-polymerized carboxylic acid, specifically triethyl citrate (TEC), promoting dispersing and/or coalescing properties of metal alkali ions in the aqueous solution and formation of alkali metal salt crystalline structures and/or coatings on or within combustible materials upon the evaporation of water molecules from applied aqueous solution, and esterification of the lignocellulosic material being treated, and (iv) minor amount of metal salt derived from carboxylic acid for inhibiting metal corrosion, mold and/or microbial life.

Another object of the present invention is to provide new and improved dry powder biochemical wood treatment compositions, for treating lignocellulosic material (i.e. wood furnish material) during factory-based wood product manufacture, and consisting of major amounts of dry tripotassium citrate monohydrate (TPC), minor amounts of triethyl citrate (TEC), and minor amounts of potassium benzoate, with these components prepared and ready for mixing with a predetermined quantity of polymeric resin in an uncured liquid state during wood furnish resination operations, to make up a fire inhibiting polymeric resin composition for use in mixing with and binding together lignocellulosic (wood) furnish material that is molded into wood products and subject to pressure and heat energy to cure the fire inhibiting polymeric resin composition and produce fire-protected finished wood products.

Another object of the present invention is to provide an environmentally-clean aqueous-based liquid biochemical wood treatment composition derived from the C1-Class of saturated non-polymerized carboxylic acid called formic acid, consisting of (i) a major amount of potassium formate, (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based liquid biochemical wood treatment composition derived from the C1-Class of saturated non-polymerized carboxylic acid called formic acid, consisting of (i) major amounts of calcium formate, and (ii) a minor amount of methyl formate or triethyl citrate (TEC) formulated with and dissolved in (iii) a major amount of water functioning as a solvent, carrier and dispersant to produce an environmentally-clean aqueous-based fire biochemical wood treatment solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material;

Another object of the present invention is to provide an environmentally-clean aqueous-based liquid biochemical wood treatment composition derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based liquid biochemical wood treatment composition derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based liquid biochemical wood treating composition derived from the C1-Class of saturated non-polymerized carboxylic acid called carbonic acid, consisting of (i) a major amount of potassium carbonate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C1-Class of saturated non-polymerized carboxylic acid called carbonic acid, consisting of (i) a major amount of sodium (bi) carbonate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called acetic acid, consisting of (i) a major amount of potassium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called acetic acid, consisting of (i) a major amount of calcium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called acetic acid, consisting of (i) a major amount of sodium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C12-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called acetic acid, consisting of (i) a major amount of magnesium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called glycolic acid, consisting of (i) a major amount of potassium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called glycolic acid, consisting of (i) a major amount of calcium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called glycolic acid, consisting of (i) a major amount of sodium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called glyoxylic acid, consisting of (i) a major amount of potassium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called glyoxylic acid, consisting of (i) a major amount of calcium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide of an environmentally-clean aqueous-based biochemical wood treatment composition derived from the C2-Class of saturated non-polymerized carboxylic acid called glyoxylic acid, consisting of (i) a major amount of sodium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called oxalic acid, consisting of (i) a major amount of potassium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called oxalic acid, consisting of (i) a major amount of calcium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C2-Class of saturated non-polymerized carboxylic acid called oxalic acid, consisting of (i) a major amount of sodium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called propionic acid, consisting of (i) a major amount of potassium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called propionic acid, consisting of (i) a major amount of calcium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

F Another object of the present invention is to provide an environmentally-clean aqueous-based fire inhibiting liquid biochemical composition derived from the C3-Class of saturated non-polymerized carboxylic acid called propionic acid, consisting of (i) a major amount of sodium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called propionic acid, consisting of (i) a major amount of magnesium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called lactic acid, consisting of (i) a major amount of potassium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called lactic acid, consisting of (i) a major amount of calcium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called lactic acid, consisting of (i) a major amount of sodium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called lactic acid, consisting of (i) a major amount of magnesium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of fasteners, and decomposition of wood material.

Another object of the present invention is to provide an environmentally-clean aqueous-based biochemical wood treatment composition derived from the C3-Class of saturated non-polymerized carboxylic acid called glyceric acid, consisting of (i) a major amount of potassium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called glyceric acid, consisting of (i) a major amount of calcium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called glyceric acid, consisting of (i) a major amount of sodium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide environmentally-clean aqueous-based biochemical wood treatment composition derived from the C3-Class of saturated non-polymerized carboxylic acid called pyruvic acid, consisting of (i) a major amount of potassium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called pyruvic acid, consisting of (i) a major amount of calcium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called pyruvic acid, consisting of (i) a major amount of sodium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called pyruvic acid, consisting of (i) a major amount of magnesium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called tartaric acid, consisting of (i) a major amount of potassium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called tartaric acid, consisting of (i) a major amount of calcium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called tartaric acid, consisting of (i) a major amount of sodium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C3-Class of saturated non-polymerized carboxylic acid called tartaric acid, consisting of (i) a major amount of magnesium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called butyric acid, consisting of (i) a major amount of potassium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called butyric acid, consisting of (i) a major amount of calcium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called butyric acid, consisting of (i) a major amount of sodium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide environmentally-clean aqueous-based biochemical wood treatment composition derived from the C4-Class of saturated non-polymerized carboxylic acid called butyric acid, consisting of (i) a major amount of magnesium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malic acid, consisting of (i) a major amount of potassium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malic acid, consisting of (i) a major amount of calcium maleate, and (ii) a minor amount of diethyl maleate or triethyl citrate

(TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malic acid, consisting of (i) a major amount of sodium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malic acid, consisting of (i) a major amount of magnesium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malonic acid, consisting of (i) a major amount of potassium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malonic acid, consisting of (i) a major amount of calcium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide environmentally-clean aqueous-based biochemical wood treatment composition derived from the C4-Class of saturated non-polymerized carboxylic acid called malonic acid, consisting of (i) a major amount of sodium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C4-Class of saturated non-polymerized carboxylic acid called malonic acid, consisting of (i) a major amount of magnesium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C5-Class of saturated non-polymerized carboxylic acid called pivalic acid, consisting of (i) a major amount of potassium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C5-Class of saturated non-polymerized carboxylic acid called pivalic acid, consisting of (i) a major amount of calcium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C5-Class of saturated non-polymerized carboxylic acid called pivalic acid, consisting of (i) a major amount of sodium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of fasteners, and decomposition of wood material.

Another object of the present invention is to provide an environmentally-clean aqueous-based biochemical wood treatment composition derived from the C5-Class of saturated non-polymerized carboxylic acid called pivalic acid, consisting of (i) a major amount of magnesium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called caproic acid, consisting of (i) a major amount of potassium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called caproic acid, consisting of (i) a major amount of calcium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical composition derived from the C6-Class of saturated non-polymerized carboxylic acid called caproic acid, consisting of (i) a major amount of sodium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called caproic acid, consisting of (i) a major amount of magnesium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based wood treatment biochemical solution based on the C6-class of carboxylic acid-called caproic acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical composition derived from the C6-Class of saturated non-polymerized carboxylic acid called caproic acid, consisting of (i) a major amount of potassium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical composition derived from the C6-Class of saturated non-polymerized carboxylic acid called caproic acid, consisting of (i) a major amount of calcium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called caproic acid, consisting of (i) a major amount of sodium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called caproic acid, consisting of (i) a major amount of magnesium adipic, and (ii) a minor amount of dimethyl adipate or triethyl citrate

(TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical composition derived from the C6-Class of saturated non-polymerized carboxylic acid called citric acid, consisting of (i) a major amount of tripotassium citrate (TPC), and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called citric acid, consisting of (i) a major amount of calcium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called citric acid, consisting of (i) a major amount of sodium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called citric acid, consisting of (i) a major amount of magnesium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called d-gluconic acid, consisting of (i) a major amount of potassium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called d-gluconic acid, consisting of (i) a major amount of calcium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called d-gluconic acid, consisting of (i) a major amount of sodium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical composition derived from the C6-Class of saturated non-polymerized carboxylic acid called d-gluconic acid, consisting of (i) a major amount of magnesium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called benzoic acid, consisting of (i) a major amount of potassium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called benzoic acid, consisting of (i) a major amount of calcium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called benzoic acid, consisting of (i) a major amount of sodium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide an environmentally-clean aqueous-based biochemical wood treatment composition derived from the C6-Class of saturated non-polymerized carboxylic acid called benzoic acid, consisting of (i) a major amount of magnesium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

Another object of the present invention is to provide a new and improved pMDI resin binder blends formulated for use in producing different types of composite wood products.

Another object of the present invention is to provide new and improved fire-inhibiting pMDI-type resin binders, such as standard polymeric resin, fast cure MDI resin, enhanced fast cure MDI resin and emulsifiable fast cure resin, for use in producing different types of composite wood products selected from the group consisting of oriented strand board (OSB), and medium density fiberboard (MDF).

Another object of the present invention is to provide a new and improved fire-inhibiting pMDI-type resin binders, namely standard polymeric resin, fast cure MDI resin, enhanced fast cure MDI resin and emulsifiable fast cure resin, and for use in producing different types of composite wood products according to the present invention, namely (iii) particleboard (PB), and (iv) wood fiber insulation fiberboard (WFI).

Another object of the present invention is to provide a new and improved (surface-treatment) method of producing treated wood products with fire, metal-corrosion, mold and moisture protection according to the present invention, comprising the steps of (a) producing or procuring a supply of environmentally clean wood treatment composition for use in treating wood (i.e. lignocellulosic) material in treated wood products to provide fire, metal-corrosion, mold and moisture protection, wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical wood treatment composition over the exterior surfaces of the wood products to be treated with class-a fire and metal-corrosion protection, (c) allowing water molecules in the applied environmentally-clean biochemical wood treatment composition to evaporate to the environment and Class-A fire and metal-corrosion inhibiting coatings to form over the treated wood surfaces, and (d) applying a polymeric-based mold inhibiting and moisture protecting coating(s) over the Class-A fire-protected, metal-corrosion and mold/mildew inhibiting wood surfaces of the treated wood products.

Another object of the present invention is to provide a new and improved method of producing composite wood products with fire, metal-corrosion, mold and moisture protection according to the present invention, comprising the steps of (a) producing or procuring a supply of environmentally-clean biochemical wood treatment composition for use in treating wood (i.e. lignocellulosic) furnish material to produce composite wood products having fire, metal-corrosion, mold and moisture protection, wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical wood treatment composition to wood furnish material prior to or during the manufacturing of composite wood components so that fire, metal-corrosion and mold protection is provided within and over the exterior surfaces of the wood furnish material during manufacture, (c) adding biochemical additives, also selected from the group consisting of metal alkali carboxylic acid salt based biochemicals, to a polymeric resin compound so as to produce an enhanced polymeric resin, then applying the same to wood furnish material, and molding a composite wood product under pressure and curing the polymeric resin during molding and compression operations so as to provide the molded composite wood product with fire, metal-corrosion and mold protection throughout composite wood products, and (d) applying a polymeric-based (mold inhibiting and) moisture protective coating over the exterior wood surfaces of the Class-A fire protected wood products.

Another object of the present invention is to provide a new and improved method of producing treated engineered wood products (EWPs) with fire, metal-corrosion, mold and moisture protection according to the present invention, comprising the steps of (a) producing or procuring a supply of environmentally-clean liquid biochemical wood treatment solution for use in treating wood furnish used in engineered wood products (EWPs), wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical liquid wood treatment solution to (i.e. wood/lignocellulosic) material prior to or during the manufacturing of the engineered wood product to produce treated wood furnish material that is protected against fire, metal corrosion and mold/mildew, (c) during manufacture of the EWP, binding the treated wood material using a polymeric resin compound infused with fire and metal-corrosion inhibiting biochemicals for producing an engineered wood product (EWP) provided with fire protection, metal-corrosion and mold/mildew protection throughout the corpus of the EWP, and (d) applying a polymeric-based (mold-inhibiting and) moisture-protecting coating over the treated wood surfaces of the fire protected EWP.

Another object of the present invention is to provide a new and improved fire-protected finger-jointed lumber products produced along a production line in an automated fire-treated lumber factory using the methods of and environmentally-clean wood treatment compositions of the present invention.

Another object of the present invention is to provide a new and improved automated lumber factory supporting an automated process for continuously fabricating Class-A fire-protected finger-jointed lumber products which, after the planning and dimensioning stage, are automatically treated by coating the products in a bath or reservoir of environmentally-clean fire inhibiting biochemical liquid of the present invention, and then automatically packaged, stack-dried and wrapped in a high-speed and economical manner.

Another object of the present invention is to provide a new and improved method of producing Class-A fire-protected finger-jointed lumber pieces (e.g. studs or beams) in an automated fire-treated lumber factory.

Another object of the present invention is to provide a new and improved automated lumber fabrication factory supporting an automated process for continuously fabricating cross-laminated timber (CLT) products which, after the planning and dimensioning stage, are automatically dip-coated in a bath of clean fire inhibiting chemical (CFIC) liquid, and then stacked, packaged, and wrapped in a high-speed manner to produce Class-A fire-protected CLT products.

Another object of the present invention is to provide a new and improved method of producing Class-A fire-protected cross-laminated timber (CLT) products in an automated fire-treated lumber factory.

Another object of the present invention is to provide a new and improved fire-protected laminated veneer lumber (LVL) product produced using environmentally-clean biochemicals and methods.

Another object of the present invention is to provide a new and improved automated factory configured for producing Class-A fire-protected laminated veneer lumber (LVL) products.

Another object of the present invention is to provide a new and improved method of producing Class-A fire-protected laminated veneer lumber (VLV) products in an automated fire-treated lumber factory.

Another object of the present invention is to provide a new and improved Class-A fire-protected oriented strand board (OSB) sheathing produced using a method and process supported by an automated factory.

Another object of the present invention is to provide a new and improved process for producing Class-A fire protected OSB panels.

Another object of the present invention is to provide a new and improved automated OSB panel fabrication factory, wherein the stages of manufacture are performed along a multi-stage fabrication process, including the treatment of wood furnish materials (e.g. wood strands) and resin adhesives (e.g. pDMI resin binders) used during the manufacturing process.

Another object of the present invention is to provide a new and improved drum-based wood strand spray treatment stage employed in an OSB panel production line, wherein wood furnish is being fed into the input handler of the strand spraying drum stage and being sprayed with environmentally-clean biochemicals using atomizing spray nozzles arranged therein, as the wood furnish materials therethrough under control system control.

Another object of the present invention is to provide a new and improved resin and biochemical mixer/blender (i.e. resonator) stage employed in an OSB panel production line, wherein precisely metered amounts of liquid pMDI resin and environmentally-clean biochemicals (including liquified waxes) are fed into the mixer/blender to produce a resin/additive emulsion that is sprayed over wood furnish materials flowing through the treatment drum using spray atomizing nozzles under precise temperature control so as to uniformly cover the surfaces of the wood furnish material (i.e. strands) so the biochemicals can infuse into and biochemically treat the biochemical structures within each strand to impart specified properties and characteristics thereto (i.e. inhibition to/protection against fire, mold, mildew an moisture).

Another object of the present invention is to provide a new and improved precision release agent and surface moisture spraying system/stage employed in an OSB panel production line, wherein precisely metered amounts of release agent and water are sprayed onto the layered mat of wood furnish material prior to compression and curing in the forming stage of the system.

Another object of the present invention is to provide a new and improved method of producing clean Class-A fire-protected OSB sheathing.

Another object of the present invention is to provide a new and improved Class-A fire protected wood fiber insulation (WFI) board produced using an automated factory.

Another object of the present invention is to provide a new and improved automated factory configured for producing Class-A fire-protected wood fiber insulation (WFI) panels.

Another object of the present invention is to provide a new and improved automated WFI panel fabrication factory, wherein each of the stages of manufacture are performed along the multi-stage fabrication process, including the treatment of wood furnish materials (e.g. wood strands) and polymeric resin binders/adhesives (e.g. pDMI resin binders) used during the manufacturing process.

Another object of the present invention is to provide a new and improved resin and biochemical mixer/blender stage employed in a wood fiber insulation (WFI) panel production line, wherein pMDI resin and biochemical additive compositions of the present invention are mixed and blended together into a homogeneous emulsion for atomization spraying and coating wood furnish material (i.e. wood particles) flowing through the wood furnish resinating stage of the system (e.g. staging applying polymeric resin binder to treated wood furnish material).

Another object of the present invention is to provide a new and improved polymeric resin and biochemical mixer/blender stage employed in a WFI panel production line, wherein a homogeneous emulsion is supplied to an turbo-flow-based glue resinating engine, within which wood fiber particle flowing thereinto are ground into fine particles that form a pair of wood particle streams that flow through the engine while the surfaces thereof are being spray atomized and coated with biochemically-treated wood resin emulsion, and then the resin-coated wood particles flow through the turboflow resinator stage of the system towards the panel formation stage of the system.

Another object of the present invention is to provide a new and improved turbo-flow-based glue (polymer binder) resinating engine employed in a resin and biochemical mixer/blender stage employed in a WFI panel production line, wherein homogeneously blended biochemically-treated polymeric resin emulsion is spray atomized over the surface of the wood particle flow streams passing through the resinating engine.

Another object of the present invention is to provide a new and improved method of producing environmentally-clean Class-A fire-protected WFI sheathing.

Another object of the present invention is to provide new and improved Class-A fire protected medium density fiber (MDF)/high density fiber (HDF) panels produced using environmentally-clean biochemicals applied in an automated factory.

Another object of the present invention is to provide a new and improved automated MDF/HDF panel fabrication factory, wherein each of the stages of manufacture are performed along the multi-stage fabrication process, including the treatment of wood furnish materials (e.g. wood particles) and polymeric resin adhesives (e.g. pDMI resin binders) used during the manufacturing process.

Another object of the present invention is to provide a new and improved polymeric resin and biochemical mixer/blender stage employed in an MDF/HDF panel production line, wherein pMDI resin and biochemical additive composition of the present invention are mixed and blended together into a homogeneous emulsion for atomization spraying and coating wood furnish material (i.e. wood particles) flowing through the resinator stage of the system.

Another object of the present invention is to provide a new and improved polymeric resin and biochemical mixer/blender stage employed in a MDF/HDF panel production line, wherein the homogeneous emulsion is produced by precisely metering and mixing (i) pDMI polymeric resins, (ii) biochemicals for treating the polymeric resin and providing specified functions (i.e. fire inhibition, corrosion inhibition, etc.), and (iii) waxes, before being emulsified by one or more different methods including rapid mixing/blending and ultrasonic mixing, and then suppling the homogeneous resin/biochemical emulsion to the spray nozzles in the turbo-flow-based glue resinating engine employed in the resin and biochemical mixer/blender stage.

Another object of the present invention is to provide a new and improved turbo-flow-based glue resinating engine employed in the resin and biochemical mixer/blender stage employed in an MDF/HDF panel production line 4, wherein the homogeneous biochemically-treated polymeric resin emulsion is spray atomized over the surface of the wood particle flow streams passing through the engine.

Another object of the present invention is to provide a new and improved turbo-flow-based glue resinating engine employed in a polymeric resin and biochemical mixer/blender stage employed in the MDF/HDF panel production line, wherein the homogeneous biochemically-treated polymeric resin emulsion is spray atomized over the surface of the wood particle flow streams passing through the engine.

Another object of the present invention is to provide a new and improved method of producing environmentally-clean Class-A fire-protected MDF/HDF sheathing.

Another object of the present invention is to provide new and improved Class-A fire-protected multi-ply plywood panels produced using environmentally-clean biochemicals applied in an automated factory.

Another object of the present invention is to provide a new and improved an automated factory, configured for producing Class-A fire-protected multi-ply plywood panels.

Another object of the present invention is to provide a new and improved resin adhesive/glue application system employed in an MDF/HDF panel production line, wherein pMDI polymeric resin and biochemical treatment of the present invention are mixed and blended together into a homogeneous adhesive resin emulsion and then spray-atomized to coat wood furnish material (i.e. wood particles) flowing through the resinator stage of the system.

Another object of the present invention is to provide a new and improved automated plywood panel fabrication factory, wherein each of the stages of plywood manufacture are performed along a multi-stage fabrication process, including the treatment of wood furnish materials (e.g. wood particles) and polymeric resin adhesives (e.g. pDMI resin binders) used during the manufacturing process.

Another object of the present invention is to provide a new and improved method of producing environmentally-clean Class-A fire-protected plywood panels using environmentally-clean biochemicals of the present invention.

Another object of the present invention is to provide a new and improved environmentally-clean Class-A fire protected multi-ply bamboo plywood panels produced using environmentally-clean fire inhibiting biochemicals applied in an automated factory.

Another object of the present invention is to provide a new and improved process used to produce multi-ply bamboo plywood panels using environmentally-clean fire inhibiting biochemicals applied in an automated factory.

Another object of the present invention is to provide a new and improved automated factory, configured for producing Class-A fire-protected multi-ply bamboo plywood panels using environmentally-clean fire inhibiting biochemicals applied in the automated factory.

Another object of the present invention is to provide new and improved environmentally-clean Class-A fire-protected bamboo strand board (BSB) panels produced according to a process using environmentally-clean fire inhibiting biochemicals applied in the automated factory.

Another object of the present invention is to provide a new and improved Class-A fire-protected bamboo strand board (BSB) panel using a factory-based process for producing bamboo strand board (BSB) panels comprising the steps of (1) preparing raw material (bamboo strands-having a desired length, width and moisture content), (2) treating prepared bamboo strands with biochemical salts according to present invention to impart properties against fire, mold/mildew and/or moisture, (3) blending pMDI polymeric resin binder with biochemical salts of the present invention to produce treated resin emulsion, (4) mixing bamboo strands with treated resin emulsion with treated bamboo strands, (5) forming sheet of bamboo strands mixed with treated polymeric resin emulsion to form a bamboo strand mat), (6) hot pressing the formed mat under compression to produce bamboo strand board (BSB), and (7) trimming and cutting bamboo strand board (BSB) panel into bamboo strand board (BSB) sheets.

Another object of the present invention is to provide a new and improved automated factory, configured for producing Class-A fire-protected bamboo strand board (BSB) panels using environmentally-clean fire inhibiting biochemicals applied in the automated factory.

Another object of the present invention is to provide a new and improved method of producing Class-A fire-protected bamboo strand board (BSB) panels using environmentally-clean fire inhibiting biochemicals applied in an automated factory.

Another object of the present invention is to provide a new and improved system for producing multi-ply fire-protected composite wood products (i.e. OSB panels) using environmentally-clean liquid fire inhibiting biochemicals and resin binder chemicals, and showing a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) chemical are supplied and provide to several (e.g. three) pipelines and used to support (i) fire inhibiting treatment of the wood furnish material, (ii) biochemical treatment of the resin binder chemicals, and (iii) resinating the treated wood furnish material before being processed and formed into layers (e.g. mats) that are then stacked into an stacked layer assembly, and then molded and compressed under heat and pressure to cure the applied binder resin chemicals, whereupon the molded wood product is released from the molds, and then sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using liquid resin binder biochemicals mixed with environmentally-clean liquid fire inhibiting chemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting biochemical, and applying the environmentally-clean liquid fire inhibiting biochemical to the lignocellulosic furnish material to provide fire protection to the treated lignocellulosic furnish material, and inhibition against corrosion of metal(s) in contact with the treated furnish material, (c) providing a supply of liquid polymeric resin binder (e.g. pMDI resin) for use in binding together the treated wood furnish material during the production of fire-protected composite wood products, (d) mixing a minor amount of environmentally-clean fire inhibiting chemical with a major amount of liquid resin binder, before applying the mixed treated polymeric resin binder to the treated wood furnish material, (e) using a particle-binder mixing/resinating module to apply the mixture of resin binder and fire inhibiting biochemical, to a supply of treated wood furnish material, and produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. OSB panels) using environmentally-clean liquid fire inhibiting and resin binder chemicals (e.g. single component binder system comprising uncatalyzed PMDI prepolymeric resins), wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) chemical are supplied and provided to several (e.g. three) pipelines and used to support (i) fire inhibiting treatment of the wood furnish material, (ii) treating the liquid resin binder chemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method one-component liquid resin binder chemicals mixed with environmentally-clean dry fire inhibiting chemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry fire inhibiting chemical powder and applying the environmentally-clean dry fire inhibiting chemical powder to the lignocellulosic furnish material provide Class-A fire protection to the treated lignocellulosic furnish material, and inhibition against corrosion of metal in contact with the treated furnish material, (c) providing a supply of liquid resin binder (e.g. pMDI polymeric resin) for use in binding wood furnish material together when producing fire-protected wood products, (d) mixing a minor amount of environmentally-clean dry powder fire inhibiting biochemical with a major amount of liquid resin binder chemical, before applying treated binder resin to treated wood furnish material, (e) using a particle-binder mixing/resinating module to apply the mixture of liquid resin binder and dry fire inhibiting chemical powder, to a supply of wood furnish material, to produce a supply of resinated treated wood furnish, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product, and (g) applying a mold and moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. OSB panels) using environmentally-clean liquid fire inhibiting and one-component resin binder chemicals (e.g. two component binder system comprising catalyzed PMDI polymeric resins), wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, and (ii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using one-component liquid resin binder chemicals mixed with environmentally-clean liquid fire inhibiting biochemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material, (c) providing a supply of liquid polymeric resin binder (e.g. pMDI resin) for use in binding together treated wood furnish material when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply, the mixture of liquid resin binder and liquid fire inhibiting chemical, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold & moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. MDF, HDF and PB panels) using environmentally-clean liquid fire inhibiting and one-component resin binder chemicals (e.g. single component binder system comprising uncatalyzed PMDI prepolymeric resins), wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) are supplied to several (e.g. three) pipelines and used to support (i) fire inhibiting treatment of the wood furnish material, (ii) treating resin binder chemicals with environmentally-clean biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using one-component liquid resin binder chemicals mixed with environmentally-clean dry fire inhibiting chemicals, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to the lignocellulosic furnish material to provide Class-A fire protection to the treated lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply the mixture of liquid resin binder and liquid fire inhibiting chemical, to a supply of wood furnish material in the rotating drum to produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly cured under pressure to the form a fire-protected composite wood product, and (g) applying a mold & moisture protection coating over the fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. MDF, HDF, PB panels) using environmentally-clean liquid fire inhibiting biochemical and resin binder chemicals (e.g. two component binder system comprising catalyzed PMDI prepolymeric resins), wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, (ii) treating the resin binder chemicals with environmentally-clean biochemicals, and (iii) resinating (i.e. applying pDMI polymeric resin binder material to) the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing fire-protected composite wood products (e.g. HDF, MDF and PB panels) using liquid resin binder chemicals mixed with environmentally-clean liquid fire inhibiting chemicals, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to the lignocellulosic furnish material to provide fire protection to the treated lignocellulosic furnish material, and inhibition against corrosion of metal in contact with the treated furnish material, (c) providing a supply of liquid resin binder (e.g. pMDI resin) for use in binding treated wood furnish material together when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply the mixture of liquid resin binder and liquid fire inhibiting, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the assembly is cured under pressure to the form a fire-protected composite wood product, and (g) applying a mold and moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. OSB panels) using environmentally-clean dry powder and liquid fire inhibiting biochemicals and resin binder chemicals mixed and blended together, and showing a supply of wet lignocellulosic furnish material (e.g. wood strands, chips, particles, etc.), a supply of environmentally-clean liquid and dry powder fire inhibiting biochemicals of the present invention, and a supply of liquid resin binder (e.g. pMDI polymeric resin binder) are supplied to several (e.g. three) pipelines and used to support (i) fire inhibiting (dry powder) treatment of the wood furnish material, (ii) treating liquid resin binder chemicals with environmentally-clean biochemicals, and (iii) resinating the treated wood furnish material with treated liquid resin binder before being processed and formed into layers (e.g. mats) that are then stacked into an stacked layer assembly, and then molded and compressed under heat and pressure to cure the applied binder resin, whereupon the molded wood product is released from the molds, and then sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using liquid resin binder chemicals mixed with environmentally-clean liquid fire inhibiting biochemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry powder fire inhibiting biochemical, and applying the environmentally-clean dry powder fire inhibiting biochemical to the lignocellulosic furnish material to provide fire protection to the treated lignocellulosic furnish material, and inhibition against corrosion of metal(s) in contact with the treated furnish material, (c) providing a supply of liquid resin binder (e.g. pMDI polymeric resin binder material) for use in binding together the treated wood furnish material, when producing fire-protected wood products, (d) mixing a minor amount of environmentally-clean fire inhibiting biochemical with a major amount of liquid resin binder, before applying the mixed biochemically-treated binder resin to the biochemically-treated wood furnish material, (e) using a particle-binder mixing/resinating module to apply the mixture of resin binder and fire inhibiting biochemical, to a supply of biochemically-treated wood furnish material, and produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. OSB panels) using environmentally-clean dry powder and liquid fire inhibiting biochemicals and resin binder chemicals (e.g. single component binder system comprising uncatalyzed PMDI prepolymeric resins), wherein a supply of wet lignocellulosic furnish material (e.g. wood strands, chips, particles, etc.), a supply of environmentally-clean liquid fire inhibiting biochemicals, and a supply of liquid resin binder (e.g. pMDI resin) are supplied to several (e.g. three) pipelines and used to support (i) fire inhibiting treatment of the wood furnish material, treating resin binder chemical with environmentally-clean biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using dry power biochemicals to treat wood furnish material and environmentally-clean liquid fire inhibiting biochemicals to treat resin binder chemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry power fire inhibiting biochemical and applying the environmentally-clean dry powder fire inhibiting biochemical powder to the wet lignocellulosic furnish material provide Class-A fire-protection to the treated lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean dry fire inhibiting chemical powder with a major amount of liquid resin binder, before applying binder resin to wood furnish material, (e) using a particle-binder mixing/resinating module to apply the mixture of liquid resin binder and dry fire inhibiting chemical powder, to a supply of wood furnish material, to produce a supply of resinated treated wood furnish, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product, and (g) applying a mold and moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. OSB panels) using environmentally-clean liquid and dry powder fire inhibiting biochemicals to treat wood furnish material and resin binder chemicals (e.g. two component binder system comprising catalyzed PMDI prepolymeric resins), wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing multi-ply fire-protected composite wood products (i.e. OSB panels) using liquid resin binder chemicals mixed with environmentally-clean liquid fire inhibiting chemicals, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material, (c) providing a supply of liquid resin binder (e.g. pMDI resin) for use in binding together treated wood furnish material when producing fire-protected wood products, (d) mixing a minor amount of environmentally-clean liquid fire inhibiting chemical with a major amount of liquid resin binder, before applying binder resin to wood furnish material, (e) using a particle-binder mixing/resinating module to apply, the mixture of liquid resin binder and liquid fire inhibiting chemical, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold & moisture protection coating over said fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. MDF, HDF and PB panels) using environmentally-clean liquid fire inhibiting and resin binder chemicals (e.g. single component binder system comprising uncatalyzed PMDI prepolymeric resins), wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method liquid resin binder chemicals mixed with environmentally-clean dry powder and liquid fire inhibiting biochemicals, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean dry powder fire inhibiting biochemical and applying the environmentally-clean dry powder fire inhibiting biochemical to the lignocellulosic furnish material to provide Class-A fire protection to the treated lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean liquid fire inhibiting chemical with a major amount of the liquid resin binder, before applying treated binder resin to treated wood furnish material, (e) using a particle-binder mixing/resinating module to apply the mixture of liquid resin binder and liquid fire inhibiting chemical, and treat a supply of wood furnish material in the rotating drum to produce a supply of resinated treated wood furnish material, (f) molding the (pMDI) resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over the fire-protected composite wood product so as to produce a finished engineered wood product (EWP) having fire, metal-corrosion, mold and moisture protection.

Another object of the present invention is to provide a new and improved factory-based system for producing multi-ply fire-protected composite wood products (i.e. MDF, HDF, PB panels) using environmentally-clean dry powder fire inhibiting biochemical to treat wood furnish materials, and environmentally-clean dry powder fire inhibiting biochemical to treat liquid resin binder chemicals (e.g. two component binder system comprising catalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder hardener/catalyst, are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

Another object of the present invention is to provide a new and improved method of producing fire-protected composite wood products (e.g. HDF, MDF and PB panels) using liquid resin binder chemicals mixed with environmentally-clean dry powder fire inhibiting biochemicals, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean dry powder fire inhibiting biochemical and applying the environmentally-clean dry powder fire inhibiting biochemical to the lignocellulosic furnish material to provide fire protection to treated lignocellulosic furnish material, and inhibition against corrosion of metal in contact with treated furnish material, (c) providing a supply of liquid resin binder (e.g. pMDI resin) for use in binding together treated wood furnish material when producing fire-protected wood products, (d) mixing a minor amount of environmentally-clean dry powder fire inhibiting biochemical, with a major amount of liquid resin binder, before applying treated binder resin to treated wood furnish material, (e) using a particle-binder mixing/resinating module to apply the (treated) mixture of liquid resin binder and dry fire inhibiting chemical powder to a supply of treated wood furnish material to produce a supply of resinated treated wood furnish material for molding purposes, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold and moisture protection coating over the fire-protected composite wood product so as to produce a finished engineered wood product (EWP) having fire, metal-corrosion, mold and moisture protection.

Another object of the present invention is to provide a new and improved Class-A fire-protected wood by undergoing pressurized treatment contained within a pressurized tank holding untreated lumber and/or wood products and filled with environmentally-clean biochemical liquid according to the present invention that is used to impregnate wood fibers within the treated wood products and provide fire, mold/mildew and moisture protection to the treated wood products.

Another object of the present invention is to provide a new and improved a system adapted for pressure treating untreated wood within a pressurized tank filled with biochemical liquid according to the present invention, wherein environmentally clean wood treating biochemical liquid is pumped by a pressure pump into the treatment tank containing pieces of untreated wood, so as to impregnate wood fibers with the biochemical liquid and provide fire, mold/mildew and moisture protection.

Another object of the present invention is to provide a new and improved method of producing Class-A fire-protected lumber by pressure treatment of wood material with environmentally-clean biochemicals of the present invention.

Another object of the present invention is to provide a new and improved Class-A fire-protected oriented strand board (OSB) sheathing comprising environmentally-clean fire inhibiting biochemical coatings deposited on the surface of each OSB layer and sides of the core medium layer.

Another object of the present invention is to provide a new and improved method of producing Class-A fire-protected finger-jointed lumber products in an automated factory applying environmentally-clean fire inhibiting biochemicals to the surfaces of the Class-A fire-protected finger-jointed lumber products.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a table listing an exemplary set of prior art solid, composite and engineered wood products requiring Class-A fire protection, mold/mildew protection, and/or moisture protection, namely: plywood panels, oriented strand board (OSB) panels, medium density fiber (MDF) board, high density fiber (HDF) board, finger-jointed lumber, composite wood products (e.g. chipboard, etc.) and various engineered wood products (EWPs);

FIG. 1A is a schematic illustration of a prior art plywood panel produced from wood laminates and polymeric resins, without providing Class-A fire protection, mold/mildew protection, and/or moisture protection;

FIG. 1B is a schematic illustration of a prior art oriented strand board (OSB) panel produced from wood strands (i.e. wood furnish) and polymeric resins, without providing Class-A fire protection, mold/mildew protection, and/or moisture protection;

FIG. 1C is a schematic illustration of a prior art medium density fiber (MDF) board panel and high density fiber (HDF) board produced from wood fiber and polymeric resins, without providing Class-A fire protection, mold/mildew protection, and/or moisture protection;

FIG. 1D is a schematic illustration of a prior art finger-jointed lumber product (e.g. 2×4 lumber piece) produced from lumber and polymeric resins, without providing Class-A fire protection, mold/mildew protection, and/or moisture protection;

FIG. 1E is a schematic illustration of a prior art composite wood (fiber & chips) panel produced from wood fiber and pieces and polymeric resins, without providing Class-A fire protection, mold/mildew protection, and/or moisture protection;

FIG. 1F is a schematic illustration of prior art bamboo wood products (e.g. plywood panels, cross-laminated panels, etc.);

FIG. 2 is a schematic representation taken from prior art U.S. Pat. No. 6,811,731 (assigned to Chemical Specialties, Inc.) disclosing compositions and methods for protecting OSB panels against fire and mold by incorporating phosphate/borate salt formulations into wood-based composite products;

FIG. 3 is a schematic representation taken from a prior art U.S. Pat. No. 7,585,566 (assigned to Houston Advanced Research Center, i.e. HARC) disclosing compositions and methods for producing OSB panels with fire, fungus, and insect protection using polyisocynate impregnated wood compositions;

FIG. 4 is a schematic representation taken from prior art U.S. Pat. No. 8,084,523 disclosing compositions and methods for producing OSB panels using fire retardant polymeric adhesive compositions containing methylene diphenyl diisocyanate (MDI) and melamine phosphates;

FIG. 5A is a schematic representation taken from prior art U.S. Pat. No. 9,314,947 (assigned to Huntsman International) disclosing compositions and methods for producing OSB panels from lignocellulosic materials using polymeric resin binders and adhesives;

FIG. 5B is a schematic representation taken from prior art U.S. Pat. No. 8,891,005 (assigned to Huntsman International) disclosing compositions and methods for producing OSB panels from lignocellulosic materials using binder compositions containing an isocyanate compound, a metal catalyst and an acid compound;

FIG. 5C is a schematic representation taken from prior art European Patent (EP) U.S. Pat. No. 2,505,326 BH1 (assigned to Ecochem International) disclosing compositions and methods for producing fire resistant OSB panels using guanidine salts in the middle and outer layers of the OSB panels;

FIG. 5D is a schematic representation taken from prior art U.S. Pat. No. 10,995,221 (issued to Ziqiang Lu) disclosing compositions and methods for producing fire, moisture and mold resistant OSB panels using PVA-based coatings;

FIG. 5E is a schematic representation taken from prior art U.S. Pat. No. 10,919,178 (assigned to Applicant/Mighty Fire Breaker LLC) disclosing compositions and methods for producing fire-protected OSB panels using tripotassium citrate chemistry applied using dip-coating and spray coating methods;

FIG. 5F is a schematic representation taken from prior art US Patent Application Publication No. US2019/0330531 A1 (assigned to Ecochem International NV) disclosing compositions and methods for producing fire-retardant wood-composite panels using MAP and DAP based fire retarding and intumescent formulations and compositions;

FIG. 5G is a schematic representation taken from prior art US Patent Application Publication No. US2022/0017772 A1 (assigned to Dow Global Technologies LLC) disclosing compositions and methods producing OSB panels provided with fire-resistant polyurethane coating compositions containing an aromatic isocyanate component, a polyol component, and an intumescent component;

FIG. 5H is a schematic representation taken from prior art US Patent Application Publication No. 2021/0189245A1 by Rodriguez et al (assigned to BURNBLOCK HOLDINGS APS) disclosing a flame retardant and latent hardener composition including: a blend of 30-100% (by weight based on total solids) of diammonium hydrogen phosphate, and dihydrogen phosphate, 0-50% (by weight based on total solids) of monoammonium, functioning as fire retardant chemicals; as well as additives such as citrate (in range of 1.5-5% by wt) functioning as an acidic hardener, and sodium benzoate or potassium benzoate (e.g. 2-6% by wt) functioning as a mold inhibitor during transport of the flame-retardant/hardener composition. The flame-retardant/hardener composition is prepared as a solid blend or a liquid composition, the liquid composition being an aqueous composition including a liquid aqueous solution of the contents ranging from 25% w/w to 80% w/w. Methods are disclosed for making flame retarded fiber boards using the composition as flame retarder and a hardener for the resin used in the production of the boards.

FIG. 5I is a schematic representation taken from prior art US Patent Application Publication No. by Trefes (assigned to Panda Industraies, Inc.) disclosing a method of and system for manufacturing bamboo-based dimensional lumber having cross-hatched fiber layers covered with glue, so as to form a rough lumber board composed of cross-hatched bamboo fiber layers.

FIG. 5J is a schematic representation taken from prior art U.S. Pat. No. 11,578,487 (assigned to Louisana-Pacific Corporation) disclosing compositions and methods for producing fire-protected OSB panels using magnesium-based concrete coatings factory applied to wood surfaces, such as plywood or OSB panels, to provide fire resistance and an overlaid water resistant barrier;

FIG. 5K is a schematic representation taken from the 2018 Master's Thesis of Che Zheng at University of Waterloo, Chemical Engineering Department, Waterloo, Ontario, Canada, titled “Evaluation of Bio/pMDI Wood Adhesives” disclosing that citric acid is used as a wood modifying agent a binding agent for wood composite materials;

FIG. 5L is a schematic representation taken from a 2020 paper titled “A Review on Citric Acid as Green Modifying Agent and Binder for Wood” by Seng Hua Lee, et al, disclosing a review on using citric acid (CA) as a wood modifying agent and binder by forming ester linkages to provide adhesivity and good bonding characteristics;

FIG. 5M is a schematic representation taken a 2020 paper titled “Wood Surface Modification-Classic and Modern Approaches in Wood Chemical Treatment by Esterification Reactions” by Carmen-Alice Teaca and Fuiga Tanasa, disclosing methods and compositions including polycarboxylic acids, such as citric acid (CA) and tartaric acid (TA), for use in modifying the physical properties and characteristics of wood products by treating lignocellulosic material with chemicals;

FIG. 5N represents a 2024 paper titled “Nanotechnology in Wood Science: Innovations and Applications” by Richa Bansal, Harish C. Barshilia, and Krishna K. Pandey, which discloses a review of highlights of some of the advancements in the use of nanotechnology in wood science, and its potential impact on the industry, including the use of nanomaterials in improving the properties of wood and wood-based materials and protecting them from weathering, biodegradation, and other deteriorating agents. UV-resistant, self-cleaning (superhydrophobic) surfaces with anti-microbial properties have been developed using the extraordinary features of nanomaterials.

FIG. 50 is a schematic representation of the chemical compound cupric (copper) citrate, which dissolved in water produces copper ions that can be infused into treat lignocellulosic material of wood material to inhibit and control a wide range molds, fungi, algae, and harmful microbes;

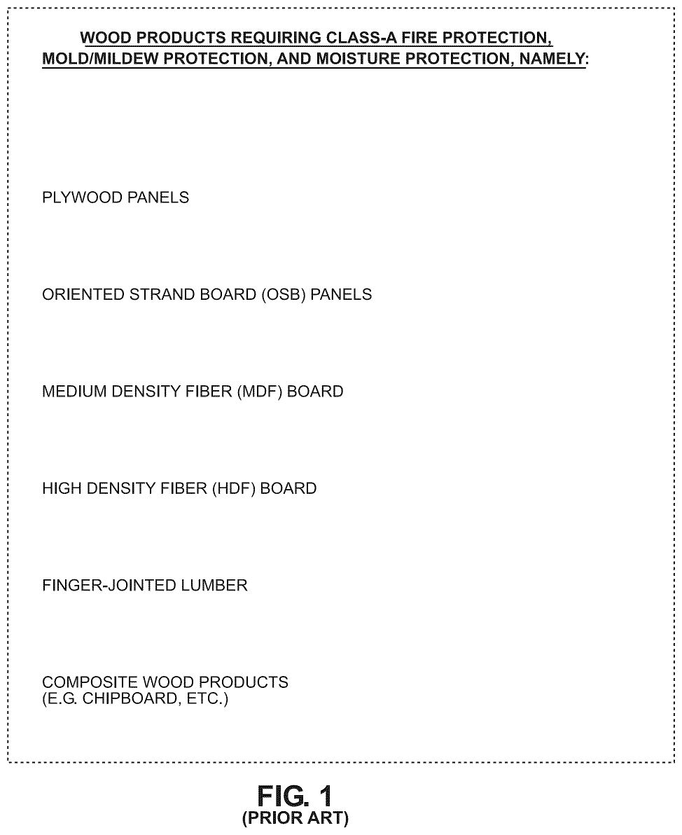

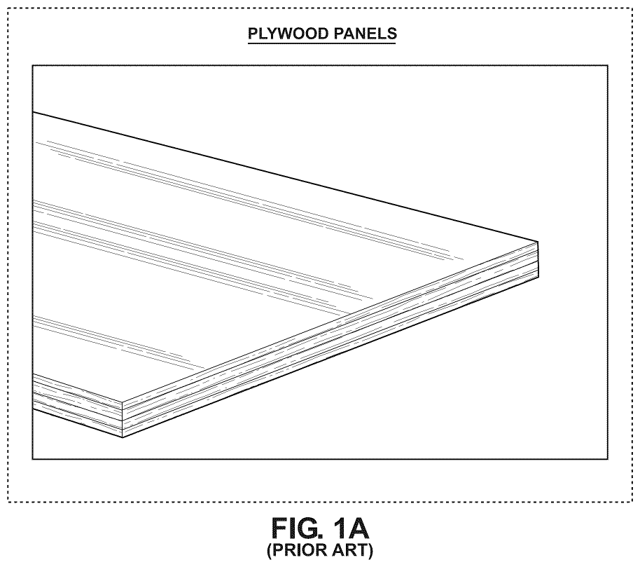

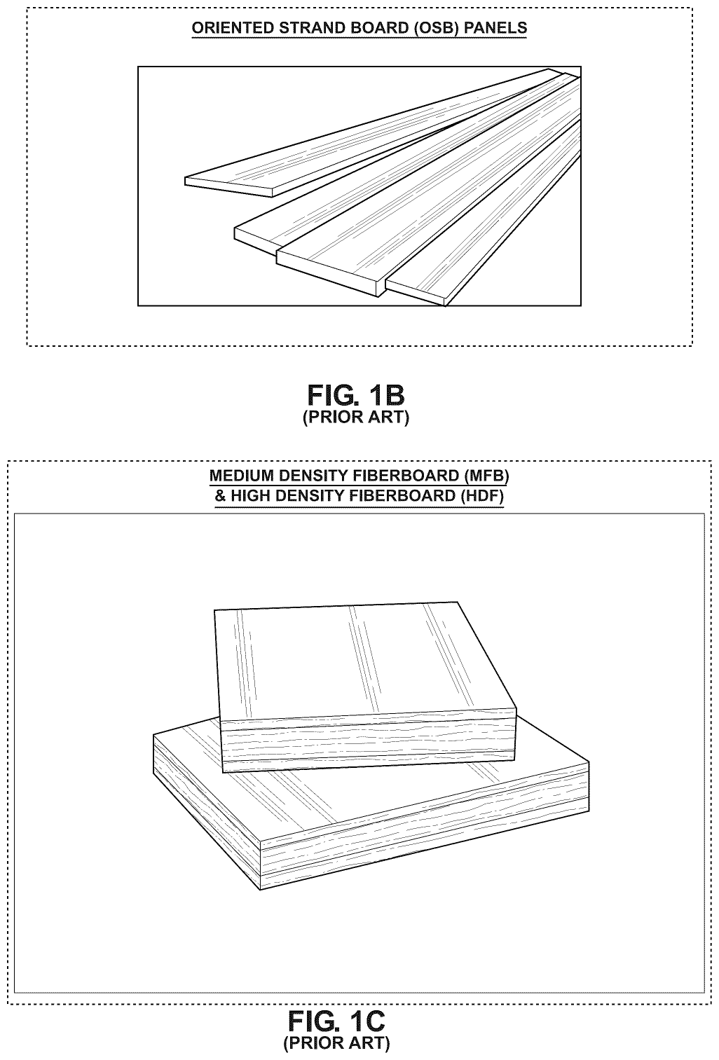

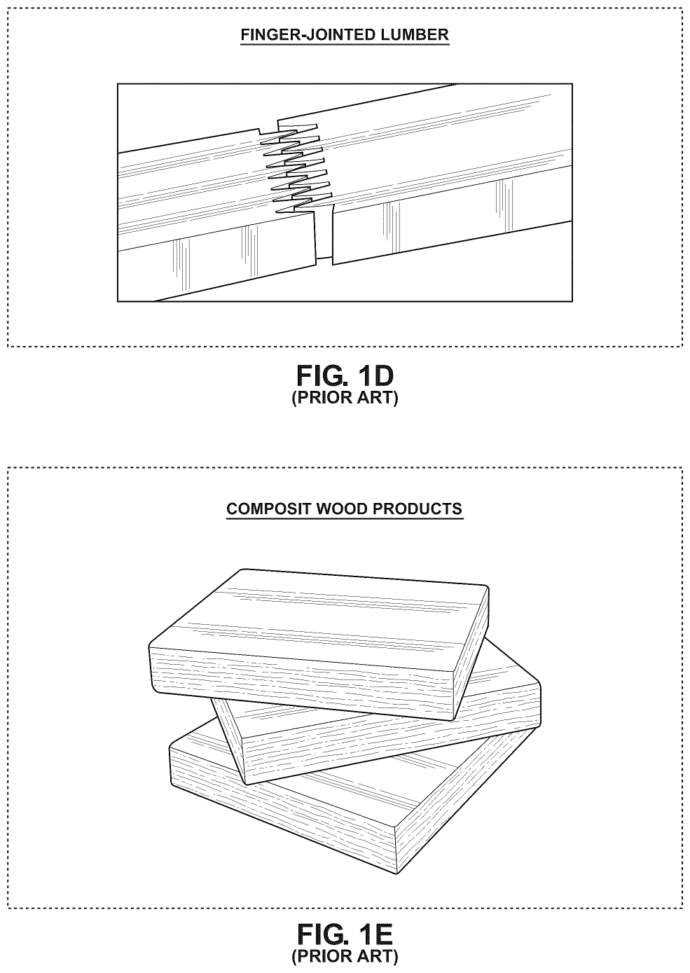

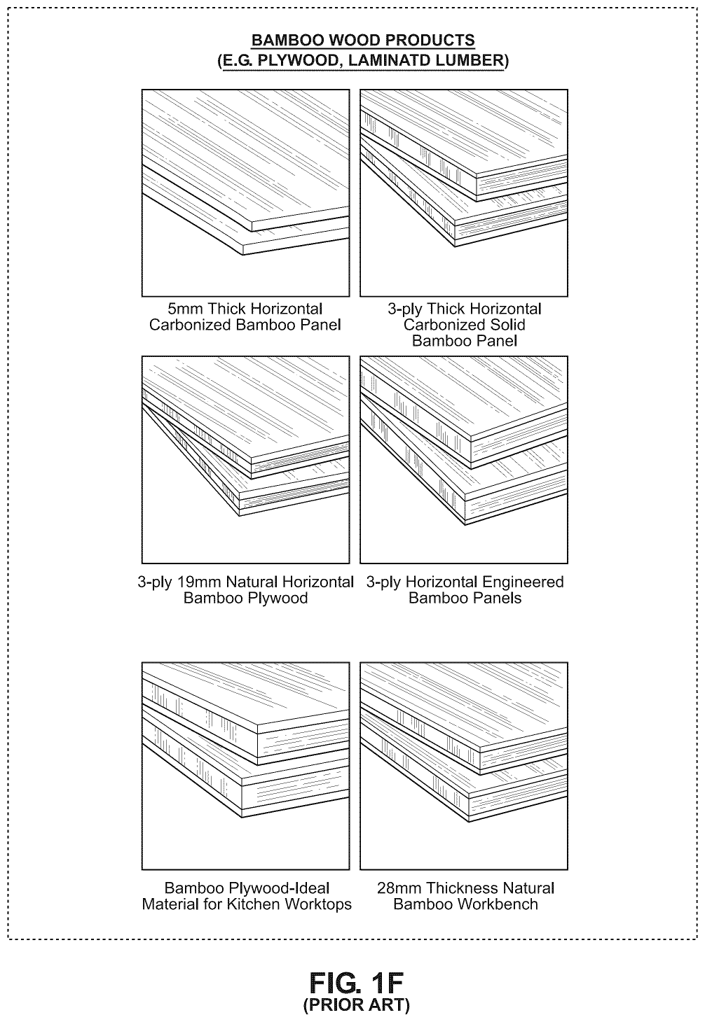

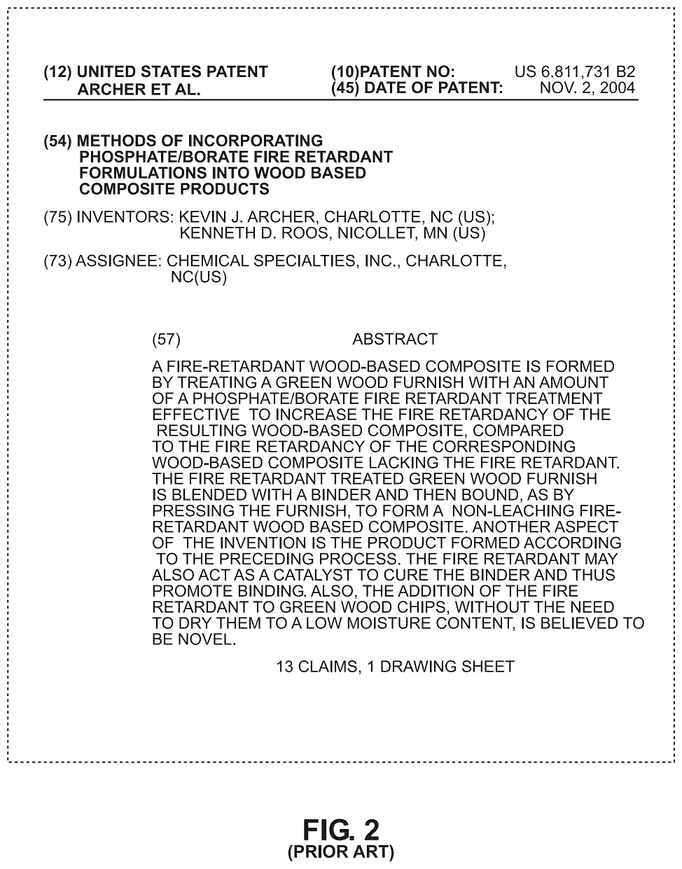

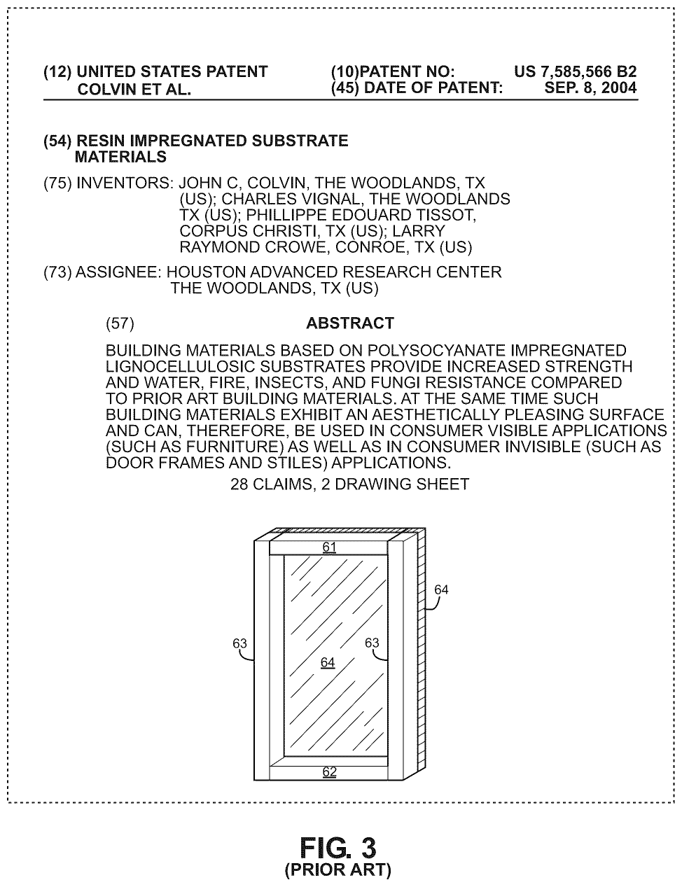

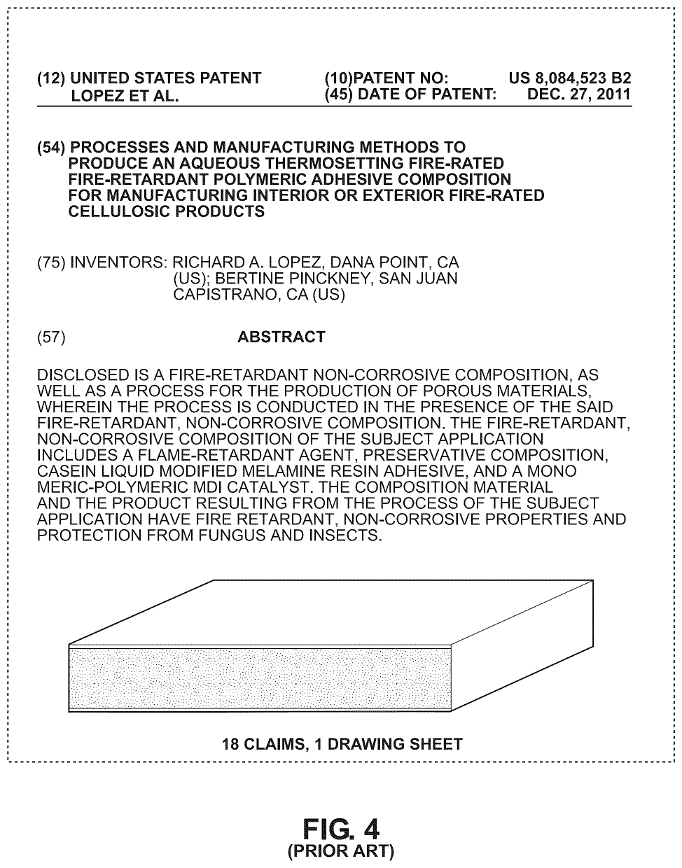

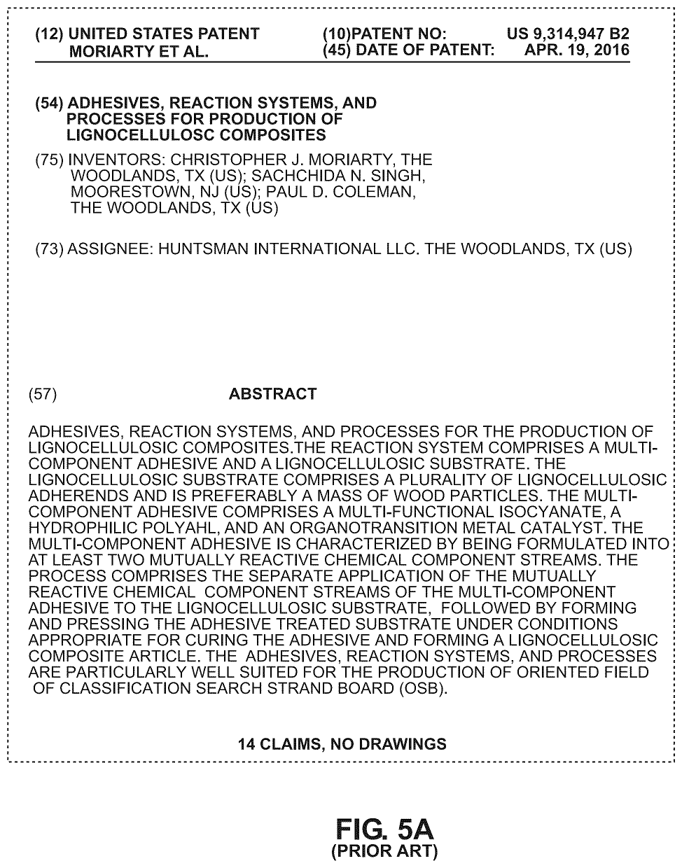

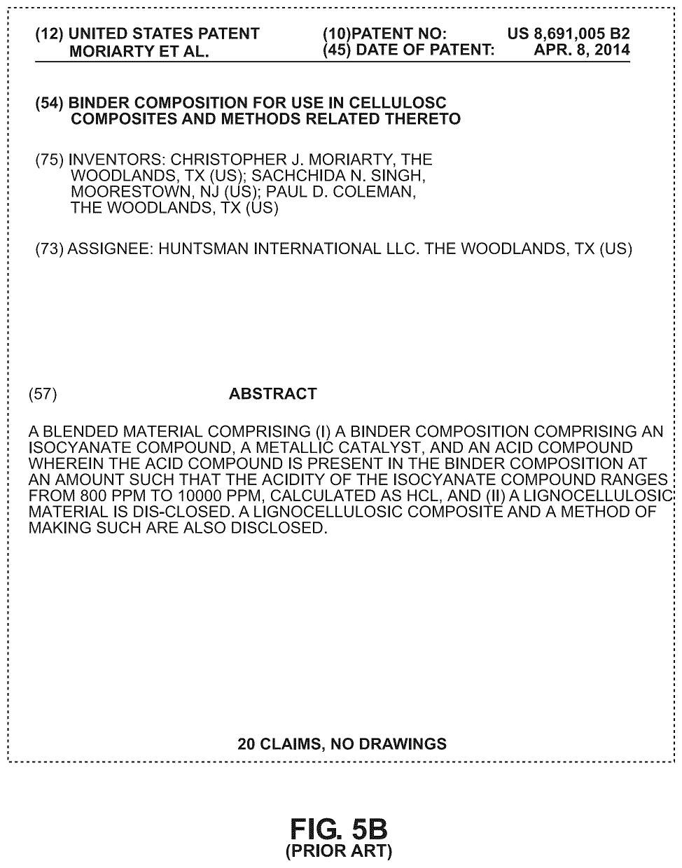

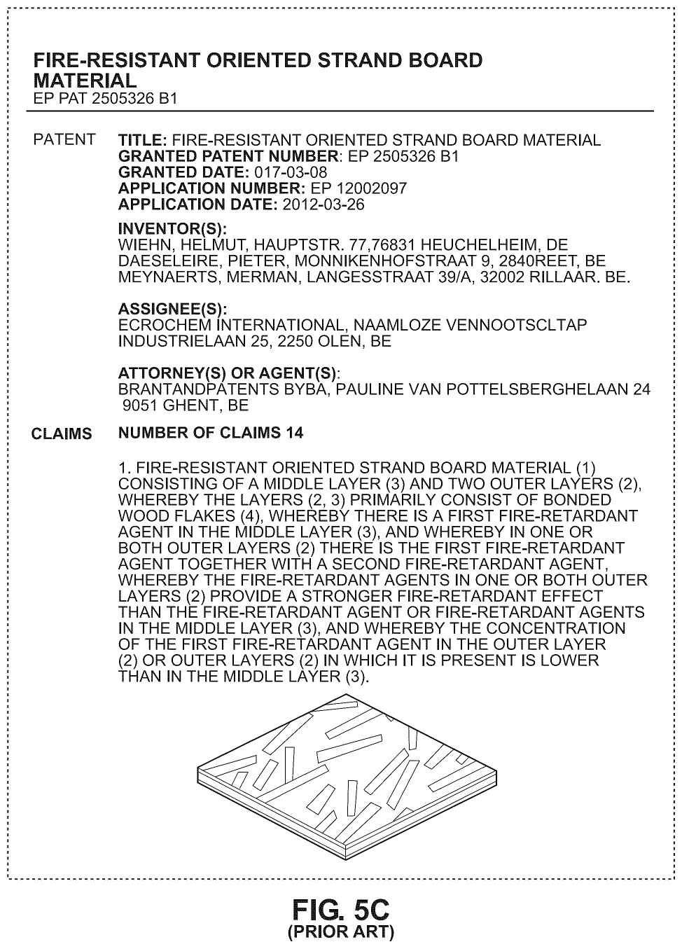

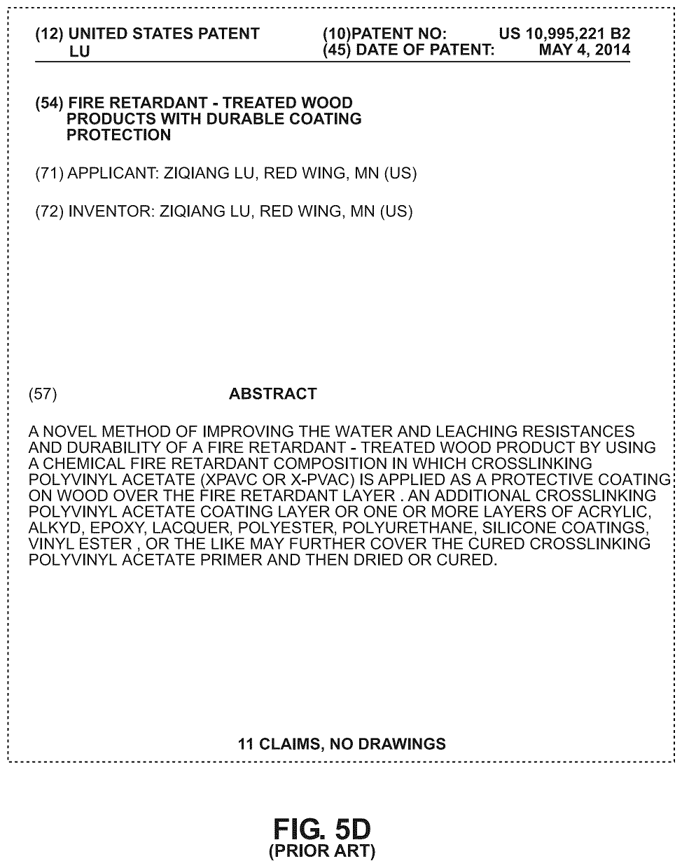

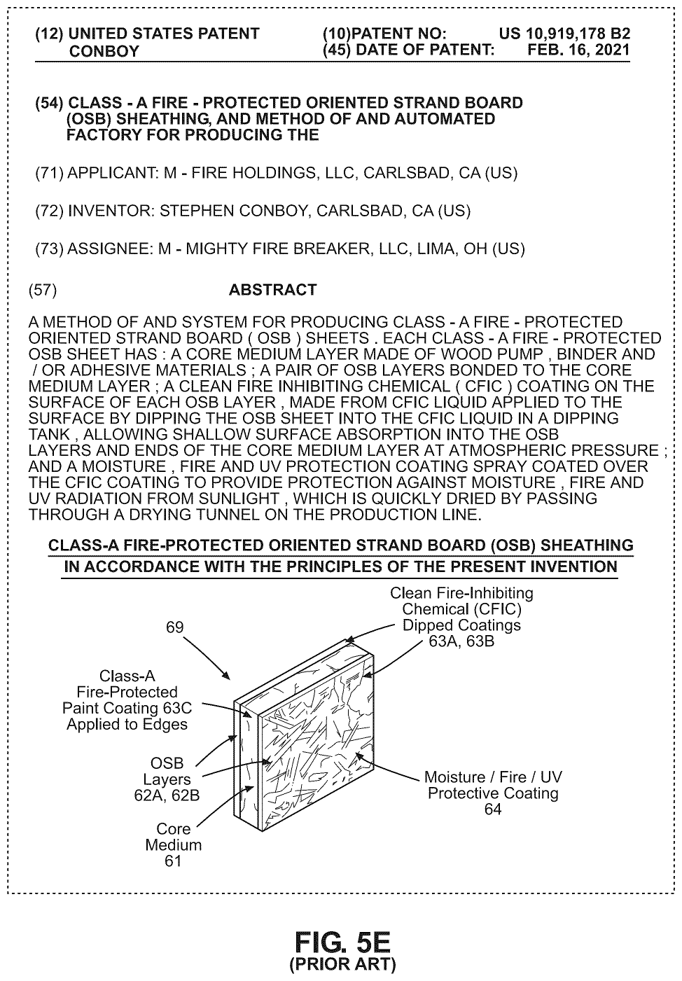

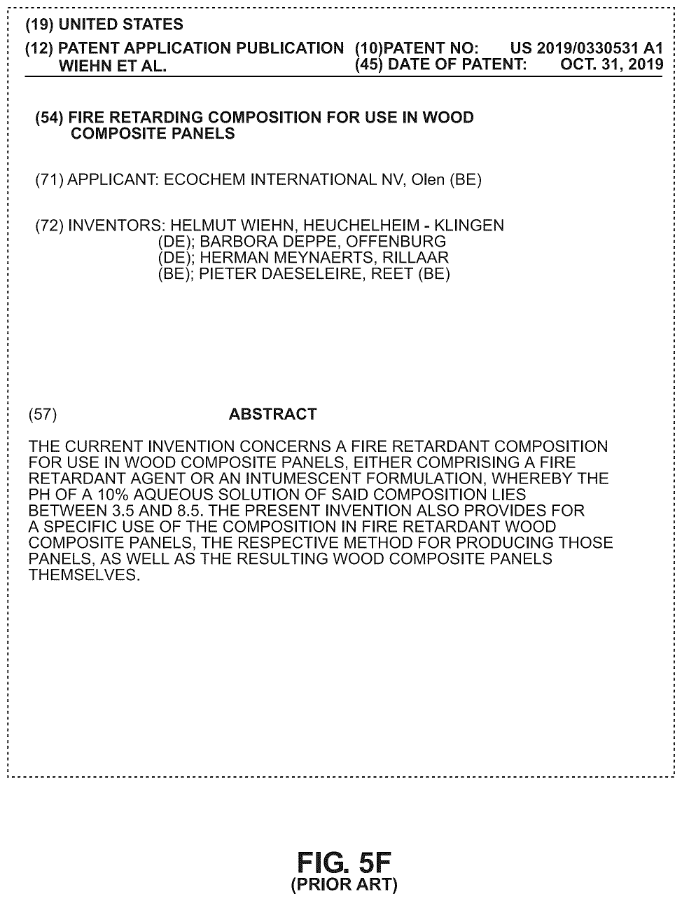

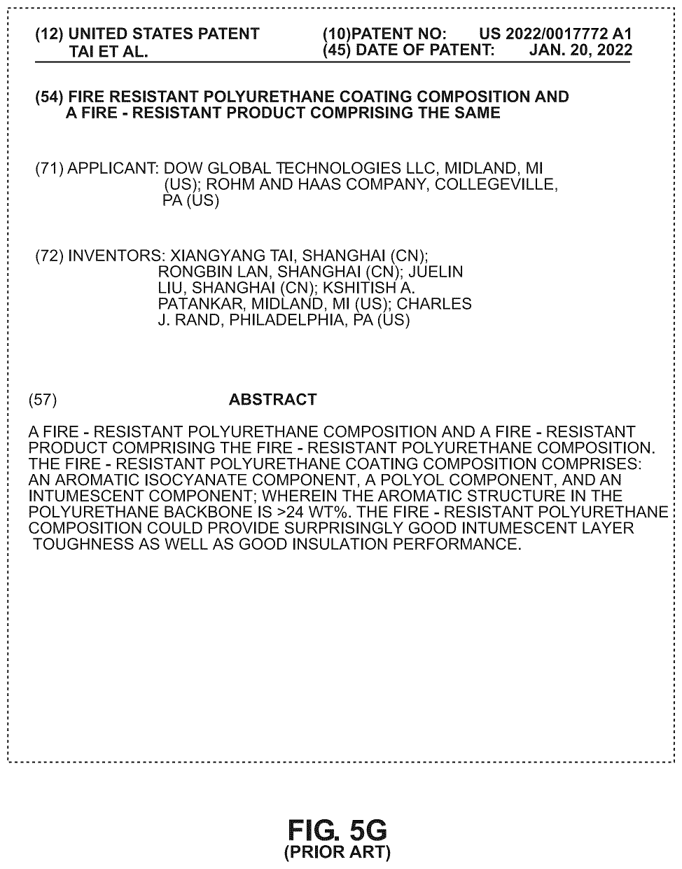

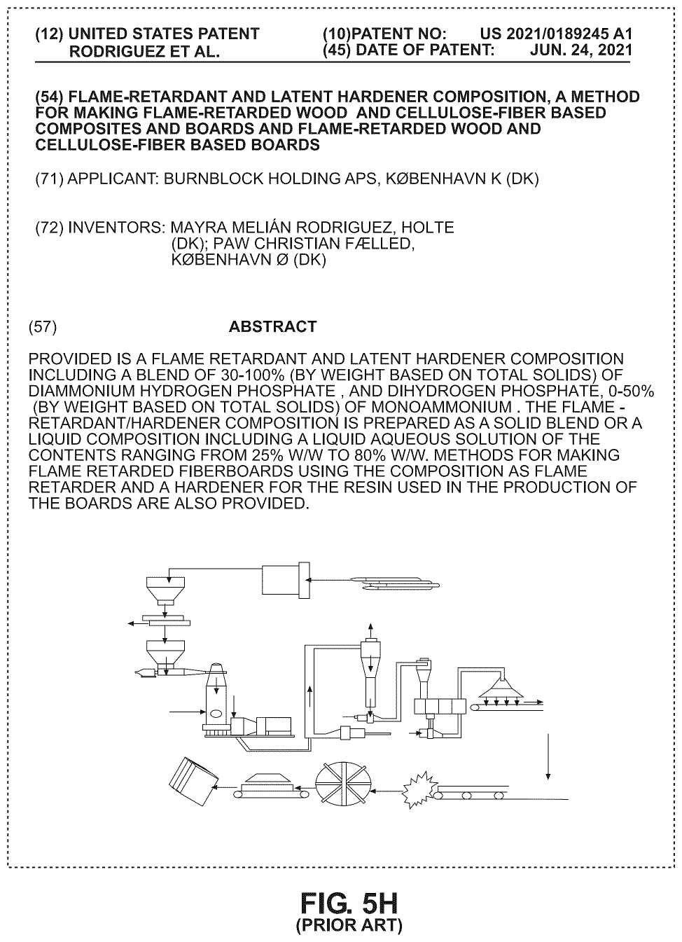

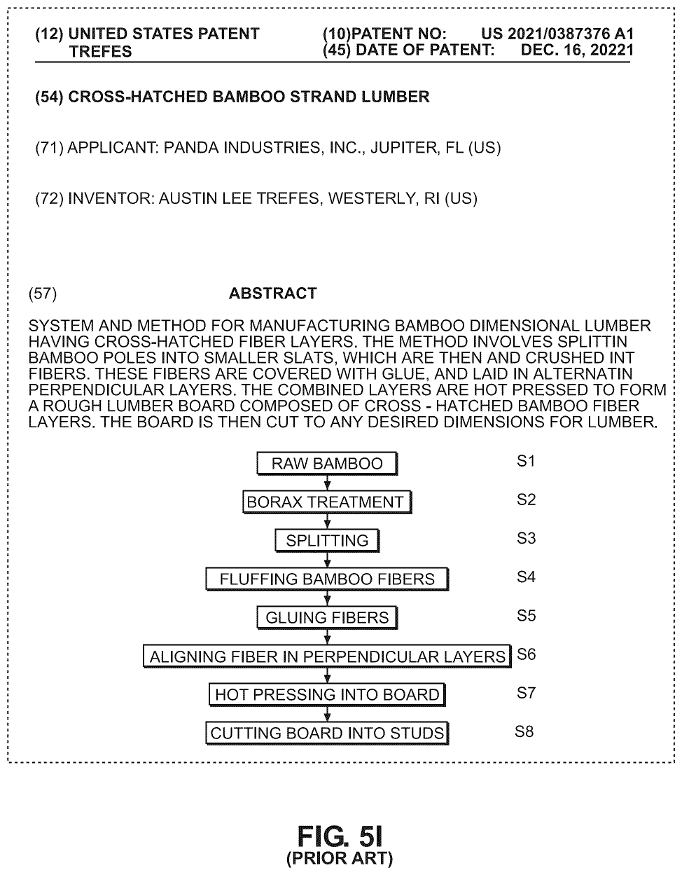

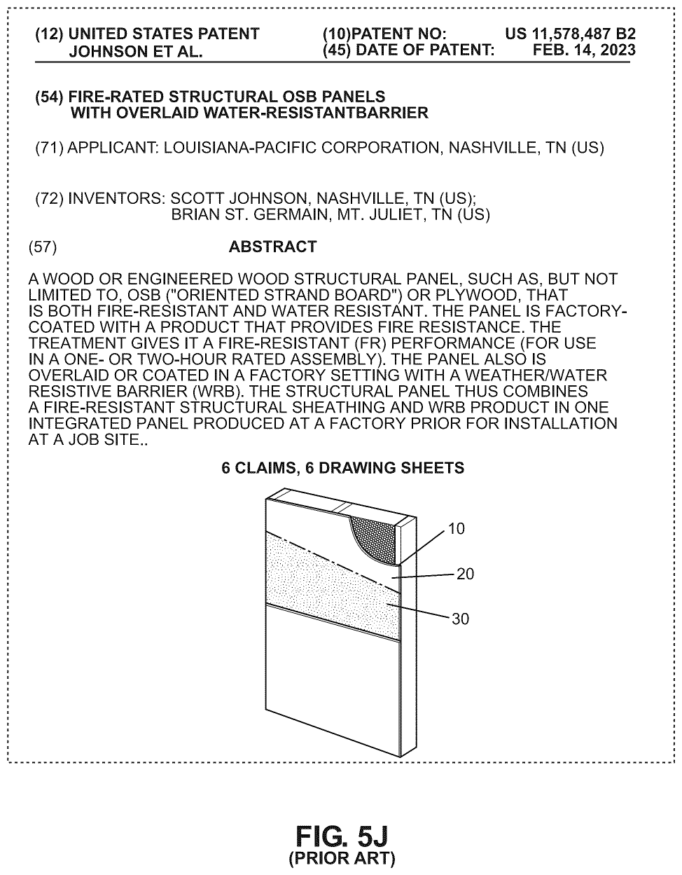

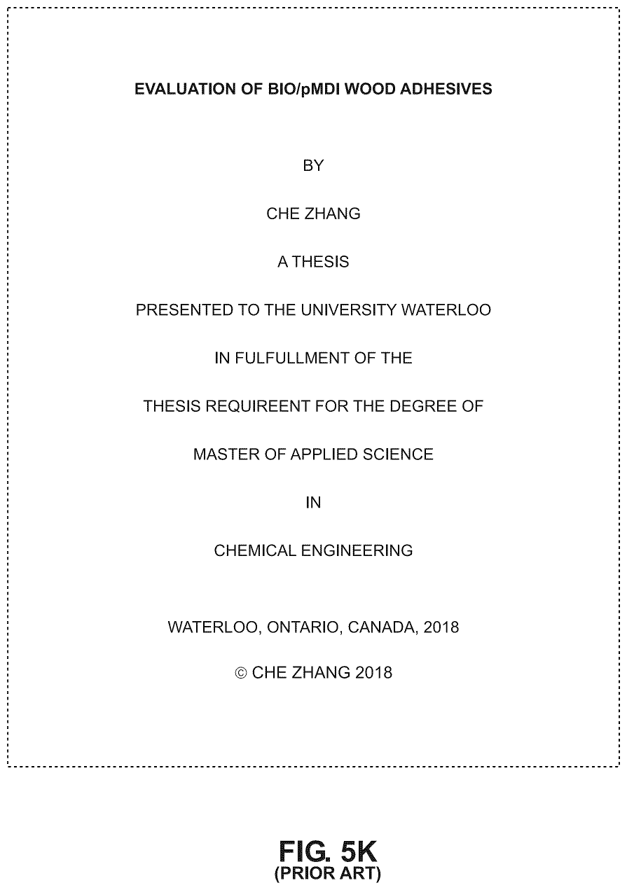

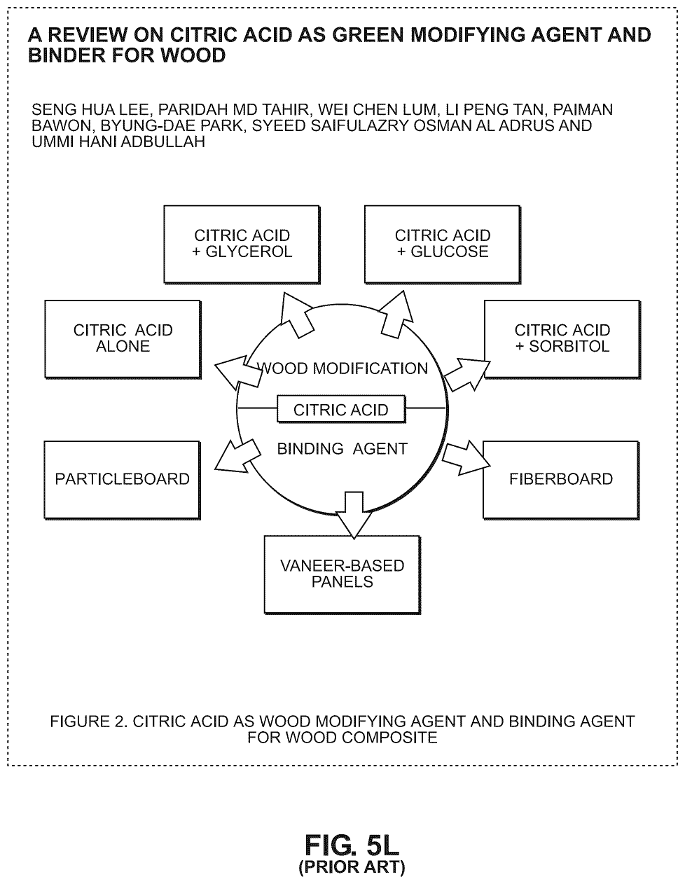

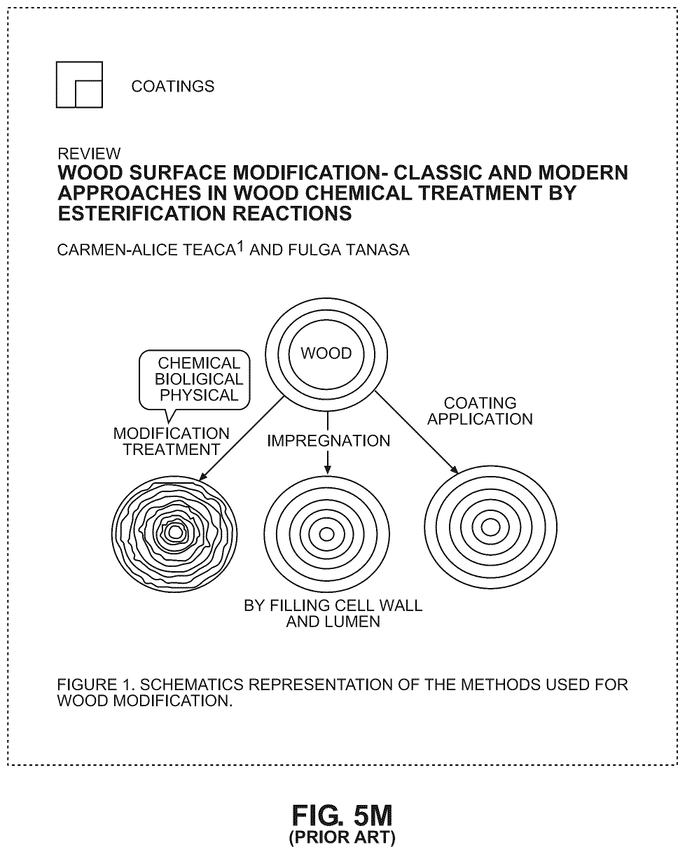

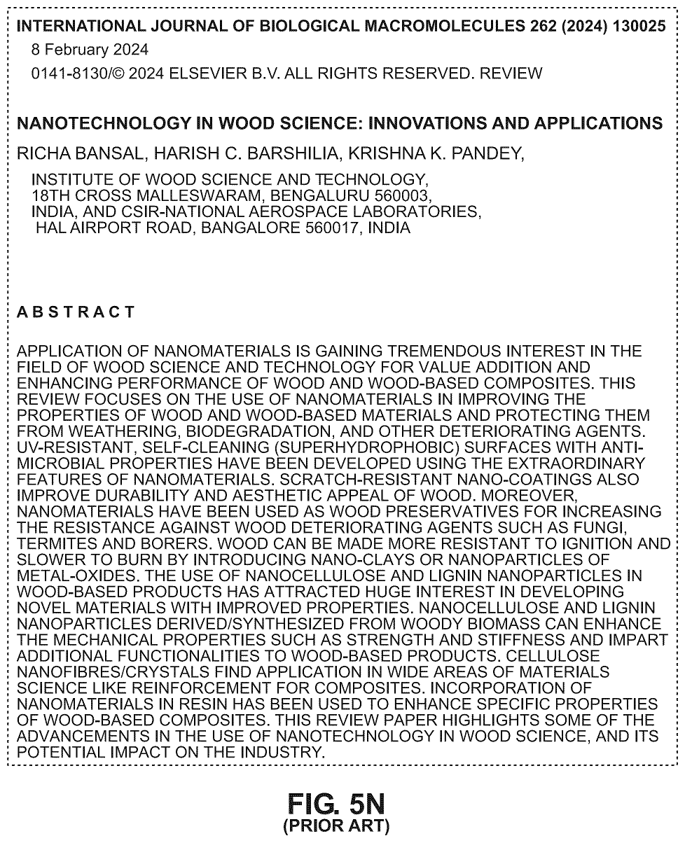

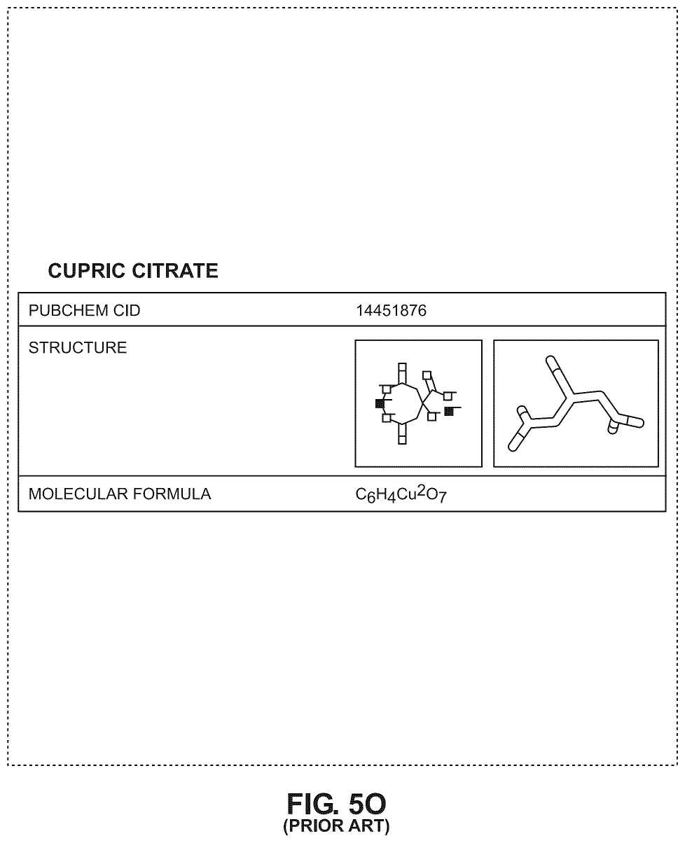

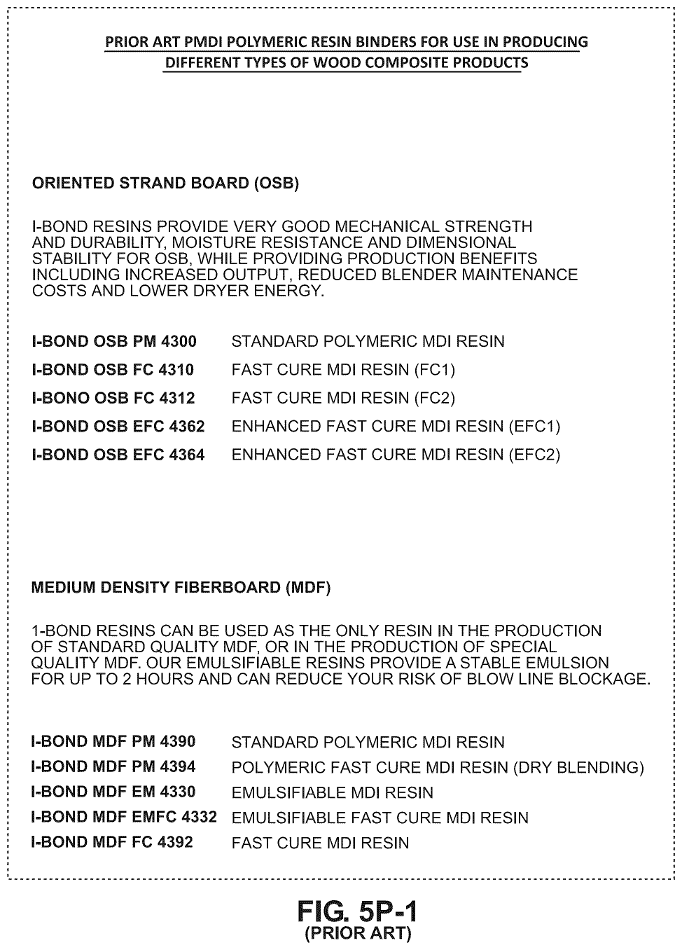

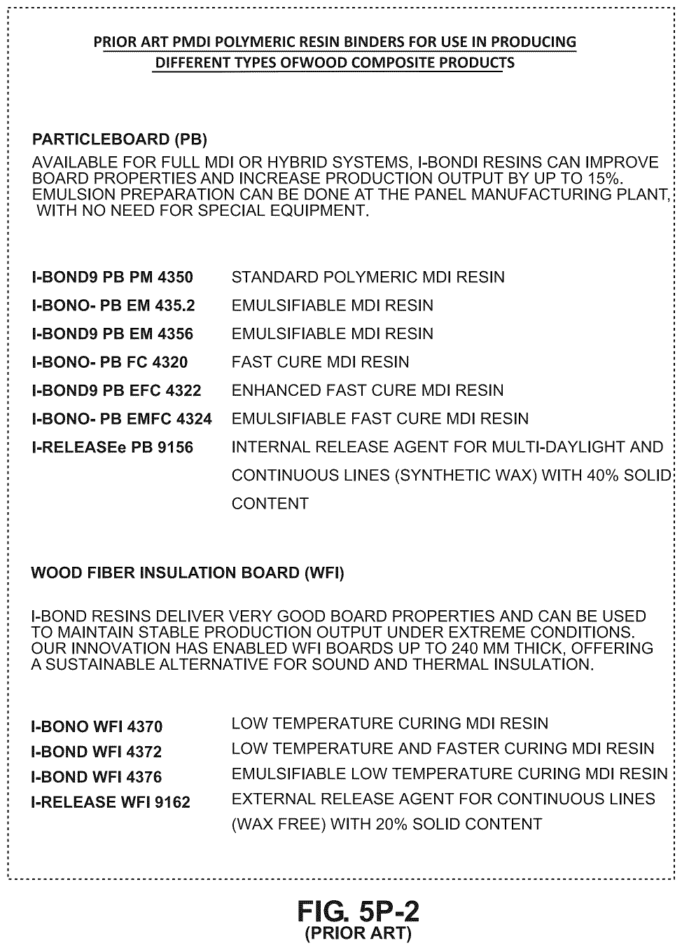

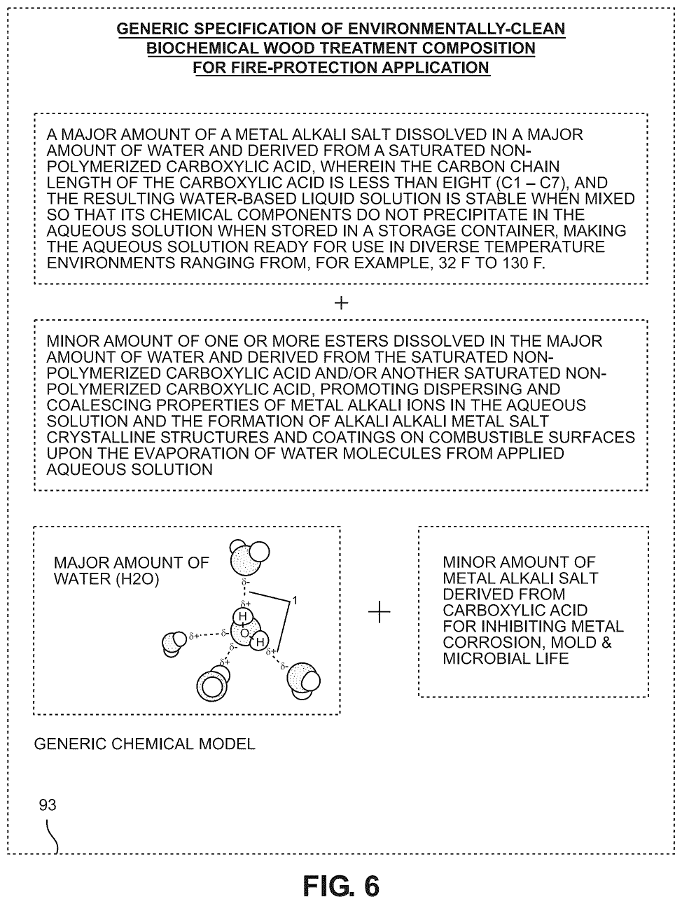

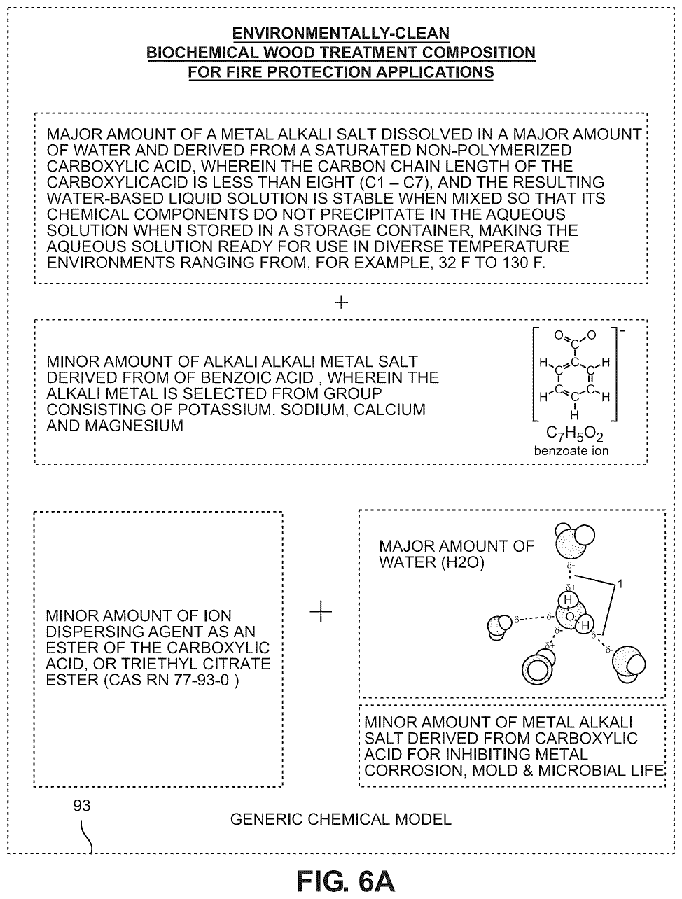

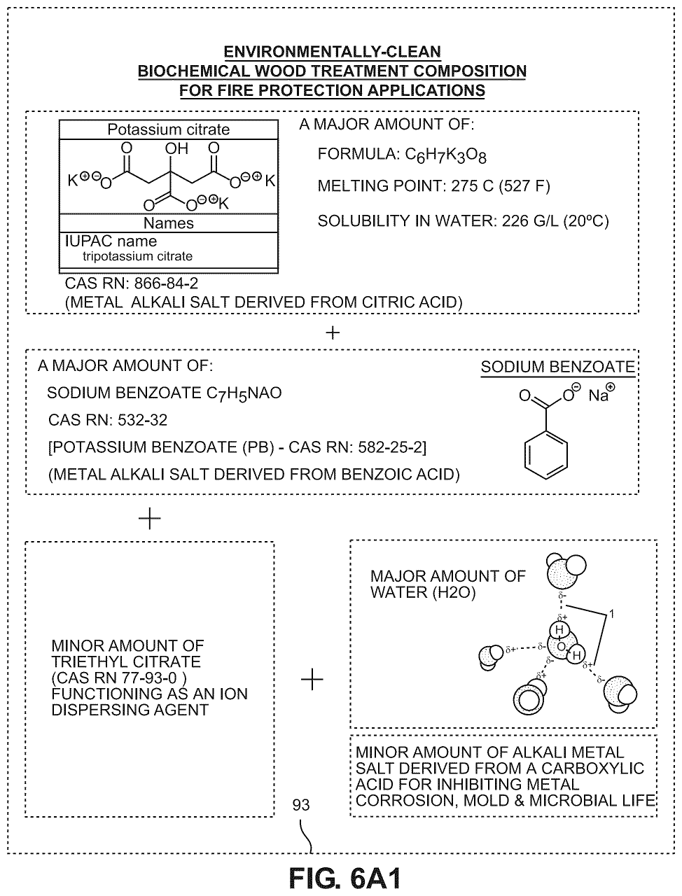

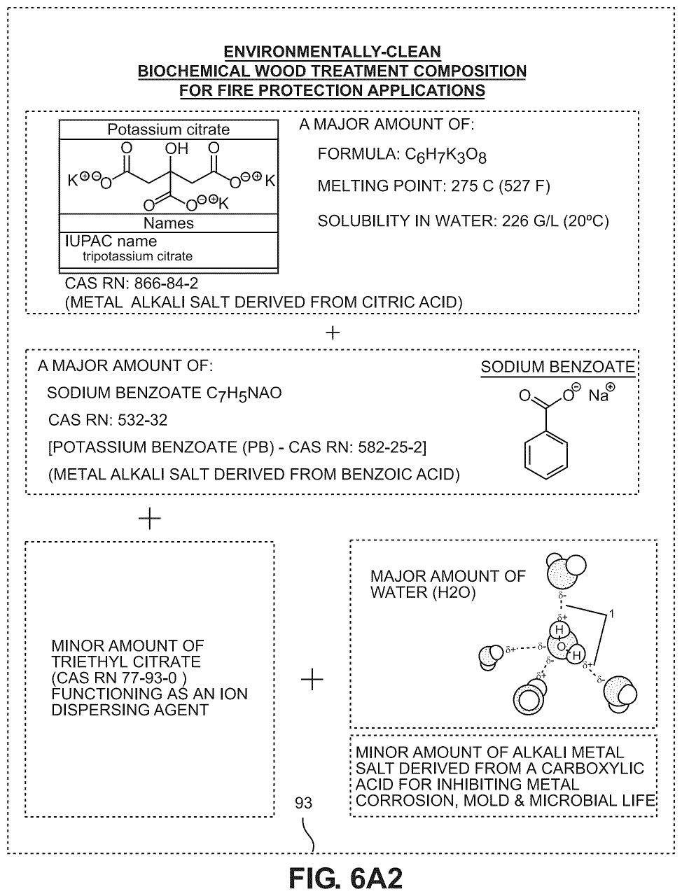

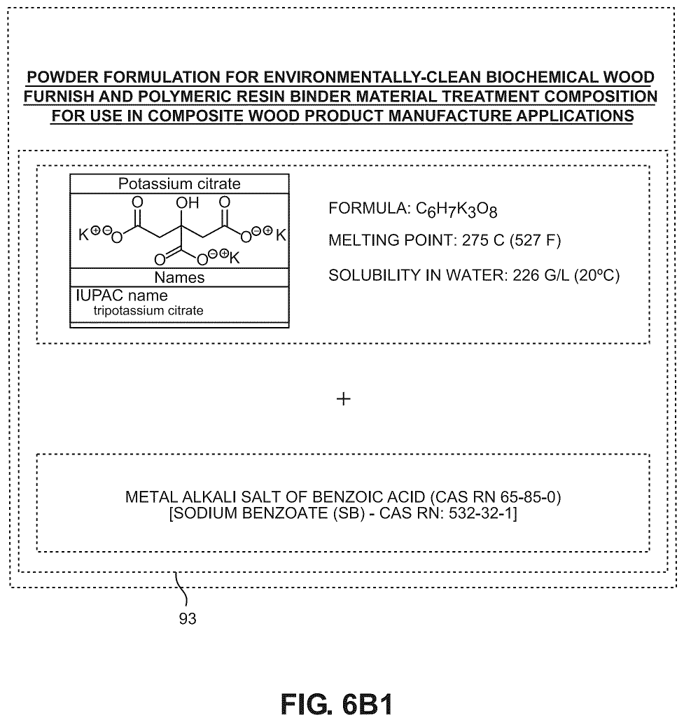

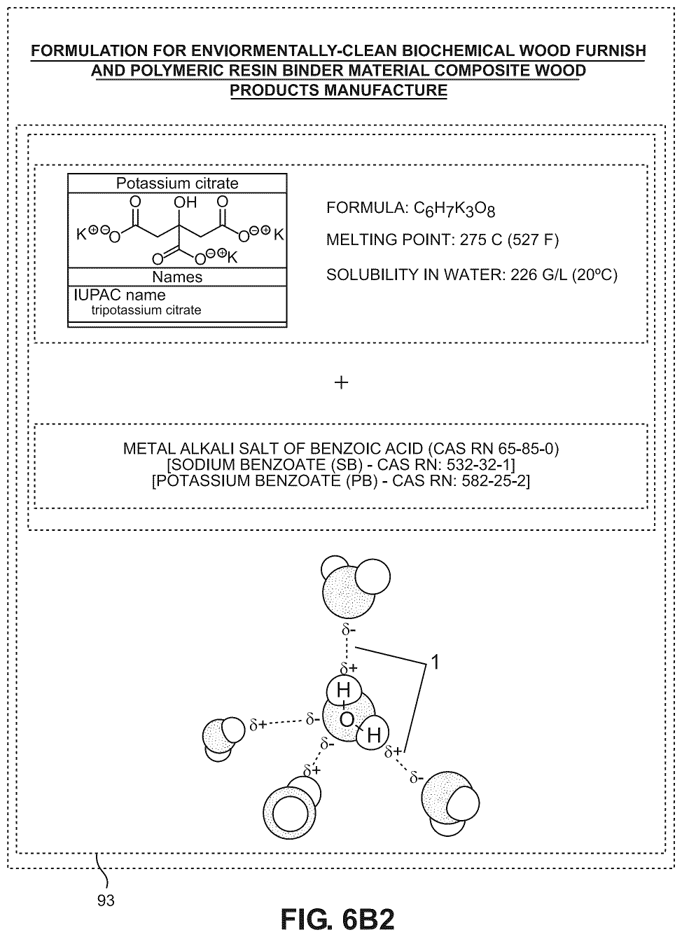

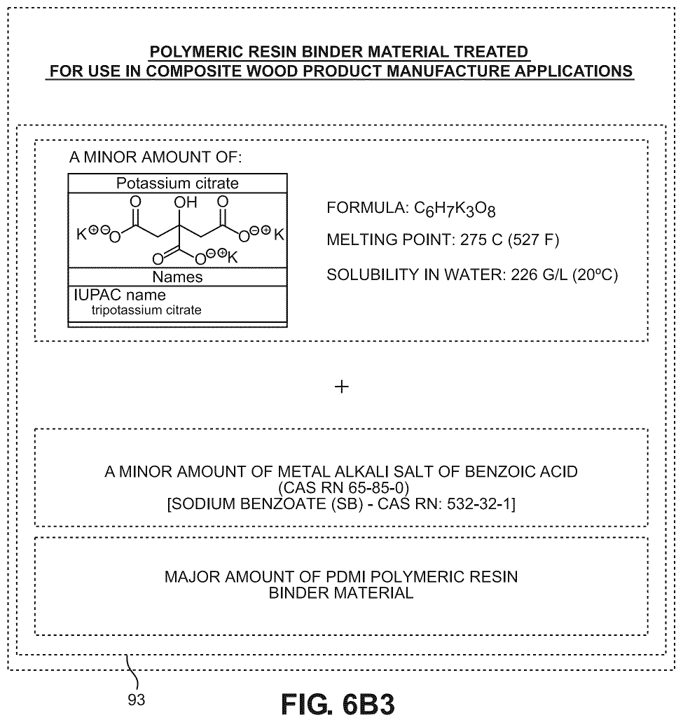

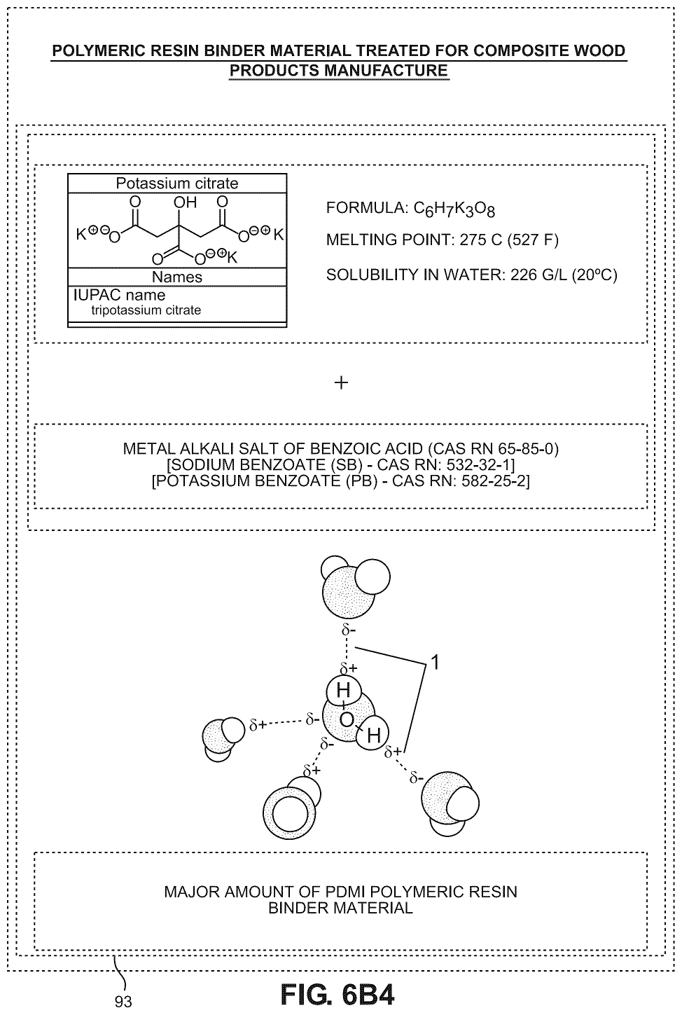

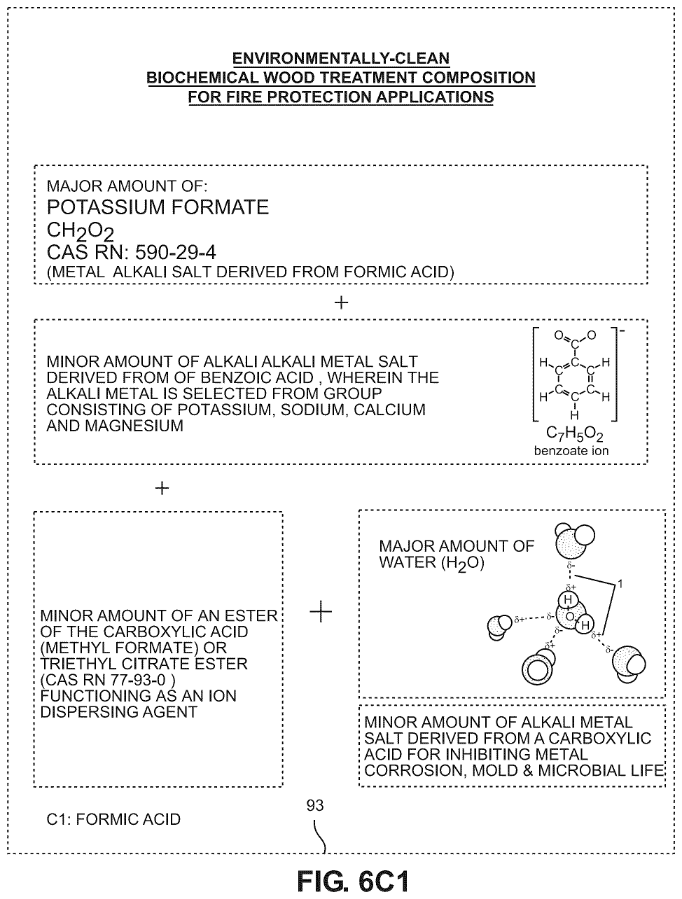

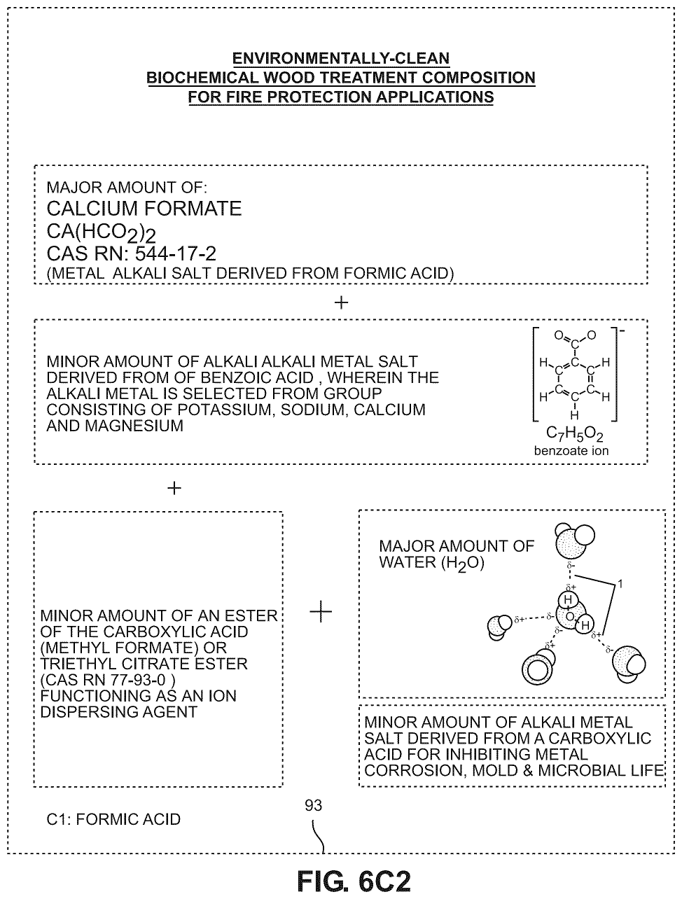

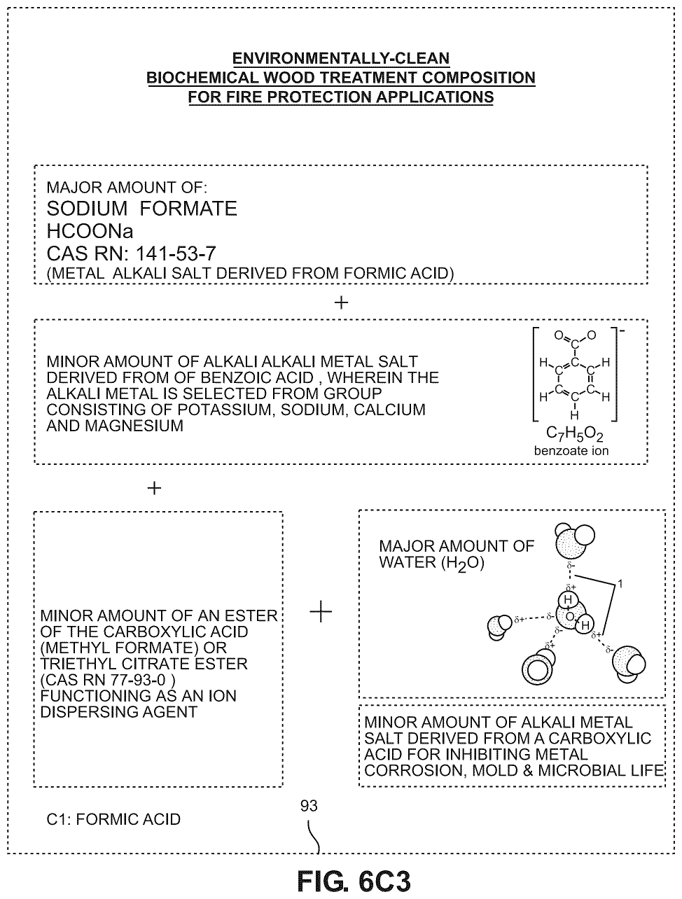

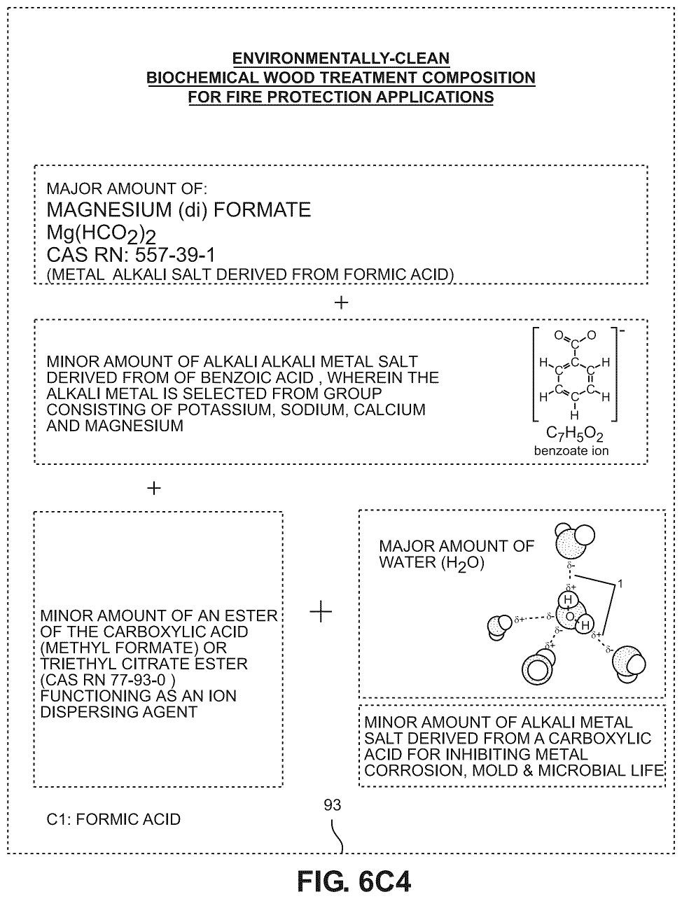

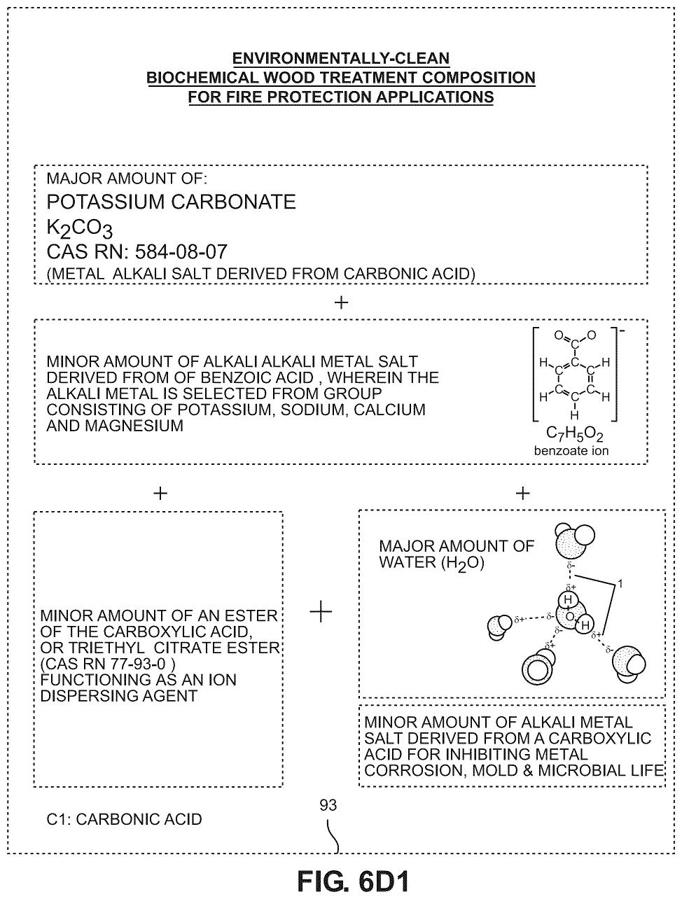

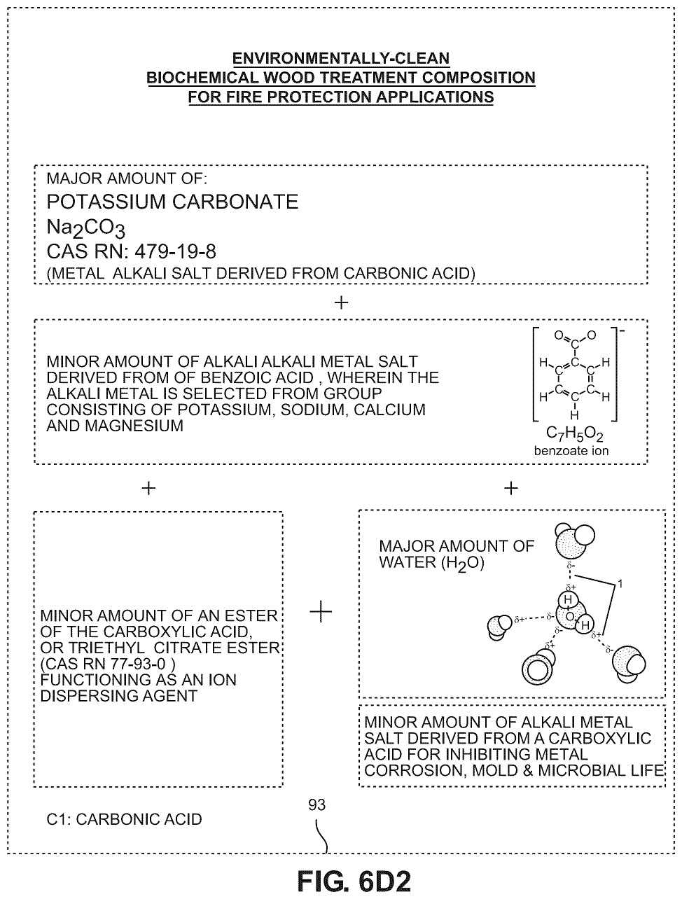

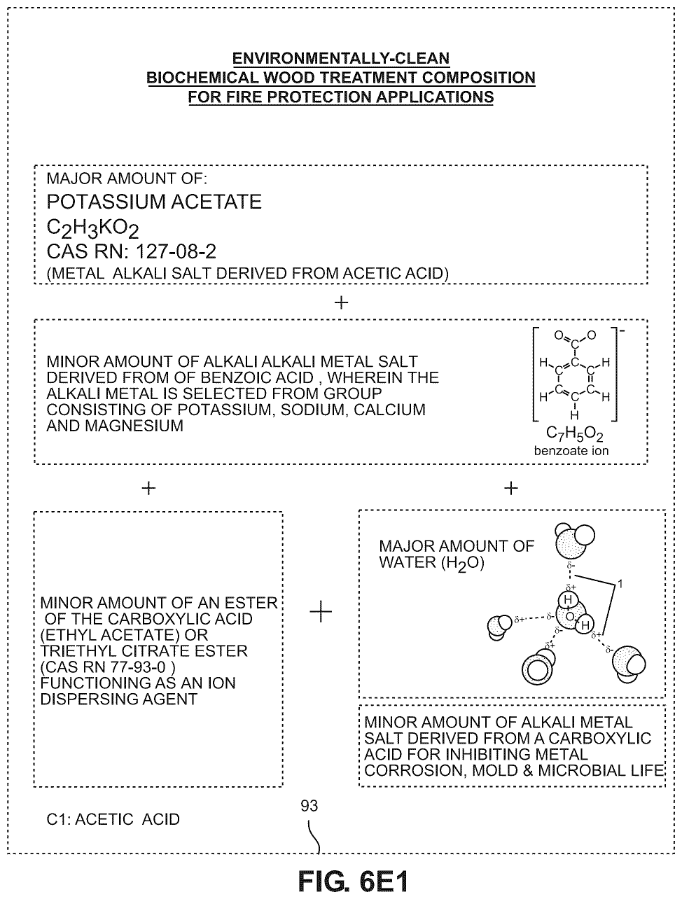

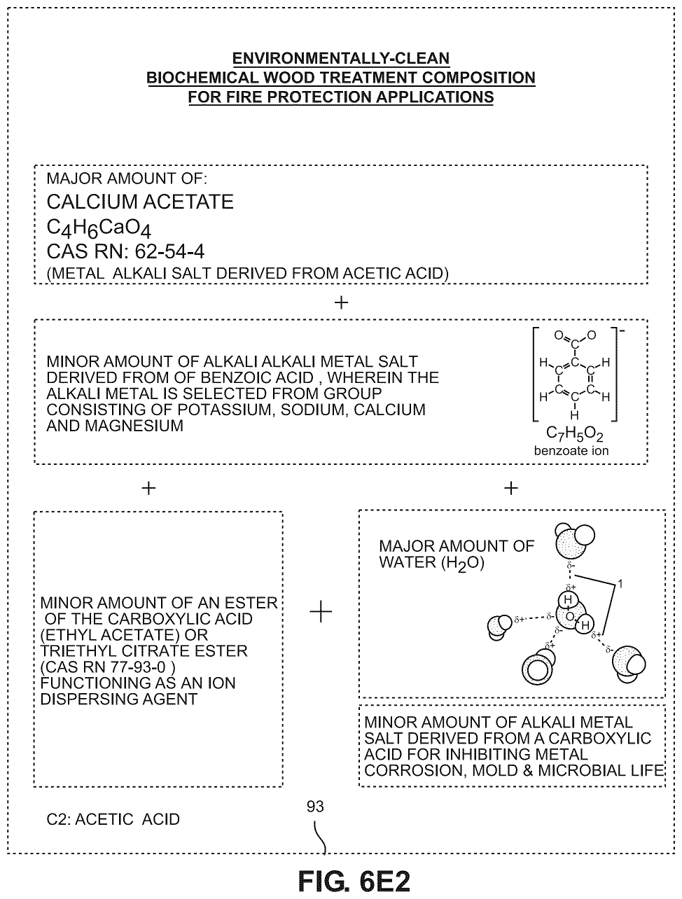

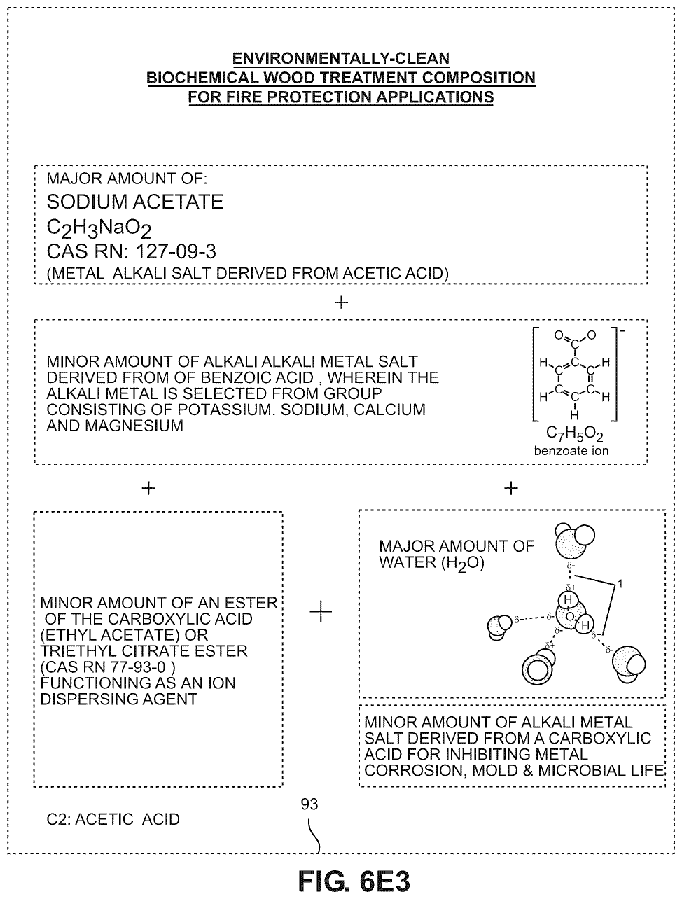

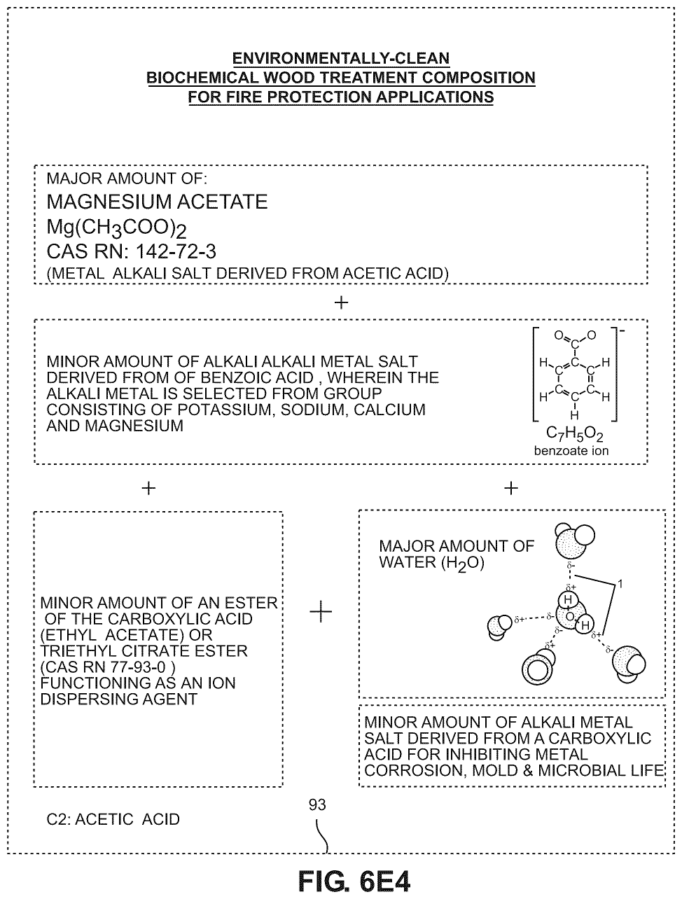

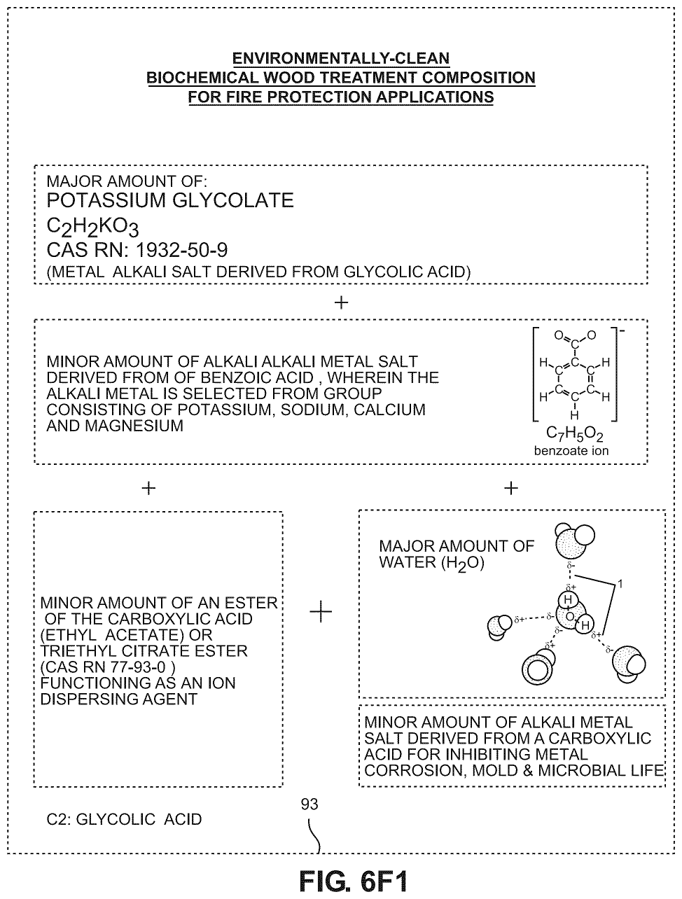

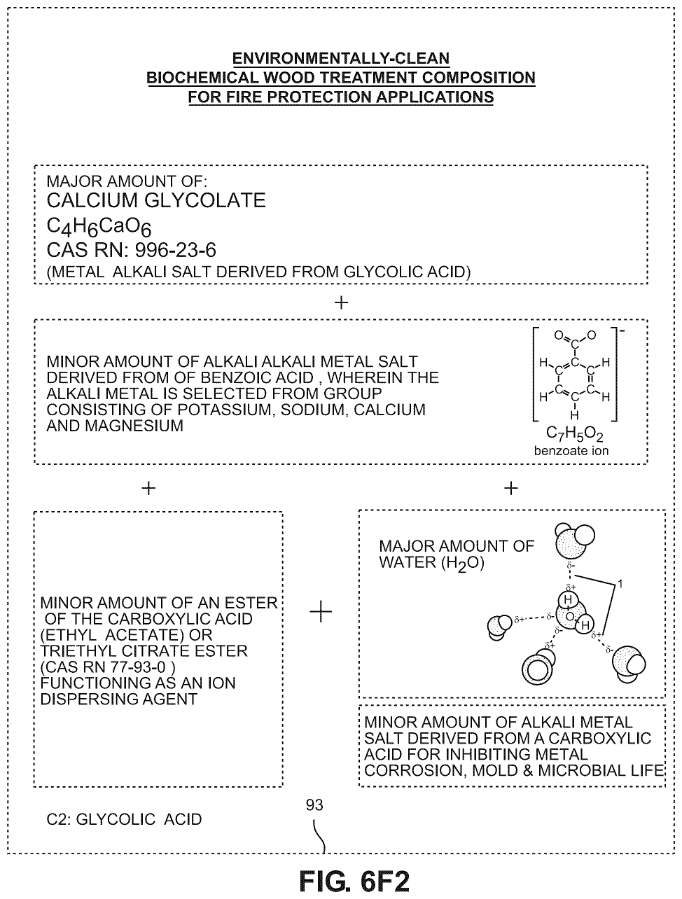

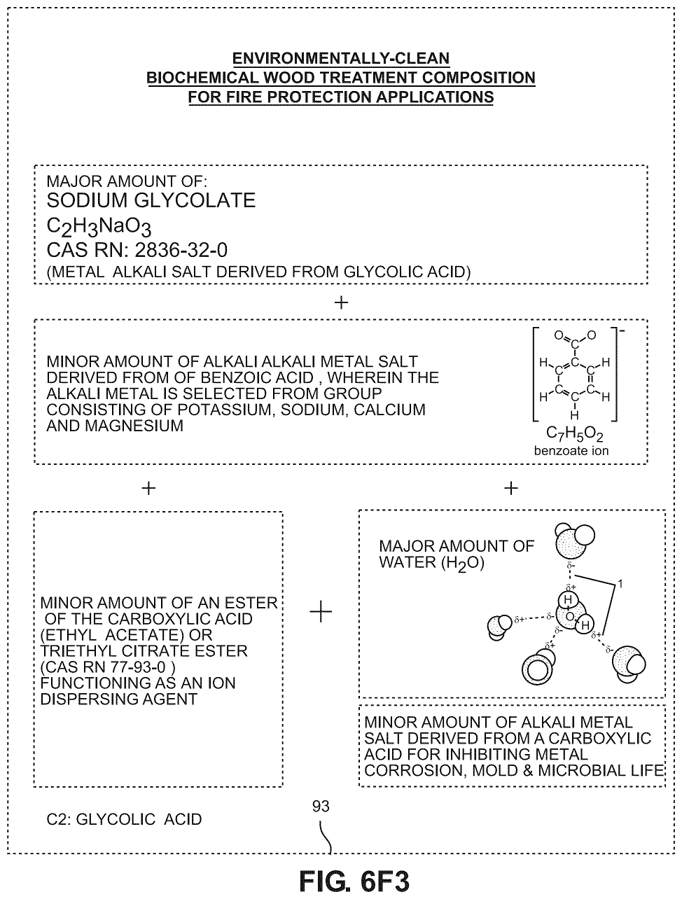

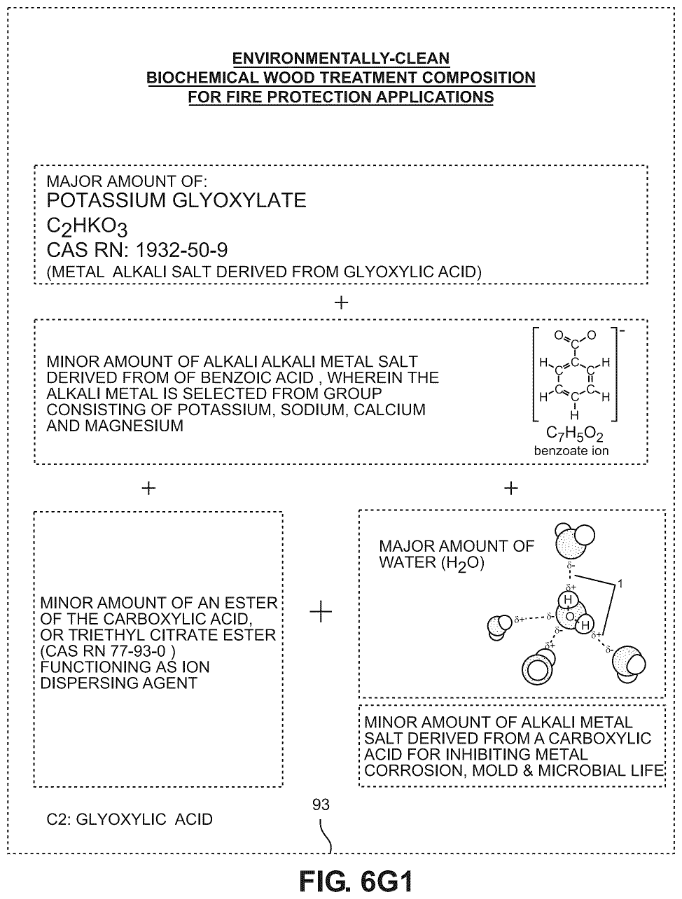

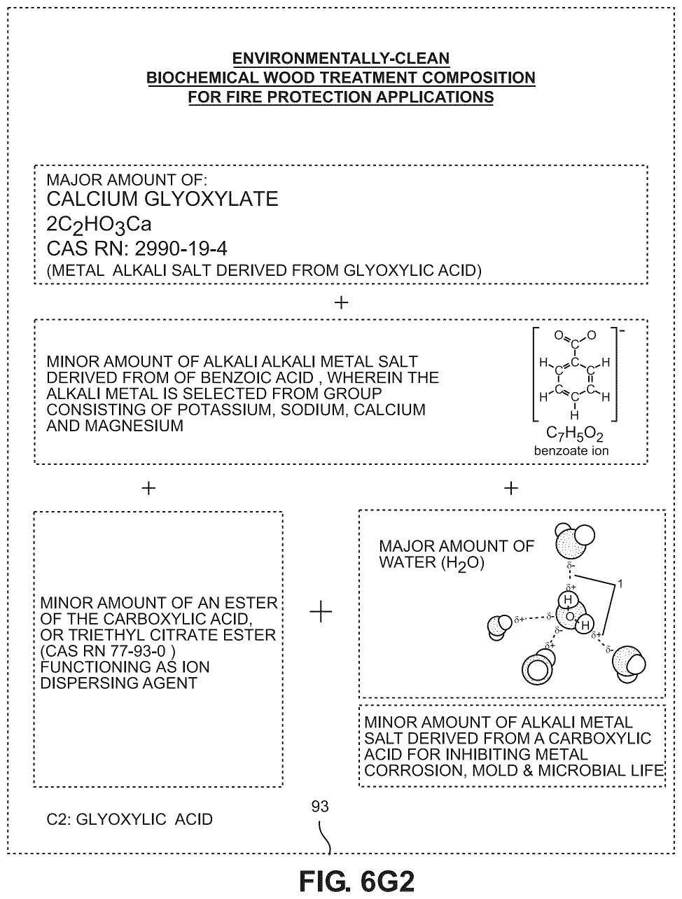

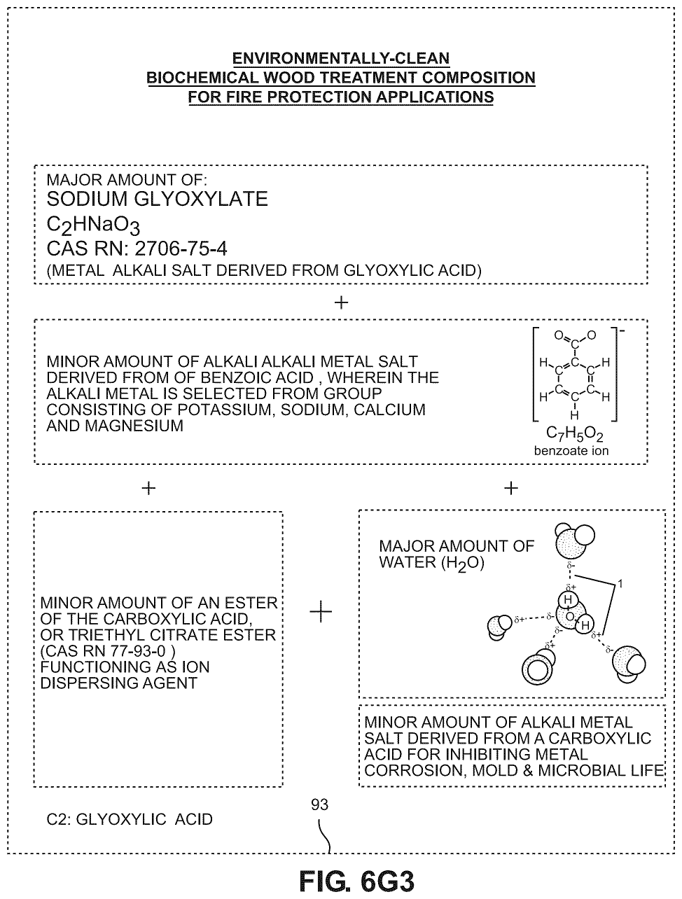

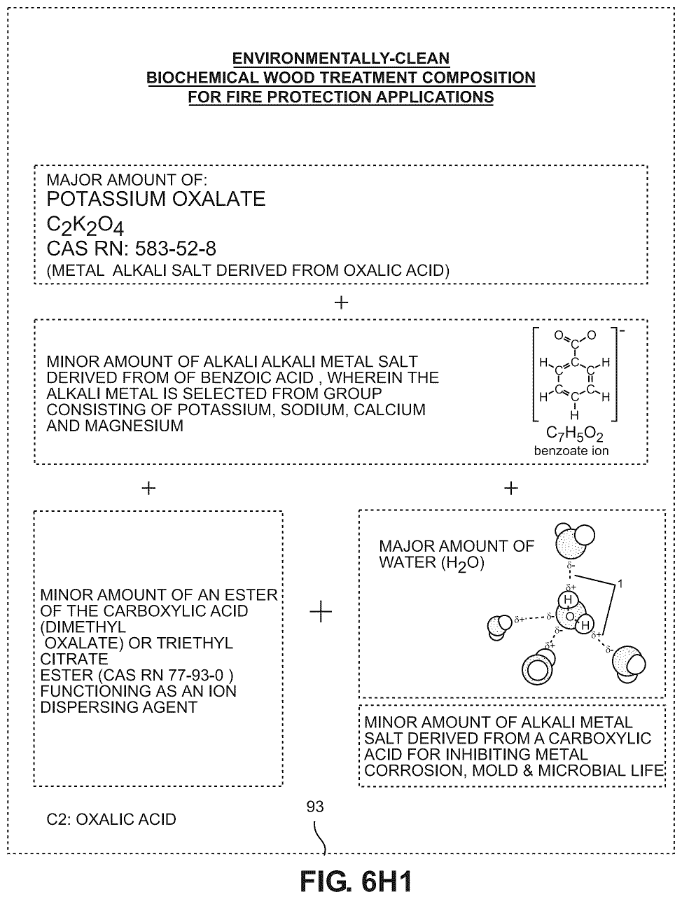

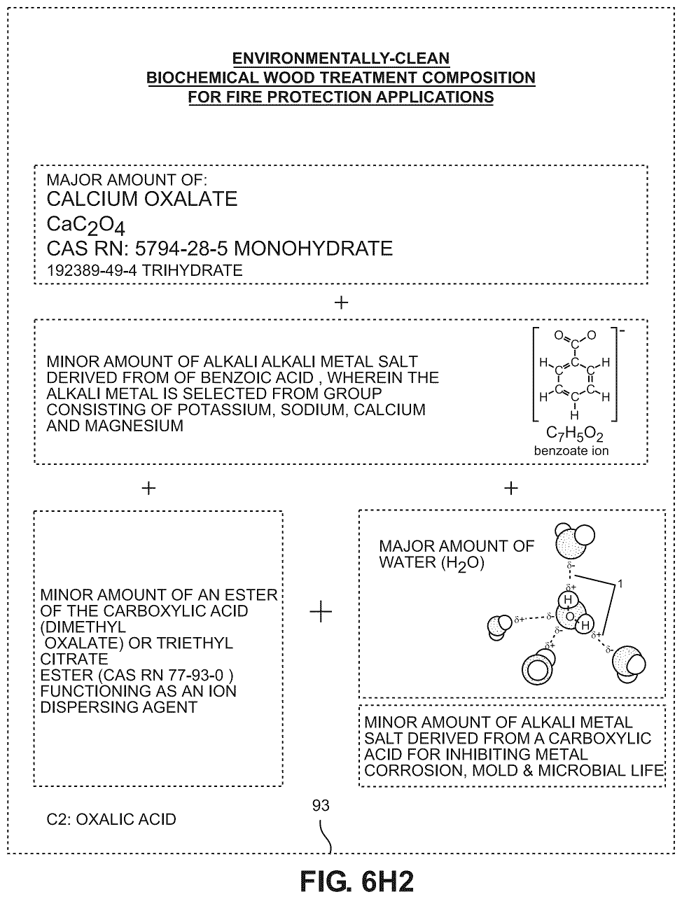

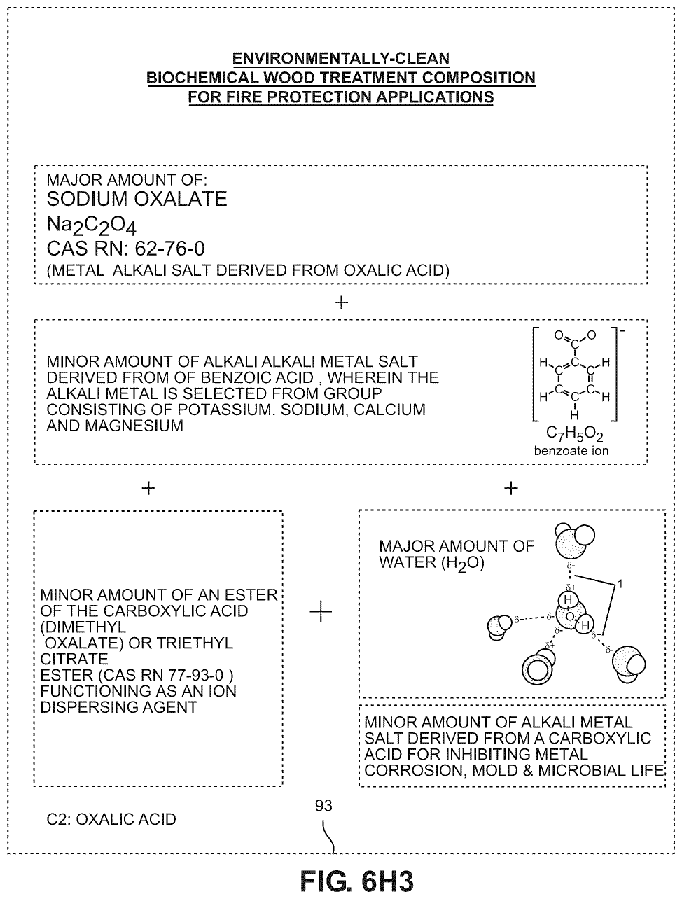

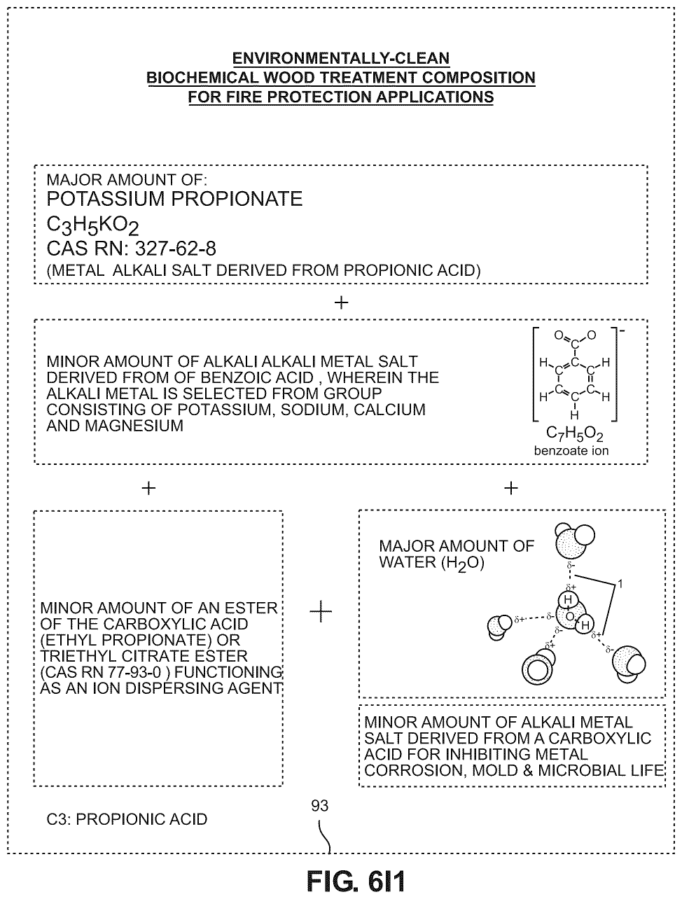

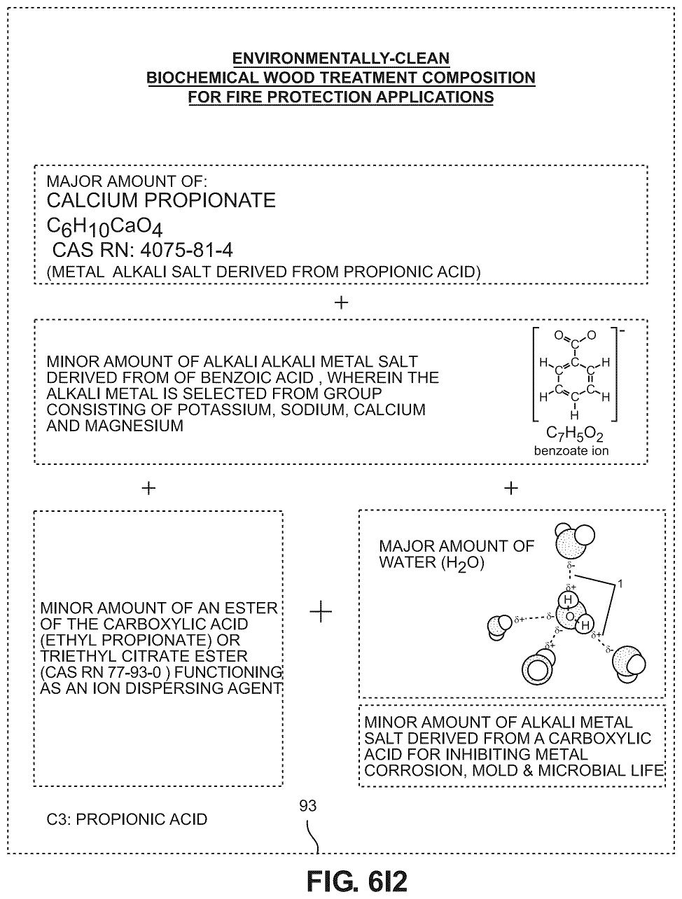

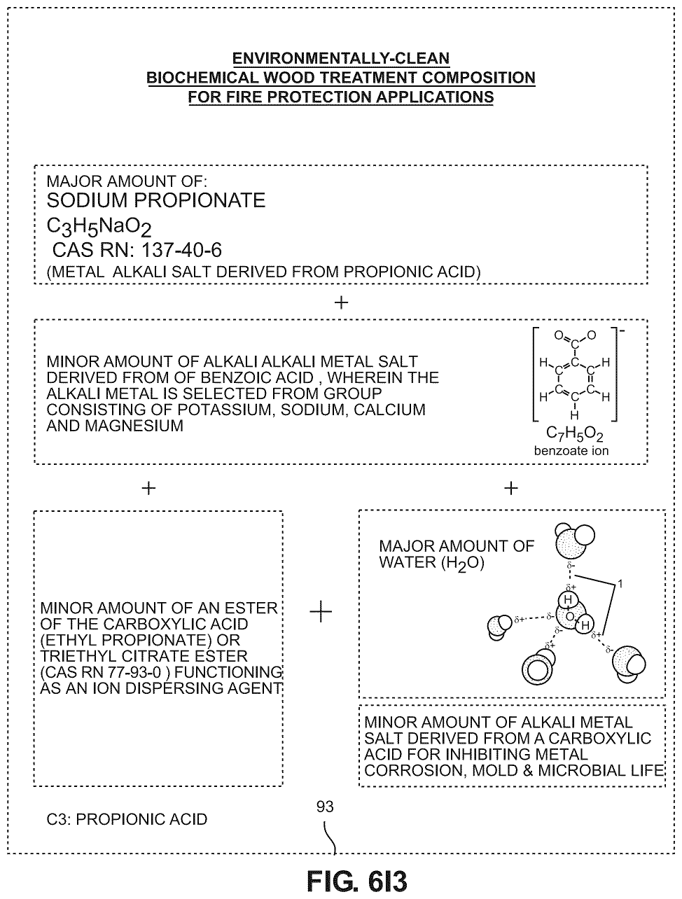

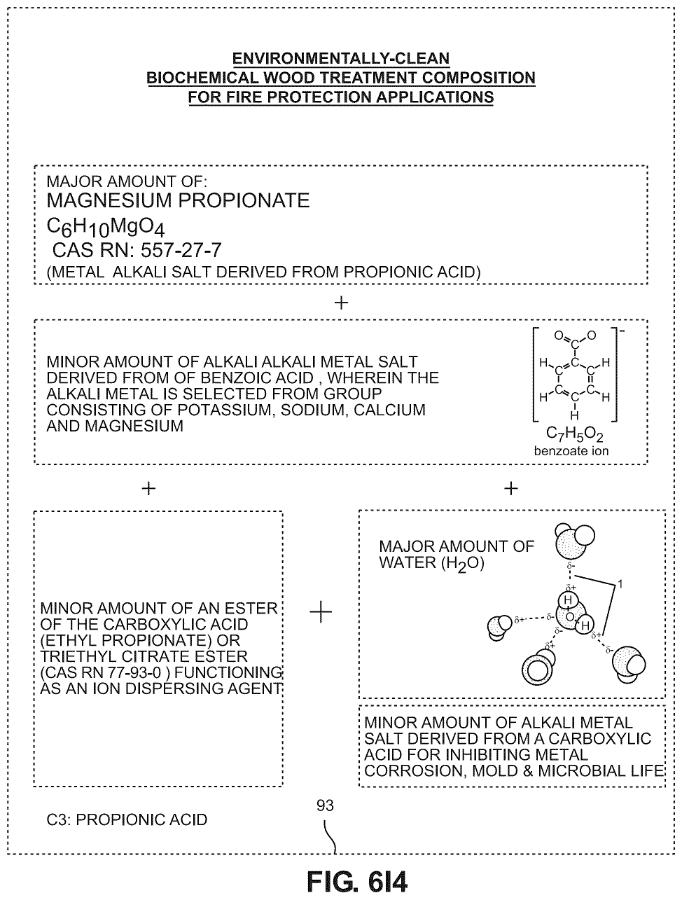

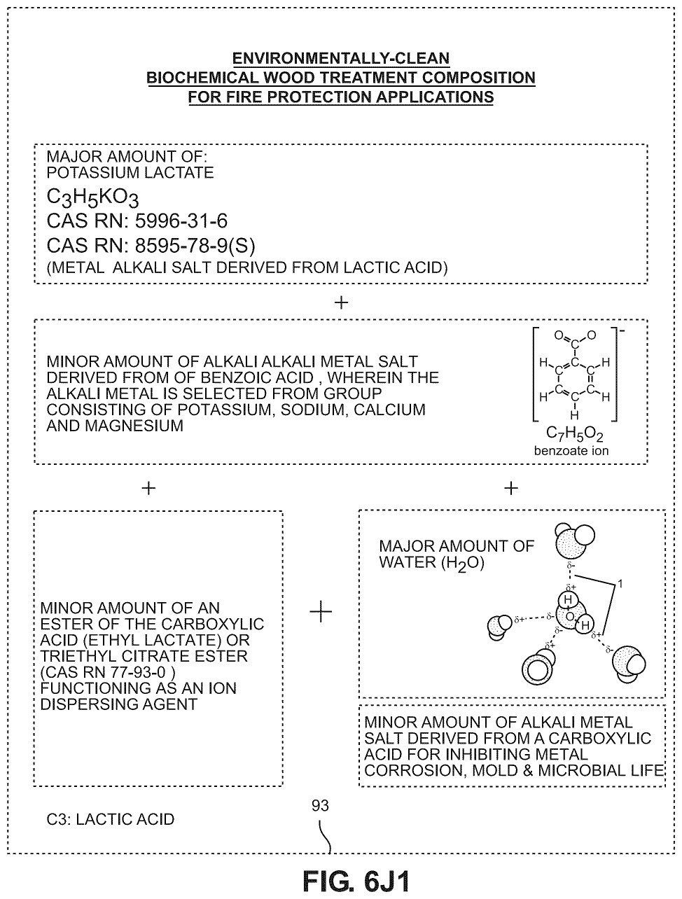

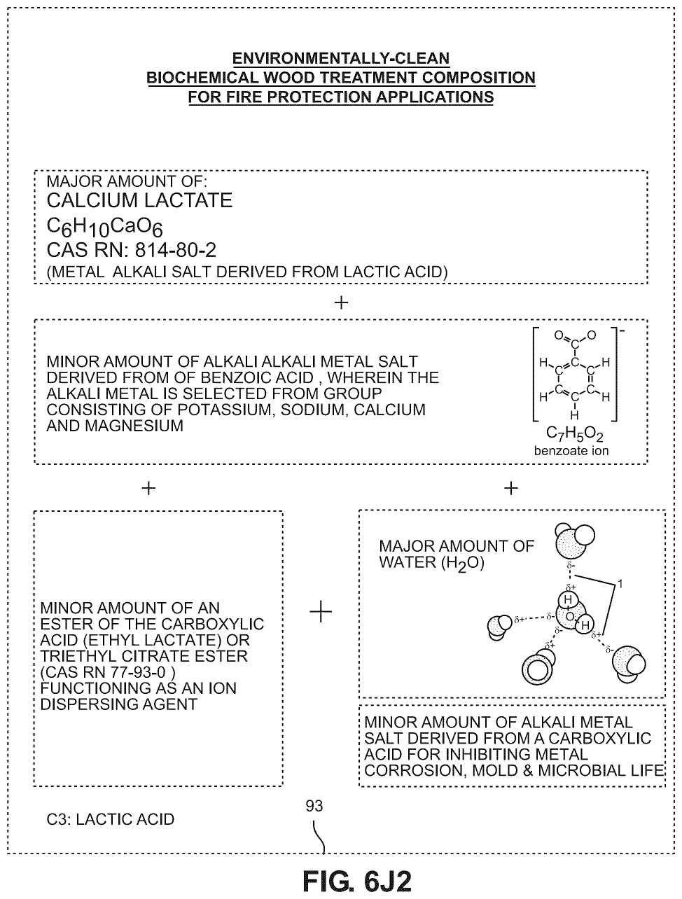

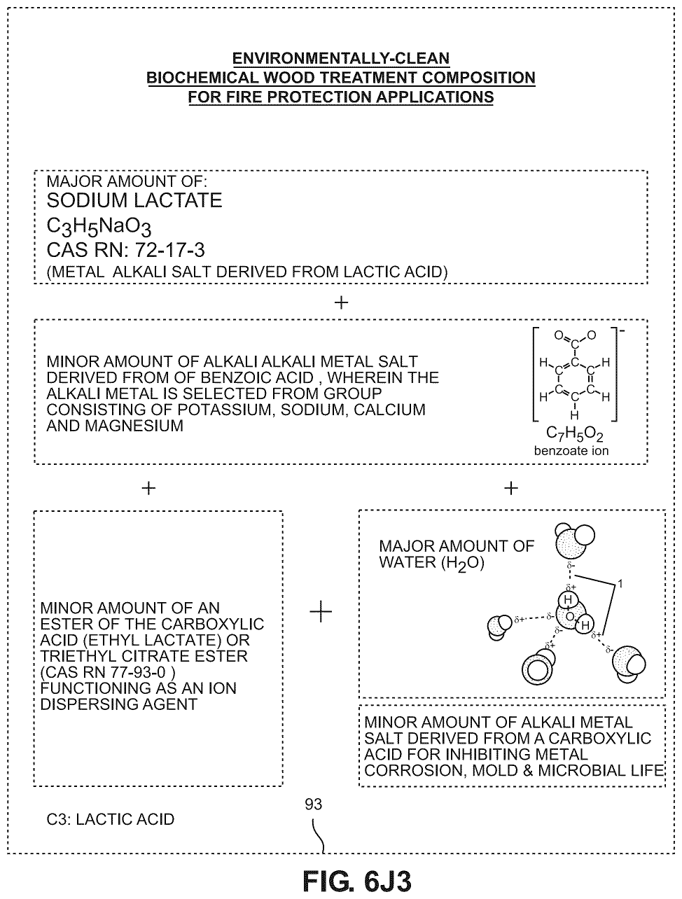

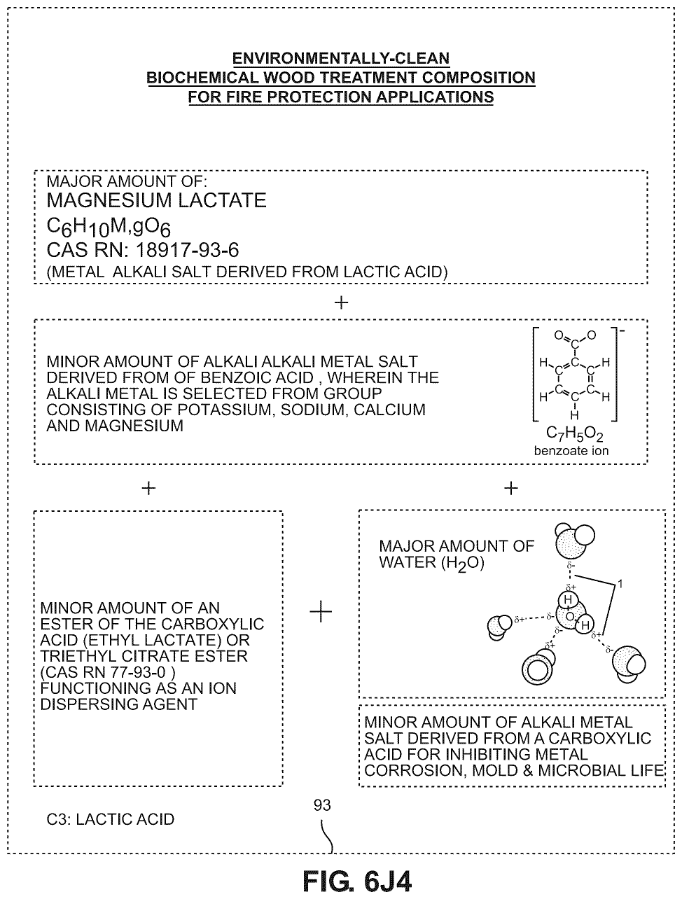

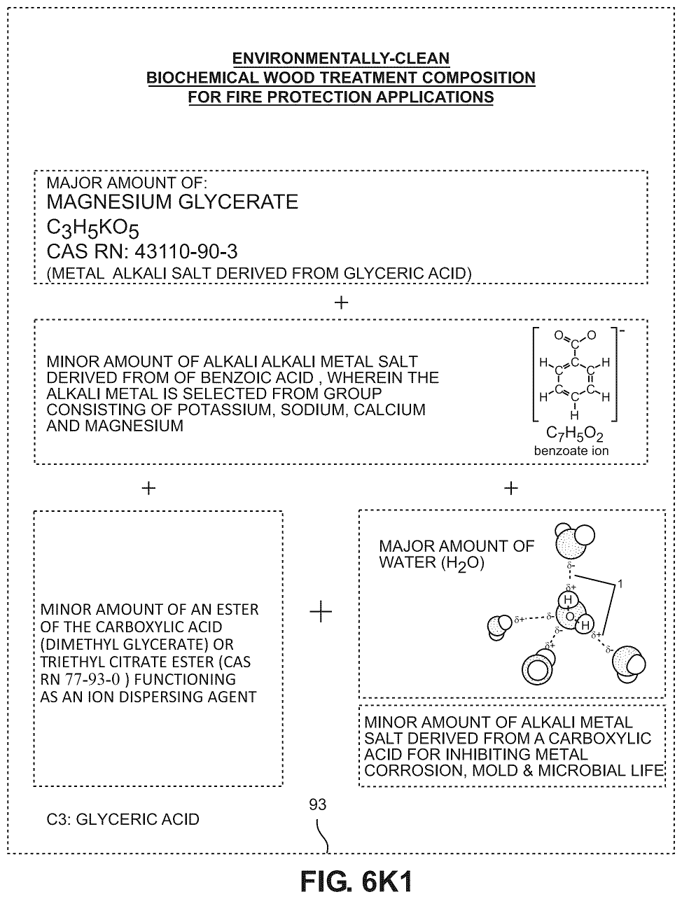

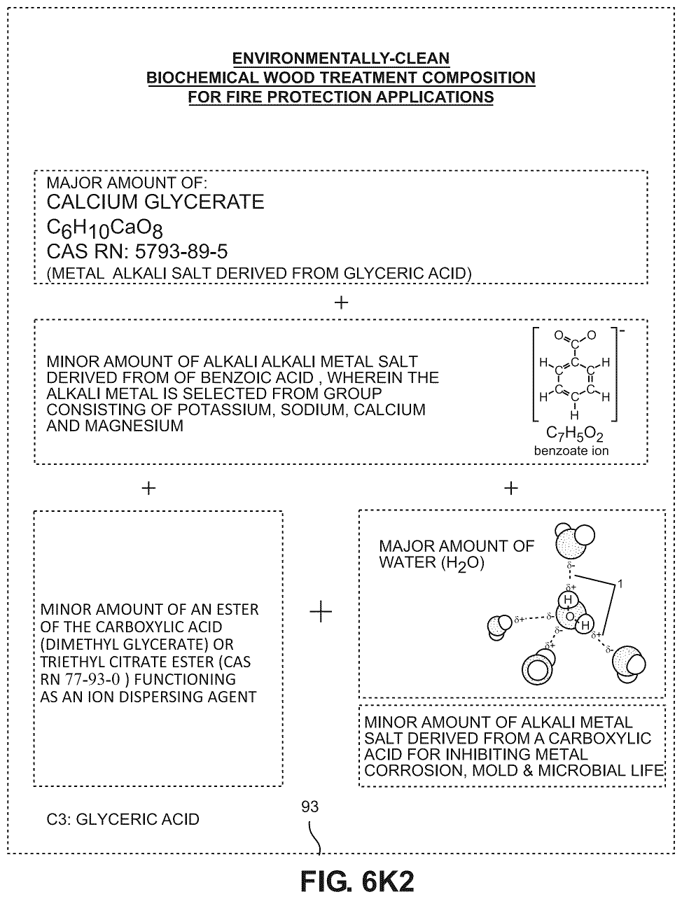

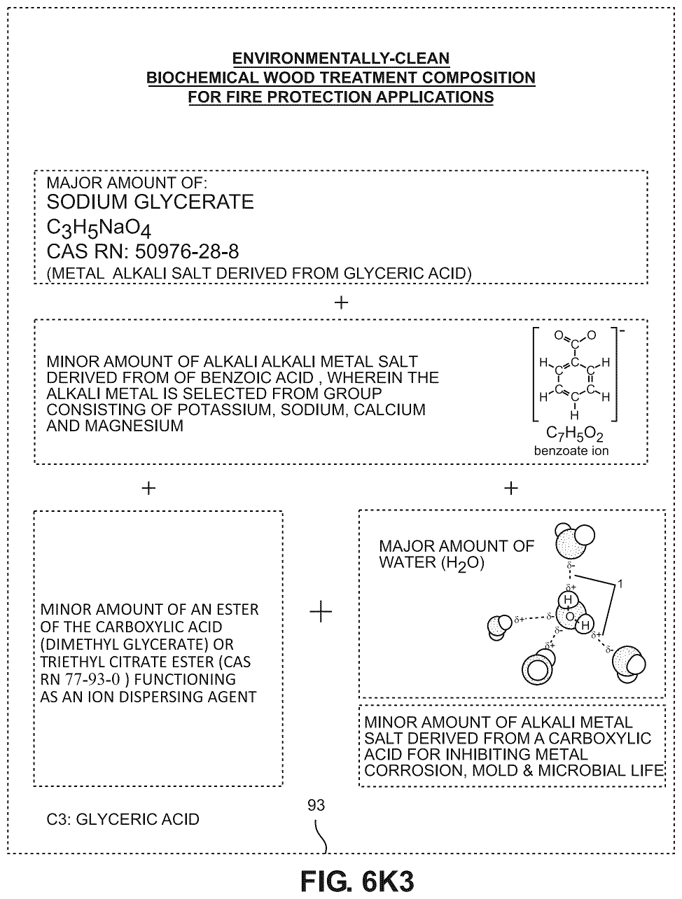

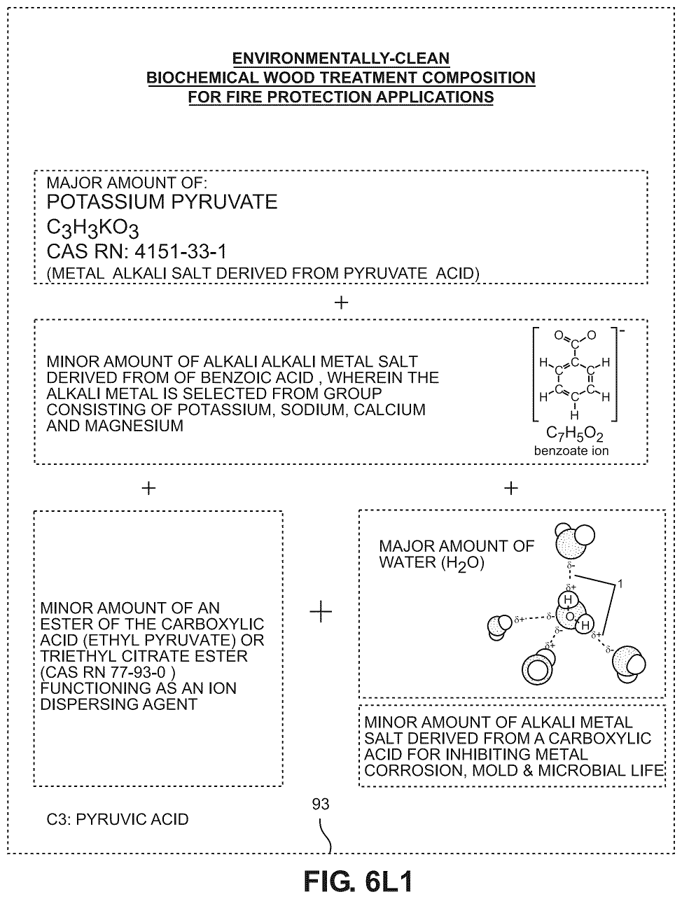

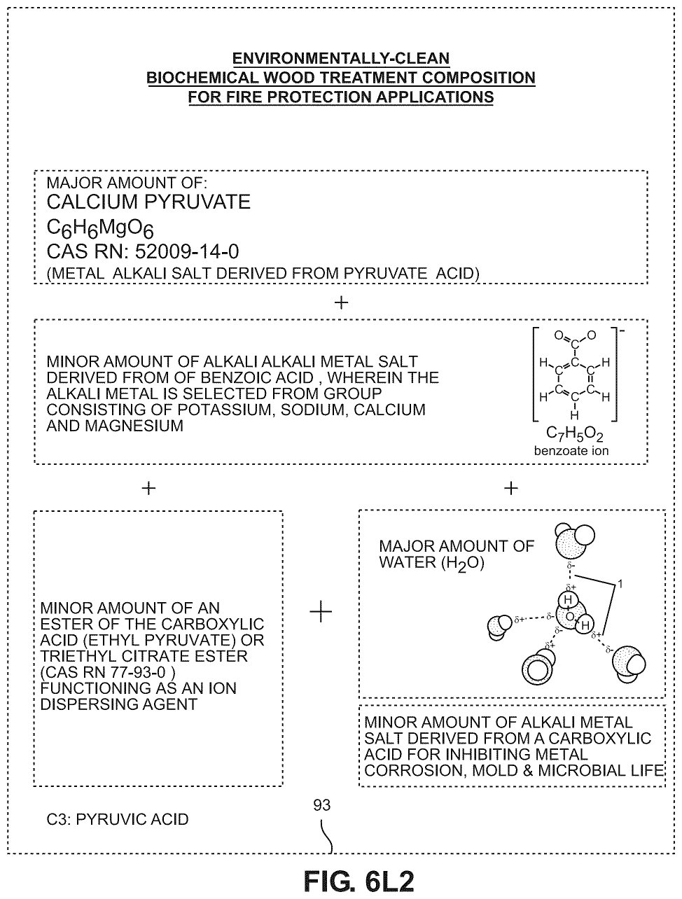

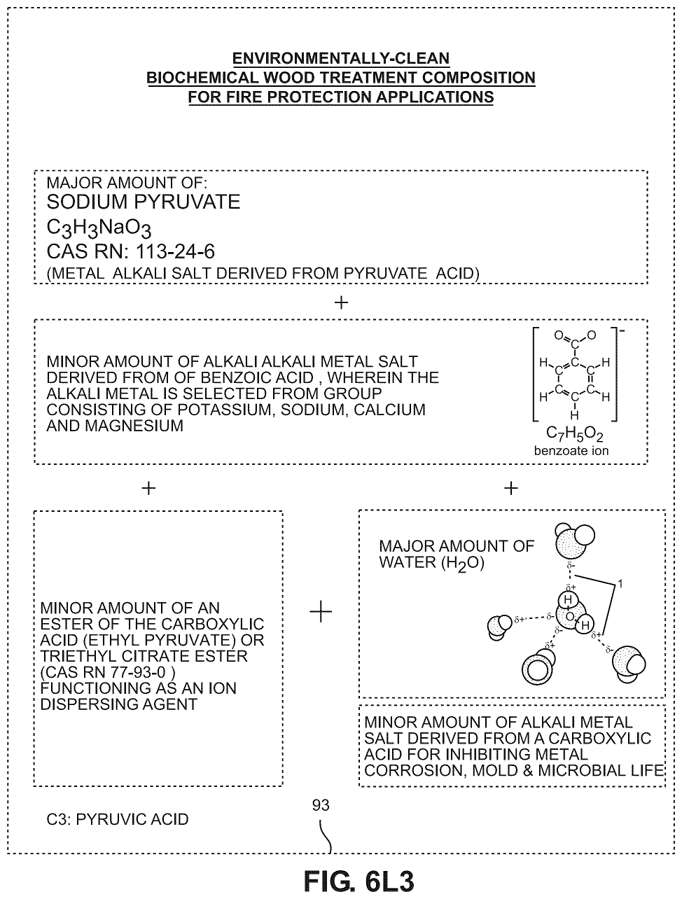

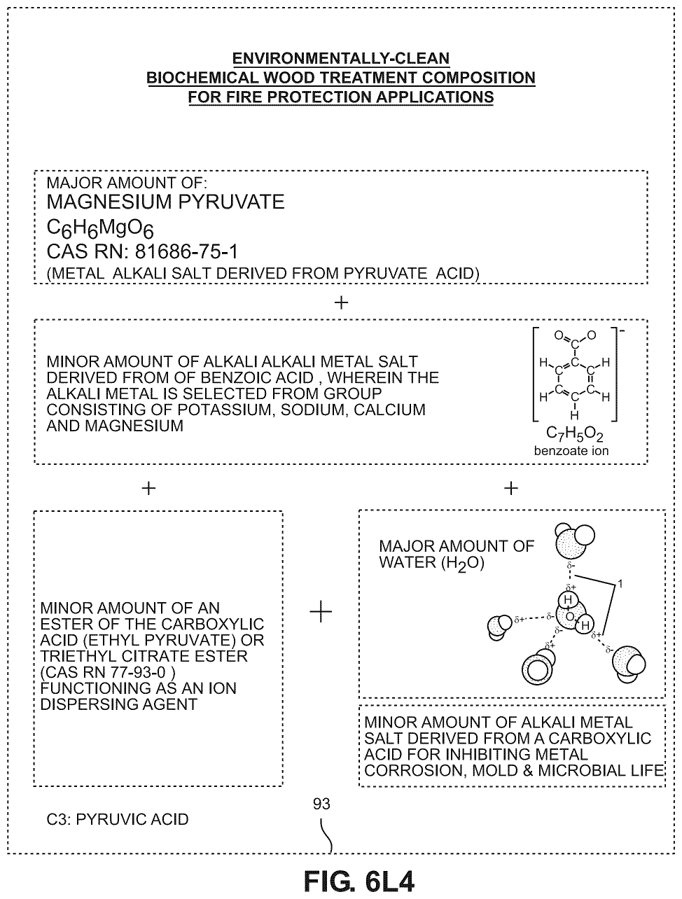

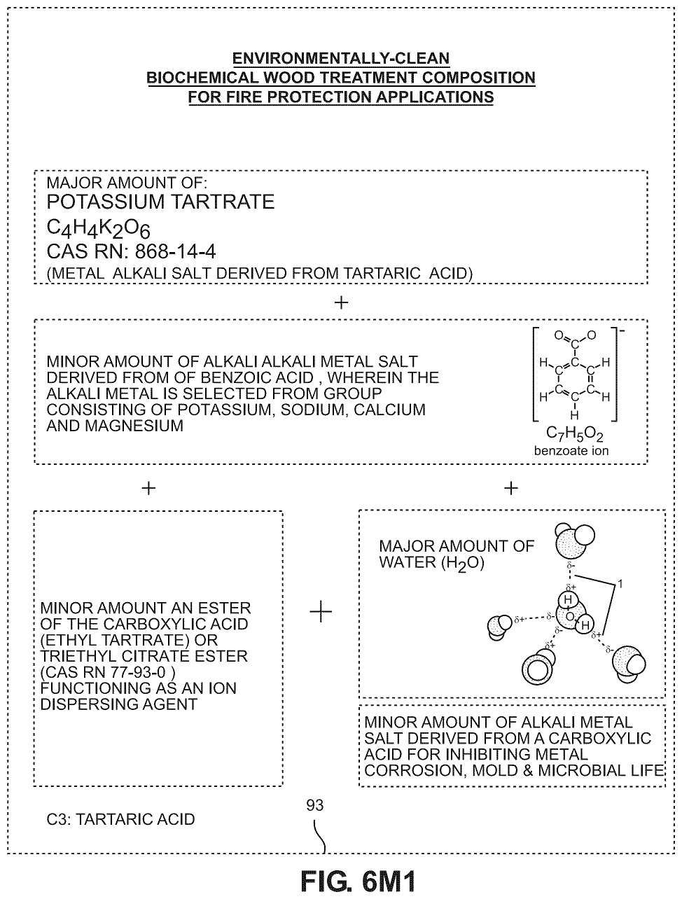

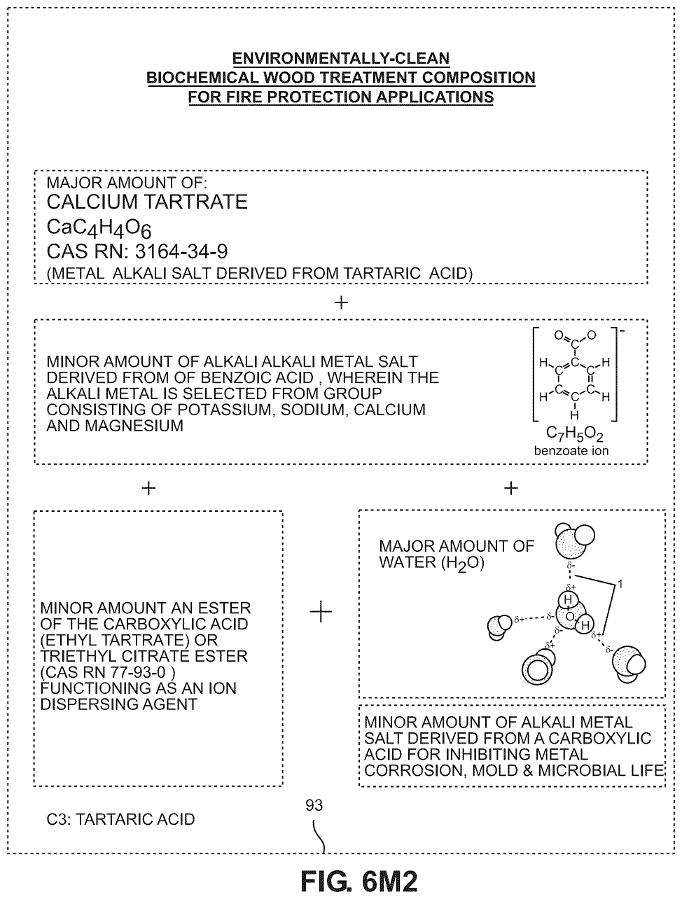

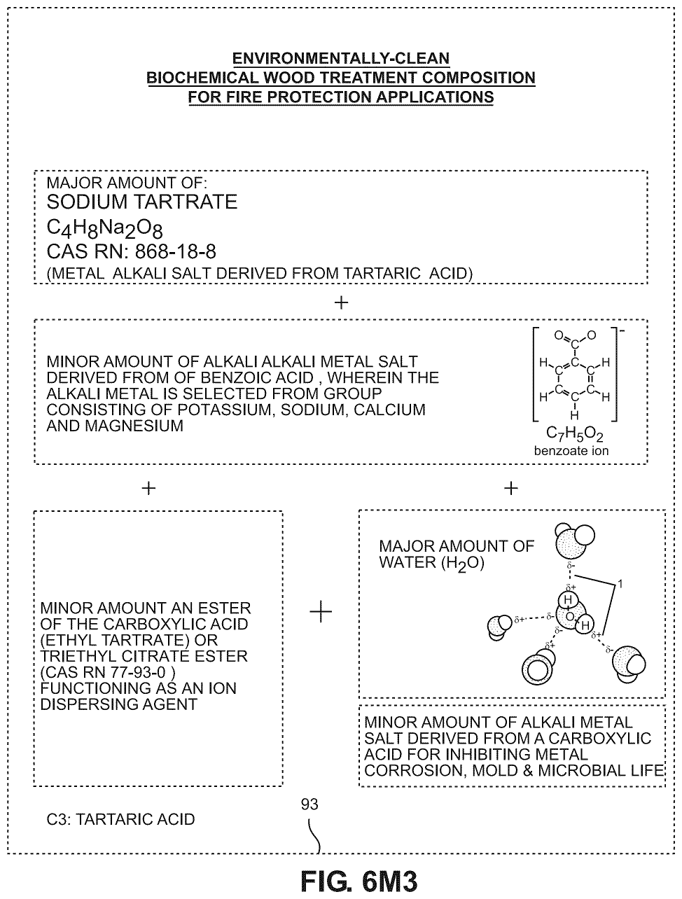

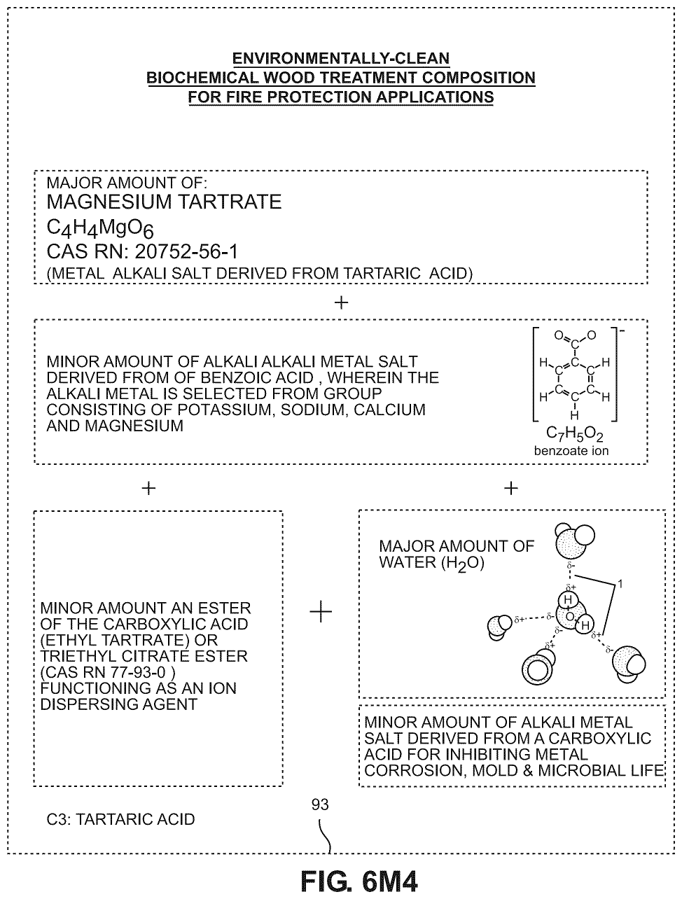

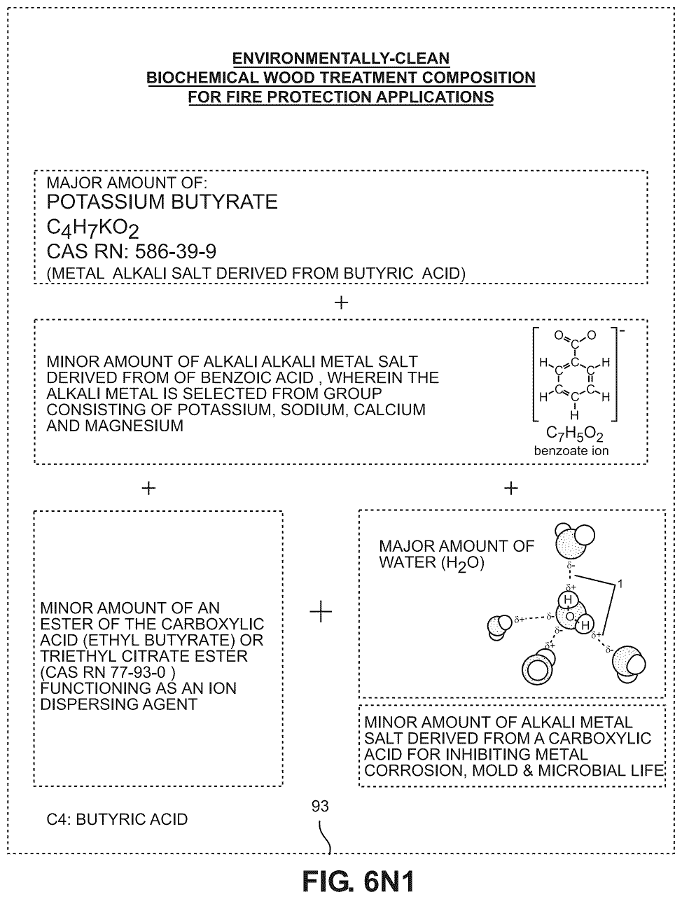

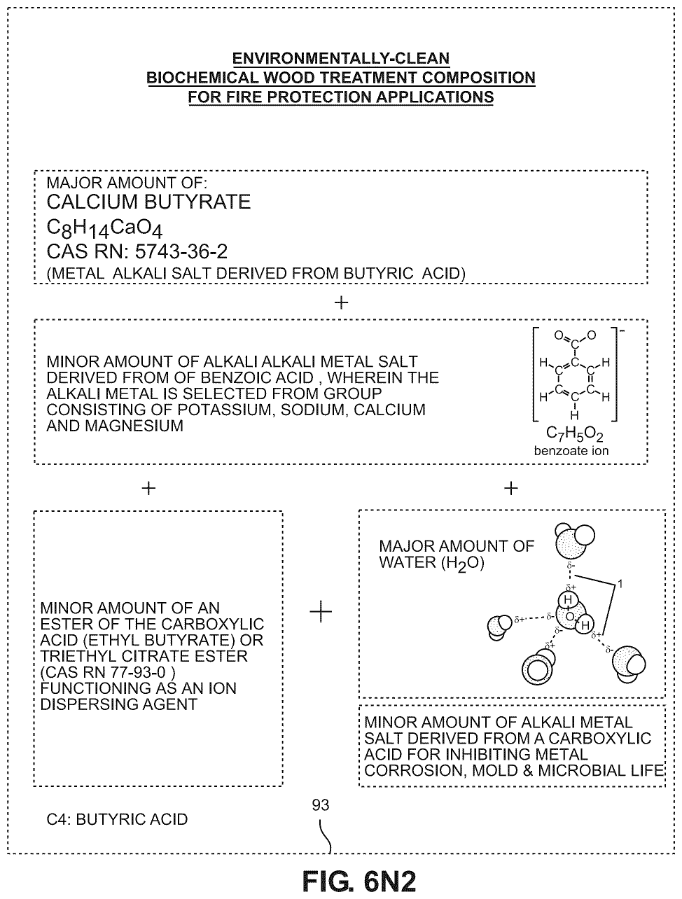

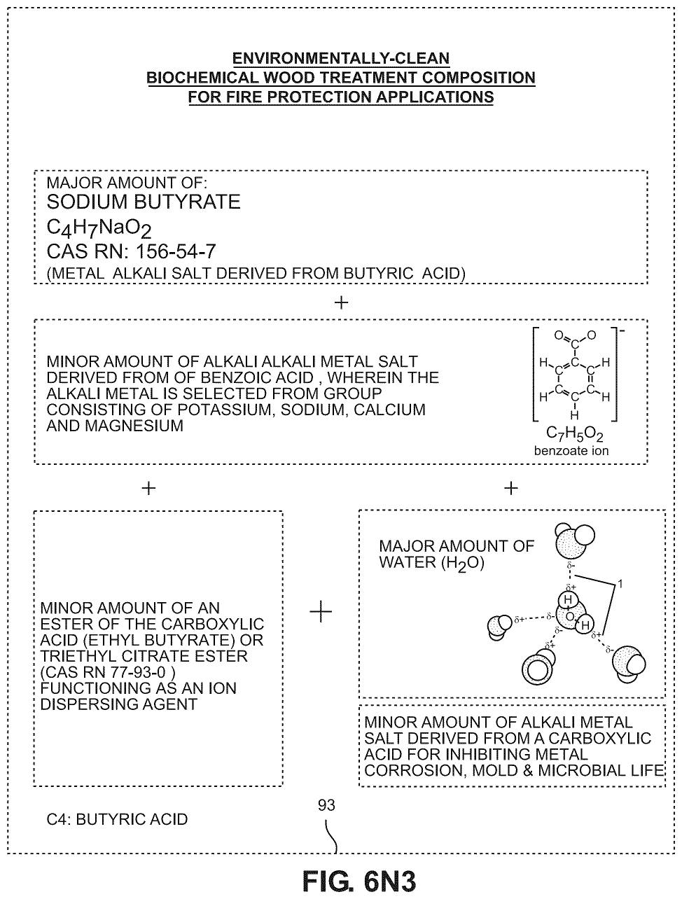

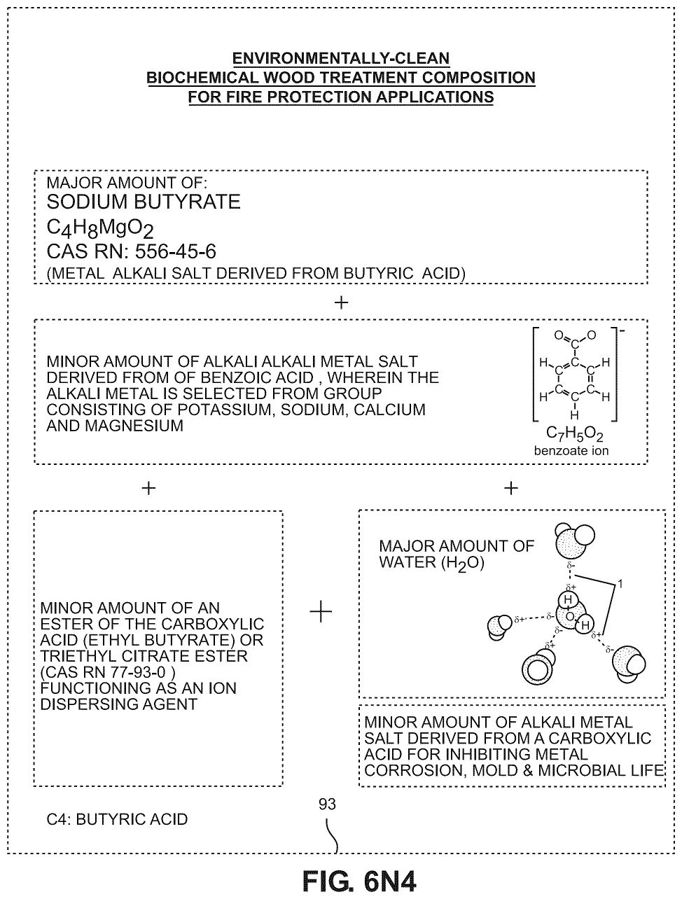

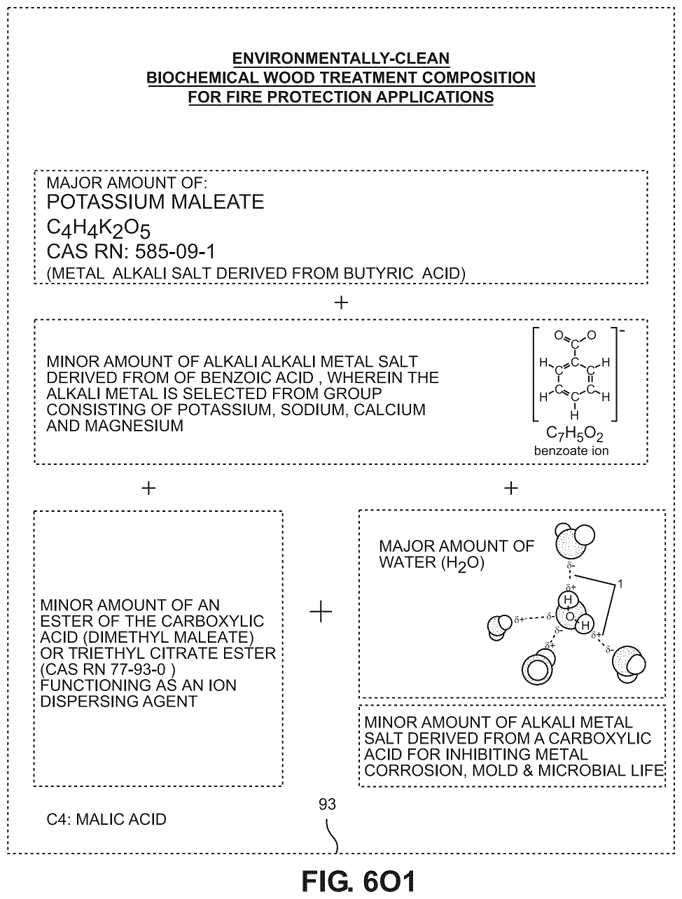

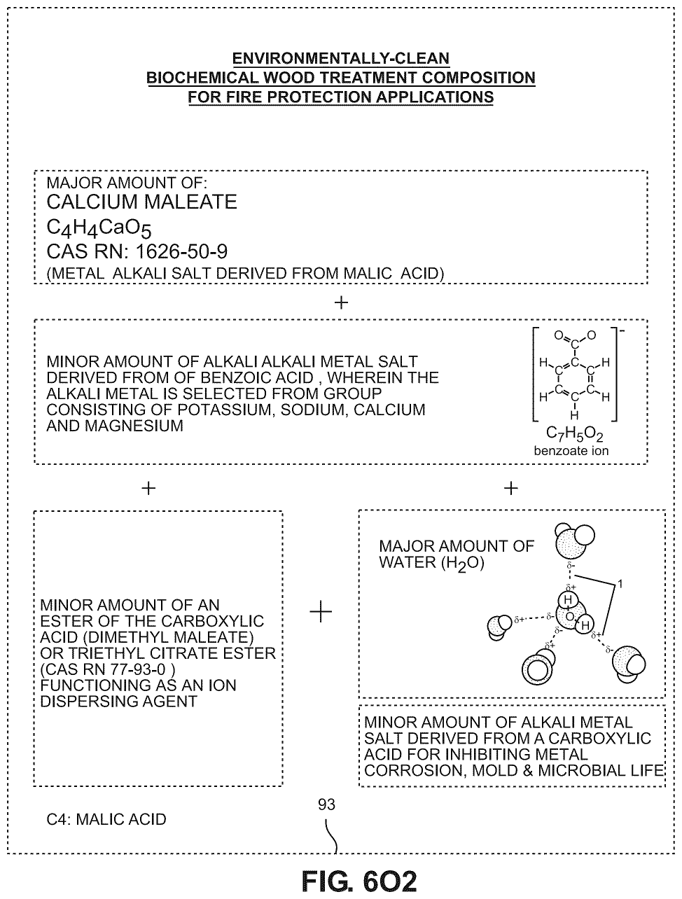

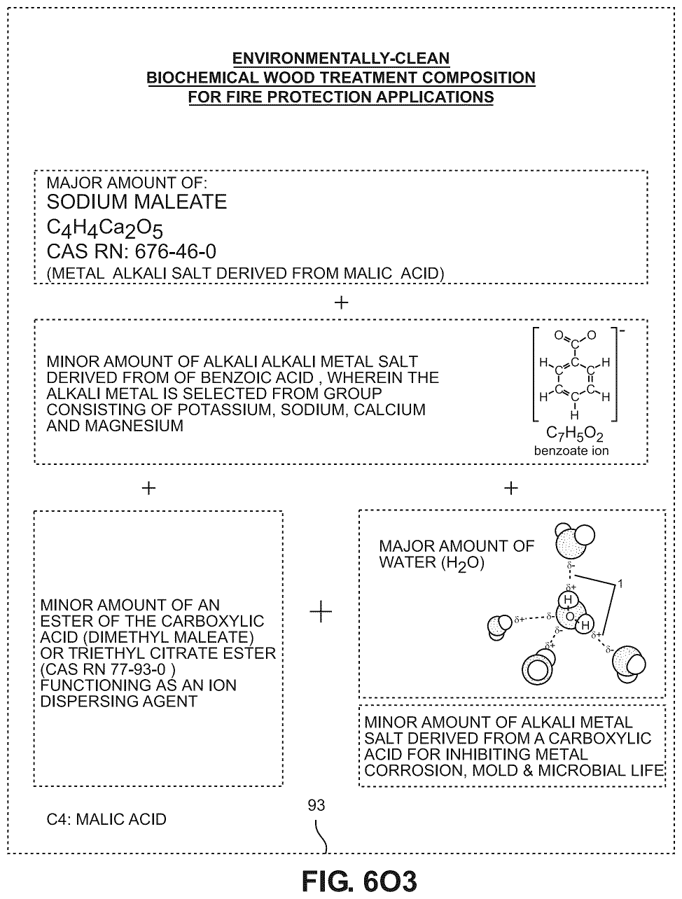

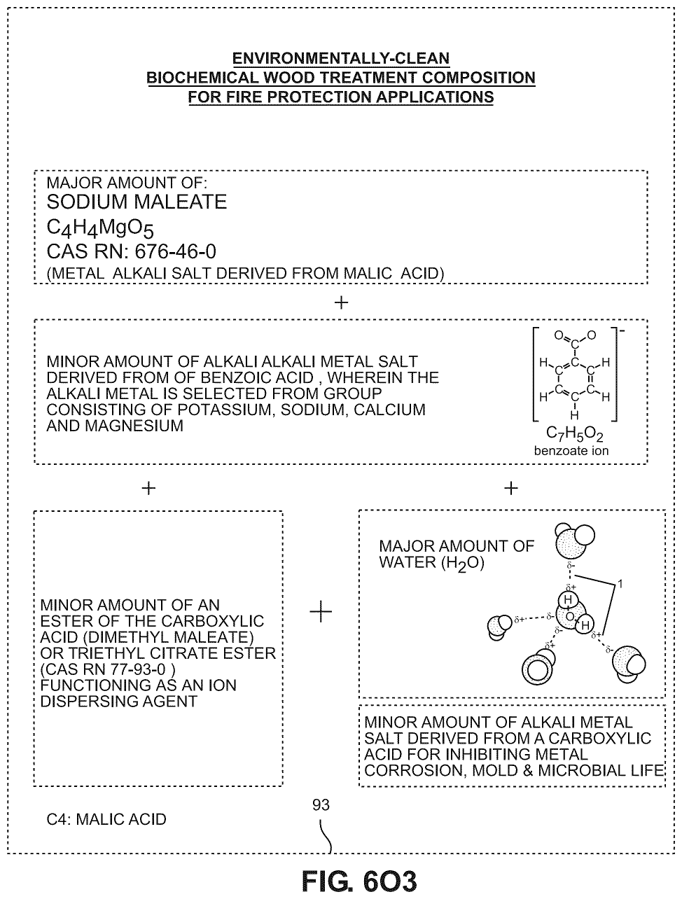

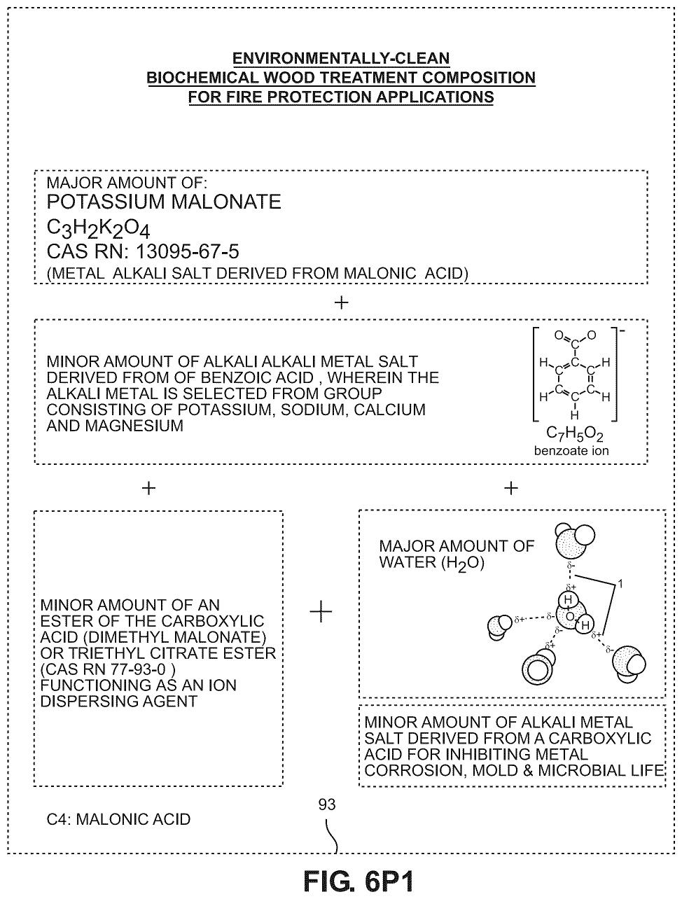

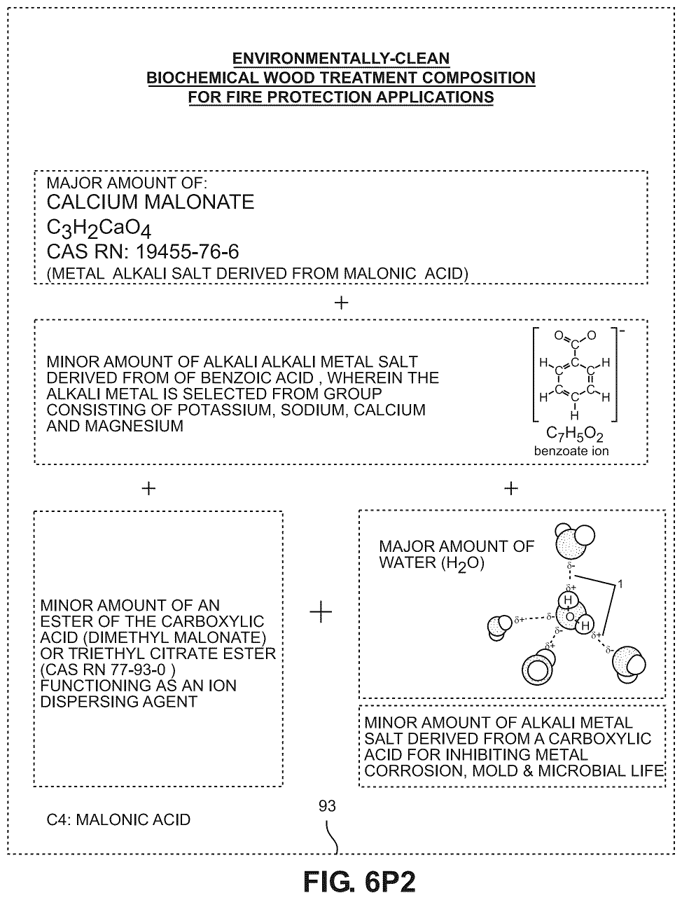

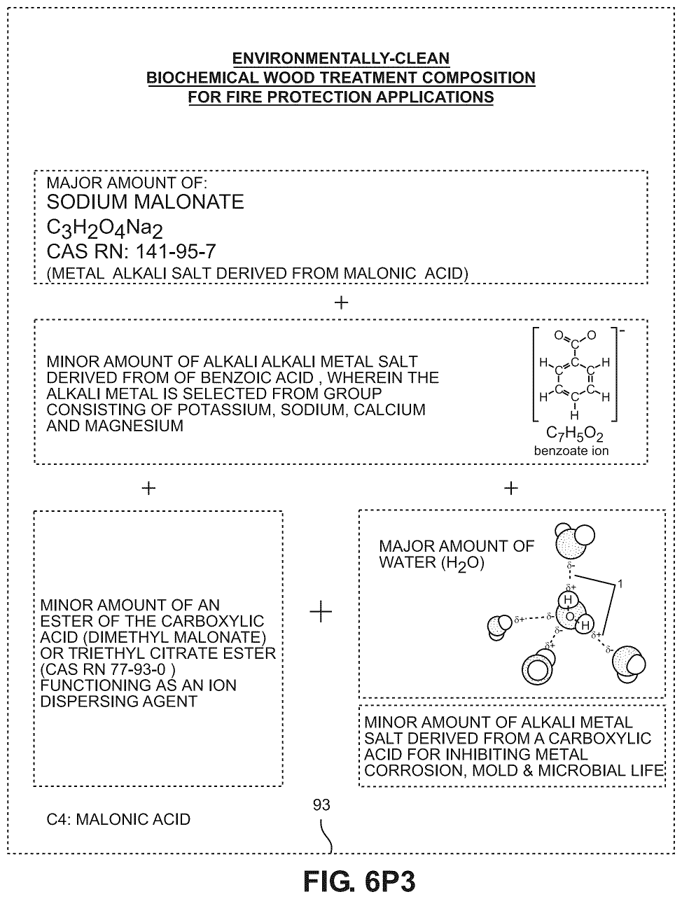

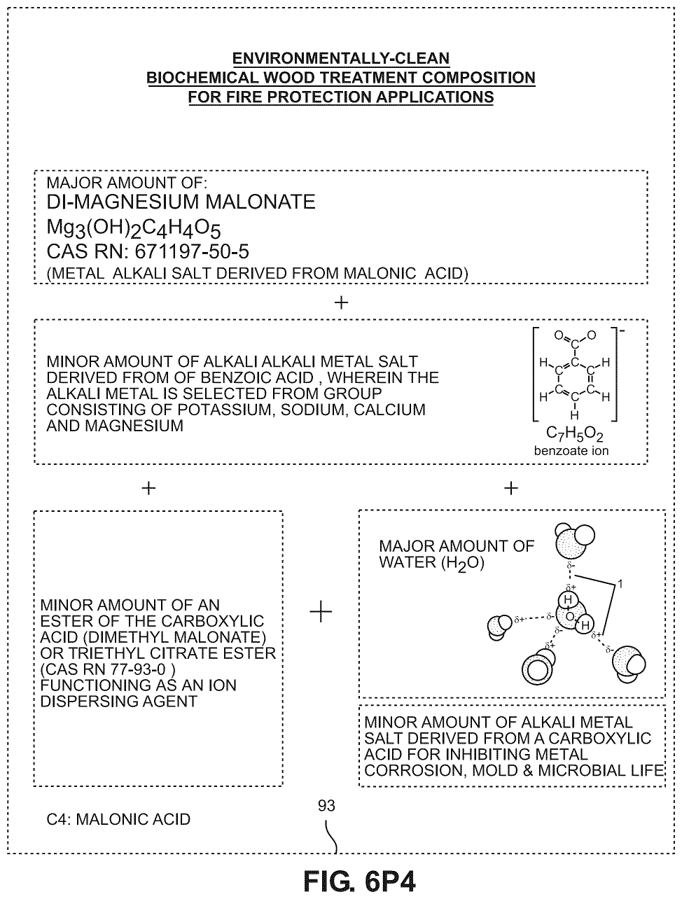

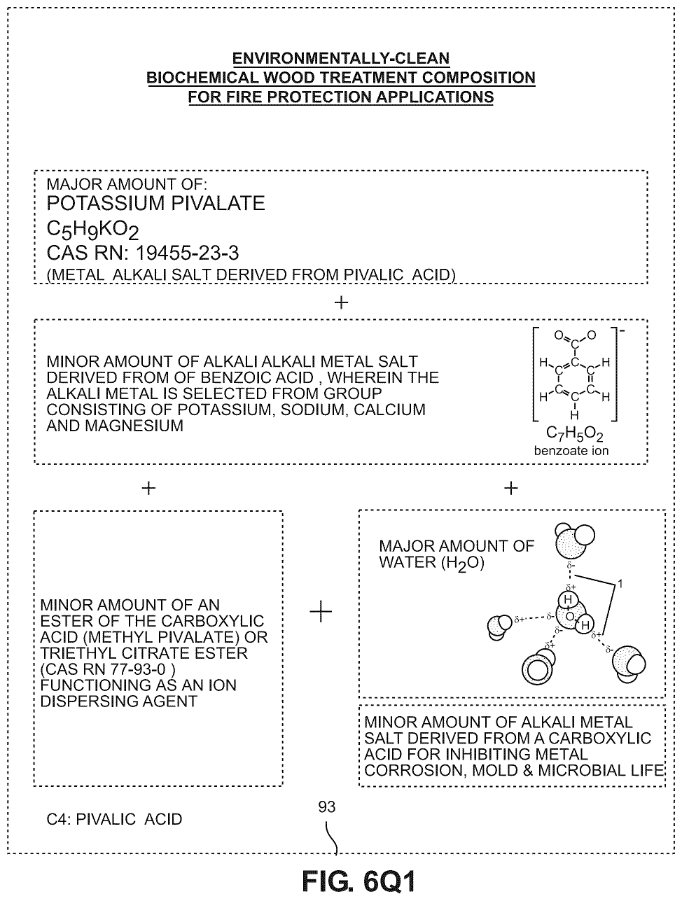

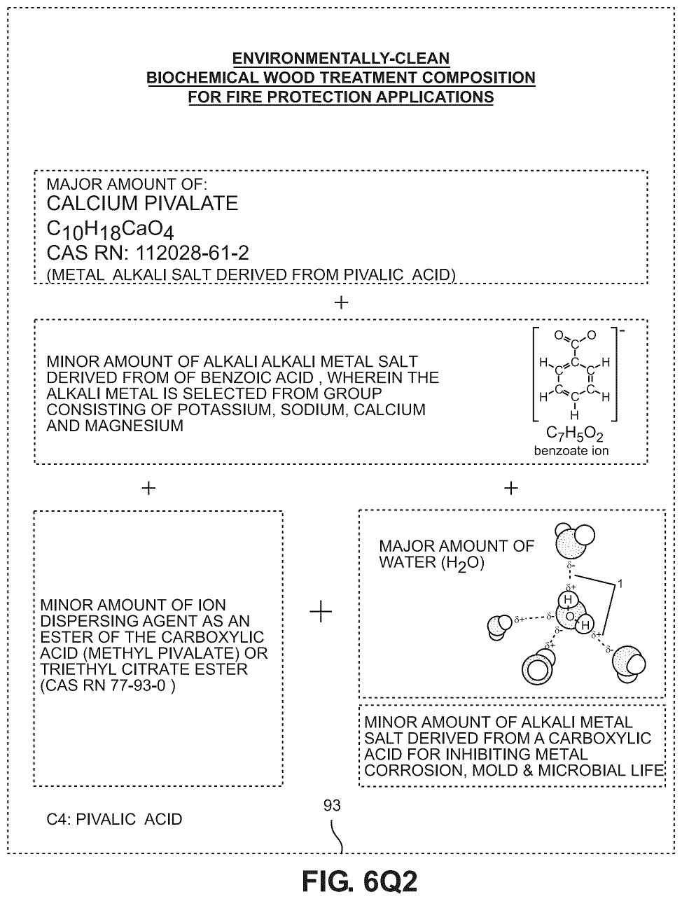

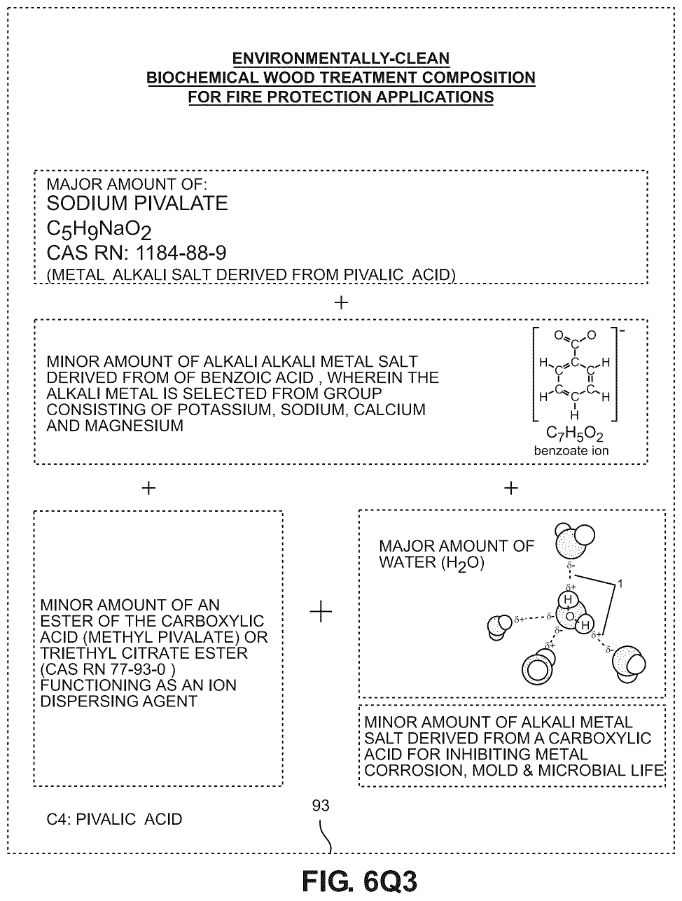

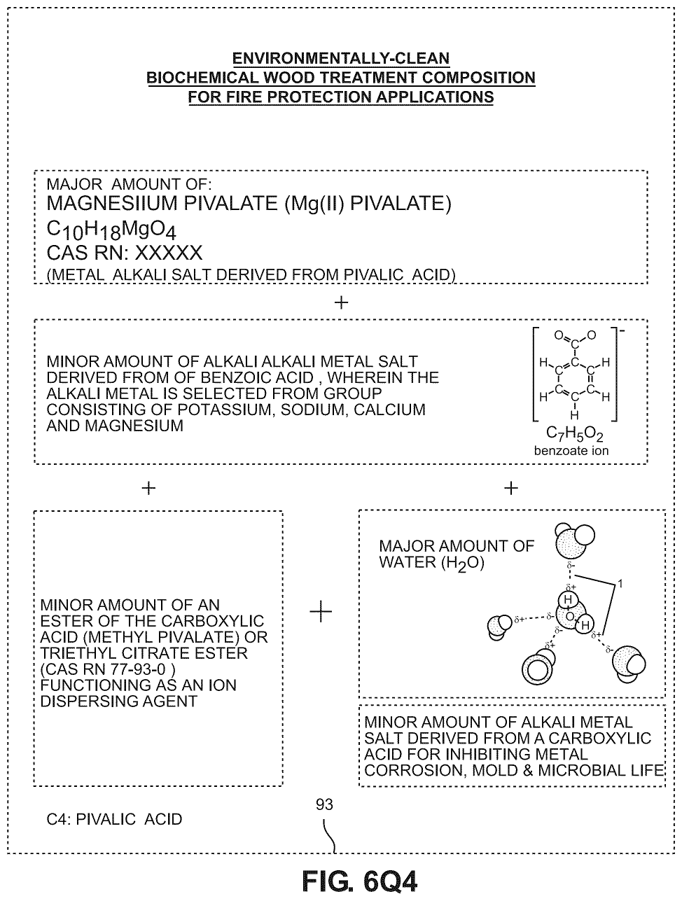

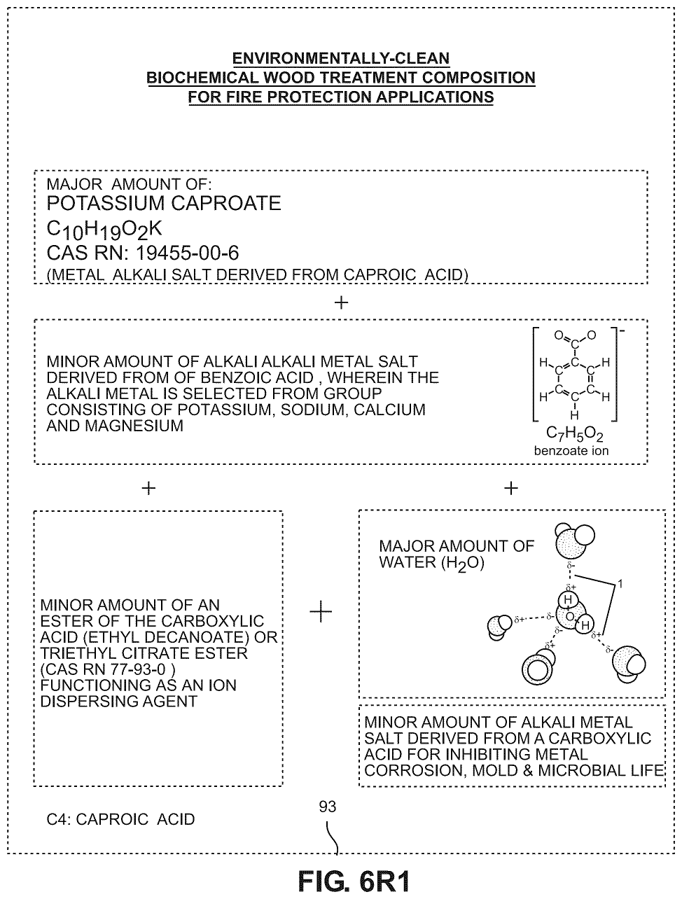

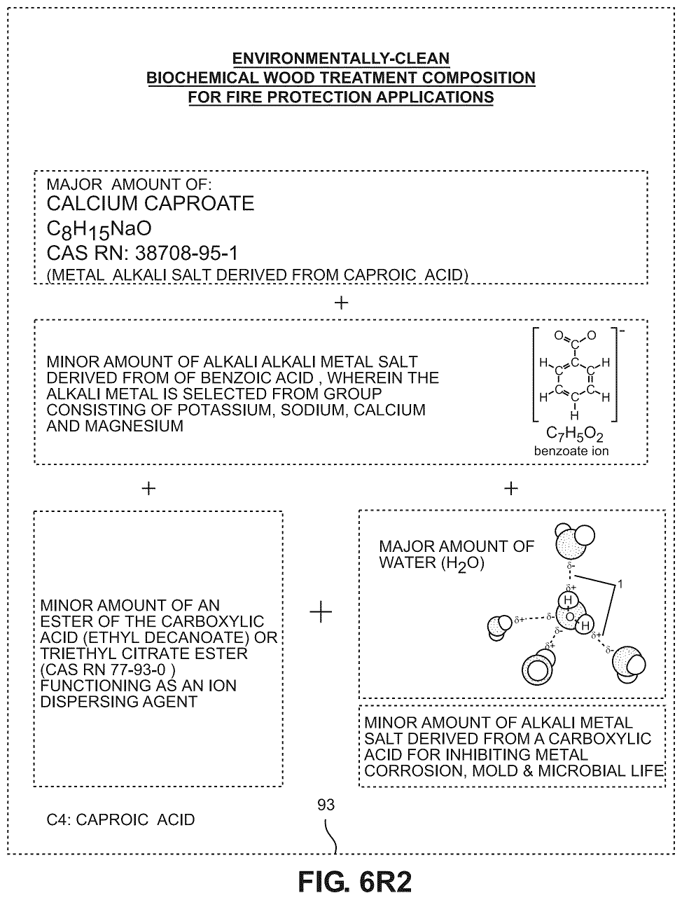

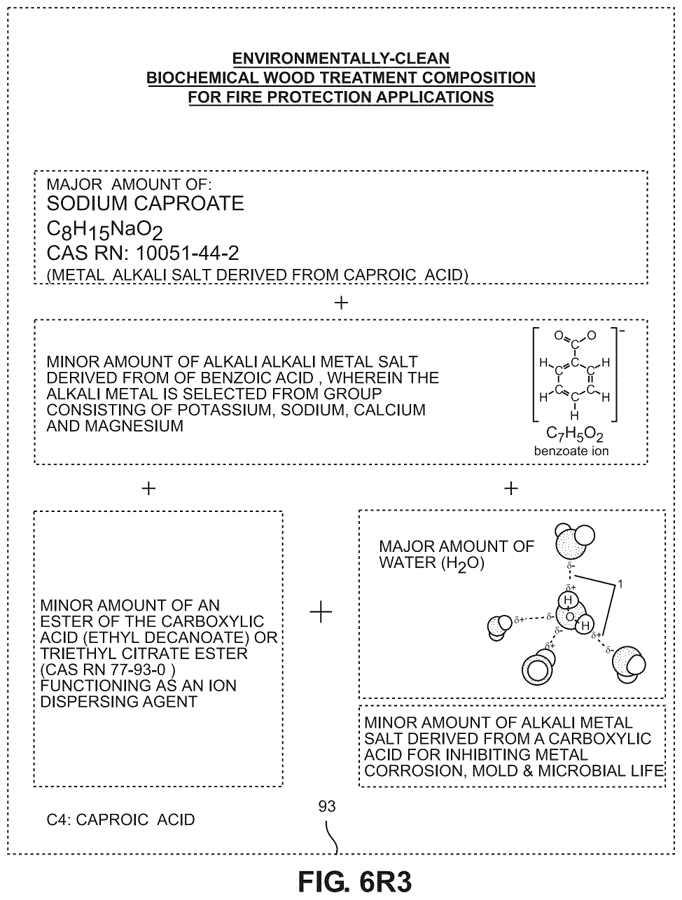

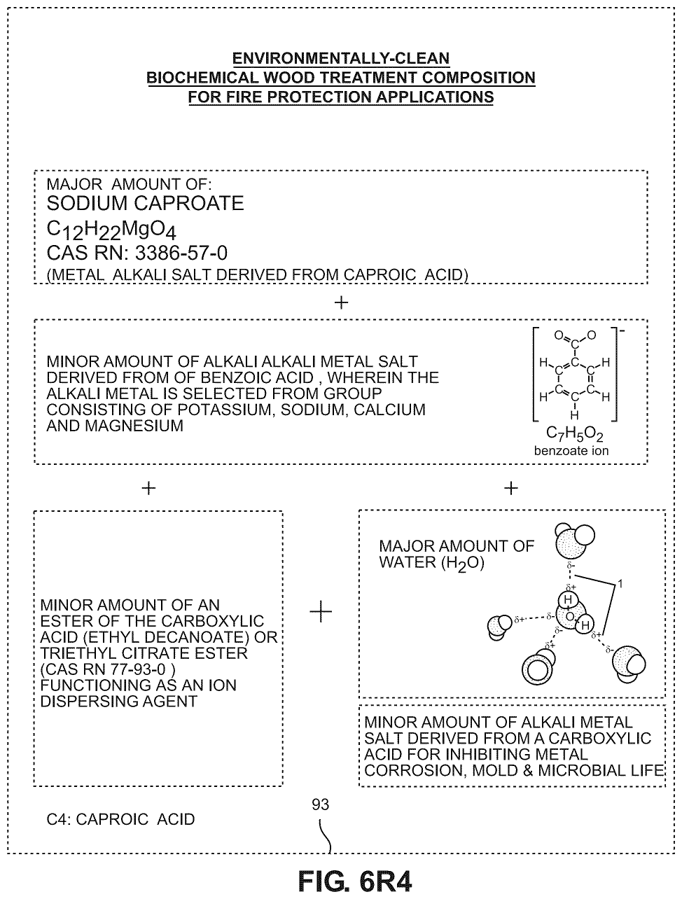

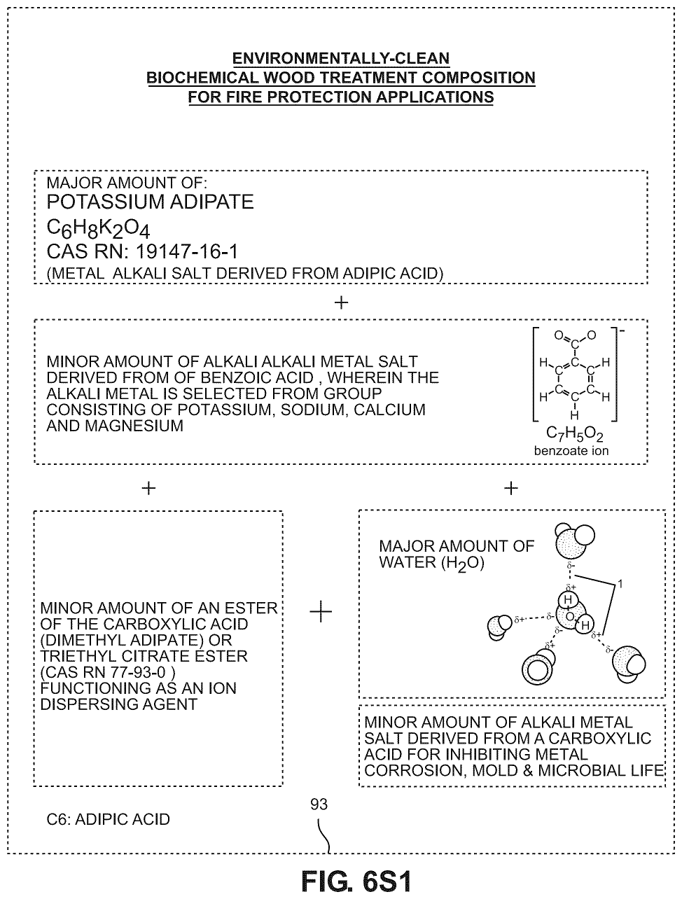

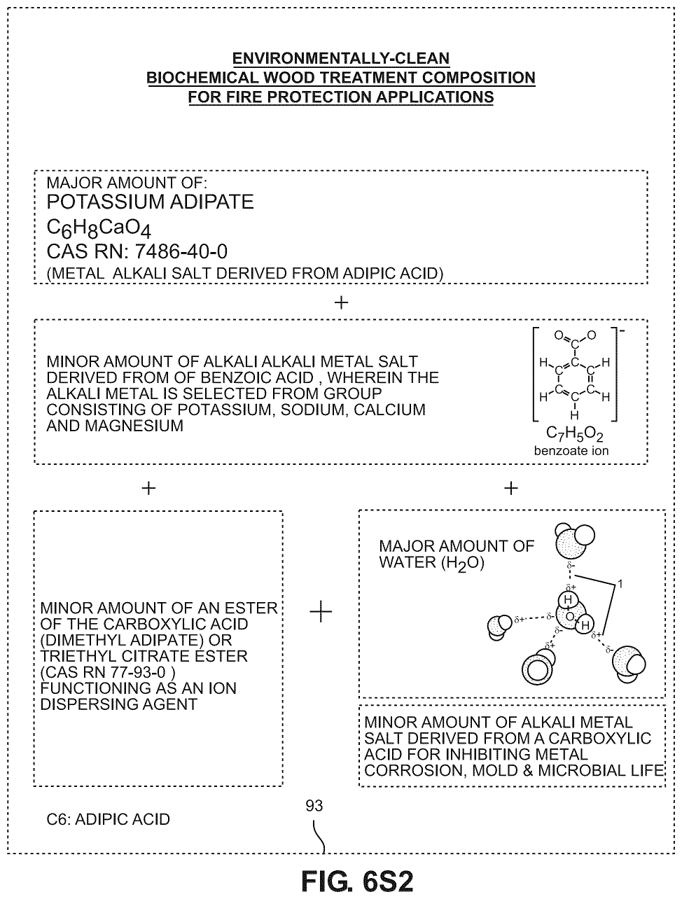

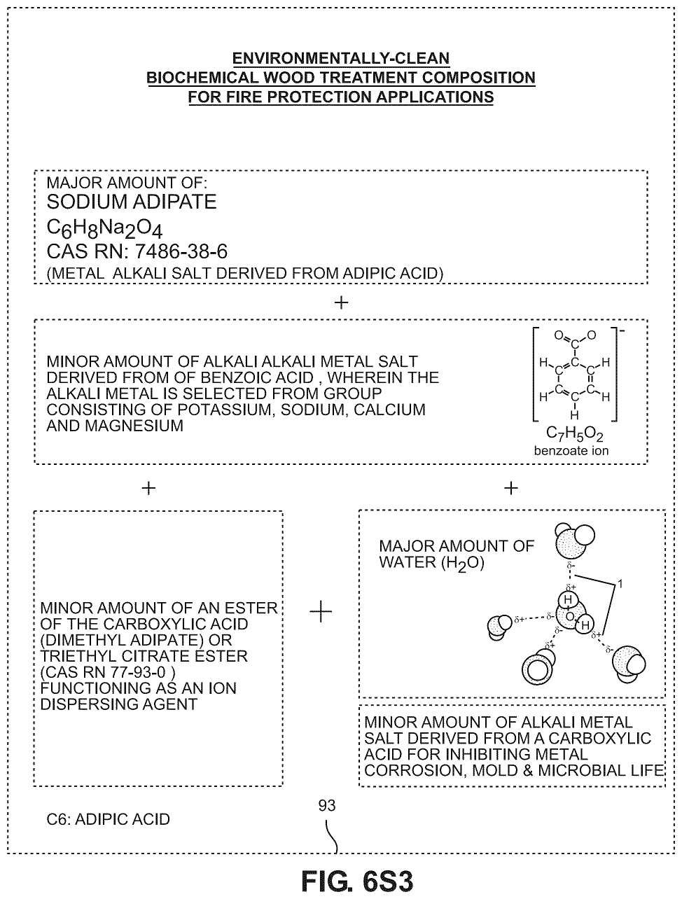

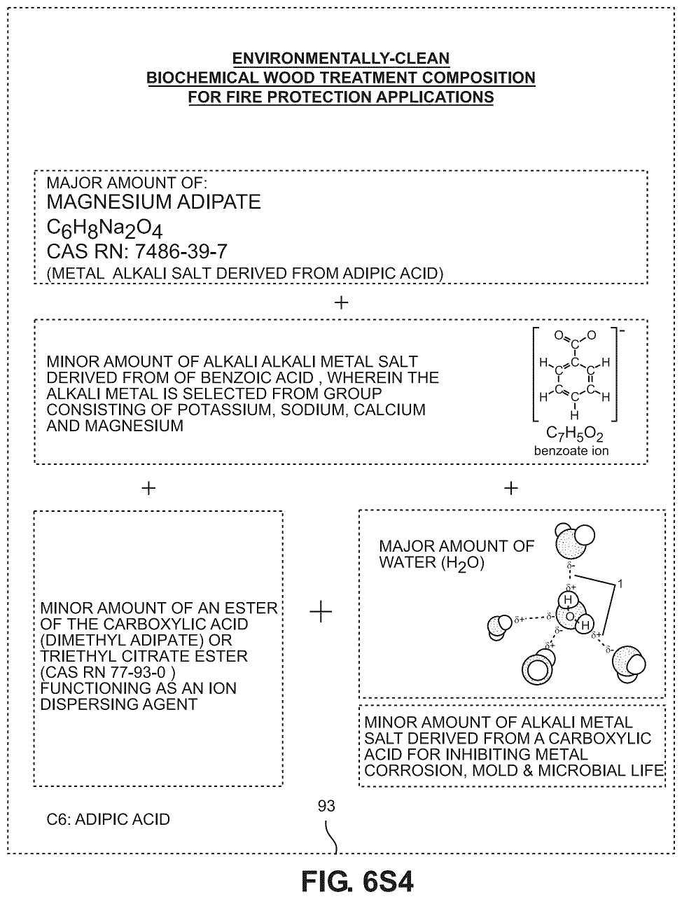

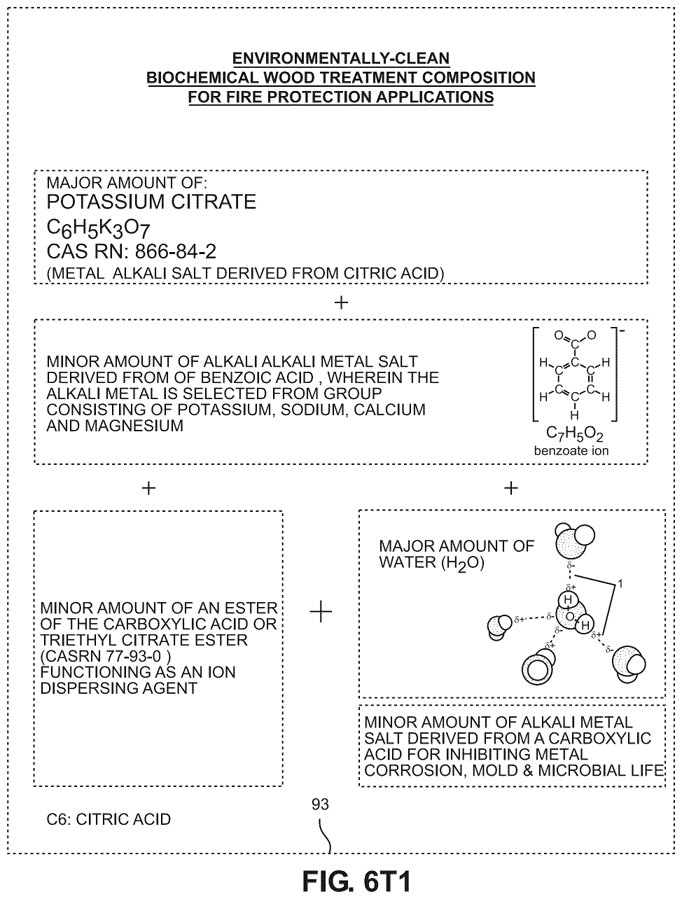

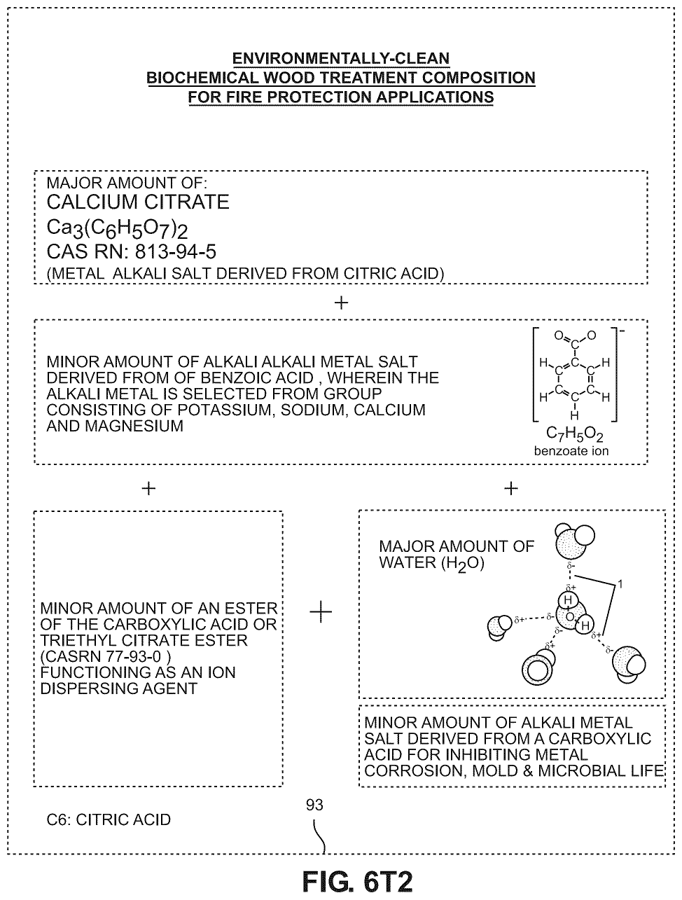

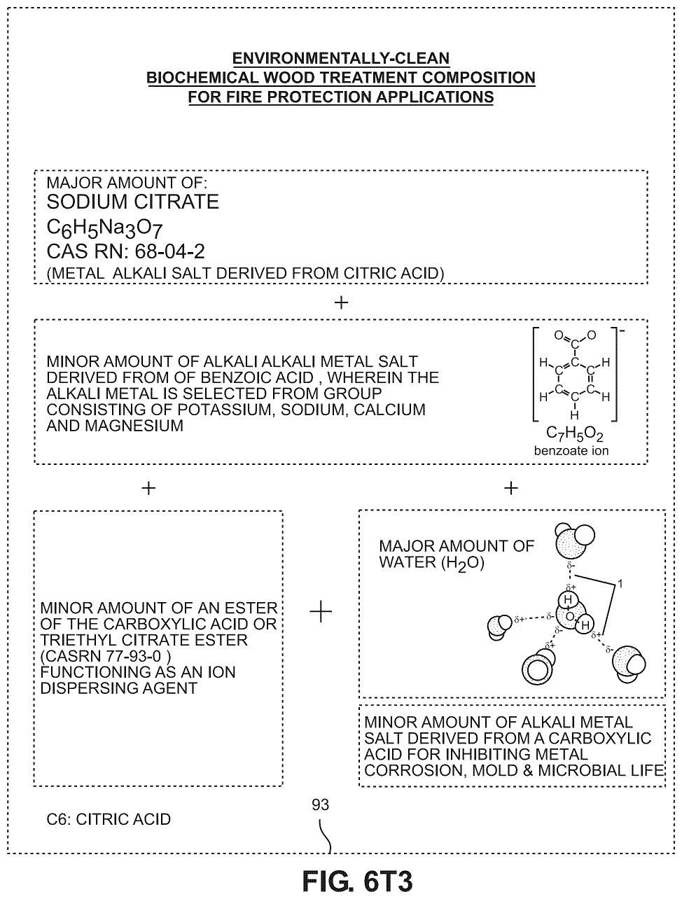

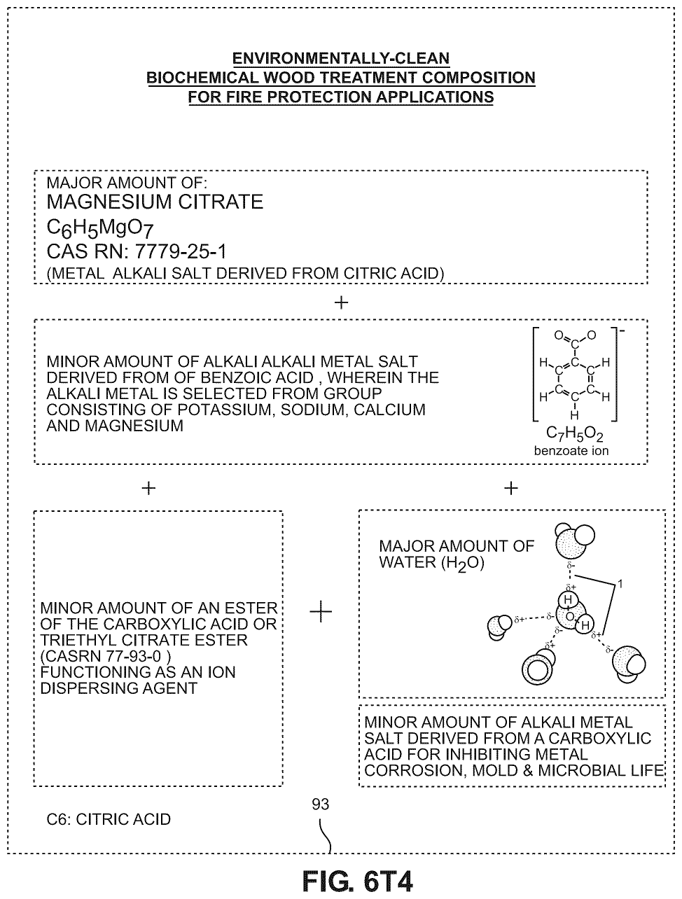

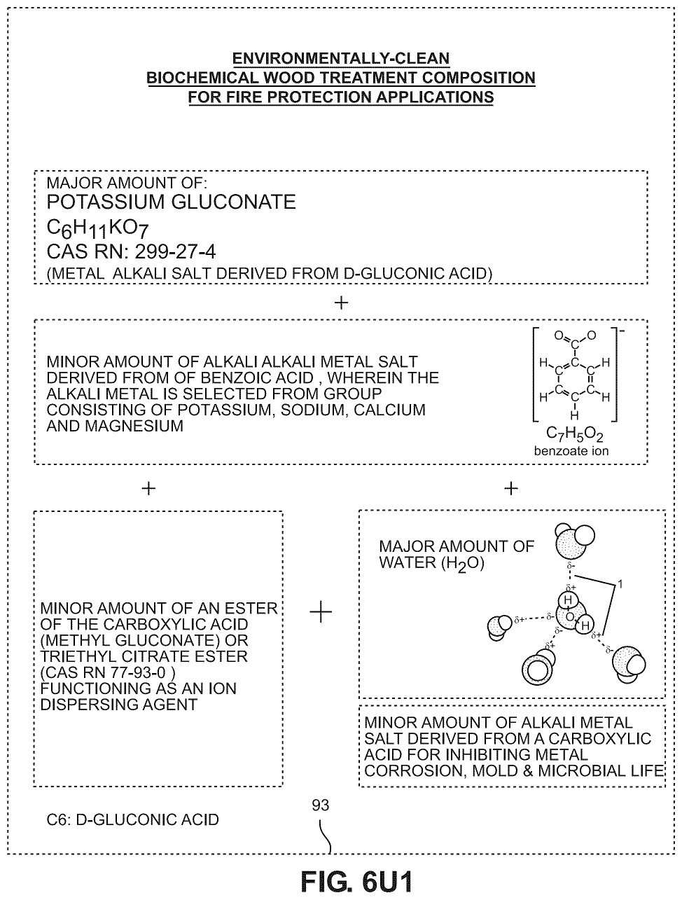

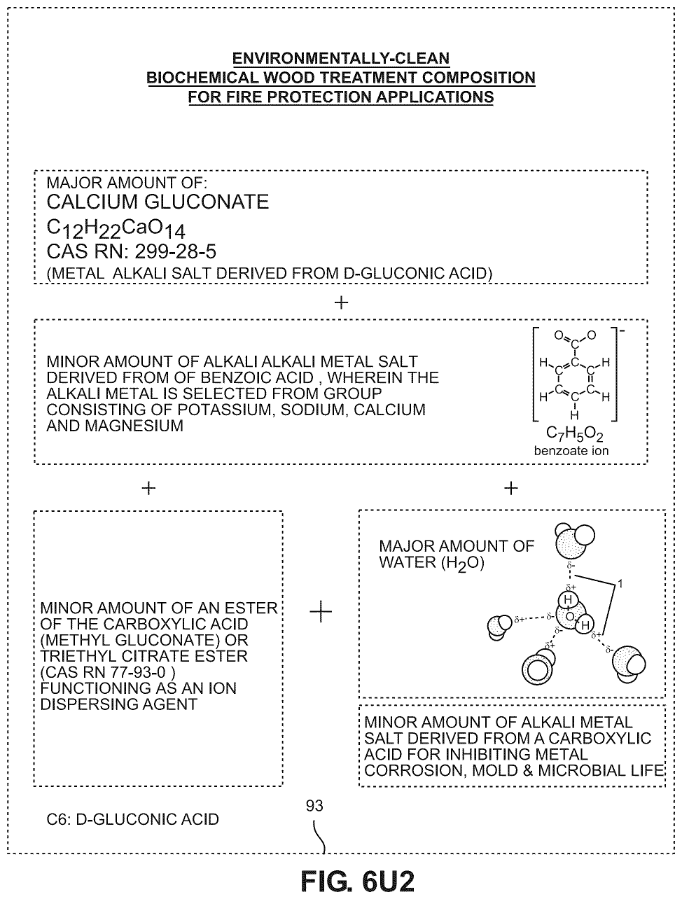

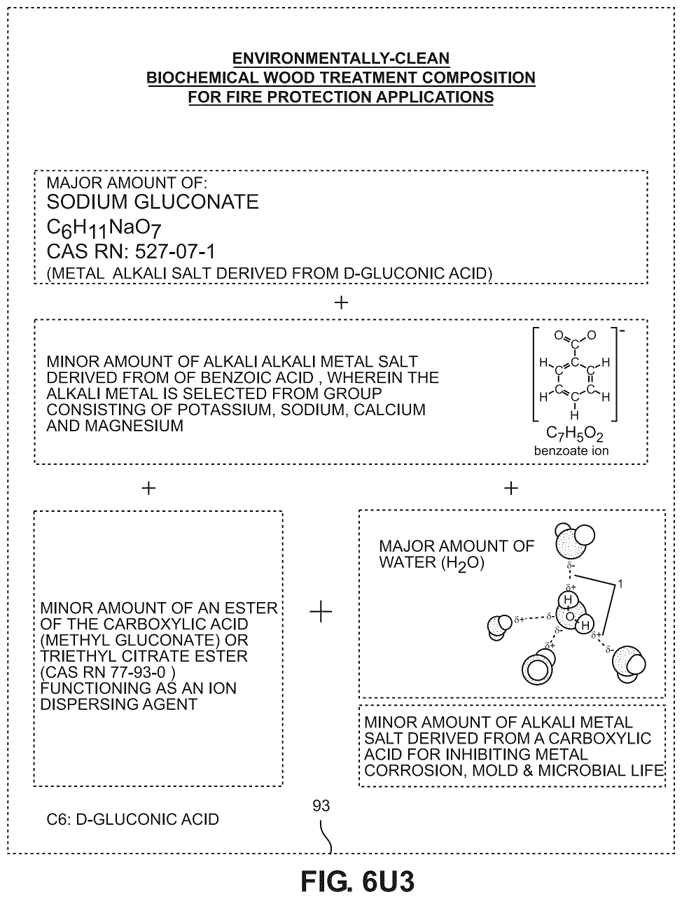

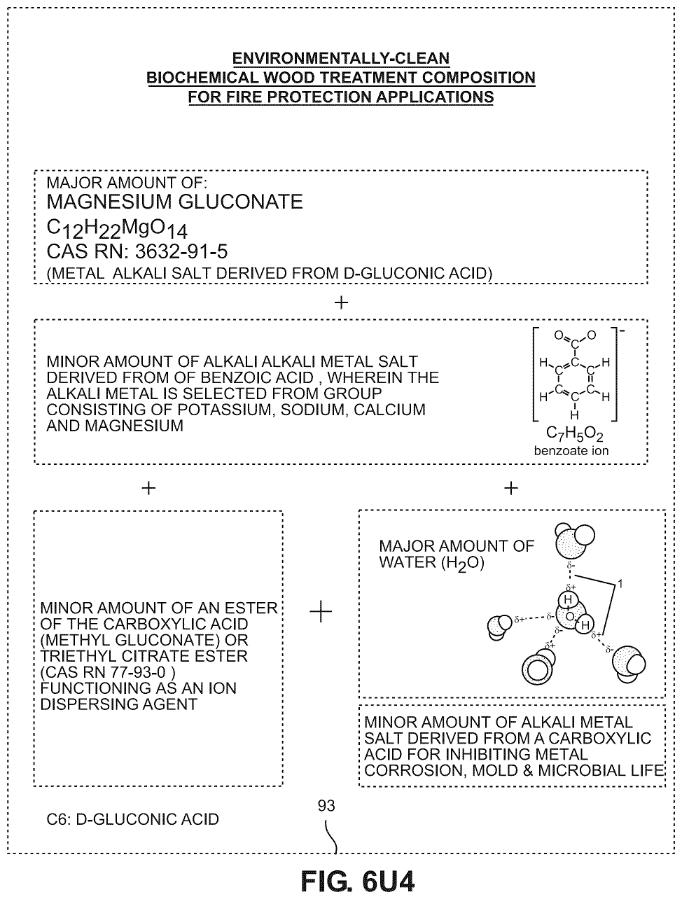

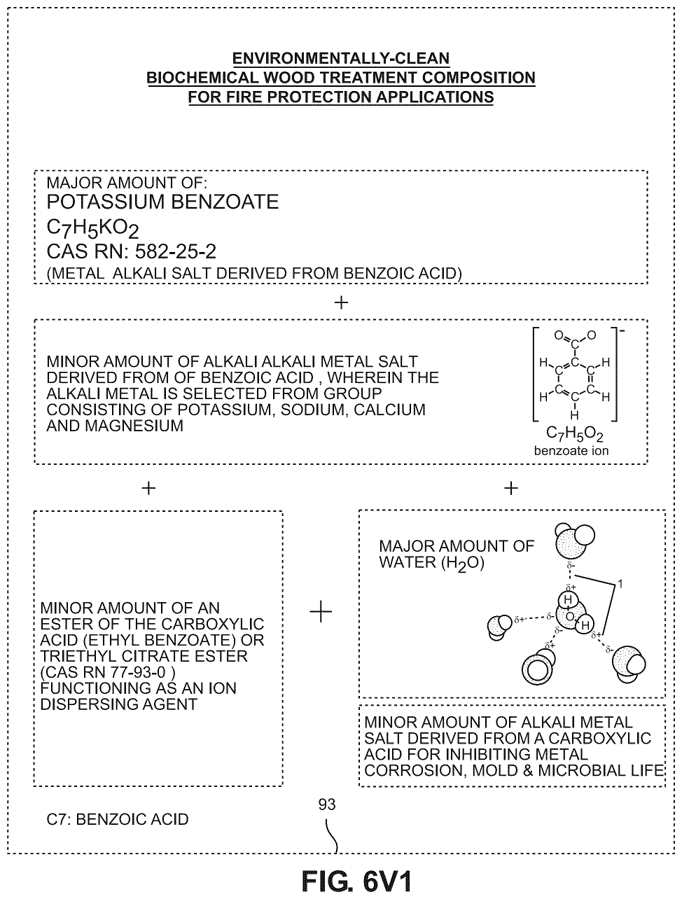

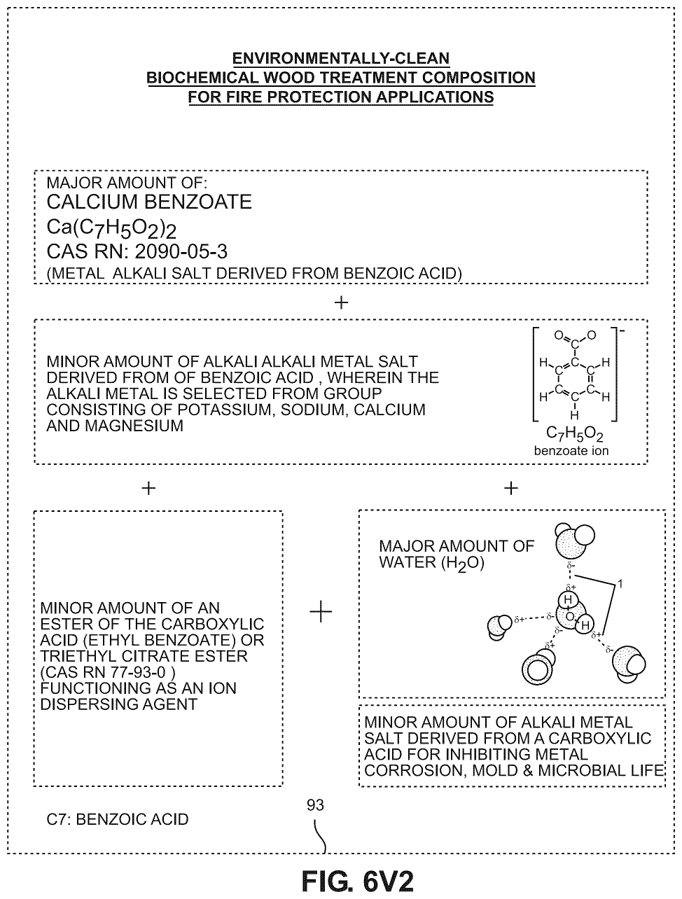

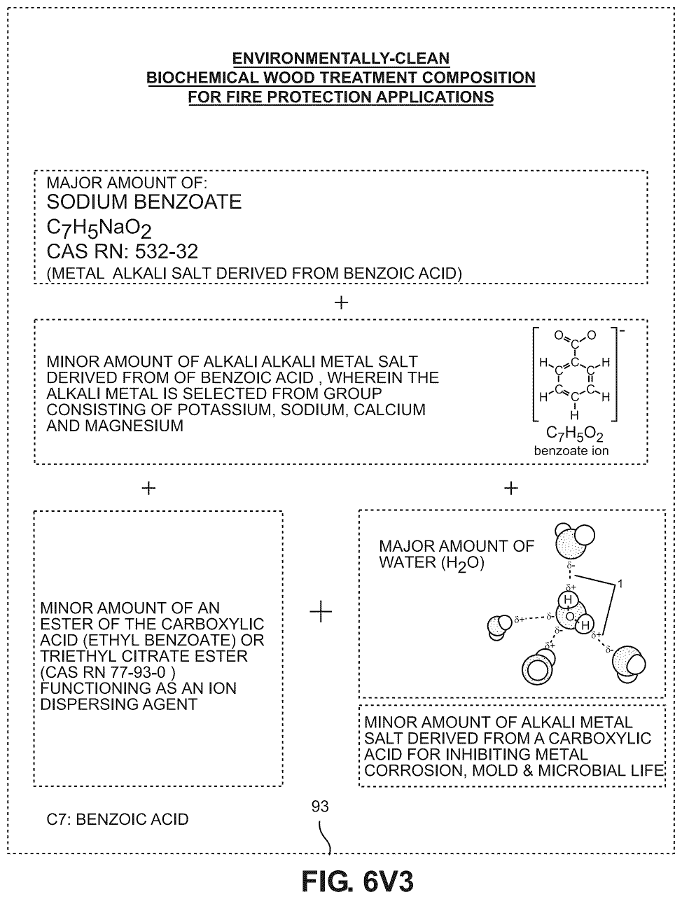

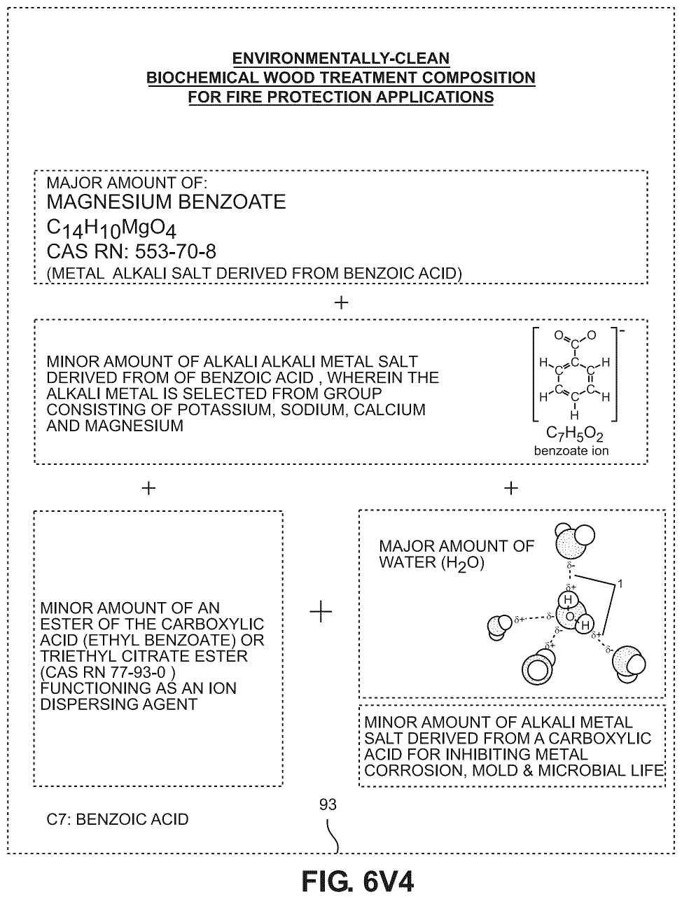

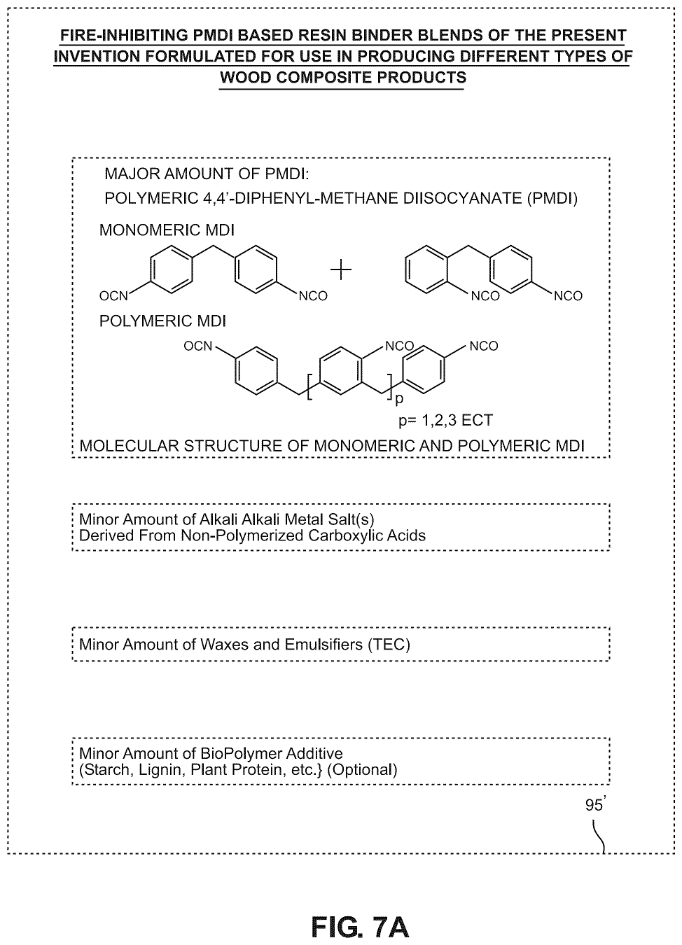

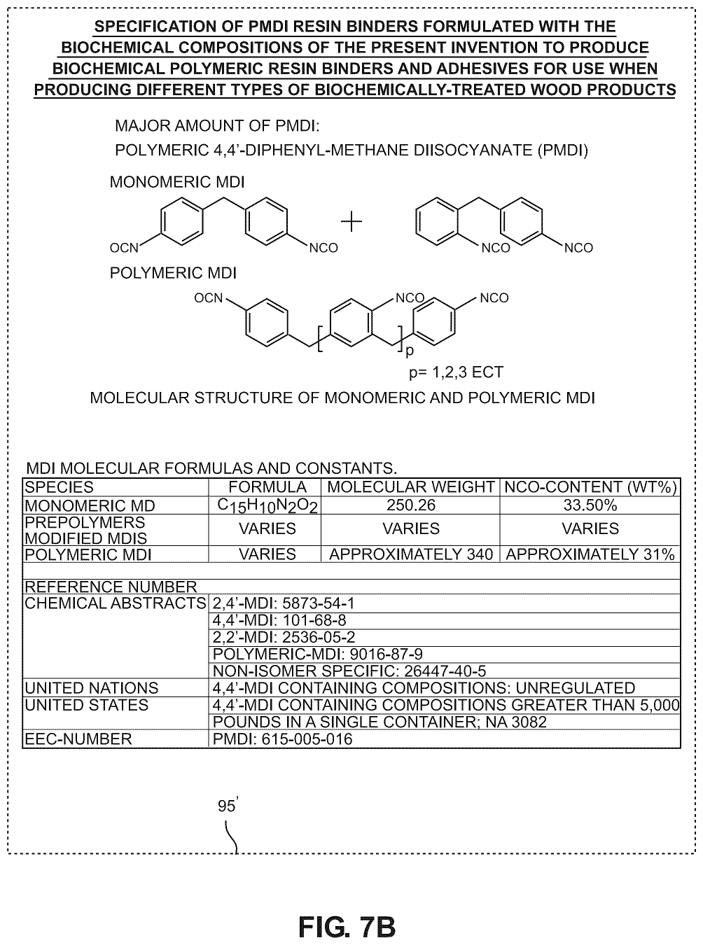

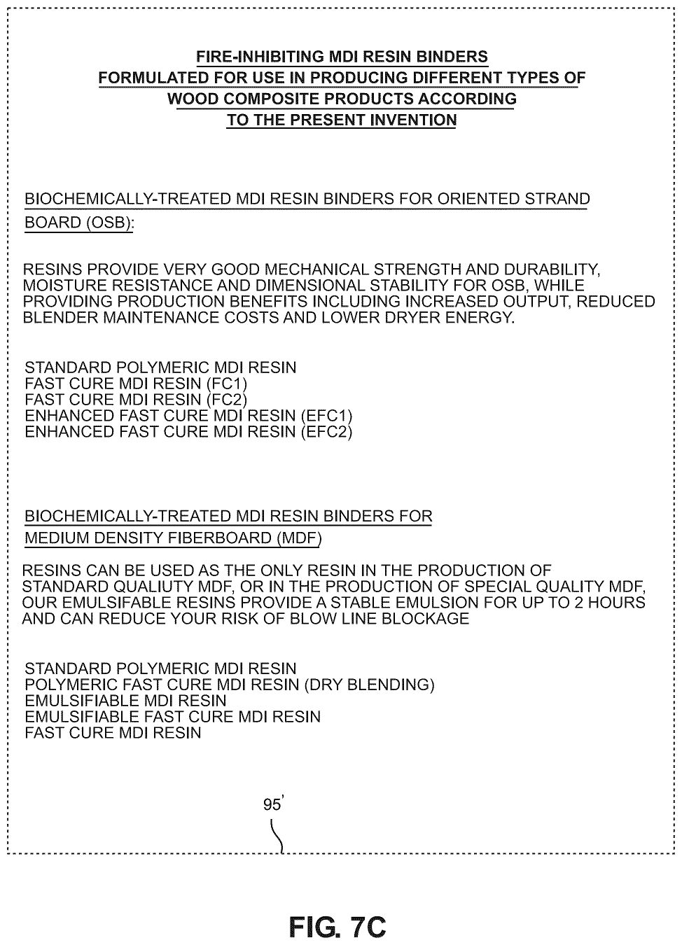

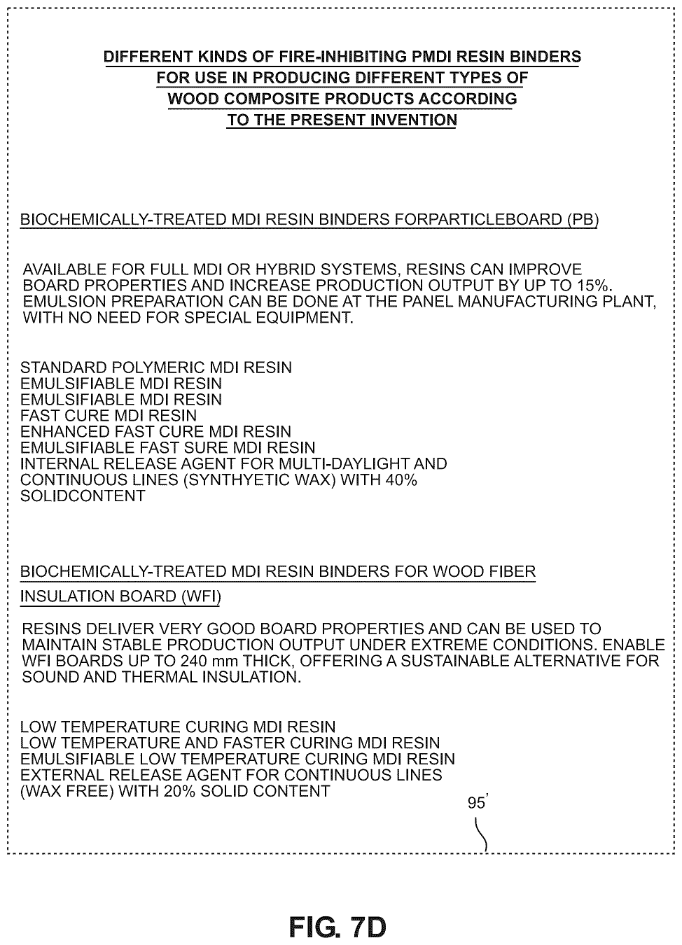

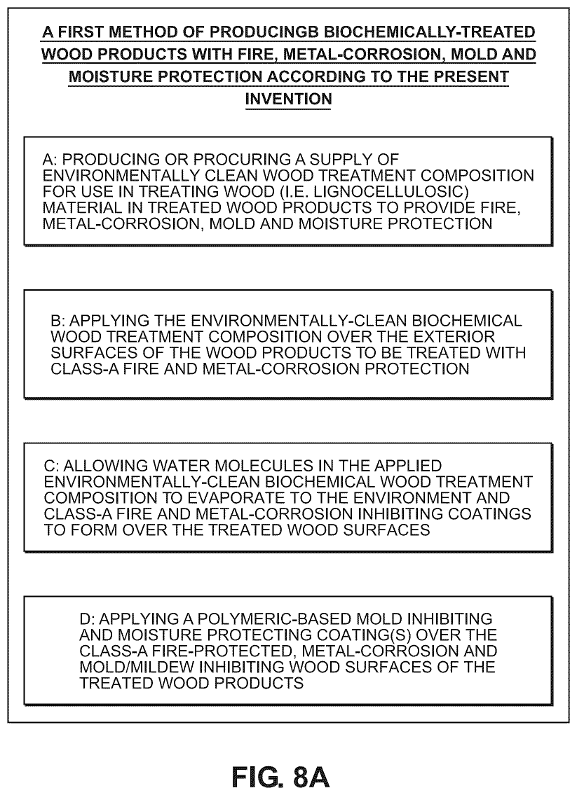

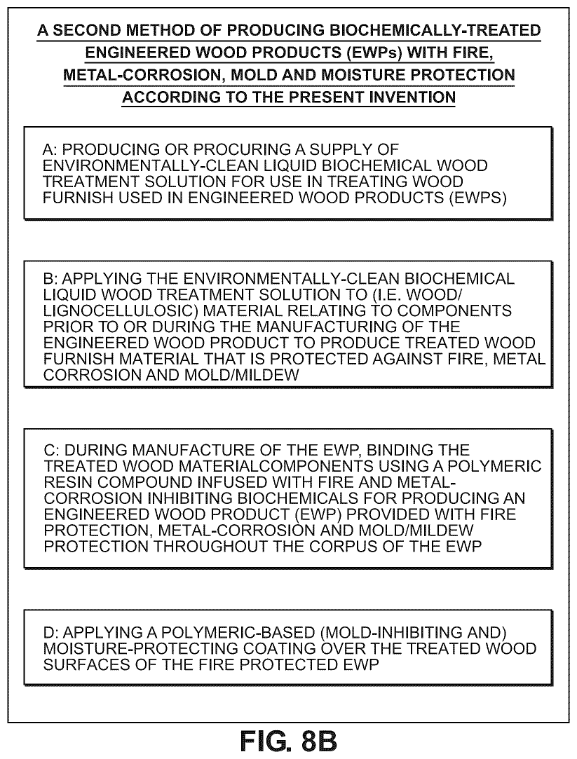

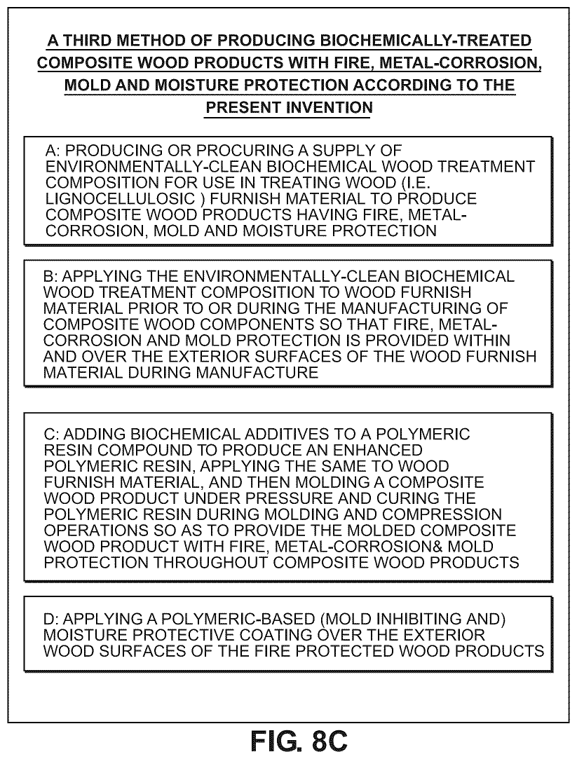

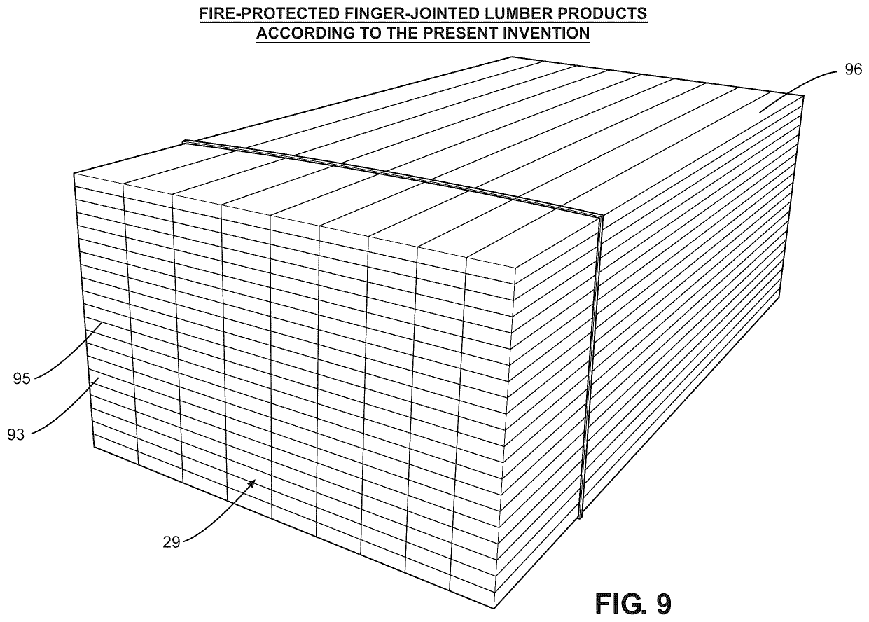

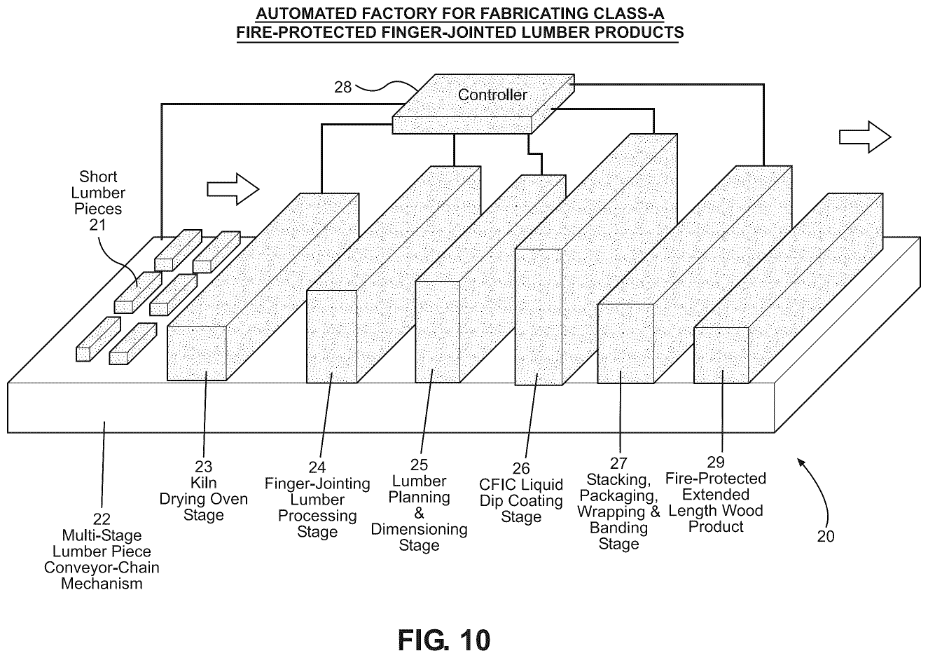

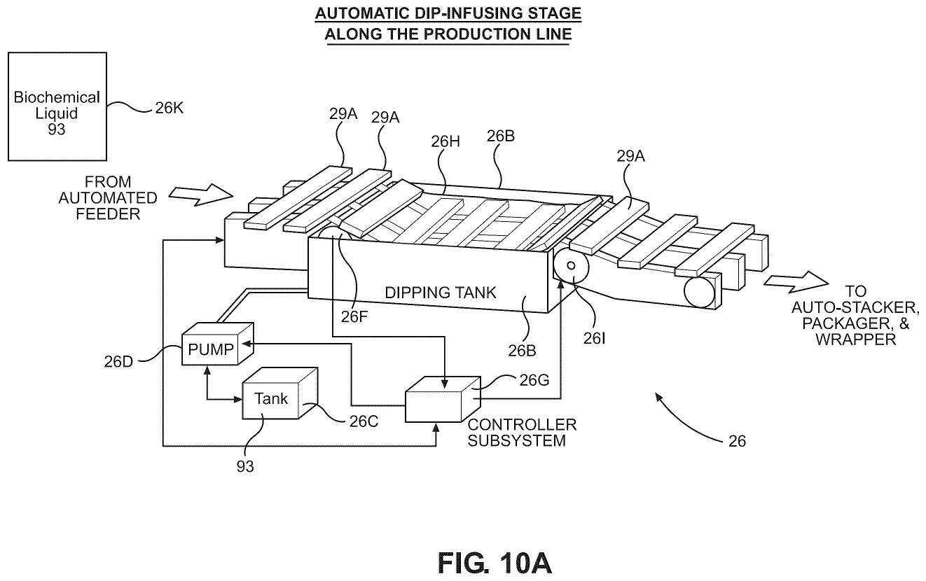

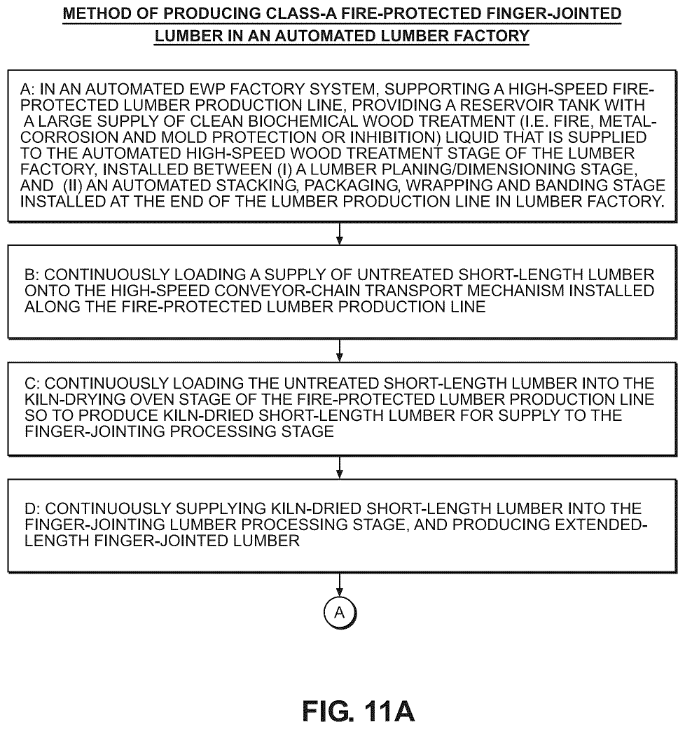

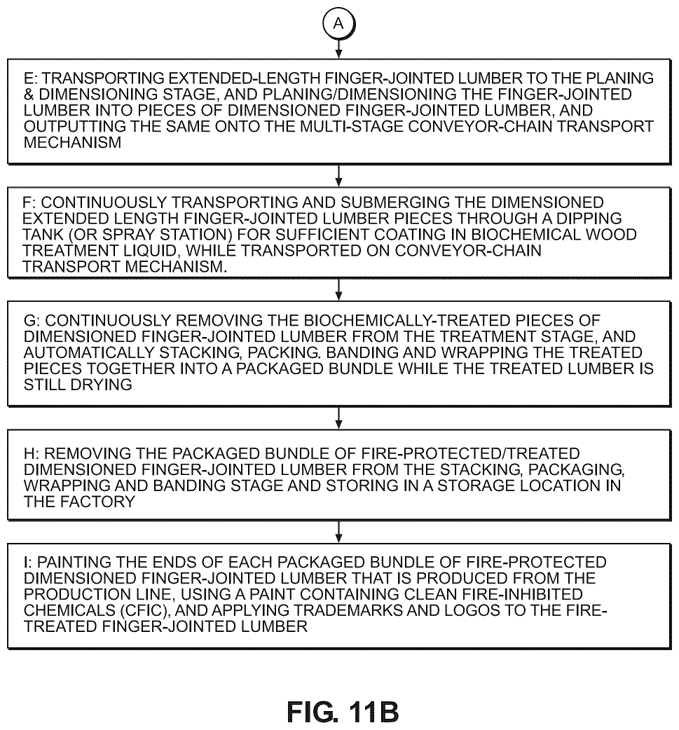

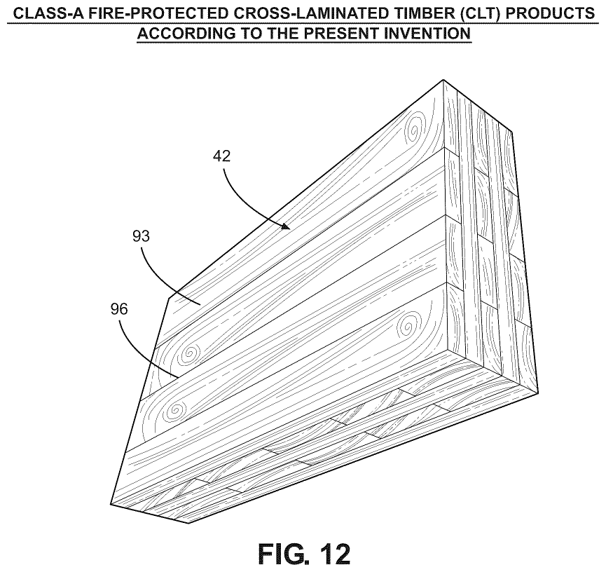

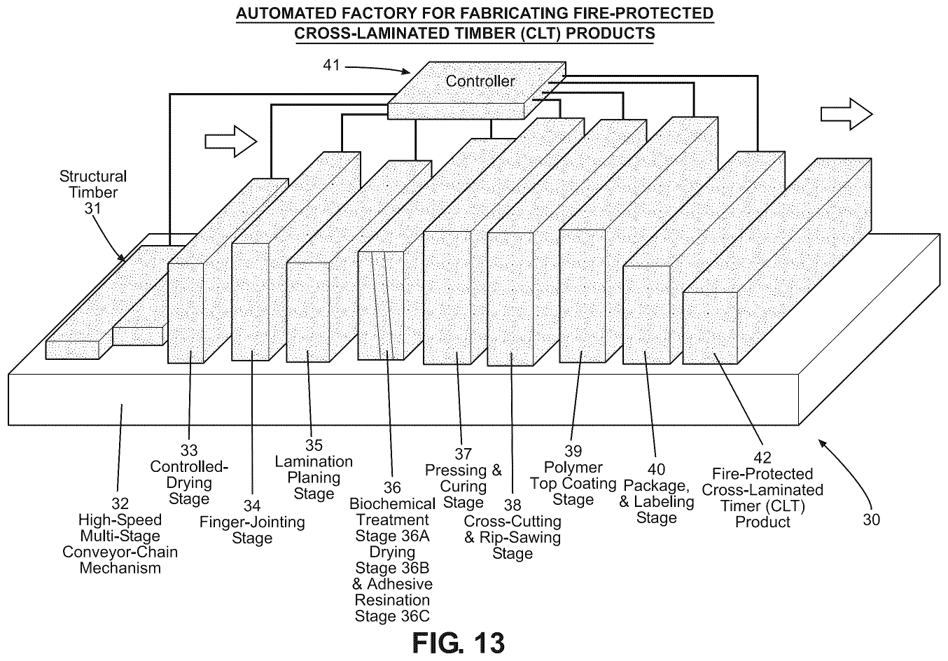

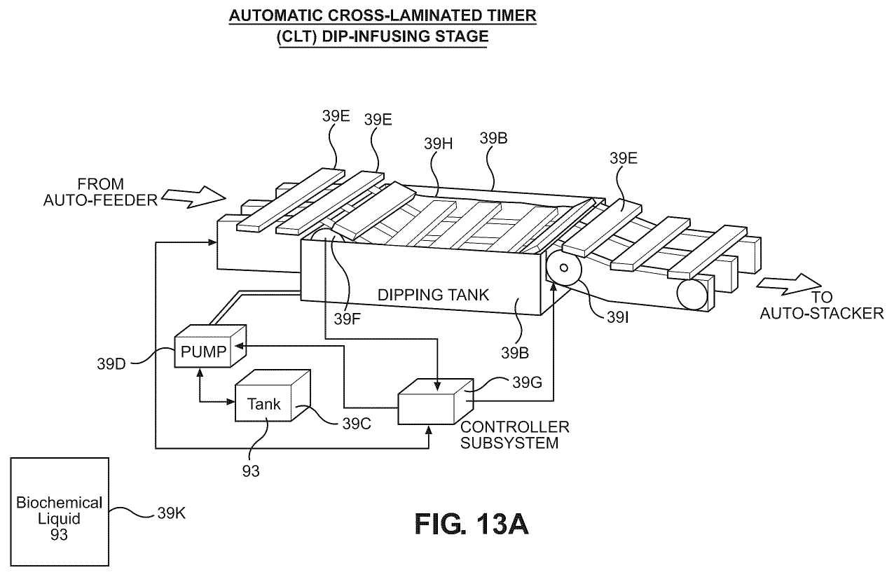

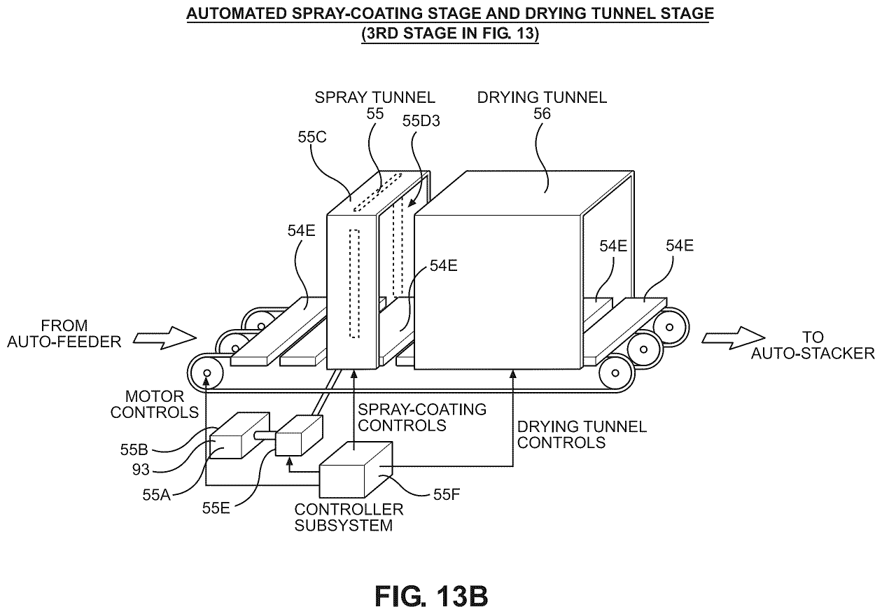

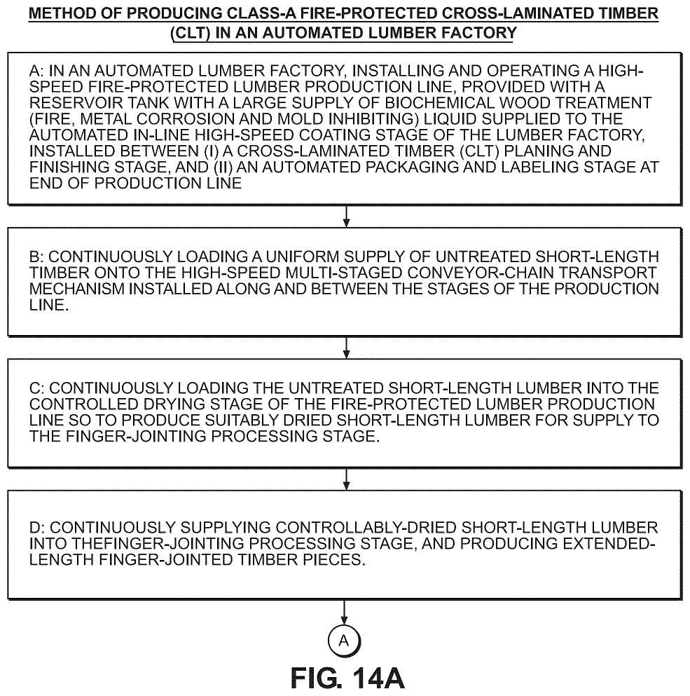

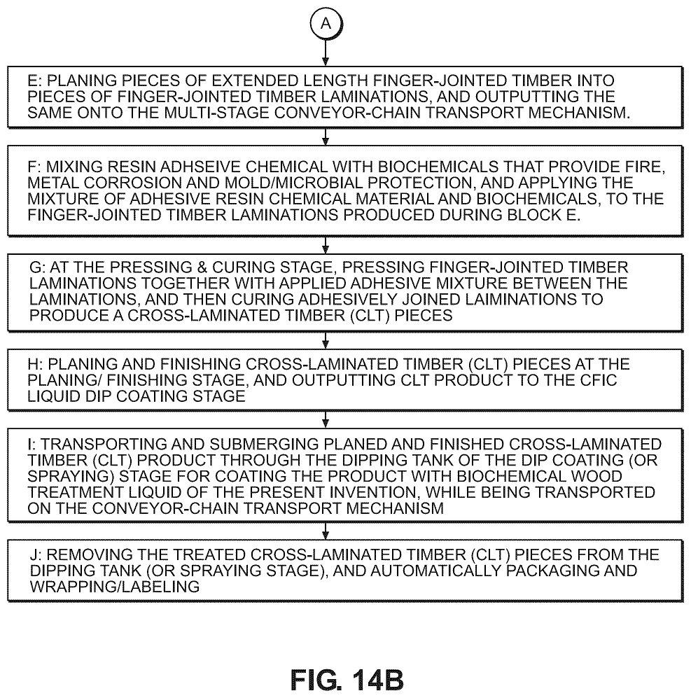

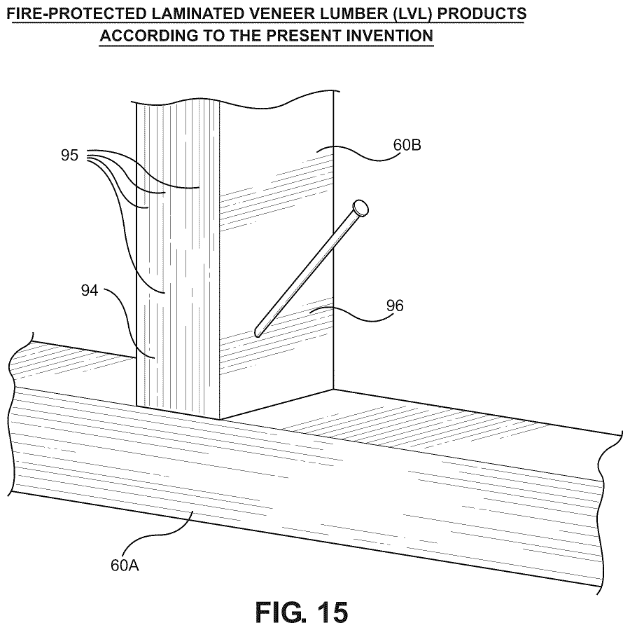

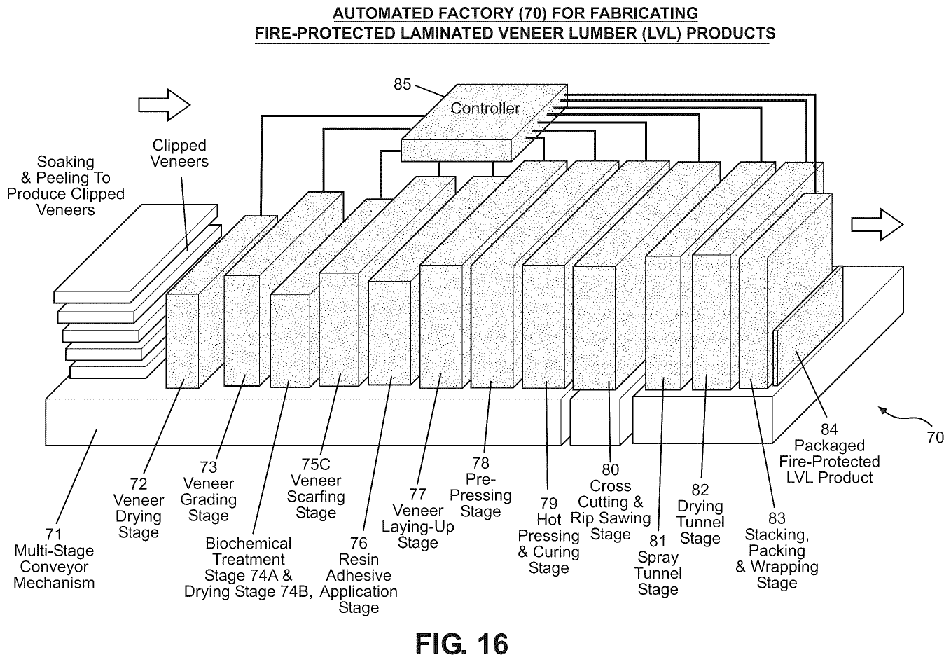

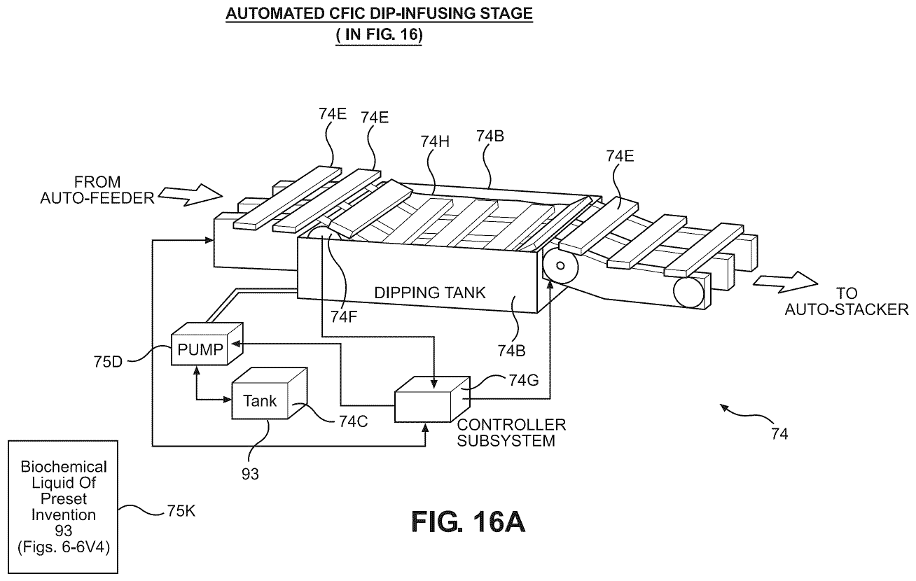

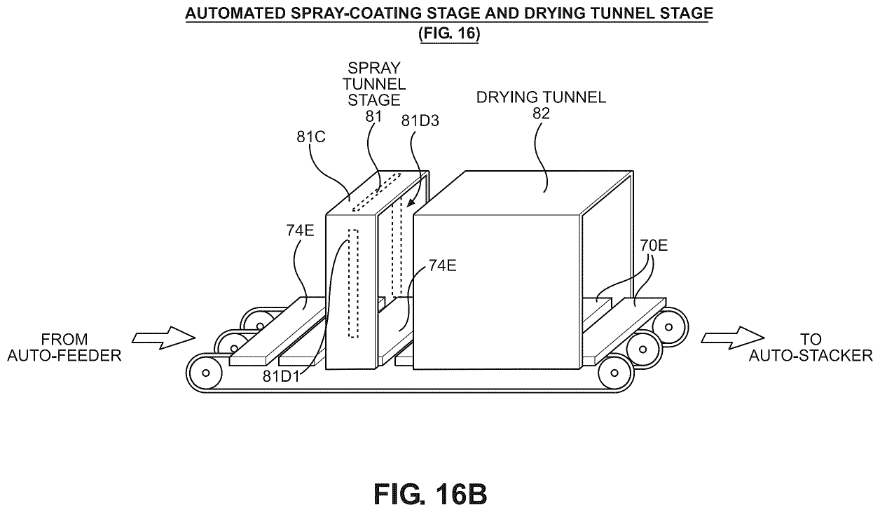

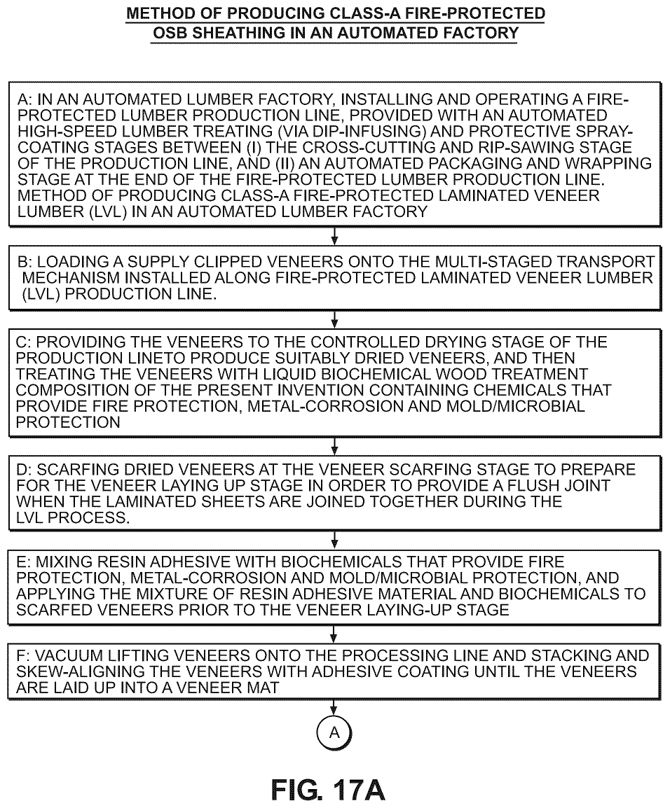

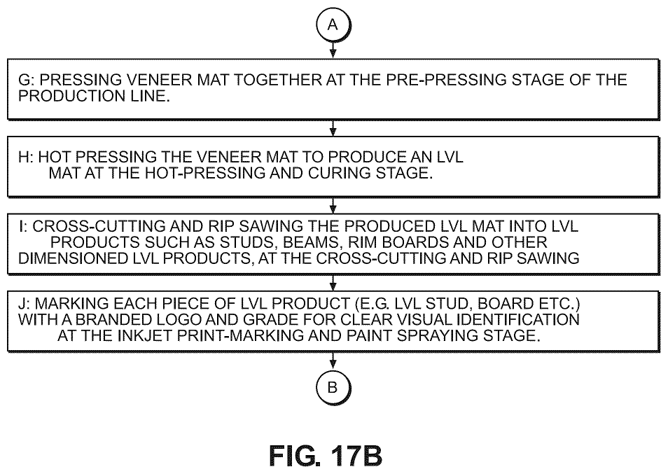

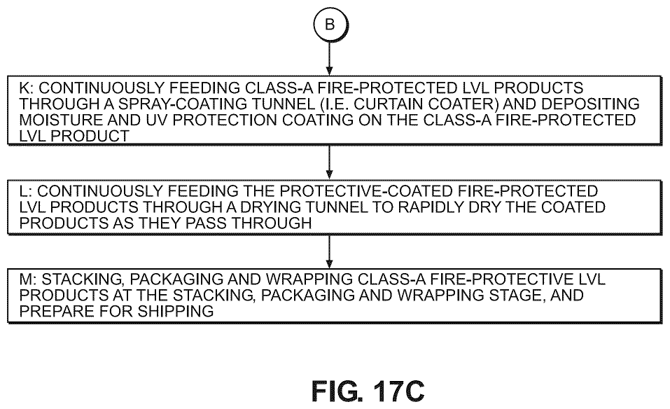

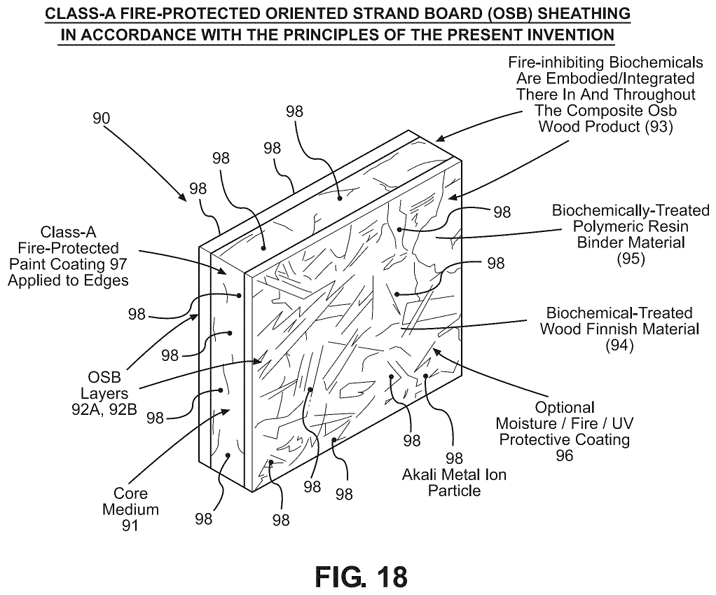

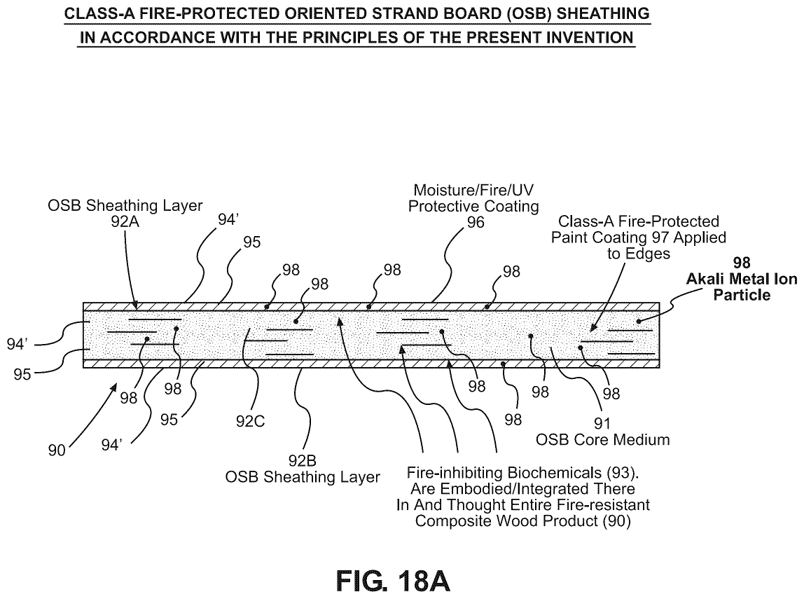

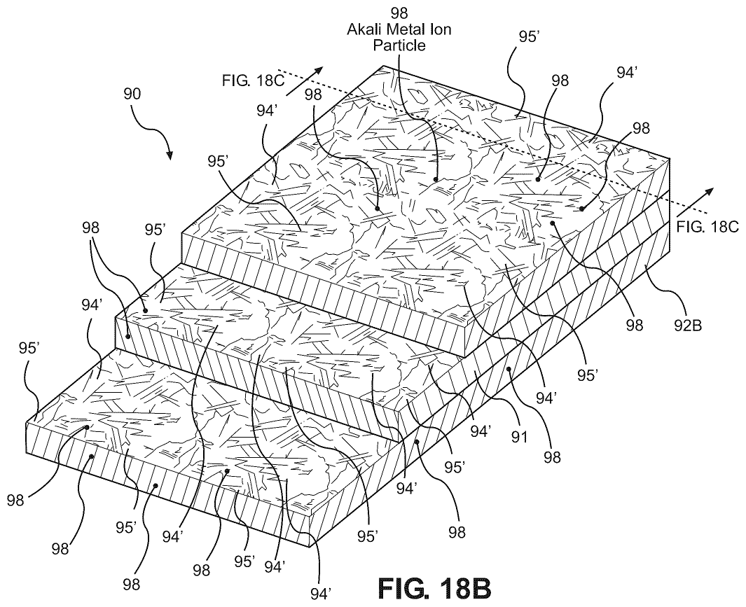

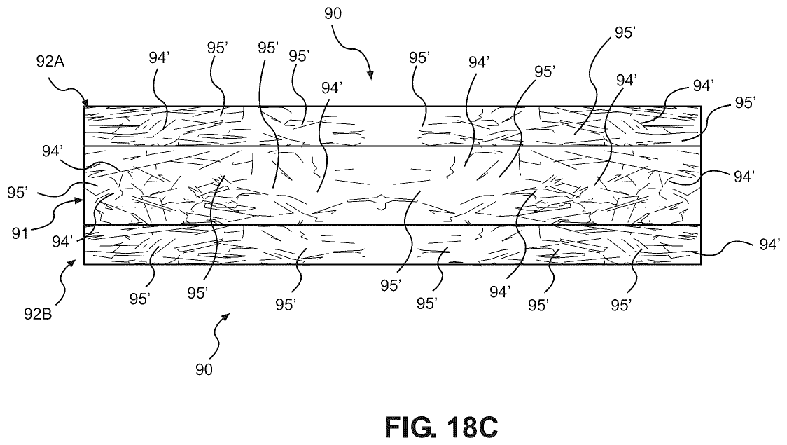

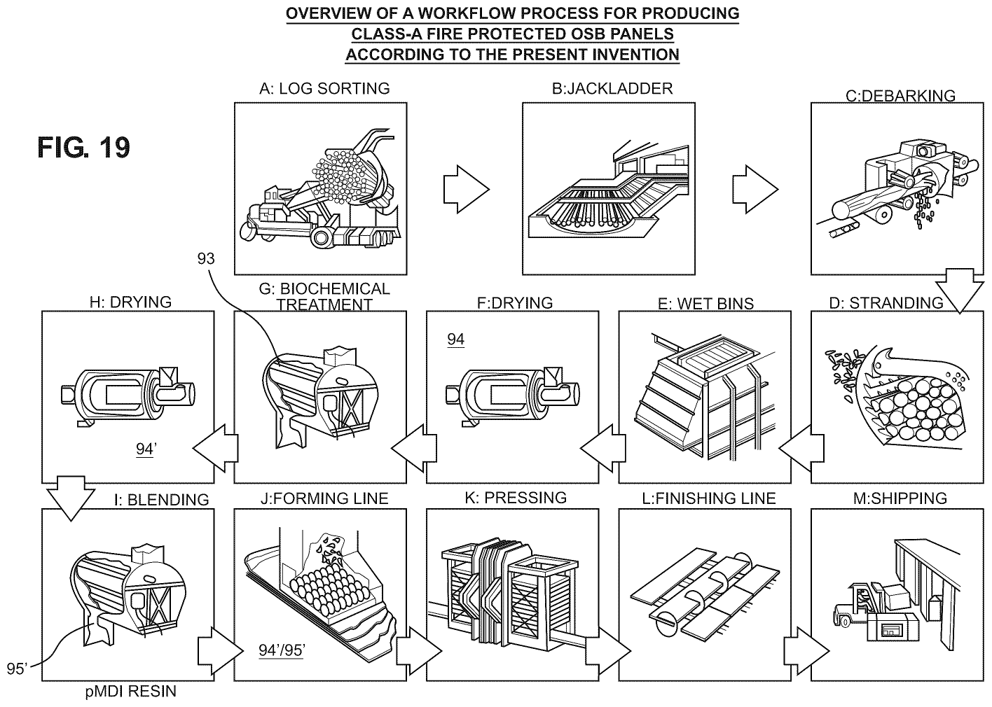

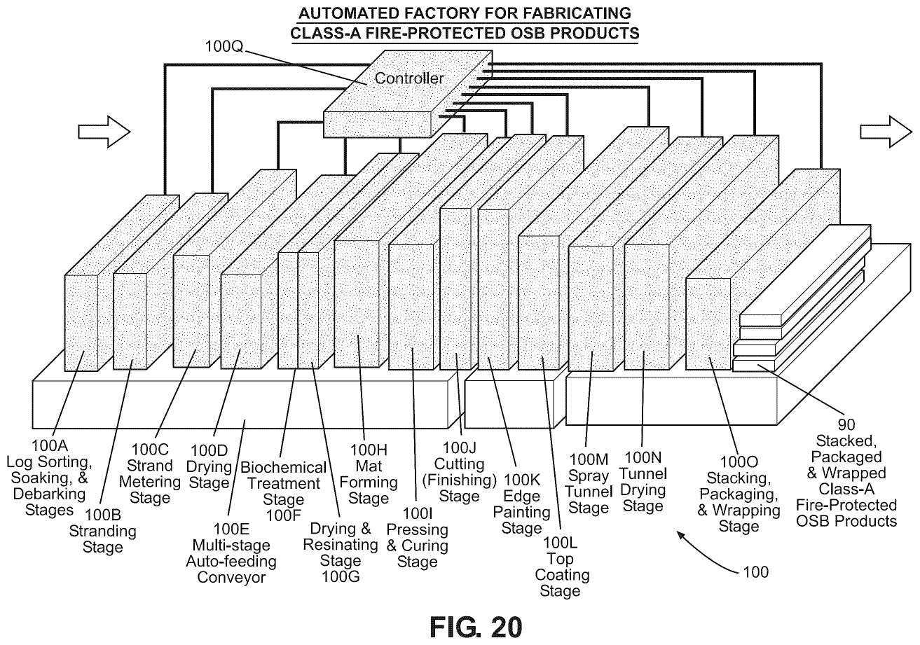

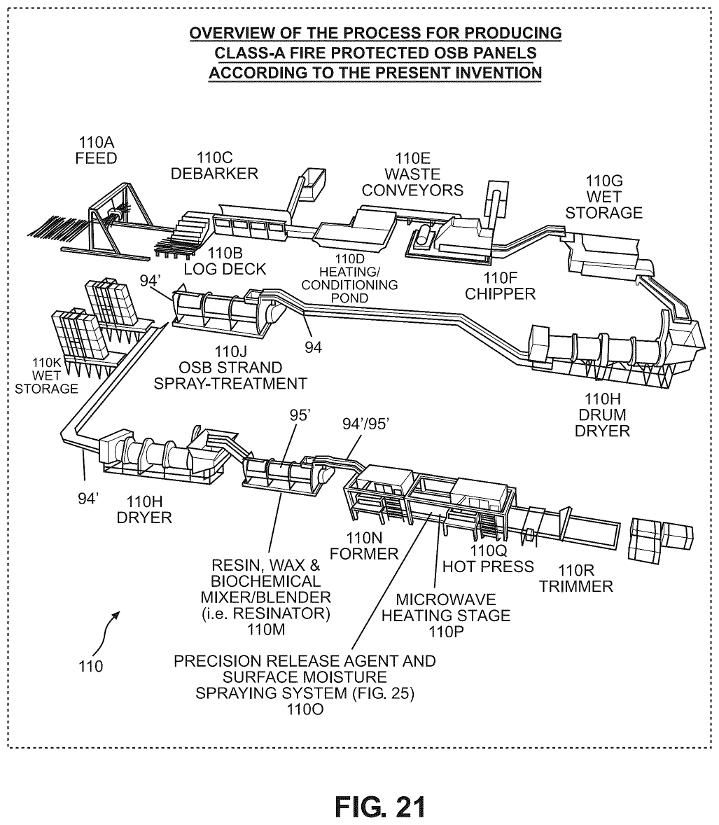

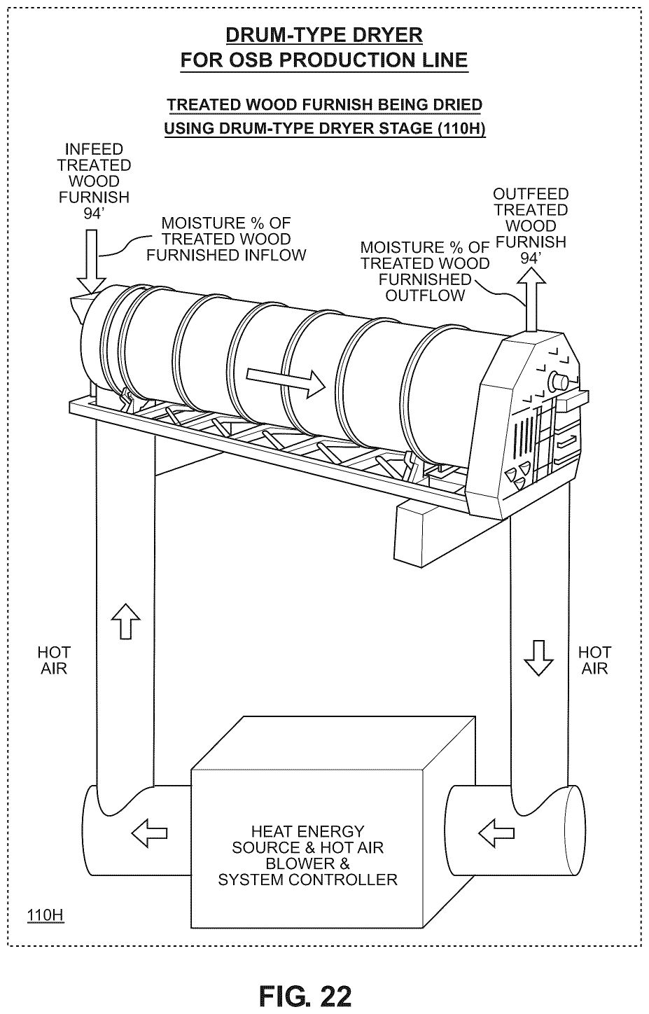

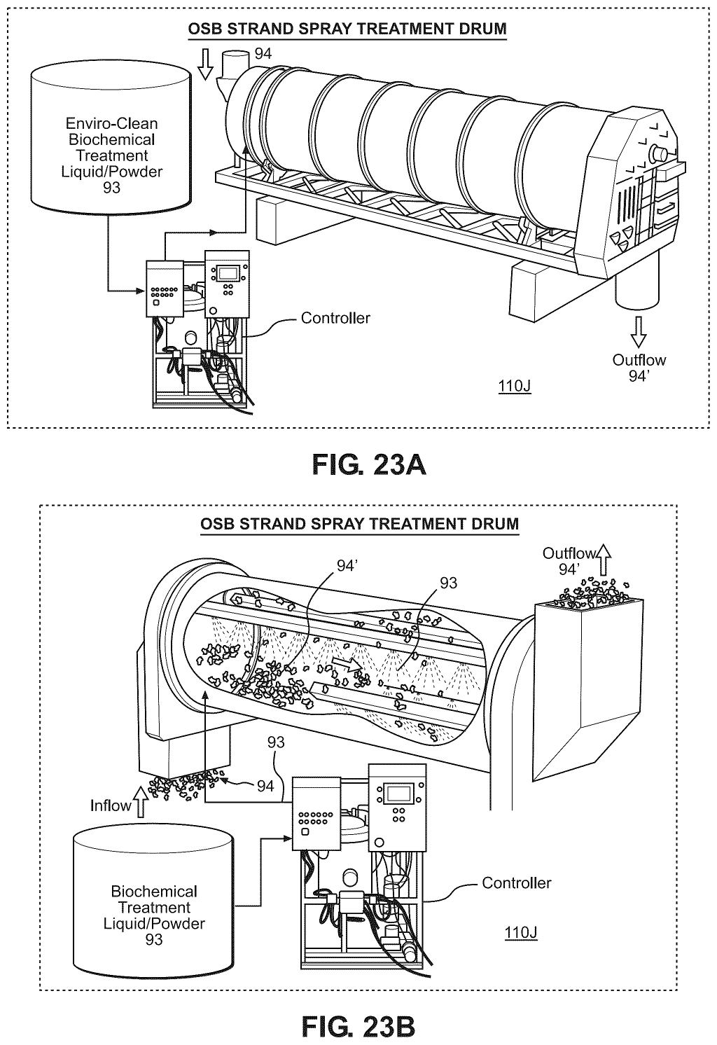

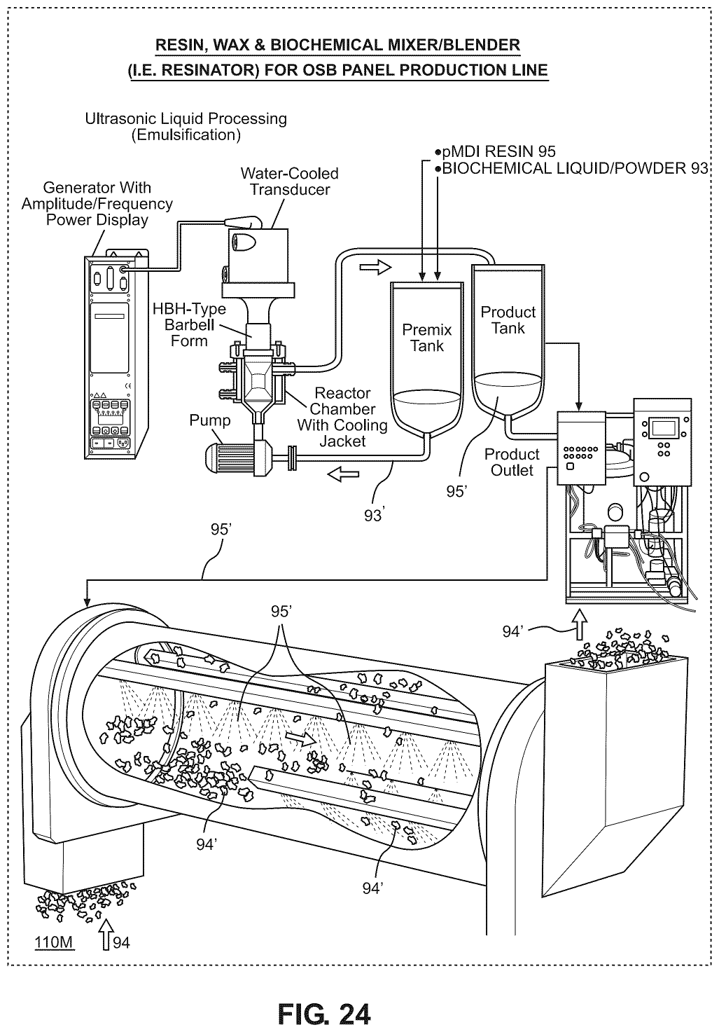

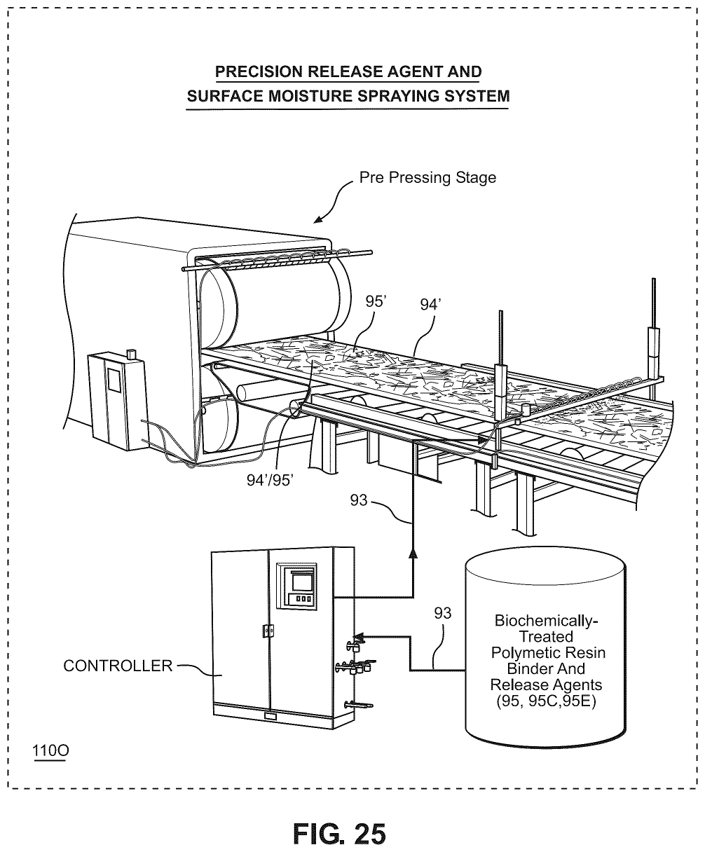

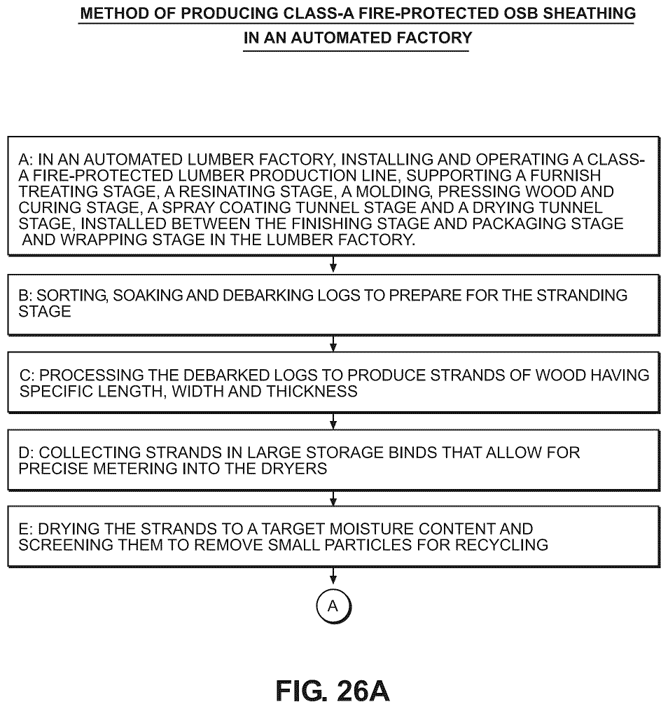

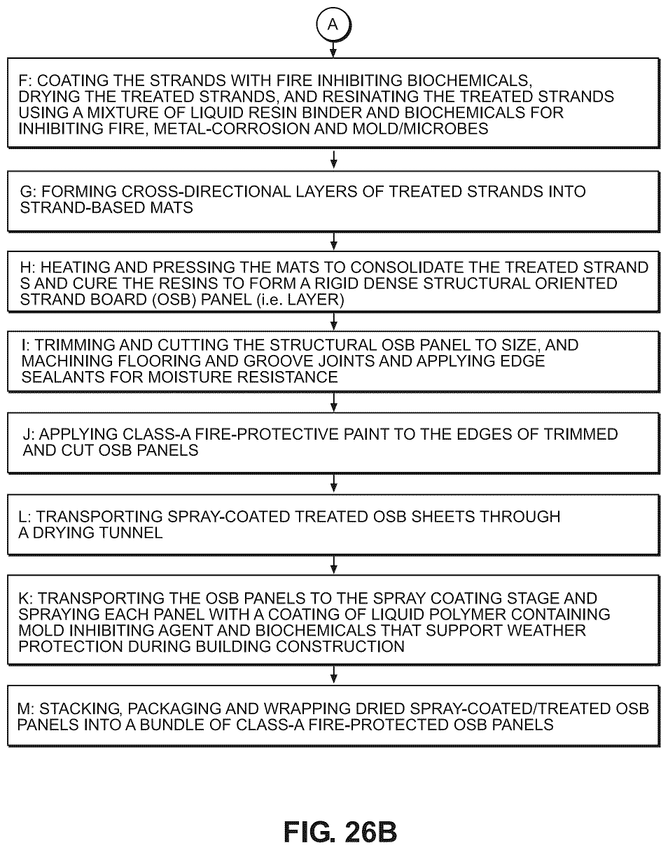

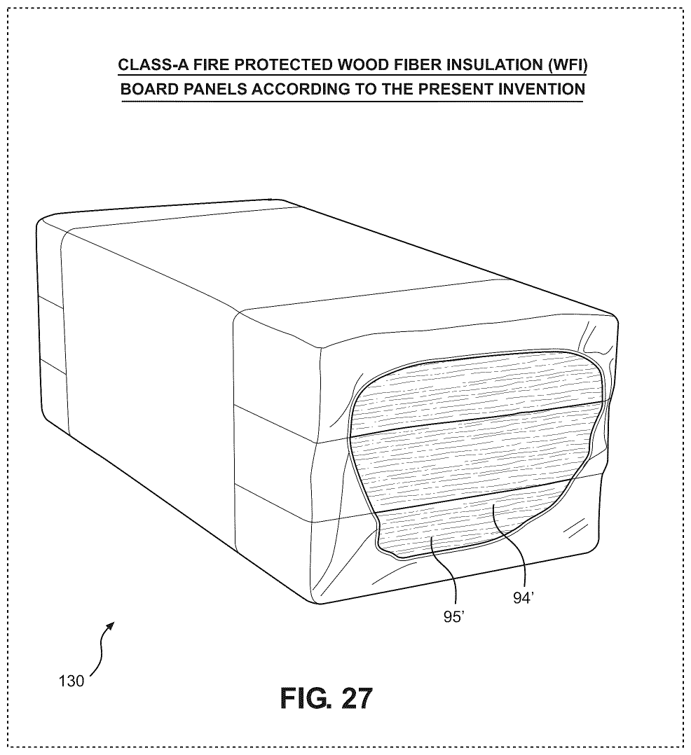

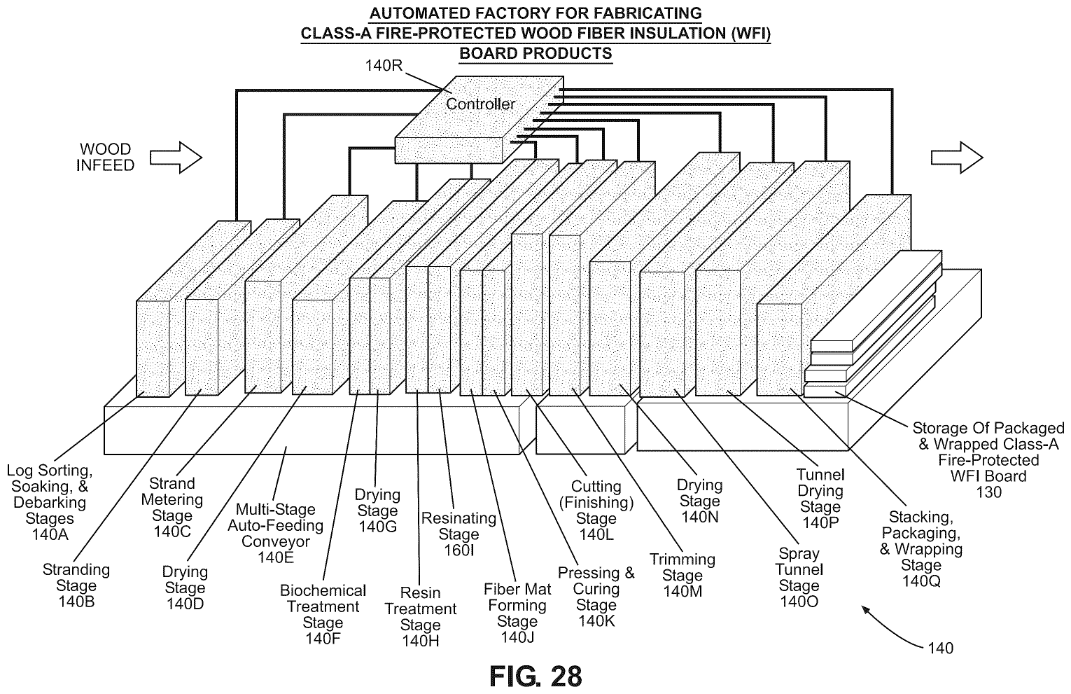

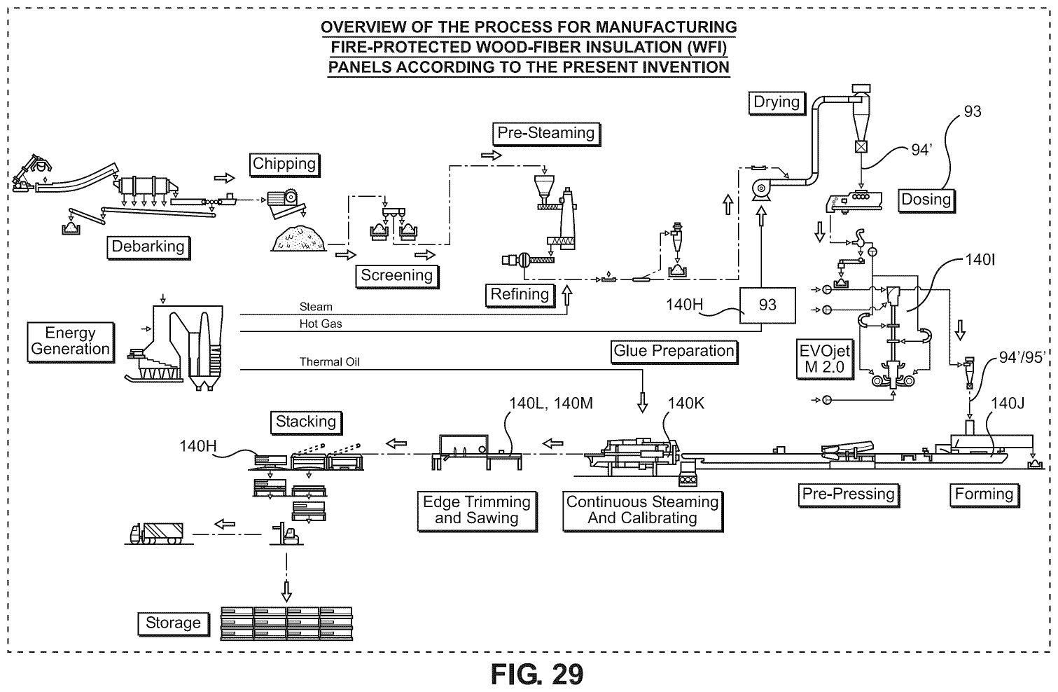

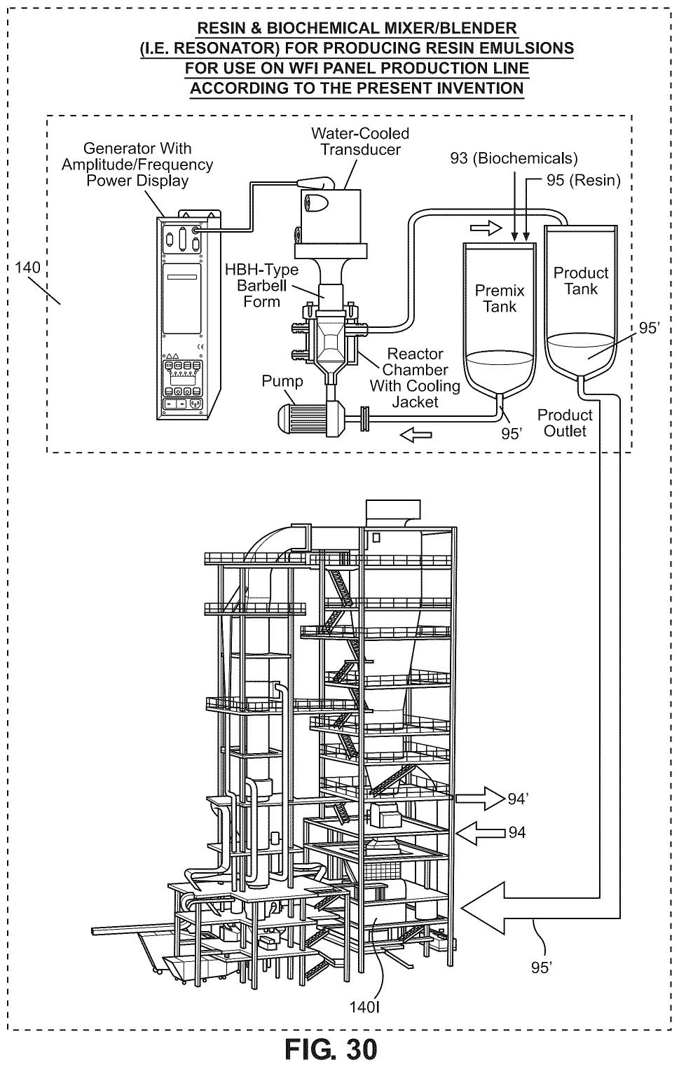

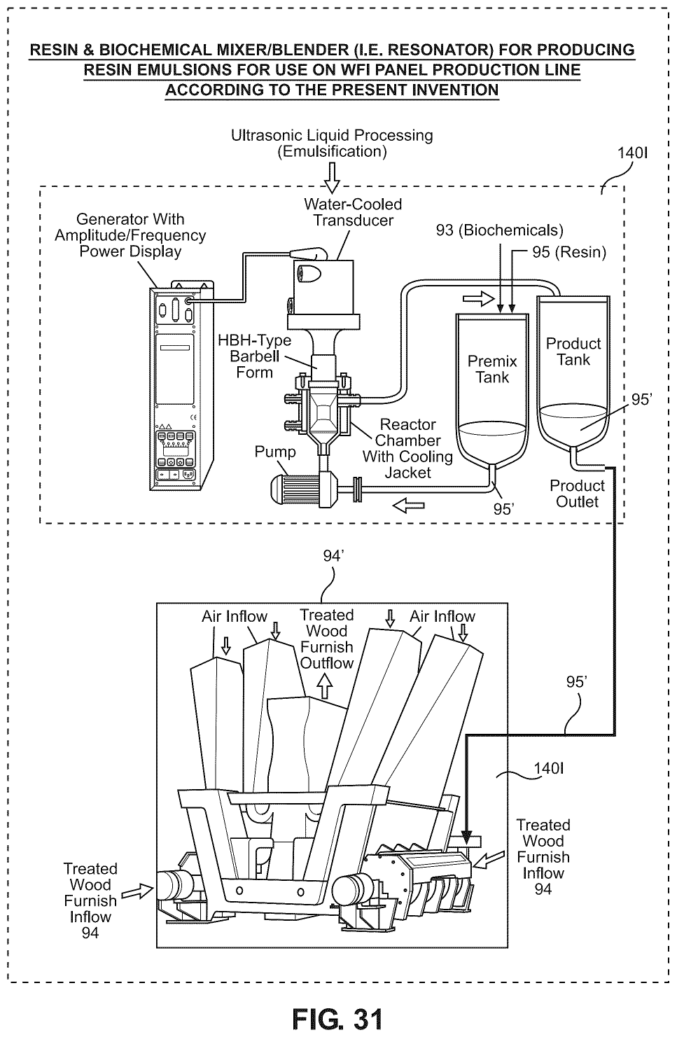

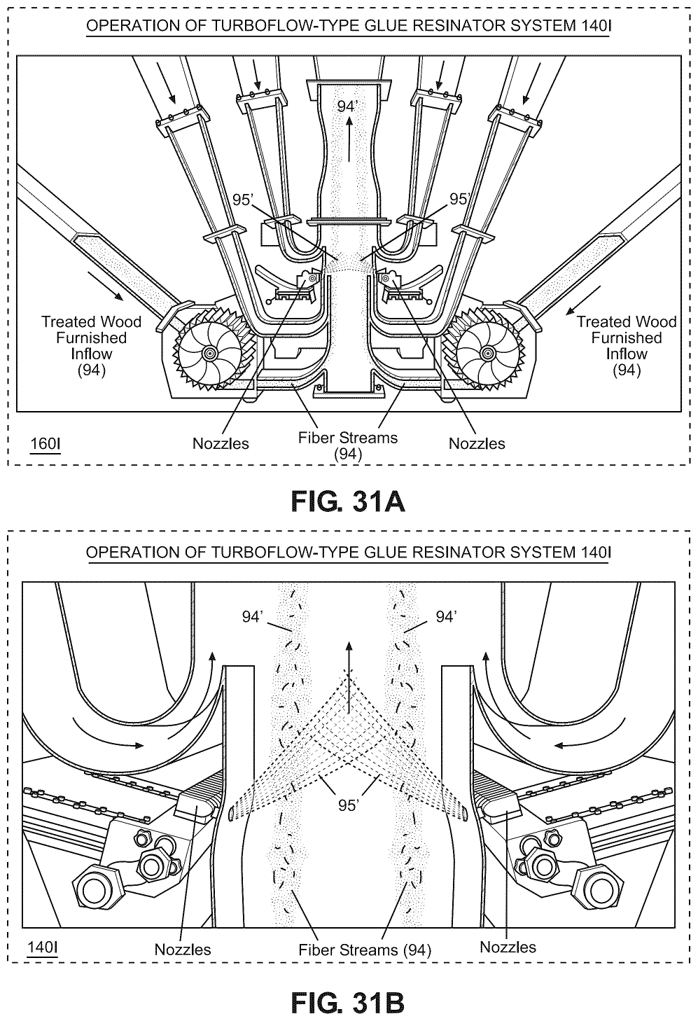

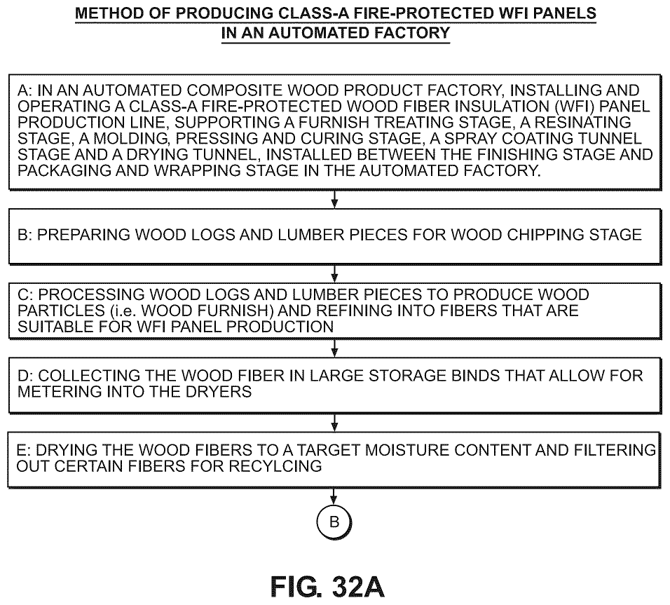

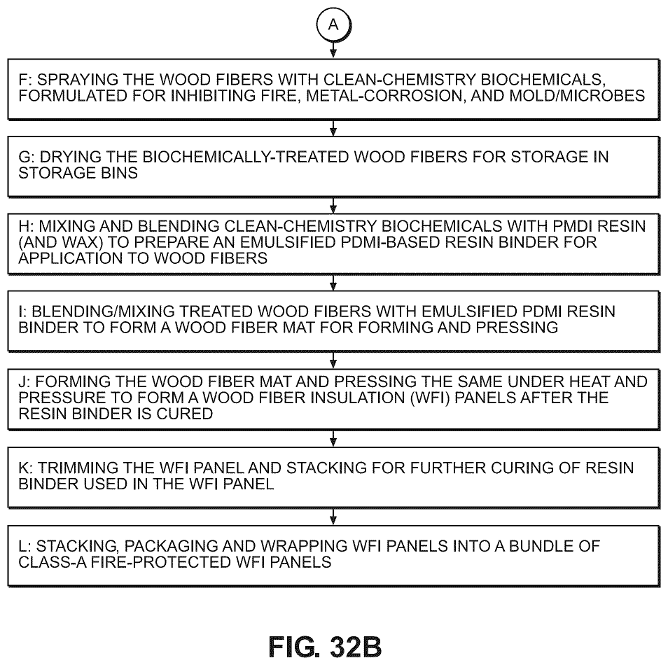

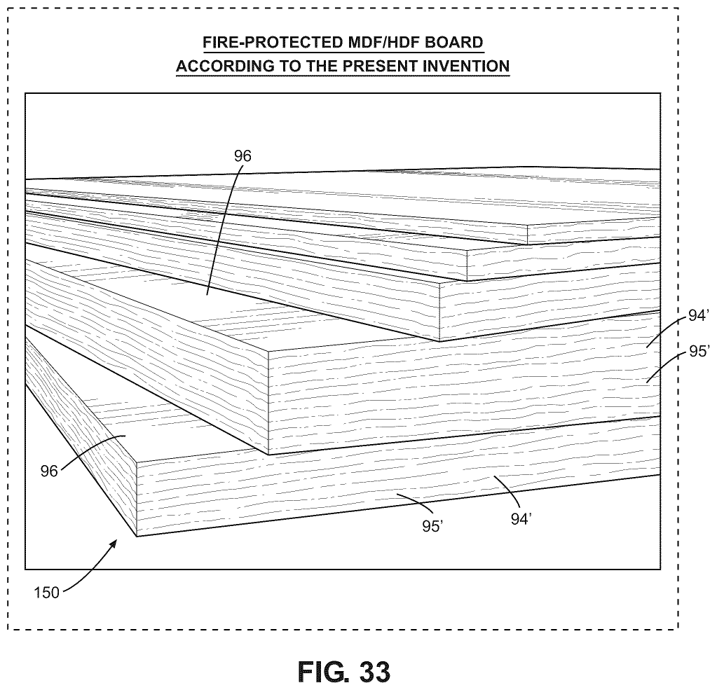

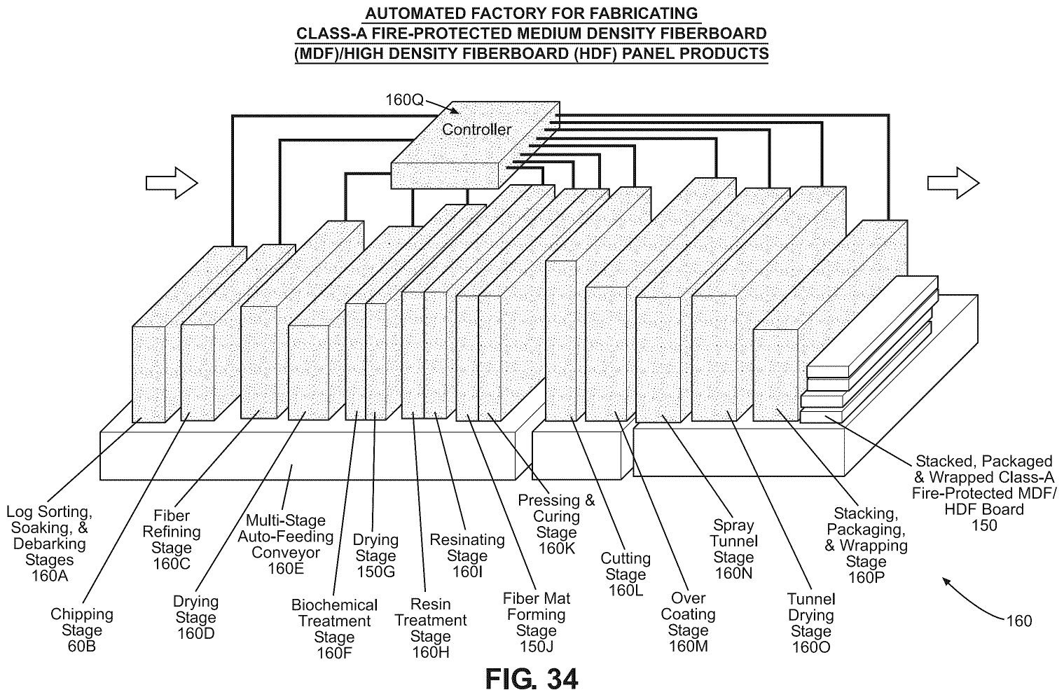

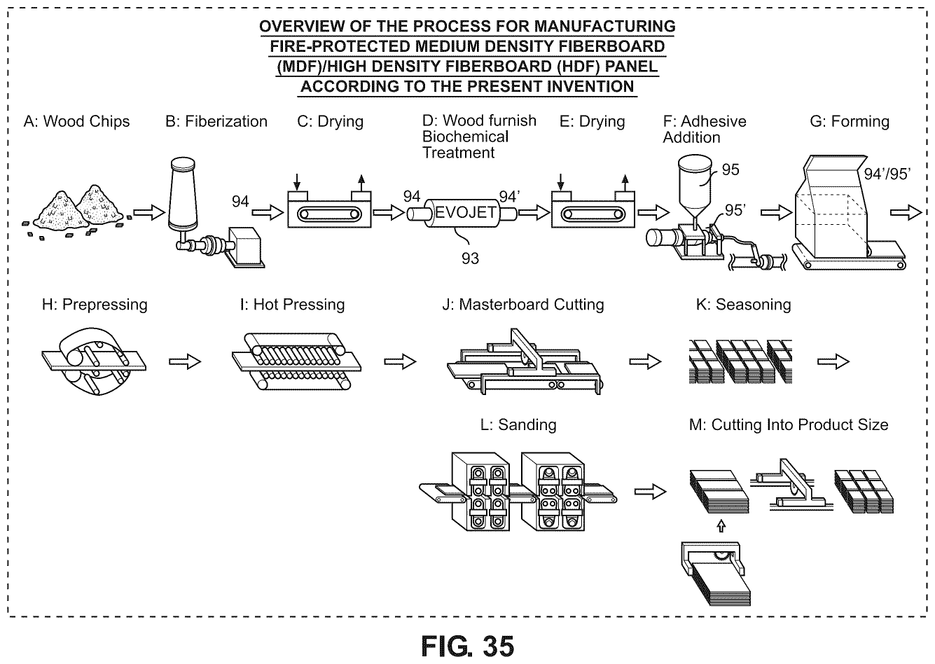

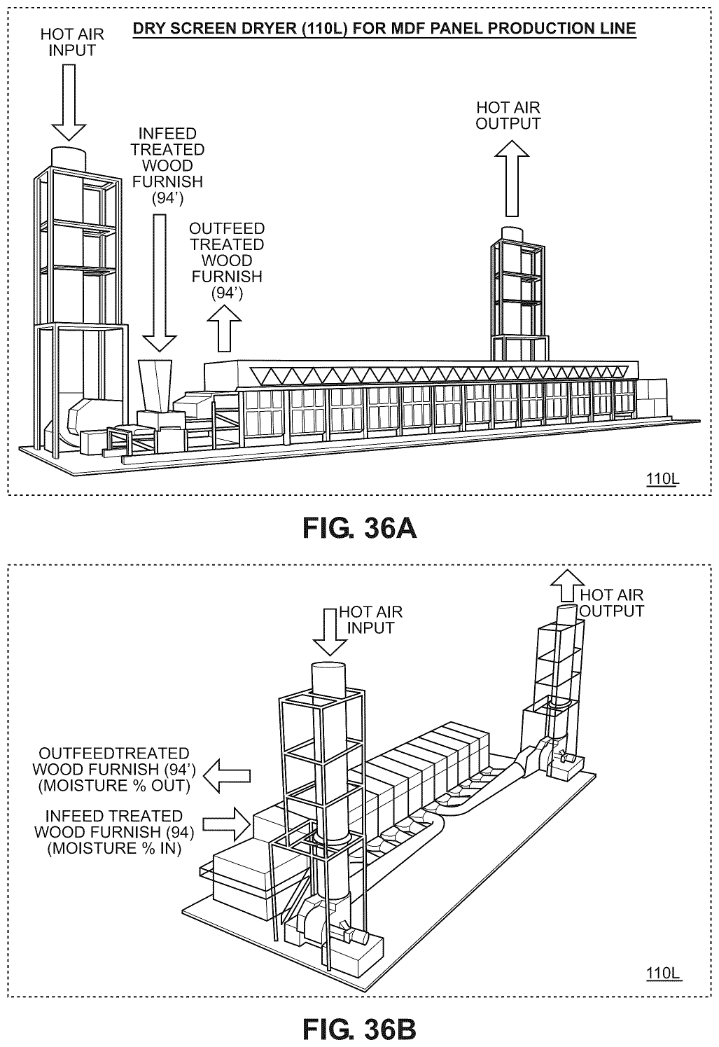

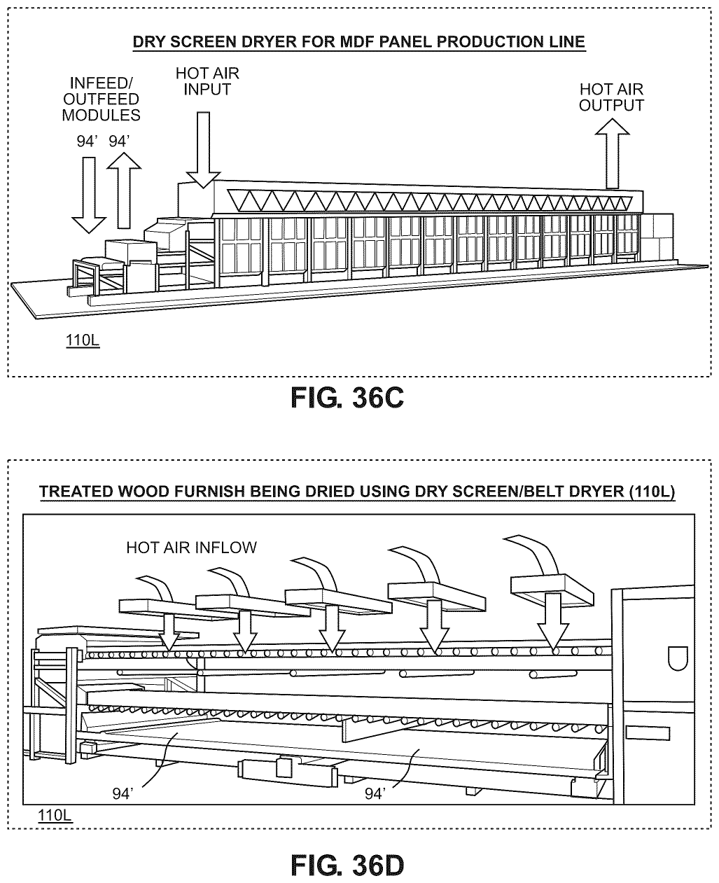

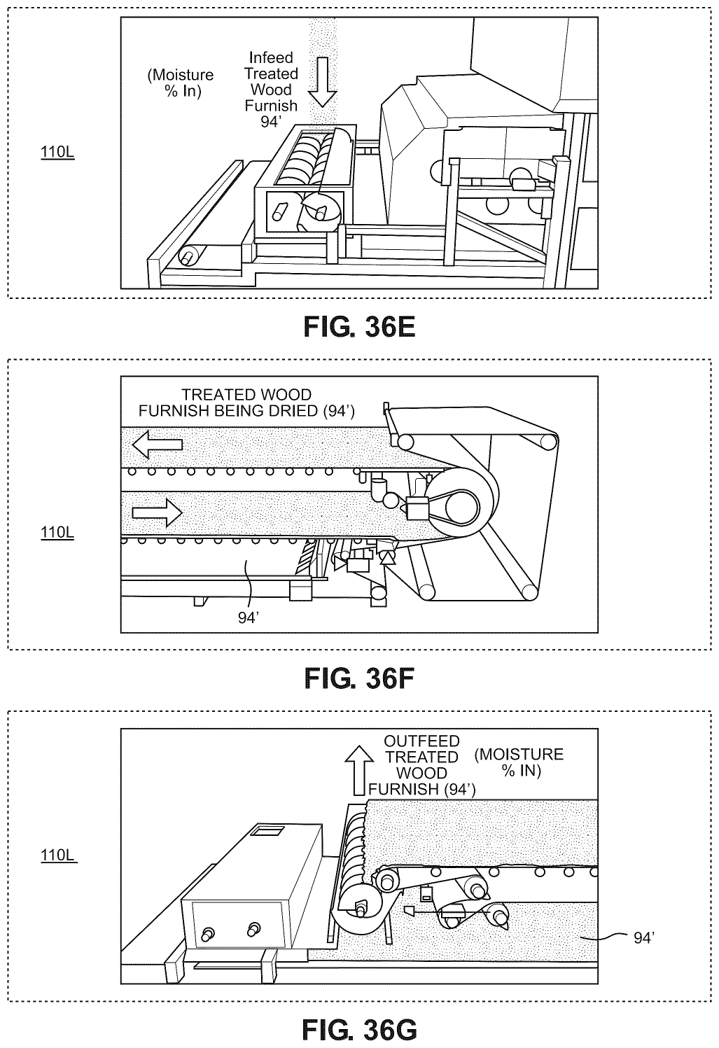

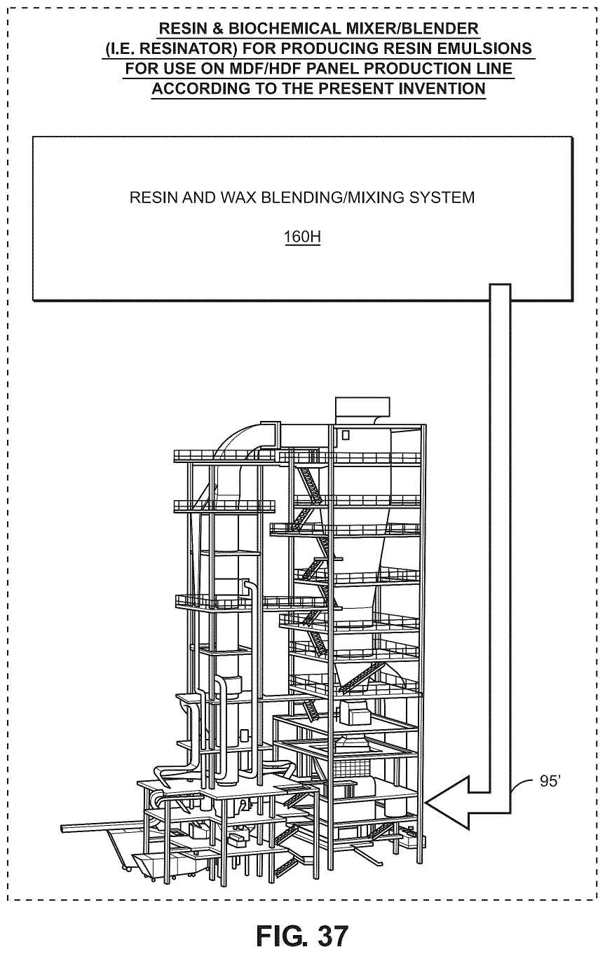

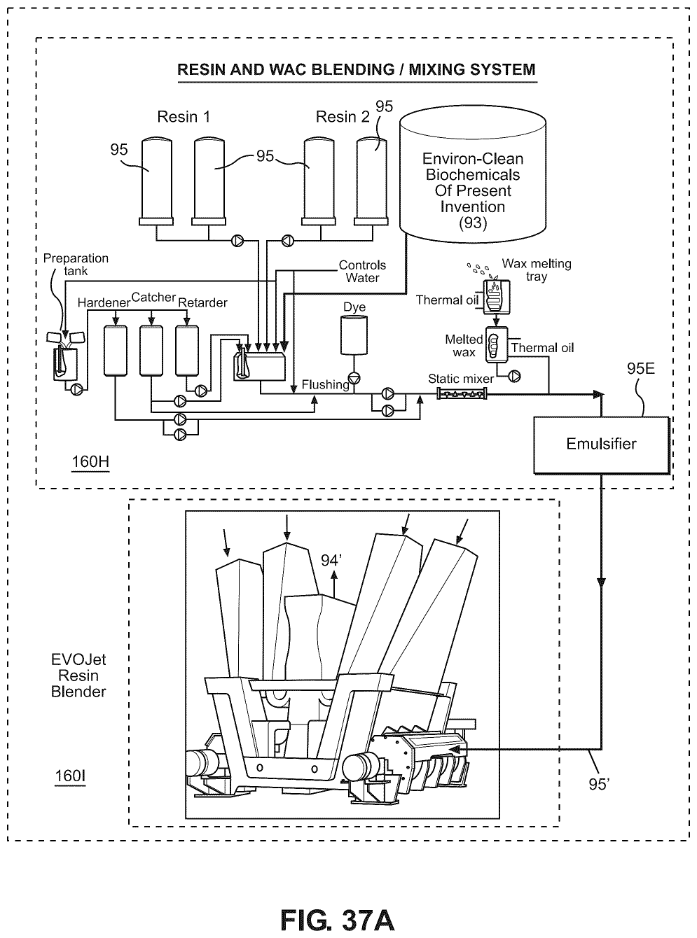

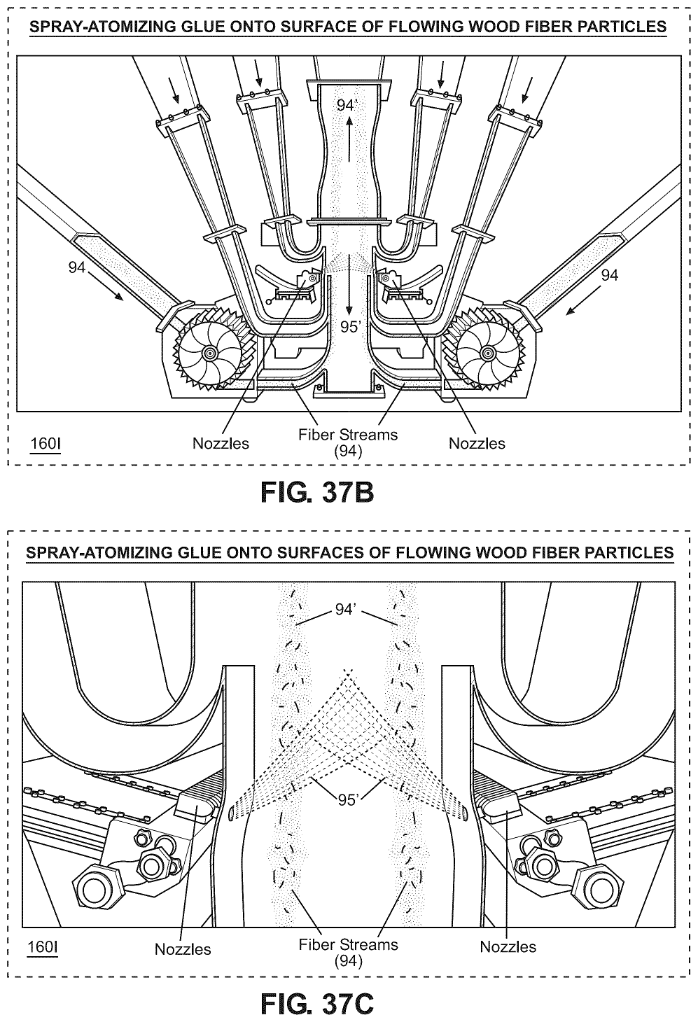

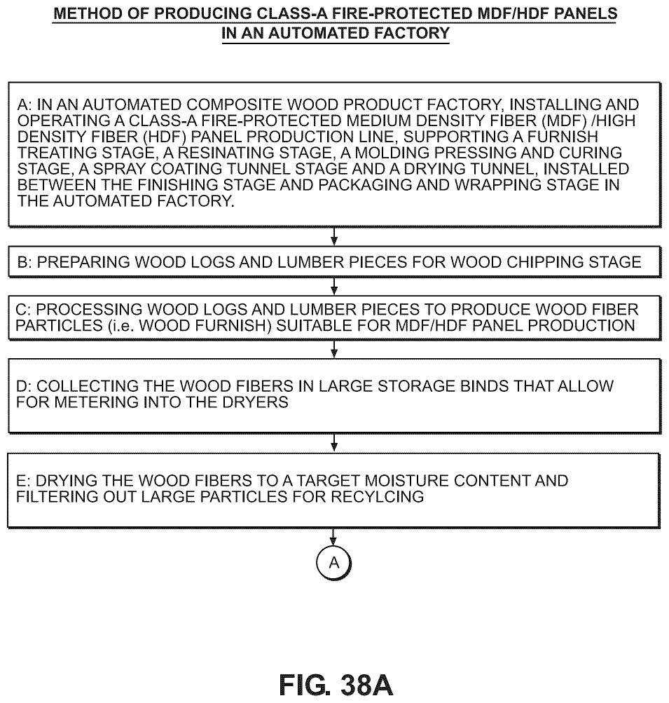

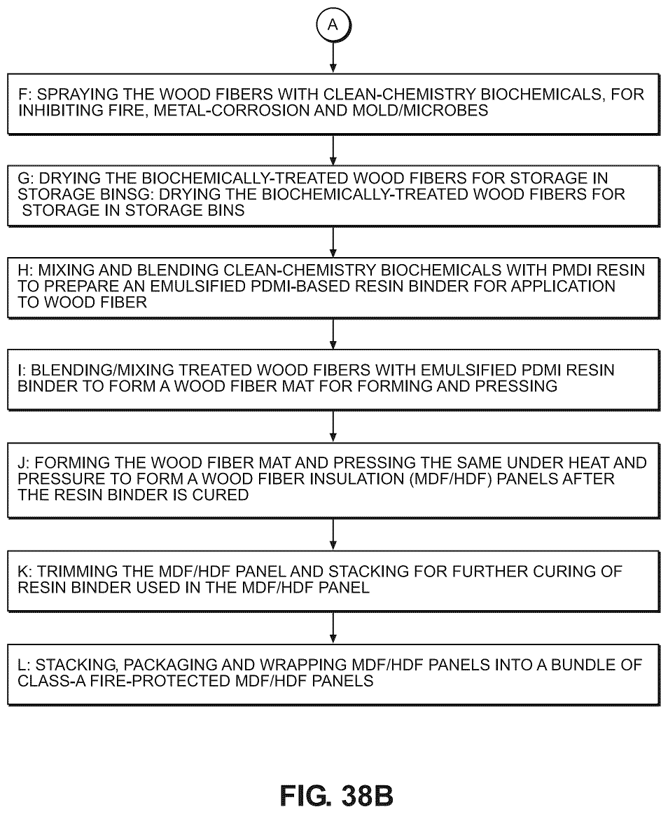

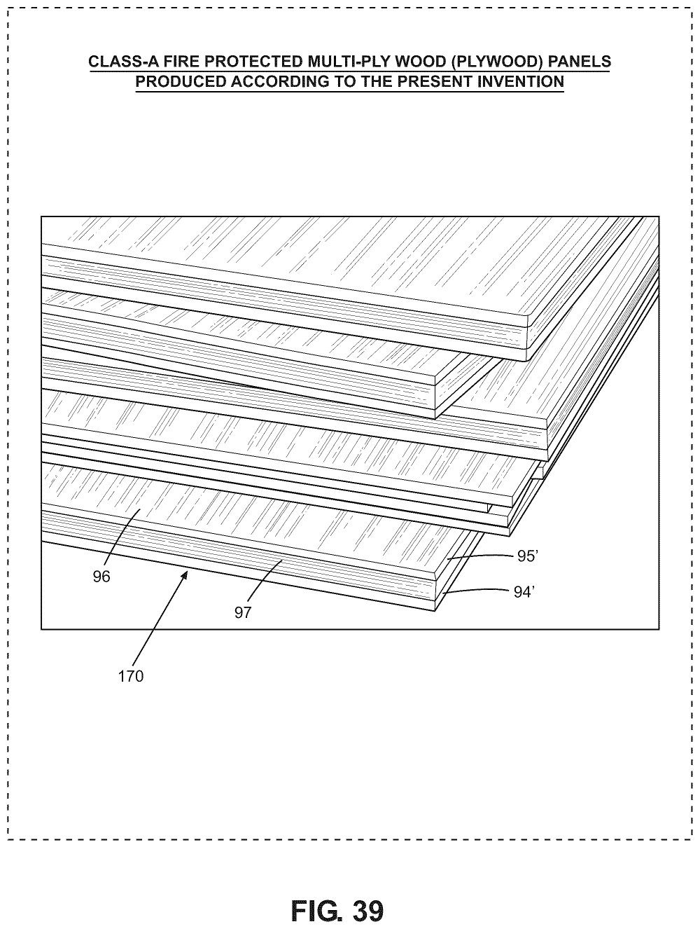

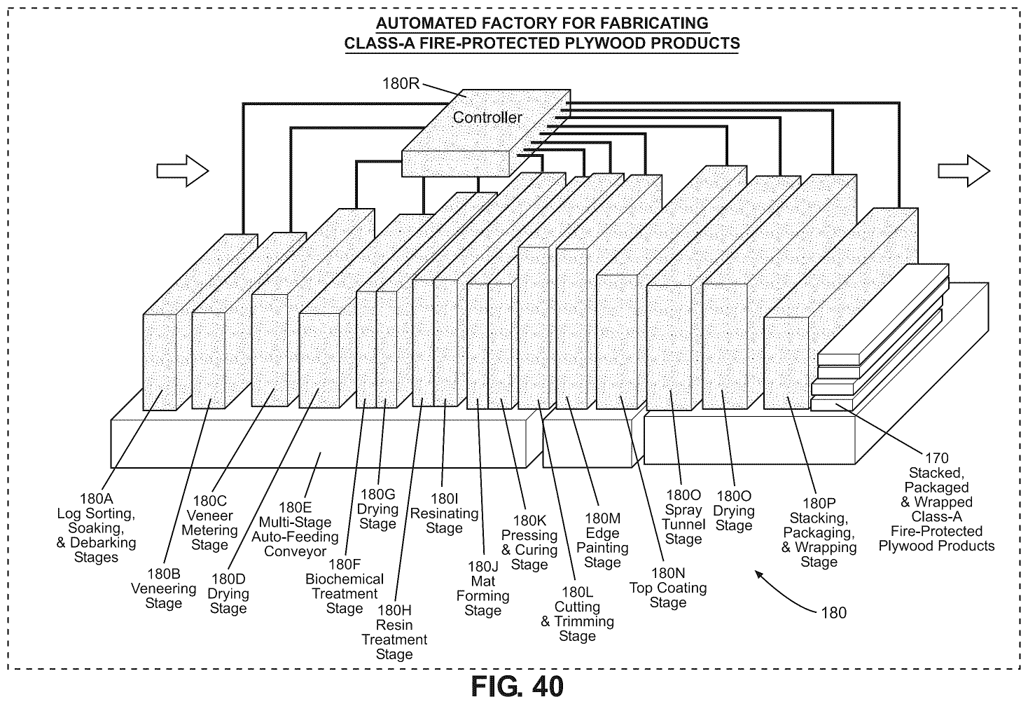

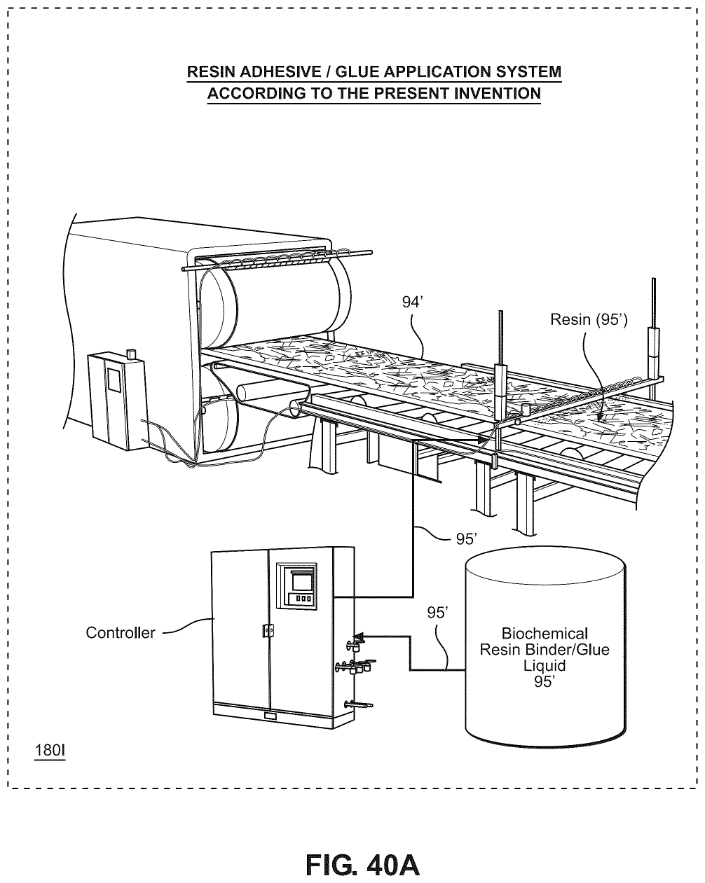

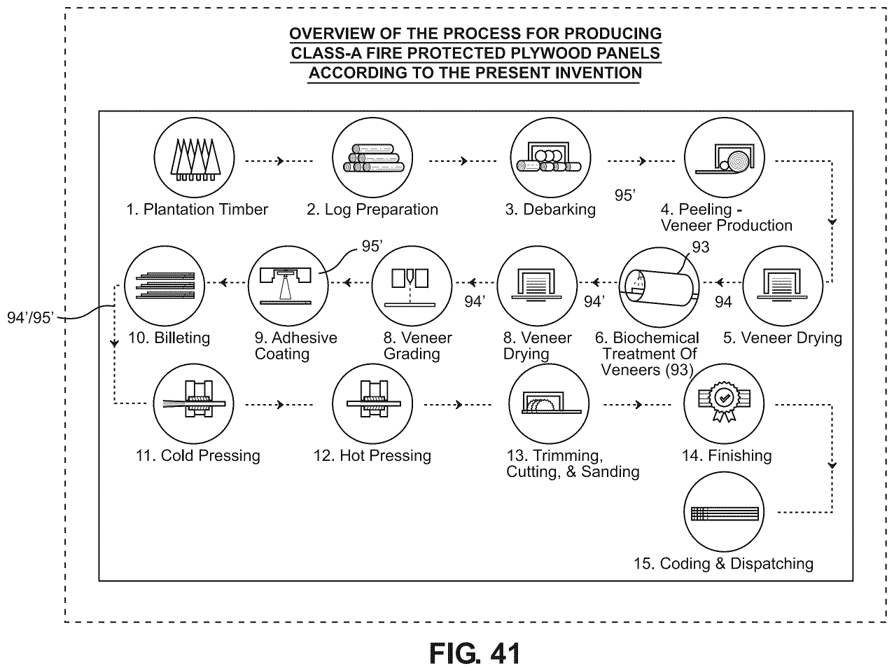

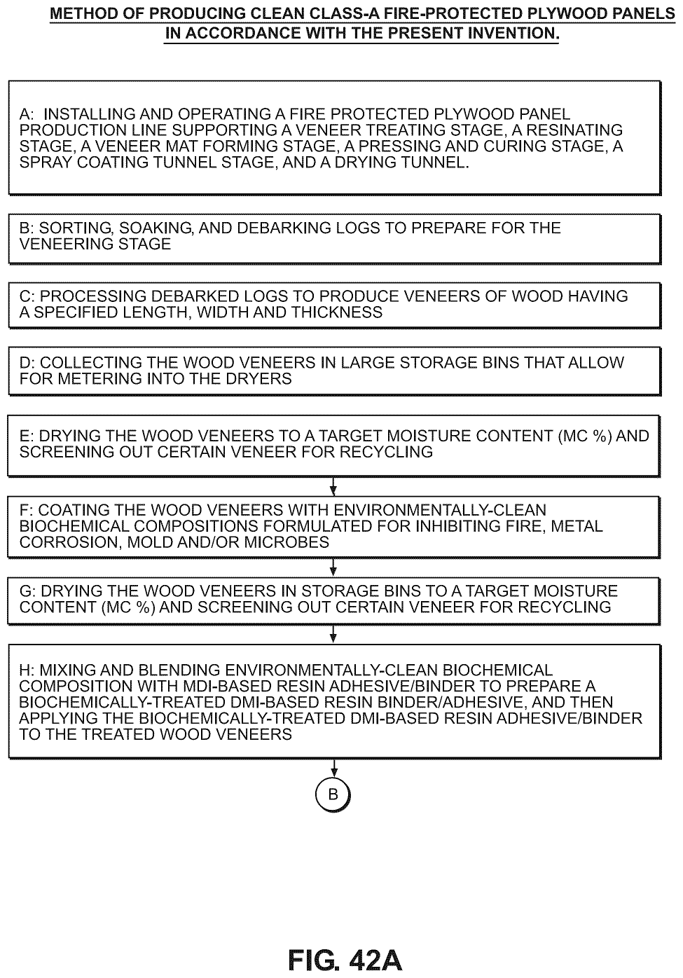

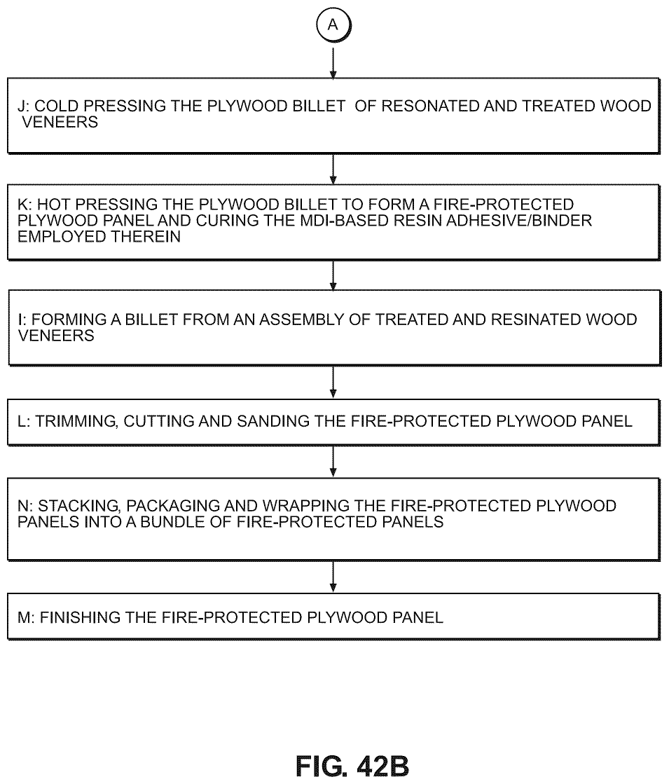

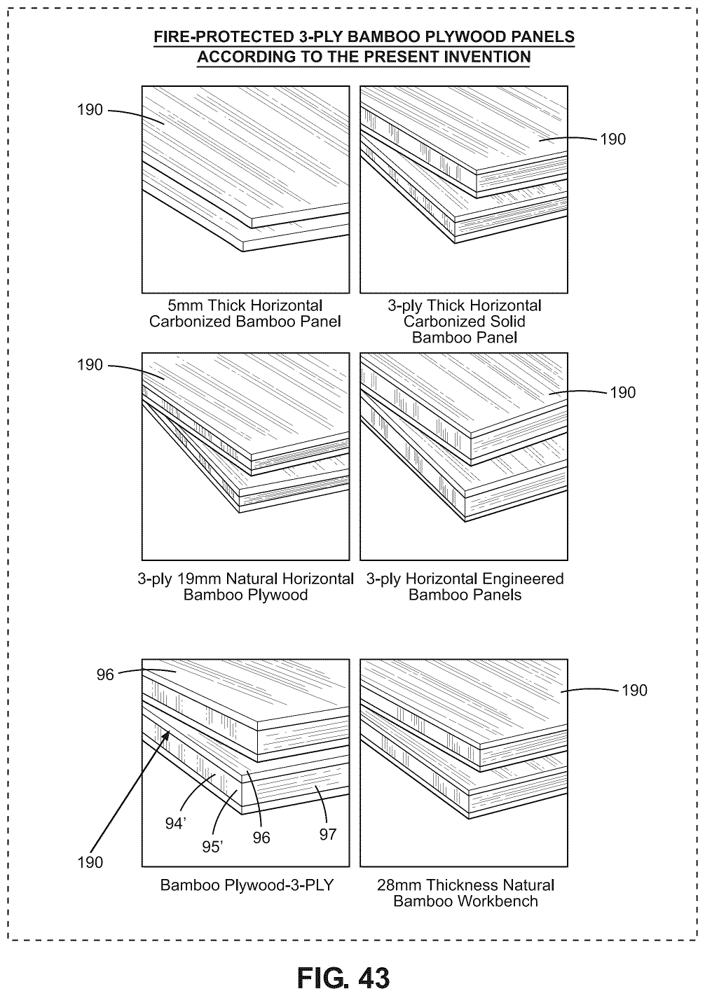

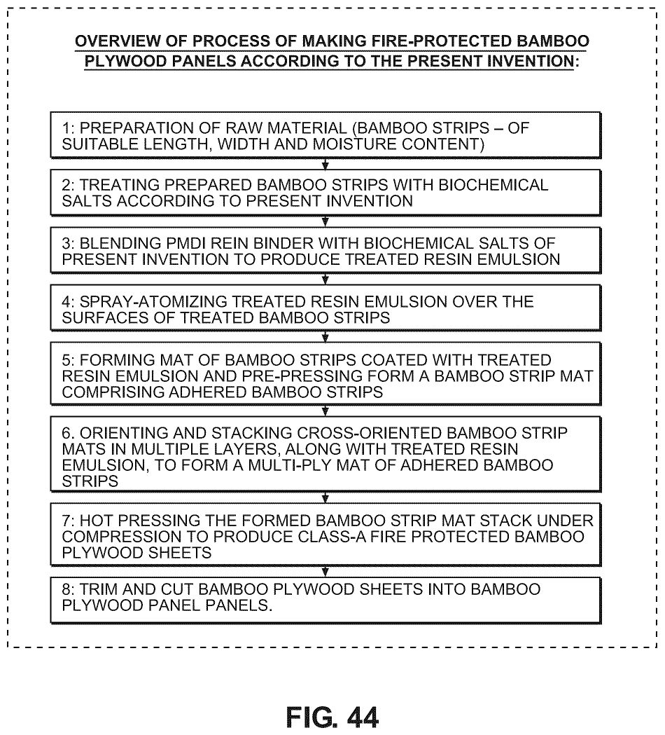

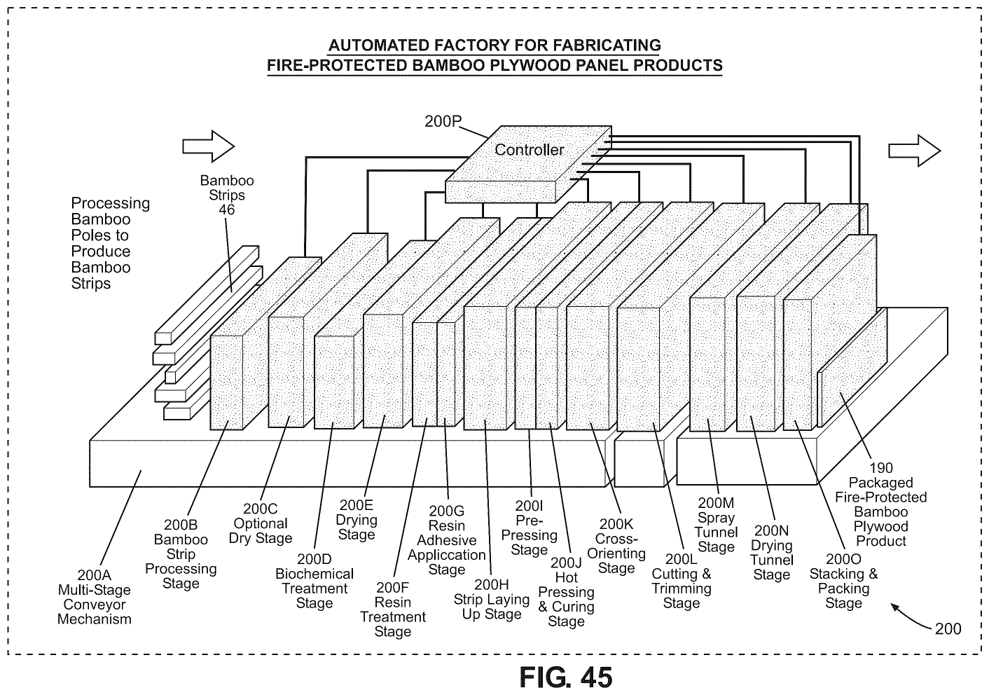

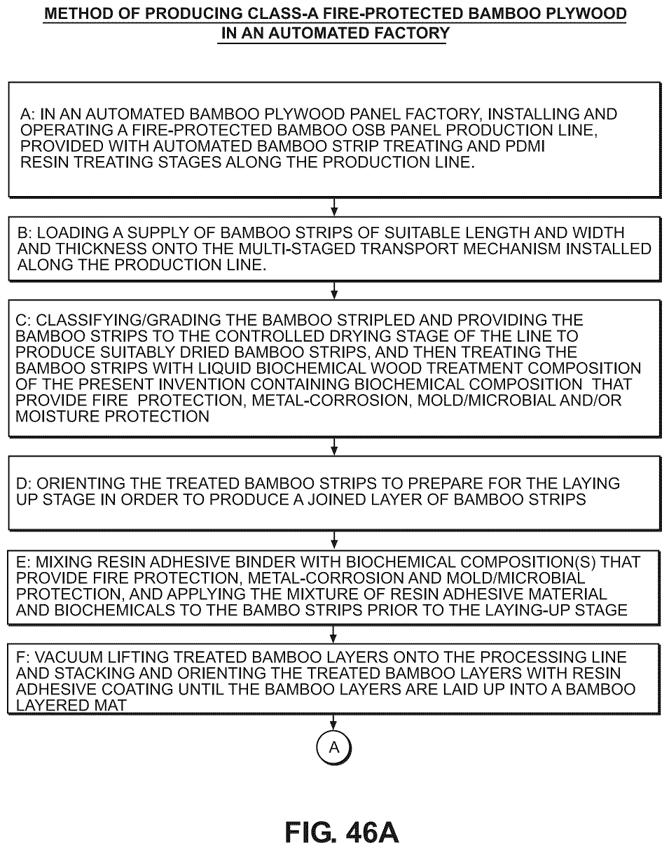

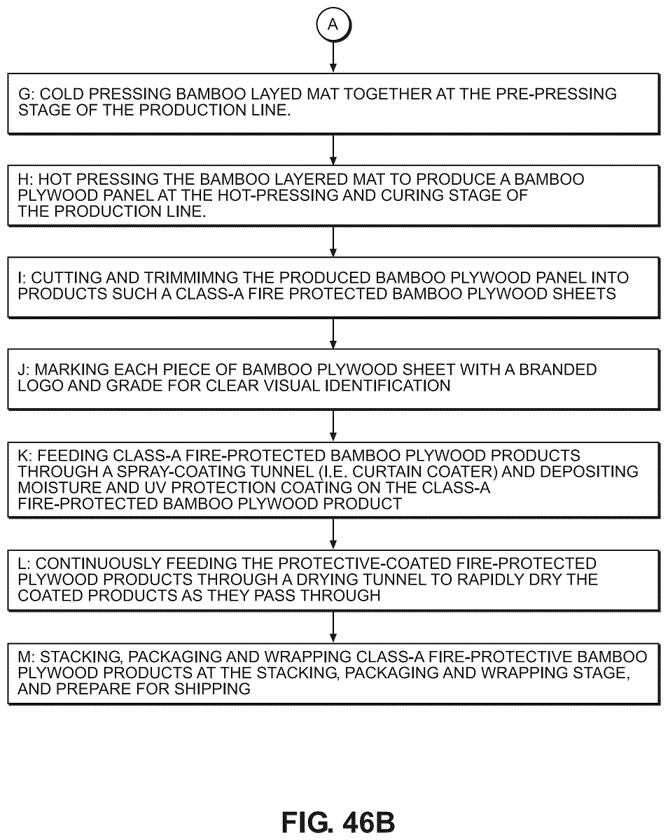

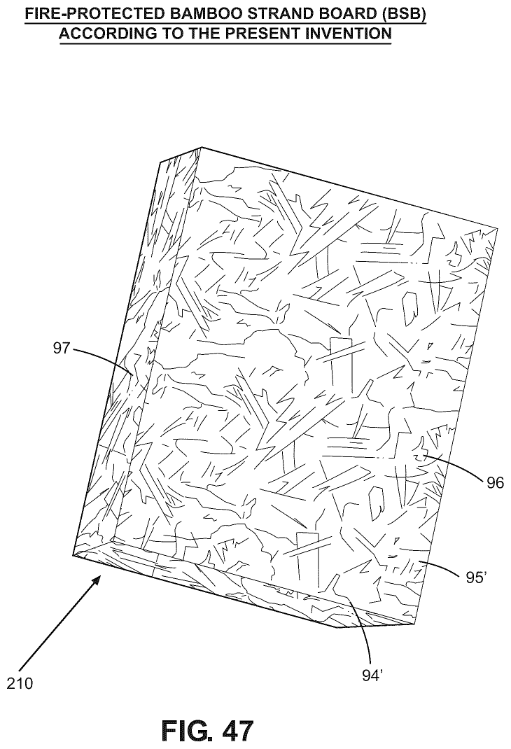

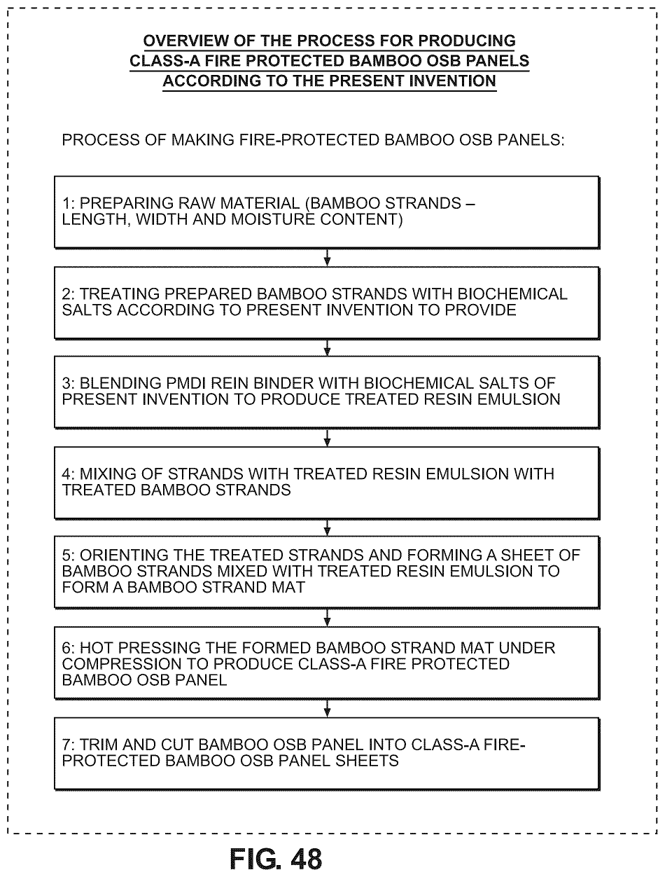

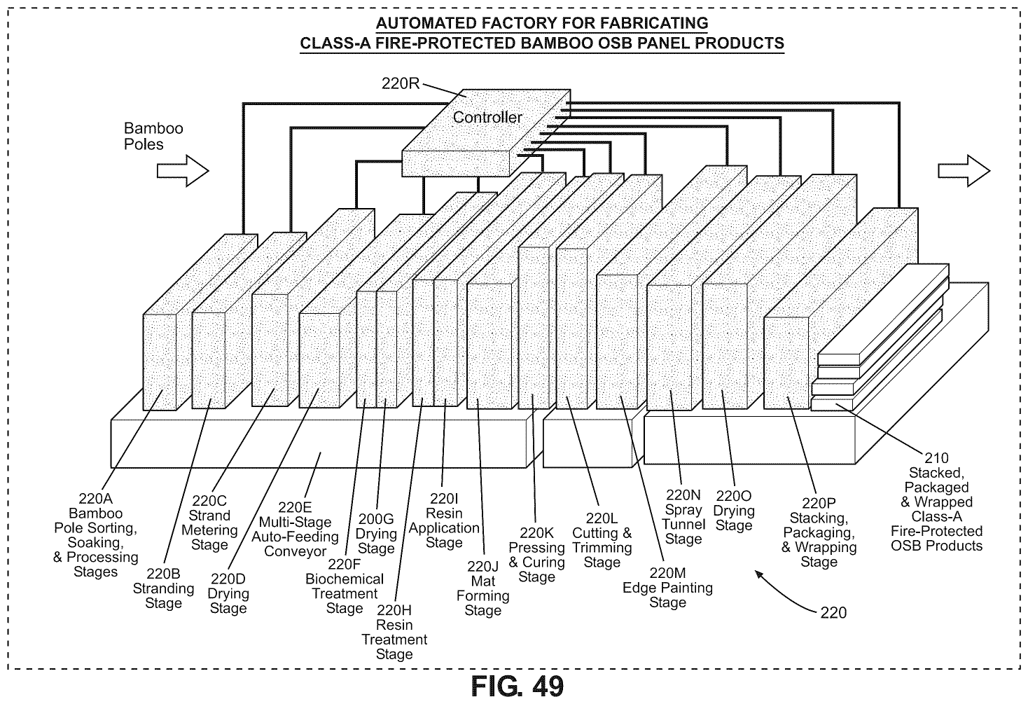

FIGS. 5P-1 and 5P-2, taken together, show a table of exemplary prior art pMDI resin binders under the I-BOND® brand, and prior art pMDI release agents under the I-RELASE® brand, produced by Huntsman International, including standard polymeric MDI resin, fast cure MDI resin (FC1), enhanced fast cure MDI resin, emulsifiable MDI resin (EFC1), fast cure MDI resin (EFC2), polymeric fast cure MDI resin (dry blending), low temperature curing MDI resin, emulsifiable low temperature curing MDI, internal release agent for multi-daylight and continuous pressing lines (synthetic wax) with 40% content, and external release agent for continuous pressing lines (wax free) with 20% solid content, that can be used for producing different types of composite wood products, such as oriented strand board (OSB), medium density board (MDF), high density board (HDF), particle board (PB), and wood fiber insulation board (WFI), for use in multi-daylight and continuous production lines using pressing machines;

FIG. 6 is a schematic representation of a first generic specification of the environmentally-clean aqueous-based fire inhibiting biochemical compositions (i.e. solutions) of the present invention for use in treating lignocellulosic materials during solid and composition wood product manufacturing operations, comprising (i) a major amount of metal alkali salt dissolved (or to be dissolved) in a major amount of water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, about 32 F to about 130 F, (ii) a minor amount of one or more esters derived from the saturated non-polymerized carboxylic acid and/or another saturated non-polymerized carboxylic acid, promoting dispersing and coalescing properties of metal alkali ions in the aqueous solution and formation of alkali metal salt crystalline structures and/or coatings on and/or within combustible materials upon the evaporation of water molecules from applied aqueous solution, and (iii) minor amount of metal salt derived from carboxylic acid for inhibiting metal corrosion, mold and microbial life;

FIG. 6A is a schematic representation of a second generic specification of the environmentally-clean aqueous-based fire inhibiting biochemical composition (i.e. solution) of the present invention for use in treating lignocellulosic (wood) furnish material, as well as solid wood materials, during the manufacture of solid, composite and engineering wood products used in the building and construction industry, so as to provide fire inhibiting, protective and/or resistant performance characteristics, comprising (i) a major amount of metal alkali salt dissolved (or to be dissolved) in a major amount of water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, (ii) a minor amount of alkali metal salt derived from of benzoic acid, wherein the alkali metal is selected from group consisting of potassium, sodium, calcium and magnesium, (iii) a minor amount of one or more esters derived from the saturated non-polymerized carboxylic acid and/or another saturated non-polymerized carboxylic acid, promoting dispersing and/or coalescing properties of metal alkali ions in the aqueous solution and formation of alkali metal salt crystalline structures and/or coatings on and/or within combustible materials upon the evaporation of water molecules from applied aqueous solution, and/or esterification of the lignocellulosic material being treated, and (iv) minor amount of metal salt derived from carboxylic acid for inhibiting metal corrosion, mold and microbial life;

FIG. 6A1 is a schematic representation of a generic specification of the environmentally-clean biochemical wood treatment composition (i.e. solution) of the present invention for use in proactive fire-protection applications such as treating lignocellulosic (wood) furnish material as well as solid wood materials, during the manufacture of solid, composite and engineering wood products used in the building and construction industry, so as to provide fire inhibiting or fire resistant performance characteristics, comprising (i) a major amount of metal alkali salt dissolved (or to be dissolved) in a major amount of water, and derived from a saturated non-polymerized carboxylic acid, wherein the carbon chain length of the carboxylic acid is C=6 (C6), and the resulting water-based liquid solution is stable when mixed so that its chemical components do not precipitate in the aqueous solution when stored in a storage container, (ii) a minor amount of alkali metal salt derived from of benzoic acid, wherein the alkali metal is selected from group consisting of potassium, sodium, calcium and magnesium, specifically potassium benzoate (SB), (iii) a minor amount of one or more esters derived from the saturated non-polymerized carboxylic acid and/or another saturated non-polymerized carboxylic acid, specifically triethyl citrate (TEC), promoting dispersing and/or coalescing properties of metal alkali ions in the aqueous solution and formation of alkali metal salt crystalline structures and/or coatings on or within combustible materials upon the evaporation of water molecules from applied aqueous solution, and esterification of the lignocellulosic material being treated, and (iv) minor amount of metal salt derived from carboxylic acid for inhibiting metal corrosion, mold and/or microbial life;

FIG. 6A2 is a schematic representation of a generic specification of the environmentally-clean biochemical wood treatment composition (i.e. solution) of the present invention for use in proactive fire-protection applications such as treating lignocellulosic (wood) furnish material as well as solid wood materials, during the manufacture of solid, composite and engineering wood products used in the building and construction industry, so as to provide fire inhibiting or fire resistant performance characteristics, comprising (i) a major amount of metal alkali salt dissolved (or to be dissolved) in a major amount of water, and derived from a saturated non-polymerized carboxylic acid, wherein the carbon chain length of the carboxylic acid is C=6 (C6), and the resulting water-based liquid solution is stable when mixed so that its chemical components do not precipitate in the aqueous solution when stored in a storage container, (ii) a minor amount of alkali metal salt derived from of benzoic acid, wherein the alkali metal is selected from group consisting of potassium, sodium, calcium and magnesium, specifically potassium benzoate (SB), and (iii) a minor amount of one or more esters derived from the saturated non-polymerized carboxylic acid and/or another saturated non-polymerized carboxylic acid, specifically triethyl citrate (TEC), promoting dispersing and/or coalescing properties of metal alkali ions in the aqueous solution and formation of alkali metal salt crystalline structures and/or coatings on or within combustible materials upon the evaporation of water molecules from applied aqueous solution, and esterification of the lignocellulosic material being treated;

FIG. 6B1 shows an exemplary specification for the first dry powder embodiment of the biochemical composition of the present invention, adapted for treating lignocellulosic-based material (i.e. wood furnish material), and/or polymeric resin binder material, during factory-based composite wood product manufacture, and comprising: (i) a major amount of dry powder tripotassium citrate monohydrate (TPC); and (ii) a minor amount of dry powder potassium benzoate (and optionally cupric citrate for mold control), wherein these dry powder components are prepared for (i) (dry powder) spraying onto wet lignocellulosic wood furnish material; and/or (ii) mixing and blending with a predetermined quantity of polymeric resin binder material (in an uncured/non-reacting liquid state), so as to treat lignocellulosic wood furnish material and/or polymeric resin binder material during composite wood product manufacture operations.

FIG. 6B2 shows an exemplary specification for the second embodiment of the biochemical composition of the present invention, adapted for treating lignocellulosic-based material (i.e. wood furnish material), and/or polymeric resin binder material, during factory-based composite wood product manufacture, and comprising: (i) a major amount of dry powder tripotassium citrate monohydrate (TPC); and (ii) a minor amount of dry powder potassium benzoate (and optionally cupric citrate for mold control) in combination with a minor amount of water as a reactant/catalyst when blended with pMDI polymeric resin binder, wherein these components are prepared for (i) (dry powder) spraying onto wet/green lignocellulosic wood furnish material; and/or (ii) mixing and blending with a predetermined quantity of polymeric resin binder material (in an uncured/non-reacting liquid state), so as to treat lignocellulosic wood furnish material and/or polymeric resin binder material during composite wood product manufacture operations.

FIG. 6B3 shows an exemplary specification for the first polymeric resin binder material biochemically-treated for use during factory-based composite wood product manufacture, and comprising: (i) a major amount of dry powder tripotassium citrate monohydrate (TPC); (ii) a minor amount of dry powder potassium benzoate (and optionally cupric citrate for mold control); and (iii) a major amount of pDMI polymeric resin binder material (in an uncured/non-reacting liquid state), blended together so that the dry power particles are well dispersed throughout the treated resin binder material, preferably in a homogeneous manner, preferably using a suitable emulsifier (e.g. triethyl citrate, waxes and other additives), whereby the polymeric resin binder material is biochemically treated prior to use during composite wood product manufacture operations, by providing fire inhibiting and corrosion inhibiting biochemicals available for protection against fire ignition, flame spread, smoke development;

FIG. 6B4 show an exemplary specification for the second polymeric resin binder material biochemically-treated for use during factory-based composite wood product manufacture, and comprising: (i) a major amount of dry powder tripotassium citrate monohydrate (TPC); (ii) a minor amount of dry powder potassium benzoate (and optionally cupric citrate for mold control); (iii) a minor amount of water functioning as a catalyst/reactant for use with pDMI-based polymeric resin binder material; and (iv) major amount of pDMI polymeric resin binder material (in an uncured/non-reacting liquid state), blended together so that the dry power particles are well dispersed throughout the treated resin binder material, preferably in a homogeneous manner, preferably using a suitable emulsifier (e.g. triethyl citrate, waxes and other additives), whereby the polymeric resin binder material is biochemically treated prior to use during composite wood product manufacture operations, by providing fire inhibiting and corrosion inhibiting biochemicals available for protection against fire ignition, flame spread, smoke development;

FIG. 6C1 is a schematic representation illustrating the primary components of an environmentally-clean aqueous-based liquid biochemical wood treatment composition of the present invention derived from the C1-Class of saturated non-polymerized carboxylic acid called formic acid, consisting of (i) a major amount of potassium formate for producing potassium ions when dissolved in a major amount of water functioning as a solvent, carrier and dispersant to produce an environmentally-clean aqueous-based fire inhibiting liquid biochemical solution based on the C1-class of carboxylic acid-called formic acid, (ii) a minor amount of methyl formate or triethyl citrate (TEC) formulated with and a dissolved in the water (iii); a minor amount of alkali metal salt dissolved in the water and derived from benzoic acid, wherein the alkali metal is selected from group consisting of potassium, sodium, calcium and magnesium, to inhibit metal corrosion of mounted fasteners; and a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6C2 is a schematic representation illustrating the primary components of an environmentally-clean aqueous-based liquid biochemical wood treatment composition of the present invention derived from the C1-Class of saturated non-polymerized carboxylic acid called formic acid, consisting of (i) a major amount of calcium formate for producing calcium ions when dissolved in a major amount of water functioning as a solvent, carrier and dispersant to produce an environmentally-clean aqueous-based fire inhibiting liquid biochemical solution based on the C1-class of carboxylic acid-called formic acid, and (ii) a minor amount of methyl formate or triethyl citrate (TEC) formulated with and dissolved in the water; (iv) a minor amount of alkali metal salt derived from benzoic acid dissolved in the water, wherein the alkali metal is selected from group consisting of potassium, sodium, calcium and magnesium, to inhibit metal corrosion of mounted fasteners; and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6C3 is a schematic representation illustrating the primary components of an environmentally-clean aqueous-based liquid biochemical wood treatment composition of the present invention derived from the C1-Class of saturated non-polymerized carboxylic acid called formic acid, consisting of (i) a major amount of sodium formate for producing sodium ions when dissolved in a major amount of water functioning as a solvent, carrier and dispersant, (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid; (iv) a minor amount of alkali metal salt derived from benzoic acid and dissolved in the water, wherein the alkali metal is selected from group consisting of potassium, sodium, calcium and magnesium, to inhibit metal corrosion of mounted fasteners; and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6C4 is a schematic representation illustrating the primary components of an environmentally-clean aqueous-based liquid biochemical wood treatment composition of the present invention derived from the C1-Class of saturated non-polymerized carboxylic acid called formic acid, consisting of (i) major amounts of magnesium formate for producing magnesium ions when dissolved in a major amount of water functioning as a solvent, carrier and dispersant, and (ii) a minor amount of methyl formate or triethyl citrate (TEC) formulated with and dissolved in the water for dispersing magnesium ions in water, (iii) a major amount of water functioning as a solvent, carrier and dispersant to produce an environmentally-clean aqueous-based fire inhibiting liquid biochemical solution based on the C1-class of carboxylic acid-called formic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6D1 is a schematic representation illustrating the primary components of an environmentally-clean aqueous-based liquid biochemical wood treating composition of the present invention derived from the C1-Class of saturated non-polymerized carboxylic acid called carbonic acid, consisting of (i) a major amount of potassium carbonate for producing potassium ions when dissolved in a major amount of water functioning as a solvent, carrier and dispersant, (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid; a minor amount of alkali metal salt derived from benzoic acid dissolved in water, wherein the alkali metal is selected from group consisting of potassium, sodium, calcium and magnesium, to inhibit metal corrosion of mounted fasteners; and a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6D2 is a schematic representation illustrating the primary components of an environmentally-clean aqueous-based biochemical wood treatment composition of the present invention derived from the C1-Class of saturated non-polymerized carboxylic acid called carbonic acid, consisting of (i) a major amount of sodium (bi) carbonate for producing sodium ions when dissolved in a major amount of water functioning as a solvent, carrier and dispersant, (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid; a minor amount of alkali metal salt derived from benzoic acid dissolved in water, wherein the alkali metal is selected from group consisting of potassium, sodium, calcium and magnesium, to inhibit metal corrosion of mounted fasteners; and a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6E1 is a schematic representation illustrating the primary components of an environmentally-clean aqueous-based biochemical wood treatment composition of the present invention derived from the C2-Class of saturated non-polymerized carboxylic acid called acetic acid, consisting of (i) a major amount of potassium acetate for producing potassium ions when dissolved in a major amount of water functioning as a solvent, carrier and dispersant, (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid; a minor amount of alkali metal salt derived from benzoic acid dissolved in water, wherein the alkali metal is selected from group consisting of potassium, sodium, calcium and magnesium, to inhibit metal corrosion of mounted fasteners; and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6E2 is a schematic representation illustrating the primary components of an environmentally-clean aqueous-based biochemical wood treatment composition of the present invention derived from the C2-Class of saturated non-polymerized carboxylic acid called acetic acid, consisting of (i) a major amount of calcium acetate for producing calcium ions when dissolved in a major amount of water functioning as a solvent, carrier and dispersant, (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid; a minor amount of alkali metal salt derived from benzoic acid and dissolved in the water, wherein the alkali metal is selected from group consisting of potassium, sodium, calcium and magnesium, to inhibit metal corrosion of mounted fasteners; and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6E3 is a schematic representation illustrating the primary components of an environmentally-clean aqueous-based biochemical wood treatment composition of the present invention derived from the C2-Class of saturated non-polymerized carboxylic acid called acetic acid, consisting of (i) a major amount of sodium acetate, for producing sodium ions when dissolved in a major amount of water functioning as a solvent, carrier and dispersant, (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C12-class of carboxylic acid-called acetic acid; a minor amount of alkali metal salt derived from benzoic acid and dissolved in the water, wherein the alkali metal is selected from group consisting of potassium, sodium, calcium and magnesium, to inhibit metal corrosion of mounted fasteners; and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6E4 is a schematic representation illustrating the primary components of an environmentally-clean aqueous-based biochemical wood treatment composition of the present invention derived from the C2-Class of saturated non-polymerized carboxylic acid called acetic acid, consisting of (i) a major amount of magnesium acetate for producing magnesium ions when dissolved in a major amount of water functioning as a solvent, carrier and dispersant, (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners; and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6F1 is a schematic representation illustrating the primary components of an environmentally-clean aqueous-based biochemical wood treatment composition of the present invention derived from the C2-Class of saturated non-polymerized carboxylic acid called glycolic acid, consisting of (i) a major amount of potassium glycolate for producing potassium ions when dissolved in a major amount of water functioning as a solvent, carrier and dispersant (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6F2 is a schematic representation illustrating the primary components of an environmentally-clean aqueous-based biochemical wood treatment composition of the present invention derived from the C2-Class of saturated non-polymerized carboxylic acid called glycolic acid, consisting of (i) a major amount of calcium glycolate for producing calcium ions when dissolved in a major amount of water functioning as a solvent, carrier and dispersant (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6F3 is a schematic representation illustrating the primary components of an environmentally-clean aqueous-based biochemical wood treatment composition of the present invention derived from the C2-Class of saturated non-polymerized carboxylic acid called glycolic acid, consisting of (i) a major amount of sodium glycolate for producing sodium ions when dissolved in a major amount of water functioning as a solvent, carrier and dispersant, (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6G1 is a schematic representation illustrating the primary components of an environmentally-clean aqueous-based biochemical wood treatment composition of the present invention derived from the C2-Class of saturated non-polymerized carboxylic acid called glyoxylic acid, consisting of (i) a major amount of potassium glyoxylate for producing potassium ions when dissolved in a major amount of water functioning as a solvent, carrier and dispersant, (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, (v) and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6G2 is a schematic representation illustrating the primary components of an environmentally-clean aqueous-based biochemical wood treatment composition of the present invention derived from the C2-Class of saturated non-polymerized carboxylic acid called glyoxylic acid, consisting of (i) a major amount of calcium glyoxylate for producing calcium ions when dissolved in a major amount of water functioning as a solvent, carrier and dispersant, (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6G3 is a schematic representation illustrating the primary components of an environmentally-clean aqueous-based biochemical wood treatment composition of the present invention derived from the C2-Class of saturated non-polymerized carboxylic acid called glyoxylic acid, consisting of (i) a major amount of sodium glyoxylate for producing sodium ions when dissolved in a major amount of water functioning as a solvent, carrier and dispersant, (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6H1 is a schematic representation illustrating the primary components of an environmentally-clean aqueous-based biochemical wood treatment composition of the present invention derived from the C2-Class of saturated non-polymerized carboxylic acid called oxalic acid, consisting of (i) a major amount of potassium oxalate for producing potassium ions when dissolved in a major amount of water functioning as a solvent, carrier and dispersant, (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6H2 is a schematic representation illustrating the primary components of an environmentally-clean aqueous-based biochemical wood treatment composition of the present invention derived from the C2-Class of saturated non-polymerized carboxylic acid called oxalic acid, consisting of (i) a major amount of calcium oxalate for producing calcium ions when dissolved in a major amount of water functioning as a solvent, carrier and dispersant, (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6H3 is a schematic representation illustrating the primary components of an environmentally-clean aqueous-based biochemical wood treatment composition of the present invention derived from the C2-Class of saturated non-polymerized carboxylic acid called oxalic acid, consisting of (i) a major amount of sodium oxalate for producing sodium ions when dissolved in a major amount of water functioning as a solvent, carrier and dispersant, (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water, and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6I1 is a schematic representation illustrating the primary components of an environmentally-clean aqueous-based biochemical wood treatment composition of the present invention derived from the C3-Class of saturated non-polymerized carboxylic acid called propionic acid, consisting of (i) a major amount of potassium propionate for producing potassium ions when dissolved in a major amount of water functioning as a solvent, carrier and dispersant, (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid; a minor amount of alkali metal salt derived from benzoic acid and dissolved in the water, wherein the alkali metal is selected from group consisting of potassium, sodium, calcium and magnesium, to inhibit metal corrosion of mounted fasteners, (iv) and a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 612 is a schematic representation illustrating the primary components of an environmentally-clean aqueous-based biochemical wood treatment composition of the present invention derived from the C3-Class of saturated non-polymerized carboxylic acid called propionic acid, consisting of (i) a major amount of calcium propionate for producing calcium ions when dissolved in a major amount of water functioning as a solvent, carrier and dispersant, (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water, and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 613 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of sodium propionate for producing sodium ions when dissolved in a major amount of water functioning as a solvent, carrier and dispersant, (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-called propionic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6I4 is a schematic representation illustrating the primary components of an environmentally-clean aqueous-based biochemical wood treatment composition of the present invention derived from the C3-Class of saturated non-polymerized carboxylic acid called propionic acid, consisting of (i) a major amount of magnesium propionate for producing magnesium ions when dissolved in a major amount of water functioning as a solvent, carrier and dispersant, (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6J1 is a schematic representation illustrating the primary components of an environmentally-clean aqueous-based biochemical wood treatment composition of the present invention derived from the C3-Class of saturated non-polymerized carboxylic acid called lactic acid, consisting of (i) a major amount of potassium lactate for producing potassium ions when dissolved in a major amount of water functioning as a solvent, carrier and dispersant, (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water, and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6J2 is a schematic representation illustrating the primary components of an environmentally-clean aqueous-based biochemical wood treatment composition of the present invention derived from the C3-Class of saturated non-polymerized carboxylic acid called lactic acid, consisting of (i) a major amount of calcium lactate for producing calcium ions when dissolved in a major amount of water functioning as a solvent, carrier and dispersant, (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6J3 is a schematic representation illustrating the primary components of an environmentally-clean aqueous-based biochemical wood treatment composition of the present invention derived from the C3-Class of saturated non-polymerized carboxylic acid called lactic acid, consisting of (i) a major amount of sodium lactate for producing sodium ions when dissolved in a major amount of water functioning as a solvent, carrier and dispersant, (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6J4 is a schematic representation illustrating the primary components of an environmentally-clean aqueous-based biochemical wood treatment composition of the present invention derived from the C3-Class of saturated non-polymerized carboxylic acid called lactic acid, consisting of (i) a major amount of magnesium lactate for producing magnesium ions when dissolved in a major amount of water functioning as a solvent, carrier and dispersant, (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, (iv) a minor amount of alkali metal salt dissolved in the water and derived from benzoic acid, wherein the alkali metal is selected from group consisting of potassium, sodium, calcium and magnesium, to inhibit metal corrosion of mounted fasteners, and (v) a minor amount of alkali metal salt and dissolved and the water, and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6K1 is a schematic representation illustrating the primary components of an environmentally-clean aqueous-based biochemical wood treatment composition of the present invention derived from the C3-Class of saturated non-polymerized carboxylic acid called glyceric acid, consisting of (i) a major amount of potassium glycerate for producing potassium ions when dissolved in a major amount of water functioning as a solvent, carrier and dispersant, (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6K2 is a schematic representation illustrating the primary components of an environmentally-clean aqueous-based biochemical wood treatment composition of the present invention derived from the C3-Class of saturated non-polymerized carboxylic acid called glyceric acid, consisting of (i) a major amount of calcium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6K3 is a schematic representation illustrating the primary components of an environmentally-clean aqueous-based biochemical wood treatment composition of the present invention derived from the C3-Class of saturated non-polymerized carboxylic acid called glyceric acid, consisting of (i) a major amount of sodium glycerate for producing sodium ions when dissolved in a major amount of water functioning as a solvent, carrier and dispersant, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6L1 is a schematic representation illustrating the primary components of an environmentally-clean aqueous-based biochemical wood treatment composition of the present invention derived from the C3-Class of saturated non-polymerized carboxylic acid called pyruvic acid, consisting of (i) a major amount of potassium pyruvate for producing potassium ions when dissolved in a major amount of water functioning as a solvent, carrier and dispersant, (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid; a minor amount of alkali metal salt derived from benzoic acid, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6L2 is a schematic representation illustrating the primary components of an environmentally-clean aqueous-based biochemical wood treatment composition of the present invention derived from the C3-Class of saturated non-polymerized carboxylic acid called pyruvic acid, consisting of (i) a major amount of calcium pyruvate for producing calcium ions when dissolved in a major amount of water functioning as a solvent, carrier and dispersant, (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6L3 is a schematic representation illustrating the primary components of an environmentally-clean aqueous-based biochemical wood treatment composition of the present invention derived from the C3-Class of saturated non-polymerized carboxylic acid called pyruvic acid, consisting of (i) a major amount of sodium pyruvate for producing sodium ions when dissolved in a major amount of water functioning as a solvent, carrier and dispersant, (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6L4 is a schematic representation illustrating the primary components of an environmentally-clean aqueous-based biochemical wood treatment composition of the present invention derived from the C3-Class of saturated non-polymerized carboxylic acid called pyruvic acid, consisting of (i) a major amount of magnesium pyruvate for producing magnesium ions when dissolved in a major amount of water functioning as a solvent, carrier and dispersant, (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6M1 is a schematic representation illustrating the primary components of an environmentally-clean aqueous-based biochemical wood treatment composition of the present invention derived from the C3-Class of saturated non-polymerized carboxylic acid called tartaric acid, consisting of (i) a major amount of potassium tartrate for producing potassium ions when dissolved in a major amount of water functioning as a solvent, carrier and dispersant, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6M2 is a schematic representation illustrating the primary components of an environmentally-clean aqueous-based biochemical wood treatment composition of the present invention derived from the C3-Class of saturated non-polymerized carboxylic acid called tartaric acid, consisting of (i) a major amount of calcium tartrate for producing calcium ions when dissolved in a major amount of water functioning as a solvent, carrier and dispersant, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6M3 is a schematic representation illustrating the primary components of an environmentally-clean aqueous-based biochemical wood treatment composition of the present invention derived from the C3-Class of saturated non-polymerized carboxylic acid called tartaric acid, consisting of (i) a major amount of sodium tartrate for producing sodium ions when dissolved in a major amount of water functioning as a solvent, carrier and dispersant, (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6M4 is a schematic representation illustrating the primary components of an environmentally-clean aqueous-based biochemical wood treatment composition of the present invention derived from the C3-Class of saturated non-polymerized carboxylic acid called tartaric acid, consisting of (i) a major amount of magnesium tartrate for producing magnesium ions when dissolved in a major amount of water functioning as a solvent, carrier and dispersant, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid; a minor amount of alkali metal salt derived from benzoic acid and dissolved in the water, wherein the alkali metal is selected from group consisting of potassium, sodium, calcium and magnesium, to inhibit metal corrosion of mounted fasteners, (iv) and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6N1 is a schematic representation illustrating the primary components of an environmentally-clean aqueous-based biochemical wood treatment composition of the present invention derived from the C4-Class of saturated non-polymerized carboxylic acid called butyric acid, consisting of (i) a major amount of potassium butyrate for producing potassium ions when dissolved in a major amount of water functioning as a solvent, carrier and dispersant, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6N2 is a schematic representation illustrating the primary components of an environmentally-clean aqueous-based biochemical wood treatment composition of the present invention derived from the C4-Class of saturated non-polymerized carboxylic acid called butyric acid, consisting of (i) a major amount of calcium butyrate for producing calcium ions when dissolved in a major amount of water functioning as a solvent, carrier and dispersant, (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6N3 is a schematic representation illustrating the primary components of an environmentally-clean aqueous-based biochemical wood treatment composition of the present invention derived from the C4-Class of saturated non-polymerized carboxylic acid called butyric acid, consisting of (i) a major amount of sodium butyrate for producing sodium ions when dissolved in a major amount of water functioning as a solvent, carrier and dispersant, (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6N4 is a schematic representation illustrating the primary components of an environmentally-clean aqueous-based biochemical wood treatment composition of the present invention derived from the C4-Class of saturated non-polymerized carboxylic acid called butyric acid, consisting of (i) a major amount of magnesium butyrate for producing magnesium ions when dissolved in a major amount of water functioning as a solvent, carrier and dispersant, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 601 is a schematic representation illustrating the primary components of an environmentally-clean aqueous-based biochemical wood treatment composition of the present invention derived from the C4-Class of saturated non-polymerized carboxylic acid called malic acid, consisting of (i) a major amount of potassium maleate for producing potassium ions when dissolved in a major amount of water functioning as a solvent, carrier and dispersant, (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, (iv) a minor amount of alkali metal salt dissolved in the water and derived from benzoic acid, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 602 is a schematic representation illustrating the primary components of an environmentally-clean aqueous-based biochemical wood treatment composition of the present invention derived from the C4-Class of saturated non-polymerized carboxylic acid called malic acid, consisting of (i) a major amount of calcium maleate for producing calcium ions when dissolved in a major amount of water functioning as a solvent, carrier and dispersant, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 603 is a schematic representation illustrating the primary components of an environmentally-clean aqueous-based biochemical wood treatment composition of the present invention derived from the C4-Class of saturated non-polymerized carboxylic acid called malic acid, consisting of (i) a major amount of sodium maleate for producing sodium ions when dissolved in a major amount of water functioning as a solvent, carrier and dispersant, (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 604 is a schematic representation illustrating the primary components of an environmentally-clean aqueous-based biochemical wood treatment composition of the present invention derived from the C4-Class of saturated non-polymerized carboxylic acid called malic acid, consisting of (i) a major amount of magnesium maleate for producing magnesium ions when dissolved in a major amount of water functioning as a solvent, carrier and dispersant, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6P1 is a schematic representation illustrating the primary components of an environmentally-clean aqueous-based biochemical wood treatment composition of the present invention derived from the C4-Class of saturated non-polymerized carboxylic acid called malonic acid, consisting of (i) a major amount of potassium malonate for producing potassium ions when dissolved in a major amount of water functioning as a solvent, carrier and dispersant, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6P2 is a schematic representation illustrating the primary components of an environmentally-clean aqueous-based biochemical wood treatment composition of the present invention derived from the C4-Class of saturated non-polymerized carboxylic acid called malonic acid, consisting of (i) a major amount of calcium malonate for producing calcium ions when dissolved in a major amount of water functioning as a solvent, carrier and dispersant, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6P3 is a schematic representation illustrating the primary components of an environmentally-clean aqueous-based biochemical wood treatment composition of the present invention derived from the C4-Class of saturated non-polymerized carboxylic acid called malonic acid, consisting of (i) a major amount of sodium malonate for producing sodium ions when dissolved in a major amount of water functioning as a solvent, carrier and dispersant, (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6P4 is a schematic representation illustrating the primary components of an environmentally-clean aqueous-based biochemical wood treatment composition of the present invention derived from the C4-Class of saturated non-polymerized carboxylic acid called malonic acid, consisting of (i) a major amount of magnesium malonate for producing magnesium ions when dissolved in a major amount of water functioning as a solvent, carrier and dispersant, (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, (iv) a minor amount of alkali metal salt derived from benzoic acid and dissolved in the water and dissolved in the water, wherein the alkali metal is selected from group consisting of potassium, sodium, calcium and magnesium, to inhibit metal corrosion of mounted fasteners, (v) and a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6Q1 is a schematic representation illustrating the primary components of an environmentally-clean aqueous-based biochemical wood treatment composition of the present invention derived from the C5-Class of saturated non-polymerized carboxylic acid called pivalic acid, consisting of (i) a major amount of potassium pivalate for producing potassium ions when dissolved in a major amount of water functioning as a solvent, carrier and dispersant, (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6Q2 is a schematic representation illustrating the primary components of an environmentally-clean aqueous-based biochemical wood treatment composition of the present invention derived from the C5-Class of saturated non-polymerized carboxylic acid called pivalic acid, consisting of (i) a major amount of calcium pivalate for producing calcium ions when dissolved in a major amount of water functioning as a solvent, carrier and dispersant, (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6Q3 is a schematic representation illustrating the primary components of an environmentally-clean aqueous-based biochemical wood treatment composition of the present invention derived from the C5-Class of saturated non-polymerized carboxylic acid called pivalic acid, consisting of (i) a major amount of sodium pivalate for producing sodium ions when dissolved in a major amount of water functioning as a solvent, carrier and dispersant, (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6Q4 is a schematic representation illustrating the primary components of an environmentally-clean aqueous-based biochemical wood treatment composition of the present invention derived from the C5-Class of saturated non-polymerized carboxylic acid called pivalic acid, consisting of (i) a major amount of magnesium pivalate for producing magnesium ions when dissolved in a major amount of water functioning as a solvent, carrier and dispersant, (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6R1 is a schematic representation illustrating the primary components of an environmentally-clean aqueous-based biochemical wood treatment composition of the present invention derived from the C6-Class of saturated non-polymerized carboxylic acid called caproic acid, consisting of (i) a major amount of potassium caproate for producing potassium ions when dissolved in a major amount of water functioning as a solvent, carrier and dispersant, (ii) a minor amount of ethyl caproate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called caproic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt and dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6R2 is a schematic representation illustrating the primary components of an environmentally-clean aqueous-based biochemical wood treatment composition of the present invention derived from the C6-Class of saturated non-polymerized carboxylic acid called caproic acid, consisting of (i) a major amount of calcium caproate for producing calcium ions when dissolved in a major amount of water functioning as a solvent, carrier and dispersant, (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6R3 is a schematic representation illustrating the primary components of an environmentally-clean aqueous-based biochemical composition of the present invention derived from the C6-Class of saturated non-polymerized carboxylic acid called caproic acid, consisting of (i) a major amount of sodium caproate for producing sodium ions when dissolved in a major amount of water functioning as a solvent, carrier and dispersant, (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, (iv) a minor amount of alkali metal salt derived from benzoic acid, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6R4 is a schematic representation illustrating the primary components of an environmentally-clean aqueous-based biochemical wood treatment composition of the present invention derived from the C6-Class of saturated non-polymerized carboxylic acid called caproic acid, consisting of (i) a major amount of magnesium caproate for producing magnesium ions when dissolved in a major amount of water functioning as a solvent, carrier and dispersant, (ii) a minor amount of ethyl caproate or triethyl citrate (TEC) formulated with and dissolved in (iii) a major amount of water functioning as a solvent, carrier and dispersant to produce an environmentally-clean aqueous-based wood treatment biochemical solution based on the C6-class of carboxylic acid-called caproic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6S1 is a schematic representation illustrating the primary components of an environmentally-clean aqueous-based biochemical composition of the present invention derived from the C6-Class of saturated non-polymerized carboxylic acid called adipic acid, consisting of (i) a major amount of potassium adipic for producing potassium ions when dissolved in a major amount of water functioning as a solvent, carrier and dispersant, (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6S2 is a schematic representation illustrating the primary components of an environmentally-clean aqueous-based biochemical composition of the present invention derived from the C6-Class of saturated non-polymerized carboxylic acid called adipic acid, consisting of (i) a major amount of calcium adipic for producing calcium ions when dissolved in a major amount of water functioning as a solvent, carrier and dispersant, (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6S3 is a schematic representation illustrating the primary components of an environmentally-clean aqueous-based biochemical wood treatment composition of the present invention derived from the C6-Class of saturated non-polymerized carboxylic acid called adipic acid, consisting of (i) a major amount of sodium adipic for producing sodium ions when dissolved in a major amount of water functioning as a solvent, carrier and dispersant, (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6S4 is a schematic representation illustrating the primary components of an environmentally-clean aqueous-based biochemical wood treatment composition of the present invention derived from the C6-Class of saturated non-polymerized carboxylic acid called adipic acid, consisting of (i) a major amount of magnesium adipic for producing magnesium ions when dissolved in a major amount of water functioning as a solvent, carrier and dispersant, (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6T1 is a schematic representation illustrating the primary components of an environmentally-clean aqueous-based biochemical composition of the present invention derived from the C6-Class of saturated non-polymerized carboxylic acid called citric acid, consisting of (i) a major amount of (tri) potassium citrate for producing potassium ions when dissolved in a major amount of water functioning as a solvent, carrier and dispersant, (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water, and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6T2 is a schematic representation illustrating the primary components of an environmentally-clean aqueous-based biochemical wood treatment composition of the present invention derived from the C6-Class of saturated non-polymerized carboxylic acid called citric acid, consisting of (i) a major amount of calcium citrate for producing calcium ions when dissolved in a major amount of water functioning as a solvent, carrier and dispersant, (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6T3 is a schematic representation illustrating the primary components of an environmentally-clean aqueous-based biochemical wood treatment composition of the present invention derived from the C6-Class of saturated non-polymerized carboxylic acid called citric acid, consisting of (i) a major amount of sodium citrate for producing sodium ions when dissolved in a major amount of water functioning as a solvent, carrier and dispersant, (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6T4 is a schematic representation illustrating the primary components of an environmentally-clean aqueous-based biochemical wood treatment composition of the present invention derived from the C6-Class of saturated non-polymerized carboxylic acid called citric acid, consisting of (i) a major amount of magnesium citrate for producing magnesium ions when dissolved in a major amount of water functioning as a solvent, carrier and dispersant, (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6U1 is a schematic representation illustrating the primary components of an environmentally-clean aqueous-based biochemical wood treatment composition of the present invention derived from the C6-Class of saturated non-polymerized carboxylic acid called d-gluconic acid, consisting of (i) a major amount of potassium gluconate for producing potassium ions when dissolved in a major amount of water functioning as a solvent, carrier and dispersant, (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6U2 is a schematic representation illustrating the primary components of an environmentally-clean aqueous-based biochemical wood treatment composition of the present invention derived from the C6-Class of saturated non-polymerized carboxylic acid called d-gluconic acid, consisting of (i) a major amount of calcium gluconate for producing calcium ions when dissolved in a major amount of water functioning as a solvent, carrier and dispersant, (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6U3 is a schematic representation illustrating the primary components of an environmentally-clean aqueous-based biochemical wood treatment composition of the present invention derived from the C6-Class of saturated non-polymerized carboxylic acid called d-gluconic acid, consisting of (i) a major amount of sodium gluconate for producing sodium ions when dissolved in a major amount of water functioning as a solvent, carrier and dispersant, (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6U4 is a schematic representation illustrating the primary components of an environmentally-clean aqueous-based biochemical composition of the present invention derived from the C6-Class of saturated non-polymerized carboxylic acid called d-gluconic acid, consisting of (i) a major amount of magnesium gluconate for producing magnesium ions when dissolved in a major amount of water functioning as a solvent, carrier and dispersant, (ii) a minor amount methyl gluconate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called d-gluconic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6V1 is a schematic representation illustrating the primary components of an environmentally-clean aqueous-based biochemical wood treatment composition of the present invention derived from the C6-Class of saturated non-polymerized carboxylic acid called benzoic acid, consisting of (i) a major amount of potassium benzoate for producing potassium ions when dissolved in a major amount of water functioning as a solvent, carrier and dispersant, (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6V2 is a schematic representation illustrating the primary components of an environmentally-clean aqueous-based biochemical wood treatment composition of the present invention derived from the C6-Class of saturated non-polymerized carboxylic acid called benzoic acid, consisting of (i) a major amount of calcium benzoate for producing calcium ions when dissolved in a major amount of water functioning as a solvent, carrier and dispersant, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6V3 is a schematic representation illustrating the primary components of an environmentally-clean aqueous-based biochemical wood treatment composition of the present invention derived from the C6-Class of saturated non-polymerized carboxylic acid called benzoic acid, consisting of (i) a major amount of sodium benzoate for producing sodium ions when dissolved in a major amount of water functioning as a solvent, carrier and dispersant, (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 6V4 is a schematic representation illustrating the primary components of an environmentally-clean aqueous-based biochemical wood treatment composition of the present invention derived from the C6-Class of saturated non-polymerized carboxylic acid called benzoic acid, consisting of (i) a major amount of magnesium benzoate for producing magnesium ions when dissolved in a major amount of water functioning as a solvent, carrier and dispersant, (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, (iv) a minor amount of alkali metal salt derived from benzoic acid and dissolved in the water, wherein the alkali metal is selected from group consisting of potassium, sodium, calcium and magnesium, to inhibit metal corrosion of mounted fasteners, and (v) a minor amount of alkali metal salt dissolved in the water and derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material;

FIG. 7A is a schematic representation of the fire inhibiting pMDI-type resin binder blends of the present invention formulated for use in producing different types of composite wood products of the present invention;

FIG. 7B is a schematic representation of the molecular structure, molecular formulas and constants of pMDI-type polymeric resin binder blends that are formulated and biochemically-treated using the biochemical compositions of the present invention, so as to produce biochemically-treated (fire-inhibiting) polymeric resin binders and adhesives that are suitably adapted for use when producing different types of biochemically-treated fire-inhibiting composite wood products according to the present invention;

FIG. 7C is a table listing different kinds of fire-inhibiting pMDI-type polymeric resin binders biochemically-treated according to the principles of the present invention, namely standard polymeric resin, fast cure MDI resin, enhanced fast cure MDI resin and emulsifiable fast cure resin, for use in producing different types of fire-protected composite wood products according to the present invention, namely (i) oriented strand board (OSB), and (ii) medium density fiberboard (MDF);

FIG. 7D is a table listing different kinds of fire-inhibiting pMDI-type resin binders biochemically-treated according to the principles of the present invention, namely standard polymeric resin, fast cure MDI resin, enhanced fast cure MDI resin and emulsifiable fast cure resin, for use in producing different types of fire-protected composite wood products according to the present invention, namely (iii) particleboard (PB), and (iv) wood fiber insulation fiberboard (WFI);

FIG. 8A is a flow chart describing the primary steps involved in the practice of a first (surface-treatment) method of producing treated wood products with fire, metal-corrosion, mold and moisture protection according to the present invention, comprising the steps of (a) producing or procuring a supply of environmentally clean wood treatment composition for use in treating wood (i.e. lignocellulosic) material in treated wood products to provide fire, metal-corrosion, mold and moisture protection, wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical wood treatment composition over the exterior surfaces of the wood products to be treated with Class-A fire and metal-corrosion protection, (c) allowing water molecules in the applied environmentally-clean biochemical wood treatment composition to evaporate to the environment and class-a fire and metal-corrosion inhibiting coatings to form over the treated wood surfaces, and (d) applying a polymeric-based mold inhibiting and moisture protecting coating(s) over the Class-A fire-protected, metal-corrosion and mold/mildew inhibiting wood surfaces of the treated wood products;

FIG. 8B is a flow chart describing the primary steps involved in the practice of a second method of producing composite wood products with fire, metal-corrosion, mold and moisture protection according to the present invention, comprising the steps of (a) producing or procuring a supply of environmentally-clean biochemical wood treatment composition for use in treating wood (i.e. lignocellulosic) furnish material to produce composite wood products having fire, metal-corrosion, mold and moisture protection, wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical wood treatment composition to wood furnish material prior to or during the manufacturing of composite wood components so that fire, metal-corrosion and mold protection is provided within and over the exterior surfaces of the wood furnish material during manufacture, (c) adding biochemical additives, also selected from the group consisting of metal alkali carboxylic acid salt based biochemicals, to a polymeric resin compound so as to produce an enhanced polymeric resin, then applying the same to wood furnish material, and molding a composite wood product under pressure and curing the polymeric resin during molding and compression operations so as to provide the molded composite wood product with fire, metal-corrosion & mold protection throughout composite wood products, and (d) applying a polymeric-based (mold inhibiting and) moisture protective coating over the exterior wood surfaces of the Class-A fire protected wood products;

FIG. 8C is a flow chart describing the primary steps involved in the practice of a third method of producing treated engineered wood products (EWPs) with fire, metal-corrosion, mold and moisture protection according to the present invention, comprising the steps of (a) producing or procuring a supply of environmentally-clean liquid biochemical wood treatment solution for use in treating wood furnish used in engineered wood products (EWPs), wherein the environmentally-clean liquid wood treatment composition comprises environmentally-clean fire inhibiting biochemicals selected from the group consisting of metal alkali carboxylic acid salt based biochemicals, (b) applying the environmentally-clean biochemical liquid wood treatment solution to (i.e. wood/lignocellulosic) material prior to or during the manufacturing of the engineered wood product to produce treated wood furnish material that is protected against fire, metal corrosion and mold/mildew, (c) during manufacture of the EWP, binding the treated wood material using a polymeric resin compound infused with fire and metal-corrosion inhibiting biochemicals for producing an engineered wood product (EWP) provided with fire protection, metal-corrosion and mold/mildew protection throughout the corpus of the EWP, and (d) applying a polymeric-based (mold-inhibiting and) moisture-protecting coating over the treated wood surfaces of the fire protected EWP;

FIG. 9 is a perspective view of a bundle of fire-protected finger-jointed lumber products produced along the production line in an automated fire-treated lumber factory using the methods of and environmentally-clean wood treatment compositions of the present invention;

FIG. 10 is a perspective view of an automated lumber factory supporting an automated process for continuously fabricating Class-A fire-protected finger-jointed lumber products which, after the planning and dimensioning stage, are automatically treated by coating the products in a bath or reservoir of environmentally-clean fire inhibiting biochemical liquid of the present invention, and then automatically packaged, stack-dried and wrapped in a high-speed and economical manner;

FIG. 10A is a perspective view of the high-speed CFIC dip-coating stage depicted in FIG. 10, showing the various components used to implement this subsystem along the production line of the automated lumber factory;

FIGS. 11A and 11B, taken together, set forth a flow chart describing the high-level steps carried out when practicing the method of producing Class-A fire-protected finger-jointed lumber pieces (e.g. studs or beams) in the automated fire-treated lumber factory shown in FIGS. 10 and 10A;

FIG. 12 is a perspective view of a Class-A fire-protected cross-laminated-timber (CLT) product (e.g. panel, stud, beam, etc.) fabricated along the production line of the automated lumber fabrication factory of FIG. 13;

FIG. 13 is a perspective view of an automated lumber fabrication factory supporting an automated process for continuously fabricating cross-laminated timber (CLT) products which, after the planning and dimensioning stage, are automatically dip-coated in a bath of clean fire inhibiting chemical (CFIC) liquid, and then stacked, packaged, and wrapped in a high-speed manner to produce Class-A fire-protected CLT products;

FIG. 13A is a perspective view of the automatic cross-laminated timber (CLT) dip-coating stage deployed along the production line of the automated lumber fabrication factory shown in FIG. 13;

FIG. 13B is a perspective view of the automatic spray coating and drying tunnel stage deployed along the production line of the automated lumber fabrication factory shown in FIG. 13;

FIGS. 14A and 14B, taken together, set forth a flow chart describing the high-level steps carried out when practicing the method of producing Class-A fire-protected cross-laminated timber (CLT) products in the automated fire-treated lumber factory illustrated in FIGS. 13 and 13A;

FIG. 15 is a perspective view of a fire-protected laminated veneer lumber (LVL) product produced using the environmentally-clean biochemicals and methods of the present invention;

FIG. 16 is a schematic representation of the automated factory configured for producing Class-A fire-protected laminated veneer lumber (LVL) products in accordance with the principles of the present invention;

FIG. 16A is a perspective view of the automatic biochemical treatment stage deployed along the production line of the automated LVL product factory shown in FIGS. 14A and 15;

FIG. 16B is a perspective view of the automatic biochemical spray coating and drying stage deployed along the production line of the automated LVL product factory shown in FIGS. 16A and 16A;

FIGS. 17A, 17B and 17C, taken together, set forth a flow chart describing the high-level steps carried out when practicing the method of producing Class-A fire-protected laminated veneer lumber (VLV) products in the automated fire-treated lumber factory illustrated in FIGS. 16, 16A and 16B;

FIG. 18 is a perspective of a cut-away portion of a piece of Class-A fire-protected oriented strand board (OSB) sheathing/panel produced using the method and process described in FIGS. 19A, 19B and 20 supported by the automated factory shown in FIG. 18;

FIG. 18A is a cross-sectional schematic diagram of a section of the Class-A fire-protected OSB sheathing shown in FIG. 18;

FIG. 18B is a cut-away perspective view of the Class-A fire-protected OSB sheathing shown in FIG. 18 showing the biochemically-treated wood furnish material uniformly distributed and embodied with and binded together within a matrix-like or network-like arrangement of cured biochemically-treated polymer resin binder material in accordance with the principles of the present invention, so that alkali metal (i.e. potassium) ions or micro-particles are freely available throughout the entire composite wood product so as to inhibit fire ignition, flame spread, smoke development, as well as optionally, inhibit mold, mildew, microbial life and/or moisture;

FIG. 18C is a cross-sectional view of the fire-protected OSB sheathing taken along the line 18C-18C in FIG. 18B, showing the biochemically-treated wood furnish material uniformly distributed and embodied with and binded together within a matrix-like or network-like arrangement of cured biochemically-treated polymer resin binder material in accordance with the principles of the present invention, so that alkali metal (i.e. potassium) ions or micro-particles, associated with the fire inhibiting biochemical treatment compositions of the present invention 93 (shown in FIGS. 6-6V4), are freely available throughout the entire composite wood product so as to inhibit fire ignition, flame spread, smoke development, as well as optionally, inhibit mold, mildew, microbial life and/or moisture;

FIG. 19 is a schematic representation for an overview of a process for producing Class-A fire protected OSB panels according to the principles of manufacture according to the present invention;

FIG. 20 is a schematic illustration of the automated factory, as generally depicted in FIG. 20, and configured for producing Class-A fire-protected OSB sheathing in accordance with the principles of the present invention as described herein;

FIG. 21 is a schematic representation of the automated OSB panel fabrication factory shown in FIG. 20, wherein each of the stages of manufacture are graphically depicted to illustrate the functions performed along the multi-stage fabrication process of the present invention, including the treatment of wood furnish materials (e.g. wood strands) and resin adhesives (e.g. pDMI resin binders) used during the manufacturing process;

FIG. 22 is a schematic illustration providing a view of the drum-type drying stage (i.e. dryer) employed in the OSB panel production line of the present invention shown in FIGS. 20 and 21, wherein wood furnish is being fed into the input handler of the dry screen drying stage, flows through the drum structure to the outfeed port, while water is evaporated from the wood furnish material flowing the through the barrel structure, under computer sensing and control system, so as to produce wood furnish having a specified water/moisture content required for the application at hand;

FIG. 23A is a schematic illustration providing a first view of the drum-based wood strand spray treatment stage employed in the OSB panel production line of the present invention shown in FIGS. 20 and 21, wherein wood furnish is being fed into the input handler of the strand spraying drum stage and being sprayed with environmentally-clean biochemicals using atomizing spray nozzles arranged therein, as the wood furnish materials therethrough under control system control;

FIG. 23B is a schematic illustration providing a second view of the drum-based wood strand spray treatment stage employed in the OSB panel production line of the present invention shown in FIGS. 20 and 21, wherein wood furnish is being fed into the input handler of the strand spraying drum stage and being sprayed with environmentally-clean biochemicals using atomizing spray nozzles arranged therein, as the wood furnish materials therethrough under control system control;

FIG. 24 is a schematic illustration providing a first view of the resin and biochemical mixer/blender (i.e. resonator) stage employed in the OSB panel production line of the present invention shown in FIGS. 20 and 21, wherein precisely metered amounts of liquid pMDI resin and environmentally-clean biochemicals (including liquified waxes) are fed into the mixer/blender to produce a resin/additive emulsion that is sprayed over wood furnish materials flowing through the treatment drum using spray atomizing nozzles under precise temperature control so as to uniformly cover the surfaces of the wood furnish material (i.e. strands) so the biochemicals can infuse into and biochemically treat the biochemical structures within each strand to impart specified properties and characteristics thereto (i.e. inhibition to/protection against fire, mold, mildew an moisture);

FIG. 25. is a schematic illustration providing a view of the precision release agent and surface moisture spraying system/stage employed in the OSB panel production line of the present invention shown in FIGS. 20 and 21, wherein precisely metered amounts of release agent and water are sprayed onto the layered mat of wood furnish material prior to compression and curing in the forming stage of the system;

FIGS. 26A and 26B, taken together, set forth a flow chart describing the high-level steps carried out when practicing the method of producing clean Class-A fire-protected OSB sheathing in accordance with the present invention, as illustrated in FIGS. 20, 20A and 20B through 25;

FIG. 27 is a perspective view of a stack of Class-A fire protected wood fiber insulation (WFI) board produced using the automated factory schematically represented in FIG. 28;

FIG. 28 is a schematic illustration of the automated factory, as generally depicted, and configured for producing Class-A fire-protected wood fiber insulation (WFI) panels in accordance with the principles of the present invention as described herein;

FIG. 29 is a schematic representation of the automated WFI panel fabrication factory shown in FIG. 28, wherein each of the stages of manufacture are graphically depicted to illustrate the functions performed along the multi-stage fabrication process of the present invention, including the treatment of wood furnish materials (e.g. wood strands) and resin adhesives (e.g. pDMI resin binders) used during the manufacturing process;

FIG. 30 is a schematic illustration providing a first view of the resin and biochemical mixer/blender stage employed in the WFI panel production line of the present invention shown in FIGS. 27 and 28, wherein pMDI resin and biochemical additive composition of the present invention are mixed and blended together into a homogeneous emulsion for atomization spraying and coating wood furnish material (i.e. wood particles) flowing through the resinator stage of the system;

FIG. 31 is a schematic illustration providing a second view of the resin and biochemical mixer/blender stage employed in the WFI panel production line of the present invention shown in FIGS. 27 and 28, wherein the homogeneous emulsion is supplied to an turbo-flow-based glue resinating engine, within which wood fiber particle flowing thereinto are ground into fine particles that form a pair of wood particle streams that flow through the engine while the surfaces thereof are being spray atomized and coated with biochemically-treated wood resin emulsion, and then the resin-coated wood particles flow through the turboflow resinator stage of the system towards the panel formation stage of the system;

FIG. 31A is a schematic illustration providing a first detailed view of the turbo-flow-based glue resinating engine employed in the resin and biochemical mixer/blender stage employed in the WFI panel production line of the present invention shown in FIG. 30, wherein the homogeneous biochemically-treated resin emulsion is spray atomized over the surface of the wood particle flow streams passing through the engine;

FIG. 31B is a schematic illustration providing a second detailed view of the turbo-flow-based glue resinating engine employed in the resin and biochemical mixer/blender stage employed in the WFI panel production line of the present invention shown in FIG. 30, wherein the homogeneous biochemically-treated resin emulsion is spray atomized over the surface of the wood particle flow streams passing through the engine;

FIGS. 32A and 32B, taken together, set forth a flow chart describing the high-level steps carried out when practicing the method of producing clean Class-A fire-protected WFI sheathing in accordance with the present invention, as illustrated in FIGS. 30, 31A and 31B;

FIG. 33 is a perspective view of a stack of Class-A fire protected medium density fiber (MDF)/high density fiber (HDF) panels produced using the automated factory schematically represented in FIG. 34;

FIG. 34 is a schematic illustration of the automated factory, as generally depicted, and configured for producing Class-A fire-protected MDF/HDF panels in accordance with the principles of the present invention as described herein;

FIG. 35 is a schematic representation of the automated MDF/HDF panel fabrication factory shown in FIG. 34, wherein each of the stages of manufacture are graphically depicted to illustrate the functions performed along the multi-stage fabrication process of the present invention, including the treatment of wood furnish materials (e.g. wood particles) and resin adhesives (e.g. pDMI resin binders) used during the manufacturing process;

FIG. 36A shows a first view of the dry screen drying stage employed in the MDF panel production line of the present invention shown in FIGS. 34 and 35 wherein hot air is input into the drying stage along with infed wood furnish materials so to evaporate moisture therefrom as the wood furnish exits the dry screen drying stage of the system;

FIG. 36B shows a second view of the dry screen drying stage employed in the MDF panel production line of the present invention shown in FIGS. 34 and 35, wherein hot air is input into the drying stage along with infed wood furnish materials so to evaporate moisture therefrom as the wood furnish exits the dry screen drying stage of the system;

FIG. 36C shows a third view of the dry screen drying stage employed in the MDF panel production line of the present invention shown in FIGS. 34 and 35, wherein hot air is input into the drying stage along with infed wood furnish materials so to evaporate moisture therefrom as the wood furnish exits the dry screen drying stage of the system;

FIG. 36D shows a fourth view of the dry screen drying stage employed in the MDF panel production line of the present invention shown in FIGS. 34 and 35, wherein hot air is input into the drying stage along with infed wood furnish materials so to flow over wood furnish material (e.g. strands, particles, etc.) being conveyed along a moving screen (i.e. belt) and allowing moisture to evaporate therefrom as the wood furnish exits the dry screen drying stage of the system;

FIG. 36E shows a fifth view of the dry screen drying stage employed in the MDF panel production line of the present invention shown in FIGS. 34 and 35 wherein wood furnish is being fed into the input handler of the dry screen drying stage of the system 100.

FIG. 36F shows a sixth view of the dry screen drying stage employed in the MDF panel production line of the present invention shown in FIGS. 34 and 35 wherein wood furnish is being fed along the moving screen conveyor towards the output handler of the dry screen drying stage of the system;

FIG. 36G shows a seventh view of the dry screen drying stage employed in the MDF panel production line of the present invention shown in FIGS. 34 and 35, wherein wood furnish material is being fed into the output handler of the dry screen drying stage of the system;

FIG. 37 is a schematic illustration providing a view of the resin and biochemical mixer/blender stage employed in the MDF/HDF panel production line of the present invention shown in FIGS. 34 and 35, wherein the homogeneous emulsion is produced by precisely metering and mixing (i) pDMI resins, (ii) biochemicals for performing specified functions, and (iii) waxes before being emulsified by one or more different methods including rapid mixing/blending and ultrasonic mixing, and then suppling the homogeneous resin/biochemical emulsion to the spray nozzles in the turbo-flow-based glue resinating engine employed in the resin and biochemical mixer/blender stage;

FIG. 37A is a schematic illustration providing a more detailed view of the resin and biochemical mixer/blender stage employed in the MDF/HDF panel production line of the present invention shown in FIG. 37;

FIG. 37B is a schematic illustration providing a first detailed view of the turbo-flow-based glue resinating engine employed in the resin and biochemical mixer/blender stage employed in the MDF/HDF panel production line of the present invention shown in FIG. 34, wherein the homogeneous biochemically-treated resin emulsion is spray atomized over the surface of the wood particle flow streams passing through the engine;

FIG. 37C is a schematic illustration providing a second detailed view of the turbo-flow-based glue resinating (i.e. resin application) engine employed in the resin and biochemical mixer/blender stage employed in the MDF/HDF panel production line of the present invention shown in FIG. 34, wherein the homogeneously-mixed and biochemically-treated resin emulsion is spray atomized over the surface of the wood particle flow streams passing through the resinating engine;

FIGS. 38A and 38B, taken together, set forth a flow chart describing the high-level steps carried out when practicing the method of producing Class-A fire-protected MDF/HDF sheathing in accordance with the present invention, as illustrated in FIGS. 34 and 35;

FIG. 39 is a perspective view of a stack of Class-A fire protected multi-ply plywood panels produced using the automated factory schematically represented in FIG. 40;

FIG. 40 is a schematic illustration of the automated factory, as generally depicted, and configured for producing Class-A fire-protected multi-ply plywood panels in accordance with the principles of the present invention as described herein;

FIG. 40A is a schematic illustration providing a first view of the resin adhesive/glue application system employed in the MDF/HDF panel production line of the present invention shown in FIGS. 39 and 40, wherein pMDI resin and biochemical additive composition of the present invention are mixed and blended together into a homogeneous adhesive resin emulsion is then spray-atomized to coat wood furnish material (i.e. wood particles) flowing through the resinator stage of the system;

FIG. 41 is a schematic representation of the automated plywood panel fabrication factory shown in FIG. 40, wherein each of the stages of plywood manufacture are graphically depicted to illustrate the functions performed along the multi-stage fabrication process of the present invention, including the treatment of wood furnish materials (e.g. wood particles) and resin adhesives (e.g. pDMI resin binders) used during the manufacturing process;

FIGS. 42A and 42B, taken together, set forth a flow chart describing the high-level steps carried out when practicing the method of producing clean Class-A fire-protected plywood panels in accordance with the present invention, as illustrated in FIG. 40;

FIG. 43 is a perspective view of a stack of Class-A fire protected 3-ply bamboo plywood panels produced according to the process illustrated in FIG. 44 using the automated factory schematically represented in FIG. 45;

FIG. 44 is a schematic representation of a process used to produce 3-ply bamboo plywood panels according to the present invention;

FIG. 45 is a schematic illustration of the automated factory, as generally depicted, and configured for producing Class-A fire-protected 3-ply bamboo plywood panels in accordance with the principles of the present invention as described herein;

FIGS. 46A and 46B, taken together, set forth a flow chart describing the high-level steps carried out when practicing the method of producing clean Class-A fire-protected 3-ply bamboo plywood panels in accordance with the present invention, as illustrated in FIG. 44;

FIG. 47 is a perspective view of a stack of Class-A fire protected bamboo strand board (BSB) panels produced according to the process illustrated in FIG. 48 using the automated factory schematically represented in FIG. 49;

FIG. 48 is a schematic representation of a process used to produce bamboo strand board (BSB) panels according to the present invention, wherein process for producing bamboo strand board (BSB) panels according to the present invention comprising the steps of (1) preparing raw material (bamboo strands-having a desired length, width and moisture content), (2) treating prepared bamboo strands with biochemical salts according to present invention to impart properties against fire, mold/mildew and/or moisture, (3) blending pMDI resin binder with biochemical salts of the present invention to produce treated resin emulsion, (4) mixing bamboo strands with treated resin emulsion with treated bamboo strands, (5) forming sheet of bamboo strands mixed with treated resin emulsion to form mat), (6) hot pressing the formed mat under compression to produce bamboo strand board (BSB), and (7) trimming and cutting bamboo strand board (BSB) panel into bamboo strand board (BSB) sheets;

FIG. 49 is a schematic illustration of the automated factory, as generally depicted, and configured for producing Class-A fire-protected bamboo strand board (BSB) panels in accordance with the principles of the present invention as described herein;

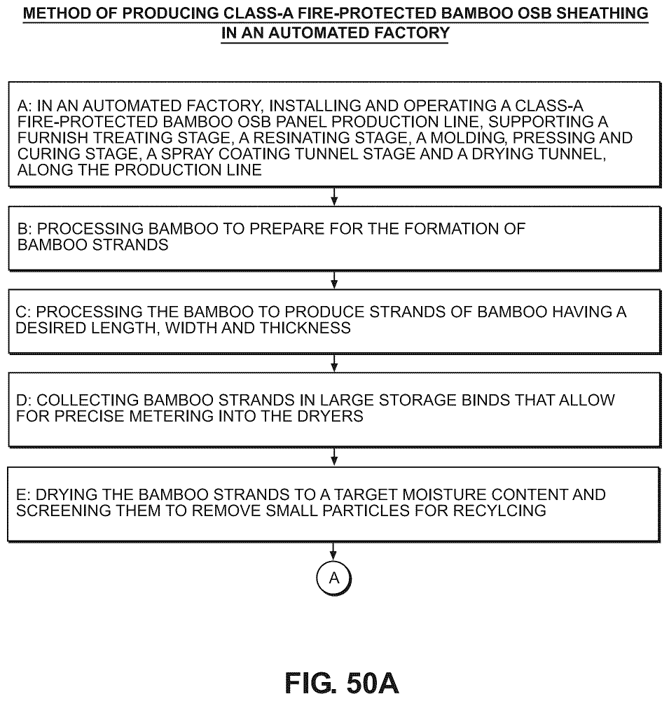

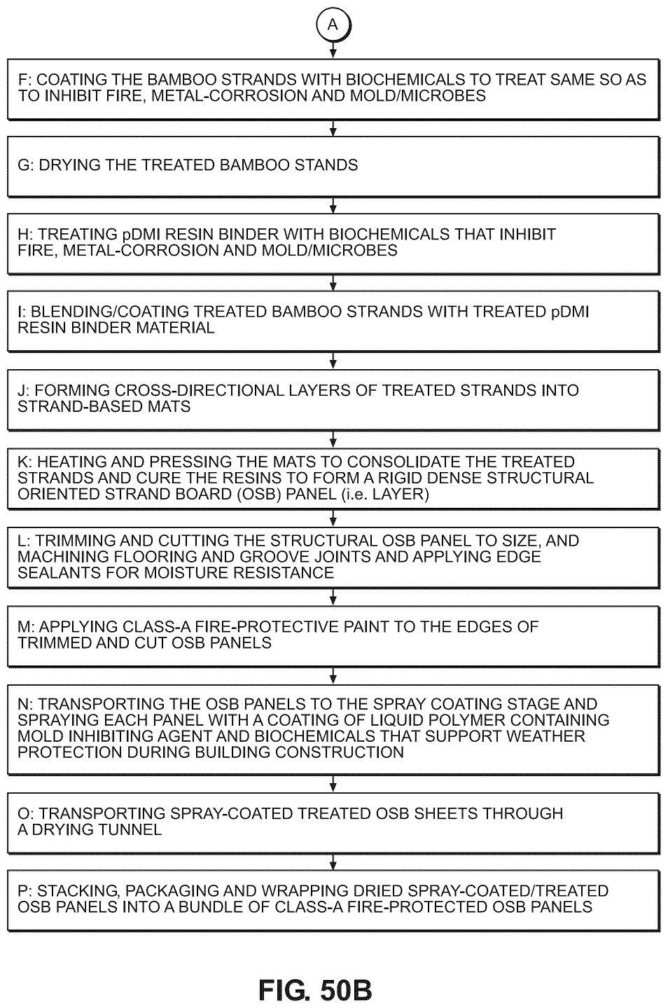

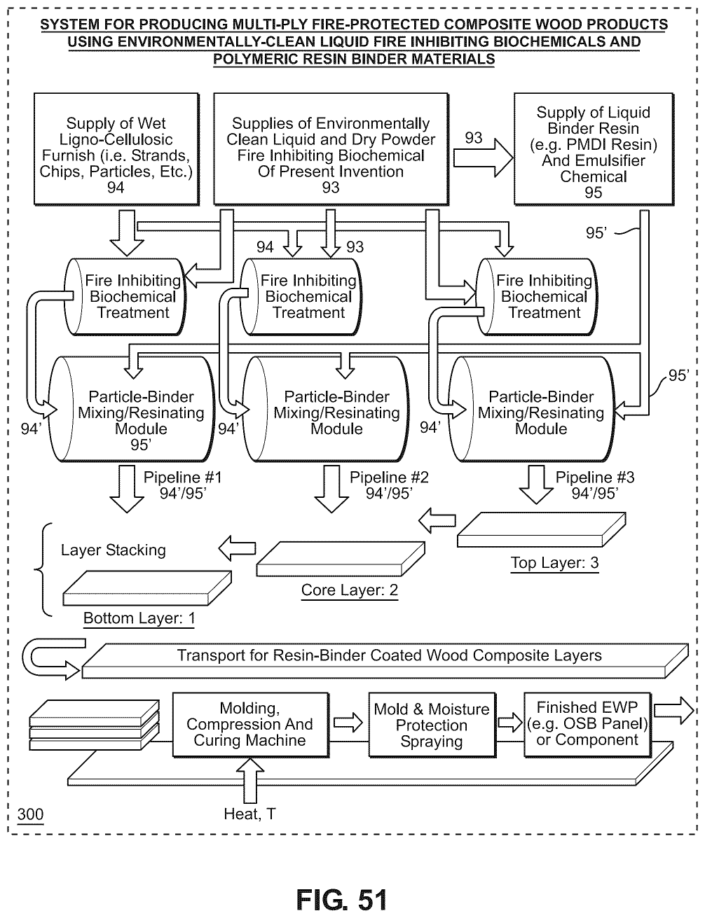

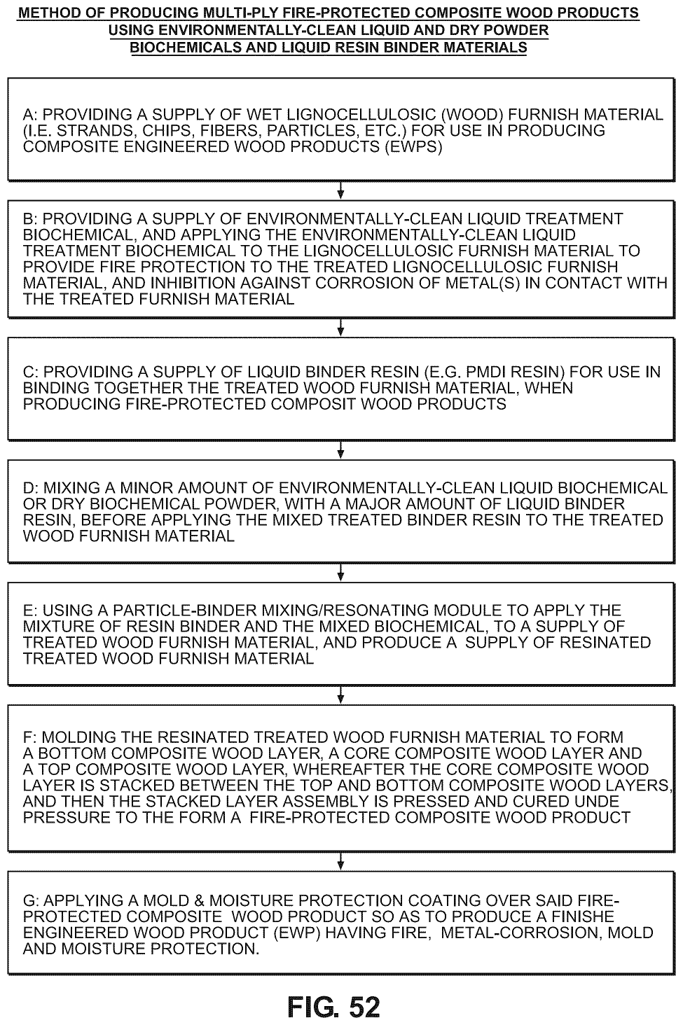

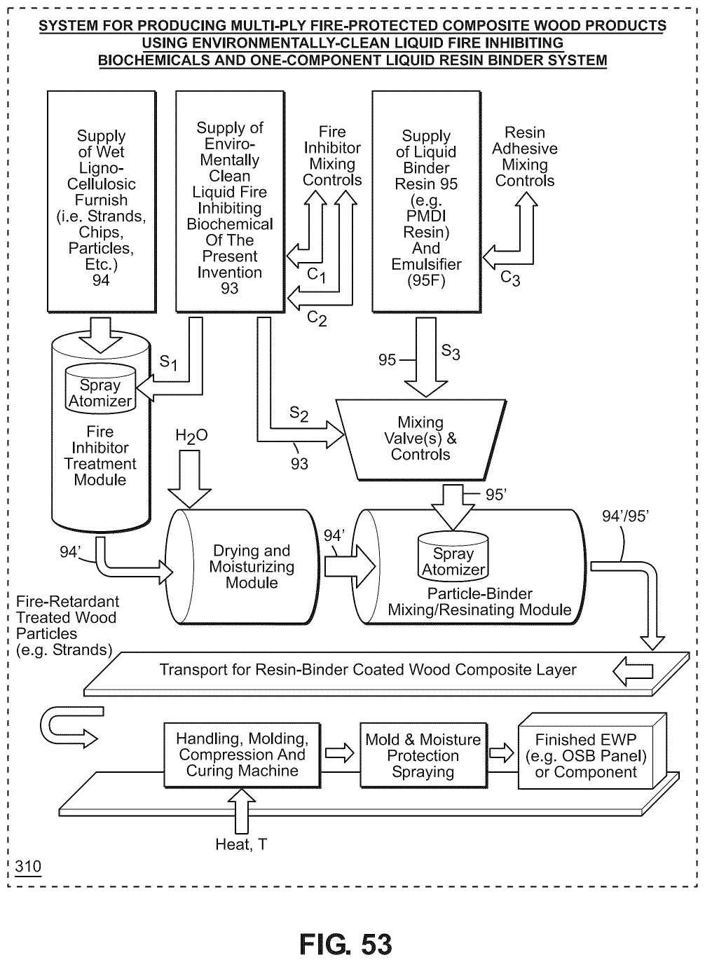

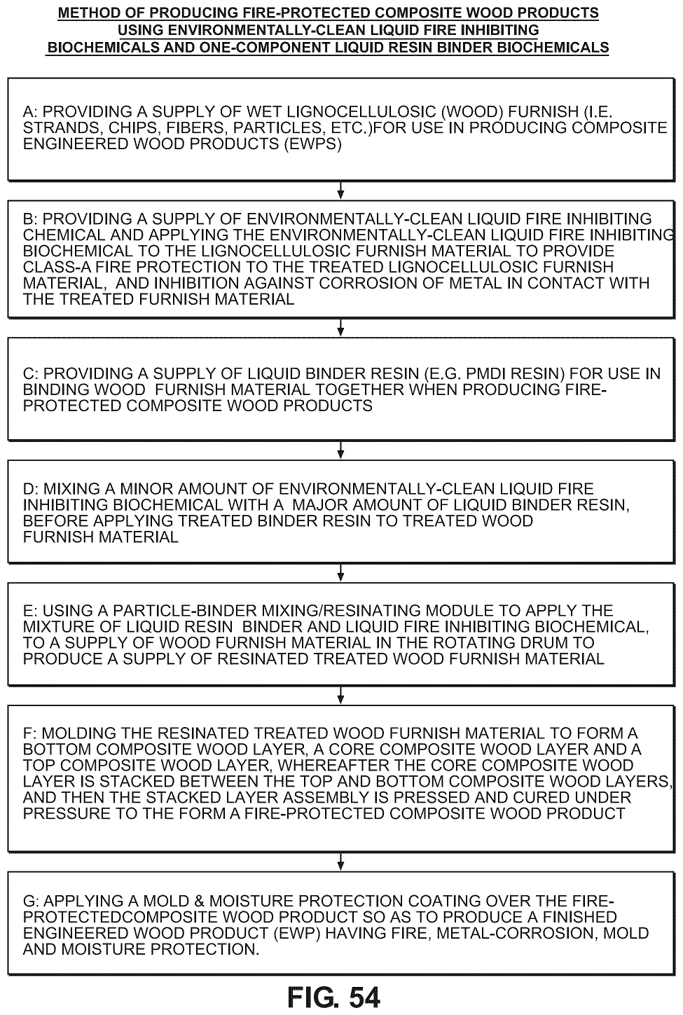

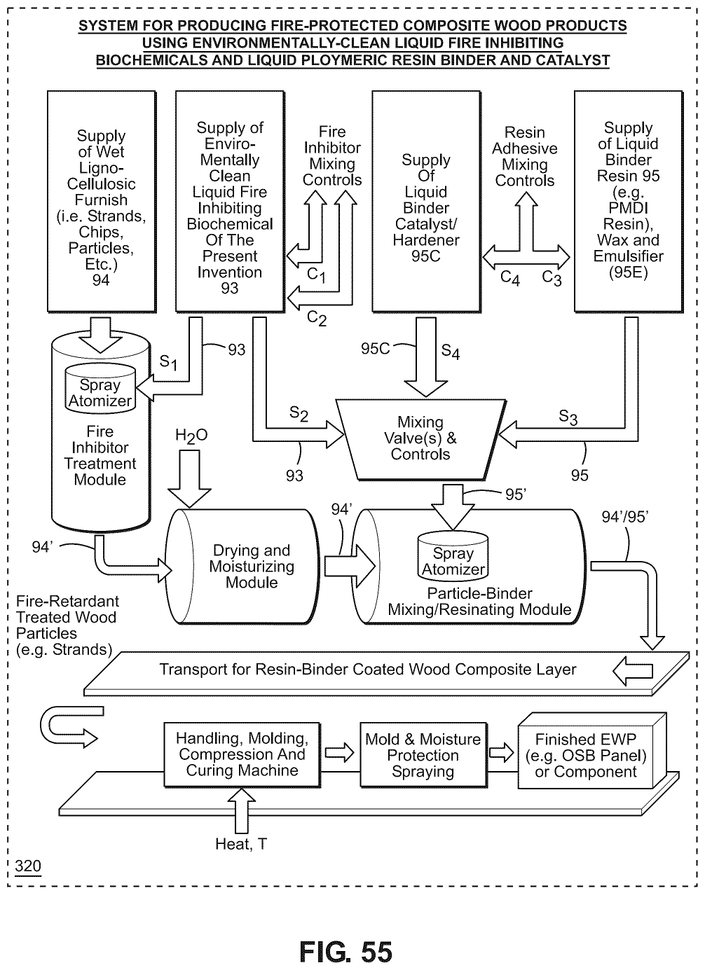

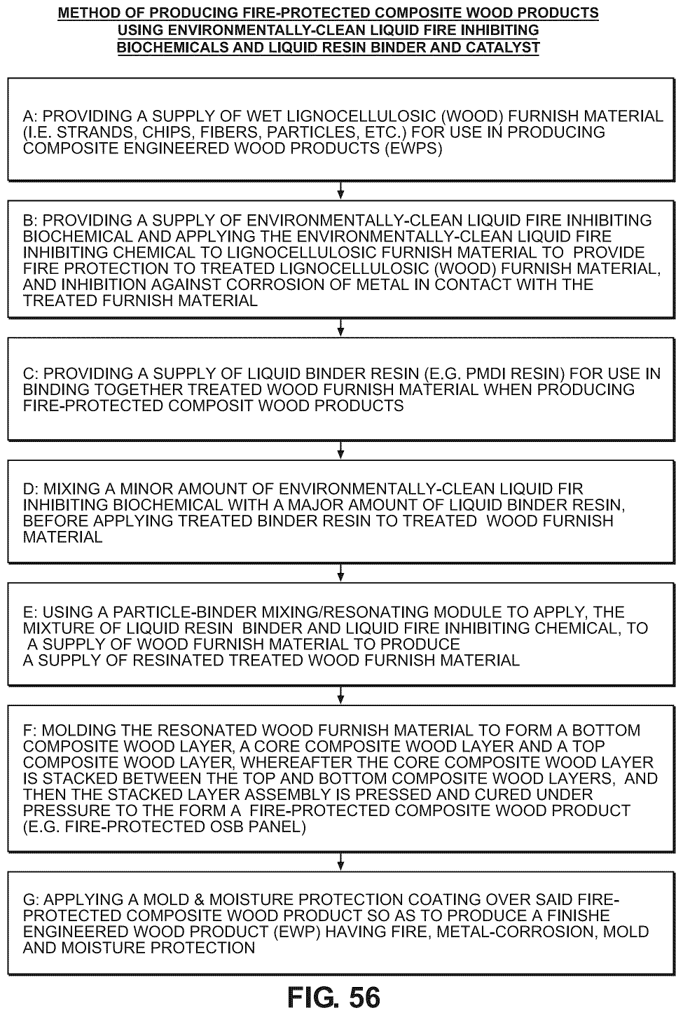

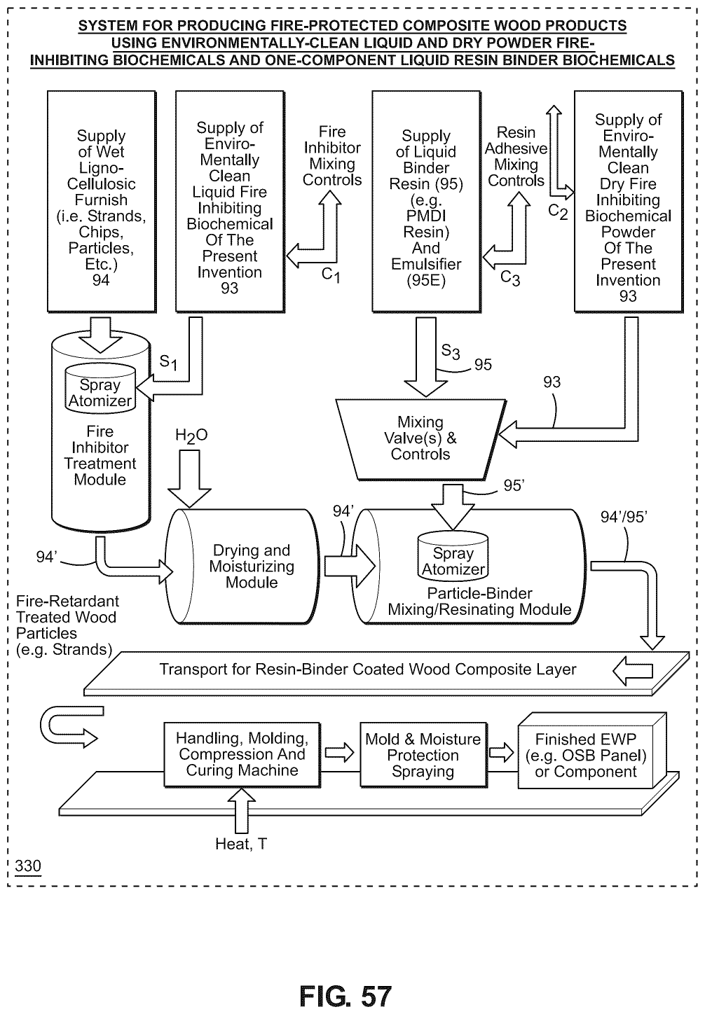

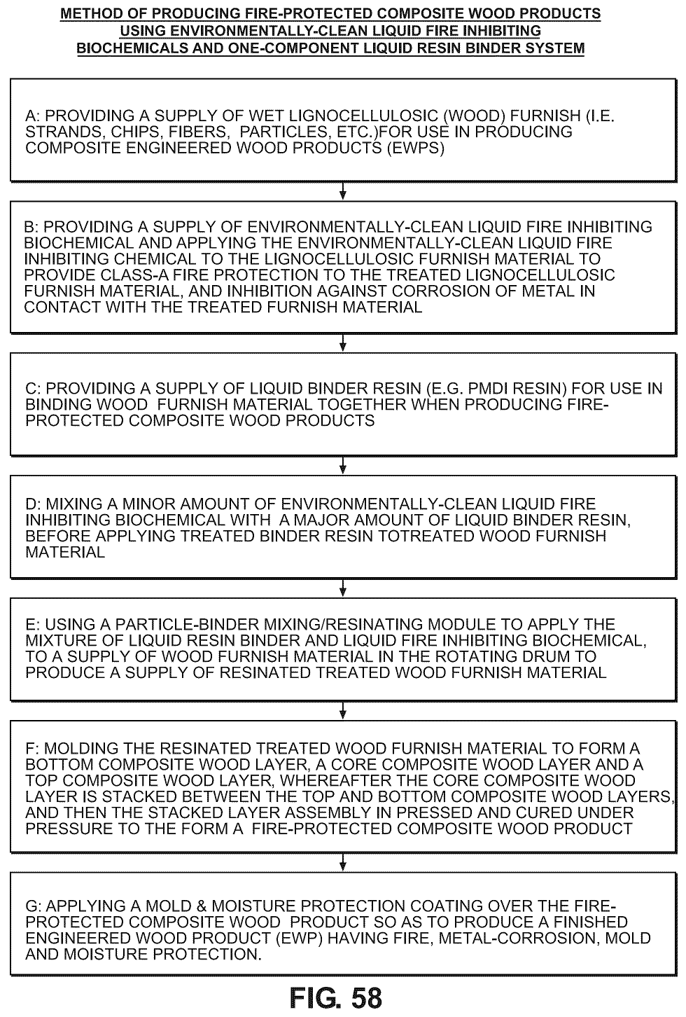

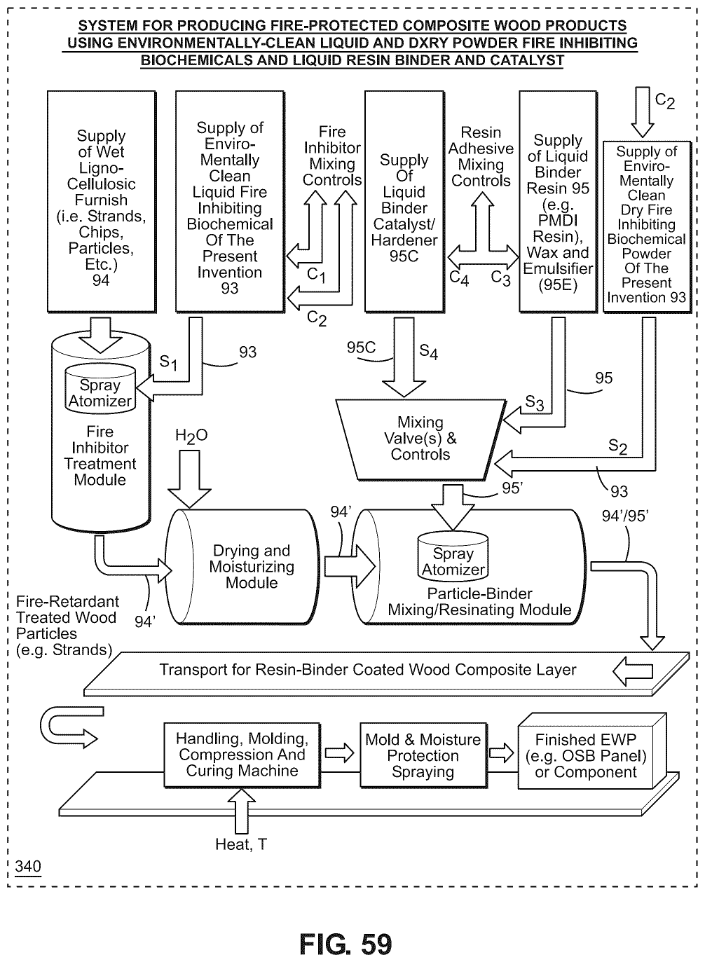

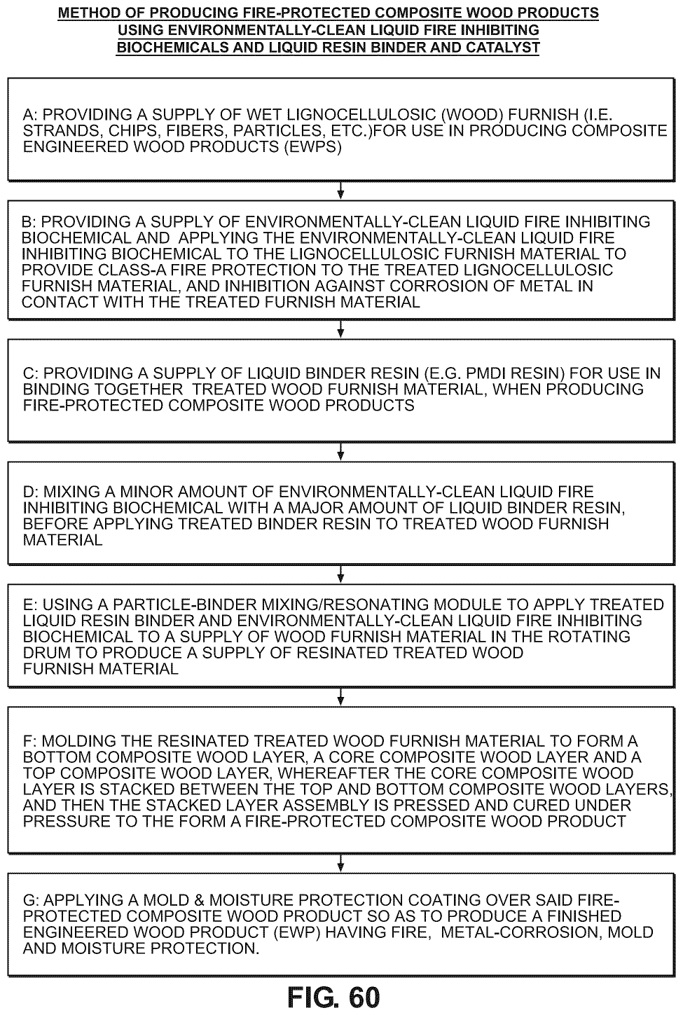

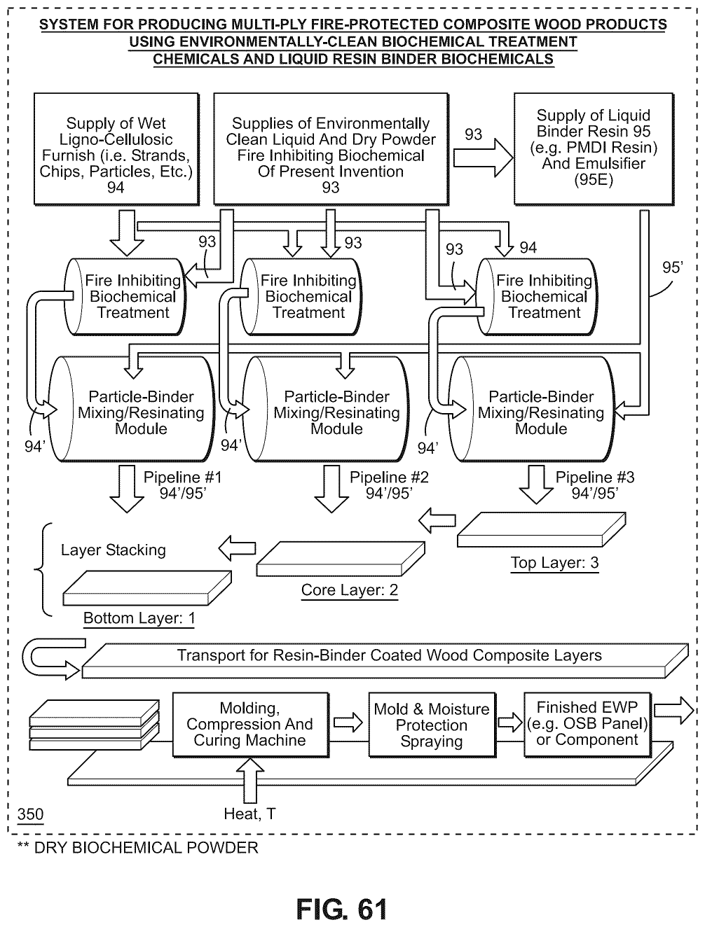

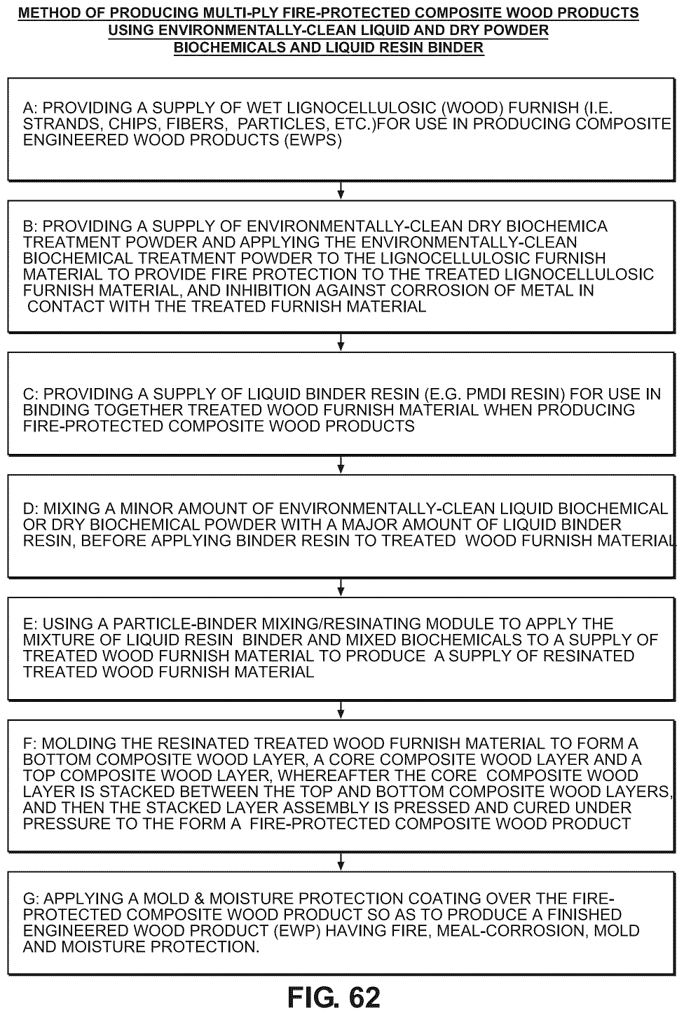

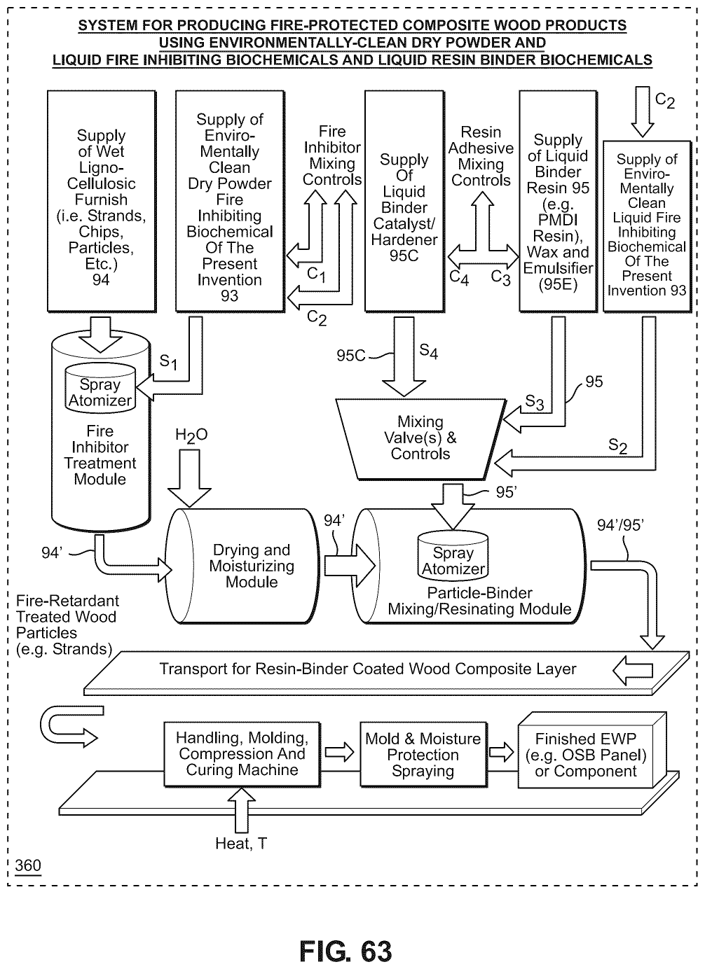

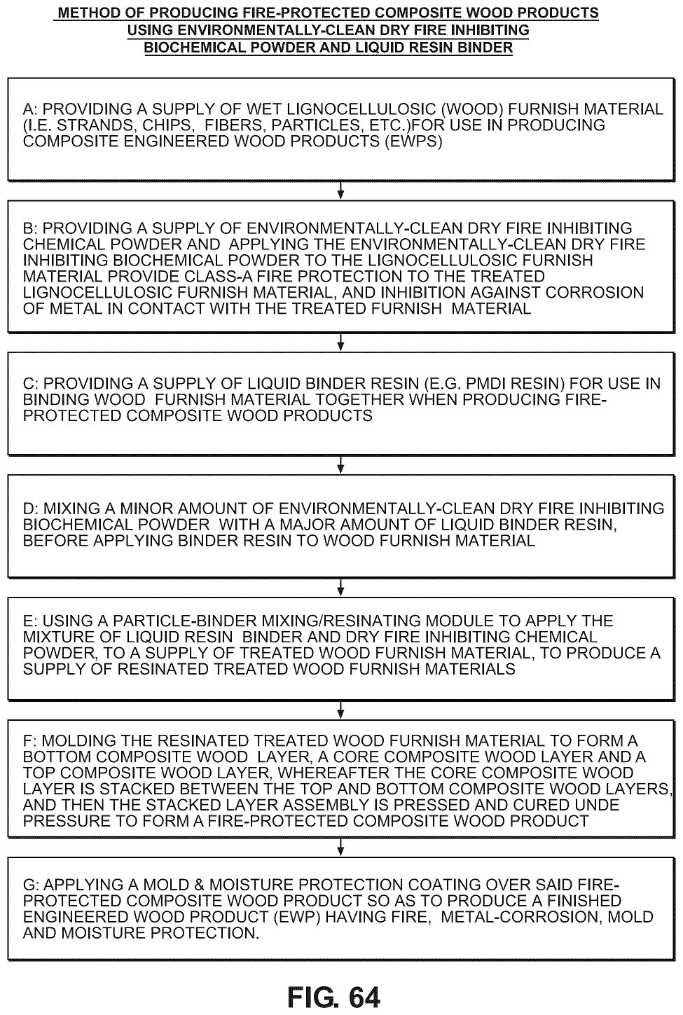

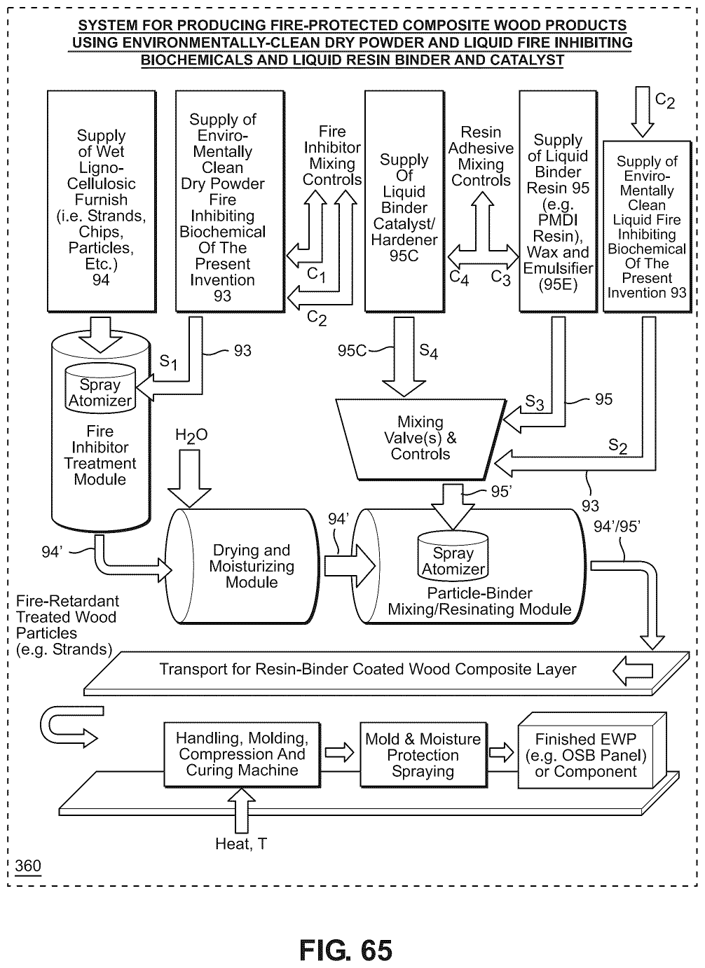

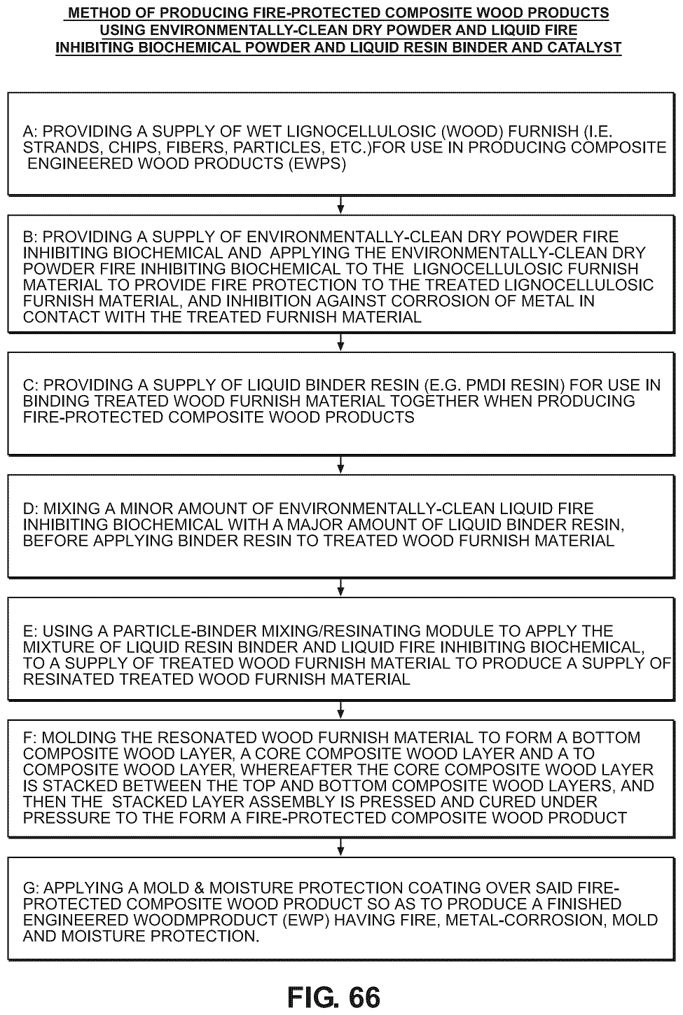

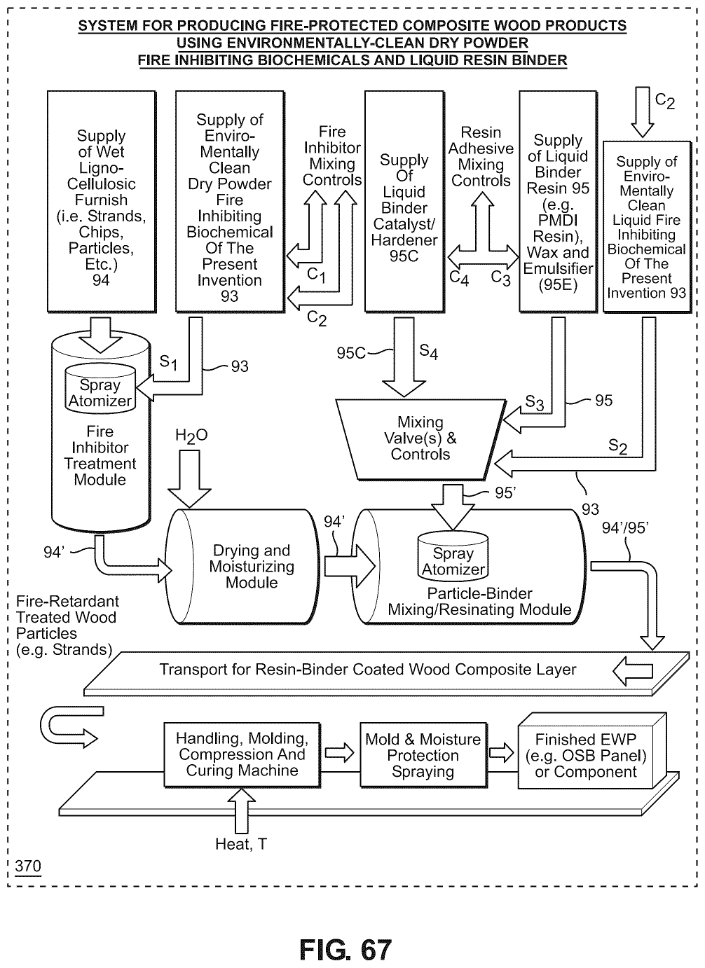

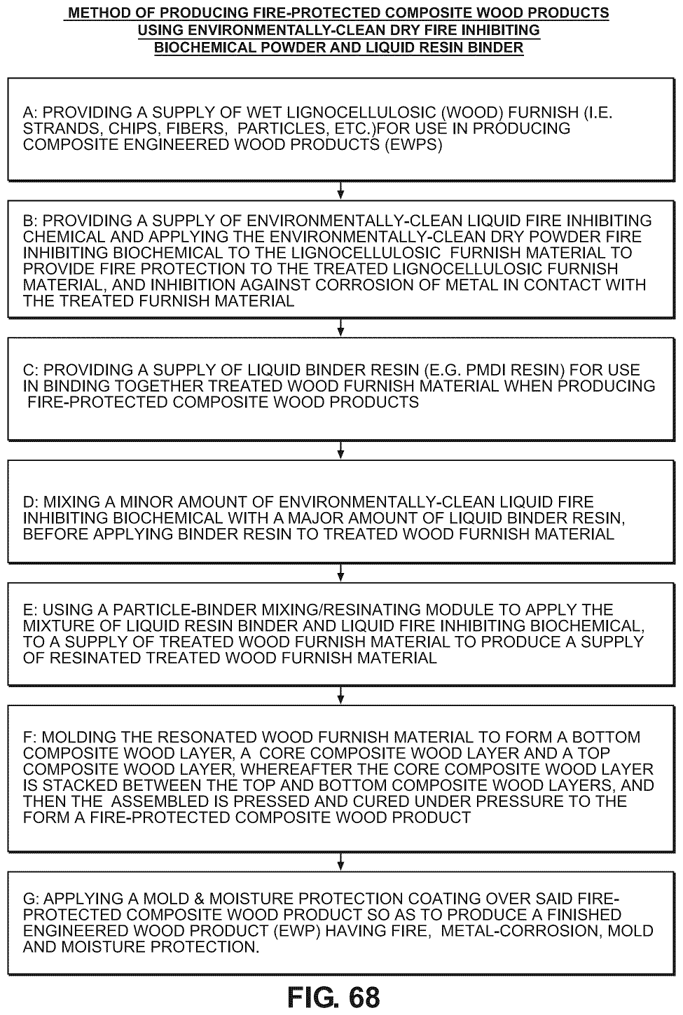

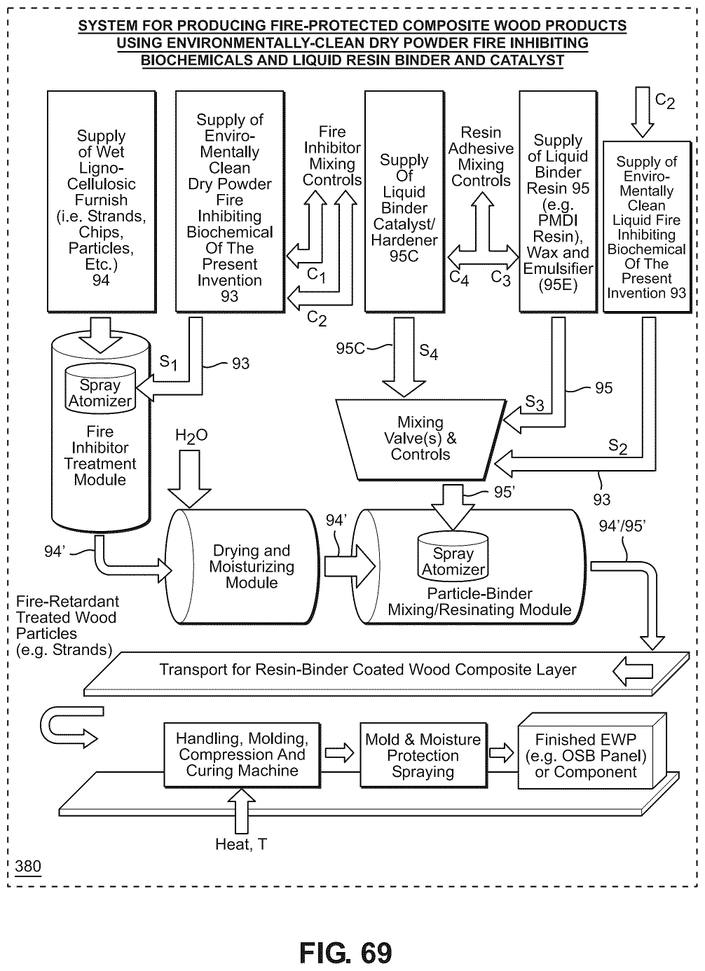

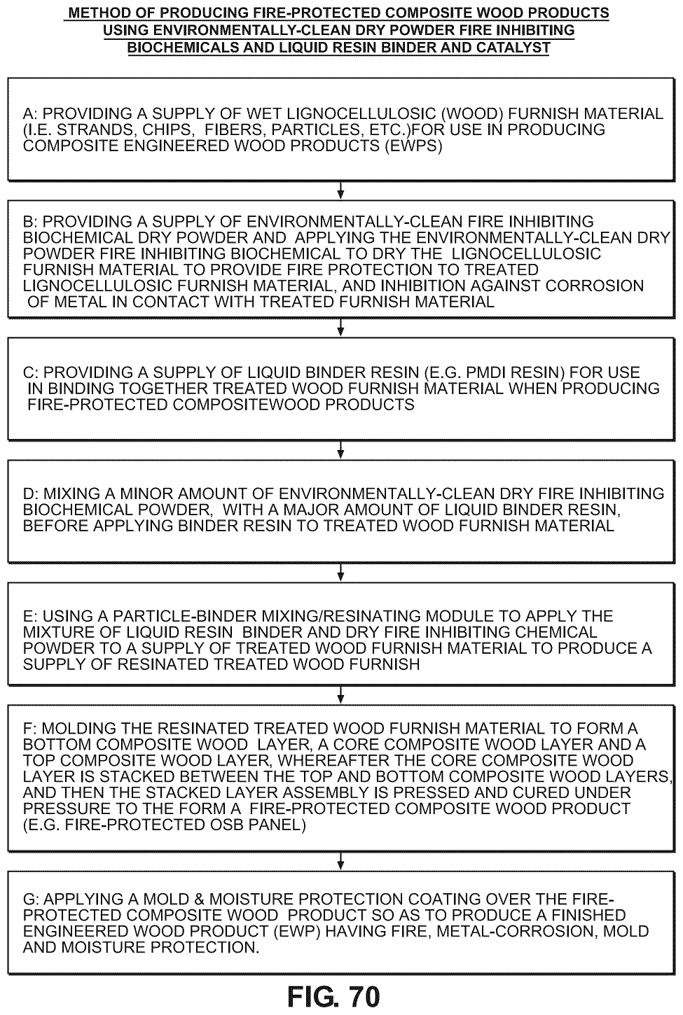

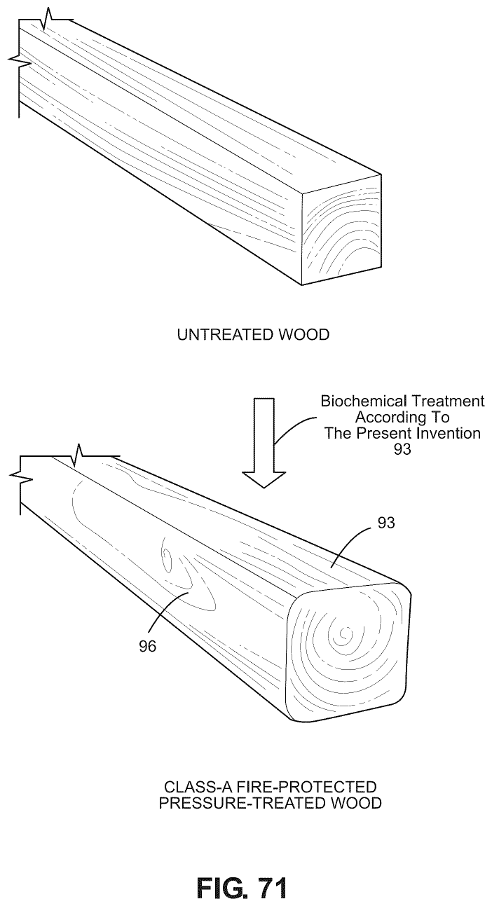

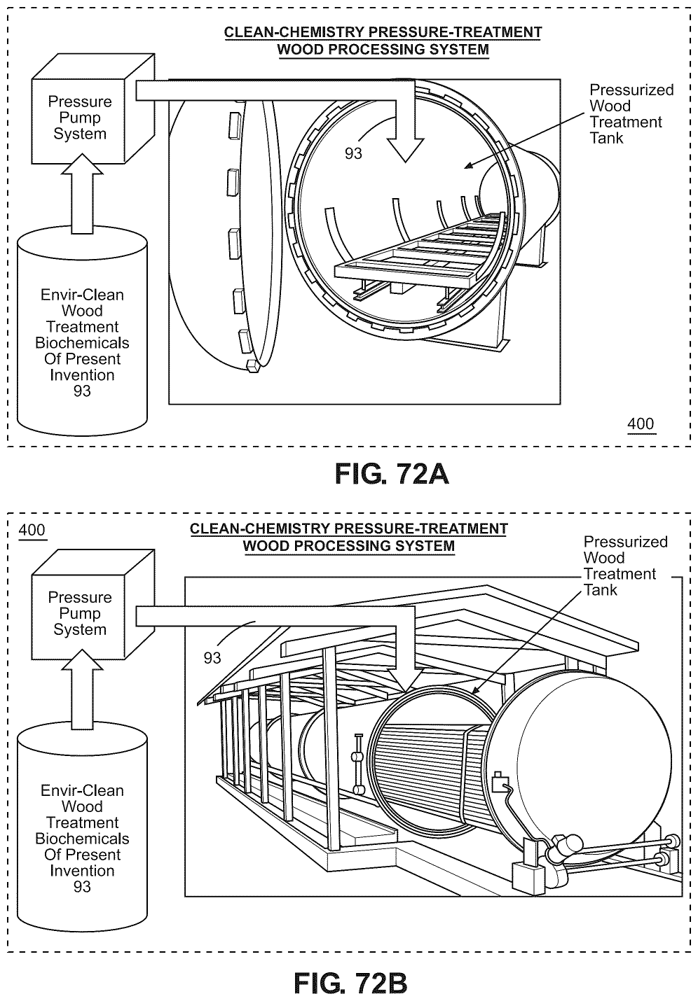

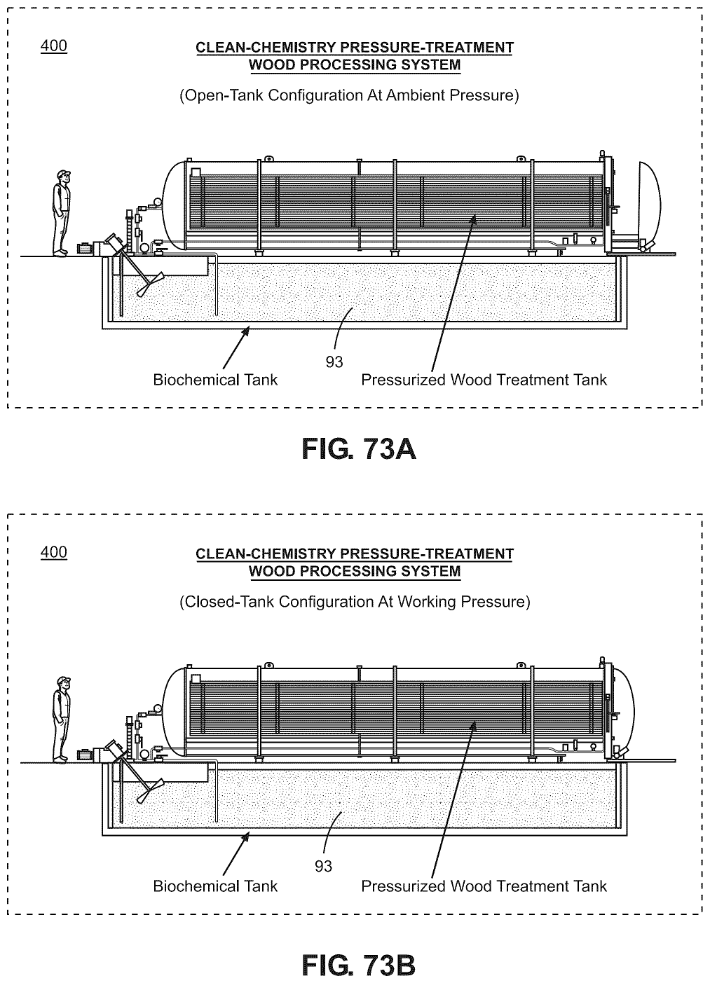

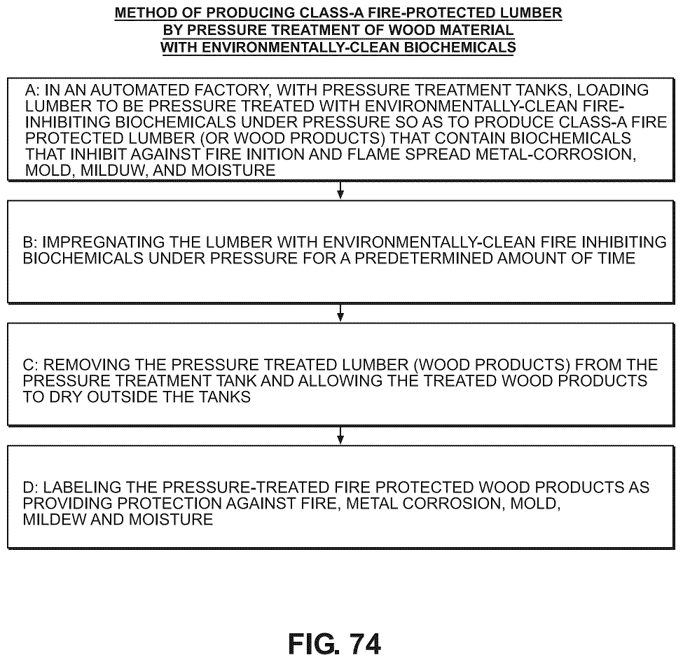

FIGS. 50A and 50B, taken together, set forth a flow chart describing the high-level steps carried out when practicing the method of producing clean Class-A fire-protected bamboo strand board (BSB) panels in accordance with the present invention, as illustrated in FIG. 48;

FIG. 51 is a schematic representation of a first generalized system for producing multi-ply fire-protected composite wood products (i.e. OSB panels) using environmentally-clean liquid fire inhibiting biochemicals and resin binder chemicals according to the principles of the present invention, and showing a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) chemical are supplied and provide to several (e.g. three) pipelines and used to support (i) fire inhibiting treatment of the wood furnish material, (ii) biochemical treatment of the resin binder chemicals, and (iii) resinating the treated wood furnish material before being processed and formed into layers (e.g. mats) that are then stacked into an stacked layer assembly, and then molded and compressed under heat and pressure to cure the applied binder resin chemicals, whereupon the molded wood product is released from the molds, and then sprayed with a polymer-based moisture protection top coating to produce finished final engineering wood product (EWP) in the form of a panel or other building construction component;

FIG. 52 is a flow chart representation describing the high level steps carried out during the first generalized method of producing multi-ply fire-protected composite wood products (i.e. OSB panels) using liquid resin binder biochemicals mixed with environmentally-clean liquid fire inhibiting chemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting biochemical, and applying the environmentally-clean liquid fire inhibiting biochemical to the lignocellulosic furnish material to provide fire protection to the treated lignocellulosic furnish material, and inhibition against corrosion of metal(s) in contact with the treated furnish material, (c) providing a supply of liquid resin binder (e.g. pMDI resin) for use in binding together the treated wood furnish material, when producing fire-protected wood products, (d) mixing a minor amount of environmentally-clean fire inhibiting chemical with a major amount of liquid resin binder, before applying the mixed treated binder resin to the treated wood furnish material, (e) using a particle-binder mixing/resinating module to apply the mixture of resin binder and fire inhibiting biochemical, to a supply of treated wood furnish material, and produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over said fire-protected composite wood product so as to produce a finished engineered wood product (EWP) having fire, metal-corrosion, mold and moisture protection;

FIG. 53 is a schematic representation of a first exemplary factory-based system for producing multi-ply fire-protected composite wood products (i.e. OSB panels) using environmentally-clean liquid fire inhibiting and resin binder chemicals (e.g. single component binder system comprising uncatalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) chemical are supplied and provided to several (e.g. three) pipelines and used to support (i) fire inhibiting treatment of the wood furnish material, (ii) treating the liquid resin binder chemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 54 is a flow chart describing the high level steps carried out during a first method of producing multi-ply fire-protected composite wood products (i.e. OSB panels) using one-component liquid resin binder chemicals mixed with environmentally-clean dry fire inhibiting chemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry fire inhibiting chemical powder and applying the environmentally-clean dry fire inhibiting chemical powder to the lignocellulosic furnish material provide Class-A fire protection to the treated Lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean dry powder fire inhibiting biochemical with a major amount of liquid resin binder chemical, before applying treated binder resin to treated wood furnish material, (e) using a particle-binder mixing/resinating module to apply the mixture of liquid resin binder and dry fire inhibiting chemical powder, to a supply of wood furnish material, to produce a supply of resinated treated wood furnish, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product, and (g) applying a mold and moisture protection coating over said fire-protected composite wood product so as to produce a finished engineered wood product (EWP) having fire, metal-corrosion, mold and moisture protection;

FIG. 55 is a schematic representation of a second exemplary factory-based system for producing multi-ply fire-protected composite wood products (i.e. OSB panels) using environmentally-clean liquid fire inhibiting and one-component resin binder chemicals (e.g. two component binder system comprising catalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, and (ii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 56 is a flow chart representation describing the high level steps carried out during the second method of producing multi-ply fire-protected composite wood products (i.e. OSB panels) using one-component liquid resin binder chemicals mixed with environmentally-clean liquid fire inhibiting biochemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material, (c) providing a supply of liquid resin binder (e.g. pMDI resin) for use in binding together treated wood furnish material when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply, the mixture of liquid resin binder and liquid fire inhibiting chemical, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold & moisture protection coating over said fire-protected composite wood product so as to produce a finished engineered wood product (EWP) having fire, metal-corrosion, mold and moisture protection;

FIG. 57 is a schematic representation of a third exemplary factory-based system for producing multi-ply fire-protected composite wood products (i.e. MDF, HDF and PB panels) using environmentally-clean liquid fire inhibiting and one-component resin binder chemicals (e.g. single component binder system comprising uncatalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) are supplied to several (e.g. three) pipelines and used to support (i) fire inhibiting treatment of the wood furnish material, (ii) treating resin binder chemicals with environmentally-clean biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 58 is a flow chart representation describing the high level steps carried out during a third method of producing multi-ply fire-protected composite wood products (i.e. OSB panels) using one-component liquid resin binder chemicals mixed with environmentally-clean dry fire inhibiting chemicals according to the principles of the present invention, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to the lignocellulosic furnish material to provide Class-A fire protection to the treated Lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply the mixture of liquid resin binder and liquid fire inhibiting chemical, to a supply of wood furnish material in the rotating drum to produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly cured under pressure to the form a fire-protected composite wood product, and (g) applying a mold & moisture protection coating over the fire-protected composite wood product so as to produce a finished engineered wood product (EWP) having fire, metal-corrosion, mold and moisture protection;

FIG. 59 is a schematic representation of a fourth exemplary factory-based system for producing multi-ply fire-protected composite wood products (i.e. MDF, HDF, PB panels) using environmentally-clean liquid fire inhibiting biochemical and resin binder chemicals (e.g. two component binder system comprising catalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, (ii) treating the rein binder chemicals with environmentally-clean biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 60 is a flow chart representation describing the high level steps carried out during a fourth method of producing fire-protected composite wood products (e.g. HDF, MDF and PB panels) using liquid resin binder chemicals mixed with environmentally-clean liquid fire inhibiting chemicals according to the principles of the present invention, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to the lignocellulosic furnish material to provide fire protection to the treated lignocellulosic furnish material, and inhibition against corrosion of metal in contact with the treated furnish material, (c) providing a supply of liquid resin binder (e.g. pMDI resin) for use in binding treated wood furnish material together when producing fire-protected wood products, (d) mixing a minor amount of environmentally-clean liquid fire inhibiting biochemical with a major amount of liquid resin binder chemical, before applying treated binder resin to treated wood furnish material, (e) using a particle-binder mixing/resinating module to apply the mixture of liquid resin binder and liquid fire inhibiting, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the assembly is cured under pressure to the form a fire-protected composite wood product, and (g) applying a mold and moisture protection coating over said fire-protected composite wood product so as to produce a finished engineered wood product (EWP) having fire, metal-corrosion, mold and moisture protection;

FIG. 61 is a schematic representation of a second generalized factory-based system for producing multi-ply fire-protected composite wood products (i.e. OSB panels) using environmentally-clean dry powder and liquid fire inhibiting biochemicals and resin binder chemicals mixed and blended together according to the principles of the present invention, and showing a supply of wet lignocellulosic furnish material (e.g. wood strands, chips, particles, etc.), a supply of environmentally-clean liquid and dry powder fire inhibiting biochemicals of the present invention, and a supply of liquid resin binder (e.g. pMDI resin) are supplied to several (e.g. three) pipelines and used to support (i) fire inhibiting (dry powder) treatment of the wood furnish material, (ii) treating liquid resin binder chemicals with environmentally-clean biochemicals, and (iii) resinating the treated wood furnish material with treated liquid resin binder before being processed and formed into layers (e.g. mats) that are then stacked into an stacked layer assembly, and then molded and compressed under heat and pressure to cure the applied binder resin, whereupon the molded wood product is released from the molds, and then sprayed with a polymer-based moisture protection top coating to produce finished final engineering wood product (EWP) in the form of a panel or other building construction component;

FIG. 62 is a flow chart representation describing the high level steps carried out during a second generalized method of producing multi-ply fire-protected composite wood products (i.e. OSB panels) using liquid resin binder chemicals mixed with environmentally-clean liquid fire inhibiting biochemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry powder fire inhibiting biochemical, and applying the environmentally-clean dry powder fire inhibiting biochemical to the lignocellulosic furnish material to provide fire protection to the treated lignocellulosic furnish material, and inhibition against corrosion of metal(s) in contact with the treated furnish material, (c) providing a supply of liquid resin binder (e.g. pMDI resin) for use in binding together the treated wood furnish material, when producing fire-protected wood products, (d) mixing a minor amount of environmentally-clean fire inhibiting biochemical with a major amount of liquid resin binder, before applying the mixed biochemically-treated binder resin to the biochemically-treated wood furnish material, (e) using a particle-binder mixing/resinating module to apply the mixture of resin binder and fire inhibiting biochemical, to a supply of biochemically-treated wood furnish material, and produce a supply of resinated treated wood furnish material, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over said fire-protected composite wood product so as to produce a finished engineered wood product (EWP) having fire, metal-corrosion, mold and moisture protection;

FIG. 63 is a schematic representation of a fifth exemplary factory-based system for producing multi-ply fire-protected composite wood products (i.e. OSB panels) using environmentally-clean dry powder and liquid fire inhibiting biochemicals and resin binder chemicals (e.g. single component binder system comprising uncatalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) are supplied to several (e.g. three) pipelines and used to support (i) fire inhibiting treatment of the wood furnish material, treating resin binder chemical with environmentally-clean biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 64 is a flow chart representation describing the high level steps carried out during a fifth method of producing multi-ply fire-protected composite wood products (i.e. OSB panels) using dry power biochemicals to treat wood furnish material and environmentally-clean liquid fire inhibiting biochemicals to treat resin binder chemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean dry power fire inhibiting biochemical and applying the environmentally-clean dry powder fire inhibiting biochemical powder to the wet lignocellulosic furnish material provide Class-A fire protection to the treated lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) Mixing a minor amount of environmentally-clean dry fire inhibiting chemical powder with a major amount of liquid resin binder, before applying binder resin to wood furnish material, (e) using a particle-binder mixing/resinating module to apply the mixture of liquid resin binder and dry fire inhibiting chemical powder, to a supply of wood furnish material, to produce a supply of resinated treated wood furnish, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product, and (g) applying a mold and moisture protection coating over said fire-protected composite wood product so as to produce a finished engineered wood product (EWP) having fire, metal-corrosion, mold and moisture protection;

FIG. 65 is a schematic representation of a sixth exemplary factory-based system for producing multi-ply fire-protected composite wood products (i.e. OSB panels) using environmentally-clean liquid and dry powder fire inhibiting biochemicals to treat wood furnish material and resin binder chemicals (e.g. two component binder system comprising catalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder catalyst (e.g. HCL), are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 66 is a flow chart representation describing the high level steps carried out during a sixth method of producing multi-ply fire-protected composite wood products (i.e. OSB panels) using liquid resin binder chemicals mixed with environmentally-clean liquid fire inhibiting chemicals according to the principles of the present invention, comprising the steps of (a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material, (c) providing a supply of liquid resin binder (e.g. pMDI resin) for use in binding together treated wood furnish material when producing fire-protected wood products, (d) mixing a minor amount of environmentally-clean liquid fire inhibiting chemical with a major amount of liquid resin binder, before applying binder resin to wood furnish material, (e) using a particle-binder mixing/resinating module to apply, the mixture of liquid resin binder and liquid fire inhibiting chemical, to a supply of wood furnish material to produce a supply of resinated treated wood furnish material, (f) molding the resonated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold and moisture protection coating over said fire-protected composite wood product so as to produce a finished engineered wood product (EWP) having fire, metal-corrosion, mold and moisture protection;

FIG. 67 is a schematic representation of a seventh exemplary factory-based system for producing multi-ply fire-protected composite wood products (i.e. MDF, HDF and PB panels) using environmentally-clean liquid fire inhibiting and resin binder chemicals (e.g. single component binder system comprising uncatalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, and a supply of liquid resin binder (e.g. pMDI resin) are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 68 is a flow chart representation describing the high level steps carried out during a seventh method of producing multi-ply fire-protected composite wood products (i.e. OSB panels) using liquid resin binder chemicals mixed with environmentally-clean dry powder and liquid fire inhibiting biochemicals according to the principles of the present invention, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean dry powder fire inhibiting biochemical and applying the environmentally-clean dry powder fire inhibiting biochemical to the lignocellulosic furnish material to provide Class-A fire protection to the treated lignocellulosic furnish material, and inhibition against corrosion of metal in contact with the treated furnish material, (c) providing a supply of liquid resin binder (e.g. pMDI resin) for use in binding wood furnish material together when producing fire-protected wood products, (d) mixing a minor amount of environmentally-clean liquid fire inhibiting chemical with a major amount of the liquid resin binder, before applying treated binder resin to treated wood furnish material, (e) using a particle-binder mixing/resinating module to apply the mixture of liquid resin binder and liquid fire inhibiting chemical, and treat a supply of wood furnish material in the rotating drum to produce a supply of resinated treated wood furnish material, (f) molding the (pMDI) resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over the fire-protected composite wood product so as to produce a finished engineered wood product (EWP) having fire, metal-corrosion, mold and moisture protection;

FIG. 69 is a schematic representation of an eighth exemplary factory-based system for producing multi-ply fire-protected composite wood products (i.e. MDF, HDF, PB panels) using environmentally-clean dry powder fire inhibiting biochemical to treat wood furnish materials, and environmentally-clean dry powder fire inhibiting biochemical to treat liquid resin binder chemicals (e.g. two component binder system comprising catalyzed PMDI prepolymeric resins) according to the principles of the present invention, wherein a supply of wet lignocellulosic furnish material (e.g. wood strands, chips, particles, etc.), a supply of environmentally-clean liquid fire inhibiting biochemicals of the present invention, a supply of liquid resin binder (e.g. pMDI resin) and a supply of liquid binder hardener/catalyst, are supplied to several (e.g. three) pipelines and used to support (i) fire inhibiting treatment of the wood furnish material, (ii) treating of liquid resin binder with the biochemicals, and (iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component;

FIG. 70 is a flow chart representation describing the high level steps carried out during an eighth method of producing fire-protected composite wood products (e.g. HDF, MDF and PB panels) using liquid resin binder chemicals mixed with environmentally-clean dry powder fire inhibiting biochemicals according to the principles of the present invention, comprising the steps of (a) providing a supply of wet lignocellulosic (wood) furnish (i.e. strands, chips, fibers, particles, etc.) for use in producing composite engineered wood products (EWPs), (b) providing a supply of environmentally-clean dry powder fire inhibiting biochemical and applying the environmentally-clean dry powder fire inhibiting biochemical to the lignocellulosic furnish material to provide fire protection to treated lignocellulosic furnish material, and inhibition against corrosion of metal in contact with treated furnish material, (c) providing a supply of liquid resin binder (e.g. pMDI resin) for use in binding together treated wood furnish material when producing fire-protected wood products, (d) mixing a minor amount of environmentally-clean dry powder fire inhibiting biochemical, with a major amount of liquid resin binder, before applying treated binder resin to treated wood furnish material, (e) using a particle-binder mixing/resinating module to apply the (treated) mixture of liquid resin binder and dry fire inhibiting chemical powder to a supply of treated wood furnish material to produce a supply of resinated treated wood furnish material for molding purposes, (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel), and (g) applying a mold and moisture protection coating over the fire-protected composite wood product so as to produce a finished engineered wood product (EWP) having fire, metal-corrosion, mold and moisture protection;

FIG. 71 is a schematic illustration of a piece of untreated wood that is transformed into a piece of Class-A fire protected wood by undergoing pressurized treatment contained within a pressurized tank holding untreated lumber and/or wood products and filled with environmentally-clean biochemical liquid according to the present invention that is used to impregnate wood fibers within the treated wood products and provide fire, mold/mildew and moisture protection to the treated wood products;

FIG. 72A is a schematic representation showing a first perspective view of a system of the present invention adapted for pressure treating untreated wood within a pressurized tank filled with biochemical liquid according to the present invention, wherein environmentally clean wood treating biochemical liquid of the present invention is pumped by a pressure pump into the treatment tank containing pieces of untreated wood, so as to impregnate wood fibers with the biochemical liquid and provide fire, mold/mildew and moisture protection;

FIG. 72B is a schematic representation showing a second perspective view of the system of the present invention adapted for pressure treating untreated wood contained within a pressurized tank filled with biochemical liquid according to the present invention, wherein the environmentally clean wood treating biochemical liquid of the present invention is pumped by a pressure pump into the treatment tank containing pieces of untreated wood, so as to impregnate wood fibers with the biochemical liquid and provide fire, mold/mildew and moisture protection; and

FIG. 73A and FIG. 73B, taken together, set forth a flow chart describing the primary steps the method of producing Class-A fire-protected lumber according to the present invention by pressure treatment of wood material with environmentally-clean biochemicals of the present invention.

DETAILLED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

While the invention will be described in connection with one or more embodiments, it will be understood that the invention is not limited to those embodiments. On the contrary, the invention includes all alternatives, all modifications, and equivalents as may be included within the spirit and scope of the appended claims.

While the present invention is exemplified by treating the wood furnish materials and polymeric resin binders (i.e. pMDI-based resin binders) used during OSB panel manufacture, it is understood that many other composite wood products (e.g. HDF, MDF, WIDI, BSB, Multi-Ply Plywood, etc.) and other polymeric resin binder systems (e.g. urea formaldehyde (UF), phenol formaldehyde (PF) in a liquid or powder state, liquid melamine urea formaldehyde (MUF),) can make great used of the present invention disclosed and claimed herein.

Specification Of Environmentally-Clean Fire Inhibiting Bio-Chemical Compositions And Formulations, And Methods of Making The Same In Accordance With The Principles Of The Present Invention

Another object of the present invention is to provide new and improved family of environmentally-clean (“i.e. Green”) fire inhibiting biochemical solutions (i.e. wet liquid compositions and dry powder compositions) for producing biochemical products that demonstrate very good long-term fire inhibiting effects when used to biochemically treat lignocellulosic-based wood furnish materials, and polymer resin binders, that are used during composite wood product manufacture.

While the preferred formulation of the fire inhibiting biochemical composition is a “ready-to-use” liquid (aqueous-based) formulation requiring no addition of water and/or mixing before use, the fire-inhibiting biochemical composition of the present invention can also be produced in dry powder form as shown in FIGS. 6B1 and 6B2, and described in the Specification hereinbelow.

In general, as illustrated in the generic chemical formulation model of FIG. 6, each new and improved environmentally-clean (i.e. “green” or “wet”) aqueous-based fire inhibiting biochemical compositions of the present invention is adapted for use in treating lignocellulosic-based wood furnish materials during solid and composition wood product manufacturing operations, and comprises: (i) a major amount of metal alkali salt dissolved (or to be dissolved) in a major amount of water, and derived from a saturated non-polymerized carboxylic acid, for producing alkali meal ions when the metal alkali salt is dissolved in water (aqueous solution), wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, about 32 F to about 130 F; (ii) a minor amount of one or more esters derived from the saturated non-polymerized carboxylic acid and/or another saturated non-polymerized carboxylic acid, promoting dispersing and coalescing properties of metal alkali ions in the aqueous solution and formation of alkali metal salt crystalline structures and/or coatings on and/or within combustible materials upon the evaporation of water molecules from applied aqueous solution; and (iii) minor amount of metal salt derived from carboxylic acid for inhibiting metal corrosion, mold and microbial life.

FIG. 6A1 provides an exemplary specification for the first aqueous-solution embodiment of the environmentally-clean aqueous-based fire inhibiting biochemical composition (i.e. solution) of the present invention, for treating lignocellulosic-based wood furnish material, and/or polymeric resin binder material, during composite wood product manufacture, and comprising: (i) a major amount of metal alkali salt dissolved (or to be dissolved) in a major amount of water, and derived from a saturated non-polymerized carboxylic acid, for producing metal alkali ions when the metal alkali salt is dissolved in water (i.e. aqueous solution), wherein the carbon chain length of the carboxylic acid is less than eight (C1-C7), and the resulting water-based liquid solution is stable when mixed so that its chemical components do not precipitate in the aqueous solution when stored in a storage container; (ii) a minor amount of alkali metal salt derived from of benzoic acid, wherein the alkali metal is selected from group consisting of potassium, sodium, calcium and magnesium; (iii) a minor amount of one or more esters derived from the saturated non-polymerized carboxylic acid and/or another saturated non-polymerized carboxylic acid, promoting dispersing and/or coalescing properties of metal alkali ions in the aqueous solution and formation of alkali metal salt crystalline structures and/or coatings on and/or within combustible materials upon the evaporation of water molecules from applied aqueous solution, and/or esterification of the lignocellulosic material being treated; and (iv) minor amount of metal salt derived from carboxylic acid for inhibiting metal corrosion, mold and microbial life.

FIG. 6A2 shows an exemplary specification for the second embodiment of the environmentally-clean biochemical wood treatment composition of the present invention for treating lignocellulosic-based wood furnish material, and/or polymeric resin binder material, during composite wood product manufacture, and comprising: (i) a minor amount of metal alkali salt dissolved (or to be dissolved) in a minor amount of water, and derived from a saturated non-polymerized carboxylic acid, for producing alkali metal ions when the metal alkali salt is disposed in the presence of water, wherein the carbon chain length of the carboxylic acid is C=6 (C6), and the resulting water-based liquid solution is stable when mixed so that its chemical components do not precipitate in the aqueous solution when stored in a storage container; (ii) a minor amount of alkali metal salt derived from of benzoic acid, wherein the alkali metal is selected from group consisting of potassium, sodium, calcium and magnesium, specifically potassium benzoate (SB).

FIG. 6B1 shows an exemplary specification for the first dry powder embodiment of the biochemical composition of the present invention, adapted for treating lignocellulosic-based material (i.e. wood furnish material), and/or polymeric resin binder material, during factory-based composite wood product manufacture, and comprising: (i) a major amount of dry powder tripotassium citrate monohydrate (TPC); and (ii) a minor amount of dry powder potassium benzoate (and optionally cupric citrate for mold control), wherein these dry powder components are prepared for (i) (dry powder) spraying onto wet lignocellulosic wood furnish material; and/or (ii) mixing and blending with a predetermined quantity of polymeric resin binder material (in an uncured/non-reacting liquid state), so as to treat lignocellulosic wood furnish material and/or polymeric resin binder material during composite wood product manufacture operations.

FIG. 6B2 shows an exemplary specification for the second embodiment of the biochemical composition of the present invention, adapted for treating lignocellulosic-based material (i.e. wood furnish material), and/or polymeric resin binder material, during factory-based composite wood product manufacture, and comprising: (i) a major amount of dry powder tripotassium citrate monohydrate (TPC); and (ii) a minor amount of dry powder potassium benzoate (and optionally cupric citrate for mold control) in combination with a minor amount of water as a reactant/catalyst when blended with pMDI polymeric resin binder, wherein these components are prepared for (i) (dry powder) spraying onto wet/green lignocellulosic wood furnish material; and/or (ii) mixing and blending with a predetermined quantity of polymeric resin binder material (in an uncured/non-reacting liquid state), so as to treat lignocellulosic wood furnish material and/or polymeric resin binder material during composite wood product manufacture operations.

FIG. 6B3 shows an exemplary specification for the first polymeric resin binder material biochemically-treated for use during factory-based composite wood product manufacture, and comprising: (i) a major amount of dry powder tripotassium citrate monohydrate (TPC); (ii) a minor amount of dry powder potassium benzoate (and optionally cupric citrate for mold control); and (iii) a major amount of pDMI polymeric resin binder material (in an uncured/non-reacting liquid state), blended together so that the dry power particles are well dispersed throughout the treated resin binder material, preferably in a homogeneous manner, preferably using a suitable emulsifier (e.g. triethyl citrate, waxes and other additives), whereby the polymeric resin binder material is biochemically treated prior to use during composite wood product manufacture operations, by providing fire inhibiting and corrosion inhibiting biochemicals available for protection against fire ignition, flame spread, smoke development.

FIG. 6B4 show an exemplary specification for the second polymeric resin binder material biochemically-treated for use during factory-based composite wood product manufacture, and comprising: (i) a major amount of dry powder tripotassium citrate monohydrate (TPC); (ii) a minor amount of dry powder potassium benzoate (and optionally cupric citrate for mold control); (iii) a minor amount of water functioning as a catalyst/reactant for use with pDMI-based polymeric resin binder material; and (iv) major amount of pDMI polymeric resin binder material (in an uncured/non-reacting liquid state), blended together so that the dry power particles are well dispersed throughout the treated resin binder material, preferably in a homogeneous manner, preferably using a suitable emulsifier (e.g. triethyl citrate, waxes and other additives), whereby the polymeric resin binder material is biochemically treated prior to use during composite wood product manufacture operations, by providing fire inhibiting and corrosion inhibiting biochemicals available for protection against fire ignition, flame spread, smoke development.

In each of the above classes of biochemical compositions, the starting biochemical, namely the non-polymerized saturated carboxylic acid, is an organic acid which contains a carboxyl group (C(═O) OH) attached to an R-group (R=alkyl or aryl). Carboxylic acids (denoted by R—COOH) are weak acids, meaning they are not 100% ionized in water. Generally, only about 1% of the molecules of a carboxylic acid dissolved in water are ionized at any given time. The remaining molecules are undissociated in solution. Being “saturated” means in this case, that each carbon (C) atom is bonded to four other atoms (hydrogen or carbon)—the most possible, and that there are no double or triple bonds in the molecules. The word saturated has the same meaning for hydrocarbons as it does for the dietary fats and oils: the molecule has no carbon-to-carbon double bonds (C=C).

The carbon-hydrogen bond (C—H bond) in the saturated non-polymerized carboxylic acid is a chemical bond between carbon and hydrogen atoms that can be found in many organic compounds. This bond is a covalent, single bond, meaning that carbon shares its outer valence electrons with up to four hydrogens. This completes both of their outer shells, making them stable. The C—H bond in general is very strong, so it is relatively unreactive.

The term “non-polymerized” means that carbon and hydrogen atoms in the saturated carboxylic acid have not undergone polymerization or any process of reaction in which relatively small molecules (monomer molecules) are reacted or combined chemically together in a chemical reaction to form very large chainlike or network molecule, called a polymer chains or three-dimensional network. In understanding that there are many forms of polymerization and different systems exist to categorize them.

A tricarboxylic acid, by the name itself, says that it is a category of carboxylic acid which has 3 C(═O) OH groups. In a carboxylic acid group, a carbon (C) atom is bonded to an oxygen (O) atom by a double bond, and to a hydroxyl group (—OH) by a single bond i.e., its functional group represented as C(═O) OH. Carboxylic acids occur widely in nature and its derivatives are of utmost importance in various chemical reactions. Tricarboxylic acids belong to the class of carboxylic acids which contains 3 carboxyl groups (C(═O) OH) attached to R-groups (R=alkyl or aryl).

At this juncture, it will be helpful to briefly identify a few kinds of carboxylic acids that are found in nature and which are of significance for purpose of the present invention, namely: the citric acid compound, a weak acid naturally occurring in citric fruits, which carries 3 carboxyl groups (C (—O) OH) attached to the parent chain, and hence is a tricarboxylic acid, a weak acid which naturally occurs in citric fruits; malonic acid, which carries only 2 carboxyl groups (C(═O) OH), and therefore is a dicarboxylic acid; succinic acid, which carries only 2 carboxyl groups (C(═O) OH), and therefore is a dicarboxylic acid; and malic acid, which also carries only 2 carboxyl groups (C (—O) OH), and therefore is a dicarboxylic acid. Since tricarboxylic acids have 3 carboxyl groups (C(═O) OH) attached to R-groups, it does have the ability to form strong hydrogen bonds, and this results in their high boiling points. Reference is made to the published organic chemistry textbook titled “MARCH'S ADVANCED ORGANIC CHEMISTRY: Reactions, Mechanisms, and Structures (Eighth Edition)”, Michael B. Smith, published by John Wiley & Sons, Inc., 2020, and incorporated herein by reference. Whenever available, all chemical substances and compounds disclosed herein have been provided with their CAS Registration Nos. as registered in the CAS Common Chemistry Database https://commonchemistry.cas.org/In general, the novel environmentally-clean (i.e. “green”) fire inhibiting liquid biochemical solutions and compositions of the present invention comprise a number of core elements, namely: (a) a dispersing agent in the form of a major quantity of water, for dispersing metal ions dissolved in water; (b) a major amount of a fire inhibiting agent in the form of at least one alkali metal salt of a nonpolymeric saturated carboxylic acid, for providing metal ions dispersed in the water when the at least one alkali metal salt is dissolved in the water; (c) a minor amount of a coalescing agent in the form of an organic compound containing multiple (e.g. double or triple) carboxylic acid groups (or salt/ester derivatives thereof), such as triethyl citrate, an ester of citric acid, for dispersing and coalescing the metal ions when the fire inhibiting liquid composition is applied to a surface to be protected against fire, while water molecules in the water evaporate during drying, and the metal ions cooperate to form metal salt crystal structure on the surface.

Optionally, additional elements may be added to the environmentally-clean liquid fire inhibiting biochemical solutions of the present invention disclosed herein, namely: (d) at least one anti-corrosive agent (e.g. potassium benzoate-(CAS RN 582-25-2) dissolved in water to form a protective film on container and piping surfaces and prevent corrosion-producing chemical reactions from damaging the surfaces of such metallic materials, as may be required by the particular application; (e) if appropriate, in certain wood protection applications, at least one biocide (e.g. citric acid or Polyphase® PW40 Biocide from Troy Corporation) dissolved in water for inhibiting the growth and development of mold, fungus, mildew and microbial growth on treated wood surfaces for purposes of preventing rot and structural deterioration of the treated wood; and (f) if appropriate, at least one colorant dissolved in the water for adding color properties to the biochemical liquid composition when applied to a combustible surface to be protected against fire.

In the world of organic chemistry, there are many possible non-polymeric saturated carboxylic acids that can be used to derive and produce alkali metal salts thereof for use in producing environmentally-clean aqueous-based liquid fire inhibitor that can be sprayed on combustible surfaces and form thin alkali metal salt crystalline coatings that inhibit fire ignition, flame spread and smoke development. Such possible carboxylic acids include, but are not limited to, the following carboxylic acids organized according to the number of carbon atoms (Ci) contained therein, namely:
(C1) The C1 Class of Carboxylic Acids having 1 carbon atom (C=1), including formic acid (i.e. methanoic acid) CH₂O₂ , and carbonic acid (i.e. hydroxymethanoic acid) H₂CO₃ ;
(C2) The C2 Class of Carboxylic Acids having 2 carbon atoms (C=2), including acetic acid (ethanoic acid) CH₃COOH, glycolic acid (hydroxyacetic acid) C₂H₄O₃, and glyoxylic acid C₂H2O₃;
(C3) The C3 Class of Carboxylic Acids having 3 carbon atoms (C=3), including propionic acid C₃H₆O₂, lactic acid C₃H₆O₃, glyceric acid C₃H₆O₄, pyruvic acid C₃H₄O₃, and tartaric acid C₃H₆O₆;
(C4) The C4 Class of Carboxylic Acids having 4 carbon atoms (C=4), including butyric acid CH3 (CH2) 2COOH, malic acid C4H605, and malonic acid C₃H404;
(C5) The C5 Class of Carboxylic Acids having 5 carbon atoms (C=5), including pivalic acid C₅H1002;
(C6) The C6 Class of Carboxylic Acids having 6 Carbon Atoms (C=6), including caproic acid CH3 (CH2) 4COOH, adipic (hexanedioic) acid HOOC (CH2) 4COOH, citric acid HOC (COOH) ((CH2) COOH) 2, and d-gluconic acid C₆H1207, and
(C7) The C7 Class of Carboxylic Acids having 7 carbon atoms (C=7), including benzoic acid C7H60.

While many alkali metal salts can be produced from these carboxylic acids listed above, as indicated in the models shown in FIGS. 6C1 through 6V2, the alkali metal salts of citric acid under Group C6 are particularly preferred, as will be further explained hereinbelow.

While the efficacy of the alkali metal salts increases in the order of lithium, sodium, potassium, cesium and rubidium, the salts of potassium and the salts of sodium preferred for cost of manufacturing reasons. Potassium carboxylates are very particularly preferred, but tripotassium citrate monohydrate (TPC) is the preferred alkali metal salt for use in formulating the environmentally-clean fire inhibiting biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported in the European Chemicals Agency (ECHA) handbook; and (iv) tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the preferred embodiments of the biochemical compositions and solutions of the present invention will be described in greater detail hereinafter.

Preferably, the water-soluble coalescing agent should have a melting point at least 32 F (0 C) or lower in temperature, and be soluble in water. The citric acid ester, triethyl citrate (TEC), is a preferred dispersing/coalescing agent when used in combination with tripotassium citrate (TPC) having excellent molecular and chemical compatibility given that both chemical compounds are derived from citric acid.

Ideally, the biocidal agent should help increase stability in storage, especially of the aqueous preparations, and prevent or inhibit growth of mildew, mold, and fungus when the biochemical liquid compositions are sprayed or otherwise applied to the surfaces of wood products that to be treated therewith, to produce Class-A fire-protected wood products with resistance to mold, mildew and fugus growth. This is important when wood products are shipped and stored in lumber yard, and are allowed to be exposed to the natural elements for months on a construction site, where moisture is present, and conditions are excellent for such microbial growth. Mold, mildew, and fungus growth not only detracts from the appearance of the wood product, but also can adversely decrease wood fiber strength and other mechanical properties for which wood products are used in specific construction applications.

In some applications, the use of colorants may be advantageous with or without opacifying assistants, to the fire inhibiting biochemical liquid compositions of the present invention. Opacifying assistants make the fire-retarding biochemical composition cloudy and prevent any interaction between the color of the added colorant used and the background color.

The preferred colorant is mica, especially natural mica. Mica also acts as an opacifying assistant, so that a separate opacifying assistant can be omitted. Areas which have already been treated are easier to identify, for example, from the air. In addition, mica can reflect direct thermal radiation.

The concentration of the dye in the fire-retarding biochemical composition is preferably in the range from 0.005% to 10% by weight, more preferably in the range from 0.01% to 5% by weight and most preferably in the range from 0.015% to 2% by weight.

Of advantage are dyes, food dyes for example, which fade as the fire-retarding composition dries and gradually decompose or are otherwise easily removable, for example, by flushing with water.

The fire inhibiting liquid biochemical compositions of the present invention are producible and prepared by mixing the components in specified amounts with water to produce the fire inhibiting composition. The order of mixing is discretionary. It is advantageous to produce aqueous preparations by mixing the components other than water, into water.

The fire-retarding biochemical compositions of the present invention have a good fire inhibiting effect and, a good immediate fire extinguishing effect. This mixing of the constituent biochemical compounds can take place before or during their use. For example, an aqueous preparation may be set and kept in readiness for fire inhibiting use. However, it is also possible for the aqueous preparation not to be produced until it is produced, by diluting with water, during a fire defense wood treatment application.

### Specification Of Preferred Embodiments Of Aqueous-Based Fire Inhibiting Biochemical Compositions Of Matter

As indicated above, while there are many species of Applicant's generic aqueous-based liquid fire inhibiting solution invention, based on different kinds of non-polymeric saturated carboxylic acids and alkali metal salts and esters dissolved in water, for forming thin fire-inhibiting life-supportive alkali metal salt crystalline coatings, Applicant's preferred solutions and compositions are based on (i) alkali metal potassium salts derived from the citric carboxylic acid, and (ii) esters of citric acid for superior dispersion of potassium and citrate ions, and the coalescing of salt crystalline molecules in aqueous solution during coating drying operations. These preferred embodiments will be summarized below, and thereafter, the other alternative species of invention will be specified in great technical detail.

In one preferred embodiment of the fire inhibiting liquid biochemical composition/solution of the present invention, the components are realized as follows: (a) the dispersing agent is realized in the form of a quantity of water, for dispersing alkali metal ions dissolved in the water; (b) the fire inhibiting agent is realized in the form of an alkali metal salt of a nonpolymeric saturated carboxylic acid, specifically, tripotassium citrate, for providing metal (potassium) ions dispersed in the water when the at least one alkali metal salt is dissolved in the water; and (c) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid solution is applied to a surface to be protected against fire, and while water molecules in the water evaporate during drying, the metal potassium ions cooperate to form potassium salt crystalline structures and/or coatings on treated surfaces.

Once prepared using any of formulations specified above, the liquid biochemical solution is then stored in a container, bottle, or tote (i.e. its package) suitable for the end user application in mind. Then, the filled package should be sealed with appropriate sealing technology and immediately labeled with a specification of (i) its biochemical components, with weight percent measures where appropriate, and the date and time of manufacture, printed and recorded in accordance with good quality control (QC) practices well known in the art. Where necessary or desired, barcode symbols and/or barcode/RFID identification tags and labels can be produced and applied to the sealed package to efficiently track each barcoded package containing a specified quantity of clean fire inhibiting biochemical position. All product and QC information should be recorded in globally accessible network database, for use in tracking the movement of the package as it moves along the supply chain from its source of manufacture, toward it end use at a GPS specified location.

Selecting Tripotassium Citrate (TCP) As A Preferred Fire Inhibiting Agent For Use In The Fire Inhibiting Biochemical Compositions Of The Present Invention

In the preferred embodiments of the present invention, tripotassium citrate (TPC) is selected as active fire inhibiting chemical component in fire inhibiting biochemical solution. In dry form, TPC is known as tripotassium citrate monohydrate (C₆H₅K₃O₇ ·H2O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Care should be taken not to expose tripotassium citrate monohydrate to high pressure during transport and storage as this may result in caking. Tripotassium citrate monohydrate is considered “GRAS” (Generally Recognized As Safe) by the United States Food and Drug Administration without restriction as to the quantity of use within good manufacturing practice. CAS Registry Number for tripotassium citrate monohydrate: [6100 May 6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

### Selecting Triethyl Citrate (TEC) As A Preferred Dispersing/Coalescing Agent With Surface Tension Reducing And Surfactant Properties For Use In Aqueous-Based Fire Inhibiting Biochemical Compositions Of The Present Invention

In the preferred aqueous-based illustrative embodiments of the present invention, the coalescing agent used in the fire inhibitor biochemical compositions of the present invention is realized as a food-grade additive component, namely, triethyl citrate (TEC) which functions as a dispersing and coalescing agent with surface tension reducing properties and surfactant properties as well. Citric acid is a six-carbon tricarboxylic acid, first isolated from lemon juice, and used in the food and beverage industry for various purposes, as pharmaceuticals and for other industrial uses. Triethyl citrate belongs to the family of tricarboxylic acids (TCAs) and derivatives, organic chemical compounds containing three carboxylic acid groups (or salt/ester derivatives thereof).

In the aqueous-based fire inhibiting liquid composition, the coalescing agent functions as temporary dispersing agent for dispersing the metal ions dissolved and disassociated in aqueous solution. As water molecules evaporate from a coating of the biochemical composition, typically spray/atomized applied to a surface to be protected from fire, the coalescing agent allows the formation of thin metal (e.g. potassium citrate) salt crystal structure/films at ambient response temperature conditions of coating application. The coalescent agent promotes rapid metal salt crystal structure formation on surfaces to be protected against wildfire, and have a hardness evolution that promotes durability against rain and ambient moisture, while apparently allowing vital oxygen and CO2 gas transport to occur, without causing detrimental effects to the vitality of living plant tissue surfaces sought to be protected against wildfire.

A relatively minor quantity of triethyl citrate (TEC) liquid is blended with a major quantity of TCP powder in specific quantities by weight and dissolved in a major quantity of water to produce a clear, completely-dissolved liquid biochemical formulation consisting of food-grade biochemicals mixed with water and having highly effective fire inhibiting properties, as proven by testing. The resulting aqueous biochemical solution remains stable without the formation of solids at expected operating temperatures (e.g. 34F to 120 F).

Jungbunzlauer (JBL) also manufactures and distributes its CITROFOL® A1 branded bio-based citrate esters for food-grade, healthcare, pharmaceutical and over the counter (OTC) applications around the world. CITROFOL® A1 triethyl citrate (TEC) esters have an excellent toxicological and eco-toxicological profile, and provide good versatility and compatibility with the tripotassium citrate (TPC) component of the biochemical compositions of the present invention. CITROFOL® A1 branded citrate esters are particularly characterized by highly efficient solvation, low migration, and non-VOC (volatile organic compound) attributes. As an ester of citric acid, triethyl citrate is a colorless, odorless liquid which historically has found use as a food additive (E number E1505) to stabilize foams, especially as a whipping aid for egg whites.

Broadly described, the fire inhibiting biochemical liquid coatings of the present invention consist of an aqueous dispersion medium such as water which carries dissolved metal salt cations that eventually form a thin metal salt crystalline structure layer on the surface substrate to be protected from ignition of fire. The aqueous dispersion medium may be an organic solvent, although the preferred option is water when practicing the present invention. After the application of a coating onto the combustible surface to be protected against fire ignition and flame spread and smoke development, the aqueous dispersion medium evaporates, causing the metal salt (i.e. potassium salt) cations to draw together. When these metal salt particles come into contact, the coalescing agent, triethyl citrate, takes effect, uniformly dispersing the same while reducing liquid surface tension, and giving rise to the formation of a relatively homogeneous metal salt crystalline structure layer over the surface. In practice, this interaction is more complex and is influenced by various factors, in particular, the molecular interaction of the potassium salt cations and the coalescing agent, triethyl citrate, as the water molecules are evaporating during the drying process.

While offering some surface tension reducing effects, the main function of the coalescing agent in the biochemical composition of the present invention is to ensure a relatively uniform and optimal formation of the salt crystalline structure layers on the combustible surfaces to be protected, as well as desired mechanical performance (e.g. offering scrub resistance and crystal coating hardness) and aesthetic values (e.g. gloss and haze effects).

The fact that CITROFOL® A1 triethyl citrate (TEC) esters are bio-based, odorless, biodegradable, and label-free, represents a great advantage over most other coalescing agents, and fully satisfies the toxicological and environmental safety requirements desired when practicing the biochemical compositions of the present invention.

In the preferred embodiments of the present invention, the use of CITROFOL® AI triethyl citrate (TEC) esters with tripotassium citrate monohydrate (TPC) dissolved in water as a dispersion solvent, produce fire inhibiting biochemical formulations that demonstrate excellent adhesion, gloss, and hardness properties. The chemical and colloidal nature of potassium salt ions (which are mineral salt dispersions) present in TPC dissolved in water, is highly compatible with the CITROFOL® A1 triethyl citrate (TEC) ester used as the coalescing agent in the preferred embodiments of the present invention. Also, CITROFOL® A1 triethyl citrate esters are REACH registered and are safe, if not ideal, for use in environmentally sensitive products such as fire and wildfire inhibitors which must not adversely impact human, animal and plant life, ecological systems, or the natural environment.

CITROFOL® triethyl citrate esters were selected because they are biodegradable, and exhibit an excellent toxicological and eco-toxicological profile for the applications of the present invention. These esters are also versatile and demonstrate very good compatibility with the TPC solution, and are characterized by a high solvating efficiency.

### Selecting Citric Acid As A Natural And Safe Biocidal Agent For Use In The Fire Inhibiting Biochemical Compositions Of The Present Invention

It is understood that conventional biocidal agents (i.e. biocides) such as Polyphase® PW40 water-based biocidal agent from Troy Chemical, can be added to the biochemical compositions of the present invention, to control and inhibit the growth of mold, mildew and fungus on wood products treated with the biochemical of the present invention.

However, as an alternative biocidal agent, an object of the present invention is to add a minor amount of citric acid to the biochemical compositions of the present invention to effectively realize a natural and safe biocidal agent in the fire inhibitor biochemical compositions of the present invention, based on a food-grade additive component, namely, citric acid, which functions to control and inhibit the growth of mold, mildew and fugus on the surface coated with the fire inhibiting biochemical composition of the present invention.

In many applications, it will be preferred to use an organic acid, such as citric acid, to provide effective biocidal properties to the biochemical compositions of the present invention, to control and inhibit the growth of mold, mildew and fungus on wood surfaces once they are (i) proactively treated with the biochemical compositions of the present invention, and (ii) later exposed to rain, moisture and natural elements while in storage at lumber yards, and/or on wet damp building construction sites where projects may last for at least 3-6 or more months, before the buildings under construction are closed in and protected from the natural elements.

It is well known that citric acid (CA) also belongs to the family of tricarboxylic acids (TCA) and derivatives, organic compounds containing three carboxylic acid groups (or salt/ester derivatives thereof). Citric acid is a weak organic acid found in citrus fruits. In biochemistry, citric acid is important as an intermediate in the citric acid cycle (i.e. tricarboxylic acid (TCA) cycle), and therefore occurs in the metabolism of almost all living things. The tricarboxylic acid (TCA) cycle is also called the Krebs cycle which functions in the second stage of cellular respiration, a three-stage process by which living cells break down organic fuel molecules in the presence of oxygen to harvest the energy they need to grow and divide and maintain cellular vitality.

Through control of PH and oxidation in the biochemical compositions of the present invention, the citric acid (CA) is used in minor amounts in these biochemical compositions of matter for the purpose of controlling, inhibiting, and preventing the grow of mold, mildew, and fungus without the use of toxic chemical compounds known to pose health effects to humans and animals alike.

### Specification Of Preferred Formulations For Liquid Embodiment of The Fire Inhibiting Biochemical Compositions of Matter According To The Present Invention

FIG. 6A1 illustrates the primary components of an environmentally-clean biochemical wood treatment composition for biochemically treating lignocellulosic wood furnish material and/or polymeric resin binder material during composite wood product manufacturer, comprising: a major amount of a metal alkali salt dissolved in a major amount of water and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F; minor amount of alkali metal salt derived from benzoic acid for inhibiting corrosion of specified metals, wherein the alkali metal is selected from group consisting of potassium, sodium, calcium and magnesium; major amount of water (H2O); a minor amount of metal ion dispersing/coalescing agent derived from a carboxylic acid, such as triethyl citrate, for dispersing metal alkali ions in water when dissolved; and optionally a minor amount of metal alkali salt derived from carboxylic acid for inhibiting mold, mildew and microbial life (e.g. citric acid and cupric citrate).

More specifically, FIG. 6A1 illustrates the primary components of an environmentally-clean biochemical wood treatment composition for fire protection applications of the present invention (i.e. a fire inhibiting solution) consisting of: a major amount of tripotassium citrate (CAS RN 866-84-2); a minor amount of sodium benzoate (CAS RN 532-32-1), and/or potassium benzoate (CAS RN 582-25-2)-metal alkali salt derived from benzoic acid; minor amount of triethyl citrate (CAS RN 77-93-0) functioning as an ion dispersing/coalescing agent; major amount of water (H2O); and a minor amount of alkali metal salt derived from a carboxylic acid for inhibiting, mold, mildew and moisture (e.g. citric acid and cupric citrate).

### Example #1: First Illustrative Embodiment of The Liquid-Based Fire Inhibiting/Retardant Biochemical Composition Of The Present Invention Formulated For Treating Lignocellulosic Wood Furnish During Composite Wood Product Manufacture

FIG. 6A1 illustrates the primary components of a first illustrative embodiment of the environmentally-clean aqueous-based fire retarding liquid biochemical composition of the present invention (i.e. a “mixed ready-to-use” fire retarding solution) consisting of tripotassium citrate (TPC), sodium benzoate (SB), and triethyl citrate (TEC), formulated with a major amount of water functioning as a solvent, carrier, and dispersant in the biochemical fire retardant composition, adapted for treating lignocellulosic wood furnish material during composite wood product manufacture.

Example 1: Schematically illustrated in FIG. 6A1: A fire-inhibiting retarding biochemical composition, in “mixed ready-to-use” form, was produced by stirring the following components into 112.0 [Oz.] (7.13 [Lbs.]) of water of water at 72 F temperature, volumetrically measuring 3258 [ml] or 0.860 [Gal US], to produce a total of 1.0 gallon [US Gal] of finished mixed fire retardant solution:
7.13 [Lbs.]=112.0 [Oz.]=3175.14 [gm] of water as solvent;
3.00 [Lbs.]=48.0 [Oz.]=1360.74 [gm] of tripotassium citrate (TPC) as primary fire retarding agent (i.e. alkali metal salt);
3.00 [Oz.] (85.05 [gm]) of sodium benzoate (SB) as a secondary fire retarding agent and corrosion inhibiting agent; and
2.50 [Oz.] (70.87 [gm]) of triethyl citrate (TEC) ester.
   Total Weight of Components in Fire Retardant Solution: 4691.00 [gm]
   The resultant mixed retardant (finished) solution has a total 1.0 gallon of volume, and total weight equaling approximately 165.50 [Oz.]×1/16 [Lbs./Oz.]=10.34 [lbs.]=4691.00 [gm]. The weights and measures for the Ready-To-Use Fire Retardant Formulation are set forth as follows.

### Weights And Measures: Ready-To-Use Formulation:

$$Major amount of Water : 112. [ Oz . ] ( 7.13 [ Lb . ] ) \times 28.349 [ \text{gm/Oz} . ] = 3175.14 [ gm ] \\ Major amount of Tripotassium Citrate ( TPC ) : 3. [ Lb . ] \times 16. / 1 [ Oz . / Lb . ] = 48. [ Oz . ] \times 28.349 [ \text{gm/Oz} . ] = 1360.74 [ gm ] \\ Minor amount of Sodium Benzoate : 3. [ Oz . ] \times 28.349 [ \text{gm/Oz} . ] = 85.05 [ gm ] \\ Minor amount of Triethyl Citrate ( TEC ) : 2.5 [ Oz . ] \times 28.349 [ \text{gm/Oz} . ] = 70.87 [ gm ] \\ Total Weight of Ingredients ( including TEC ) = 4691. [ gm ] = 10.34 [ Lb . ] = 165.5 [ Oz . ] \\ Final Volume of Mixed Biochemical Fire Retardant ( Finished Product ) = 1. [ Gallon ]$$

### Summary Of Calculated Mass/Weight Percentage % Of Chemical Components Based On Formulation Of Ready-To-Use Liquid Biochemical Fire Retardant Composition

$$The Mass / Weight Percentage \% determined by the weight of the components used to make Ready - to - Use Fire Retardant Formulation are set forth as follows :$$

$$The Mass / Weight Percentage \% of Water : 3175.14 [ gm ] / 4691. [ gm ] = 0.676 \times 100 = > 67.6 \% \\ The Mass / Weight Percentage \% of Tripotassium Citrate : 1360.74 [ gm ] / 4691. [ gm ] = 0.29 \times 100 = > 29. \% \\ The Mass / Weight Percentage \% of Sodium Benzoate : 85.047 [ gm ] / 4691. [ gm ] = 0.0181 \times 100 = > 1.81 \% \\ The Mass / Weight Percentage \% of Triethyl Citrate : 70.85 [ gm ] / 4691. [ gm ] = 0.0151 \times 100 = > 1.51 \% \\ The Mass / Weight Percentage of the Formulation : 100 \%$$

### Example #2: Second Illustrative Embodiment of The Liquid-Based Fire Inhibiting/Retardant Biochemical Composition Of The Present Invention Formulated For Treating Lignocellulosic Wood Furnish During Composite Wood Product Manufacture

FIG. 6A1 illustrates the primary components of a second illustrative embodiment of the environmentally-clean aqueous-based fire retarding liquid biochemical composition of the present invention (i.e. a “mixed ready-to-use” fire retarding solution) consisting of tripotassium citrate (TPC), sodium benzoate (SB) and triethyl citrate (TEC), formulated with a major amount of water functioning as a solvent, carrier, and dispersant in the biochemical fire retardant composition.

Example 2: Schematically illustrated in FIG. 6A1: A fire-inhibiting retarding biochemical composition, in “mixed ready-to-use” form, was produced by stirring the following components into water of water at 72 F temperature, volumetrically measuring to produce approximately a total of 1.0 gallon [US Gal] of finished mixed retardant solution:

$$Major amount of Water : 112. [ Oz . ] ( 7.13 [ Lb . ] ) \times 28.349 [ \text{gm/Oz} . ] = 3175.14 [ gm ] \\ Major amount of Tripotassium Citrate ( TPC ) : 3. [ Lb . ] \times 16. / 1 [ Oz . / Lb . ] = 48. [ Oz . ] \times 28.349 [ \text{gm/Oz} . ] = 1360.74 [ gm ] \\ Minor amount of Sodium Benzoate : 3. [ Oz . ] \times 28.349 [ \text{gm/Oz} . ] = 85.05 [ gm ] \\ Minor amount of Triethyl Citrate ( TEC ) : 2.5 [ Oz . ] \times 28.349 [ \text{gm/Oz} . ] = 70.87 [ gm ] \\ Minor amount of Citric Acid ( for Mold / Mildew Inhibition ) : 3. [ Oz . ] \times 28.349 [ gm / Oz . ] = 85.05 [ gm ] \\ Total Weight of Ingredients ( including TEC ) = 4776.05 [ gm ] = 10.53 [ Lb . ] = 168.48 [ Oz . ]$$

### Summary Of Calculated Mass/Weight Percentage % Of Chemical Components Based On Formulation Of Ready-To-Use Liquid Biochemical Fire Retardant

The Mass/Weight Percentage % determined by the weight of the components used to make Ready-to-Use Fire Retardant Formulation are set forth as follows:

$$The Mass / Weight Percentage \% of Water : 3175.14 [ gm ] / 4776.05 [ gm ] = 0.6648 \times 100 = > 66.48 \% \\ The Mass / Weight Percentage \% of Tripotassium Citrate : 1360.74 [ gm ] / 4776.05 [ gm ] = 0.2848 \times 100 = > 28.48 \% \\ The Mass / Weight Percentage \% of Sodium Benzoate : 85.047 [ gm ] / 4776.05 [ gm ] = 0.0178 \times 100 = > 1.78 \% \\ The Mass / Weight Percentage \% of Triethyl Citrate : 70.85 [ gm ] / 4776.05 [ gm ] = 0.01483 \times 100 = > 1.48 \% \\ The Mass / Weight Percentage \% of Citric Acid : 85.047 [ gm ] / 4776.05 [ gm ] = 0.0178 \times 100 = > 1.78 \% \\ The Mass / Weight Percentage of the Formulation approximately : 100 \%$$

### Example #3: Producing A Biochemically-Treating PDMI Polymeric Resin Binder Material Using A Dry Powder-Based Fire Retarding Biochemical Composition During Composite Wood Product Manufacture

FIG. 6B1 illustrates the primary components of a dry-powder fire retarding biochemical composition of the present invention as illustrated in FIG. 6B1, comprising: tripotassium citrate (TPC) dry powder, and sodium benzoate (SB) dry powder, for mixing with a predetermined quantity of PDMI polymeric resin binder, so as to produce a predetermined amount of biochemically fire/corrosion-resistance treated polymeric resin binder material as illustrated in FIG. 6B3, for use in manufacturing composite wood (i.e. OSB) products.

Example 3: Schematically Illustrated in FIG. 6B3, a biochemically fire/corrosion-resistance treated polymeric resin binder material is produced by blending the following components with pDMI polymeric resin binder, in amounts proportional to the formulation set forth below, comprising:

$$Major amount of pDMI polymeric resin binder : \\ 110. [ Oz . ] ( 6.87 [ Lb . ] ) \times 28.349 [ \text{gm/Oz} . ] = 3118.44 [ gm ] \\ Major amount of Tripotassium Citrate ( TPC ) : 2. [ Lb . ] \times 16. / 1 [ Oz . / Lb . ] = 32. [ Oz . ] \times 28.349 [ \text{gm/Oz} . ] = 907.17 [ gm ] \\ Minor amount of Sodium Benzoate : 3. [ Oz . ] \times 28.349 [ \text{gm/Oz} . ] = 85.05 [ gm ] \\ Total Weight of Ingredients = 4110.66 [ gm ] = 10.06 [ Lb . ] = 160.96 [ Oz . ]$$

Summary Of Calculated Mass/Weight Percentage % Of Chemical Components Based On Formulation For Producing Biochemically-Treated Fire Retardant pDMI Resin Binder Material According To the Present Invention

The Mass/Weight Percentage % determined by the weight of the components used to make biochemically-treated fire-retardant pDMI resin binder using the formulation set forth above:

$$The Mass / Weight Percentage \% of pDMI polymeric resin binder : \\ 3118.44 [ gm ] / 4110.66 [ gm ] = 0.7586 \times 100 = > 75.86 \% \\ The Mass / Weight Percentage \% of Tripotassium Citrate : 907.17 [ gm ] / 4110.66 [ gm ] = 0.2206 \times 100 = > 22.06 \% \\ The Mass / Weight Percentage \% of Sodium Benzoate : 85.047 [ gm ] / 4110.66 [ gm ] = 0.0206 \times 100 = > 2.06 \% \\ Total Mass / Weight Percentage of the Formulation approximately : 100 \%$$

### Example #4: Producing A Biochemically-Treating PDMI Polymeric Resin Binder Material Using A Fire Retarding Biochemical Composition of The Present Invention During Composite Wood Product Manufacture

FIG. 6B4 illustrates the primary components of a fire retarding biochemical composition of the present invention as illustrated in FIG. 6B2, comprising: (i) a minor amount of tripotassium citrate (TPC) dry powder as a fire inhibiting agent, (ii) a minor amount of sodium benzoate (SB) dry powder as a metal corrosion inhibiting agent, and (iii) a minor amount of water as a catalyst/reactant, for mixing and blending with (iv) a major amount of PDMI polymeric resin binder material so to produce a predetermined amount of biochemically fire/corrosion-resistance treated polymeric resin binder material as shown in FIG. 6B4, suitable for use during composite wood (i.e. OSB) product manufacture.

Example 4: As illustrated in FIG. 6B4, a biochemically-treated pDMI polymeric resin binder material is produced by blending the following components in amounts proportional to the formulation set forth below, comprising:

$$Major amount of pDMI polymeric resin binder : \\ 110. [ Oz . ] ( 6.87 [ Lb . ] ) \times 28.349 [ \text{gm/Oz} . ] = 3118.44 [ gm ] \\ Major amount of Tripotassium Citrate ( TPC ) : 2. [ Lb . ] \times 16. / 1 [ Oz . / Lb . ] = 32. [ Oz . ] \times 28.349 [ \text{gm/Oz} . ] = 907.17 [ gm ] \\ Minor amount of Sodium Benzoate : 3. [ Oz . ] \times 28.349 [ \text{gm/Oz} . ] = 85.05 [ gm ] \\ Minor amount of Water : 3. [ Oz . ] \times 28.349 [ \text{gm/Oz} . ] = 85.05 [ gm ] \\ Total Weight of Ingredients = 4649.28 [ gm ] = 10.25 [ Lb . ] = 164. [ Oz . ]$$

Summary Of Calculated Mass/Weight Percentage % Of Chemical Components Based On Formulation For Producing A Biochemically-Treated Fire Retardant pDMI Resin Binder Material According to the Present Invention

The Mass/Weight Percentage % determined by the weight of the components used to make biochemically-treated fire-retardant pDMI resin binder using the formulation set forth above:

$$The Mass / Weight Percentage \% of pDMI polymeric resin binder : \\ 3118.44 [ gm ] / 4110.66 [ gm ] = 0.7586 \times 100 = > 75.86 \% \\ The Mass / Weight Percentage \% of Tripotassium Citrate : 1360.74 [ gm ] / 4649.28 [ gm ] = 0.2926 \times 100 = > 29.26 \% \\ The Mass / Weight Percentage \% of Sodium Benzoate : 85.047 [ gm ] / 4649.28 [ gm ] = 0.0183 \times 100 = > 1.83 \% \\ The Mass / Weight Percentage \% of Water : 85.047 [ gm ] / 4649.28 [ gm ] = 0.0183 \times 100 = > 1.83 \% \\ Total Mass / Weight Percentage of the Formulation approximately : 100 \%$$

### Methods Of Blending, Making And Producing The Biochemical Liquid Formulations

The fire inhibiting biochemical compositions illustrated in FIGS. 6A, 6A1, 6A2, 6B1, 6B2, 6B3 and 6B4 are reproducible by mixing the components described above. The order of mixing is discretionary. However, it is advantageous to produce aqueous preparations by mixing the components other than water, into the quantity of water.

### Preferred Weights Percentages Of The Components Of The Aqueous-Based Fire Inhibiting Biochemical Composition Of The Present Invention, Formulated For Treating Lignocellulosic-Based Wood Furnish Materials During Composite Wood Product Manufacture

In the aqueous-based biochemical compositions of the present invention formulated for treating lignocellulosic-based wood furnish materials during composite wood product manufacture, a preferred biochemical composition comprises: a major amount of at least one alkali metal salt of a nonpolymeric saturated carboxylic acid (e.g. tripotassium citrate monohydrate or TPC), from 1% to 75% by weight, preferably from 20% to 60% by weight and more preferably from 30% to 55% by weight; a major amount of water content, typically not less than 30% by weight, preferably not less than 40% by weight, more preferably not less than 50% by weight and most preferably not less than 60% by weight and preferably not more than 80% by weight and more preferably not more than 90% by weight; and a minor amount of triethyl citrate (an ester of citric acid), from 0.08% to 5% by weight, preferably from 0.5% to 2% by weight and more preferably from 0.1% to 1.0% by weight; wherein the sum by % weight of the components (a) and (b) should not exceed 100% by weight.

In such aqueous-based biochemical compositions of the present invention, the ratio of the ester of citric acid (e.g. triethyl citrate) to the alkali metal salt of a nonpolymeric saturated carboxylic acid (e.g. tripotassium citrate) may be a minor amount between 1:100: to 1:1000 and is typically in the range from 1:1 to 1:100, preferably in the range from 1:2 to 1:50, more preferably in the range from 1:4 to 1:25.

### Preferred Weights Percentages Of The Components Of The Dry Powder-Based Fire Inhibiting Biochemical Composition Of The Present Invention, Formulated For Treating Polymeric Resin Binder Materials During Composite Wood Product Manufacture

In the dry-powder biochemical compositions of the present invention formulated for treating polymeric resin binder materials, preferably PDMI polymeric resin binder material, during composite wood product manufacture, a preferred biochemical composition comprises: a major amount of at least one alkali metal salt of a nonpolymeric saturated carboxylic acid (e.g. tripotassium citrate monohydrate or TPC), from 1% to 95% by weight, preferably from 20% to 90% by weight and more preferably from 65% to 85% by weight; and a minor amount of potassium benzoate, calcium benzoate, sodium benzoate and/or magnesium benzoate, from 1.0% to 15% by weight, preferably from 1.5% to 10% by weight and more preferably from 2.0% to 8.0% by weight; wherein the sum by % weight of the components should not exceed 100% by weight.

### Preferred Weights Percentages Of The Components Of The Fire Inhibiting Biochemical Composition Of The Present Invention, Formulated For Treating Polymeric Resin Binder Furnish Materials During Composite Wood Product Manufacture

In the biochemical compositions of the present invention formulated for treating polymeric resin binder materials, preferably PDMI polymeric resin binder material, during composite wood product manufacture, a preferred biochemical composition comprises: a major amount of at least one alkali metal salt of a nonpolymeric saturated carboxylic acid (e.g. tripotassium citrate monohydrate or TPC), from 1% to 95% by weight, preferably from 20% to 85% by weight and more preferably from 65% to 85% by weight; a minor amount of potassium benzoate, calcium benzoate, sodium benzoate and/or magnesium benzoate, from 1.0% to 15% by weight, preferably from 1.5% to 10% by weight and more preferably from 2.0% to 8.0% by weight; and a minor amount of water content as catalyst/reactant, typically not less than 0.5% by weight, preferably not less than 1.0% by weight, more preferably not less than 1.5% by weight and most preferably not less than 2.0% by weight and preferably not more than 10% by weight and more preferably not more than 15% by weight); wherein the sum by % weight of the components should not exceed 100% by weight.

Specification of Various Species of Environmentally-Clean Aqueous-Based Liquid Fire Inhibitor Solutions Containing Dissolved Alkali Metal Salts Derived from Different Kinds of Non-Polymerized Saturated Carboxylic Acids Having Carbon-Atom Chain Lengths Less Than Eight (8)

Hereinbelow methods will be described how to formulate and produce various species of environmentally-clean aqueous-based liquid fire inhibitor solutions in accordance with the principles of the present invention, wherein each liquid solution contains dissolved alkali metal salts derived from different kinds of non-polymerized saturated carboxylic acids having carbon-atom chain lengths less than eight (8), which contribute solubility of alkali metal ions in water, as an essential requirement of the present invention.

When sprayed onto combustible surfaces, the new and improved liquid fire inhibitor solution forms thin fire inhibiting alkali metal salt crystalline coatings, produced from alkali metal salts derived from a carboxylic acid (R—COOH) selected from the group consisting of: formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

A wide variety of alkali metal salts are produced from these nonpolymeric saturated carboxylic acids for inclusion in the biochemical composition, including, but not limited to: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Referring to FIGS. 6C1 through 6V2, chemical model illustrations disclosed for the carboxylic acids, alkali metal salts and esters, and liquid (aqueous-based) fire inhibiting biochemical solutions of the present invention formulated therewith, are captured, and described under the generic chemical model shown in FIGS. 6 and 6A1 and 6A2.

The chemical model illustrations for the carboxylic acids, alkali metal salts, and dry powder fire inhibiting biochemical compositions of the present invention formulated therewith, are captured, and described under the generic chemical model shown in FIGS. 6 and 6B1 and 6B2. The details of each formulated species of liquid fire inhibitor solution of the present invention, and its underlying carboxylic acid and alkali metal salt(s) will be specified in great technical detail below.

For purposes of simplicity and clarity, the species of liquid fire inhibitor formulation are organized and classified according to the Carbon Atom Chain Length (Ci) of the underlying Non-Polymerized Saturated Carboxylic Acid, from which the corresponding alkali metal salts and ester are derived.

Specification Of New And Improved Environmentally-Clean Biochemical Wood Treatment Composition For Forming Fire Inhibiting Alkali Metal Salt Structures In Combustible Lignocellulosic Materials, And Produced From Alkali Metal Salts Derived From The C1 Carboxylic Acid (R—COOH), Called Formic Acid (i.e. Methanoic Acid)

In FIGS. 6C1, 6C2, 6C3 and 6C4, schematic chemical models are provided for making liquid fire inhibitor solutions containing alkali metal salts derived from a C1 Class of Carboxylic Acid having 1 carbon atom, specifically, the C1 carboxylic acid (R—COOH) called formic acid (i.e. methanoic acid), CH₂O₂ (CAS RN: 4-18-6). The exemplary alkali metal salts derived from this C1 Class of Carboxylic Acid are: potassium formate CHKO2; calcium formate Ca (HCO2) 2; sodium formate HCOONa; and magnesium formate (dihydrate) Mg (HCO2) 2. As shown in FIGS. 6C1 through 6C4, an exemplary ester of formic acid is methyl formate characterized by chemical formula C₃H₆O₂ and CAS RN: 107-31-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C1 Class of Carboxylic Acid.

FIG. 6C1 illustrates the primary components of an environmentally-clean aqueous-based fire inhibiting liquid biochemical composition of the present invention derived from the C1-Class of saturated non-polymerized carboxylic acid called formic acid, consisting of: (i) a major amount of potassium formate (CAS RN: 590-29-4), (ii) a minor amount of methyl formate (CAS RN: 107-31-3) or triethyl citrate (TEC) (CAS RN: 77-93-0) formulated with and dissolved in (iii) a major amount of water functioning as a solvent, carrier and dispersant to produce an environmentally-clean aqueous-based fire inhibiting liquid biochemical solution based on the C1-class of carboxylic acid-formic acid; and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, metal corrosion of mounted fasteners, and decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6C2 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of calcium formate (CAS RN: 107-31-3), and (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-formic acid; and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, metal corrosion of mounted fasteners, and decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6C3 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of sodium formate (CAS RN: 141-53-7), and (ii) minor amounts of methyl formate or triethyl citrate (TEC) formulated with and dissolved in (iii) major amount of water functioning as a solvent, carrier and dispersant to produce an environmentally-clean aqueous-based fire inhibiting liquid biochemical solution based on the C1-class of carboxylic acid-formic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame

FIG. 6C4 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of magnesium formate (CAS RN: 557-39-1/6150-82-9 (dihydrate)), and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-formic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium formate, calcium formate, sodium formate, or magnesium formate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least (e.g. potassium formate, calcium formate, sodium formate, or magnesium formate) one alkali metal salt of a nonpolymeric saturated carboxylic acid (e.g. potassium formate) in a major amount from 1% to 75% by weight, preferably from 20% to 60% by weight and more preferably from 35% to 55% by weight;
an ester of saturated non-polymerized carboxylic acid (e.g. ester of formic acid, namely methyl formate, or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

### Specification Of New And Improved Environmentally-Clean Biochemical Wood Treatment Compositions For Forming Fire Inhibiting Alkali Metal Salt Structures In

Combustible Lignocellulosic Materials, And Produced From Alkali Metal Salts Derived From The C1 Carboxylic Acid (R—COOH), Called Carbonic Acid (i.e. Hydroxymethanoic Acid)

In FIGS. 6D1 and 6D2, schematic chemical models are provided for making liquid fire inhibitor solutions containing alkali metal salts derived from a C1 Class of Carboxylic Acid having 1 carbon atom, specifically, the C1 carboxylic acid (R—COOH) called carbonic acid, (i.e. hydroxymethanoic acid), CH₂O₃ (CAS RN: 463-79-6). The exemplary alkali metal salts derived from this C1 Class Carboxylic Acid are: potassium carbonate K₂CO₃; sodium carbonate Na₂CO₃; and magnesium carbonate MgCO₃.

As shown in FIGS. 6D1 and 6D2, the ester of citric acid called triethyl citrate, can be used as a dispersing/coalescing agent with the alkali metal salt dissolved in water, to produce these aqueous-based liquid fire inhibiting solutions of the present invention, based on the above-referenced C1 Class of Carboxylic Acid.

FIG. 6D1 illustrates the primary components of an environmentally-clean aqueous-based fire inhibiting liquid biochemical composition of the present invention derived from the C1 Class of saturated non-polymerized carboxylic acid called carbonic acid, consisting of: (i) a major amount of potassium carbonate (CAS RN: 584-08-7/6381-79-9 sesquihydrate) and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-carbonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6D2 illustrates the primary components of an environmentally-clean aqueous-based fire inhibiting liquid biochemical composition of the present invention derived from the C1-Class of saturated non-polymerized carboxylic acid called carbonic acid, consisting of: (i) a major amount of sodium carbonate (CAS RNs: 497-19-8/5968-11-6 monohydrate/6132 Feb. 1 decahydrate), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-carbonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium carbonate, calcium carbonate, sodium carbonate, or magnesium carbonate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium carbonate, calcium carbonate, sodium carbonate, or magnesium carbonate) of a nonpolymeric saturated carboxylic acid (e.g. potassium formate) in a major amount from 1% to 75% by weight, preferably from 20% to 60% by weight and more preferably from 35% to 55% by weight;
an ester of saturated non-polymerized carboxylic acid (e.g. ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C2 Carboxylic Acid (R—COOH), Called Acetic Acid (i.e. Ethanoic Acid)

In FIGS. 6E1, 6E2, 6E3, and 6E4, schematic chemical models are provided for making liquid fire inhibitor solutions containing alkali metal salts derived from a C2 Class of Carboxylic Acid having two (2) carbon atoms, specifically, the C2 carboxylic acid (R—COOH) called acetic acid, C4H₈O₂ (CAS RN: 64-19-7) The exemplary alkali metal salts derived from this C2 Class of Carboxylic Acid are: potassium acetate C₂H₃KO₂; calcium acetate C₄H₆CaO₄; sodium acetate C₂H₃NaO₂; and magnesium acetate Mg(CH₃COO)₂.

As shown in FIGS. 6E1 through 6E4, an exemplary ester of acetic acid (i.e. ethyl acetate or ethyl ethanoate) is characterized by chemical formula C4H₈O₂ and CAS RN: 141-78-6. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6E1 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of potassium acetate (CAS RN: 127-08-2), and (ii) a minor amount of ethyl acetate (ethyl ethanoate) C4H₈O₂ (CAS RN: 141-78-6) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-acetic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6E2 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of calcium acetate (CAS RN: 62-54-4/5743-26-0 monohydrate), and (ii) a minor amount of ethyl acetate (CAS RN: 1191-16-8) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-acetic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6E3 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of sodium acetate (CAS RN: 127-09-3), and (ii) a minor amount of ethyl acetate (CAS RN: 141-78-6) or triethyl citrate (TEC) formulated with and dissolved in (iii) a major amount of water functioning as a solvent, carrier and dispersant to produce an environmentally-clean aqueous-based fire inhibiting liquid biochemical solution based on the C12-class of carboxylic acid-acetic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6E4 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of magnesium acetate (CAS RN: 142-72-3), and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-acetic acid.; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium acetate, calcium acetate, sodium acetate, or magnesium acetate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium acetate, calcium acetate, sodium acetate, or magnesium acetate) of a nonpolymeric saturated carboxylic acid (e.g. potassium formate) in a major amount from 1% to 75% by weight, preferably from 20% to 60% by weight and more preferably from 35% to 55% by weight;
an ester of saturated non-polymerized carboxylic acid (e.g. ester of acetic acid, namely ethyl acetate or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C2 Carboxylic Acid (R—COOH), Called Glycolic Acid (i.e. Hydroxyacetic Acid)

In FIGS. 6F1, 6F2, 6F3 and 6F4, schematic chemical models are provided for making liquid fire inhibitor solutions containing alkali metal salts derived from a C2 Class of Carboxylic Acid having two carbon atoms, specifically, the C2 carboxylic acid (R—COOH) called glycolic acid (hydroxyacetic acid), C₂H₄O₃ (CAS RN: 79-14-1). The exemplary alkali metal salts derived from this C2 Class of Carboxylic Acid are: potassium glycolate C₂H3KO₃; calcium glycolate C4H₆CaO₆; and sodium glycolate C₂H₃NaO₃.

As shown in FIGS. 6F1 through 6F4, an exemplary ester of glycolic acid is ethyl glycolate characterized by chemical formula C4H₈O₃ and CAS RN: 623-50-7. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6F1 illustrates the primary components of an environmentally-clean aqueous-based fire inhibiting liquid biochemical composition of the present invention derived from the C2-Class of saturated non-polymerized carboxylic acid called glycolic acid, consisting of (i) a major amount of potassium glycolate (CAS RN: 1932-50-9), and (ii) a minor amount of ethyl glycolate (CAS RN: 623-50-7) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-glycolic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6F2 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of calcium glycolate (CAS RN: 996-23-6), and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-glycolic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6F3 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of sodium glycolate (CAS RN: 2836-32-0), and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-glycolic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium glycolate, calcium glycolate, sodium glycolate or magnesium glycolate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium glycolate, calcium glycolate, sodium glycolate, or magnesium glycolate) of a nonpolymeric saturated carboxylic acid (e.g. glycolic acid) in a major amount from 1% to 75% by weight, preferably from 20% to 60% by weight and more preferably from 35% to 55% by weight;
an ester of saturated non-polymerized carboxylic acid (e.g. ester of glycolic acid, namely ethyl glycolate or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C2 Carboxylic Acid (R—COOH), Called Glyoxylic Acid

In FIGS. 6G1, 6G2, 6G3 and 6G4, schematic chemical models are provided for making liquid fire inhibitor solutions containing alkali metal salts derived from a C2 Class of Carboxylic Acid having two (2) carbon atoms, specifically, the C2 carboxylic acid (R—COOH) called glyoxylic acid (i.e. oxoacetic acid), C₂H2O₃ (CAS RN: 298-12-4). The exemplary alkali metal salts derived from this C2 Class of Carboxylic Acid are: potassium glyoxylate C₂H₃KO₃; calcium glyoxylate C4H₂CaO₆; and sodium glyoxylate (monohydrate) C₂HNaO₃.

As shown in FIGS. 6G1 through 6G4, an exemplary ester of glyoxylic acid is ethyl glyoxylate, and characterized by chemical formula C4H₆O₃ and CAS RN: 924-44-7. Because esters of glyoxylic acid are immiscible with water, the preferred alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6G1 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of potassium glyoxylate (Compound CID: 23669142/CAS RN 1932-50-9), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-glyoxylic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6G2 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of calcium glyoxylate (CAS RN 2990-19-4), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-glyoxylic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6G3 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of sodium glyoxylate (CAS RN 2706-75-4), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium glyoxylate, calcium glyoxylate, sodium glyoxylate, or magnesium glyoxylate);
2.5 [Oz.] (by weight) of an ester of saturated non-polymerized carboxylic acid (e.g. ester of glyoxylic acid, namely ethyl glyoxylate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium glyoxylate, calcium glyoxylate, sodium glyoxylate, or magnesium glyoxylate) of a nonpolymeric saturated carboxylic acid (e.g. glyoxylic acid) in a major amount from 1% to 75% by weight, preferably from 20% to 60% by weight and more preferably from 35% to 55% by weight;
an ester of saturated non-polymerized carboxylic acid (e.g. ester of glyoxylic acid, namely ethyl glyoxylate, or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C2 Carboxylic Acid (R—COOH), Called Oxalic Acid

In FIGS. 6H1, 6H2, 6H3 and 6H4, schematic chemical models are provided for making liquid fire inhibitor solutions containing alkali metal salts derived from a C2 Class of Carboxylic Acid having 2 carbon atoms, specifically, the C2 Carboxylic Acid (R—COOH) called oxalic acid, with molecular formula H₂C₂O₄ and CAS RN: 144-62-7 anhydrous/6153-56-6 dihydrate. The exemplary alkali metal salts derived from this C2 Class of Carboxylic Acid are: potassium oxalate C₂H2K₂O₅; calcium oxalate monohydrate CaC₂O₄; and (di) sodium oxalate (monohydrate) Na₂C₂O₄.

As shown in FIGS. 6H1 through 6H4, an exemplary ester of oxalic acid, dimethyl oxalate, is characterized by chemical formula: C4H₆O₄ and CAS RN: 553-90-2. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6H1 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of potassium oxalate monohydrate (CAS RN: 6487-48-5), and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-oxalic acid. Once the biochemical solution is produced according to the principles of the present invention, and applied to treat lignocellulosic-based wood furnish material, water molecules in the biochemical solution begin to evaporate, potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6H2 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of calcium oxalate monohydrate (CAS RN: 5794-28-5 monohydrate), and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-oxalic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or potassium salt crystalline structures forming in the treated material, and/or calcium salt crystalline coatings forming on the surfaces of treated material, thereby providing calcium ions available to protect against fire ignition, flame spread and smoke development.

FIG. 6H3 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of sodium oxalate (CAS RN: 62-76-0), and (ii) a minor amount of dimethyl oxalate (CAS RN: 553-90-2) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid-oxalic; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium oxalate, calcium oxalate, sodium oxalate, or magnesium oxalate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium oxolate, calcium oxolate, sodium oxolate, or magnesium oxolate) of a nonpolymeric saturated carboxylic acid (e.g. oxolic acid) in a major amount from 1% to 75% by weight, preferably from 20% to 60% by weight and more preferably from 35% to 55% by weight;
an ester of saturated non-polymerized carboxylic acid (e.g. ester of oxalic acid, namely dimethyl oxalate or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C3 Carboxylic Acid (R—COOH), Called Propionic Acid

In FIGS. 611, 612, 613 and 614, schematic chemical models are provided for making liquid fire inhibitor solutions containing alkali metal salts derived from a C1 Class of Carboxylic Acid having 3 carbon atoms, specifically, the C3 carboxylic acid (R—COOH) called propionic acid (i.e. propanoic acid, or ethanecarboxylic acid), C₃H₆O₂ with CAS RN: 79-09-04. The exemplary alkali metal salts derived from this C2 Class of Carboxylic Acid are: potassium propionate C₃H₅KO; calcium propionate C₆H₁₀CaO₄; sodium propionate C₃H₅NaO₂; and magnesium propionate C₆H₁₀MgO₄.

As shown in FIGS. 6I1 through 614, an exemplary ester of propionic acid is ethyl propionate characterized by chemical formula C₅H₁₀O₂ and CAS RN: 105-37-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 611 illustrates the primary components of an environmentally-clean aqueous-based fire inhibiting liquid biochemical composition of the present invention derived from the C3-Class of saturated non-polymerized carboxylic acid called propionic acid, consisting of: (i) a major amount of potassium propionate (CAS RN: 327-62-8), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-propionic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 612 illustrates the primary components of an environmentally-clean aqueous-based fire inhibiting liquid biochemical composition of the present invention derived from the C3-Class of saturated non-polymerized carboxylic acid called propionic acid, consisting of: (i) a major amount of calcium propionate (CAS RN: 4075-81-4), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-propionic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 613 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of sodium propionate (CAS RN: 137-40-6), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-propionic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6I4 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of magnesium propionate (CAS RN: 105-37-), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-propionic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium propionate, calcium propionate, sodium propionate, or magnesium propionate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium propionate, calcium propionate, sodium propionate, or magnesium propionate) of a nonpolymeric saturated carboxylic acid (e.g. propionic acid in a major amount from 1% to 75% by weight, preferably from 20% to 60% by weight and more preferably from 35% to 55% by weight;
an ester of saturated non-polymerized carboxylic acid (e.g. ester of propionic acid, namely ethyl propionate or ester of citric acid, namely triethyl citrate) in a minor amount from 0.08% to 5% by weight, preferably from 0.5% to 2% by weight and more preferably from 0.1% to 1.0% by weight;
potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C3 Carboxylic Acid (R—COOH), Called Lactic Acid

In FIGS. 6J1, 6J2, 6J3 and 6J4, schematic chemical models are provided for making environmentally-clean liquid fire inhibiting biochemical solutions containing alkali metal salts derived from a C3 Class of Carboxylic Acid having 3 carbon atoms, specifically, the C3 carboxylic acid (R—COOH) called lactic acid, having a molecular formula C₃H₆O₃ with CAS RNs: 50-21-5/79-33-4 (L)/10326-41-7 (D), and being miscible in water. The exemplary alkali metal salts derived from this C3 Class of Carboxylic Acid are: potassium lactate C₃H₅KO₃; calcium lactate C₆H₁₀CaO₆; sodium lactate C₃H₅NaO₃; and magnesium lactate C₆H₁₀MgO₆.

As shown in FIGS. 6J1 through 6J4, an exemplary ester of lactic acid is ethyl lactate characterized by chemical formula C₅H₁₀O₃ and CAS RN: CAS RN: 97-64-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6J1 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of potassium lactate (CAS RN: 996-31-6/85895-78-9 (S)), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-lactic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6J2 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of calcium lactate (CAS RN: 814-80-2), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-lactic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6J3 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of sodium lactate (CAS RN: 72-17-3), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-lactic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6J4 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of magnesium lactate (CAS RN: 18917-93-6), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-lactic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium lactate, calcium lactate, sodium lactate, or magnesium lactate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium lactate, calcium lactate, sodium lactate, or magnesium lactate of a nonpolymeric saturated carboxylic acid (e.g. lactic acid) in a major amount from 1% to 75% by weight, preferably from 20% to 60% by weight and more preferably from 35% to 55% by weight;
an ester of saturated non-polymerized carboxylic acid (e.g. ester of lactic acid, namely ethyl lactate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C3 Carboxylic Acid (R—COOH), Called Glyceric Acid

In FIGS. 6K1, 6K₂, 6K₃ and 6K4, schematic chemical models are provided for making liquid fire inhibitor solutions containing alkali metal salts derived from a C3 Class of Carboxylic Acid having 3 carbon atoms, specifically, the C3 carboxylic acid (R—COOH) called glyceric acid, having a molecular formula C₃H₆O₄ and CAS RNs: 473-81-4/6000-40-4 D-glyceric acid/28305-26-2-L-glyceric acid. The exemplary alkali metal salts derived from this C3-Class of Carboxylic Acid are: potassium glycerate C₃H₅KO₄; calcium glycerate C₆H₁₀CaO₈; and sodium glycerate C₃H₅NaO₄.

As shown in FIGS. 6K1 through 6K4, an exemplary ester of glyceric acid is ethyl glycerate characterized by chemical formula C₅H₁₀O₄ and CAS RN: 615-51-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6K1 illustrating the primary components of an environmentally-clean aqueous-based fire inhibiting liquid biochemical composition of the present invention derived from the C3-Class of saturated non-polymerized carboxylic acid called glyceric acid, consisting of: (i) a major amount of potassium glycerate (CAS RN: 43110-90-3), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-glyceric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6K₂ illustrates the primary components of an environmentally-clean aqueous-based fire inhibiting liquid biochemical composition of the present invention derived from the C3-Class of saturated non-polymerized carboxylic acid called glyceric acid, consisting of: (i) a major amount of calcium glycerate (CAS RN: 65644-56-6), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-glyceric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6K₃ illustrates the primary components of an environmentally-clean aqueous-based fire inhibiting liquid biochemical composition of the present invention derived from the C3-Class of saturated non-polymerized carboxylic acid called glyceric acid, consisting of: (i) a major amount of sodium glycerate (CAS RN: 383=86-8), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-glyceric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium glycerate, calcium glycerate, sodium glycerate, or magnesium glycerate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium glycerate, calcium glycerate, sodium glycerate, or magnesium glycerate) of a nonpolymeric saturated carboxylic acid (e.g. glyceric acid) in a major amount from 1% to 75% by weight, preferably from 20% to 60% by weight and more preferably from 35% to 55% by weight;
an ester of saturated non-polymerized carboxylic acid (e.g. ester of glyceric acid, namely ethyl glycerate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C3 Carboxylic Acid (R—COOH), Called Pyruvic Acid

In FIGS. 6L1, 6L2, 6L3 AND 6L4, schematic chemical models are provided for making liquid fire inhibitor solutions containing alkali metal salts derived from a C3 Class of Carboxylic Acid having 3 carbon atoms, specifically, the C3 carboxylic acid (R—COOH) called pyruvic acid, (i.e. 2-oxopropanoic acid) having the molecular formula C₃H₄O₃ and CAS RN: 127-17-3, a smell similar to that of acetic acid, and miscible with water. The exemplary alkali metal salts derived from this C3 Class of Carboxylic Acid are: potassium pyruvate C₃H₃KO₃; calcium pyruvate C₃H₆CaO₃; sodium pyruvate C₃H₃NaO₃; and magnesium pyruvate C₆H₆MgO₆.

As shown in FIGS. 6L1 through 6L4, an exemplary ester of pyruvic acid is ethyl pyruvate characterized by chemical formula C₅H₈O₃ and CAS RN: 617-35-6, and water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3-Class of Carboxylic Acid.

FIG. 6L 1 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of potassium pyruvate (CAS RN: 4151-33-1), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-Class of carboxylic acid-pyruvic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6L2 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of calcium pyruvate (CAS RN: 52009-14-0), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-pyruvic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6L3 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of sodium pyruvate (CAS RN: 113-24-6), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-pyruvic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6L4 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of: (i) a major amount of magnesium pyruvate (CAS RN: 81686-75-1), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-pyruvic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium pyruvate, calcium pyruvate, sodium pyruvate, or magnesium pyruvate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium pyruvate, calcium pyruvate, sodium pyruvate, or magnesium pyruvate) of a nonpolymeric saturated carboxylic acid (e.g. pyruvic acid) in a major amount from 1% to 75% by weight, preferably from 20% to 60% by weight and more preferably from 35% to 55% by weight;
an ester of saturated non-polymerized carboxylic acid (e.g. ester of pyruvic acid, namely ethyl pyruvate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C3 Carboxylic Acid (R—COOH), Called Tartaric Acid

In FIGS. 6M1, 6M3, 6M3 and 6M4, schematic chemical models are provided for making liquid fire inhibitor solutions containing alkali metal salts derived from a C3 Class of Carboxylic Acid having 3 carbon atoms, specifically, the C3 carboxylic acid (R—COOH) called tartaric acid having a molecular formula C₄H₆O₆ and CAS RNs: 87-89-4 R, R isomer/S,S isomer 147-71-7/racemic 133-37-9/meso-isomer 147/73-9, and soluble in water. The exemplary alkali metal salts derived from this C3 Class of Carboxylic Acid are: potassium tartrate (potassium bitartrate) C₄H₄K₂O₆; calcium tartrate CaC₄H₄O₆, sodium tartrate C₄; and magnesium tartrate C₄H₄MgO₆. As shown in FIGS. 6M1 through 6M4, an exemplary ester of tartaric acid is diethyl tartrate (DET) characterized by chemical formula C₈H₁₄O₆ and CAS RN: 408332-88-7). This ester (i.e. group of stereo-isomers), and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6M1 illustrates the primary components of an environmentally-clean aqueous-based fire inhibiting liquid biochemical composition of the present invention derived from the C3-Class of saturated non-polymerized carboxylic acid called tartaric acid, consisting of (i) a major amount of potassium tartrate (CAS RN: 589-39-1), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-tartaric; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6M2 illustrates the primary components of an environmentally-clean aqueous-based fire inhibiting liquid biochemical composition of the present invention derived from the C3-Class of saturated non-polymerized carboxylic acid called tartaric acid, consisting of: (i) a major amount of calcium tartrate (CAS RN: 5743-36-2), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-tartaric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6M3 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of: (i) a major amount of sodium tartrate (CAS RN: 156-54-7), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-tartaric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6M4 illustrates the primary components of an environmentally-clean aqueous-based fire inhibiting liquid biochemical composition of the present invention derived from the C3-Class of saturated non-polymerized carboxylic acid called tartaric acid, consisting of: (i) a major amount of magnesium tartrate (CAS RN: 20752-56-1), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-tartaric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium tartrate, calcium tartrate, sodium tartrate, or magnesium tartrate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium tartrate, calcium tartrate, sodium tartrate, or magnesium tartrate) of a nonpolymeric saturated carboxylic acid (e.g. tartric acid) in a major amount from 1% to 75% by weight, preferably from 20% to 60% by weight and more preferably from 35% to 55% by weight;
an ester of saturated non-polymerized carboxylic acid (e.g. ester of tartric acid, namely diethyl tartrate (DET), or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C4 Carboxylic Acid (R—COOH), Called Butyric Acid

In FIGS. 6N1, 6N2, 6N3, and 6N4, schematic chemical models are provided for making liquid fire inhibitor solutions containing alkali metal salts derived from a C4 Class of Carboxylic Acid having 4 carbon atoms, specifically, the C4 carboxylic acid (R—COOH) called butyric acid, having a molecular formula C₃H—COOH and CAS RN: 107-92-6. The exemplary alkali metal salts derived from this C4 Class of Carboxylic Acid are: potassium butyrate (or butanoate) C₄H-KO₂; calcium butyrate C₈H₁₄CaO₄; sodium butyrate C₄H₇NaO₂; and magnesium butyrate C₄H₈MgO₂.

As shown in FIGS. 6N1 through 6N4, an exemplary ester of butyric acid is ethyl butyrate characterized by chemical formula C₆H₁₂O₂, CAS RN: 105-54-4, a fruity odor, and being water soluble. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C4 Class of Carboxylic Acid.

FIG. 6N1 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of potassium butyrate (CAS RN: 589-39-9), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-butyric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6N2 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of calcium butyrate (CAS RN: 5743-36-2), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-butyric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6N3 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of sodium butyrate (CAS RN: 156-54-7), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-butyric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6N4 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of magnesium butyrate (CAS RN: 556-45-6), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-butyric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium butyrate, calcium butyrate, sodium butyrate or magnesium butyrate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium butyrate, calcium butyrate, sodium butyrate, or magnesium butyrate) of a nonpolymeric saturated carboxylic acid (e.g. butyric acid) in a major amount from 1% to 75% by weight, preferably from 20% to 60% by weight and more preferably from 35% to 55% by weight;
an ester of saturated non-polymerized carboxylic acid (e.g. ester of butyric acid, namely ethyl butyrate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.
   Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C4 Carboxylic Acid (R—COOH), Called Malic Acid

In FIGS. 6O1, 602, 603 and 604, schematic chemical models are provided for making liquid fire inhibitor solutions containing alkali metal salts derived from a C4 Class of Carboxylic Acid having 4 carbon atoms, specifically, the C4 carboxylic acid (R—COOH) called malic acid, having a molecular formula C₄H₆O₅ and CAS RN: 6915-15-7), and highly water soluble. The exemplary alkali metal salts derived from this C4 Class of Carboxylic Acid are: potassium malate C₄H₄K₂O₅; calcium malate C₄H₄CaO₈; sodium malate C₄H₄Na₂O₅; and magnesium malate C₄H₄MgO₅.

As shown in FIGS. 6O1 through 6O₄ , an exemplary ester of malic acid is diethyl maleate characterized by chemical formula C₈H₁₂O₄ and CAS RN: 141-05-9. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C4 Class of Carboxylic Acid.

FIG. 6O1 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of potassium maleate (CAS RN: 585-09-1), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6O2 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of calcium maleate (CAS RN: 16426-50-9), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame

FIG. 6O3 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of sodium maleate (CAS RN: 676-46-0), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6O4 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of magnesium maleate (CAS RN: 141-05-9), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium maleate, calcium maleate, sodium maleate, or magnesium maleate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium maleate, calcium maleate, sodium maleate or magnesium maleate) of a nonpolymeric saturated carboxylic acid (e.g. malic acid in a major amount from 1% to 75% by weight, preferably from 20% to 60% by weight and more preferably from 35% to 55% by weight;
an ester of saturated non-polymerized carboxylic acid (e.g. ester of malic acid, namely diethyl maleate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C4 Carboxylic Acid (R—COOH), Called Malonic Acid

In FIGS. 6P1, 6P2, 6P3 and 6P4, schematic chemical models are provided for making liquid fire inhibitor solutions containing alkali metal salts derived from a C4 Class of Carboxylic Acid having 4 carbon atoms, specifically, the C4 carboxylic acid (R—COOH) called malonic acid, C₃H₄O₄ (CAS RN: 55514 Nov. 19). The exemplary alkali metal salts derived from this C4\ Class of Carboxylic Acid are: potassium malonate; calcium malonate C₃H₂CaO₄; sodium malonate C₃H₂O₄ Na₂; and di-magnesium malonate Mg2 (OH) 2C₄H₄O₅.

As shown in FIGS. 6P1 through 6P4, an exemplary ester of malonic acid is diethyl malonate (DEM) characterized by chemical formula C₇H₁₂O₄ and CAS RN: 105-53-3. As this ester has negligible or low water solubility, and is most commonly used in the fragrance industry, its use and performance as a surface-chemistry coalescing agent may not be as desirable as the surface chemistry performance by the ester of citric acid, called triethyl citrate (TEC) described hereinabove, which may be used as a dispersing/coalescing agent with the alkali metal salts dissolved in water to produce these aqueous-based liquid fire inhibiting solutions of the present invention, based on the above-referenced C4-Class of Carboxylic Acid called Malonic Acid.

FIG. 6P1 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of potassium malonate (CAS RN: 13095-67-5), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-Class of carboxylic acid-malonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6P2 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of calcium malonate (CAS RN: 19455-76-6), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-Class of carboxylic acid-malonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6P3 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of sodium malonate (CAS RN: 141-95-7), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6P4 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of magnesium malonate (CAS RN: 671197-50-5), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid-malonic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium malonate, calcium malonate, sodium malonate, or magnesium malonate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium malonate, calcium malonate, sodium malonate, or magnesium malonate) of a nonpolymeric saturated carboxylic acid (e.g. malonic) in a major amount from 1% to 75% by weight, preferably from 20% to 60% by weight and more preferably from 35% to 55% by weight;
an ester of saturated non-polymerized carboxylic acid (e.g. ester of malonic acid, namely diethyl malonate (DEM), or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C5 Carboxylic Acid (R—COOH), Called Pivalic Acid

In FIGS. 6Q1, 6Q2, 6Q3 and 6Q4, schematic chemical models are provided for making liquid fire inhibitor solutions containing alkali metal salts derived from a C5 Class of Carboxylic Acid having 5 carbon atoms, specifically, the C5 carboxylic acid (R—COOH) called pivalic acid, (i.e. trimethylacetic acid; neopentanoic acid), C₅H₁₀O₂ (CAS RN: 75-98-9). The exemplary alkali metal salts derived from this C5 Class of Carboxylic Acid are: potassium pivalate C₅H₉KO₂; calcium pivalate C₁₀H₁₈CaO₄; sodium pivalate C₅H₉NaO₂; and magnesium pivalate C₁₀H₂OMnO₄

As shown in FIGS. 6Q1 through 6Q4, an exemplary ester of pivalic acid is methyl pivalate characterized by chemical formula C₆H₁₂O₂ and CAS RN: 598-98-1. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C5 Class of Carboxylic Acid.

FIG. 6Q1 illustrates the primary components of an environmentally-clean aqueous-based fire inhibiting liquid biochemical composition of the present invention derived from the C5-Class of saturated non-polymerized carboxylic acid called pivalic acid, consisting of (i) a major amount of potassium pivalate (CAS RN: 19455-23-3), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid-pivalic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6Q2 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of calcium pivalate (CAS RN: 598-98-1), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid-pivalic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6Q3 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of sodium pivalate (CAS RN: 1184-88-9), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid-pivalic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6Q4 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of magnesium pivalate (CAS RN: , and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid-pivalic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium pivalate, calcium pivalate, sodium pivalate, or magnesium pivalate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium pivalate, calcium pivalate, sodium pivalate, magnesium pivalate) in a major amount from 1% to 75% by weight, preferably from 20% to 60% by weight and more preferably from 35% to 55% by weight;
an ester of saturated non-polymerized carboxylic acid (e.g. ester of pivalic acid, namely methyl pivalate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C6 Carboxylic Acid (R—COOH), Called Caproic Acid

In FIGS. 6R1, 6R2, 6R3, and 6R4 schematic chemical models are provided for making liquid fire inhibitor solutions containing alkali metal salts derived from a C6 Class of Carboxylic Acid having 6 carbon atoms, specifically, the C6 carboxylic acid (R—COOH) called caproic acid, CH₃ (CH₂)₄COOH (CAS RN: 142-62-1). The exemplary alkali metal salts derived from this C6 Class of Carboxylic Acid are: potassium caproate (hexanoate) C₁₀H₁₉O₂·K; calcium caproate C₈H₁₅NaO; sodium caproate C₈H₁₅NaO₂; and magnesium caproate C₁₂H₂₂MgO₄ .

As shown in FIGS. 6R1 through 6R4, an exemplary ester of caproic acid is ethyl caprocate characterized by chemical formula C₈H₁₆O₂ and CAS RN: 123-66-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6R1 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of potassium caproate (CAS RN: 19455-00-6), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-caproic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6R2 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of calcium caproate (CAS RN: 38708-95-1), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-caproic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6R3 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of sodium caproate (CAS RN: 10051-44-2), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-caproic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6R4 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of magnesium caproate (CAS RN: 3386-57-0), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-caproic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium caproate, calcium caproate, sodium caproate or magnesium caproate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium caproate, calcium caproate, sodium caproate, or magnesium caproate) of a nonpolymeric saturated carboxylic acid (e.g. caproic acid) in a major amount from 1% to 75% by weight, preferably from 20% to 60% by weight and more preferably from 35% to 55% by weight;
an ester of saturated non-polymerized carboxylic acid (e.g. ester of caproic acid, namely ethyl caprocate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C6 Carboxylic Acid (R—COOH), Called Adipic (Hexanedioic) Acid

In FIGS. 6S1, 6S2, 6S3 and 6S4, schematic chemical models are provided for making liquid fire inhibitor solutions containing alkali metal salts derived from a C6 Class of Carboxylic Acid having 6 carbon atoms, specifically, the C6 carboxylic acid (R—COOH) called adipic (hexanedioic) acid having a molecular formula C₆H₁₀O₄ , and CAS RN: 124-04-9 and being soluble in water. The exemplary alkali metal salts derived from this C6 Class of Carboxylic Acid are: potassium adipate C₆H₈K₂O₄ ; calcium adipate C₆H₈CaO₄; sodium adipate C₆H₈Na₂O₄ ; and magnesium adipate C₆H₈MgO₄ .

As shown in FIGS. 6S1 through 6S4, an exemplary ester of adipic acid is dimethyl adipate characterized by chemical formula C₈H₁₄O₄ and CAS RN: 627-93-0 and low water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid called Adipic (i.e. Hexanedioic) Acid.

FIG. 6S1 illustrates the primary components of an environmentally-clean aqueous-based fire inhibiting liquid biochemical composition of the present invention derived from the C6-Class of saturated non-polymerized carboxylic acid called adipic acid, consisting of: (i) a major amount of potassium adipate (CAS RN: 19147-16-1), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-adipic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6S2 illustrates the primary components of an environmentally-clean aqueous-based fire inhibiting liquid biochemical composition of the present invention derived from the C6-Class of saturated non-polymerized carboxylic acid called adipic acid, consisting of: (i) a major amount of calcium adipate (CAS RN: 7486-40-0), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-adipic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6S3 illustrates the primary components of an environmentally-clean aqueous-based fire inhibiting liquid biochemical composition of the present invention derived from the C6-Class of saturated non-polymerized carboxylic acid called adipic acid, consisting of (i) a major amount of sodium adipate (CAS RN: 23311-84-4), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-adipic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6S4 illustrates the primary components of an environmentally-clean aqueous-based fire inhibiting liquid biochemical composition of the present invention derived from the C6-Class of saturated non-polymerized carboxylic acid called adipic acid, consisting of (i) a major amount of magnesium adipate (CAS RN: 7486-39-7), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-adipic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium adipate, calcium adipate, sodium adipate, or magnesium adipate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium adipate, calcium adipate, sodium adipate, or magnesium adipate) of a nonpolymeric saturated carboxylic acid (e.g. adipic acid) in a major amount from 1% to 75% by weight, preferably from 20% to 60% by weight and more preferably from 35% to 55% by weight;
an ester of saturated non-polymerized carboxylic acid (e.g. ester of adipic acid, namely dimethyl adipate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C6 Carboxylic Acid (R—COOH), Citric Acid

In FIGS. 6T1, 6T2, 6T3 AND 6T4, schematic chemical models are provided for making liquid fire inhibitor solutions containing alkali metal salts derived from a C6 Class of Carboxylic Acid having 6 carbon atoms, specifically, the C6 carboxylic acid (R—COOH) called citric acid, having a molecular formula HOC (CO₂H) (CH₂CO₂H)₂ and CAS RN: 77-92-9 anhydrous/5949-29-1 monohydrate, and being highly soluble in water. The exemplary alkali metal salts derived from this C6 Class of Carboxylic Acid are: (tri)potassium Citrate C₆H₅K₃O₇, calcium citrate Ca₃ (C₆H₅O₇)₂; sodium citrate C₆H₅Na₃O₇; and magnesium citrate C₆H₆MgO₇.

As shown in FIGS. 6T1 through 6T4, an exemplary ester of citric acid is triethyl citrate (TEC) characterized by chemical formula C₁₂H₂OO₇ and CAS RN: 77-93-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6T1 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of tripotassium citrate (TPC) (CAS RN: 866-84-2), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-citric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6T2 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of calcium citrate (CAS RN: 813-94-5), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-citric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6T3 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of sodium citrate (CAS RN: 68-04-2), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-citric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6T4 is a schematic representation illustrating the primary components of an environmentally-clean aqueous-based fire inhibiting liquid biochemical composition of the present invention derived from the C6-Class of saturated non-polymerized carboxylic acid called citric acid, consisting of: (i) a major amount of magnesium citrate (CAS RN: 779-25-1), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-citric acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium citrate, calcium citrate, sodium citrate, or magnesium citrate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium citrate, calcium citrate, sodium citrate, or magnesium citrate) of a nonpolymeric saturated carboxylic acid (e.g. citric) in a major amount from 1% to 75% by weight, preferably from 20% to 60% by weight and more preferably from 35% to 55% by weight;
an ester of saturated non-polymerized carboxylic acid (e.g. ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From The C6 Carboxylic Acid (R—COOH), D-Gluconic Acid

In FIGS. 6U1, 6U2, 6U3 and 6U4, schematic chemical models are provided for making liquid fire inhibitor solutions containing alkali metal salts derived from a C6 Class of Carboxylic Acid having 6 carbon atoms, specifically, the C6 carboxylic acid (R—COOH) called D-Gluconic Acid, having a molecular formula C₆H₁₂O₇ and CAS RN: 526-95-4) and highly soluble in water. The exemplary alkali metal salts derived from this C6 Class of

Carboxylic Acid are: potassium gluconate C₆H₁₁KO₇; calcium gluconate C₁₂H₂₂CaO₁₄; sodium gluconate C₆H₁₁NaO₇; and magnesium gluconate C₁₂H₂₂MgO₁₄.

As shown in FIGS. 6U1 through 6U4, an exemplary ester of d-gluconic acid is methyl gluconate characterized by the chemical/molecular formula C₇H₁₄O and CAS RN: 131797-36-9. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6U1 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of potassium gluconate (CAS RN: 299-27-4), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-d-gluconic; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6U2 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of calcium gluconate (CAS RN: 299-28-5), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-d-gluconic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6U3 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of sodium gluconate (CAS RN: 527-07-1), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-d-gluconic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6U4 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of magnesium gluconate (CAS RE: 3632-91-5), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid-d-gluconic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium gluconate, calcium gluconate, sodium gluconate, or magnesium gluconate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium gluconate, calcium gluconate, sodium gluconate, or magnesium gluconate) of a nonpolymeric saturated carboxylic acid (e.g. gluconic acid) in a major amount from 1% to 75% by weight, preferably from 20% to 60% by weight and more preferably from 35% to 55% by weight;
an ester of saturated non-polymerized carboxylic acid (e.g. ester of gluconic acid, namely methyl gluconate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification Of New And Improved Environmentally-Clean Biochemical Wood Treatment Compositions For Forming Fire Inhibiting Alkali Metal Salt Structures In Combustible Lignocellulosic Materials, And Produced From Alkali Metal Salts Derived From the C7 Carboxylic Acid (R—COOH), Benzoic Acid

In FIGS. 6V1, 6V2, 6V3 and 6V4, schematic chemical models are provided for making liquid fire inhibitor solutions containing alkali metal salts derived from a C7 Class of Carboxylic Acid having 7 carbon atoms, specifically, the C7 carboxylic acid (R—COOH) called benzoic acid, (benzenecarboxylic acid), having a molecular formula C₇H₆O₂, CAS RN: 65-85-0 and high water solubility. The exemplary alkali metal salts derived from this C7 Class of Carboxylic Acid are: potassium benzoate C₇H₅KO₂; calcium benzoate Ca (C-H₅O₂)₂; sodium benzoate C₇H₅NaO₂; and magnesium benzoate C14H₁₀MgO₄ .

As shown in FIGS. 6V1 through 6V4, an exemplary ester of benzoic acid is ethyl benzoate characterized by chemical formula C9H₁₀O₂, CAS RN: 93-89-0 and poor water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C7 Class of Carboxylic Acid.

FIG. 6V1 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of potassium benzoate (CAS RN: 582-25-2), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid-benzoic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with potassium ions dispersing and coalescing in the treated material, and/or potassium salt crystalline structures forming in the treated material, and/or potassium salt crystalline coatings forming on the surfaces of treated material, thereby providing potassium ions available to protect against fire ignition, flame spread and smoke development.

FIG. 6V2 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of calcium benzoate (CAS RN: 2090 May 3), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid-benzoic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with calcium ions dispersing and coalescing in the treated material, and/or calcium salt crystalline structures forming in the treated material, and/or calcium salt crystalline coatings forming on the surfaces of treated material, thereby providing calcium ions available to protect against fire ignition, flame spread and smoke development.

FIG. 6V3 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of sodium benzoate (CAS RN: 532-32-1), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid-benzoic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with sodium ions dispersing and coalescing in the treated material, and/or sodium salt crystalline structures forming in the treated material, and/or sodium salt crystalline coatings forming on the surfaces of treated material, thereby providing sodium ions available to protect against fire ignition, flame spread and smoke development.

FIG. 6V4 illustrates the primary components of an environmentally-clean aqueous-based fire inhibiting liquid biochemical composition of the present invention derived from the C7-Class of saturated non-polymerized carboxylic acid called benzoic acid, consisting of (i) a major amount of magnesium benzoate (CAS RN: 553-70-8), and (ii) a minor amount methyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid-benzoic acid; a minor amount of alkali metal salt derived from benzoic acid, wherein the alkali metal is selected from group consisting of potassium, sodium, calcium and magnesium, to inhibit metal corrosion of mounted fasteners; and a minor amount of alkali metal salt derived from carboxylic acid for inhibiting metal-corrosion, mold and/or microbial life, for application to lignocellulosic furnish material during the composite wood panel manufacturing process to inhibit fire ignition of wood material, metal corrosion of mounted fasteners, and/or decomposition of composite wood material. Once the biochemical solution is produced according to the principles of the present invention, and applied to treat lignocellulosic-based wood furnish material, water molecules in the biochemical solution begin to evaporate, with magnesium ions dispersing and coalescing in the treated material, and/or magnesium salt crystalline structures forming in the treated material, and/or magnesium salt crystalline coatings forming on the surfaces of treated material, thereby providing magnesium ions available to protect against fire ignition, flame spread and smoke development.

In the above liquid fire inhibiting solutions, the weights and measures of the constituents are specified generally in terms of major and minor mass amounts which, in preferred embodiments, may be substantially proportional to:
7.13 [Lbs.] of water as a solvent to produce a resultant solution;
3.0 [Lbs.] (by weight) of at least one alkali metal salt of a nonpolymeric saturated carboxylic acid (e.g. potassium benzoate, calcium benzoate, sodium benzoate, or magnesium benzoate);
2.5 [Oz.] (by weight) of an ester of saturated non-polymerized carboxylic acid (e.g. ester of formic acid, namely methyl formate, or ester of citric acid, namely triethyl citrate (20.3 milliliters by volume) as coalescing agent;
3.0 [Oz.] (by weight) of potassium, calcium, sodium and/or magnesium benzoate as a metal corrosion inhibiting agent; and
3.0 [Oz.] of a metal or alkali metal salt of a carboxylic acid (C less than 8) functioning as an inhibitor of mold, mildew and/or microbial life. (e.g. copper citrate or citric acid).

Also, the above liquid fire inhibiting solutions, the weights and measures of the constituents may be specified generally as follows:
at least one alkali metal salt (e.g. potassium benzoate, calcium benzoate, sodium benzoate, or magnesium benzoate) of a nonpolymeric saturated carboxylic acid (e.g. benzoic acid) in a major amount from 1% to 75% by weight, preferably from 20% to 60% by weight and more preferably from 35% to 55% by weight;
an ester of saturated non-polymerized carboxylic acid (e.g. ester of benzoic acid, namely ethyl benzoate, or ester of citric acid, namely triethyl citrate) in a minor amount from 0.08% to 5% by weight, preferably from 0.5% to 2% by weight and more preferably from 0.1% to 1.0% by weight; potassium, calcium, sodium and/or magnesium benzoate in a minor amount from 0.08% to 5% by weight, preferably from 0.5% to 3% by weight and more preferably from 0.1% to 1.5% by weight;
a metal or alkali metal salt of a carboxylic acid (C less than 8) functioning as an inhibitor of mold, mildew and/or microbial life. (e.g. copper citrate or citric acid) in a minor amount from 0.08% to 5% by weight, preferably from 0.5% to 2% by weight and more preferably from 0.1% to 1.0% by weight; and
water content in a major amount typically not less than 30% by weight, preferably not less than 40% by weight, more preferably not less than 50% by weight and most preferably not less than 60% by weight and preferably not more than 70% by weight and more preferably not more than 90% by weight, all based on the fire inhibiting biochemical composition;
wherein the sum by % weight of the components above should not exceed 100% by weight.

Specification of Biochemically-Treated Polymeric Resin Binder Materials Formulated According To The Principles of The Present Invention

FIG. 7A is a schematic representation of the fire inhibiting pMDI-type resin binder blends of the present invention 95′ formulated for use in producing different types of composite wood products of the present invention.

FIG. 7B is a schematic representation of the molecular structure, molecular formulas and constants of pMDI-type polymeric resin binder blends 95 that are formulated and biochemically-treated using the biochemical compositions of the present invention 93, so as to produce biochemically-treated (fire-inhibiting) polymeric resin binders and adhesives 95′ that are suitably adapted for use when producing different types of biochemically-treated fire-inhibiting composite wood products according to the present invention, of which fire-inhibiting/resistant wood products 29, 42, 60, 90, 130, 150, 170, 190 and 210 are just exemplary embodiments of the present invention.

FIG. 7C is a table listing different kinds of fire-inhibiting pMDI-type polymeric resin binders 95′ biochemically-treated according to the principles of the present invention, namely standard polymeric resin, fast cure MDI resin, enhanced fast cure MDI resin and emulsifiable fast cure resin 95, for use in producing different types of fire-protected composite wood products according to the present invention, namely (i) oriented strand board (OSB), and (ii) medium density fiberboard (MDF).

FIG. 7D is a table listing different kinds of fire-inhibiting pMDI-type resin binders 95′ biochemically-treated according to the principles of the present invention, namely standard polymeric resin, fast cure MDI resin, enhanced fast cure MDI resin and emulsifiable fast cure resin 95, for use in producing different types of fire-protected composite wood products according to the present invention, namely (iii) particleboard (PB), and (iv) wood fiber insulation fiberboard (WFI).

Specification Of A First (Surface-Treatment) Method Of Producing Treated Wood Products With Fire, Metal-Corrosion, Mold And Moisture Protection According To The Present Invention

FIG. 8A describes the primary steps involved in the practice a first (surface-treatment) method of producing biochemically-treated wood products with fire, metal-corrosion, mold and moisture protection according to the present invention, comprising the steps of: (a) producing or procuring a supply of environmentally clean wood treatment biochemical compositions 93 for use in treating wood (i.e. lignocellulosic) material in treated wood products to provide fire, metal-corrosion, mold and moisture protection, wherein the environmentally-clean liquid wood treatment composition 93 comprises environmentally-clean fire inhibiting biochemicals 93 selected from the group consisting of metal alkali carboxylic acid salt based biochemicals; (b) applying the environmentally-clean biochemical wood treatment composition 93 over the exterior surfaces of the wood products to be treated with Class-A fire and metal-corrosion protection; (c) allowing water molecules in the applied environmentally-clean biochemical wood treatment composition 93 to evaporate to the environment and Class-A fire and metal-corrosion inhibiting coatings to form over the treated wood surfaces; and (d) applying a polymeric-based mold inhibiting and moisture protecting coating(s) 97 over the Class-A fire-protected, metal-corrosion and mold/mildew inhibiting wood surfaces of the treated wood products.

Specification Of A Second Method Of Producing Composite Wood Products With Fire, Metal-Corrosion, Mold And Moisture Protection According To The Present Invention

FIG. 8B describes the primary steps involved in the practice a second method of producing biochemically-treated composite wood products with fire, metal-corrosion, mold and moisture protection according to the present invention, comprising the steps of: (a) producing or procuring a supply of environmentally-clean biochemical wood treatment composition 93 for use in treating wood (i.e. lignocellulosic) furnish material 94 to produce composite wood products having fire, metal-corrosion, mold and moisture protection, wherein the environmentally-clean liquid wood treatment composition 93 comprises environmentally-clean fire inhibiting biochemicals 93 selected from the group consisting of metal alkali carboxylic acid salt based biochemicals; (b) applying the environmentally-clean biochemical wood treatment composition 93 to wood furnish material 94 prior to or during the manufacturing of composite wood components so that fire, metal-corrosion and mold protection is provided within and over the exterior surfaces of the wood furnish material during manufacture; (c) adding biochemical additives 93, also selected from the group consisting of metal alkali carboxylic acid salt based biochemicals, to a polymeric resin compound 95 so as to produce an enhanced biochemically-treated polymeric resin 95′, then applying the same to wood furnish material 94, and molding a composite wood product under pressure and curing the polymeric resin 95′ during molding and compression operations so as to provide the molded composite wood product with fire, metal-corrosion and mold protection throughout composite wood products; and (d) applying a polymeric-based (mold inhibiting and) moisture protective coating 97 over the exterior wood surfaces of the Class-A fire protected wood products.

Specification Of Third Method Of Producing Treated Engineered Wood Products (EWPs) With Fire, Metal-Corrosion, Mold And Moisture Protection According To The Present Invention

FIG. 8C describes a third method of producing treated engineered wood products (EWPs) with fire, metal-corrosion, mold and moisture protection according to the present invention, comprising the steps of: (a) producing or procuring a supply of environmentally-clean liquid biochemical wood treatment solution 93 for use in treating wood furnish used in engineered wood products (EWPs), wherein the environmentally-clean liquid wood treatment composition comprises environmentally-clean fire inhibiting biochemicals 93 selected from the group consisting of metal alkali carboxylic acid salt based biochemicals; (b) applying the environmentally-clean biochemical liquid wood treatment solution 93 to (i.e. wood/lignocellulosic) furnish material 94 prior to or during the manufacturing of the engineered wood product to produce biochemically treated wood furnish material 94′ that is protected against fire, metal corrosion and mold/mildew; (c) during manufacture of the EWP, binding the treated wood material 94′ using a polymeric resin compound 95′ infused with fire and metal-corrosion inhibiting biochemicals 93 for producing an engineered wood product (EWP) provided with fire protection, metal-corrosion and mold/mildew protection throughout the corpus of the EWP; and (d) applying a polymeric-based (mold-inhibiting and) moisture-protecting coating 96 over the treated wood surfaces of the fire protected EWP.

Specification Of A Method of and Apparatus For Producing Fire-Protected Finger-Jointed Lumber Products Along The Production Line In An Automated Fire-Treated Lumber

Factory Using Environmentally-Clean Wood Treatment Compositions Of The Present Invention In Accordance With The Principles Of The Present Invention

FIG. 9 shows a bundle of Class-A fire-protected finger-jointed lumber 29 produced using the method of and apparatus (i.e. factory)₂0 of the present invention. FIG. 20 shows an automated lumber factory system 20 for continuously fabricating wrapped and packaged bundles of Class-A fire-protected finger-jointed lumber product 29 in a high-speed manner, in accordance with the principles of the present invention. However, it is understood that this automated factory and production methods can be used to biochemically-treat and protect solid wood and timber products, as well, using the biochemicals 93 shown in FIGS. 6 through 6V4, and polymeric resin adhesives 95, and/or biochemically-treated resin adhesives 95′ shown in FIGS. 7A through 7D, to produce Class-A fire-protected solid wood products (e.g. studs, beams, boards, etc.), as well as engineered wood products (EWPs) based on wood components and composite wood materials.

As shown in FIG. 10, the factory 20 comprises a number of automated industrial stages integrated together under automation and control of controller 28, namely: a high-speed multi-stage lumber piece conveyor-chain mechanism 22 having multiple primary stages in the illustrative embodiment, namely: a kiln-drying stage 23 receiving short pieces of lumber 21 from a supply warehouse maintained in or around the factory 20; a finger-jointing lumber processing stage 24, for processing short-length pieces of kiln-dried lumber and automatically fabricating extended-length finger-jointed pieces of lumber, as output from this stage; a lumber planing and dimensioning stage 25 for planing and dimensioning elongated pieces of finger-jointed lumber into lumber pieces having lengths and dimensions for the product application at hand (e.g. studs); an in-line high-speed continuous CFIC liquid dip-coating stage 26 (for applying biochemical liquid 93), as further detailed in FIG. 10A; an automated stacking, packaging, wrapping and banding/strapping stage 27, from which bundles of packaged, wrapped and strapped Class-A fire-protected lumber product 29 are produced in a high-speed automated manner.

In general, the kiln-drying stage 23 can be implemented in different ways. One way is providing a drying room with heaters that can be driven by electricity, natural or propane gas, and/or other combustible fuels which release heat energy required to dry short-length lumber pieces prior to the finger-joint wood processing stage. Batches of wood to be treated are loaded into the drying room and treated with heat energy over time to reduce the moisture content of the wood to a predetermined level (e.g. 19% moisture). In alternative embodiments, the kiln-drying stage 23 might be installed an elongated tunnel on the front end of the production line, having input and output ports, with one stage of the conveyor-chain mechanism 22 passing through the heating chamber, from its input port to output port, allowing short-length lumber to be kiln-dried as it passes through the chamber along its conveyor mechanism, in a speed-controlled and temperature-controlled manner. Other methods and apparatus can be used to realize this stage along the lumber production line, provided that the desired degree of moisture within the wood is removed at this stage of the process.

As illustrated in FIG. 10A, the finger-jointing lumber processing stage 24 can be configured as generally disclosed in US Patent Application Publication Nos. US20070220825A1 and US20170138049A1, incorporated herein by reference. In general, this stage involves robotic wood-working machinery, automation, and programmable controls, well known in the finger-jointing wood art, and transforms multiple smaller-pieces of kiln-dried lumber into an extended-length piece of finger-jointed lumber, which is then planed and dimensioned during the next planning/dimensioning stage of the production line. An example of commercial equipment that may be adapted for the finger-jointing processing stage 24 of the present invention may be the CRP 2500, CRP 2750 or CRP 3000 Finger Jointing System from Conception R.P., Inc., Quebec, Canada http://www.conceptionrp.com/finger-jointing-systems.

As illustrated in FIG. 10A, the lumber planing and dimensioning stage 25 includes wood planing equipment, such industrial band or rotary saws designed to cut and dimension finger-jointed lumber pieces produced from the finger-jointing lumber processing stage 24, into lumber boards of a specified dimension and thickness, in a highly programmed and automated manner.

As shown in FIG. 10A, the dip-coating stage 26 of the factory system 800 comprises a number of components integrated together on the production line with suitable automation and controls, namely: a multi-stage chain-driven conveyor subsystem 22, supporting several parallel sets of chain-driven transport rails, as shown, extending from the planing and dimensioning stage 25 towards the dipping tank 26B, and then running inside and along the bottom of the dipping tank 26B, and then running out thereof towards the stacking, packing, wrapping and banding/strapping stage 27, as shown, and having the capacity of transporting extend-length finger-jointed lumber pieces (i.e. boards) having a length as long as 30 or so feet; a dipping reservoir 26B having a width dimension to accommodate the width of the chain-driven conveyor rails 22A1, 22A2 and 22A3 mounted and running outside of and also within the dipping tank 26B, as shown, to transport up planed and dimensioned finger-jointed lumber pieces 29A supported upon the chain-driven rails, while the boards are fully immersed and submerged at least 6 inches deep in CFIC liquid 26H (i.e. biochemical liquid 93 shown in FIGS. 6 through 6V4) contained in the dipping tank 26B, while moving at high speed, such as 300 feet/minute through the dipping tank 26B during the CFIC dip-coating process of the present invention; electrically-powered driven motors 26I for driving the chain-driven conveyors under computer control to transport finger-jointed pieces of lumber from stage to stage along the lumber production line; a level sensor 26F for sensing the level of CFIC liquid 26B in the dipping tank at any moment in time during production line operation; a reservoir tank 26C for containing a large volume or supply of CFIC liquid solution 26K; a computer controller 26G for controlling the conveyor subsystem 22, and an electric pump 26D for pumping CFIC liquid 93 into the dipping tank 26B to maintain a constant supply level during system operation in response to the liquid level measured by the level sensor 26F.

The high-speed CFIC liquid dip-coating subsystem 26 shown in FIG. 51B may also include additional apparatus including, for example, liquid heaters, circulation pumps and controls for (i) maintaining the temperature of CFIC liquid 96 in the dipping tank 26B, and (ii) controlling the circulation of CFIC liquid 93 around submerged pieces of finger-jointed lumber 29A being transported through the dipping tank 26B in a submerged manner during a CFIC coating process. Controlling such dip-coating parameters may be used to control the amount and degree of absorption of CFIC liquid within the surface fibers of the finger-jointed lumber 29A as it is rapidly transported through the dipping tank 26B between the lumber planing and dimensioning stage 25 and the lumber stacking, packaging, wrapping, and banding/strapping stage 27 of the lumber production line. Notably, the dip coating process of the present invention allows for the rapid formation a fire inhibiting surface coating, on the surface of each piece of dipped lumber, and in the presence of the surfactant/dispersing agent in the fire inhibiting biochemical liquid in the dipping tank, allows shallow impregnation of the biochemical liquid 26H into the lignocellulosic fibers present in each piece of lumber 29A near atmospheric pressure (i.e. below 6 inches of liquid CFIC in the dipping tank) during the dip-coated process. It is understood that drip pans may also be provided beyond the dipping tank 26B, installed beneath the chain-driven conveyor subsystem arranged between the dripping tank 26B and the stacking, packaging, wrapping and banding/strapping stage 27, to recover excess biochemical liquid dripping from the dip-coated lumber pieces 29A and returning this recovered biochemical liquid to the dipping tank 26B after appropriate filtering of the biochemical liquid, if and as necessary.

As illustrated in FIG. 10A, the stacking, packaging, wrapping and banding stage 27 includes equipment designed to automatically receive CFIC-coated finger-jointed lumber pieces 29A while still dripping and wet from CFIC liquid 26H, and wet stacking a predetermined number of lumber pieces into a package, and then wrapping the package of lumber with a sheet of wrapping material (e.g. TVEK or like material) that covers the top portion and at least half way down each side of the lumber package, and then banding or strapping the wrapped package with fiberglass or steel banding, well known in the art. The wrapping will typically be preprinted with trademarks and logos of the lumber manufacturer's brand. Finally, the ends of the lumber pieces in the strapped, wrapped lumber package are painted with a fire-protective paint also containing CFIC liquid in amounts to be effective in Class-A fire suppression.

FIGS. 11A and 11B describe the high-level steps carried out when practicing the method of producing bundles of Class-A fire-protected finger-jointed lumber 29 for use in fire-protected building construction.

As indicated at Block A in FIG. 11A, in an automated lumber factory, a high-speed Class-A fire-protected lumber production line is installed and operated, with a reservoir tank 26C containing a large supply of clean fire inhibiting biochemical (CFIC) liquid 26K (i.e. biochemical liquid 93) that is supplied to the automated CFIC liquid dip-coating stage 26 of the lumber factory 20.

As indicated at Block B in FIG. 11A, a supply of untreated short-length lumber is loaded onto the high-speed conveyor-chain transport mechanism 22 and auto-feeder installed along and between the stages of the lumber production line.

As indicated at Block C in FIG. 11B, the untreated short-length lumber is loaded into the controlled-drying stage 23 of the fire-protected lumber production line so to produce suitably dried short-pieces of lumber for supply to the finger-jointing processing stage 24. This stage can be performed by loading batches of short length lumber into the drying room or oven, whose temperature and humidity are strictly controlled using electric heaters and other equipment under computer control. Alternatively, short-length lumber pieces can be controllably dried by moving batches of short-length lumber through a tunnel-like drying room or chamber, through which chain-driven conveyor mechanism 22 passes, like other stages along the lumber production line, while the temperature and humidity of the environment is controlled using electric-driven or gas-combusting heaters under computer control in a manner well known in the art.

As indicated at Block D in FIG. 11A, the controllably-dried short-length lumber is continuously supplied into the finger-jointing lumber processing stage 24, for producing pieces of extended-length finger-jointed lumber in a highly automated manner.

As indicated at Block E in FIG. 11A, produced pieces of extended-length finger-jointed lumber are automatically transported to the planing/dimensioning stage 25 so that the finger-jointed lumber can be planed/dimensioned into pieces of dimensioned finger-jointed lumber 29A, and outputted onto the multi-stage conveyor-chain transport mechanism 22.

As indicated at Block F in FIG. 11B, the dimensioned finger-jointed lumber pieces 29A are continuously transported and submerged through an automated dipping tank 26B for sufficient coating in CFIC liquid while being transported on the conveyor-chain transport mechanism 22.

As indicated at Block G in FIG. 11B, the wet dip-coated pieces of dimensioned finger-jointed lumber are continuously removed from the dipping tank 26B, and automatically wet-stacking, packing, wrapping, and banding the wet dip-coated pieces into a packaged bundle of Class-A fire-protected finger-jointed lumber.

As indicated at Block H in FIG. 11B, the packaged bundle of Class-A fire-protected finger-jointed lumber is removed from the stacking, packaging, wrapping and banding stage 27 and stored in a storage location in the factory 20. The strapping for the bundle material used may be made of high-strength fiberglass plastic or metal banding material.

As indicated at Block I in FIG. 11B, the ends of each packaged bundle of fire-protected dimensioned finger-jointed lumber 29, produced from the production line, are painted using a Class-A fire-protected paint 97 containing clean fire-inhibited biochemicals (CFIC) (e.g. 25% fire inhibiting biochemical liquid of the present invention 93 shown in FIGS. 6 through 6V4, 75% liquid polymer binder, and black liquid pigment) and applying trademarks and logos to the wrapped package of Class-A fire-protected finger-jointed lumber.

In the illustrative embodiment, a fire inhibitor biochemical liquid of the present invention is used as the CFIC liquid 26H (.e. biochemical liquid 93) that is deposited as a CFIC surface coating during the dip-coating and/or spray-coating of wood/lumber products on the production line of the present invention described above. Chemicals with surface reducing properties in biochemical formulation (e.g. triethyl citrate) should help to break the surface tension and allow its chemical molecules to impregnate the lignocellulosic-fibers of the treated wood. This way, in the presence of a flame, the chemical molecules (e.g. alkali metal ions or particles) present in the alkali metal salt crystalline coating (i.e. CFIC-coating) on the surface of the fire-protected lumber, interferes with the free radicals (H+, OH-, O-) produced during the combustion phase of a fire, and breaks the fire's chemical reaction and extinguishes its flame. This is a primary fire suppression mechanism implemented by the environmentally-clean fire inhibiting biochemical-coatings deposited on wood surfaces in accordance with the various principles of invention disclosed and taught herein.

Expectedly, the flame spread and smoke development indices of fire-protected lumber 29 produced using the method of the illustrative embodiment, using biochemical liquid of the present invention 93 as a fire inhibiting dip coating material, described herein, should meet or exceed the standards of ASTM E84 Testing for proactively treated wood under the ASTM Standards.

Specification Of A Method Of And Apparatus For Producing Class-A Fire-Protected Cross-Laminated-Timber (CLT) Products (E.G. Panel, Stud, Beam, Etc.) Fabricated Along The Production Line Of An Automated Lumber Fabrication Factory Of The Present Invention In Accordance With The Principles Of The Present Invention

FIG. 12 shows a bundle of fire-protected cross-laminated timber (CLT) products (e.g. panels) 42 produced using the method and apparatus of the present invention. The Class-A fire-protected cross-laminated timber (CLT) of the present invention 30 bears a surface coating of clean fire inhibiting biochemical (CFIC) liquid 93 as shown in FIGS. 6 through 6V4 and described in great technical detail herein. This CFIC coating prevents flames from spreading by breaking the free radical chemical reaction within the combustion phase of fire, and confining the fire to the ignition source which can be readily extinguished, or go out by itself.

FIG. 13 shows an automated factory system 30 for producing Class-A fire-protected cross-laminated timber (CLT) panels, beams, and other products 42 in a high-volume manner. As shown in FIG. 13, the factory 30 comprises a number of automated stages integrated together under automation and control, namely: a multi-stage conveyor-chain mechanism 32 having numerous primary stages in the illustrative embodiment, namely; a controlled-drying stage 33 receiving short pieces of lumber from a supply warehouse maintained in or around the factory and drying them in a controlled manner well known in the art; a finger-jointing stage 34, for processing short-length pieces of dried timber (i.e. lumber) and automatically fabricating extended-length finger-jointed pieces of timber, as output from this stage, using biochemically-treated polymeric resin adhesive material 93 according to the present invention shown in FIGS. 7A through 7D a lamination planing stage 35 for planing finger-jointed pieces of timber to produce finger-jointed timber laminations; a biochemical treatment stage 36A for treating the finger-jointed laminations with the biochemical composition of the present invention shown in FIGS. 7A through 7D using a dip coating tank as illustrated in FIG. 13A, or using a spraying tunnel stage but less preferred; drying stage 36B for drying the pieces of biochemically-treated laminations prior to pressing and curing in an laminated structure; an automated adhesive stage 36 for applying adhesive 93 to the biochemically-treated finger-jointed timer laminations; a pressing and curing stage 37 where the biochemically-treated finger-jointed laminations with adhesive while stacked in a cross-directional manner, and then placed in pressing machine where the applied adhesive is cured under pressure to produce a cross-laminated timber (CLT) panel, beam or other product; cross-cutting and rip-sawing stage 38 for cutting and ripping cross-laminated timber (CLT) panels into CLT products 42A; a chain-driven conveyor 32 for conveying the CLT product 42A along the next few stages of the production line; an optional in-line spray coating stage 39, followed by a drying tunnel 56 as further detailed in FIG. 13B; a packaging and wrapping/labeling stage 40 for packaging and wrapping/labeling CLT product 42A either after it has dried, or while the CFIC-coated CLT product is still wet and allowed to dry in its wrapping.

In general, the controlled-drying stage 33 will include drying room with heaters that can be driven by electricity, natural or propane gas, or other combustible fuels which produce heat energy required to dry short-length lumber prior to the finger-joint wood processing stage. Some alternative embodiments, the controlled-drying stage 33 might be installed on the front end of the production line, and having input and output ports, with one stage of the conveyor-chain mechanism 32 passing through the heating chamber, from its input port to output port, allowing short-length lumber to be kiln-dried as it passes through the chamber along its conveyor mechanism. Other methods and apparatus can be used to realize this stage of the lumber production line of the present invention, provided that the desired degree of moisture within the wood is removed with heat or radiant energy at this stage of the process.

As illustrated in FIG. 13A, the finger-jointing lumber processing stage 34 can be configured as generally disclosed in US Patent Application Publication Nos. US20070220825A1 and US20170138049A1, incorporated herein by reference. In general, this stage involves robotic wood-working machinery, automation, and programmable controls, well known in the finger-jointing wood art, and transforms multiple smaller-pieces of kiln-dried lumber into an extended-length piece of finger-jointed lumber, which is then planed and dimensioned during the next planning/dimensioning stage of the production line. An example of commercial equipment that may be adapted for the finger-jointing processing stage 34 of the present invention may be the CRP 2500, CRP 2750 or CRP 3000 Finger Jointing System from Conception R.P., Inc., Quebec, Canada http://www.conceptionrp.com/finger-jointing-systems.

As illustrated in FIG. 13A, the laminating planing stage 35 includes wood lamination planing equipment, such industrial band or rotary saws designed to cut, plane and dimension finger-jointed lumber pieces produced from the finger-jointing stage 34, into finger-jointed timber laminations of a specified dimension and thickness.

As illustrated in FIG. 13A, the lamination planing stage 35 can be realized using a band or radial saw as may be required to produce finger-jointed laminations.

As illustrated in FIG. 13A, the adhesive application stage 36 can be realized using automated adhesive applicators well known in the art to apply a predetermined controlled amount of adhesive to each finger-jointed timber lamination during the automated finger-jointing process.

As illustrated in FIG. 13A, the pressing and curing stage 37 can be realized using an automated pressing and curing machine well known in the art to apply a predetermined controlled amount of pressure to the timber laminations after they have been cross-configured, and placed into the machine for pressing and subsequent curing operations.

LEDINEK Engineering, do.o.o, of Hoce, Slovenia, offers complete turnkey CLT production lines for high-volume automated production of cross-laminated timber (CLT) panels. Such systems comprise: lamination planers; finger jointing machines; presses ₈ curing machines; and automation and controllers. Such technologies and machines can be used to implement many of the stages described above in the CLT panel production line of the present invention. https://www.ledinek.com/engineered-timber

As shown in FIG. 13A, the in-line high-speed continuous CFIC liquid dip-coating stage 39 of the production line comprises a number of components integrated together, with suitable automation and controls, namely: a multi-stage lumber board chain-driven conveyor subsystem 32, supporting several parallel sets of chain-driven transport rails, as shown, extending from the pressing and curing stage 39 towards a dipping tank 39B, and then running inside and along the bottom of the dipping tank 39B, and then running out thereof, as shown, and having the capacity of transporting CLT laminations having a length up to 30 or so feet.

In the illustrative embodiment, the dipping tank 39B has a width dimension of 32 or so feet to accommodate the width of the CLT product being transported on chain-driven conveyor rails mounted and running outside of and within the dipping tank 39B, as shown.

As shown, the CLT laminations prior to biochemical-treatment are supported upon chain driven rails while the CLT products are transported through the dipping tank 39B while fully immersed and submerged at least 6 inches deep in CFIC liquid 39H contained in the dipping tank 39B, moving lumber in and out of the dipping tank 39B in just a few seconds during the CFIC dip-coating process of the present invention. Electrically-powered driven motors 39I are provided for the purpose of driving the chain-driven conveyors under computer control to transport CLT products 39E from stage to stage along the production line. A level sensor 39F is used for real-time sensing and control of the liquid level of CFIC liquid 39H in the dipping tank 39B at any moment in time during production line operation. A reservoir tank 39C is provided for containing a large volume or supply of made up CFIC liquid solution. Also, a computer controller 39G is used for controlling the conveyor subsystem 32, and an electric pump 39D for pumping CFIC liquid into the dipping tank 39B to maintain a constant supply level during system operation in response to the liquid level measured by the level sensor 39F and supplied to the control computer 39G.

The high-speed dip-coating subsystem 39 may also include additional apparatus including, for example, liquid heaters, circulation pumps and controls for (i) maintaining the temperature of CFIC liquid solution in the dipping tank 39B, and (ii) controlling the circulation of CFIC liquid around submerged CLT product 39E being transported through the dipping tank in a submerged manner during a CFIC coating process. Controlling such dip coating parameters may be used to control the amount and degree of absorption of CFIC liquid within the surface fibers of the CLT product, as it is rapidly transported through the dipping tank 39B. Notably, the dip coating process allows for the rapid formation a surface coating, or surface barrier, on the surface of each CLT lamination prior to cross lamination, and in the presence of a surfactant in the CFIC liquid in the dipping tank 39B, shallow impregnation of CFIC liquid 39H can occur into the surface fibers of each CLT piece 42A near atmospheric pressure (i.e. below 6 inches of liquid CFIC in the dipping tank). It is understood that drip pans may also be provided beyond the dipping tank 39B, installed beneath the chain-driven conveyor subsystem 32 arranged between the dripping tank 39B and the packaging and wrapping stage 40, to recover excess CFIC liquid dripping from the dip-coated lumber pieces and returning this recovered CFIC liquid to the dipping tank 39B after appropriate filtering of the CFIC liquid if and as necessary.

In alternative embodiments, the dipping tank can be replaced with an air-less spraying station for spraying CFIC liquid solution over surfaces of CLT products.

As illustrated in FIG. 13A, the packaging and wrapping stage 40 includes equipment designed to receive CFIC-coated CLT product while still dripping and wet from CFIC liquid, and wrapping the CLT product 42A with a sheet of wrapping material (e.g. TVEK or like material) that covers the top portion and at least half way down each side of the CLT product, and then banding or strapping the wrapped package 42 with fiberglass or steel banding, well known in the art. The wrapping will typically be preprinted with trademarks and logos of the lumber manufacturer's brand. Finally, the ends of the lumber pieces in the strapped, wrapped lumber package 42 are painted with a fire-protective paint also containing CFIC liquid material, in amounts to be effective in fire suppression.

FIGS. 14A and 14B describe the high-level steps carried out when practicing the method of producing bundles of Class-A fire-protected cross-laminated timber (CLT) 42 for use in fire-protected building construction.

As indicated at Block A in FIG. 14A, in an automated lumber factory 30, a high-speed Class-A fire-protected lumber production line is installed and operated, with a reservoir tank 39B containing a large supply of clean fire inhibiting chemical (CFIC) liquid 39H that is continuously supplied to the automated high-speed CFIC liquid dip-coating stage 39 of the lumber factory 30, installed between (i) a cross-cutting and rip-sawing stage 38, and (ii) an automated stacking, packaging, wrapping and banding/strapping stage 40 installed at the end of the production line in the factory 30.

As indicated at Block B in FIG. 14A, a supply of untreated short-length lumber is loaded onto the conveyor-chain transport mechanism 32 installed along and between the stages of the production line.

As indicated at Block C in FIG. 14A, the untreated short-length lumber is loaded into the controlled-drying stage of the production line so to produce suitably dried short-length lumber for supply to the finger-jointing processing stage 34. This stage can be performed by loading batches of short length lumber into the drying room or oven, whose temperature and humidity are strictly controlled using electric heaters and other equipment under computer control. Alternatively, short-length lumber pieces can be controllably dried by moving batches of short-length lumber through a tunnel-like drying room or chamber, through which chain-driven conveyor mechanism 32 passes, like other stages along the lumber production line of the present invention, while the temperature and humidity of the environment is controlled using electric-driven or gas-combusting space heaters under computer control in a manner well known in the art.

As indicated at Block D in FIG. 14B, the controllably-dried short-length lumber is continuously supplied into the finger-jointing stage 34, for producing pieces of extended-length finger-jointed timber (lumber) in a highly automated manner.

As indicated at Block E in FIG. 14B, pieces of extended length finger-jointed timber are planned and dimensioned into pieces of finger-jointed timber laminations, and outputting the same onto the conveyor-chain transport mechanism 32.

As indicated at Block F in FIG. 14B, a suitable amount of biochemically-treated polymeric resin adhesive material 95′ as shown in FIGS. 7A through 7D is blended and applied to the finger-jointed timber laminations produced during Block E.

As indicated at Block G in FIG. 14B, at the pressing ₈ curing stage 37, pressing a plurality of finger-jointed timber laminations together with applied adhesive between the laminations, and then curing the adhesively joined laminations to produce a cross-laminated timber (CLT) pieces.

As indicated at Block H in FIG. 14B, cross-laminated timber (CLT) pieces are planed and finished at the cross-cutting and rip-sawing stage 38, and outputting finished CLT product to the CFIC liquid dip coating stage 39.

As indicated at Block I in FIG. 14B, the finished CLT products are continuously transported and submerged through the dipping tank 39B of the dip coating stage 39 for sufficient coating in CFIC liquid 39H (i.e. biochemical liquid 93), while being transported on the conveyor-chain transport mechanism 32.

As indicated at Block I in FIG. 14B, continuously removing the wet dip-coated cross-laminated timber (CLT) pieces are continuously removed from the dipping tank 39B, and automatically stacked, packaged, and wrapped/labeled while wet with CFIC liquid coating, and allowed to dry within the package wrapping.

In the illustrative embodiment, CFIC biochemical liquid 34H of the present invention is used to form the CFIC surface coating onto treated wood/lumber products 40 produced on the production line of the factory 30 described above. The potassium citrate salt crystalline structures in the resultant fire inhibiting coating (i.e. CFIC surface) will cling to the surface of the CFIC-coated wood, while surfactants properties in its coalescing agent help to break the surface tension and allow potassium salt ions to penetrate ever so slightly the surface of the treated wood. This way, in the presence of a flame, the potassium citrate salt crystalline structures in the CFIC-coating on the surface of the fire-protected lumber, are present to interrupt the combustion phase of fire by one or more pathways including interferes with the free radicals (H+, OH-, O-) of the chemical reaction produced within the combustion phase of a fire, and breaking the fire's chemical reaction and extinguishes its flame.

Specification Of A Method of And Apparatus For Producing Fire-Protected Laminated Veneer Lumber (LVL) Product In Automated Factory System Using The Environmentally-Clean Biochemical Compositions Of The Present Invention In Accordance With The Principles Of The Present Invention

In many ways, LVL (Laminated Veneer Lumber) beams, headers, columns and studs provide a better alternative than traditional solid sawn lumber pieces, because engineered wood products (EWPs) are a stronger, stiffer, more consistent and more predictable building material. Also, when compared to similar sized sections, fire-protected LVL products can support heavier loads and allow greater spans than conventional lumber. Every LVL product is made from sheets of veneer. When these sheets are combined into a continuous piece of LVL, the effects of flaws in individual sheets are negated because they are spread throughout the cross-section of the piece, rather than being concentrated in specific locations, such as is the case with sawn lumber.

FIG. 15 shows a few pieces of Class-A fire-protected laminated veneer lumber (LVL) products (e.g. beams, headers, columns, studs and rim boards) 60A, 60B produced using the method and automated factory system 70 shown in FIGS. 16 and 16A. The Class-A fire-protected laminated veneer lumber (LVL) products 60A bear two fire protective coatings: (i) an under-layer surface-coating of Class-A fire-protection provided by a dip-infusion of environmentally-clean fire-inhibiting biochemical 93 (e.g. shown in FIGS. 6 through 6V4) which is applied to wood laminations used to build the LVL piece, and allowed to stack-dry (e.g. for 12-24 hours or so) before being adhesively glued together using biochemically-treated polymer resin adhesive 95′ shown in FIGS. 7A through 7D; and (ii) an optional, top-layer moisture, mold-mildew and UV protective coating 96 that is spray-coated over the Class-A fire-protected adhesively-assembled LVL product, using a spraying tunnel 81 to deposit a moisture, fire and UV protection coating 97 over the Class-A fire-protection coating. Optionally, an additional fire inhibiting biochemical liquid 93 can be sprayed over the adhesively-assembled LVL product before spray depositing a moisture, fire and UV protection coating 97 over the Class-A fire-protection coating, to provide additional fire inhibiting properties to the final LVL product.

FIG. 16 shows an automated factory system 70 for producing Class-A fire-protected laminated veneer lumber (LVL) products in a high volume manner in accordance with the principles of the present invention. As shown in FIG. 16, the factory 70 comprises a number of automated stages integrated together under automation and control, namely: a conveyor-chain mechanism 71 having numerous stages in the illustrative embodiment shown in FIGS. 16A and 16B, and a stage for delivering clipped veneer to the front of the LVL production line. The stage that delivers the continuous supply of clipped veneer is supported by five preceding stages, starting in the log yard, where veneer logs are delivered to the log yard for the LVL process. There, the logs, graded A and J and suitable for peeling, are debarked at a log debarking stage, and then bathed in a hot bath at the hot log bath stage, to increase the core temperature of the logs up to about 65 degrees Celsius. Such hot log bath equipment can be obtained from the Southern Cross Engineering Co. Then, at a lathe peeling stage, the wood lathe scans the log profile using multiple lasers, then centers the log for the most efficient recovery of material and peels the logs to a core diameter (e.g. 78 mm for the Raute Wood Lathe) to produce peeled veneers. Raute Corporation of Nastola, Finland supplies lathe peeling equipment for this stage. At the clipping stage, the peeled veneers are clipped to a wet width of approximately 1.4 meters and then stacked according to their moisture content. Equipment for supporting this stage is supplied by Babcock ₈ Wilcox.

As shown in FIG. 16, the LVL production line comprises, beyond its veneer delivery stage, an arrangement of stages, namely: a veneer drying stage 72 for receiving veneers from the supply and drying them in a controlled manner using, for example, a Babcock BSH, 22 bar, steam heated, six deck, roller veneer drier, supporting three stages of drying to reach a target moisture content of between 8 and 10%; a chain-driven conveyor for conveying the components and LVL products along subsequent stages of the production line; an automated veneer grading stage 73 for automatically structurally and visually grading veneers using a Babcock NovaScan 4000 camera for surface appearance, a Metriguard 2650 DFX for ultrasonic propagation time, and an Elliot Bay Cypress 2000 moisture detection system; a veneer scarfing stage 75C for scarfing veneer edges to a uniform thickness at the joints between veneers, during the subsequent laying-up stage and process; polymeric resin adhesive application stage 76 for curtain coating veneers preferably with biochemically-treated PMDI resin adhesive as taught herein in FIG. 7A through 7D using a Koch (1400 mm curtain coater, with PDMD resin adhesive supplied by Huntsman International; a lay-up stage (i.e. station) 77 for vacuum lifting veneers (core sheets, face sheets and make-up sheets) onto the processing line according to the press recipe, and stacking and skew aligning the veneers with adhesive coating until they are laid up into a veneer mat; a pre-pressing stage 78 for pressing the veneer mat together; a hot-pressing and curing stage 79 for continuous hot pressing (over an extending length (e.g. 40 meters) using a Dieffenbacher hot press with hot oil platens to complete cure of the adhesive resin 95′ applied to the pressed veneers, and produce an LVL mat having a length up to 18m long in size, a width of up to 1.2m, and a thickness between 12 and 120 mm; a cross-cutting and rip sawing stage 80 for cross-cutting and rip sawing the produced LVL mat into LVL products such as studs, beams, rim boards and other dimensioned LVL products; an optional sanding stage, employing orbital sanders; an inkjet print-marking and paint spraying system for marking each piece of LVL product (e.g. LVL stud, board etc.) with a branded logo and grade for clear visual identification; a spray tunnel 81 for spray-coating Class-A fire-protective LVL product 54E (feed with an auto-feeder) with a mold/mildew, moisture, fire and UV protective coating while the LVL product is being passed through a spraying tunnel 81, and then quick-dried in a drying tunnel 82 and then passed onto the final stage; a stacking, packaging and wrapping/labeling stage 83 using Dieffenbacher, Signode equipment, for packaging and wrapping/labeling the Class-A fire-protected LVL product in its wrapping, ready for forklift handling.

KALLESOE MACHINERY A/S of Bredgade, Denmark, offers complete turnkey LVL production lines for high-volume automated production of LVL products. Such systems comprise: presses and curing machines; automation and controllers. Such technologies and machines can be used to implement many of the stages described above in the LVL product production line of the present invention.

As shown in FIG. 16A, the biochemical-treatment (dip-infusion) stage 74 comprises a chain-driven conveyor subsystem supporting several parallel sets of chain-driven transport rails extending from the veneer grading stage towards a dipping tank, and then running inside and along the bottom of the dipping tank 74B (with biochemical liquid 93), and then running out thereof towards the veneer scarfing stage, as shown, having the capacity of handling studs and boards having a length up to 18 feet (6m) or so, as the production application may require.

In the illustrative embodiment, the dipping tank 74B has a width dimension of up to 32 feet to accommodate the width of the LVL product 74E being transported on chain-driven conveyor rails 74A1, 74A2 and 74A3 mounted and running outside of and also within the dipping tank 74B, as shown, and allowing sufficient dwell time in the CFIC liquid 74H during the dip-infusion process. As shown, the LVL products 74E are supported upon the chain driven rails 74A1, 74A2 and 74A3 while the LVL products 74E are transported through the dipping tank 74B while fully immersed and submerged at least 6 inches deep in CFIC liquid 74C contained in the dipping tank 74B, moving at the linear rate of 300 feet/minute through the dipping tank 74B during the CFIC dip-infusion process of the present invention. Electrically-powered driven motors are provided for the purpose of driving the chain-driven conveyors under computer control to transport LVL products along the production line. A level sensor 74F is used for real-time sensing the level of CFIC liquid 74H in the dipping tank 74B during production line operation. A reservoir tank 75K is provided for containing a large volume or supply of made up CFIC liquid 93. Also, a computer controller 74G is used for controlling the conveyor subsystem and an electric pump 74D is provided for pumping CFIC biochemical liquid 93 into the dipping tank 74B to maintain a constant supply level 74H during system operation in response to the liquid level measured by the level sensor 74F and controlled by the controller 74G.

The high-speed dip-infusion stage 74 may also include additional apparatus including, for example, liquid heaters, circulation pumps and controls for (i) maintaining the temperature of CFIC liquid solution 93 in the dipping tank 74B, and (ii) controlling the circulation of CFIC liquid 93 around submerged LVL product 74E being transported through the dipping tank in a submerged manner during the CFIC dip-infusion process. Controlling such dip infusion parameters may be used to control the amount and degree of absorption of CFIC liquid within the surface fibers of the LVL product as it is rapidly transported through the dipping tank 74B along the production line.

Notably, the dip infusion process of the present invention allows for the rapid formation a surface infusion, or surface barrier, in and through the surface of each piece of dipped LVL product, or in the presence of a surfactant added to the CFIC liquid in the dipping tank 74B, shallow impregnation of CFIC liquid 93 to occur into the lignocellulosic fibers of each LVL (lamination) piece 74E near atmospheric pressure (i.e. below 6 inches of liquid CFIC in the dipping tank) during the dip-coated process. It is understood that drip pans may also be provided beyond the dipping tank 54B, installed beneath the chain-driven conveyor subsystem 47 arranged between the dripping tank 54B and the packaging and wrapping stage 57 so as to recover excess CFIC liquid dripping from the dip-coated lumber pieces and returning this recovered CFIC liquid 93 to the dipping tank after appropriate filtering of the CFIC liquid if and as necessary.

As shown in FIG. 16B, the moisture, fire and UV protection is provided using the spray tunnel stage 81. As shown, the spray tunnel stage 81 comprises: a storage tank 55A for storing a large supply of moisture/fire/UV-protective liquid chemical 55B; a spray tunnel 81 for supporting an array of spray nozzles 81D1, 81D2, 81D3 arranged about the conveyor rails, operably connected to a liquid pump 55E connected to the storage tank 55A under controller 55F, to provide a 360 degrees of spray coverage in the tunnel 81, for spray-coating dip-infused LVL products within a controlled plane of moisture/fire/UV-protection liquid sprayed to cover 100% of surfaces of such LVL products 74E as they are being transported through the spray tunnel 81 at high-speed; and a drying tunnel stage 82 installed after the spray tunnel stage 81, for quick drying of spray-coated Class-A fire-protected LVL products, as they move through the drying tunnel 82 towards the automated stacking, packaging and wrapping stage 83 under the control of the subsystem controller. In the preferred embodiment, the moisture/fire/UV protection liquid sprayed in the spray tunnel 82 is formulated as follows: 75% by volume fire inhibiting biochemical liquid 93 shown in FIGS. 6 through 6U4; 25% liquid polymer compatible with the biochemical liquid 93; and 1.0-0.75 [cups/gallon] of Hy-Tech ceramic microsphere dust, as an additive.

As illustrated in FIG. 16, the automated stacking, packaging and wrapping stage 83 includes equipment designed to receive Class-A fire-protected LVL product 74E, automatically stack the fire-protected LVL product, package and wrap the product within a sheet of wrapping material (e.g. plastic, TVEK or other wrapping material) covering the top portion and at least half way down each side of the LVL product package 84, and then banding or strapping the wrapped package with fiberglass or steel banding, well known in the art. The wrapping will typically be preprinted with trademarks and logos of the lumber manufacturer's brand. Finally, the ends of the fire-protected LVL product 84 in the strapped, wrapped lumber package are painted with a Class-A fire-protective paint 97, also containing CFIC biochemical composition 93 (e.g. 25% by volume of biochemical composition 93) shown in FIGS. 6 from 6V4, to be effective in achieving Class-A fire-protection.

FIGS. 17A and 17B describe the high level steps carried out when practicing the method of producing bundles of Class-A fire-protected carbon-quantized laminated veneer lumber (LVL) product for use in fire-protected building construction.

As indicated at Block A in FIG. 17A, a high-speed fire-protected lumber production line is installed and operated in an automated lumber factory 70, provided with an automated high-speed dip-infusion stage 74 and spray-coating stage 81 installed on the production line, and (ii) an automated stacking, packaging and wrapping stage 83 installed at the end of the production line in the lumber factory 70.

As indicated at Block B in FIG. 17A, a supply clipped veneers are continuously loaded onto the conveyor/transport mechanism 71 installed along the LVL production line.

As indicated at Block C in FIG. 17A, the veneers are continuously provided to the controlled drying stage 72 of the production line so to produce suitably dried veneers for supply to the veneer grading stage 73 and subsequent stages.

At Block C in FIG. 17A, each LVL lamination is continuously transported and submerged through the dipping reservoir 74B at the CFIC-liquid dip-infusion stage 74 so as to apply CFIC liquid 93 to the surface of the dipped LVL product 74E at a coating coverage density of about 300 square feet per gallon of CFIC liquid 74H (i.e. FIG. 6 through 6V4). The dip-coated LVL laminations can be then wet-stacked in an automated manner using auto-stacking machinery, and then set aside and allowed to dry for a predetermined period of time (e.g. 24 hours) before the stack of dip-coated LVL wood is returned to the production line for continued processing.

In the illustrative embodiment, fire inhibiting biochemical composition shown in FIGS. 6 through 6U4 is used as the CFIC liquid solution 74H, for depositing the biochemicals of the present invention within the lignocellulosic fibers of treated LVL laminations being transported along the production line described above. The surface tension reducing chemicals contained in the CFIC biochemical liquid 93 will help to break the surface tension and allow chemical molecules to impregnate within the lignocellulosic fibers of the biochemically-treated LVL laminations 74E, without reducing wood fiber strength while providing Class-A fire protection.

As indicated at Block D in FIG. 17A, dried veneers are scarfed at the veneer scarfing stage 49 to prepare for the veneer laying-up stage 77 where the leading and trailing edges of each sheet of veneer are scarfed (i.e. lapped-jointed) in order to provide a flush joint when the veneer sheets are joined together at the laying-up stage of the LVL process.

As indicated at Block E in FIG. 28B, biochemically-treated adhesive material 95′ is applied by curtain coating at the adhesive application stage 76, to the surfaces of scarfed biochemically-treated veneers prior to the veneer laying-up stage 77.

As indicated at Block F in FIG. 17B, the veneers are vacuum lifted onto the processing line and stacked and skew aligned with adhesive coating until the veneers are laid up, at the veneer laying-up line 77, into a veneer mat of a predetermined number of veneer layers (i.e. ply).

As indicated at Block G in FIG. 17B, the veneer mat is pressed together at the pre-pressing stage 78 of the production line.

As indicated at Block H in FIG. 17B, the veneer mat is hot pressed in a hot-pressing/curing machine 79 to produce an LVL mat at the hot-pressing and curing stage 79 of the production line.

As indicated at Block I in FIG. 17B, the produced LVL mat is cross-cut and rip-sawed into LVL products (such as studs, beams, rim boards and other dimensioned LVL products) 74E at the cross-cutting and rip sawing stage 80.

As indicated at Block J in FIG. 17B, each piece of LVL product (e.g. LVL studs, boards, etc.) 74E is marked with a branded logo and grade for clear visual identification at the inkjet print-marking and paint spraying stage installed after the cross-cutting and rip-sawing stage 80.

As indicated at Block K in FIG. 17C, the Class-A fire-protective LVL products 54E are continuously feed through the spray tunnel stage 81 for spray coating a moisture/mold/UV-protective liquid coating 96 over the entire surface as each dip-coated Class-A fire-protected LVL product (e.g. stud) 54E is feed through the spray (or curtain coating) tunnel 8155.

As indicated at Block L in FIG. 17C, the Class-A fire-protected LVL product is quick-dried while being passed through the drying tunnel 82 disposed immediately after the spray tunnel 81. This produces a Class-A fire-protective LVL product with a moisture/fire/UV protective coating as it exits the production line, improving the durability of the Class-A fire-protective LVL product when exposed to outdoor weather conditions during the construction phase.

As indicated at Block M in FIG. 17B, Class-A fire-protective LVL product 84 is automatically stacked, packaged and wrapped at the automated stacking, packaging and wrapping stage 83, with trademarked wrapping, logos and the like.

In the presence of a flame, the alkali metal ions and or particles (i.e. molecules) of biochemical composition 93 embodied in the Class-A fire-protected LVL lumber 54E interferes with the free radicals (H+, OH-, O-) produced during the combustion phase of a fire, and breaks the free-radical chemical reactions in the fire and extinguishes its flame. This is a primary fire suppression mechanism implemented by the CFIC-coatings embodied within the wood materials, in accordance with the principles of invention, disclosed and taught herein.

Overview Specification Of The Methods of And Biochemical Compositions For Treating Wood Materials And Polymeric Resin Materials So As To Produce Fire-Protected And Corrosion-Protected Wood Products According To The Present Invention

The environmentally-clean (i.e. “green”) family of alkali metal salt biochemical compositions of the present invention, are schematically modelled in FIGS. 6 through 6V4, with the intention and understanding that such biochemical compositions can be formulated in either aqueous (water soluble) and dry powder, and mixed liquid/dry powder form, the user will have several options, despite water (H₂O) being shown in each model, for purposes of illustration, and not limitation, because water is nature's cleanest and greenest solvent, in almost all cases in the world of organic chemistry.

When Working With Solid Wood And Lumber, And Wishing To Provide Fire Inhibiting Properties

When working with solid wood and lumber, and wishing to provide fire inhibiting properties using one of the selected alkali metal salt biochemical compositions of the present invention 9, the user will have at least three possible options, as shown in FIGS. 6-6V4, 8A, 9-12, and 71-74 disclosed and taught herein.

Specifically, a preferred first method involve comprises spraying a liquid coating of the aqueous-based biochemical compositions 93 over the exterior surface of a component or finished product made from solid wood or lumber, at atmospheric pressure conditions, wherein the water contained in the biochemical solution 93 as a solvent will evaporate to the environment, and form an alkali metal salt crystalline coating that will bind to the lignocellulosic tissue of the wood, thereby inhibiting fire ignition, flame spread and smoke development in the presence of fire.

A less convenient, but feasible second method involves impregnating an aqueous-based biochemical composition 93 into the exterior surface of a component or finished product made from solid wood or lumber, wherein the alkali metal ions contained in the biochemical solution 93 will be dispersed into the lignocellulosic fibers of the wood materials, during pressure impregnation, and after removal from the pressure tank shown in FIGS. 72A through 73B, and allowed to remove water while drying in a drying room, alkali metal salt crystalline ion particles form within the lignocellulosic fibers of the wood, thereby inhibiting fire ignition, flame spread and smoke development in the presence of fire, without compromising significantly wood fiber strength.

A least preferred third method involves spraying a powder coating of the powder dry biochemical composition(s) 93 over the exterior surfaces of a wet/green (water-saturated) components or finished products made from solid wood or lumber, at atmospheric pressure conditions, wherein water molecules contained in the wood or lumber are allowed dissolve the applied dry powder biochemical composition coating 93, and alkali metal salt ions from the coating allowed to diffuse into and deposit within the shallow surface layer(s) of the lignocellulosic tissue of the wood, to help inhibit fire ignition, flame spread and smoke development.

When Working With Certain Engineered Wood Products (EWPs) Involving The Lamination Of Wood Components Such As Lamination Strips And Wood Veneers Substantially Larger Than Wood Chips, Strands, Fibers And Particles

When working with certain engineered wood products (EWPs) involving the lamination of wood components such as lamination strips and wood veneers substantially larger than wood chips, strands, fibers and particles, to make finger-jointed lumber products, LVL products, CLT products, 3-ply and multi-ply plywood products, the user will have a number of new and improved methods, biochemical compositions and enhanced polymeric resin materials, as shown in FIGS. 6-6V4, 7A-7D, 8B, 9-11A, 12-14B, 15-17C, 39-42B, 43-46B, disclosed and taught herein, for making such products with fire resistant/inhibiting properties, as well as other properties such as inhibition to mold/mildew, moisture and UV radiation.

When Working With Composite Wood Products, Such As OSB, MDF/HDE, PB, WFI, And Other Products Made From Lignocellulosic Wood Furnish Material

When working with composite wood products, such as OSB, MDF/HDF, PB, WFI, and other products made from lignocellulosic wood furnish material, the user will have a number of new and improved methods, biochemical compositions and enhanced polymeric resin materials, as shown in FIGS. 6-6V4, 7A-7D, 8C, 18-26B, 27-32B, 33-38B, 47-50B, disclosed and taught herein, for making such products with fire resistant/inhibiting properties, as well as other properties such as inhibition to mold/mildew, moisture and UV radiation.

In addition to the methods and compositions of the present invention being utilizable in producing diverse kinds of Class-A fire-protected composite wood products (e.g. OSB, MDF/HDF, PB, WFI, etc.), as well as finger-jointed lumber products, LVL products, CLT products, 3-ply and multi-ply plywood products and 3-ply bamboo products, the present invention can also be used to produce other kinds of home and office building products (e.g. roofing shingles, sheathing, siding, interior paneling, exterior paneling, flooring, ceiling panels, wall panels, etc.), as well as web stock for engineered wood I-beams; and sheathing and roofing in commercial buildings; and various uses in multi-unit residential housing applications. Such alternative fire-inhibiting applications shall also include fire-resistant products made from biodegradable plastic materials, other than synthetically-grown lignocellulosic plant material.

Overview On Selecting Optimal Blending Technology And Polymeric (pDMI) Resin Binder Materials For Use in Manufacturing Composite Wood Products In An Automated Composite Wood Product Factory or Plant System

By selecting the right polymeric resin blending technology, it is possible to further optimize the use of this resin and minimize maintenance costs and rejected boards.

When designing and operating a composite wood product manufacturing plant that is built for using a specific polymeric resin binder technologies, including pMDI resin, it is expected that multiple trials and process adjustments will be required to figure out the optimum press heats, line speeds, and other process variable settings. While it is possible to adapt and use any existing traditional blow line blending system for the purpose of blending and dosing/applying pMDI resin to wood furnish material along the manufacturing line, selection of the blending system will be based on many factors including the size and character of the particles comprising a given stream of wood furnish material that is being processed and used to make any given composite wood product.

During the manufacture of MDF, HDF and PB panels, selection the Dieffenbacher Group's EVOJet turbo-based resin blending system technology will offer significant advantages in controlling the pMDI resin droplet size as small as possible to be able to have a more efficient resin application; whereas more traditional blow line blending systems, using large tubes/lines or large drums, equipped with spray atomizing nozzles, blow polymeric resin binder material onto wood furnish material moving down (or being blown down) the “blow line” section of the system, as the case may be. Regardless of the blending technology used in any given application, it is a goal to allow the (uncured) pDMI resin binder material to move through and distribute the resin binder chemical throughout the fibers of the wood furnish. Also, it to avoid the harsh conditions of the dryers, it will be preferred to apply the pDMI resin onto dry fibers (i.e. resinate) along the line of the system, that is, reducing resin pre-cure and reducing resin dosage, and consequently, produces resin savings of up to 50%.

In the various embodiments of the systems and methods of the present invention disclosed herein, examples of different resin blending equipment/technology are given to teach the various ways of practicing the principles of the present invention. When making MDF, HDF and PD panels, it is preferred to use the Dieffenbacher EVOjet blending system (i.e. engine) to apply “biochemically-treated” Huntsman I-Bond® standard polymeric MDI (pMDI) resin binder material 95′, Huntsman I-Bond® OSB FC 4310 fast cure MDI resin binder material 95′, or Huntsman I-Bond® OSB FC 4312 fast cure MDI resin binder material 95′, to biochemically-treated dry wood furnish material 94′ during the MDF/HDF or PB panel production process. When making OSB panels, it is preferred to use the Dieffenbacher drum blending system to apply biochemically-treated Huntsman I-Bond® standard polymeric MDI (pMDI) resin binder material 95′, Huntsman I-Bond® OSB FC 4310 fast cure MDI resin binder material 95′, or Huntsman I-Bond® OSB FC 4312 fast cure MDI resin binder material 95′, to biochemically-treated dry wood furnish material 94′ during the OSB production process.

While it is standard to use an aromatic polymeric isocyanate resin binder (e.g. Covestro Mondur G-541 isocyanate) based on diphenylmethane-diisocyanate (MDI) when making the outer and core layers of fiber particle board (PB), it has been shown possible to make PB panels using a single-component PMDI prepolymer resin and achieve good results, while eliminating any possible pre-cure effect from the initial contact with the heated press platens. A key advantage of using a prepolymer PDMI resin binder material is that it requires no mill dosing equipment, and easy to handle (stable) with no apparent pre-curing of the resinated wood.

When using a single-component PMDI prepolymer to manufacture PB panels (or other panels such as OSB, MDF, HDF etc.), it will necessary to adjust resin parameters such as mat moisture, wax content, wood species, bin life, water, emulsifier, dimensional stability, while maintaining temperature-controlled conditions, and carefully observing resin binder curing characteristics, with the aim of achieving the following: (i) improved curing without the potential for pre-curing; (ii) shorter press cycles while maintaining binder stability and shelf life for the hot pressing process; (iii) greater PMDI prepolymer reactivity and shorter pressing times; and (iv) improved internal bonding (IB) properties of the panel board achieved by improved resin binder strength (e.g. achieving at least 100 psi. internal Bond Strength during sample testing).

When planning out the manufacturing of a particular type of panel (e.g. OSB, PB, or MDF), the user will choose panel manufacturing conditions using typical mill target criteria (e.g. particle board (PB) mill target criteria), calling for: Southern Yellow Pine furnish, using wood screened for particle size to meet manufacturing standards for panel production; moisture content of the wood which can be adjusted by hot air drying and/or by water spray addition (e.g. so wood moisture content is adjusted typically to 11% in the face material and 7.5% in the core material).

The polymeric (including prepolymeric) resin binder material (e.g. based on pMDI chemistry) can be selected for the core and layers of the OSB board, along with the use of release agents during pressing, with controlled temperatures and press times.

Once sample OSB panels are produced, the panels should be trimmed, sanded and conditioned for at least 48 hours under suitable conditions (e.g. at 25° C. and 50% humidity) and then the panels should be ready for testing of “internal bonds” using the ASTM Standard Test Method D1037-06A for Internal Bond Testing of Fiberboard and Wood Adhesives, and other Standard Test Methods For Evaluating Properties of Wood-Base Fiber and Particle Panel Materials by the ASTM International Organization.

To produce an OSB panel with sufficient strength, it will be helpful to (i) understand the effect that the Reaction Time and Reaction Temperature of the polymeric resin binder being used will have on resulting strength performance, and (ii) detect the existence of resin-wood covalent bonds in the final product. To support such product engineering research, nuclear magnetic resonance spectroscopy (NMRS) methods can be used to detect the existence of spectral peaks in the cured resins, that are consistent with existence of urethanes and a chemically complex polyurea-based network. Expectedly, the proportion of polyurea, biuret/polyuret, allophanate and polyurethane bonds detected in the resin test sample will be strongly influenced by wood moisture, temperature, time and wood species, all of which can influence productivity and panel properties.

Also, research should be conducted on panel samples to determine what effect the biochemical treatments of the present invention 93 disclosed herein actually have on (i) biochemically-treated lignocellulosic-based wood furnish material 94′ and (ii) biochemically-treated PDMI resin binder material 95′ of the present invention, and whether or not such biochemical treatments 93 actually lowered the onset (reaction) temperature and increased the resin reaction rate so as to create bonds more quickly. The reasoning is as follows: (i) if biochemical treatment of the polymer resin 95 can lower the onset temperature necessary for bond formation, then the OSB board may cure faster; (ii) an increased resin reaction rate, predictive of faster processing speed, could reduce the amount of (cure) time needed for the resin 95′ to form a strong internal bond network and bind biochemically-treated lignocellulosic material 94′ together in the composite wood product (i.e. panel). By carefully monitoring temperatures during the panel production process, one should be able to determine and detect temperature rises and rates of temperature change in the test production sample, and this information can be used to help tune the composite wood product production process.

When using a PMDI resin, which typically cures at 105° C. (221 F), one should look for the reactivity onset zone, which can typically occur between 40 to 80° C. When looking at the cure onset temperature, one should determine the time it takes for the resin binder material to reach 100 to 110° C., and other dynamics within the pressing machine, such as density, moisture content and wood species, which can swing these reactivity onset temperatures and cure onset temperatures plus or minus 5 degrees.

Once the PMDI resin temperature attains or reaches the curing temperature range of 100-110° C., a small reactivity peak should be detectable, followed by a decrease in reactivity. It is at this point that the PMDI resin is considered cured, and the cook time can be defined as the time it takes to cure a composite wood panel once it reaches its target (compressed) thickness in the thermal pressing machine, at which time the press is ready to open and the system transition to the de-gasing stage. A typical base cook time for a PMDI resin might be 130 seconds (or 2.2 minutes). When this cook time is reached, all of the IB (internal bond) strength in the composite wood panel should be high, and far exceed the 100 psi internal bond strength target, which is to be expected in typical composite wood panels. In a OSB board factory environment, correcting the bond strength issue (if needed) can be achieved by either (i) adding more press time which results in lower productivity, or (ii) increasing the polymeric resin binder content in the OSB panel, which leads to a shorter and faster efficient/economical production process. Typically, the setting and adjustment of these and other process parameters will be easily made by those skilled in the art without undue experimentation.

Producing New And Improved Fire-Resistant Lumber And Composite Wood Products With Improved Capacity To Inhibit Fire Ignition, Flame Spread And Smoke Development By Deeply Embodying Alkali Metal Ions And/Or Particles Within The Wood Furnish Material And Polymeric Resin Binder/Adhesive Materials Used During Composite Wood Product Manufacture, So That Alkali Metal Ions And Particles Are Freely Available Within Final Composite Wood Product And Capable Of Interfering With The Free Radical Chain Reactions Present In Incident Sources Of Fire

Notably, the new and improved alkali metal salt compositions of the present invention are derived from the short-chain fatty carboxylic acids of the present invention, where C is less than 8, and the alkali metal is selected from potassium, calcium, sodium and magnesium, as shown in FIGS. 6 through 6V4. These alkali metal salt compositions have the capacity to quickly dissolve into alkali metal ions in the presence of water and be highly absorbed into lignocellulosic cells of wood fiber.

While not to be held to or limited by any theory of explanation proposed or disclosed herein, it is expected that the alkali-treatment of the lignocellulosic cells of wood fiber, during the biochemical treatment of wood furnish materials according to the present invention, will increase the absorption capacity of potassium, calcium, sodium and magnesium ions, into all wood fibers with which the liquid biochemical compositions 93 of the present invention come into direct contact and diffuse into the lignocellulosic cells of the treated wood fiber, by way of liquid ion exchange and covalent bonding to carboxylate ions, as discussed in detail below.

The biochemical treatment of wood furnish materials of the present invention is a chlorine-free treatment eliminating the use of organochlorine compounds with high toxicity, and avoiding the creation of environmental problems.

Expectedly, there will be several advantages to using the monovalent-type alkali metals of potassium and sodium, over the divalent-type alkali metals of calcium and magnesium, when practicing the present invention, as discussed in greater detail below.

Divalent and monovalent are terms used to describe the valence or the number of electrons that an atom can gain, lose, or share in a chemical reaction. Divalent atoms have a valence of two, meaning they can either gain or lose two electrons to achieve a stable electron configuration. Examples of divalent atoms include calcium (Ca2+), magnesium (Mg2+), and oxygen (O2-). On the other hand, monovalent atoms have a valence of one, meaning they can gain or lose only one electron. Examples of monovalent atoms include sodium (Na+), potassium (K+), and chlorine (C1-). The difference in valence between divalent and monovalent atoms affects their reactivity and the types of chemical bonds they can form.

A comparison between the divalent alkali metals (i.e. calcium (Ca2+) and magnesium (Mg2+)) and monovalent alkali metals (i.e. potassium (K+) and sodium (Na+)) present in the biochemical compositions of the present invention 93 is set forth below for convenience:

| Attribute | Divalent | Monovalent |
|---|---|---|
| Definition | Containing two valence electrons | Containing one valence electron |
| Charge | Can have a charge of +2 or −2 | Can have a charge of +1 or −1 |
| Examples | Calcium (Ca), Magnesium (Mg) | Sodium (Na), Potassium (K) |
| Chemical Bonding | Tends to form ionic bonds | Tends to form covalent bonds |
| Electron | Outermost shell has 2 valence | Outermost shell has 1 valence |
| Configuration | electrons | electron |
| Ionization Energy | Higher ionization energy | Lower ionization energy |
| | compared to monovalent | compared to divalent |

Two important classifications of the compounds are divalent and monovalent compounds. The biochemical compositions of the present invention 93 employing potassium (K+) and sodium (Na+) shall be considered monovalent compounds, whereas the biochemical compositions of the present invention 93 employing calcium (Ca2+) and magnesium (Mg2+) shall be considered divalent compounds. Divalent and monovalent compounds differ in their valence, or the or the number of electrons an atom can gain, lose, or share to form chemical bonds.

One of the key differences between divalent and monovalent compounds lies in their chemical properties. Divalent compounds tend to be more reactive compared to monovalent compounds. This higher reactivity is due to the presence of two valence electrons, which allows for the formation of multiple bonds. Divalent compounds often participate in redox reactions, where they can both gain and lose electrons. On the other hand, monovalent compounds are generally less reactive compared to divalent compounds. This is because they have only one valence electron, limiting their ability to form multiple bonds. Monovalent compounds often participate in ionic bonding, where they transfer their valence electron to another atom.

Aside from their chemical properties, divalent and monovalent compounds also exhibit distinct physical properties. Divalent compounds tend to have higher melting and boiling points compared to monovalent compounds. This is because the presence of multiple bonds in divalent compounds leads to stronger intermolecular forces, requiring more energy to break these bonds and transition from solid to liquid or gas phase. Monovalent compounds, on the other hand, generally have lower melting and boiling points. This is due to the weaker intermolecular forces resulting from the presence of only one bond.

In conclusion, the fire-inhibiting divalent and monovalent compounds of the present invention differ in their valence and will exhibit distinct chemical and physical properties. Divalent compounds employing calcium (Ca2+) and magnesium (Mg2+), with their ability to form two chemical bonds, tend to be more reactive and have higher melting and boiling points. On the other hand, monovalent compounds employing potassium (K+) and sodium (Na+), with their ability to form only one bond, will and should be generally less reactive and have lower melting and boiling points. Both types of compounds play important roles in biochemical-based wood and resin treatment systems of the present invention.

When producing new and improved fire-resistant lumber and composite wood products having an improved capacity to inhibit fire ignition, flame spread and smoke development, it is believed and expected that both the divalent and monovalent classes of compounds of the present invention described above will be effective in delivering alkali metal ions and/or particles thereof within treated wood furnish material 94′ and treated polymeric resin binder/adhesive materials 95′ used during composite wood product manufacture, so that alkali metal ions and/or particles 98, shown in FIGS. 18A, 18B and 18C, are freely available within final composite wood product and capable of interfering with the free radical chain reactions present in incident sources of fire, thereby inhibiting fire ignition, flame spread, and smoke development.

However, it believed and expected that both the monovalent class of compounds of the present invention described above, employing potassium (K+) and sodium (Na+), should have an advantage over the divalent class of compounds of the present invention described above, employing calcium (Ca2+) and magnesium (Mg2+), because monovalent compounds are generally less reactive compared to divalent compounds, and more willing to participate in ionic bonding, where they transfer their valence electron to another atom, and thus the alkali metal ions and/or particles thereof within treated wood furnish material 94′ and treated polymeric resin binder/adhesive materials 95′m, should enjoy greater freedom freely within final composite wood product and capacity to interfere with the free radical chain reactions present in incident sources of fire, thereby inhibiting fire ignition, flame spread, and smoke development.

Understanding the attributes of divalent and monovalent fire-inhibiting compounds of the present invention, and the chemical and physical properties thereof, should be helpful and insightful when selecting particular fire inhibiting biochemical compositions from FIGS. 6 through 6V4 for use in treating lignocellulosic wood (and bamboo) fiber and polymeric resin binder materials used in composite wood product manufacture.

Specification Of Method Of and Apparatus For Producing Class-A Fire-Protected Oriented Strand Board (OSB) Sheathing Using The Biochemical Compositions Of The Present Invention Supported By An Automated Factory System

FIGS. 18, 18A, 18B and 19C show a piece of Class-A fire-protected oriented strand board (OSB) sheathing 90 constructed in accordance with the principles of the present invention. In general, OSB board is manufactured from recycled softwood strands that are compressed and bonded together with exterior grade, water resistant polymeric resin binders. OSB board is readily identified by the random pattern of flattened, softwood strands which make up its surface. OSB board can be used in place of other sheet materials, but due to the surface finish, it is generally restricted to areas where appearance does not matter. It can be provided with tongue and groove features for use on flat roof decking and flooring applications. OSB board can be sawn using either a hand or power saw.

During the composite wood product manufacturing process, wood furnish material (e.g. wood strands, chips, particles or fibers) 94 is biochemically-treated using one or more environmentally-clean fire inhibiting biochemical composition(s) 93 of the present invention as schematically illustrated in FIGS. 6 through V4, to produce biochemically-treated wood furnish material 94′. This treated wood furnish material 94′ is then binded together using biochemically-treated polymeric resin binder material (e.g. pMDI polymeric resin binder or adhesive material) 95′ schematically illustrated in FIGS. 7A through 7D. The biochemically-treated polymeric resin binder material 95′ comprises polymeric resin binder material 95 that is biochemically-treated using fire inhibiting biochemical composition(s) 93 of the present invention schematically illustrated in FIGS. 6 through V4.

As shown in FIGS. 18 and 18A the Class-A fire-protective OSB sheathing 90 comprises: a core medium layer 91, binded together with and between outer layers 92A and 92B. In general, each of these layers is made by the process comprising the steps of: (i) biochemically-treating lignocellulosic wood furnish material 94 to produce biochemically-treated wood furnish material 94′ using the liquid and/or dry powder biochemical compositions of the present invention 93 schematically represented in FIGS. 6 through 6V4; (ii) biochemically-treating polymeric resin binder/adhesive material 95 to produce biochemically-treated polymeric resin binder material 95′ also using the liquid and/or dry powder biochemical compositions of the present invention 93 schematically represented in FIGS. 6 through 6V4; (iii) applying biochemically-treated (pMDI-based) polymeric resin binder material 95′ to biochemically-treated wood furnish material 94′, and blending the materials together to produce resinated wood furnish material; (iv) shaping/forming the resinated wood furnish material into a product shape; and (v) pressing and curing the formed resinated wood furnish material to produce a finished composite wood product, in accordance with the composite manufacturing process.

Optionally, after the composite wood product is released from the press, the finished fire protected OSB product 90 may also be spray-coated with one or more biochemical compositions at a final stage of manufacture, to provide the finished composite wood product 90 with an extra outer layer of fire, mildew/mold, and/or moisture protection which may be required or desired during building construction, when roof, wall, and floor sheeting is exposed to the natural environment until the building is dried in. Also, the edges of the fire-protected OSB panel 90 can be painted and protected with a fire inhibiting and moisture-protecting chemical coating 97 formulated using (i) environmentally-clean fire inhibiting biochemical compositions of the present invention 93, (ii) colored pigment powder/liquid, (iii) liquid polymer material, and (iv) dispersing agent to form a desirable paint coating on the edges of the fire-protected composite wood product of the present invention.

FIGS. 18B and 18C show the biochemically-treated wood furnish material 94′ uniformly distributed and embodied with and binded together within a matrix-like or network-like arrangement of cured biochemically-treated polymer resin binder material 95′ in accordance with the principles of the present invention, so that alkali metal (i.e. potassium) ions or micro-particles 98, associated with the fire inhibiting biochemical treatment compositions of the present invention 93 (shown in FIGS. 6-6V4) are freely available throughout the entire composite wood product so as to inhibit fire ignition, flame spread, smoke development, as well as optionally, inhibit mold, mildew, microbial life and/or moisture.

In short, by integrating the fire inhibiting biochemical compositions of the present invention 93 into the treated lignocellulosic-based wood furnish material 94′ of the composite wood product 90, and preferably its polymeric resin binder material 95, it is now possible, during the composite wood product manufacturing process, to safely treat substantially the entire physical structure of the finished composite wood product and its structural components, with environmentally-clean fire inhibiting biochemical composition(s) 93. By doing so, it is possible to provide the entire finished composite wood product with alkali metal ions and/or particles 98, that are freely available to inhibit fire ignition, flame spread and smoke development in accordance with ASTM Class-A fire-protected standards, as well as, optionally, inhibit metal corrosion, mold/mildew and moisture in a significantly new and improved manner.

FIG. 19 shows an overview of a process for producing Class-A fire protected OSB panels 90 according to the principles of manufacture according to the present invention. The process comprises the steps of: (A) Log Sorting; (B) JackLadder; (C) Debarking; (D) Stranding; (E) Store in Wet Bins; (F) Drying; (G) Biochemical Blending (PDMI); (H) Drying; (I) Blending; (J) Forming; (K) Pressing; (L) Finishing Line; (M) Shipping.

FIG. 20 shows the automated factory 100, as generally depicted, and configured for producing Class-A fire-protected OSB sheathing in accordance with the principles of the present invention as described herein.

As shown in FIG. 20, the automated OSB panel factory 100 comprises a number of stages integrated together and configured to operate along a Class-A fire-protected lumber production line supported by an auto-feeding conveyor system 100E, comprising: a log sorting stage 100A for sorting, soaking and debarking logs to prepare for the stranding stage; a stranding stage 100B for processing the debarked logs to produce strands of wood having specific length, width and thickness; a strand metering stage 100C for collecting strands in large storage binds that allow for precise metering into the dryers; a drying stage 100D for drying the strands to a target moisture content and screening them to remove small particles for recycling; a biochemical strand (furnish) treatment stage 100F for applying one or more fire inhibiting biochemical compositions of the present invention (as illustrated in FIGS. 6 through 6V4), on the lignocellulosic-based wood furnish (i.e. strands) for biochemical treatment in accordance with the principles of the present invention; a drying and resinating stage 100G for drying the strands to a desired moisture content, and then coating the strands with a biochemically-treated polymeric resin binder (as illustrated in FIGS. 7A through 7D) and wax to enhance the finished panel's resistance to moisture and water absorption; a forming stage 100H for forming cross-directional layers of strands into strand-based mats; a pressing and curing stage 100I for heating and pressing the mats to consolidate the strands and cure the resins to form a rigid dense structural oriented strand board (OSB) panel; a cutting (finishing) stage 100J for trimming and cutting the structural OSB panel to size, and machining flooring and groove joints and applying edge sealants for moisture resistance; an edge-painting stage 100K for applying Class-A fire-protective paint to the edges of the trimmed and cut OSB panels; an (optional) top coating stage 100L for spray-coating the finished OSB panels with a moisture, fire and UV protection coating that supports weather during building construction while protecting the Class-A fire protection properties of the OSB panels; an (optional) spraying tunnel 100M (or curtain coating system) for spraying biochemical (CFIC) liquid of the present invention over the exterior surfaces of the OSB panels; a drying tunnel system 100N for drying treated OSB panels after the application of surface coatings at stages 100L and 100M, while being transported on the conveyor-chain transport mechanism; and a stacking, packaging and wrapping stage 1000 for stacking, packaging and wrapping dried spray-coated/dipped OSB panels into a bundle of Class-A fire-protected OSB panels or sheets (i.e. sheathing) 90.

FIG. 21 shows an exemplary OSB panel manufacturing process 110 carried out generally by the automated OSB panel fabrication factory 100 as generally represented by the system 100 shown in FIG. 20, wherein each of the stages of manufacture are graphically depicted to illustrate the functions performed along the multi-stage fabrication process of the present invention, including the treatment of wood furnish materials (e.g. wood strands) and resin adhesives (e.g. pDMI resin binders) used during the manufacturing process. As shown in 21, the process is supported by the following stages of equipment, namely: a log feed stage 110A; a log deck stage 110B; a debarker stage 110C; heating/conditioning pond 110D; waste conveyors 110E; chipper (strand) stage 110F; wet storage stage 110G; a drum dryer stage 110H; OSB strand spray treatment stage 110J; wet storage stage 110K; resin, wax and biochemical mixer/blender (i.e. resinator) stage 110M; former stage 110N; precision release agent and surface moisture spraying system 1100; microwave heating stage 110P; hot press stage 110Q; and trimmer stage 110R.

It will be helpful at this juncture to further specify in greater detail certain of these process equipment items, and the operations they need to perform to fulfill their assigned functions along the composite wood (OSB) product manufacturing process.

FIG. 22 shows a view of the drum-type drying stage (i.e. dryer) employed in the OSB panel production line of the present invention shown in FIGS. 20 and 21, wherein biochemically-treated wood furnish material 94′ is fed into the input handler of the drum-type drying stage 110H, flows through the drum structure to the outfeed port, while water (i.e. moisture) is evaporated from the wood furnish material 94 flowing the through the barrel structure, along with the forced hot air flow, under computer sensing and control system, so as to produce wood furnish material 94 having a specified outflow water/moisture content % required for biochemical treatment with biochemical composition 93.

FIGS. 23A and 23B show the drum-based wood strand spray treatment stage 110H employed in the OSB panel production line of the present invention shown in FIGS. 20 and 21. As shown, biochemically-treated wood furnish material 94′ having a specified moisture content % is being fed into the input handler of the OSB strand spraying drum stage 110J, and then sprayed with environmentally-clean biochemicals 93 using atomizing spray nozzles arranged therein, as the wood furnish materials 94 flows through the elongated drum structure under control system control.

FIG. 24 is a schematic illustration providing a first view of the resin and biochemical mixer/blender (i.e. resonator) stage employed in the OSB panel production line of the present invention shown in FIGS. 20 and 21, wherein precisely metered amounts of liquid pMDI resin 95′ and environmentally-clean biochemicals (including liquified waxes) 93 are fed into the mixer/blender to produce a resin/additive emulsion that is sprayed over wood furnish materials 94 flowing through the treatment drum using spray atomizing nozzles under precise temperature control so as to uniformly cover the surfaces of the wood furnish material (i.e. strands) 94 so the biochemicals can infuse into and biochemically treat the biochemical structures within each strand to impart specified properties and characteristics thereto (i.e. inhibition to/protection against fire, mold, mildew an moisture);

FIG. 25 shows the precision release agent and surface moisture spraying system/stage 1100 employed in the OSB panel production line of the present invention shown in FIGS. 20 and 21, wherein precisely metered amounts of release agent and water 95E are sprayed onto the layered mat of wood furnish material 14 prior to compression and curing in the forming stage of the system 100.

FIGS. 26A and 26B describes the high-level steps carried out when practicing the method of producing clean Class-A fire-protected OSB sheathing 90 in the automated factory system 100 in accordance with the present invention, as illustrated in FIGS. 20 through 25.

As indicated at Block A in FIG. 26A, in an automated factory 100 configured for automated production of Class-A fire-protected OSB sheeting, an edge painting stage 65J, an CFIC liquid dip-coating (i.e. biochemical treatment) stage 67, a spray tunnel stage 67, and a drying tunnel stage 68 are installed along the lumber production line.

As indicated at Block B in FIG. 26A, logs are sorted, soaked, and debarked at stage 65A to prepare for the logs for the stranding stage 65B.

As indicated at Block C in FIG. 26A, the debarked logs are processed at the stranding stage 65B to produce strands of wood (i.e. wood furnish material) 94′ having specific length, width, and thickness dimensions.

As indicated at Block D in FIG. 26A, at the strand metering stage 65C, the biochemically treated strands 94′ are collected in large storage binds 110K that allow for precise metering into the drum-type dryers 110H.

As indicated at Block E in FIG. 26A, the strands are dried at the drying stage 65D to a target moisture content and screening them to remove small particles for recycling. OSB strands have a high initial moisture content (40-75%) which needs to be reduced to a range of 5-10% for proper manufacturing and board stability. To achieve this, the strands are fed into large, rotating dryers that use hot air to evaporate the moisture. These dryers can be either single-pass or multiple-pass. The temperature inside the dryer can reach high levels, sometimes as high as 1500 degrees Fahrenheit at the entrance and lower at the exit. The TrilliumTM and Diamond Roll are screen types used to separate the OSB strands into different size fractions, which aids in the drying process, helping with efficient fines removal and strand retention. Preferably, an AI machine learning system is used to automatically analyze thousands of data points being monitored along the production line during the OSB manufacturing process, and automatically change the dryer settings in response to monitored changes using adaptive AI-assisted control.

Preferably, at the OSB plant, before the biochemical wood furnish treatment stage, the wood strands 94 are dried using sets of multi-pass dryers, where the wood strands are dried to a particular moisture content (MC) % (e.g. 3-10% MC, and preferably 5% MC) so as to optimize the rapid absorption of alkali metal ions (provided by biochemical solution 93) into the lignocellulosic fibers of the wood furnish material 94.

As indicated at Block F in FIG. 26B, the wood furnish (strands) 14 are coated with fire inhibiting biochemicals 93, then the treated strands 94′ are dried in the drying drum, and then the dried treated strands 94′ are resinated (i.e. blended) with treated polymeric resin binder material 95′, for inhibiting fire ignition, metal-corrosion, and mold/microbes. The treated wood furnish material 94′ blended with biochemically-treated polymeric resin 95′, to provide resinated treated wood furnish material 94′/95′.

As indicated at Block G in FIG. 26B, cross-directional layers of dried and resinated strands 94′ are formed into a continuous strand-based mat at the mat forming stage 65G. At the OSB Forming Station, the resinated treated wood strands 95′/94′ are formed to an equal and calibrated multilayer OSB mattress. The mat is formed of two symmetrical surface layers with length-oriented strands, optional intermediate layers, and a core layer of various finer strands with cross orientation. However, OSL Forming Station orients both surface layer and core layer strands lengthwise. Notably, the strength of oriented strand board (OSB) is measured by the modulus of rupture (MOR) of the OSB panel, which depends on the fiber orientation on OSB surface. Thus, to improve the quality of OSB products, it is essential to optimize the flake alignments of the wood strands. At the Forming Station, a real-time AI-assisted strand inspection system can be deployed, trained and configured for automated detection and recognition of the wood strand patterns in the mat structure, and automatically generate commands to automated robotic machinery adapted to correct the physical orientation of specific strand regions in the moving mat as it is transported down the conveyor belt.

After strand-based mats are formed, and prior to pressing and curing, the mats are sprayed with moisture for quick temperature transfer to the mat's core during press process. High-precision spray system consisting of two units for spraying water onto the forming belt and onto the material to be pressed. If desired, additives (e.g., release agent) can be added to the water. After spraying with water, the mats are transferred through a microwave heating station to heat up the wet mat to a desired temperature into the pressing machine.

As indicated at Block H in FIG. 26B, the mats are heated and pressed at the pressing and curing stage 65H to consolidate the strands 94′ and cure the resins 95′ and form a rigid dense structural oriented strand board (OSB) panel (i.e. layer).

As indicated at Block I in FIG. 26B, at the finishing stage 65I, the structural OSB panel is trimmed and cut to size, and groove joints machined, and edge sealants applied for moisture resistance.

As indicated at Block J in FIG. 26B, Class-A fire-protective paint (containing CFIC liquid, 25% by volume) 97 is applied to the edges of the trimmed and cut OSB panels, at the edge painting stage 65J.

As indicated at Block K in FIG. 26B, OSB panels are transported through the spray coating stage and spraying each panel with liquid polymer containing biochemical liquid 93 for inhibiting mold, mildew and microbes, moisture and UV radiation protection, so as to support weather protection during building construction.

As indicated at Block L in FIG. 26B, the spray-coated dipped OSB sheets 90 are transported through a drying tunnel at stage 68.

As indicated at Block M in FIG. 26B, dried spray-coated OSB panels 90 are stacked, packaged, and wrapped into a bundle of Class-A fire-protected OSB panels at the stacking, packaging, and wrapping stage 65K.

As shown and described above, the lumber factory 100 is configured for producing Class-A fire-protected OSB sheathing 90 fabricated in accordance with the principles of the present invention.

In summary, fire-protected OSB panels of the present invention 90 can be made by the following process: (i) providing wood furnish material 94; treating the wood furnish material 94 with a fire inhibiting biochemical composition of the present invention 93, to provide biochemically-treated wood furnish material 94′ having fire inhibitor/resistance and other desired properties; (ii) treating a polymeric resin binder material 95 with a fire inhibiting biochemical composition of the present invention 93, to produce a biochemically-treated polymeric resin binder 95′; (iii) blending the treated wood furnish material 94′ with the treated polymeric resin binder material 95′ to provide a blend of resinated wood furnish material 94′/95′; (iv) forming the resinated wood furnish material 94′/95′ into a desired product shape; and (v) pressing the formed product made from treated wood furnish materials 94′/95′ to form fire-protected composite wood boards having desired dimensions and other desired properties for the application at hand.

In general, different methods can be used to produce wood furnish materials for any specific application. For example, the wood furnish material 94 can be prepared by various conventional techniques. For example, debarked pulpwood grade logs, or so-called roundwood, can be converted into a furnish in one operation with a conventional roundwood flaker. Alternatively, logs, logging residue, saplings, etc. can be cut into fingerlings on the order of 0.5 to 3.5 inches long using a conventional device, such as a helical comminuting shear or other tool, and then the fingerlings can be flaked using a conventional ring-type flaker well known in the OSB panel art.

During the manufacturing process, as illustrated in FIG. 21, produced OSB strands are transferred to a primary (wet) strand storage bin 110G after processing by the wood chipper 110F. From the primary strand bin, the strands are metered out and pass through a screening operation to remove undesirable fine material. The strands are transferred from the storage bin to a dryer chute at a continuous rate depending upon the floor speed of the bin, by a separating the strands from one another into individual flakes. For purposes of the present invention disclose, the term “flake” wood “strand” can and will be used interchangeably, and understood to be an example of “wood furnish” material, from which composite wood products can be made.

In general, wood furnish material 94 can be produced in different ways including by milling, planing, sanding, sawing, or other wood processing operations that produce waste that can be processed into a suitable wood furnish material adapted to the composite wood product process at hand. Preferably, wood furnishes made from processed woods should be classified in size. The size of the flakes is not regarded as critical, and the flake size may and typically will vary from embodiment to embodiment of the present invention, without departing from the scope of the invention. In particular, wood fibers having dimensions smaller than those provided for OSB board are commonly used for manufacturing medium density fiberboard (MDF). Also, particleboard (PB) can be made from wood flakes having major dimensions of about 0.5 to 1 inch and a thickness of about 0.01 to 0.015 inch. However, it is understood that flake dimensions for use in particleboard manufacture may be even smaller, and should not be taken as limiting the present invention.

When manufacturing oriented strand board (OSB) panels, it is necessary to properly align the wood furnish flakes (or strands) 94, and this proper alignment can be achieved by ensuring the flakes (or strands) 94 are several times as long, as they are wide, for example, about 4 to about 10 times as long as they are wide. As a guide, the average width of OSB wood flakes 94 generally can be from about 0.1 to about 2.5 inches, and alternatively, can be from about 0.1 to about 0.5 inch, with an average thickness of about 0.015 to about 0.025 inch. While typical, these numbers are not critical to practicing the present invention. Non-oriented composite wood products, like particleboard (PB) and medium density fiberboard (MDF), can be made from more compact flakes (i.e. wood furnish material) 94 that can be about as wide as they are long, in size or physical dimension.

The wood furnish material used to make OSB wood products can be assembled or maintained as one or more strata or layers of wood furnish 94. In each layer, the wood furnish material can have a grain direction extending generally parallel to the machine direction (i.e. in the direction of travel of wood through the manufacturing process). In one embodiment of OSB manufacture, at least 90% of the wood particles in the treated wood furnish material 94′ are oriented in the direction of travel, although it is understood that orientation can and will vary from embodiment to embodiment, to meet the requirements of the application.

As commonly used in the art, the term “green wood” includes both (1) wood that has not been dried; and (2) wood that has been dried and then has been rewetted back to a moisture content of at least about 30% MC (moisture content). In theory, specifying the moisture content (MC) of wood furnish material 94 is simply determined as the amount of water contained in the mass composition of a sample of wood furnish material 94, compared to the weight of everything and anything else that may be contained in the wood furnish material 94. The use of a green wood furnish ensures that the penetration of the fire inhibiting (i.e. fire retarding) treatment 93 is maximized. The “fiber saturation point” of wood, at which the fibers are saturated with water, is generally considered to be about 30% moisture content (MC) based on dry wood weight, and is dependent on the wood species of the wood furnish material. The moisture content of a green wood furnish commonly exceeds the fiber saturation point thereof (i.e. 30% MC point). Preferably, the fire inhibiting biochemical compositions of the present invention 93 can be applied to wood furnish material having a moisture content (MC) below or above the (30% MC) fiber saturation point of the wood furnish material being treated with the biochemical composition 93. Thus, the biochemical wood treatment method of the present invention can be carried out using either (i) green wood furnish material 94, (ii) dried wood furnish material 94, or (iii) wood furnish material 94 containing any amount of moisture, including moisture levels characteristic of green flakes.

If necessary or desired in any given instance, the wood furnish material 94 can be partially dried prior to classification to prevent the wood particles from sticking together, thus assisting classification, or to provide other benefits. However, in general, wood furnish material 94 can be classified and used when very moist, and while meeting one of the moisture content (MC) ranges contemplated when practicing the present invention.

Preferably, the moisture content of the wood furnish material 94, just before biochemical treatment stage, may be at or above the saturation point of the wood, alternatively on the order of from about 3% to about 80% by weight (based on the weight of dry wood), alternatively from about 5% to about 40% by weight. The moisture content may optionally be from about 60% to about 80% by weight, optionally from about 50% to about 70% by weight, based on the weight of dry wood. Moisture contents outside these ranges that are found in green wood are also contemplated. Alternatively, the moisture content to which the furnish material is dried may be on the order of from about 20 weight % to about 3 weight % or less, based on the dry weight of the wood furnish material 94.

The class of fire inhibiting biochemical compositions 93 contemplated for use with the methods and systems of the present invention, are illustrated in FIGS. 6 though 6V4. Preferred examples of environmentally-clean alkali metal salts of carboxylic acids 93 for selection and use in practicing the present invention are specified in great detail in FIGS. 6C1 through 6V4, and most notably, avoid altogether any use of monoammonium phosphate (MAP), diammonium phosphate (DAP), ammonium/phosphate salts (AMP), and/or other organic phosphate salts. A preferred alkali metal salt for practicing the present invention is tripotassium citrate (TPC), used with triethyl citrate (TEC), an ester of citric acid. Specification of useful formulations of these biochemical compositions 93 is disclosed in great detail hereinabove.

Preferably, rate of addition (i.e. addition rate) for adding the fire inhibiting/retardation treatment (FRT/FIT) composition 93 to the untreated wood furnish material 94 may range from 2% by wt. of active ingredient to 40% by wt. of active ingredient, referenced against the total weight of the material being treated (e.g. wood furnish material). More preferably, the rate of addition of the fire inhibiting biochemical 93 (based on TPC and TEC) will be between 5% to 30%, and more preferably between 10% to 20% by wt. of active ingredient. In general, the final fire resistance/inhibiting properties of the finished composite wood panel will be proportionally linked to the weight percentage of fire inhibiting biochemical composition 93 incorporated or embodied within the material composition of the wood furnish material 94 using the biochemical treatment methods of present invention.

After treating wood furnish particles 94 with the fire inhibiting biochemical composition of the present invention 93, it will be useful to allow the wood furnish particles 94 to remain in physical contact with the aqueous-based biochemical treatment solution 93 (i.e. dry powder biochemical composition 93) to provide the biochemical composition 93 sufficient time to disperse, migrate, penetrate and coalesce within the lignocellulosic fibers of wood furnish particles 94. This step is particularly contemplated if the wood furnish particles are green (wet) and thus retain a substantial proportion of water. When using liquid biochemical compositions 93, this contact time allows for alkali metal ion exchange to occur between (i) the water in the wood furnish particles and (ii) the water contained in the biochemical solution, thereby allowing the diffusion of fire retardant salts (i.e. alkali metal ions) into the lignocellulosic fibers of the wood furnish particles being treated. While at least 5 minutes of contact time is contemplated, it is understood that more or less contact time may be useful in certain condition and circumstances.

During biochemical treatment according to the present invention, wood furnish material 94 can be blended with any fire inhibiting biochemical composition 93 in liquid form, along with other additives that will service other functions such as inhibiting mold, mildew, microbial, and moisture. Yet another alternative is to apply the fire inhibiting biochemical composition 93 in dry powdered form to the green/wet wood furnish material (i.e. OSB flakes) 94 being biochemically treated. The biochemical composition 93 absorbs the water content in the wood furnish material 94 and is then dissolved by the water molecules to produce alkali metal ions for dispersion/diffusion into the lignocellulosic fibers of the wood furnish material. This further reduces the amount of water that must be dried from the flakes (i.e. furnish material) prior to biochemical treatment, and subsequent blending with polymeric resin binder material 95 during resination operations, thereby reducing energy costs.

Once biochemically treated as described above, the treated wood furnish material 94′ is formed into a loosely felted, layered mat (single or multi-layered), which may be made continuously in a roller process or as discrete billets in a molding process. In general, sufficient pressure (with or without heat) is applied to the mat by a roller, press, or other means to compress it to the desired thickness and shape for the structural member being made and to bond the wood furnish together.

As illustrated in FIG. 21, fire-inhibiting treated wood furnish material 94′ is dried using conventional drying equipment (e.g. drying drum or drying belt machine) 110H to a moisture content (MC) appropriate to the type of polymeric resin binder application system 95 that will be used and the composite wood product that will be made. This can range from 0.5% to 25% MC based on the oven-dry density of the wood furnish material 94.

The water repellence or moisture resistance of composite wood products can be improved by spraying a liquid wax emulsion onto the biochemically-treated (i.e. fire-treated) wood furnish particles 95′, during or after the wood furnish and resin binder blending step. In general, the wax additive can be, for example, an aliphatic or paraffinic petroleum product commonly known as slack wax recovered from petroleum hydrocarbons. Preferably, molten or emulsified wax is applied to the wood furnish particles 94 at the same time treated resin binder 94 is applied to the treated wood furnish materials 94′. In general, the amount of wax added is about 0.5 to about 5 weight %, as solids, based on the dry weight of the particles. Alternatively, the amount of wax can be at least about 1% of the oven dry weight of the wood furnish particles. Alternatively, the amount of wax can be at least about 2% of the oven dry weight of the wood furnish particles. The wax or other water repellant may be added after the biochemical-based fire resistance treatment, preferably with the resin binder application stage, but preferably is not added before the fire resistance treatment step. By adding fire resistance treatment, before water repellant treatment, allows the alkali metal salt ions (from biochemical treatment) to penetrate deeper into the lignocellulosic fibers of wood furnish particles 94, before the water repellant is added to the wood furnish material 94 so as to exclude water.

When applying a suitable polymeric resin binder or adhesive (i.e. pDMI polymeric resin binder) 95 to wood furnish martial 94 to bind the particles together, careful attention should be given to the choice of thermosetting polymeric resins. FIGS. 7A through 7B illustrate different kinds of polymeric resin binders (modelled after Huntsman International's MDI resin binders) that may be used in the manufacture of oriented strandboard (OSB), particleboard (PB), fiberboard (MDF/HDF). While MDI-based resin systems are preferred for the reasons discussed and disclosed herein, it is understood that other chemical wood particle bonding systems may be used with good results, but not with the advantages of MDI polymer resins. For example, alternative polymeric resins systems and materials that may be used when practicing the present invention may include, for example: phenolic, urea formaldehyde (UF), phenol formaldehyde (PF) in a liquid or powder state, liquid melamine urea formaldehyde (MUF), resorcinol-formaldehyde (RF), melamine-formaldehyde (MF), urea-furfural, condensed furfuryl alcohol, acid catalyzed PF resins (commonly known as Novalac resins), isocyanate (MDI), or combinations of those resins.

In general, the particular type of polymeric resin binder used will depend primarily upon the intended use for the composite wood product. For instance, composite wood products made with urea-formaldehyde (UF) resins have sufficient moisture durability for many uses that involve minimal exposure to moisture, but generally cannot withstand extended outdoor exposure. Phenol-formaldehyde (PF) and melamine-formaldehyde (MF) resins provide composite wood products with durable properties required for long-term exterior applications. pDMI polymeric resins have the advantage of providing moisture resistance, without the production of formaldehyde off-gassing.

Rates of Addition (i.e. Addition Rates) of biochemical compositions 93 into polymeric resin binder material 95 may vary from 1% to 20% resin solids depending on panel type and application. Preferably, when a pMDI resin binder from Huntsman International (e.g. IBOND OSB FC 4312) is used for OSB panel production, the rate of addition of the fire inhibiting biochemical composition 93 (selected from FIGS. 6 through 6V4 and 7A-7D) may range from about 2% to about 30% for the active biochemical ingredient. Under normal circumstances, the use of this pMDI resin does dictate the use of an acid catalyst, but when using other resin binder that do require an acid catalyst, the catalyst addition rates that may vary from 0.5% to 15% on a liquid to liquid basis.

In general, the polymeric resin binder 95 can be biochemically treated (for fire resistance, mold resistance, mildew, microbe and moisture resistance) using the fire inhibiting biochemical compositions 93 of the present invention, in either a preferred dry powder formulation, or a liquid water containing formulation. Preferably, the rate of addition of the biochemical composition 93 to the resin binder can range from 2% to 30% by weight. Once biochemically treated with biochemical composition 93, the treated polymer resin binder 95′ is blended with the wood furnish particles 94 in either dry or liquid form. To maximize coverage of the wood furnish particles 94, the biochemically-treated polymeric resin binder 95′ can be applied by spraying droplets of the resin binder in liquid form onto the particles as they are being tumbled or agitated in a drum blender described hereinabove.

Any processing equipment can be used to prepare the treated wood particles 94′. For example, the particles can be circulated in a rotating drum mixer and sprayed with the fire resistance treatment (FRT), wax, and binder using one or more Coil spinning disc atomizers.

During the resination stage of the manufacturing process, biochemically-treated (fire-resistant) wood furnish material 94′ dried to a specified moisture content (e.g. 8% MC) is (i) sprayed with biochemically-treated pDMI polymeric resin binder material and wax 95′, (ii) formed and oriented into a mat of the desired thickness, and (iii) pressed into the final composite wood panel.

Using suitable panel forming and compression apparatus, the treated wood furnish particles 94′, once blended with biochemically-treated resin binder material 95′, is formed into a generally flat, loosely-felted mat of treated and resinated wood furnish material 94′/95′, having one or more layers. The formed mat is then placed in a suitable press and compressed to consolidate the wood furnish particles 94′ and polymeric resin binder material 95′ into a wood composite product of the desired size and cross-sectional shape.

For example, when forming a single layer mat, the resinated wood furnish particles 94//95′ can be deposited on a plate-like carriage that is carried on an endless belt or conveyor structure, moving from one or more hoppers spaced above the belt in the direction of travel, for depositing the treated and resinated wood furnish material 94′/95′. When forming a multi-layered mat of treated and resinated furnish material 94′/95′, a plurality of hoppers can be used, wherein each wood furnish mat is formed under a dispensing or forming head extending across the width of the carriage for successively depositing a separate layer of treated wood furnish particles, as the carriage is moved beneath the forming heads.

In practice, the wood furnish mat formation process can be carried out using a batch method, or a continuous method. Using a batch method, the individual sheets of the wood composite material 94′/95′ can be molded by treating an appropriate volume of treated wood furnish particles 94′ blended with the treated binder resin 95′, and heating, pressing and curing the treated furnish material 94′/95′ into a finished composite wood product. Using a continuous method, the process can be carried out by feeding treated particles 94 in the form of a continuous web or mat, through a heating and pressing zone defined by upper and lower continuous steel belts, through which the necessary heat and pressure are applied to the mat of resinated treated wood furnish material 94′/95′.

The thickness of the wood furnish mat 94′/95′ will vary depending upon factors such as: the size and shape of the wood furnish particles; the particular technique used in forming the mat; the desired thickness and density of the structural member or component; and the compression pressure used during composite wood product manufacture. The mat thickness usually is about 5 to 6 times the final thickness of the structural member or component. For example, for a structural component having a 1-inch thickness and a density of about 40 lbs./ft3, the mat usually will be about 5-6 inches thick. If the mat is substantially thicker than this measure, then it usually must be partially pre-compressed to a reduced thickness, using rollers or the like prior to introduction into the pressing machine stage.

In general, the pressing temperatures, pressures, and times vary widely depending on the thickness and the desired density of the structural member or component, size and type of wood particles, moisture content of the particles, and the type of polymeric resin binder material used during the composite wood product manufacturing process.

The pressing temperature should be sufficient to at least partially cure the resin binder material 95′ and expel water from the mat within a reasonable time period, without charring the wood. Generally, a pressing temperature ranging from ambient (for room temperature-curable binders) up to about 450 degrees F. (230 degrees C.) can be used. Temperatures above this threshold can cause charring of the resinated/treated wood furnish particles. Preferred pressing temperatures will be known for a give polymeric resin binder material selected for the manufacturing process.

The pressing pressure should be sufficient to press the resonated/treated wood furnish particles 94′ into intimate contact with each other, but without crushing them to the point causing a breakdown of the lignocellulosic fibers, which will likely result in a degradation of structural integrity. The pressing pressure usually is about 325 to about 500 PSIG, but may vary across different embodiments of the present invention.

The pressing time should be sufficient to partially cure the polymeric resin binder material 95′ to a point where the composite wood product or component (layer) has sufficient integrity for handling. The press cycle typically is about 2 to about 20 minutes; however, longer times can be used when pressure-curing binders are employed or when more complete curing of thermosetting binders is desired or required.

During the pressing and curing stage, formed and treated wood furnish mats are pressed and cured under heat and pressure conditions appropriate to the final end use of the finished composite wood product. Typical press parameters include consolidation pressures ranging from 50 PSIG to 650 PSIG, cook pressures 0 PSIG to 400 PSIG, and a de-gas cycle. Typical press temperatures vary from 200 degrees F. (93. degree. C.) to 550 degrees F. (290. degree. C.), depending on the type of composite wood product being manufactured and polymeric resin binder material 95 being used. Press time may vary from 1 minute to 20 minutes duration, but shorter press times will support higher output production rates.

Once formed, the pressed composite wood product (e.g. board) may be cooled, stacked to allow time to lapse and air circulation to flow, and then sanded to uniform smoothness and thickness, in a conventional manner. Expectedly, it is believed that when biochemically-treated (i.e. fire-resistant treated) wood furnish material 94′ is used in combination with the biochemically-treated pMDI polymeric resin binder material 95′ described above, the level of catalyst or reactant (e.g. water) needed to cure the treated polymeric resin binder 95′ can be reduced, potentially to zero, while at the same time permitting the manufacture of composite wood panels to produce panels having excellent mechanical and physical properties.

Specification Of A Method Of Producing Class-A Fire Protected Wood Fiber Insulation (WFI) Board Produced Using An Automated Factory

FIG. 27 shows a piece of fire-protected wood fiber insulation (WFI) board 130 produced using the automated factory schematically represented in FIG. 28. During the composite wood product manufacturing process, wood furnish material (e.g. wood particles and/or fibers) 94 is biochemically-treated using one or more environmentally-clean fire inhibiting biochemical composition(s) 93 of the present invention as schematically illustrated in FIGS. 6 through V4, to produce biochemically-treated wood furnish material 94′. This treated wood furnish material 94′ is then binded together using biochemically-treated polymeric resin binder material (e.g. pMDI polymeric resin binder or adhesive material) 95′ schematically illustrated in FIGS. 7A through 7D. The biochemically-treated polymeric resin binder material 95′ comprises polymeric resin binder material 95 that is biochemically-treated using fire inhibiting biochemical composition(s) 93 of the present invention schematically illustrated in FIGS. 6 through V4.

As shown in FIG. 27, the Class-A fire-protective WFI panel 130 comprises at least one layer of composite wood material, made by the process comprising the steps of: (i) biochemically-treating lignocellulosic wood furnish material 94 to produce biochemically-treated wood furnish material 94′ using the liquid and/or dry powder biochemical compositions of the present invention 93 schematically represented in FIGS. 6 through 6V4; (ii) biochemically-treating polymeric resin binder/adhesive material 95 to produce biochemically-treated polymeric resin binder material 95′ also using the liquid and/or dry powder biochemical compositions of the present invention 93 schematically represented in FIGS. 6 through 6V4; (iii) applying biochemically-treated (pMDI-based) polymeric resin binder material 95′ to biochemically-treated wood furnish material 94′, and blending the materials together to produce resinated wood furnish material 94′/95′; (iv) shaping/forming the resinated wood furnish material 94′/95′into a product shape; and (v) pressing and curing the formed resinated wood furnish material to produce a finished composite wood product, in accordance with the composite manufacturing process.

Optionally, after the composite wood product is released from the press, the finished fire-protected WFI product 130 may also be spray-coated with one or more biochemical compositions 96 at a final stage of manufacture, to provide the finished composite wood product with an extra outer layer of fire, mildew/mold, and/or moisture protection which may be required or desired during building construction, when roof, wall, and floor sheeting is exposed to the natural environment until the building is dried in. Also, the edges of the fire-protected WFI panel 130 can be painted and protected with a fire inhibiting and moisture-protecting chemical coating 97 formulated using (i) environmentally-clean fire inhibiting biochemical compositions of the present invention 93, (ii) colored pigment powder/liquid, (iii) liquid polymer material, and (iv) dispersing agent to form a desirable paint coating on the edges of the fire-protected composite wood product of the present invention.

In short, by integrating the fire inhibiting biochemical compositions of the present invention 93 into the treated lignocellulosic-based wood furnish material 94′ of the WFI wood product 130, and preferably its polymeric resin binder material 95, it is now possible, during the composite wood product manufacturing process, to safely treat substantially the entire physical structure of the finished composite wood product and its structural components, with environmentally-clean fire inhibiting biochemical composition(s) 93. By doing so, it is possible to provide the entire finished WFI wood product 130 with alkali metal ions and/or particles, that are freely available to inhibit fire ignition, flame spread and smoke development in accordance with ASTM Class-A fire-protected standards, as well as, optionally, inhibit metal corrosion, mold/mildew and moisture in a significantly new and improved manner.

FIG. 28 shows the automated factory, as generally depicted, and configured for producing Class-A fire-protected wood fiber insulation (WFI) panels 130 in accordance with the principles of the present invention as described herein.

FIG. 29 shows the automated WFI panel fabrication factory illustrated in FIG. 28, wherein each of the stages of manufacture are graphically depicted to illustrate the functions performed along the multi-stage fabrication process of the present invention, including the treatment of wood furnish materials (e.g. wood strands) 94′ and resin adhesives (e.g. pDMI resin binders) 95′ used during the manufacturing process. As shown, As shown in FIG. 29, the automated WFI panel factory 140 comprises a number of stages integrated together and configured to operate along a production line supported by an auto-feeding conveyor system 100E, comprising: a log debarking stage for sorting, soaking and debarking logs (typically spruce and fir species retrieved as waste from the manufacture of other timber products) to prepare for the chipping stage; a chipping stage for processing the debarked logs to produce chips of wood; a screening stage for screening the chip; pre-steaming stage for pre-steaming the chips; refining stage for grinding/refining the streamed chips into wood fiber pulp; a drying stage for drying the wood fiber pulp to a specified moisture content %; a biochemical wood treatment stage for biochemically treating wood fiber pulp 94 with biochemical composition 93 to produce treated wood fiber pulp 94′ at stage 140H; drying stage for drying treated wood fiber pulp 94′ to a desired moisture content %; resinating stage, using the EVOJet M2.0, for mixing and blending treated wood fiber pulp 94′ with a biochemically-treated polymeric resin binder material 95′, selected from FIGS. 7A through 7D and treated with biochemical compositions 93 selected from FIGS. 6 through 6V4; a forming stage for forming resinated wood fiber pulp material 94′/95′ into a continuous fire-resistant wood fiber mat; a pre-pressing stage for removing water from the wood fiber mat through pre-pressing, continuous steaming, and vacuum pumping to produce WFI board material while curing the polymeric resin binder 95′; an air drying stage for drying the WFI board material and curing the resin binder material employed therein; a trimming stage for cutting and trimming the WFI boards to size and milling the edges thereof; and a stacking, packaging and wrapping stage for stacking, packaging and wrapping the WFI boards into a WFI board bundle for labeling and storage.

FIG. 30 shows a first view of the resin and biochemical mixer/blender stage 140I employed in the WFI panel production line of the present invention shown in FIGS. 27 and 28, wherein MDI resin binder 95′ and biochemical additive composition of the present invention 93 are mixed and blended together into a homogeneous emulsion for atomization spraying and coating wood furnish material (i.e. wood particles) flowing through the resinator stage 140I of the system.

FIG. 31 shows second view of the resin and biochemical mixer/blender stage 140I employed in the WFI panel production line of the present invention shown in FIGS. 27 and 28, wherein the homogeneous treated resin emulsion 95′ is supplied to an turbo-flow-based glue resinating engine, within which treated wood fiber particles 94′ flowing thereinto are ground into fine particles that form a pair of treated wood particle streams 94′ that flow through the engine while the surfaces thereof are being spray atomized and coated with biochemically-treated wood resin emulsion 95′, and then the resin-coated wood particles 94′ flow through the turboflow resinator stage 140I of the system towards the panel formation stage of the system.

FIG. 31A shows first detailed view of the turbo-flow-based glue resinating engine 140I employed in the resin and biochemical mixer/blender stage employed in the WFI panel production line of the present invention shown in FIG. 30, wherein the homogeneous biochemically-treated resin emulsion is spray atomized over the surface of the wood particle flow streams passing through the engine.

FIG. 31B is a schematic illustration providing a second detailed view of the turbo-flow-based glue resinating engine employed in the resin and biochemical mixer/blender stage employed in the WFI panel production line of the present invention shown in FIG. 30, wherein the homogeneous biochemically-treated resin emulsion is spray atomized over the surface of the wood particle flow streams passing through the engine.

FIGS. 32A and 32B describe the high-level steps carried out when practicing the method of producing clean Class-A fire-protected WFI sheathing in accordance with the present invention, as illustrated in FIGS. 30, 31A and 31B.

As indicated at Block A in FIG. 32A, the method involves installing and operating a fire protected wood fiber insulation (WFI) panel production line 140 supporting a furnish treating stage 140F, a resinating stage 140I, a molding stage 140J, a pressing and curing stage 140K, a spray coating tunnel stage 1400, and a drying tunnel 140N.

As indicated at Block B in FIG. 32A, the method involves preparing at stage 140A, wood logs and lumber pieces for wood chipping stage 140B.

As indicated at Block C in FIG. 32A, the method involves processing wood logs and lumber pieces to produce wood particles (i.e. wood furnish) at stage 140B, and refining into fibers at stage 140C that are suitable for WFIP panel production.

As indicated at Block D in FIG. 32A, the method involves collecting the wood fiber in large storage bins that allow for meting into the dryers.

As indicated at Block E in FIG. 32A, the method involves drying the wood fibers to a target moisture content (MC %) and filtering out certain fibers for recycling.

As indicated at Block F in FIG. 32B, the method involves spraying the wood fibers 94 with environmentally-clean biochemical compositions 93 formulated for inhibiting fire, metal corrosion, mold and/or microbes.

As indicated at Block G in FIG. 32B, the method involves drying the biochemically-treated wood fibers 94′ for storage in the storage bins.

As indicated at Block H in FIG. 32B, the method involves mixing and blending clean-chemistry biochemicals 93 with PMDI resin 95 and wax to prepare an emulsified PDMI-based resin binder 95′ for application to wood fibers 94.

As indicated at Block I in FIG. 32B, the method involves blending/mixing treated wood fibers 94′/95′ to form a wood fiber mat for forming and pressing operations.

As indicated at Block J in FIG. 32B, the method involves forming a wood fiber mat and pressing the same under heat and pressure to form a wood fiber mat insulation (WFI) panel after the resin binder is cured.

As indicated at Block K in FIG. 32B, the method involves trimming the WFI panel and stacking for further curing of resin binder used in the WFI panel.

As indicated at Block L in FIG. 32B, the method involves stacking, packaging and wrapping the WFI panels into a bundle of Class-A fire-protected WFI panels.

Specification Of A Method Of Class-A Fire Protected Medium Density Fiber (MDF)/High Density Fiber (HDF) Panels Produced Using The Automated Factory

FIG. 33 shows several fire-protected medium density fiber (MDF)/high density fiber (HDF) panels 150 produced using the automated factory 160 schematically represented in FIG. 34. During the composite wood product manufacturing process, wood furnish material (e.g. wood strands, chips, particles or fibers) 94 is biochemically-treated using one or more environmentally-clean fire inhibiting biochemical composition(s) 93 of the present invention as schematically illustrated in FIGS. 6 through V4, to produce biochemically-treated wood furnish material 94′. This treated wood furnish material 94′ is then binded together using biochemically-treated polymeric resin binder material (e.g. pMDI polymeric resin binder or adhesive material) 95′ schematically illustrated in FIGS. 7A through 7D. The biochemically-treated polymeric resin binder material 95′ comprises polymeric resin binder material 95 that is biochemically-treated using fire inhibiting biochemical composition(s) 93 of the present invention schematically illustrated in FIGS. 6 through V4.

As shown in FIG. 33, each Class-A fire-protective MDF/HDF panel comprises: a core layer made by the process comprising the steps of: (i) biochemically-treating lignocellulosic wood furnish material 94 to produce biochemically-treated wood furnish material 94′ using the liquid and/or dry powder biochemical compositions of the present invention 93 schematically represented in FIGS. 6 through 6V4; (ii) biochemically-treating polymeric resin binder/adhesive material 95 to produce biochemically-treated polymeric resin binder material 95′ also using the liquid and/or dry powder biochemical compositions of the present invention 93 schematically represented in FIGS. 6 through 6V4; (iii) applying biochemically-treated (pMDI-based) polymeric resin binder material 95′ to biochemically-treated wood furnish material 94′, and blending the materials together to produce resinated wood furnish material; (iv) shaping/forming the resinated wood furnish material into a product shape; and (v) pressing and curing the formed resinated wood furnish material to produce a finished composite wood product, in accordance with the composite manufacturing process.

Optionally, after the composite wood product is released from the press, the finished fire-protected MDF/HDF product 150 may also be spray-coated with one or more biochemical compositions at a final stage of manufacture, to provide the finished composite wood product 150 with an extra outer layer of fire, mildew/mold, and/or moisture protection 96 which may be required or desired during building construction, when roof, wall, and floor sheeting is exposed to the natural environment until the building is dried in. Also, the edges of the fire-protected MDF/HDF panel 150 may be painted and protected with a fire inhibiting and moisture-protecting chemical coating 97 formulated using (i) environmentally-clean fire inhibiting biochemical compositions of the present invention 93, (ii) colored pigment powder/liquid, (iii) liquid polymer material, and (iv) dispersing agent to form a desirable paint coating on the edges of the fire-protected composite wood product of the present invention.

In short, by integrating the fire inhibiting biochemical compositions of the present invention 93 into the treated lignocellulosic-based wood furnish material 94′ of the composite wood product 150 and preferably its polymeric resin binder material 95′, it is now possible, during the composite wood product manufacturing process, to safely treat substantially the entire physical structure of the finished composite wood product and its structural components, with environmentally-clean fire inhibiting biochemical composition(s) 93. By doing so, it is possible to provide the entire finished composite wood product 150 with alkali metal ions and/or particles, that are freely available to inhibit fire ignition, flame spread and smoke development in accordance with ASTM Class-A fire-protected standards, as well as, optionally, inhibit metal corrosion, mold/mildew and moisture in a significantly new and improved manner.

FIG. 34 shows the automated factory 160, as generally depicted, and configured for producing Class-A fire-protected MDF/HDF panels 150 in accordance with the principles of the present invention as described herein.

FIG. 35 shows the automated MDF/HDF panel fabrication factory 160 shown in FIG. 34, wherein each of the stages of manufacture (A through L) are graphically depicted to illustrate the functions performed along the multi-stage fabrication process of the present invention, including the treatment of wood furnish materials (e.g. wood particles) 94 and resin binders and/or adhesives (e.g. pDMI resin binders) 95 used during the manufacturing process.

FIGS. 36A, 36B and 36C show the dry screen drying stage 110L employed in the MDF panel production line of the present invention 160 shown in FIGS. 34 and 35, wherein hot air is input into the drying stage along with infed wood furnish materials 94′ (at moisture content MC % in) so to evaporate moisture therefrom as the wood furnish (with moisture content % out) exits the dry screen drying stage 110L of the system 100.

FIG. 36D shows the dry screen drying stage 110L employed in the MDF panel production line of the present invention 160 shown in FIGS. 34 and 35, wherein hot air is input into the drying stage along with infed wood furnish materials 94′ so to flow over wood furnish material (e.g. strands, particles, etc.) 94′ being conveyed along a moving screen (i.e. belt) and allowing moisture to evaporate therefrom as the wood furnish 94′ exits the dry screen drying stage 110L of the system 100.

FIG. 36E shows the dry screen drying stage employed in the MDF panel production line of the present invention shown in FIGS. 34 and 35, wherein wood furnish 94′ is being fed into the input handler of the dry screen drying stage 110L of the system 100.

FIG. 36F shows the dry screen drying stage employed in the MDF panel production line of the present invention shown in FIGS. 34 and 35, wherein wood furnish 94′ is being fed along the moving screen conveyor towards the output handler of the dry screen drying stage 110L of the system 100.

FIG. 36G shows the dry screen drying stage employed in the MDF panel production line of the present invention shown in FIGS. 34 and 35, wherein wood furnish material 94′ is being fed into the output handler of the dry screen drying stage 110L of the system.

FIG. 37 shows the resin and biochemical mixer/blender stage 160H employed in the MDF/HDF panel production line of the present invention shown in FIGS. 34 and 35, wherein the homogeneous emulsion is produced by precisely metering and mixing (i) pDMI resins 95, (ii) biochemicals for performing specified functions, and (iii) waxes before being emulsified by one or more different methods including rapid mixing/blending and ultrasonic mixing, and then suppling the homogeneous resin/biochemical emulsion 95′ to the spray nozzles in the turbo-flow-based glue resinating engine (EVOJET M 2.0), a dry resin application system from the Dieffenbacher Group, Eppingen, Germany, employed in the resin and biochemical mixer/blender stage 160H.

FIG. 37A shows a more detailed view of the resin and biochemical mixer/blender stage 160H employed in the MDF/HDF panel production line of the present invention shown in FIG. 37.

FIG. 37B is a schematic illustration providing a first detailed view of the turbo-flow-based glue resinating engine employed in the resin and biochemical mixer/blender stage 160I employed in the MDF/HDF panel production line of the present invention shown in FIG. 34, wherein the homogeneous biochemically-treated resin emulsion 95′ is spray atomized over the surface of the biochemically-treated wood particle flow streams 94′ passing through the resinating engine (EVOJET M 2.0).

FIG. 37C is a schematic illustration providing a second detailed view of the turbo-flow-based glue resinating (i.e. resin application) engine employed in the resin and biochemical mixer/blender stage 160I employed in the MDF/HDF panel production line of the present invention shown in FIG. 34, wherein the homogeneously-mixed and biochemically-treated resin emulsion 95′ is spray atomized over the surface of the biochemically-treated wood particle flow streams 94′ passing through the EVOJet M2.0 resinating engine.

During operation, after drying, the EVOjet M2.0 resinating engine employs a trap that separates coarse foreign particles from treated wood fibers 94′ to protect the fast rotating spike rolls which dissolve the fiber stream 94′ before entering the resinator, wherein special nozzles atomize biochemically-treated resin binder 95′ into the finest droplets to guarantee optimum gluing of the wood fibers 94′.

The two fast-rotating spike rollers employed in the EVOjet M2.0 resinating engine ensure the production of a high-quality board surface. The dissolved wood fiber flow 94′ is sprayed with resin binder 95′. The externally arranged nozzles atomize treated resin binder 95′ into defined droplets size. The engine has fully automatic self-cleaning of the nozzles without interrupting the production. The EVOJet engine has controlled protection air that prevents the sticking of the freshly glued fibers 94′/95′. Down-stream, a unique air slide elbow works in combination with recirculated wood fibers to prevent contact between resinated wood fibers 94′/95′ and the surrounding ductwork. The EVOjet M 2.0 provides superior fiber/resin contact; achieves resin savings up to 25% compared to conventional blow line resonators; Reduced emissions out of the dryer; Proven flow technology for minimum cleaning; and Less pre-curing of the resin.

Along the MDF production line, before the pressing machine stage, a high-precision mat spraying system is installed for the purpose of adding moisture to the wood furnish mat 94′/95′ for quick temperature transfer to the mat's core during the pressing process. In general, the high-precision spray system comprises two units for spraying water onto the forming belt and onto the material to be pressed. If desired, additives (e.g., release agent) can be added to the water. Use of the mat spraying system improves board properties and surface quality, reduces press factor, is fully automated and integrates into the control system of the line.

In order to form and press MDF/THDF board, the production line supports a MDF forming station which consists of several single machines (forming bin, discharge head, forming head and scalper unit) and produces a uniform wood fiber mat. Because the MDF station enables the formation of uniform wood fiber mats, sanding requirements are significantly lowered, due to high forming accuracy, both lengthwise and crosswise. The excellent board surface quality produced by this machine is highly suitable for laminating or direct painting on formed surfaces. Other advantages of using the MDF forming system, includes: possible material savings due to short control loop of the scalper system and direct return of material to the bin; the appearance of the top and bottom board surfaces are identical; Spike-Roll disintegrates wood fibers; a vacuum system is used to pre-compress the mat and adjust fiber distribution; a scalper is used to separately scalp 100 mm wide segments over board's width regulated in closed loop; has the ability to reduce raw material consumption considerably, because scalped material is returned to the forming bin.

Prior to pressing wood fiber mats during MDF/HDF board (and WFI board) manufacturing, it is helpful to use a pre-pressing machine to continuously pre-compress and de-aerate the wood fiber mat. The pre-pressing machine comprises: A Precompressor inside spreading wall; a Precompressor and prepress belt cleaning; Two hinges with different pressure zones; Top press belt optionally perforated and degassing belt optionally endless (installing device included); and Max. speed 2,500 mm/s:

There are many advantages to be achieved by using the pre-press machine/stage along the production line. For example, a long de-aeration zone and a high-pressure compacting area is provided in order to achieve thin mat at press infeed. Excellent line speeds are possible. Formation of homogeneously compressed wood fiber mat are achievable without blowout.

FIGS. 38A and 38B describes the high-level steps carried out when practicing the method of producing Class-A fire-protected MDF/HDF sheathing in accordance with the present invention, as illustrated in FIGS. 34 and 35.

As indicated at Block A in FIG. 38A, the method involves installing and operating a fire protected medium density fiber (MDF)/high density fiber (HDF) panel production line 160 supporting a furnish treating stage 160F, a resinating stage 160I, a molding stage 160J, a pressing and curing stage 160K, a spray coating tunnel stage 160N, and a drying tunnel 1600.

As indicated at Block B in FIG. 38A, the method involves preparing at stage 160A, wood logs and lumber pieces for wood chipping stage 160B.

As indicated at Block C in FIG. 38A, the method involves processing wood logs and lumber pieces to produce wood particles (i.e. wood furnish) at stage 160B, and refining into fibers at stage 160C that are suitable for MDF/HDF panel production.

As indicated at Block D in FIG. 38A, the method involves collecting the wood fiber in large storage bins that allow for metering into the dryers.

As indicated at Block E in FIG. 38A, the method involves drying the wood fibers 94 to a target moisture content (MC %) and filtering out certain fibers for recycling.

As indicated at Block F in FIG. 38B, the method involves spraying the wood fibers 94 with environmentally-clean biochemical compositions 93 formulated for inhibiting fire, metal corrosion, mold and/or microbes.

As indicated at Block G in FIG. 38B, the method involves drying the biochemically-treated wood fibers 94′ for storage in the storage bins.

As indicated at Block H in FIG. 38B, the method involves mixing and blending clean-chemistry biochemicals 93 with PMDI resin 95 and wax to prepare an emulsified PDMI-based resin binder 95′ for application to wood fibers 94.

As indicated at Block I in FIG. 38B, the method involves blending/mixing treated wood fibers 94′/95′ to form a wood fiber mat 94′/95′ for forming and pressing operations.

As indicated at Block J in FIG. 38B, the method involves forming a wood fiber mat and pressing the same under heat and pressure to form an MDF/HDF panel after the resin binder is cured.

As indicated at Block K in FIG. 38B, the method involves trimming the MDF/HDF panel and stacking for further curing of resin binder used in the MDF/HDF panel.

As indicated at Block L in FIG. 38B, the method involves stacking, packaging and wrapping the WFI panels into a bundle of Class-A fire-protected MDF/HDF panels.

Specification Of A Method Of Producing Class-A Fire Protected Multi-Ply Plywood Panels Produced Using An Automated Factory

FIG. 39 show a stack of Class-A fire protected multi-ply plywood panels 170 produced using the automated factory 180 schematically represented in FIG. 40.

FIG. 40 shows the automated factory 180, as generally depicted, and configured for producing Class-A fire-protected multi-ply plywood panels 170 in accordance with the principles of the present invention as described herein.

FIG. 40A shows a resin adhesive/glue application system 1801 employed in the MDF/HDF panel production line of the present invention shown in FIGS. 39 and 40, wherein pMDI resin 95 and biochemical additive composition 93 of the present invention are mixed and blended together into a homogeneous adhesive resin emulsion 95′ that is then spray-atomized to coat biochemically-treated wood furnish material (i.e. wood particles) 94′ flowing through the resinator stage 180H of the system.

FIG. 41 is a schematic representation of the automated plywood panel fabrication factory shown in FIG. 40, wherein each of the stages of plywood manufacture are graphically depicted to illustrate the functions performed along the multi-stage fabrication process of the present invention, including the treatment of wood furnish materials (e.g. wood particles) and resin adhesives (e.g. pDMI resin binders) used during the manufacturing process.

As shown in FIG. 41, the fire-protected plywood manufacturing process of the present invention comprises the following sequence of stages, namely: (1) Plantation Timber; (2) Log Preparation; (3) Debarking; (4) Peeling Veneer Production; (5) Veneer Drying; (6) Biochemical Treatment of Veneers; (7) Veneer Drying; (8) Veneer Grading; (9) Adhesive/Resin Coating; (10) Billeting/Formation; (11) Cold Pressing; (12) Hot Pressing; (13) Trimming, Cutting and Sanding; (14) Finishing; (15) Cooling and Dispatching (e.g. Stacking, Packaging and Wrapping).

FIGS. 42A and 42B describe the high-level steps carried out when practicing the method of producing clean Class-A fire-protected plywood panels in accordance with the present invention, as illustrated in FIG. 40.

As indicated at Block A in FIG. 42A, the method involves installing and operating a fire protected plywood panel production line 180 supporting a veneer treating stage 180F, a resinating stage 180I, a mat forming stage 180J, a pressing and curing stage 180K, a spray coating tunnel stage 180N, and a drying tunnel 1800.

As indicated at Block B in FIG. 42A, the method involves sorting, soaking, and debarking logs to prepare for the veneering stage 180B.

As indicated at Block C in FIG. 42A, the method involves processing debarked logs to produce veneers of wood having a specified length, width and thickness.

As indicated at Block D in FIG. 42A, the method involves collecting the wood veneers in large storage bins that allow for metering into the dryers.

As indicated at Block E in FIG. 42A, the method involves drying the wood veneers 94 to a target moisture content (MC %) and screening out certain veneer for recycling.

As indicated at Block F in FIG. 42B, the method involves coating the wood veneers 94 with environmentally-clean biochemical compositions 93 formulated for inhibiting fire, metal corrosion, mold and/or microbes

As indicated at Block G in FIG. 42A, the method involves drying the wood veneers 94 in storage bins to a target moisture content (MC %) and screening out certain veneer for recycling.

As indicated at Block H in FIG. 42A, the method involves mixing and blending environmentally-clean biochemical composition 93 with MDI-based resin adhesive/binder 95 to prepare a biochemically-treated MDI-based resin adhesive/binder 95′ (for fire and other kinds of inhibition), and then applying the biochemically-treated adhesive resin 95′ to the treated wood veneers 94′/95′.

As indicated at Block I in FIG. 42B, the method involves forming a billet from an assembly of the treated and resinated wood veneers 94′/95′.

As indicated at Block J in FIG. 42B, the method involves cold pressing the plywood billet 94′/95′.

As indicated at Block K in FIG. 42B, the method involves hot pressing the plywood billet 94′/95′ to form a fire-protected plywood panel and cure the adhesive resins employed therein.

As indicated at Block L in FIG. 42B, the method involves trimming, cutting and sanding the fire-protected plywood panel.

As indicated at Block M in FIG. 42B, the method involves finishing the fire-protected plywood panel.

As indicated at Block N in FIG. 42B, the method involves stacking, packaging and wrapping the WFI panels into a bundle of Class-A fire-protected panels.

Specification Of Method of Making A Class-A Fire Protected 3-Ply Bamboo Plywood Panels Produced According To The Process Using An Automated Factory

FIG. 43 shows a stack of Class-A fire-protected 3-ply bamboo plywood panels 190 produced according to the process illustrated in FIG. 44 using the automated factory 200 schematically represented in FIG. 45.

During the composite wood product manufacturing process, wood furnish material (e.g. wood strands, chips, particles, fibers, or bamboo strips) 94 is biochemically-treated using one or more environmentally-clean fire inhibiting biochemical composition(s) 93 of the present invention as schematically illustrated in FIGS. 6 through V4, to produce biochemically-treated wood furnish material (i.e. treated bamboo strips) 94′. This treated wood furnish material (i.e. bamboo strips) 94′ is then binded together using biochemically-treated polymeric resin adhesive/binder material (e.g. MDI-based polymeric resin binder or adhesive material) 95′ schematically illustrated in FIGS. 7A through 7D. The biochemically-treated polymeric resin adhesive/binder material 95′ comprises polymeric resin adhesive/binder material 95 that is biochemically-treated using fire inhibiting biochemical composition(s) 93 of the present invention schematically illustrated in FIGS. 6 through V4.

As shown in FIG. 43, the Class-A fire-protective 3-ply bamboo plywood panel 190 comprises: three layers stacked and adhesive binded together, wherein each of these layers is made by the process comprising the steps of: (i) biochemically-treating lignocellulosic wood furnish material (i.e. bamboo strips) 94 to produce biochemically-treated wood furnish material 94′ using the liquid and/or dry powder biochemical compositions of the present invention 93 schematically represented in FIGS. 6 through 6V4; (ii) biochemically-treating polymeric resin binder/adhesive material 95 to produce biochemically-treated polymeric resin adhesive/binder material 95′ also using the liquid and/or dry powder biochemical compositions of the present invention 93 schematically represented in FIGS. 6 through 6V4; (iii) applying biochemically-treated (MDI-based) polymeric resin adhesive/binder material 95′ to biochemically-treated wood furnish material 94′, and combining the materials together to produce resinated wood furnish material (i.e. bamboo strips); (iv) laying up and arranging the resinated wood furnish material into a product shape (i.e. 3-ply bamboo mat or billet); and (v) pressing and curing the formed resinated wood furnish assembly to produce a finished composite wood product (i.e. fire-resistant 3-ply bamboo panel 190), in accordance with the composite manufacturing process.

Optionally, after the composite wood product is released from the press, the finished fire protected product 190 may also be spray-coated with one or more biochemical compositions at a final stage of manufacture, to provide the finished composite wood product 190 with an extra outer layer of fire, mildew/mold, and/or moisture protection which may be required or desired during building construction, when roof, wall, and floor sheeting is exposed to the natural environment until the building is dried in. Also, the edges of the fire-protected bamboo plywood 190 can be painted and protected with a fire inhibiting and moisture-protecting chemical coating 97 formulated using (i) environmentally-clean fire inhibiting biochemical compositions of the present invention 93, (ii) colored pigment powder/liquid, (iii) liquid polymer material, and (iv) dispersing agent to form a desirable paint coating on the edges of the fire-protected composite wood product of the present invention.

In short, by integrating the fire inhibiting biochemical compositions of the present invention 93 into the treated lignocellulosic-based wood furnish material (i.e. bamboo strips) 94′ of the composite wood product 190, and preferably its polymeric resin adhesive/binder material 95, it is now possible, during the composite wood product manufacturing process, to safely treat substantially the entire physical structure of the finished composite wood product and its structural components, with environmentally-clean fire inhibiting biochemical composition(s) 93. By doing so, it is possible to provide the entire finished composite wood product with alkali metal ions and/or particles, that are freely available to inhibit fire ignition, flame spread and smoke development in accordance with ASTM Class-A fire-protected standards, as well as, optionally, inhibit metal corrosion, mold/mildew and moisture in a significantly new and improved manner.

FIG. 44 illustrates a process used to produce 3-ply bamboo plywood panels 190 according to the present invention.

FIG. 45 shows the automated factory 200, as generally depicted, and configured for producing Class-A fire-protected 3-ply bamboo plywood panels 190 in accordance with the principles of the present invention as described herein.

FIGS. 46A and 46B describes the high-level steps carried out when practicing the method of producing clean Class-A fire-protected 3-ply bamboo plywood panels in accordance with the present invention, as illustrated in FIG. 44.

As indicated at Block A in FIG. 46A, the method involves installing and operating a fire-protected bamboo plywood panel production line 180 supporting a bamboo strip treating stage 200F, an MDI-based resinating stage 2001, a bamboo billet forming stage 200J, a pressing and curing stage 200K, a spray coating tunnel stage 200N, and a drying tunnel 200O.

As indicated at Block B in FIG. 46A, the method involves loading a supply of bamboo poles onto the multi-stage transport mechanism 200A installed along the production line, for bamboo pole processing into bamboo strips 94 having suitable length and width and thickness dimensions for subsequent processing.

As indicated at Block C in FIG. 46A, the method involves grading the bamboo strips 94 at stage 200C, then drying the bamboo strips at controlled drying stage 200C to produce suitably dried bamboo strips with the desired moisture content % (% MC), and then at stage 200D, treating the bamboo strips with liquid biochemical treatment solution 93 selected from FIGS. 6-thjrough 6V4 containing biochemicals, so as to provide fire-protection/inhibition, metal-corrosion inhibition, mold/mildew inhibition and/or moisture protection, as described hereinabove.

As indicated at Block D in FIG. 46A, the method involves orienting the treated bamboo strips 94′ to prepare for the laying up stage in order to produce a joined layer or assembly of treated bamboo strips 94′.

As indicated at Block E in FIG. 46A, the method involves mixing MDI-based resin adhesive/binder material 95 with biochemical composition 93 to produce biochemically-treated MDI-based resin adhesive/binder material 95′ which, once applied to treated bamboo strips 94′, will provide to the treated bamboo material 94′ (i.e. treated wood furnish material) alkali metal ion based inhibition against fire, mildew, mold and/or moisture, and then applying at the resin application stage 200G, the mixture of biochemically-treated resin adhesive/binder material 95 to the-biochemically-treated bamboo strips 94 prior to the laying up stage 200H.

As indicated at Block F in FIG. 46A, the method involves vacuum lifting the treated/resinated bamboo layers 94′/95′ onto the processing line, and stacking and orienting the biochemically-treated bamboo layers 94′ with resin adhesive/binder coating 95′ until the bamboo layers are laid up into a resinated treated bamboo layered mat 94′/95′ at the laying up stage 200H, for further processing on the production line.

As indicated at Block G in FIG. 46B, the method involves cold pressing together the bamboo layered mat 94′/95′ at the pre-pressing stage 2001 on the production line.

As indicated at Block H in FIG. 46B, the method involves hot pressing the layered bamboo mat to produce a bamboo plywood panel at the hot pressing and curing stage 200J on the production line.

As indicated at Block I in FIG. 46B, the method involves cutting and trimming the produced bamboo plywood panel into products such as Class-A fire-protected bamboo multi-ply plywood sheets 190.

As indicated at Block J in FIG. 46B, the method involves marking each fire-protected bamboo plywood sheet 190 with a branded logo and grade for clear visual identification.

As indicated at Block K in FIG. 46B, the method involves feeding the Class-A fire-protected bamboo plywood products 190 through a spray-coating tunnel stage 200M, for optionally depositing a polymer-based moisture, mold and/or UV protection coating 96 on each finished bamboo plywood product, along with the painting of edges using a fire-resistant paint coating 97 described in detail above.

As indicated at Block L in FIG. 46B, the method involves continuously transporting the spray-coated bamboo plywood products through a drying tunnel 200N to rapidly dry the coated products and promote curing.

As indicated at Block M in FIG. 46B, the method involves stacking, packaging and wrapping the fire-protected bamboo plywood panels into a bundle of Class-A fire-protected bamboo plywood panels, at stage 200O, for shipping and distribution.

Specification Of A Method Of Making Class-A Fire Protected Bamboo Strand Board (BSB) Panels Produced According To The Process Using An Automated Factory

FIG. 47 shows a piece of fire-protected bamboo strand board (BSB) panels 210 produced according to the process illustrated in FIG. 48 using the automated factory 220 schematically represented in FIG. 49. During the composite wood product manufacturing process, wood furnish material (e.g. bamboo wood strands, chips, particles or fibers) 94 is biochemically-treated using one or more environmentally-clean fire inhibiting biochemical composition(s) 93 of the present invention as schematically illustrated in FIGS. 6 through V4, to produce biochemically-treated wood furnish material 94′. This treated wood furnish material 94′ is then binded together using biochemically-treated polymeric resin binder material (e.g. pMDI-based polymeric resin binder or adhesive material) 95′ schematically illustrated in FIGS. 7A through 7D. The biochemically-treated polymeric resin binder material 95′ comprises polymeric resin binder material 95 that is biochemically-treated using fire inhibiting biochemical composition(s) 93 of the present invention schematically illustrated in FIGS. 6 through V4.

As shown in FIG. 47, the Class-A fire-protective BSB panel 210 comprises: a core layer binded by and between two outer layers. In general, each of these layers is made by the process comprising the steps of: (i) biochemically-treating lignocellulosic wood furnish material 94 to produce biochemically-treated wood furnish material 94′ using the liquid and/or dry powder biochemical compositions of the present invention 93 schematically represented in FIGS. 6 through 6V4; (ii) biochemically-treating polymeric resin binder/adhesive material 95 to produce biochemically-treated polymeric resin binder material 95′ also using the liquid and/or dry powder biochemical compositions of the present invention 93 schematically represented in FIGS. 6 through 6V4; (iii) applying biochemically-treated (pMDI-based) polymeric resin binder material 95′ to biochemically-treated wood furnish material 94′, and blending the materials together to produce resinated wood furnish material; (iv) shaping/forming the resinated wood furnish material into a product shape; and (v) pressing and curing the formed resinated wood furnish material to produce a finished composite wood (i.e. bamboo strand board-BSB) product 210, in accordance with the composite manufacturing process.

Optionally, after the composite wood product 210 is released from the press, the finished fire protected BSB product 210 may also be spray-coated with one or more biochemical compositions 93 at a final stage of manufacture, to provide the finished composite wood product 210 with an extra outer layer of fire, mildew/mold, and/or moisture protection 96 which may be required or desired during building construction, when roof, wall, and floor sheeting is exposed to the natural environment until the building is dried in. Also, the edges of the fire-protected BSB panel 210 can be painted and protected with a fire inhibiting and moisture-protecting chemical coating 97 formulated using (i) environmentally-clean fire inhibiting biochemical compositions of the present invention 93, (ii) colored pigment powder/liquid, (iii) liquid polymer material, and (iv) dispersing agent to form a desirable paint coating on the edges of the fire-protected composite wood product of the present invention.

In short, by integrating the fire inhibiting biochemical compositions of the present invention 93 into the treated lignocellulosic-based wood furnish material 94′ of the composite BSB product 210, and preferably its polymeric resin binder material 95, it is now possible, during the composite wood product manufacturing process, to safely treat substantially the entire physical structure of the finished composite BSB product 210 and its structural components, with environmentally-clean fire inhibiting biochemical composition(s) 93. By doing so, it is possible to provide the entire finished bamboo-based BSB panel product 210 embodying alkali metal ions and/or particles, that are freely available within the entire product to inhibit fire ignition, flame spread and smoke development in accordance with ASTM Class-A fire-protected standards, as well as, optionally, inhibit metal corrosion, mold/mildew and moisture in a significantly new and improved manner.

FIG. 48 describes a process used to produce bamboo strand board (BSB) panels 210 according to the present invention, wherein process for producing bamboo strand board (BSB) panels 210 according to the present invention comprises the steps of: (1) preparing raw material (bamboo strands-having a desired length, width and moisture content) 94; (2) treating prepared bamboo strands 94 with biochemical alkali metal salt compositions 93 according to present invention to impart properties against fire, mold/mildew and/or moisture; (3) blending pMDI resin binder 95 with biochemical alkali metal salt composition 93 of the present invention to produce biochemically-treated resin binder emulsion 95′; (4) mixing bamboo strands (i.e. wood furnish material) 94′ with treated resin binder emulsion 95′ with treated bamboo strands 94′; (5) forming a sheet of bamboo strands mixed with treated resin binder emulsion 95′ to form a resinated BSB mat assembly 94′95′; (6) hot pressing the formed BSB mat 94′/95′ under compression to produce bamboo strand board (BSB); and (7) trimming and cutting the bamboo strand board (BSB) panel into bamboo strand board (BSB) sheets 210.

FIG. 49 shows the automated factory 220, as generally depicted, and configured for producing Class-A fire-protected bamboo strand board (BSB) panels 210 in accordance with the principles of the present invention as described herein.

FIGS. 50A and 50B describes the high-level steps carried out when practicing the method of producing Class-A fire-protected bamboo strand board (BSB) panels 210 in the automated factory 220 in accordance with the present invention, as illustrated in FIG. 48.

As indicated at Block A in FIG. 50A, in an automated factory 220 configured for automated production of Class-A fire-protected BSB sheeting, stranding stage 220B, strand metering stage 220C, drying stage 220D, biochemical treatment stage 220F, drying stage 220G, resin treatment stage 220H, resin application stage 220I, mat forming stage 220L, pressing and curing stage 220K, cooling and trimming stage 220L, edge paining stage 220M, a spray tunnel stage 220N, and a drying tunnel stage 220P are installed along the lumber production line.

As indicated at Block B in FIG. 26A, the method involves processing bamboo poles at stage 220A to prepare for formation of bamboo strands at the stranding stage 220B.

As indicated at Block C in FIG. 50A, the method involves processing the bamboo at stranding stage 220B to produce bamboo strands having a desired length, width and thickness.

As indicated at Block D in FIG. 50A, the method involves at the strand metering stage 220C, the bamboo strands 94 are collected in large storage binds that allow for precise metering into the drum-type dryers 220DH.

As indicated at Block E in FIG. 50A, the method involves drying the bamboo strands 94 to a target moisture content % (% MC) and screen them at stage 220C to remove small particles for recycling on the production line. The bamboo strands are dried at the drying stage 220D to a target moisture content and screening them to remove small particles for recycling. BSB strands have a high initial moisture content (40-75%) which needs to be reduced to a range of about 5-10% for proper biochemical treatment, and transport of alkali metal ions during manufacturing. To achieve this, the strands are fed into large, rotating dryers that use hot air to evaporate the moisture. These dryers can be either single-pass or multiple-pass. The temperature inside the dryer can reach high levels, sometimes as high as 1500 degrees Fahrenheit at the entrance and lower at the exit. The TrilliumTM and Diamond Roll are screen types used to separate the BSB strands into different size fractions, which aids in the drying process, helping with efficient fines removal and strand retention.

As indicated at Block F in FIG. 50B, the method involves coating at stage the bamboo strands 94 with biochemical composition 93 to treat the same so as to produce biochemically-treated bamboo strands (i.e. wood furnish material) 94′ that contain alkali metal salt to inhibit fire, metal corrosion, mold and microbes.

As indicated at Block G in FIG. 50B, the method involves drying the treated bamboo strands at drying station 220G.

As indicated at Block H in FIG. 50B, the method involves treating the PMDI-based resin binder material 95 with biochemical composition 93 that inhibit fire, metal corrosion, mold, mildew and moisture at stage 220H.

As indicated at Block I in FIG. 50B, the method involves coating and blending (i.e. resinating) at stage 220I, the treated strands 94′ with treated polymeric resin binder material 95′, for inhibiting fire ignition, metal-corrosion, and mold/microbes.

As indicated at Block J in FIG. 50B, the method involves forming cross-directional layers of dried and resinated strands 94′ into a continuous strand-based mat at the mat forming stage 220J. At the BSB Forming Station, the glued strands 95′/94′ are formed to an equal and calibrated multilayer mat. The mat is formed of two symmetrical surface layers with length-oriented strands, optional intermediate layers and a core layer of various finer strands with cross orientation. However, BSB Forming Station orients both surface layer and core layer strands lengthwise.

After strand-based mats are formed, and prior to pressing and curing, the mats are sprayed with moisture for quick temperature transfer to the mat's core during press process.

High-precision spray system consisting of two units for spraying water onto the forming belt and onto the material to be pressed. If desired, additives (e.g., release agent) can be added to the water. After spraying with water, the mats are transferred through a microwave heating station to heat up the wet mat to a desired temperature into the pressing machine.

As indicated at Block K in FIG. 50B, the method involves heating and pressing the mats at the pressing and curing stage 220K to consolidate the strands 94′ and cure the resins 95′ and form a rigid dense structural bamboo strand board (BSB) panel (i.e. layer). As indicated at Block L in FIG. 50, the method involves at the cutting and trimming stage 220L, cutting to size and trimming the structural BSB panel and machining groove joints.

As indicated at Block M in FIG. 50B, the method involves applying a Class-A fire-protective paint (containing biochemical liquid 93, 25% by volume) 97 to the edges of the trimmed and cut BSB panels, at the edge painting stage 220M.

As indicated at Block N in FIG. 50B, the method involves transporting the BSB panels through the spray coating stage 220N and spraying each panel with a liquid polymer containing biochemical liquid 93 for inhibiting mold, mildew and microbes, moisture and UV radiation protection, so as to support weather protection during building construction.

As indicated at Block O in FIG. 50B, the method involves transporting the spray-coated BSB sheets 90 through a drying tunnel at stage 2200.

As indicated at Block P in FIG. 50B, dried spray-coated BSB panels 90 are stacked, packaged, and wrapped into a bundle of Class-A fire-protected BSB panels at the stacking, packaging, and wrapping stage 220P.

As shown and described above, the lumber factory 220 is configured for producing Class-A fire-protected BSB sheathing 210 fabricated in accordance with the principles of the present invention.

In summary, fire-protected BSB panels of the present invention 210 can be made by the following process: (i) providing wood furnish material (i.e. bamboo strands) 94; treating the wood furnish material 94 with a fire inhibiting biochemical composition of the present invention 93, to provide biochemically-treated wood furnish material 94′ having fire inhibitor/resistance and other desired properties; (ii) treating a polymeric resin binder material 95 with a fire inhibiting biochemical composition of the present invention 93, to produce a biochemically-treated polymeric resin binder 95′; (iii) blending the treated wood furnish material 94′ with the treated polymeric resin binder material 95′ to provide a blend of resinated wood furnish material 94′/95′; (iv) forming the resinated wood furnish material 94′/95′ into a desired product shape (i.e. BSB panel); and (v) pressing the formed product made from treated wood furnish materials 94′/95′ to form fire-protected composite BSB boards 210 having desired dimensions and other desired properties for the application at hand.

Specification Of A First Generalized System For Producing Multi-Ply Fire-Protected Composite Wood Products Using Environmentally-Clean Liquid Fire Inhibiting Biochemicals And Resin Binder Chemicals According To The Principles Of The Present Invention, And Showing A Supply Of Wet Lignocellulosic Furnish Material (E.G. Wood Strands, Chips, Particles, Etc.), A Supply Of Environmentally-Clean Liquid Fire Inhibiting Biochemicals Of The Present Invention

FIG. 51 shows a first generalized system for producing multi-ply fire-protected composite wood products (i.e. OSB panels) using environmentally-clean liquid fire inhibiting biochemicals 93 and resin binder chemicals 95 according to the principles of the present invention. As shown, a supply of wet lignocellulosic furnish material (e.g. wood strands, chips, particles, etc.) 94, a supply of environmentally-clean liquid fire inhibiting biochemicals of the present invention 93, and a supply of liquid resin binder (e.g. pMDI resin) chemical 95 are supplied and provide to several (e.g. three) pipelines. As shown, the pipelines are used to support: (i) fire inhibiting treatment of the wood furnish material 94, (ii) biochemical treatment of the resin binder chemicals 94, and (iii) resinating the treated wood furnish material 94′ with treated resin binder material 95′ before being processed and formed into layers (e.g. mats) that are then stacked into an stacked layer assembly, and then molded and compressed under heat and pressure to cure the applied binder resin chemicals 95′, whereupon the molded wood product is released from the molds, and then sprayed with a polymer-based moisture protection top coating 96 to produce finished final engineering wood product (EWP) in the form of a panel or other building construction component.

FIG. 52 describes the high level steps carried out during the first generalized method of producing multi-ply fire-protected composite wood products (i.e. OSB panels) on the system of FIG. 51, using liquid resin binder biochemicals 95 mixed with environmentally-clean liquid fire inhibiting chemicals 93 according to the principles of the present invention, comprising the steps of: (a) providing a supply of wet lignocellulosic (wood) furnish material (i.e. strands, chips, fibers, particles, etc.) 94 for use in producing composite engineered wood products (EWPs); (b) providing a supply of environmentally-clean liquid fire inhibiting biochemical 93, and applying the environmentally-clean liquid fire inhibiting biochemical 93 to the lignocellulosic furnish material 94 to provide fire protection to the treated lignocellulosic furnish material 94′, and inhibition against corrosion of metal(s) in contact with the treated furnish material; (c) providing a supply of liquid resin binder (e.g. pMDI resin) 95 for use in binding together the treated wood furnish material 94′, when producing fire-protected wood products; (d) mixing a minor amount of environmentally-clean fire inhibiting chemical 93 with a major amount of liquid resin binder 95, before applying the mixed treated binder resin to the treated wood furnish material 94′; (e) using a particle-binder mixing/resinating module to apply the mixture of resin binder 95 and fire inhibiting biochemical 93, to a supply of treated wood furnish material 94′, and produce a supply of resinated treated wood furnish material 94′/95′; (f) molding the resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product; and (g) applying a mold and moisture protection coating over said fire-protected composite wood product so as to produce a finished engineered wood product (EWP) having fire, metal-corrosion, mold and moisture protection.

Specification Of A First Exemplary Factory-Based System For Producing Multi-Ply Fire-Protected Composite Wood Products Using Environmentally-Clean Liquid Fire Inhibiting And Resin Binder Chemicals (E.G. Single Component Binder System Comprising Uncatalyzed PMDI Prepolymeric Resins) According To The Principles Of The Present Invention

FIG. 53 shows a first exemplary factory-based system for producing multi-ply fire-protected composite wood products (i.e. OSB panels) using environmentally-clean liquid fire inhibiting and resin binder chemicals (e.g. single component binder system comprising uncatalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, and a supply of liquid resin binder (e.g. pMDI resin) chemical 95 are supplied and provided to several (e.g. three) pipelines. As shown, the pipelines are used to support: (i) fire inhibiting treatment of the wood furnish material 94, (ii) treating the liquid resin binder chemicals 95, and (iii) resinating the treated wood furnish material 94 before being processed and formed into layers (e.g. mats) that are then stacked into a stacked layer assembly, and then molded and compressed under heat and pressure to cure the applied binder resin. Upon completion of the pressing process, the molded wood product is released from the molds, and thereafter sprayed with a polymer-based moisture protection top coating 96 to produce finished final engineering wood product (EWP) in the form of a panel or other building construction component.

FIG. 54 describes the high level steps carried out during a first method of producing multi-ply fire-protected composite wood products (i.e. OSB panels) using one-component liquid resin binder chemicals mixed with environmentally-clean dry fire inhibiting chemicals according to the principles of the present invention, comprising the steps of: (a) providing a supply of wet lignocellulosic (wood) furnish material (i.e. strands, chips, fibers, particles, etc.) for use in producing composite engineered wood products (EWPs); (b) providing a supply of environmentally-clean dry fire inhibiting chemical powder and applying the environmentally-clean dry fire inhibiting chemical powder to the lignocellulosic furnish material provide Class-A fire protection to the treated Lignocellulosic furnish material, and inhibition against corrosion of metal in contact with the treated furnish material; (c) providing a supply of liquid resin binder (e.g. pMDI resin) for use in binding wood furnish material together when producing fire-protected wood products; (d) mixing a minor amount of environmentally-clean dry powder fire inhibiting biochemical with a major amount of liquid resin binder chemical, before applying treated binder resin to treated wood furnish material; (e) using a particle-binder mixing/resinating module to apply the mixture of liquid resin binder and dry fire inhibiting chemical powder, to a supply of wood furnish material, to produce a supply of resinated treated wood furnish; (f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product; and (g) applying a mold and moisture protection coating over said fire-protected composite wood product so as to produce a finished engineered wood product (EWP) having fire, metal-corrosion, mold and moisture protection.

Specification Of A Second Exemplary Factory-Based System For Producing Multi-Ply Fire-Protected Composite Wood Products Using Environmentally-Clean Liquid Fire Inhibiting And One-Component Resin Binder Chemicals (E.G. Two Component Binder System Comprising Catalyzed PMDI Prepolymeric Resins) According To The Principles Of The Present Invention

FIG. 55 shows a second exemplary factory-based system for producing multi-ply fire-protected composite wood products (i.e. OSB panels) using environmentally-clean liquid fire inhibiting and one-component resin binder chemicals (e.g. two component binder system comprising catalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, a supply of liquid resin binder (e.g. pMDI resin) 95 and a supply of liquid binder catalyst (e.g. HCL) 95C, are supplied to several (e.g. three) pipelines. As shown, the pipelines are used to support (i) fire inhibiting treatment of the wood furnish material 94, and (ii) resinating the treated wood furnish material 94′ before being processed and formed into layers (e.g. mats) 94′/95′ that are then stacked into a stacked layer assembly, and then molded and compressed under heat and pressure to cure the applied binder resin. Upon completely the pressing process, the molded wood product is released from the molds, and thereafter sprayed with a polymer-based moisture protection top coating to produce finished final engineering wood product (EWP) in the form of a panel or other building construction component.

FIG. 56 describes the high level steps carried out during the second method of producing multi-ply fire-protected composite wood products (i.e. OSB panels) using one-component liquid resin binder chemicals mixed with environmentally-clean liquid fire inhibiting biochemicals according to the principles of the present invention, comprising the steps of: (a) providing a supply of wet lignocellulosic (wood) furnish material (i.e. strands, chips, fibers, particles, etc.) 94 for use in producing composite engineered wood products (EWPs); (b) providing a supply of environmentally-clean liquid fire inhibiting chemical 93 and applying the environmentally-clean liquid fire inhibiting chemical 93 to lignocellulosic furnish material 94 to provide fire protection to treated lignocellulosic (wood) furnish material 94′, and inhibition against corrosion of metal in contact with the treated furnish material 94′; (c) providing a supply of liquid resin binder (e.g. pMDI resin) 95 for use in binding together treated wood furnish material 94′ when producing fire-protected wood products; (d) mixing a minor amount of environmentally-clean liquid fire inhibiting biochemical 93 with a major amount of liquid resin binder chemical 95, before applying treated binder resin 95′ to treated wood furnish material 94′; (e) using a particle-binder mixing/resinating module to apply the mixture of liquid resin binder 95 and liquid fire inhibiting chemical 93, to a supply of wood furnish material 94 to produce a supply of resinated treated wood furnish material 94′/95′; (f) molding the resonated wood furnish material 94′/95′ to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and (g) applying a mold ₈ moisture protection coating over said fire-protected composite wood product so as to produce a finished engineered wood product (EWP) having fire, metal-corrosion, mold and moisture protection.

Specification Of A Third Exemplary Factory-Based System For Producing Multi-Ply Fire-Protected Composite Wood Products Using Environmentally-Clean Liquid Fire Inhibiting And One-Component Resin Binder Chemicals (E.G. Single Component Binder System Comprising Uncatalyzed PMDI Prepolymeric Resins) According To The Principles Of The Present Invention

FIG. 57 shows a third exemplary factory-based system for producing multi-ply fire-protected composite wood products (i.e. MDF, HDF and PB panels) using environmentally-clean liquid fire inhibiting and one-component resin binder chemicals (e.g. single component binder system comprising uncatalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, and a supply of liquid resin binder (e.g. pMDI resin) 95 are supplied to several (e.g. three) pipelines. The pipelines are used to support (i) fire inhibiting treatment of the wood furnish material 94, (ii) treating resin binder material 95 with environmentally-clean biochemicals 93, and (iii) resinating the treated wood furnish material 94′ before being processed and formed into layers (e.g. mats) 94′/95′ that are then stacked into a stacked layer assembly, and then molded and compressed under heat and pressure to cure the applied binder resin. Upon completing the pressing process, the molded wood product is released from the molds, and thereafter sprayed with a polymer-based moisture protection top coating to produce finished final engineering wood product (EWP) in the form of a panel or other building construction component.

FIG. 58 describes the high level steps carried out during a third method of producing multi-ply fire-protected composite wood products (i.e. OSB panels) using one-component liquid resin binder chemicals mixed with environmentally-clean dry fire inhibiting chemicals according to the principles of the present invention, comprising the steps of: (a) providing a supply of wet lignocellulosic (wood) furnish (i.e. strands, chips, fibers, particles, etc.) 94 for use in producing composite engineered wood products (EWPs); (b) providing a supply of environmentally-clean liquid fire inhibiting chemical 93 and applying the environmentally-clean liquid fire inhibiting chemical 93 to the lignocellulosic furnish material 94 to provide Class-A fire protection to the treated lignocellulosic furnish material 94′, and inhibition against corrosion of metal in contact with the treated furnish material 94′; (c) providing a supply of liquid resin binder (e.g. pMDI resin) 94 for use in binding treated wood furnish material 94′ together when producing fire-protected wood products; (d) mixing a minor amount of environmentally-clean liquid fire inhibiting biochemical 93 with a major amount of liquid resin binder material 95, before applying treated binder resin 95′ to treated wood furnish material 94′; (e) using a particle-binder mixing/resinating module to apply the mixture of liquid resin binder 95 and liquid fire inhibiting chemical 93, to a supply of treated wood furnish material 94′ in the rotating drum to produce a supply of resinated treated wood furnish material 94′/95′; (f) molding the resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly cured under pressure to the form a fire-protected composite wood product; and (g) applying a mold ₈ moisture protection coating over the fire-protected composite wood product so as to produce a finished engineered wood product (EWP) having fire, metal-corrosion, mold and moisture protection.

Specification Of A Fourth Exemplary Factory-Based System For Producing Multi-Ply Fire-Protected Composite Wood Products Using Environmentally-Clean Liquid Fire Inhibiting Biochemical And Resin Binder Chemicals (E.G. Two Component Binder System Comprising Catalyzed PMDI Prepolymeric Resins) According To The Principles Of The Present Invention

FIG. 59 shows a fourth exemplary factory-based system for producing multi-ply fire-protected composite wood products (i.e. MDF, HDF, PB panels) using environmentally-clean liquid fire inhibiting biochemical and resin binder chemicals (e.g. two component binder system comprising catalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, a supply of liquid resin binder (e.g. pMDI resin) 95 and a supply of liquid binder catalyst (e.g. HCL) 95C, are supplied to several (e.g. three) pipelines. The pipelines are used to support (i) fire inhibiting treatment of the wood furnish material 94, (ii) treating the resin binder chemicals 95 with environmentally-clean biochemicals 93, and (iii) resinating the treated wood furnish material 94′ before being processed and formed into layers (e.g. mats) 94′/95′ that are then stacked into a stacked layer assembly, and then molded and compressed under heat and pressure to cure the applied binder resin. Upon completing the pressing process, the molded wood product is released from the molds, and thereafter sprayed with a polymer-based moisture protection top coating to produce finished final engineering wood product (EWP) in the form of a panel or other building construction component.

FIG. 6O describes the high level steps carried out during a fourth method of producing fire-protected composite wood products (e.g. HDF, MDF and PB panels) using liquid resin binder chemicals 95 mixed with environmentally-clean liquid fire inhibiting chemicals 93 according to the principles of the present invention, comprising the steps of: (a) providing a supply of wet lignocellulosic (wood) furnish (i.e. strands, chips, fibers, particles, etc.) 94 for use in producing composite engineered wood products (EWPs); (b) providing a supply of environmentally-clean liquid fire inhibiting chemical 93 and applying the environmentally-clean liquid fire inhibiting chemical 93 to the lignocellulosic furnish material 94 to provide fire protection to the treated lignocellulosic furnish material 94′, and inhibition against corrosion of metal in contact with the treated furnish material 94′; (c) providing a supply of liquid resin binder 95 (e.g. pMDI resin) for use in binding treated wood furnish material 94′ together when producing fire-protected wood products; (d) mixing a minor amount of environmentally-clean liquid fire inhibiting biochemical 93 with a major amount of liquid resin binder chemical 95, before applying treated binder resin 95′ to treated wood furnish material 94′; (e) using a particle-binder mixing/resinating module to apply the mixture of liquid resin binder 95 and liquid fire inhibiting biochemical composition 93, to a supply of wood furnish material 94 to produce a supply of resinated treated wood furnish material 94′/95′; (f) molding the resonated wood furnish material 94′/95′ to form a bottom composite wood layer, a core composite wood layer and a top composite wood layer, whereafter the core composite wood layer is stacked between the top and bottom composite wood layers, and then the assembly is cured under pressure to the form a fire-protected composite wood product; and (g) applying a mold and moisture protection coating over said fire-protected composite wood product so as to produce a finished engineered wood product (EWP) having fire, metal-corrosion, mold and moisture protection.

Specification Of A Second Generalized Factory-Based System For Producing Multi-Ply Fire-Protected Composite Wood Products Using Environmentally-Clean Dry Powder And Liquid Fire Inhibiting Biochemicals And Resin Binder Chemicals Mixed And Blended Together According To The Principles Of The Present Invention

FIG. 61 shows a second generalized factory-based system for producing multi-ply fire-protected composite wood products (i.e. OSB panels) using environmentally-clean dry powder and liquid fire inhibiting biochemicals and resin binder chemicals mixed and blended together according to the principles of the present invention. As shown, the system comprises: a supply of wet lignocellulosic furnish material (e.g. wood strands, chips, particles, etc.) 94; a supply of environmentally-clean liquid and dry powder fire inhibiting biochemicals of the present invention 93, and a supply of liquid resin binder (e.g. pMDI resin) 95 are supplied to several (e.g. three) pipelines. As shown, the pipelines are used to support (i) fire inhibiting (dry powder) treatment of the wood furnish material 94, (ii) treating liquid resin binder chemicals with environmentally-clean biochemicals 95, and (iii) resinating the treated wood furnish material 94′ with treated liquid resin binder 95′ before being processed and formed into layers (e.g. mats) 94′/95′ that are then stacked into a stacked layer assembly, and then molded and compressed under heat and pressure to cure the applied binder resin. Upon completing the pressing process, the molded wood product is released from the molds, and then sprayed with a polymer-based moisture protection top coating to produce finished final engineering wood product (EWP) in the form of a panel or other building construction component.

FIG. 62 describes the high level steps carried out during a second generalized method of producing multi-ply fire-protected composite wood products (i.e. OSB panels) using liquid resin binder chemicals 95 mixed with environmentally-clean liquid fire inhibiting biochemicals 93 according to the principles of the present invention, comprising the steps of (a) providing a supply of wet lignocellulosic (wood) furnish material (i.e. strands, chips, fibers, particles, etc.) 94 for use in producing composite engineered wood products (EWPs), (b) providing a supply of environmentally-clean dry powder fire inhibiting biochemical 93, and applying the environmentally-clean dry powder fire inhibiting biochemical 93 to the lignocellulosic furnish material 94 to provide fire protection to the treated lignocellulosic furnish material 94′, and inhibition against corrosion of metal(s) in contact with the treated furnish material 94′, (c) providing a supply of liquid resin binder (e.g. pMDI resin) 95 for use in binding together the treated wood furnish material 94′, when producing fire-protected wood products, (d) mixing a minor amount of environmentally-clean fire inhibiting biochemical 93 with a major amount of liquid resin binder 95, before applying the mixed biochemically-treated binder resin 95′ to the biochemically-treated wood furnish material 94′, (e) using a particle-binder mixing/resinating module to apply the mixture of resin binder 95 and fire inhibiting biochemical 93, to a supply of biochemically-treated wood furnish material 94′, and produce a supply of resinated treated wood furnish material 94′/95′, (f) molding the resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product, and (g) applying a mold and moisture protection coating over said fire-protected composite wood product so as to produce a finished engineered wood product (EWP) having fire, metal-corrosion, mold and moisture protection.

Specification Of A Fifth Exemplary Factory-Based System For Producing Multi-Ply Fire-Protected Composite Wood Products Using Environmentally-Clean Dry Powder And Liquid Fire Inhibiting Biochemicals And Resin Binder Chemicals (E.G. Single Component Binder System Comprising Uncatalyzed PMDI Prepolymeric Resins) According To The Principles Of The Present Invention

FIG. 63 shows a fifth exemplary factory-based system for producing multi-ply fire-protected composite wood products (i.e. OSB panels) using environmentally-clean dry powder and liquid fire inhibiting biochemicals and resin binder chemicals (e.g. single component binder system 95 comprising uncatalyzed PMDI prepolymeric resins according to the principles of the present invention. As shown, a supply of wet lignocellulosic furnish material (e.g. wood strands, chips, particles, etc.) 94, a supply of environmentally-clean liquid fire inhibiting biochemicals of the present invention 93, and a supply of liquid resin binder (e.g. pMDI resin) 95 are supplied to several (e.g. three) pipelines. The pipelines are used to support (i) fire inhibiting treatment of the wood furnish material 94, treating resin binder chemical 95 with environmentally-clean biochemicals 93, and (iii) resinating the treated wood furnish material 94′ before being processed and formed into layers (e.g. mats) 94′/95′ that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

FIG. 64 describes the high level steps carried out during a fifth method of producing multi-ply fire-protected composite wood products (i.e. OSB panels) using dry power biochemicals 93 to treat wood furnish material 94 and environmentally-clean liquid fire inhibiting biochemicals 93 to treat resin binder chemicals 95 according to the principles of the present invention, comprising the steps of: (a) providing a supply of wet lignocellulosic (wood) furnish material (i.e. strands, chips, fibers, particles, etc.) 94 for use in producing composite engineered wood products (EWPs); (b) providing a supply of environmentally-clean dry power fire inhibiting biochemical 93 and applying the environmentally-clean dry powder fire inhibiting biochemical powder 93 to the wet lignocellulosic furnish material 94 provide Class-A fire protection to the treated lignocellulosic furnish material 94′, and inhibition against corrosion of metal in contact with the treated furnish material 94′; (c) providing a supply of liquid resin binder (e.g. pMDI resin) 95 for use in binding wood furnish material together when producing fire-protected wood products; (d) mixing a minor amount of environmentally-clean dry fire inhibiting chemical powder 93 with a major amount of liquid resin binder 95, before applying treated binder resin 95′ to treated wood furnish material 94′; (e) using a particle-binder mixing/resinating module to apply the mixture of liquid resin binder 95 and dry fire inhibiting chemical powder 93, to a supply of treated wood furnish material 94, to produce a supply of resinated treated wood furnish 94′/95′; (f) molding the resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product; and (g) applying a mold and moisture protection coating over said fire-protected composite wood product so as to produce a finished engineered wood product (EWP) having fire, metal-corrosion, mold and moisture protection.

Specification Of A Sixth Exemplary Factory-Based System For Producing Multi-Ply Fire-Protected Composite Wood Products Using Environmentally-Clean Liquid And Dry Powder Fire Inhibiting Biochemicals To Treat Wood Furnish Material And Resin Binder

Chemicals (E.G. Two Component Binder System Comprising Catalyzed PMDI Prepolymeric Resins) According To The Principles Of The Present Invention

FIG. 65 shows a sixth exemplary factory-based system for producing multi-ply fire-protected composite wood products (i.e. OSB panels) using environmentally-clean liquid and dry powder fire inhibiting biochemicals 93 to treat wood furnish material 94 and resin binder chemicals (e.g. two component binder system comprising catalyzed PMDI prepolymeric resins) 95 according to the principles of the present invention. As shown, a supply of wet lignocellulosic furnish material (e.g. wood strands, chips, particles, etc.) 94, a supply of environmentally-clean liquid fire inhibiting biochemicals of the present invention 93, a supply of liquid resin binder (e.g. pMDI resin) 95 and a supply of liquid binder catalyst (e.g. HCL) 95C, are supplied to several (e.g. three) pipelines. The pipelines are used to support (i) fire inhibiting treatment of the wood furnish material 94, (ii) treating of liquid resin binder 95 with the biochemicals 93, and (iii) resinating the treated wood furnish material 94′ before being processed and formed into layers (e.g. mats) 94′/95′ that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

FIG. 66 describes the high level steps carried out during a sixth method of producing multi-ply fire-protected composite wood products (i.e. OSB panels) using liquid resin binder chemicals 95 mixed with environmentally-clean liquid fire inhibiting chemicals 93 according to the principles of the present invention, comprising the steps of: (a) providing a supply of wet lignocellulosic (wood) furnish material (i.e. strands, chips, fibers, particles, etc.) 94 for use in producing composite engineered wood products (EWPs); (b) providing a supply of environmentally-clean liquid fire inhibiting chemical 93 and applying the environmentally-clean liquid fire inhibiting chemical 93 to lignocellulosic furnish material 94 to provide fire protection to treated lignocellulosic (wood) furnish material 94′, and inhibition against corrosion of metal in contact with the treated furnish material 94′; (c) providing a supply of liquid resin binder (e.g. pMDI resin) 95 for use in binding together treated wood furnish material 94′ when producing fire-protected wood products; (d) mixing a minor amount of environmentally-clean liquid fire inhibiting chemical 93 with a major amount of liquid resin binder 95, before applying treated binder resin 95′ to treated wood furnish material 94′; (e) using a particle-binder mixing/resinating module to apply, the mixture of liquid resin binder 95 and liquid fire inhibiting chemical 93, to a supply of wood furnish material 94 to produce a supply of resinated treated wood furnish material 94′/95′; (f) molding the resonated wood furnish material 94′/95′ to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and (g) applying a mold and moisture protection coating over said fire-protected composite wood product so as to produce a finished engineered wood product (EWP) having fire, metal-corrosion, mold and moisture protection.

Specification Of A Seventh Exemplary Factory-Based System For Producing Multi-Ply Fire-Protected Composite Wood Products Using Environmentally-Clean Liquid Fire Inhibiting And Resin Binder Chemicals (E.G. Single Component Binder System Comprising Uncatalyzed PMDI Prepolymeric Resins) According To The Principles Of The Present Invention

FIG. 67 shows a seventh exemplary factory-based system for producing multi-ply fire-protected composite wood products (i.e. MDF, HDF and PB panels) using environmentally-clean liquid fire inhibiting and resin binder chemicals (e.g. single component binder system comprising uncatalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, and a supply of liquid resin binder (e.g. pMDI resin) 95 are supplied to several (e.g. three) pipelines. The pipelines are used to support (i) fire inhibiting treatment of the wood furnish material 94, (ii) treating of liquid resin binder 95 with the biochemicals 93, and (iii) resinating the treated wood furnish material 94′/95′ before being processed and formed into layers (e.g. mats) 94′/95′ that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

FIG. 68 describes the high level steps carried out during a seventh method of producing multi-ply fire-protected composite wood products (i.e. OSB panels) using liquid resin binder chemicals 95 mixed with environmentally-clean dry powder and liquid fire inhibiting biochemicals according to the principles of the present invention, comprising the steps of: (a) providing a supply of wet lignocellulosic (wood) furnish (i.e. strands, chips, fibers, particles, etc.) 94 for use in producing composite engineered wood products (EWPs); (b) providing a supply of environmentally-clean dry powder fire inhibiting biochemical 93 and applying the environmentally-clean dry powder fire inhibiting biochemical 93 to the lignocellulosic furnish material 94 to provide Class-A fire protection to the treated lignocellulosic furnish material 94′, and inhibition against corrosion of metal in contact with the treated furnish material 94′; (c) providing a supply of liquid resin binder (e.g. pMDI resin) 95 for use in binding treated wood furnish material ‘94 together when producing fire-protected wood products; (d) mixing a minor amount of environmentally-clean liquid fire inhibiting chemical 93 with a major amount of the liquid resin binder 95, before applying treated binder resin 95’ to treated wood furnish material 94′; (e) using a particle-binder mixing/resinating module to apply the mixture of liquid resin binder 95 and liquid fire inhibiting chemical 93, and treat a supply of wood furnish material 94 in the rotating drum to produce a supply of resinated treated wood furnish material 94′; (f) molding the (pMDI) resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product; and (g) applying a mold and moisture protection coating over the fire-protected composite wood product so as to produce a finished engineered wood product (EWP) having fire, metal-corrosion, mold and moisture protection.

Specification Of An Eighth Exemplary Factory-Based System For Producing Multi-Ply Fire-Protected Composite Wood Products Using Environmentally-Clean Dry Powder Fire Inhibiting Biochemical To Treat Wood Furnish Materials, And Environmentally-Clean Dry Powder Fire Inhibiting Biochemical To Treat Liquid Resin Binder Chemicals (E.G. Two Component Binder System Comprising Catalyzed PMDI Prepolymeric Resins) According To The Principles Of The Present Invention

FIG. 69 shows an eighth exemplary factory-based system for producing multi-ply fire-protected composite wood products (i.e. MDF, HDF, PB panels) using environmentally-clean dry powder fire inhibiting biochemical 93 to treat wood furnish materials 94, and environmentally-clean dry powder fire inhibiting biochemical 93 to treat liquid resin binder chemicals 95 (e.g. two component binder system comprising catalyzed PMDI prepolymeric resins) according to the principles of the present invention. As shown, a supply of wet lignocellulosic furnish material (e.g. wood strands, chips, particles, etc.) 94, a supply of environmentally-clean liquid fire inhibiting biochemicals of the present invention 93, a supply of liquid resin binder (e.g. pMDI resin) 95 and a supply of liquid binder hardener/catalyst 95C, are supplied to several (e.g. three) pipelines. The pipelines are used to support (i) fire inhibiting treatment of the wood furnish material 94, (ii) treating of liquid resin binder 95 with the biochemicals 93, and (iii) resinating the treated wood furnish material 94′ before being processed and formed into layers (e.g. mats) 94′/95′ that are then stacked into a stacked layer assembly, and then molded and compressed under heat and pressure to cure the applied binder resin. Upon completing the pressing process, the molded wood product is released from the molds, and thereafter sprayed with a polymer-based moisture protection top coating to produce finished final engineering wood product (EWP) in the form of a panel or other building construction component.

FIG. 70 describes the high level steps carried out during an eighth method of producing fire-protected composite wood products (e.g. HDF, MDF and PB panels) using liquid resin binder chemicals 95 mixed with environmentally-clean dry powder fire inhibiting biochemicals 93 according to the principles of the present invention, comprising the steps of (a) providing a supply of wet lignocellulosic (wood) furnish (i.e. strands, chips, fibers, particles, etc.) 94 for use in producing composite engineered wood products (EWPs); (b) providing a supply of environmentally-clean dry powder fire inhibiting biochemical 93 and applying the environmentally-clean dry powder fire inhibiting biochemical 93 to the lignocellulosic furnish material 94 to provide fire protection to treated lignocellulosic furnish material 94′, and inhibition against corrosion of metal in contact with treated furnish material 94′; (c) providing a supply of liquid resin binder (e.g. pMDI resin) 95 for use in binding together treated wood furnish material 94′ when producing fire-protected wood products; (d) mixing a minor amount of environmentally-clean dry powder fire inhibiting biochemical 93, with a major amount of liquid resin binder 95, before applying treated binder resin 95′ to treated wood furnish material 94′; (e) using a particle-binder mixing/resinating module to apply the (treated) mixture of liquid resin binder 95 and dry fire inhibiting chemical powder 93 to a supply of treated wood furnish material 94′ to produce a supply of resinated treated wood furnish material 94′/95′ for molding purposes; (f) molding the resinated treated wood furnish material 94′/95′ to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and (g) applying a mold and moisture protection coating over the fire-protected composite wood product so as to produce a finished engineered wood product (EWP) having fire, metal-corrosion, mold and moisture protection.

Specification Of Method Of And System For Producing Class-A Fire Protected Wood By Undergoing Pressurized Treatment Contained Within A Pressurized Tank Holding Untreated Lumber And/Or Wood Products And Filled With Environmentally-Clean Biochemical Liquid According To The Present Invention

FIG. 71 shows a piece of untreated wood that is transformed into a piece of Class-A fire protected wood by undergoing pressurized treatment contained within a pressurized tank holding untreated lumber and/or wood products and filled with environmentally-clean biochemical liquid according to the present invention 93 that is used to impregnate wood fibers within the treated wood products and provide fire, mold/mildew and moisture protection to the treated wood products.

FIG. 72A shows a first perspective view of a system of the present invention 400 adapted for pressure treating untreated wood within a pressurized tank filled with biochemical liquid according to the present invention 93, wherein environmentally clean wood treating biochemical liquid 93 is pumped by a pressure pump into the treatment tank containing pieces of untreated wood, so as to impregnate wood fibers with the biochemical liquid 93 and provide fire, mold/mildew and moisture protection.

FIG. 72B shows a second perspective view of the system of the present invention adapted for pressure treating untreated wood contained within a pressurized tank filled with biochemical liquid 93 according to the present invention. As shown, the environmentally clean wood treating biochemical liquid 93 is pumped by a pressure pump into the treatment tank containing pieces of untreated wood, so as to impregnate wood fibers with the biochemical liquid and provide fire, mold/mildew and moisture protection.

FIG. 73A and FIG. 73B describes the primary steps the method of producing Class-A fire-protected lumber according to the present invention by pressure treatment of wood material with environmentally-clean biochemicals of the present invention.

As indicated in Step A of FIG. 74, the method involves loading the lumber (or wood product) into a pressure treatment tank, for pressure treatment with environmentally-clean fire-inhibiting biochemicals under pressure so as to produce Class-A fire-protected lumber (or composite wood products) that contain biochemicals that inhibit fire ignition, flame spread and smoke development, and metal corrosion, mold, mildew and moisture.

As indicated in Step B of FIG. 74, the method involves impregnating the lumber or wood product with the environmentally-clean fire inhibiting biochemical under pressure for a predetermined amount of time.

As indicated in Step C of FIG. 74, the method involves removing the pressure treated lumber from the pressure treatment tank and allowing the treated lumber or wood product to dry outside the tank.

As indicated in Step D of FIG. 74, the method involves labeling the pressure-treated fire protected wood product as providing protection against fire, metal corrosion, mold, mildew and moisture, as the case may be.

Physical Examination And Fire-Performance Testing Of The Thin Metal Salt Crystalline Structures Formed Using The Biochemical Compositions and Methods And Apparatus Of The Present Invention

One method of viewing the resulting metal salt crystal structures formed within the internal structure and/or upon a surface substrate of a composite wood product to be protected against fire, using the biochemical liquid solution of the present invention, would be by using atomic force microscope to form atomic force microscopy (AFM) images of the biochemical coatings safely applied to the combustible surfaces in accordance with the principles of the present invention. Another method of viewing the resulting metal salt crystal structures would be to use a scanning electron microscope to form scanning electron microscopy (SEM) images. Expectedly, using either instrument, such images of alkali metal salt crystalline structures formed using a greater wt % of coalescent agent (e.g. triethyl citrate dissolved in water with tripotassium citrate) will show that the coalescent agent resulted in metal salt crystal structures that are more coalesced and smoother, and demonstrating higher hardness evolution and better water repulsion, than when the metal salt crystal structures are formed using a lower wt % coalescent agent in the aqueous-based fire inhibiting liquid composition.

Other Useful Applications For The Fire Inhibiting Biochemical Compositions Of The Present Invention

As described above, the fire inhibiting biochemical compositions of the present invention can be used to treat and protect combustible sold and composite (i.e. wood furnish) materials, and polymeric resin binder materials used in producing composite wood products and engineered wood products (EWPs), including panels and structural members, using the fire inhibiting biochemical compositions of the present invention as disclosed and taught herein

When treated with the biochemical liquid compositions of the present invention, and allowed to form fire inhibiting alkali metal ions and/or particles (e.g. salt crystalline structures) within and/or on the surfaces of biochemically treated solid and/or composite wood furnish materials, these solid and composite wood products will remarkably demonstrate Class-A fire protection characteristics that can be reliably proven using the ASTM E84 Testing Standards, as having ultra-low flame spread and smoke development indices.

As disclosed in great detail hereinabove, the fire inhibiting biochemical compositions of the present invention can also be incorporated into composite wood products by treating lignocellulosic-based wood furnish material, as well as polymeric resin binder materials, during composite wood product manufacturing processes. Also, the fire inhibiting biochemical compositions of the present invention can also be used outside the field of lignocellulosic building material production, and used in producing fire-inhibiting paints, coatings and other materials having either functional and/or aesthetic purposes.

The biochemical compositions of the present invention can be used in proactively and actively fight diverse kinds of fires presented in forests, tire warehouses, landfill sites, coal stocks, oil fields, timberyards, and mines.

Advantageously, the clean (i.e. green) fire defense chemistry of the present invention can be used around animal such as horses, dogs, cats, and other pets without posing any health risk to such creatures, while mitigating the risks that fire can present to human life and society at large.

Also, most significantly, the fire inhibiting biochemical compositions of the present invention are substantially free of the many disadvantages and dangers associated with the use of ammonium-based and/or phosphorous-based compounds historically used in fighting forest fires, which have been shown to an adverse effect as fertilizers in watercourses.

The building materials and/or structural components treated with the biochemical compositions of the present invention are distinctly less flammable than untreated building materials. Thus, the biochemical compositions of the present invention can also be used to proactively protect, in factory environments, carbon-storing building materials and/or structural components, such wood panel and engineering wood products (EWPs), from fire outbreaks caused by nature, accident, arson or terrorism. and/or structural components.

### Beliefs, Expectations and Theories Relating To The Present Invention

Although not intending to be bound to the accuracy of any theory or theories relating to the present invention disclosed herein, the Inventor and Applicant believe that incorporation of biochemical treatment of lignocellulosic wood furnish materials and/or polymeric resin binder material used during composite wood product manufacture, should not adversely affect the internal bond values of finished composite wood products produced using the addition rates of biochemical compositions disclosed herein and proposed for practicing the present invention.

It is believed that inhibition to fire ignition, flame spread index (FSI), and smoke generation will improve as the loading rate of biochemical composition increases in the panel. Without the fire retardant treatment in the composite wood product, it is expected that flame spread result for test panels will not qualify for Class-A certification. It is expected that with modest (e.g. at least an 5%) addition rate of biochemical compositions of the present invention to the lignocellulosic wood furnish material, it should be possible to achieve a Class A fire spread index (FSI) on produced composite wood products using the fire treatment processes of the present invention, with very little smoke being generated.

Based on the principles of the present invention, it is believed possible to practice the various manufacturing methods of the present invention with success and produce Class-A fire-protected OSB panels, with fire inhibiting treatment provided throughout the entire composite wood product, including its core layer, outer layers and polymeric resin binder lines, made viable using an appropriate combination of biochemically-treated wood furnish materials and/or polymeric resin binder materials, fire resistant treatments, and proper pressing parameters.

It is believed possible that under the physical conditions expected to be generated in the press, while practicing the methods of the present invention, new and potentially novel materials may be created by the combination of the biochemically-treated wood furnish materials and biochemically-treated PDMI polymeric resin binder materials of the present invention.

It is believed possible that the simple organic acids employed in the biochemical treatment compositions of the present invention, such as for example, formic acid, carbonic acid, lactic acid, gluconic acid, malic acid, citric acid and benzoic acid, may be effective in catalyzing and/or reacting with the PDMI-based polymeric resin binder treatment so as to produce cross-linking and covalent-bonding, and new intermediate chemical species that may produce several possible advantages including, for example:
(i) reducing precuring of resinated wood furnish;
(ii) lowering the reaction onset temperature of the composite wood product;
(iii) reducing the cook time and pressing time for the composite wood product in the press;
(iv) increasing/maintaining the internal bond (IB) strength of composite wood product; and
(v) decreasing resin content required to produce the composite wood product.

While Applicant and Inventor do not intend to limit the claims according to the accuracy of the above theory, the Applicant and Inventor believe that similar catalytic properties might be ascribed to the fire inhibiting biochemical compositions of the present invention.

### Modifications To The Present Invention Which Readily Come To Mind

While the preferred embodiments of the environmentally-clean fire inhibiting biochemical liquid solutions of the present invention are shown and described as being formulated using a single alkali metal salt derived from a non-polymeric saturated carboxylic acid having carbon chain length less than eight (8) to meet practical solubility requirements, it is understood that two or more alkali metal salts derived from different non-polymeric saturated carboxylic acids may be combined together and dissolved in aqueous solution, along with a suitable ester-based coalescing agent, to produce additional embodiments of the water-based biochemical solutions of the present invention that can perform with acceptable fire inhibiting/extinguishing functions, in accordance with the principles of the present invention. Such modifications fall within the scope and spirit of the present invention.

While the alkali metal salt powder particles of the present invention will be typically milled to the size of physical dimensions considered safe for purposes of health and safety reasons, it is expected that in some embodiments, the alkali metal salt powder particles of the present invention 93 may be realized as alkali metal salt powder nanoparticles for embodiment within polymer resin binder material 95 during the biochemical treatment operations according to the present invention.

While the fire inhibiting biochemical compositions of the present invention 93 shown in FIGS. 6 though 6V4 have been described herein for used in lignocellulosic fiber, wood furnish and polymeric resin binder/adhesive material treatment methods, it is understood that these biochemicals can be used in other applications such as proactive wildfire defense application, as well as industrial, commercial and military fire defense and firefighting applications, using both liquid and dry powder formulations, and thus such applications shall fall within the scope and spirit of the present invention.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

What is claimed is:

1. An environmentally-clean aqueous-based fire inhibiting biochemical compositions comprising an aqueous mixture of (i) major amount of alkali metal salt derived from a non-polymerized saturated carboxylic acid characterized by having less than 8 carbon atoms (C1-C7), and dissolved in (ii) a major amount of water (H₂O) along with (iii) a minor amount of dispersing and coalescing agent, dissolved in the water and realized as an ester of a non-polymerized saturated carboxylic acid, promoting dispersion and coalescing of metal alkali ions in lignocellulosic furnish material during the production of composite wood products, and forming alkali metal salt crystalline structures in the lignocellulosic furnish material and/or alkali metal salt crystalline coatings on the surfaces of the wood furnish material and/or the exterior surfaces of treated wood material, when and as water molecules evaporate during drying operations during composite wood production manufacture, thereby depositing alkali metal ions that inhibit fire ignition, flame spread and smoke development.

2. An environmentally-clean fire inhibitors, flame retardants and resin binder compositions suitable for treating lignocellulosic-based wood furnish materials used in the manufacture and production of solid, composite and engineered wood products (EWPs) including cellulose fiber boards, lignocellulosic panels, and wood-based structural members offering protection against fire, metal-corrosion, mold/mildew and moisture.

3. An environmentally-clean fire-inhibiting biochemical compositions for treating lignocellulosic wood-furnish material used in production of a wood composite panel provided with protection against fire, metal-corrosion, mold/mildew and moisture while functioning in a high performance manner, wherein the environmentally-clean fire-inhibiting biochemical compositions comprises:
(i) a major amount of water, and
(ii) a major amount of alkali metal salt dissolved in the quantity of water for producing alkali metal ions, and derived from a saturated non-polymerized carboxylic acid,
wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F, and
(iii) a minor amount of one or more esters dissolved in the water and derived from the saturated non-polymerized carboxylic acid and/or another saturated non-polymerized carboxylic acid, promoting dispersion and coalescing of metal alkali ions in the lignocellulosic furnish material, and forming alkali metal salt crystalline structures in the lignocellulosic furnish material and/or alkali metal salt crystalline coatings on the surfaces of the wood furnish material, when and as water molecules evaporate during drying operations and/or reactions with polymeric resin binders during composite wood product manufacture operations, thereby providing alkali metal ions that inhibit fire ignition, flame spread and smoke development.

3. An environmentally-clean fire inhibiting liquid biochemical solutions (i.e. compositions) for fire-protecting combustible wood furnish material used in the production of composite wood products, comprising:
(i) a major amount of water,
(ii) a major amount of metal alkali salt dissolved in the quantity of water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F, and
(iii) a minor amount of one or more esters dissolved in the water and derived from the saturated non-polymerized carboxylic acid and/or another saturated non-polymerized carboxylic acid, promoting dispersion and coalescing of metal alkali ions in the lignocellulosic furnish material, and forming alkali metal salt crystalline structures in the lignocellulosic furnish material and/or alkali metal salt crystalline coatings on the surfaces of the wood furnish material when and as water molecules evaporate during drying operations curing composite wood manufacturing operations, thereby depositing alkali metal ions in finished composite wood products that inhibit fire ignition, flame spread and smoke development.

4. An environmentally-clean aqueous-based fire inhibiting biochemical compositions and solutions designed for the biochemical treatment of combustible materials, wherein each aqueous-based biochemical composition is formed by
(i) mixing a major amount of a metal alkali salt of a saturated non-polymerized carboxylic acid, that is dissolvable in a major amount of a water, wherein the metal alkali atom is selected from the group consisting of (ecologically-friendly metals) including potassium, calcium, sodium and magnesium, and wherein the carbon chain length of the carboxylic acid is less than eight (C1-C7), and the resulting water-based liquid solution is stable when mixed and its chemical components do not precipitate in the aqueous solution when stored in a storage container, making the aqueous solution ready for use in diverse temperature environments (e.g. 120 F to 34 F), and
(ii) then mixing into the solution, a minor amount of an ester derived from a saturated non-polymerized carboxylic acid carboxylic acid and/or another saturated non-polymerized carboxylic acid, promoting dispersion and coalescing of metal alkali ions in lignocellulosic-based wood furnish material during composite wood product manufacture, and forming alkali metal salt crystalline structures in the lignocellulosic furnish material and/or forming alkali metal salt crystalline coatings on the surfaces of the wood furnish material, when and as water molecules evaporate during drying operations and/or disassociate during composite wood manufacturing operations, thereby depositing alkali metal ions in finished composite wood products that inhibit fire ignition, flame spread and smoke development.

5. An environmentally-clean fire inhibitors, flame retardants and polymeric resin binder materials and compositions, based on different kinds of alkali metal salt, and suitable for treating lignocellulosic materials and/or polymeric resin binder materials (e.g. polymeric methylene diphenyl diisocyanate resins-pMDI or PMDI) used in during the manufacture and production of solid, composite and engineered wood products (EWPs) including cellulose fiber boards, lignocellulosic-based panels, and wood-based structural members providing protection against fire, metal-corrosion, mold/mildew and moisture.

6. An aqueous-based fire inhibiting biochemical composition for treating lignocellulosic-based wood furnish material during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

7. A fire inhibiting biochemical composition for treating lignocellulosic-based wood furnish material during the production of fire-protected composite wood products, using alkali metal salts derived from a carboxylic acid (R—COOH), selected from the group consisting of:
(i) alkali metal salts of formic acid (i.e. methanoic acid);
(ii) alkali metal salts of carbonic acid (i.e. hydroxymethanoic acid);
(iii) alkali metal salts of acetic acid (i.e. ethanoic acid);
(iv) alkali metal salts of glycolic acid (i.e. hydroxyacetic acid);
(v) alkali metal salts of glyoxylic acid;
(vi) alkali metal salts of propionic acid;
(vii) alkali metal salts of lactic acid;
(viii) alkali metal salts of glyceric acid;
(ix) alkali metal salts of tartaric acid;
(x) alkali metal salts of malic acid;
(xi) alkali metal salts of malonic acid;
(xii) alkali metal salts of caproic acid;
(xiii) alkali metal salts of adipic (hexanedioic) acid;
(xiv) alkali metal salts of citric acid; and
(xv) alkali metal salts of benzoic acid.

8. An aqueous-based fire inhibiting biochemical composition for treating lignocellulosic-based wood furnish material during the production of fire-protected composite wood products, using alkali metal salts derived from the C1 carboxylic acid (R—COOH), called formic acid (i.e. methanoic acid), specifically: potassium formate; calcium formate; sodium formate; and magnesium formate (dihydrate).

9. An aqueous-based fire inhibiting biochemical composition for treating lignocellulosic-based wood furnish material during the production of fire-protected composite wood products, using alkali metal salts derived from the C1 carboxylic acid (R—COOH), carbonic acid (i.e. hydroxymethanoic acid); specifically: potassium carbonate K₂CO₃; sodium bicarbonate Na₂CO₃; and magnesium carbonate MgCO₃.

10. An aqueous-based fire inhibiting biochemical composition for treating lignocellulosic-based wood furnish material during the production of fire-protected composite wood products, and produced using alkali metal salts derived from the C2 carboxylic acid (R-COOH), called acetic acid (ethanoic acid), specifically: potassium acetate; calcium acetate; sodium acetate; and magnesium acetate.

11. An aqueous-based fire inhibiting biochemical composition for treating lignocellulosic-based wood furnish material during the production of fire-protected composite wood products, using alkali metal salts derived from the C2 carboxylic acid (R—COOH), called glycolic acid (hydroxyacetic acid) C₂H₄O₃ ; specifically: potassium glycolate C₂H₃KO₃; calcium glycolate C₄H₆CaO₆; and sodium glycolate C₂H₃NaO₃.

12. An aqueous-based fire inhibiting biochemical composition for treating lignocellulosic-based wood furnish material during the production of fire-protected composite wood products, and produced using alkali metal salts derived from the C2 carboxylic acid (R-COOH), called glyoxylic acid, specifically: potassium glyoxylate; calcium glyoxylate; and sodium glyoxylate (monohydrate).

13. An aqueous-based fire inhibiting biochemical composition for treating lignocellulosic-based wood furnish material during the production of fire-protected composite wood products, using alkali metal salts derived from the C2 carboxylic acid (R—COOH), called oxalic acid, specifically: potassium oxalate; calcium oxalate; and sodium oxalate.

14. An aqueous-based fire inhibiting biochemical composition for treating lignocellulosic-based wood furnish material during the production of fire-protected composite wood products, using alkali metal salts derived from the C3 carboxylic acid (R—COOH), called propionic acid, specifically: potassium propionate; calcium propionate; sodium propionate; and magnesium propionate.

15. An aqueous-based fire inhibiting biochemical composition for treating lignocellulosic-based wood furnish material during the production of fire-protected composite wood products, using alkali metal salts derived from the C3 carboxylic acid (R—COOH), called lactic acid, specifically: potassium lactate; calcium lactate; sodium lactate; and magnesium lactate.

16. An aqueous-based fire inhibiting biochemical composition for treating lignocellulosic-based wood furnish material and/or polymeric resin binder material during the production of fire-protected composite wood products, using alkali metal salts derived from the C3 carboxylic acid (R—COOH), called glyceric acid specifically: potassium glycerate; calcium glycerate; and sodium glycerate.

17. An aqueous-based fire inhibiting biochemical composition for treating lignocellulosic-based wood furnish material during the production of fire-protected composite wood products, using alkali metal salts derived from the C3 carboxylic acid (R—COOH), called pyruvic acid, specifically: potassium pyruvate; calcium pyruvate; sodium pyruvate; and magnesium pyruvate.

18. An aqueous-based fire inhibiting biochemical composition for treating lignocellulosic-based wood furnish material during the production of fire-protected composite wood products, using alkali metal salts derived from alkali metal salts produced from the C3 carboxylic acid (R—COOH), called tartaric acid, specifically: potassium tartrate (potassium bitartrate); calcium tartrate, sodium tartrate, and magnesium tartrate.

19. An aqueous-based fire inhibiting biochemical composition for treating lignocellulosic-based wood furnish material during the production of fire-protected composite wood products, using alkali metal salts derived from the C4 carboxylic acid (R—COOH), called butyric acid, specifically: potassium butyrate (or butanoate); calcium butyrate; sodium butyrate; and magnesium butyrate.

20. An aqueous-based fire inhibiting biochemical composition for treating lignocellulosic-based wood furnish material during the production of fire-protected composite wood products, using alkali metal salts derived from the C4 carboxylic acid (R—COOH), called malic acid, specifically: potassium malate; calcium malate; sodium malate; and magnesium malate.

21. An aqueous-based fire inhibiting biochemical composition for treating lignocellulosic-based wood furnish material during the production of fire-protected composite wood products, and produced using alkali metal salts derived from the C4 carboxylic acid (R-COOH), called malonic acid, specifically: potassium malonate; calcium malonate; sodium malonate; and di-magnesium malonate.

22. An aqueous-based fire inhibiting biochemical composition for treating lignocellulosic-based wood furnish material during the production of fire-protected composite wood products, using alkali metal salts derived from the C5 carboxylic acid (R—COOH), called pivalic acid, specifically: potassium pivalate; calcium pivalate; sodium pivalate; and magnesium pivalate.

23. An aqueous-based fire inhibiting biochemical composition for treating lignocellulosic-based wood furnish material during the production of fire-protected composite wood products, and produced using alkali metal salts derived from the C6 carboxylic acid (R-COOH), called caproic acid, specifically: potassium caproate (hexanoate); calcium caproate; sodium caproate; and magnesium caproate.

24. An aqueous-based fire inhibiting biochemical composition for treating lignocellulosic-based wood furnish material during the production of fire-protected composite wood products, using alkali metal salts derived from the C6 carboxylic acid (R—COOH), called adipic (hexanedioic) acid, specifically: potassium adipate; calcium adipate; sodium adipate; and magnesium adipate.

25. An aqueous-based fire inhibiting biochemical composition for treating lignocellulosic-based wood furnish material during the production of fire-protected composite wood products, using alkali metal salts derived from the C6 carboxylic acid (R—COOH), called citric acid, specifically: (tri)potassium citrate; calcium citrate; sodium citrate; and magnesium citrate.

26. An aqueous-based fire inhibiting biochemical composition for treating lignocellulosic-based wood furnish material during the production of fire-protected composite wood products, using alkali metal salts derived from the C7 carboxylic acid (R—COOH), benzoic acid C₇H₆O, specifically: potassium benzoate; calcium benzoate; sodium benzoate; and magnesium benzoate.

27. An environmentally-clean dry powder fire inhibiting biochemical compositions for treating polymeric resin binder material, including pMDI resin binder material, during the production of fire-protected composite wood products, comprising:
(i) a major amount of first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and
(ii) a minor amount of second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys;
(iii) wherein said major amount of first alkali metal salt powder particles are mixed with said minor amount of second alkali metal salt powder particles, and blended with a major amount of pMDI-based polymeric resin binder material for biochemical treatment of said pMDI-based polymeric resin binder material, prior to use in binding together lignocellulosic-based wood furnish material used in the production of composite wood products during a composite wood product manufacturing process, whereby after the treated pMDI-based polymeric resin binder material is cured during the composite wood product manufacturing process, each finished composite wood product contains cured pMDI-based polymeric resin binder material, binding together lignocellulosic-based wood furnish material, and supporting said first alkali metal salt powder particles that are freely available to inhibit fire ignition, flame spread and smoke development, and said second alkali metal salt powder particles that are freely available to inhibit metal-corrosion of said selected metals and/or metallic alloys.

28. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

29. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

30. An environmentally-clean aqueous-based fire inhibiting biochemical solution for treating lignocellulosic-based wood furnish material during the production of fire-protected composite wood products, comprising:
(i) a major amount of water (H₂O) as a solvent and dispersant;
(ii) major amount of alkali metal salt dissolved in the major amount of water (H₂O), and derived from a non-polymerized saturated carboxylic acid characterized by having less than 8 carbon atoms (C1-C7), wherein the alkali metal from which said alkali metal salt is derived is selected from the group consisting of potassium, calcium, sodium and magnesium; and
(iii) a minor amount of dispersing and coalescing agent, dissolved in the water and realized as an ester of a non-polymerized saturated carboxylic acid, promoting dispersion and coalescing of metal alkali ions in lignocellulosic furnish material during the production of composite wood products, and forming alkali metal salt structures in the lignocellulosic-based wood furnish material and/or alkali metal salt crystalline coatings on the exterior surfaces of the treated wood furnish material, when and as water molecules evaporate during drying operations during composite wood production manufacture, thereby producing fire-protected composite wood products having alkali metal ions that are available to inhibit fire ignition, flame spread and smoke development.

31. An environmentally-clean aqueous-based fire inhibiting biochemical solution for treating lignocellulosic-based wood furnish material during the production of fire-protected composite wood products, using alkali metal salts derived from a carboxylic acid (R—COOH), selected from the group consisting of: alkali metal salts of nonpolymeric saturated carboxylic acids for inclusion in the biochemical composition comprises: alkali metal salts of formic acid (i.e. methanoic acid); alkali metal salts of carbonic acid (i.e. hydroxymethanoic acid); alkali metal salts of acetic acid (i.e. ethanoic acid); alkali metal salts of glycolic acid (i.e. hydroxyacetic acid); alkali metal salts of glyoxylic acid; alkali metal salts of propionic acid; alkali metal salts of lactic acid; alkali metal salts of glyceric acid; alkali metal salts of tartaric acid, alkali metal salts of malic acid; alkali metal salts of malonic acid; alkali metal salts of caproic acid; alkali metal salts of adipic (hexanedioic) acid; alkali metal salts of citric acid; and alkali metal salts of benzoic acid.

32. An environmentally-clean aqueous-based fire inhibiting biochemical solution for treating lignocellulosic-based wood furnish material during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate, sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri)potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

33. An aqueous-based fire inhibiting biochemical composition for treating lignocellulosic-based wood furnish material during the production of fire-protected composite wood products, wherein the aqueous-based fire inhibiting biochemical composition contains alkali metal salts derived from C1 Class of Carboxylic Acids having 1 carbon atom, specifically, the C1 carboxylic acid, called formic acid (i.e. methanoic acid).

34. An environmentally-clean aqueous-based fire inhibiting biochemical solution for treating lignocellulosic-based wood furnish material during the production of fire-protected composite wood products, comprising:
a major amount of water;
a major amount of potassium formate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl formate or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated lignocellulosic material, and potassium salt structures form in the treated lignocellulosic material and/or potassium salt crystalline coatings form on the surfaces of treated lignocellulosic material, thereby providing finished composite wood products having potassium ion inhibitors that are available to inhibit fire ignition, flame spread and smoke development.

35. An environmentally-clean aqueous-based fire inhibiting biochemical solution for treating lignocellulosic-based wood furnish material during the production of fire-protected composite wood products, comprising:
a major amount of water;
a major amount of calcium formate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

36. An environmentally-clean aqueous-based fire inhibiting biochemical solution for treating lignocellulosic-based wood furnish material during the production of fire-protected composite wood products, comprising:
a major amount of water;
a major amount of sodium formate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

37. An environmentally-clean aqueous-based fire inhibiting biochemical solution for treating lignocellulosic-based wood furnish material during the production of fire-protected composite wood products, comprising:
a major amount of water;
a major amount of magnesium formate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl formate, or triethyl citrate, dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

38. An environmentally-clean aqueous-based fire inhibiting biochemical solution for treating lignocellulosic-based wood furnish material during the production of fire-protected composite wood products, wherein each said liquid fire inhibitor solution contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

39. An environmentally-clean aqueous-based fire inhibiting biochemical solution for treating lignocellulosic-based wood furnish material during the production of fire-protected composite wood products, comprising:
a major amount of water;
a major amount of potassium carbonate (or bicarbonate) for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

40. An environmentally-clean aqueous-based fire inhibiting biochemical solution for treating lignocellulosic-based wood furnish material during the production of fire-protected composite wood products, comprising:
a major amount of water;
a major amount of sodium carbonate (or bicarbonate) for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

41. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

42. An environmentally-clean aqueous-based fire inhibiting biochemical solution for treating lignocellulosic-based wood furnish material during the production of fire-protected composite wood products, comprising:
a major amount of water;
a major amount of potassium acetate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

43. An environmentally-clean aqueous-based fire inhibiting biochemical solution for treating lignocellulosic-based wood furnish material during the production of fire-protected composite wood products, comprising:
a major amount of water;
a major amount of calcium acetate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

44. An environmentally-clean aqueous-based fire inhibiting biochemical solution for treating lignocellulosic-based wood furnish material during the production of fire-protected composite wood products, comprising:
a major amount of water;
a major amount of sodium acetate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame

45. An environmentally-clean aqueous-based fire inhibiting biochemical solution for treating lignocellulosic-based wood furnish material during the production of fire-protected composite wood products, comprising:
a major amount of water;
a major amount of magnesium acetate for producing magnesium ions when dissolved in water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl acetate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

46. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C2 Class of Carboxylic Acids having 2 carbon atoms, specifically, the C2 carboxylic acid, called glycolic acid (hydroxyacetic acid).

47. An environmentally-clean aqueous-based fire inhibiting biochemical solution for treating lignocellulosic-based wood furnish material during the production of fire-protected composite wood products, comprising:
a major amount of water;
a major amount of potassium glycolate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

48. An environmentally-clean aqueous-based fire inhibiting biochemical solution for treating lignocellulosic-based wood furnish material during the production of fire-protected composite wood products, comprising:
a major amount of water;
a major amount of calcium glycolate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

49. An environmentally-clean aqueous-based fire inhibiting biochemical solution for treating lignocellulosic-based wood furnish material during the production of fire-protected composite wood products, comprising:
a major amount of water;
a major amount of sodium glycolate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl glycolate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame

50. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

51. An environmentally-clean aqueous-based fire inhibiting biochemical solution for treating lignocellulosic-based wood furnish material during the production of fire-protected composite wood products, comprising:
a major amount of water;
a major amount of potassium glyoxylate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having alkali potassium inhibitors that are available to inhibit fire ignition, flame spread and smoke development.

52. An environmentally-clean aqueous-based fire inhibiting biochemical solution for treating lignocellulosic-based wood furnish material during the production of fire-protected composite wood products, comprising:
a major amount of water;
a major amount of calcium glyoxylate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

53. An environmentally-clean aqueous-based fire inhibiting biochemical solution for treating lignocellulosic-based wood furnish material during the production of fire-protected composite wood products, comprising:
a major amount of water;
a major amount of sodium glyoxylate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

54. An environmentally-clean aqueous-based fire inhibiting biochemical solution for treating lignocellulosic-based wood furnish material during the production of fire-protected composite wood products, wherein each said liquid fire inhibitor solution contains alkali metal salts derived from C2 Class of Carboxylic Acids having 2 carbon atoms, specifically, the C2 carboxylic acid, called oxalic acid.

55. An environmentally-clean aqueous-based fire inhibiting biochemical solution for treating lignocellulosic-based wood furnish material during the production of fire-protected composite wood products, comprising:
a major amount of water;
a major amount of potassium oxalate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of dimethyl oxalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

56. An environmentally-clean aqueous-based fire inhibiting biochemical solution for treating lignocellulosic-based wood furnish material during the production of fire-protected composite wood products, comprising:
a major amount of water;
a major amount of calcium oxalate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl oxalate or triethyl citrate dissolved in the water to form the aqueous-based fire inhibiting biochemical solution for treating lignocellulosic-based wood furnish material during the production of fire-protected composite wood products, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

57. An environmentally-clean aqueous-based fire inhibiting biochemical solution for treating lignocellulosic-based wood furnish material during the production of fire-protected composite wood products, comprising:
a major amount of water;
a major amount of sodium oxalate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl oxalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

58. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04).

59. An environmentally-clean aqueous-based fire inhibiting biochemical solution for treating lignocellulosic-based wood furnish material during the production of fire-protected composite wood products, comprising:
a major amount of water;
a major amount of potassium propionate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

60. An environmentally-clean aqueous-based fire inhibiting biochemical solution for treating lignocellulosic-based wood furnish material during the production of fire-protected composite wood products, comprising:
a major amount of water;
a major amount of calcium propionate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

61. An environmentally-clean aqueous-based fire inhibiting biochemical solution for treating lignocellulosic-based wood furnish material during the production of fire-protected composite wood products, comprising:
a major amount of water;
a major amount of sodium propionate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

62. An environmentally-clean aqueous-based fire inhibiting biochemical solution for treating lignocellulosic-based wood furnish material during the production of fire-protected composite wood products, comprising:
a major amount of water;
a major amount of magnesium propionate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl propionate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

63. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called lactic acid.

64. An environmentally-clean aqueous-based fire inhibiting biochemical solution for treating lignocellulosic-based wood furnish material during the production of fire-protected composite wood products, comprising:
a major amount of water;
a major amount of potassium lactate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

65. An environmentally-clean aqueous-based fire inhibiting biochemical solution for treating lignocellulosic-based wood furnish material during the production of fire-protected composite wood products, comprising:
a major amount of water;
a major amount of calcium lactate for producing calcium ions when dissolved in the water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

66. An environmentally-clean aqueous-based fire inhibiting solution for treating lignocellulosic-based wood furnish material during the production of fire-protected composite wood products, comprising:
a major amount of water;
a major amount of sodium lactate for producing sodium ions when dissolved in the water;
a minor amount of alkali metal salt derived from benzoic acid and producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

67. An environmentally-clean aqueous-based fire inhibiting biochemical solution for treating lignocellulosic-based wood furnish material during the production of fire-protected composite wood products, comprising:
a major amount of water;
a major amount of magnesium lactate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl lactate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

68. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

69. An environmentally-clean aqueous-based fire inhibiting biochemical solution for treating lignocellulosic-based wood furnish material during the production of fire-protected composite wood products, comprising:
a major amount of water;
a major amount of potassium glycerate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl glycerate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

70. An environmentally-clean aqueous-based fire inhibitor solution for treating lignocellulosic-based wood furnish material during the production of fire-protected composite wood products, comprising:
a major amount of water;
a major amount of calcium glycerate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl glycerate or triethyl citrate dissolved in the water to form the aqueous-based fire inhibiting biochemical solution for treating lignocellulosic-based wood furnish material during the production of fire-protected composite wood products, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

71. An environmentally-clean aqueous-based fire inhibiting biochemical solution for treating lignocellulosic-based wood furnish material during the production of fire-protected composite wood products, comprising:
a major amount of water;
a major amount of sodium glycerate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl glycerate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

72. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

73. An environmentally-clean aqueous-based fire inhibiting biochemical solution for treating lignocellulosic-based wood furnish material during the production of fire-protected composite wood products, comprising:
a major amount of water;
a major amount of potassium pyruvate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

74. An environmentally-clean aqueous-based fire inhibiting biochemical solution for treating lignocellulosic-based wood furnish material during the production of fire-protected composite wood products, comprising:
a major amount of water;
a major amount of calcium pyruvate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

75. An environmentally-clean aqueous-based fire inhibiting biochemical solution for treating lignocellulosic-based wood furnish material during the production of fire-protected composite wood products, comprising:
a major amount of water;
a major amount of sodium pyruvate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

76. An environmentally-clean aqueous-based fire inhibiting biochemical solution for treating lignocellulosic-based wood furnish material during the production of fire-protected composite wood products, comprising:
a major amount of water;
a major amount of magnesium pyruvate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of ethyl pyruvate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

77. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

78. An environmentally-clean aqueous-based fire inhibiting biochemical solution for treating lignocellulosic-based wood furnish material during the production of fire-protected composite wood products, comprising:
a major amount of water;
a major amount of potassium tartrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

79. An environmentally-clean aqueous-based fire inhibiting biochemical solution for treating lignocellulosic-based wood furnish material during the production of fire-protected composite wood products, comprising:
a major amount of water;
a major amount of calcium tartrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame

80. An environmentally-clean aqueous-based fire inhibiting biochemical solution for treating lignocellulosic-based wood furnish material during the production of fire-protected composite wood products, comprising:
a major amount of water;
a major amount of sodium tartrate for producing sodium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl tartrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

81. An environmentally-clean aqueous-based fire inhibiting biochemical solution for treating lignocellulosic-based wood furnish material during the production of fire-protected composite wood products, comprising:
a major amount of water;
a major amount of magnesium tartrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

82. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

83. An environmentally-clean aqueous-based fire inhibiting biochemical solution for treating lignocellulosic-based wood furnish material during the production of fire-protected composite wood products, comprising:
a major amount of water;
a major amount of potassium butyrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
a minor amount ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having magnesium ion inhibitors that are available to inhibit fire ignition, flame spread and smoke development.

84. An environmentally-clean aqueous-based fire inhibiting biochemical solution for treating lignocellulosic-based wood furnish material during the production of fire-protected composite wood products, comprising:
a major amount of water;
a major amount of calcium butyrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

85. An environmentally-clean aqueous-based fire inhibiting biochemical solution for treating lignocellulosic-based wood furnish material during the production of fire-protected composite wood products, comprising:
a major amount of water;
a major amount of sodium butyrate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

86. An environmentally-clean aqueous-based fire inhibiting biochemical solution for treating lignocellulosic-based wood furnish material during the production of fire-protected composite wood products, comprising:
a major amount of water;
a major amount of magnesium butyrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl butyrate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

87. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic, called malic acid.

88. An environmentally-clean aqueous-based fire inhibiting biochemical solution for treating lignocellulosic-based wood furnish material during the production of fire-protected composite wood products, comprising:
a major amount of water;
a major amount of potassium malate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

89. An environmentally-clean aqueous-based fire inhibiting biochemical solution for treating lignocellulosic-based wood furnish material during the production of fire-protected composite wood products, comprising:
a major amount of water;
a major amount of calcium malate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

90. An environmentally-clean aqueous-based fire inhibiting biochemical solution for treating lignocellulosic-based wood furnish material during the production of fire-protected composite wood products, comprising:
a major amount of water;
a major amount of sodium malate for producing sodium ions when dissolved in the water; and
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

91. An environmentally-clean aqueous-based fire inhibiting biochemical solution for treating lignocellulosic-based wood furnish material during the production of fire-protected composite wood products, comprising:
a major amount of water;
a major amount of magnesium malate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
a minor amount of diethyl malate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

92. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C4 Class of Carboxylic Acids having 4 carbon atoms, specifically, the C4 carboxylic acid, called malonic acid.

93. An environmentally-clean aqueous-based fire inhibiting biochemical solution for treating lignocellulosic-based wood furnish material during the production of fire-protected composite wood products, comprising:
a major amount of water;
a major amount of potassium malonate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

94. An environmentally-clean aqueous-based fire inhibiting biochemical solution for treating lignocellulosic-based wood furnish material during the production of fire-protected composite wood products, comprising:
a major amount of water;
a major amount of calcium malonate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame

95. An environmentally-clean aqueous-based fire inhibiting biochemical solution for treating lignocellulosic-based wood furnish material during the production of fire-protected composite wood products, comprising:
a major amount of water;
a major amount of sodium malonate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

96. An environmentally-clean aqueous-based fire inhibiting biochemical solution for treating lignocellulosic-based wood furnish material during the production of fire-protected composite wood products, comprising:
a major amount of water;
a major amount of di-magnesium malonate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of diethyl malonate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

97. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid;
neopentanoic acid).

98. An environmentally-clean aqueous-based fire inhibiting biochemical solution for treating lignocellulosic-based wood furnish material during the production of fire-protected composite wood products, comprising:
a major amount of water;
a major amount of potassium pivalate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

99. An environmentally-clean aqueous-based fire inhibiting biochemical solution for treating lignocellulosic-based wood furnish material during the production of fire-protected composite wood products, comprising:
a major amount of water;
a major amount of calcium pivalate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

100. An environmentally-clean aqueous-based fire inhibiting biochemical solution for treating lignocellulosic-based wood furnish material during the production of fire-protected composite wood products, comprising:
a major amount of water;
a major amount of sodium pivalate for producing sodium ions when dissolved in the water; and
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

101. An environmentally-clean aqueous-based fire inhibiting biochemical solution for treating lignocellulosic-based wood furnish material during the production of fire-protected composite wood products, comprising:
a major amount of water;
a major amount of magnesium pivalate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of methyl pivalate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

102. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called caproic acid (hexanoic acid).

103. An environmentally-clean aqueous-based fire inhibiting biochemical solution for treating lignocellulosic-based wood furnish material during the production of fire-protected composite wood products, comprising:
a major amount of water;
a major amount of potassium caproate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

104. An environmentally-clean aqueous-based fire inhibiting biochemical solution for treating lignocellulosic-based wood furnish material during the production of fire-protected composite wood products, comprising:
a major amount of water;
a major amount of calcium caproate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame

105. An environmentally-clean aqueous-based fire inhibiting biochemical solution for treating lignocellulosic-based wood furnish material during the production of fire-protected composite wood products, comprising:
a major amount of water;
a major amount of sodium caproate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

106. An environmentally-clean aqueous-based fire inhibiting biochemical solution for treating lignocellulosic-based wood furnish material during the production of fire-protected composite wood products, comprising:
a major amount of water;
a major amount of magnesium caproate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl caproate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

107. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called adipic (hexanedioic) acid.

108. An environmentally-clean aqueous-based fire inhibiting biochemical solution for treating lignocellulosic-based wood furnish material during the production of fire-protected composite wood products, comprising:
a major amount of water;
a major amount of potassium adipate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

109. An environmentally-clean aqueous-based fire inhibiting biochemical solution for treating lignocellulosic-based wood furnish material during the production of fire-protected composite wood products, comprising:
a major amount of water;
a major amount of calcium adipate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame

110. An environmentally-clean aqueous-based fire inhibiting biochemical solution for treating lignocellulosic-based wood furnish material during the production of fire-protected composite wood products, comprising:
a major amount of water;
a major amount of sodium adipate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

111. An environmentally-clean aqueous-based fire inhibiting biochemical solution for treating lignocellulosic-based wood furnish material during the production of fire-protected composite wood products, comprising:
a major amount of water;
a major amount of magnesium adipate for producing magnesium ions when dissolved in the water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
a minor amount of dimethyl adipate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

112. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called citric acid.

113. An environmentally-clean aqueous-based fire inhibiting biochemical solution for treating lignocellulosic-based wood furnish material during the production of fire-protected composite wood products, comprising:
a major amount of water;
a major amount of potassium citrate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

114. An environmentally-clean aqueous-based fire inhibiting biochemical solution for treating lignocellulosic-based wood furnish material during the production of fire-protected composite wood products, comprising:
a major amount of water;
a major amount of calcium citrate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

115. An environmentally-clean aqueous-based fire inhibiting biochemical solution for treating lignocellulosic-based wood furnish material during the production of fire-protected composite wood products, comprising:
a major amount of water;
a major amount of sodium citrate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame spread and smoke development.

116. An environmentally-clean aqueous-based fire inhibiting biochemical solution for treating lignocellulosic-based wood furnish material during the production of fire-protected composite wood products, comprising:
a major amount of water;
a major amount of magnesium citrate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

117. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, d-gluconic acid.

118. An environmentally-clean aqueous-based fire inhibiting biochemical solution for treating lignocellulosic-based wood furnish material during the production of fire-protected composite wood products, comprising:
a major amount of water;
a major amount of potassium gluconate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate (d-gluconic acid, methyl ester) or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

119. An environmentally-clean aqueous-based fire inhibiting biochemical solution for treating lignocellulosic-based wood furnish material during the production of fire-protected composite wood products, comprising:
a major amount of water;
a major amount of calcium gluconate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

120. An environmentally-clean aqueous-based fire inhibiting biochemical solution for treating lignocellulosic-based wood furnish material during the production of fire-protected composite wood products, comprising:
a major amount of water;
a major amount of sodium gluconate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having gluconate ion inhibitors that are available to inhibit fire ignition, flame spread and smoke development.

121. An environmentally-clean aqueous-based fire inhibiting biochemical solution for treating lignocellulosic-based wood furnish material during the production of fire-protected composite wood products, comprising:
a major amount of water;
a major amount of magnesium gluconate for producing magnesium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of methyl gluconate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, magnesium ions disperse and coalesce in the treated material, and magnesium salt crystalline structures form in the treated material and/or magnesium salt crystalline coatings form on the surfaces of treated material, thereby providing finished composite wood products having magnesium ion inhibitors that are available to inhibit fire ignition, flame spread and smoke development.

122. An aqueous-based fire inhibiting biochemical composition for treating lignocellulosic-based wood furnish material during the production of fire-protected composite wood products, wherein said aqueous-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

123. An environmentally-clean aqueous-based fire inhibiting biochemical solution for treating lignocellulosic-based wood furnish material during the production of fire-protected composite wood products, comprising:
a major amount of water;
a major amount of potassium benzoate for producing potassium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, potassium ions disperse and coalesce in the treated material, and potassium salt crystalline structures form in the treated material and/or potassium salt crystalline coatings form on the surfaces of treated material, thereby providing finished composite wood products having potassium ion inhibitors that are available to inhibit fire ignition, flame spread and smoke development.

124. An environmentally-clean aqueous-based fire inhibiting biochemical solution for treating lignocellulosic-based wood furnish material during the production of fire-protected composite wood products, comprising:
a major amount of water;
a major amount of calcium benzoate for producing calcium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, calcium ions disperse and coalesce in the treated material, and calcium salt crystalline structures form in the treated material and/or calcium salt crystalline coatings form on the surfaces of treated material, thereby providing finished composite wood products having calcium ion inhibitors that are available to inhibit fire ignition, flame spread and smoke development.

125. An environmentally-clean aqueous-based fire inhibiting biochemical solution for treating lignocellulosic-based wood furnish material during the production of fire-protected composite wood products, comprising:
a major amount of water;
a major amount of sodium benzoate for producing sodium ions when dissolved in the water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
a minor amount of ethyl benzoate or triethyl citrate dissolved in the water to form the aqueous-based fire inhibiting biochemical solution for treating lignocellulosic-based wood furnish material, wherein as water molecules in the biochemical solution evaporate to the environment and/or react with lignocellulosic material during wood furnish treatment operations, sodium ions disperse and coalesce in the treated material, and sodium salt crystalline structures form in the treated material and/or sodium salt crystalline coatings form on the surfaces of treated material, thereby providing finished composite wood products having sodium ion inhibitors that are available to inhibit fire ignition, flame

126. An environmentally-clean dry powder fire inhibiting biochemical composition for treating lignocellulosic-based wood furnish material during the production of fire-protected composite wood products, comprising:
(i) a major amount of a first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium;
(ii) a minor amount of a second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys; and
(iii) wherein said major amount of first alkali metal salt powder particles are mixed with said minor amount of second alkali metal salt powder particles, and blended together with a fluidizing agent and milled into a dry biochemical treatment powder consisting of fine powder or granular particles,
wherein during biochemical treatment of said lignocellulosic-based wood furnish material, said dry biochemical treatment powder is sprayed over wet/green lignocellulosic-based wood furnish material retaining water molecules, whereby the first and second alkali metal salt powder particles are dissolved in the presence of the water molecules retained in the water molecules, producing first alkali metal ions that are available to inhibit fire, flame spread and smoke development, and benzoate ions that are available to form a protective coating on the surface of selected metals and/or metallic alloys that protects against corrosion of said selected metals and/or metallic alloys.

127. An environmentally-clean dry powder fire inhibiting biochemical composition for treating lignocellulosic-based wood furnish material during the production of fire-protected composite wood products, using alkali metal salts derived from a carboxylic acid (R—COOH), selected from the group consisting of formic acid (i.e. methanoic acid);
carbonic acid (i.e. hydroxymethanoic acid); acetic acid (ethanoic acid); glycolic acid (hydroxyacetic acid); glyoxylic acid; propionic acid; lactic acid; glyceric acid; tartaric acid;
malic acid; malonic acid; caproic acid; adipic (hexanedioic) acid; citric acid; and benzoic acid.

128. An environmentally-clean dry powder fire inhibiting biochemical composition for treating lignocellulosic-based wood furnish material during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid;
(ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

129. An environmentally-clean dry powder fire inhibiting biochemical composition for treating lignocellulosic-based wood furnish material during the production of fire-protected composite wood products, wherein the dry powder-based fire inhibiting biochemical composition contains alkali metal salts derived from C1 Class of Carboxylic Acids having 1 carbon atom, specifically, the C1 carboxylic acid, called formic acid (i.e. methanoic acid).

130. An environmentally-clean dry powder fire inhibiting biochemical composition for treating lignocellulosic-based wood furnish material during the production of fire-protected composite wood products, comprising:
a major amount of potassium formate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

131. An environmentally-clean dry powder fire inhibiting biochemical composition for treating lignocellulosic-based wood furnish material during the production of fire-protected composite wood products, comprising:
a major amount of calcium formate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

132. An environmentally-clean dry powder fire inhibiting biochemical composition for treating lignocellulosic-based wood furnish material during the production of fire-protected composite wood products, comprising:
a major amount of sodium formate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sod salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

133. An environmentally-clean dry powder fire inhibiting biochemical composition for treating lignocellulosic-based wood furnish material during the production of fire-protected composite wood products, comprising:
a major amount of magnesium formate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium formate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

134. An environmentally-clean dry powder fire inhibiting biochemical composition for treating lignocellulosic-based wood furnish material during the production of fire-protected composite wood products, wherein each said dry powder-based fire inhibiting composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

135. An environmentally-clean dry powder fire inhibiting biochemical composition for treating lignocellulosic-based wood furnish material during the production of fire-protected composite wood products, comprising:
a major amount of potassium carbonate (or bicarbonate) for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

136. An environmentally-clean dry powder fire inhibiting biochemical composition for treating lignocellulosic-based wood furnish material during the production of fire-protected composite wood products, comprising:
a major amount of sodium carbonate (or bicarbonate) for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

137. An environmentally-clean dry powder fire inhibiting biochemical composition for treating lignocellulosic-based wood furnish material during the production of fire-protected composite wood products, wherein said aqueous-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

138. An environmentally-clean dry powder fire inhibiting biochemical composition for treating lignocellulosic-based wood furnish material during the production of fire-protected composite wood products, comprising:
a major amount of potassium acetate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

139. An environmentally-clean dry powder fire inhibiting biochemical composition for treating lignocellulosic-based wood furnish material during the production of fire-protected composite wood products, comprising:
a major amount of calcium acetate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the calcium salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

140. An environmentally-clean dry powder fire inhibiting biochemical composition for treating lignocellulosic-based wood furnish material during the production of fire-protected composite wood products, comprising:
a major amount of sodium acetate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

141. An environmentally-clean dry powder fire inhibiting biochemical composition for treating lignocellulosic-based wood furnish material during the production of fire-protected composite wood products, comprising:
a major amount of magnesium acetate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
wherein when said environmentally-clean dry powder-based fire inhibiting biochemical composition is used to treat lignocellulosic-based wood furnish material during the production of fire-protected composite wood products, said magnesium formate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

142. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C2 Class of Carboxylic Acids having 2 carbon atoms, specifically, the C2 carboxylic acid, called glycolic acid (hydroxyacetic acid).

143. An environmentally-clean dry powder fire inhibiting biochemical composition for treating lignocellulosic-based wood furnish material during the production of fire-protected composite wood products, comprising:
a major amount of potassium glycolate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium, and
wherein when said environmentally-clean dry powder-based fire inhibiting biochemical composition is used to treat lignocellulosic-based wood furnish material during the production of fire-protected composite wood products, said potassium formate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

144. An environmentally-clean dry powder fire inhibiting biochemical composition for treating lignocellulosic-based wood furnish material during the production of fire-protected composite wood products, comprising:
a major amount of calcium glycolate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium formate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

145. An environmentally-clean dry powder fire inhibiting biochemical composition for treating lignocellulosic-based wood furnish material during the production of fire-protected composite wood products, comprising:
a major amount of sodium glycolate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium formate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

146. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

147. An environmentally-clean dry powder fire inhibiting biochemical composition for treating lignocellulosic-based wood furnish material during the production of fire-protected composite wood products, comprising:
a major amount of potassium glyoxylate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium glyoxylate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

148. An environmentally-clean dry powder fire inhibiting biochemical composition for treating lignocellulosic-based wood furnish material during the production of fire-protected composite wood products, comprising:
a major amount of calcium glyoxylate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium
wherein when said environmentally-clean dry powder-based fire inhibiting biochemical composition is used to treat lignocellulosic-based wood furnish material during the production of fire-protected composite wood products, said calcium glyoxylate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

149. An environmentally-clean dry powder fire inhibiting biochemical composition for treating lignocellulosic-based wood furnish material during the production of fire-protected composite wood products, comprising:
a major amount of sodium glyoxylate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium glyoxylate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

150. An environmentally-clean dry powder fire inhibiting biochemical composition for treating lignocellulosic-based wood furnish material during the production of fire-protected composite wood products, wherein each said dry powder-based fire inhibiting composition contains alkali metal salts derived from C2 Class of Carboxylic Acids having 2 carbon atoms, specifically, the C2 carboxylic acid, called oxalic acid.

151. An environmentally-clean dry powder-based fire inhibiting biochemical composition for treating lignocellulosic-based wood furnish material during the production of fire-protected composite wood products, comprising:
a major amount of potassium oxalate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium oxalate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

152. An environmentally-clean dry powder fire inhibiting biochemical composition for treating lignocellulosic-based wood furnish material during the production of fire-protected composite wood products, comprising:
a major amount of calcium oxalate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium oxalate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

153. An environmentally-clean dry powder fire inhibiting biochemical composition for treating lignocellulosic-based wood furnish material during the production of fire-protected composite wood products, comprising:
a major amount of sodium oxalate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium oxalate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

154. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04).

155. An environmentally-clean dry powder fire inhibiting biochemical composition for treating lignocellulosic-based wood furnish material during the production of fire-protected composite wood products, comprising:
a major amount of potassium propionate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium propionate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

156. An environmentally-clean dry powder fire inhibiting biochemical composition for treating lignocellulosic-based wood furnish material during the production of fire-protected composite wood products, comprising:
a major amount of calcium propionate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium propionate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

157. An environmentally-clean dry powder fire inhibiting biochemical composition for treating lignocellulosic-based wood furnish material during the production of fire-protected composite wood products, comprising:
a major amount of sodium propionate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium propionate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

158. An environmentally-clean dry powder fire inhibiting biochemical composition for treating lignocellulosic-based wood furnish material during the production of fire-protected composite wood products, comprising:
a major amount of magnesium propionate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium propionate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

159. An environmentally-clean dry powder fire inhibiting biochemical composition for treating lignocellulosic-based wood furnish material during the production of fire-protected composite wood products, wherein said dry powder-based fire inhibiting biochemical composition contains alkali metal salts derived from C3 Class of Carboxylic Acids having 3 carbon atoms, specifically, the C3 carboxylic acid, called lactic acid.

160. An environmentally-clean dry powder fire inhibiting biochemical composition for treating lignocellulosic-based wood furnish material during the production of fire-protected composite wood products, comprising:
a major amount of potassium lactate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium lactate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

161. An environmentally-clean dry powder fire inhibiting biochemical composition for treating lignocellulosic-based wood furnish material during the production of fire-protected composite wood products, comprising:
a major amount of calcium lactate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium lactate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

162. An environmentally-clean dry powder fire inhibiting biochemical composition for treating lignocellulosic-based wood furnish material during the production of fire-protected composite wood products, comprising:
a major amount of sodium lactate for producing sodium ions when dissolved in the presence of water;
a minor amount of alkali metal salt derived from benzoic acid and producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium lactate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

163. An environmentally-clean dry powder fire inhibiting biochemical composition for treating lignocellulosic-based wood furnish material during the production of fire-protected composite wood products, comprising:
a major amount of magnesium lactate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium lactate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

164. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

165. An environmentally-clean dry powder fire inhibiting biochemical composition for treating lignocellulosic-based wood furnish material during the production of fire-protected composite wood products, comprising:
a major amount of potassium glycerate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said potassium glycerate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

166. An environmentally-clean dry powder fire inhibiting biochemical composition for treating lignocellulosic-based wood furnish material during the production of fire-protected composite wood products, comprising:
a major amount of calcium glycerate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium glycerate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

167. An environmentally-clean dry powder fire inhibiting biochemical composition for treating lignocellulosic-based wood furnish material during the production of fire-protected composite wood products, comprising:
a major amount of sodium glycerate for producing sodium ions when dissolved in the presence of water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium glycerate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

168. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

169. An environmentally-clean dry powder-based fire inhibiting biochemical composition for treating lignocellulosic-based wood furnish material during the production of fire-protected composite wood products, comprising:
a major amount of potassium pyruvate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
wherein when said environmentally-clean dry powder-based fire inhibiting biochemical composition is used to treat lignocellulosic-based wood furnish material during the production of fire-protected composite wood products, said potassium pyruvate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

170. An environmentally-clean dry powder fire inhibiting biochemical composition for treating lignocellulosic-based wood furnish material during the production of fire-protected composite wood products, comprising:
a major amount of calcium pyruvate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said calcium pyruvate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

171. An environmentally-clean dry powder fire inhibiting biochemical composition for treating lignocellulosic-based wood furnish material during the production of fire-protected composite wood products, comprising:
a major amount of sodium pyruvate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium pyruvate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

172. An environmentally-clean dry powder fire inhibiting biochemical composition for treating lignocellulosic-based wood furnish material during the production of fire-protected composite wood products, comprising:
a major amount of magnesium pyruvate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium pyruvate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

173. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

174. An environmentally-clean dry powder fire inhibiting biochemical composition for treating lignocellulosic-based wood furnish material during the production of fire-protected composite wood products, comprising:
a major amount of potassium tartrate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali
wherein when said environmentally-clean dry powder-based fire inhibiting biochemical composition is used to treat lignocellulosic-based wood furnish material during the production of fire-protected composite wood products, said potassium tartrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

175. An environmentally-clean dry powder fire inhibiting biochemical composition for treating lignocellulosic-based wood furnish material during the production of fire-protected composite wood products, comprising:
a major amount of calcium tartrate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium tartrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

176. An environmentally-clean dry powder fire inhibiting biochemical composition for treating lignocellulosic-based wood furnish material during the production of fire-protected composite wood products, comprising:
a major amount of sodium tartrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium tartrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

177. An environmentally-clean dry powder fire inhibiting biochemical composition for treating lignocellulosic-based wood furnish material during the production of fire-protected composite wood products, comprising:
a major amount of magnesium tartrate for producing magnesium ions when dissolved in the presence of water;
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium tartrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

178. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

179. An environmentally-clean dry powder fire inhibiting biochemical composition for treating lignocellulosic-based wood furnish material during the production of fire-protected composite wood products, comprising:
a major amount of potassium butyrate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali and magnesium;
wherein when said environmentally-clean dry powder-based fire inhibiting biochemical composition is used to treat lignocellulosic-based wood furnish material during the production of fire-protected composite wood products, said potassium butyrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

180. An environmentally-clean dry powder fire inhibiting biochemical composition for treating lignocellulosic-based wood furnish material during the production of fire-protected composite wood products, comprising:
a major amount of calcium butyrate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium butyrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

181. An environmentally-clean dry powder fire inhibiting biochemical composition for treating lignocellulosic-based wood furnish material during the production of fire-protected composite wood products, comprising:
a major amount of sodium butyrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium butyrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having solid ion inhibitors that are available to inhibit fire ignition, flame spread and smoke development.

182. An environmentally-clean dry powder fire inhibiting biochemical composition for treating lignocellulosic-based wood furnish material during the production of fire-protected composite wood products, comprising:
a major amount of magnesium butyrate for producing magnesium ions when dissolved in the presence of water; and
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium butyrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

183. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic, called malic acid.

184. An improved environmentally-clean dry powder fire inhibiting biochemical composition for treating lignocellulosic-based wood furnish material during the production of fire-protected composite wood products, comprising:
a major amount of potassium malate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali and magnesium;
wherein when said environmentally-clean dry powder-based fire inhibiting biochemical composition is used to treat lignocellulosic-based wood furnish material during the production of fire-protected composite wood products, said potassium malate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

185. An environmentally-clean dry powder fire inhibiting biochemical composition for treating lignocellulosic-based wood furnish material during the production of fire-protected composite wood products, comprising:
a major amount of calcium malate for producing calcium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium malate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

186. An environmentally-clean dry powder fire inhibiting biochemical composition for treating lignocellulosic-based wood furnish material during the production of fire-protected composite wood products, comprising:
a major amount of sodium malate for producing sodium ions when dissolved in the water; and
wherein when said environmentally-clean dry powder-based fire inhibiting biochemical composition is used to treat lignocellulosic-based wood furnish material during the production of fire-protected composite wood products, said sodium malate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

187. An environmentally-clean dry powder fire inhibiting biochemical composition for treating lignocellulosic-based wood furnish material during the production of fire-protected composite wood products, comprising:
a major amount of magnesium malate for producing magnesium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium malate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

188. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C4 Class of Carboxylic Acids having 4 carbon atoms, specifically, the C4 carboxylic acid, called malonic acid.

189. An environmentally-clean dry powder fire inhibiting biochemical composition for treating lignocellulosic-based wood furnish material during the production of fire-protected composite wood products, comprising:
a major amount of potassium malonate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium malonate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

190. An environmentally-clean dry powder fire inhibiting biochemical composition for treating lignocellulosic-based wood furnish material during the production of fire-protected composite wood products, comprising:
a major amount of calcium malonate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium malonate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

191. An environmentally-clean dry powder fire inhibiting biochemical composition for treating lignocellulosic-based wood furnish material during the production of fire-protected composite wood products, comprising:
a major amount of sodium malonate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium malonate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

192. An environmentally-clean dry powder fire inhibiting biochemical composition for treating lignocellulosic-based wood furnish material during the production of fire-protected composite wood products, comprising:
a major amount of di-magnesium malonate for producing magnesium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said magnesium malonate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

193. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

194. An environmentally-clean aqueous-based fire inhibiting biochemical solution for treating lignocellulosic-based wood furnish material during the production of fire-protected composite wood products, comprising:
a major amount of potassium pivalate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium pivalate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

195. An environmentally-clean dry powder fire inhibiting biochemical composition for treating lignocellulosic-based wood furnish material during the production of fire-protected composite wood products, comprising:
a major amount of calcium pivalate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium pivalate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

196. An environmentally-clean dry powder fire inhibiting biochemical composition for treating lignocellulosic-based wood furnish material during the production of fire-protected composite wood products, comprising:
a major amount of sodium pivalate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium pivalate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

197. An environmentally-clean dry powder fire inhibiting biochemical composition for treating lignocellulosic-based wood furnish material during the production of fire-protected composite wood products, comprising:
a major amount of magnesium pivalate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium pivalate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

198. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

199. An environmentally-clean dry powder-based fire inhibiting biochemical composition for treating lignocellulosic-based wood furnish material during the production of fire-protected composite wood products, comprising:
a major amount of potassium caproate for producing potassium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium caproate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

200. An environmentally-clean dry powder fire inhibiting biochemical composition for treating lignocellulosic-based wood furnish material during the production of fire-protected composite wood products, comprising:
a major amount of calcium caproate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium caproate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

201. An environmentally-clean dry powder fire inhibiting biochemical composition for treating lignocellulosic-based wood furnish material during the production of fire-protected composite wood products, comprising:
a major amount of sodium caproate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium caproate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

202. An environmentally-clean dry powder fire inhibiting biochemical composition for treating lignocellulosic-based wood furnish material during the production of fire-protected composite wood products, comprising:
a major amount of magnesium caproate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium caproate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

203. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

204. An environmentally-clean dry powder fire inhibiting biochemical composition for treating lignocellulosic-based wood furnish material during the production of fire-protected composite wood products, comprising:
a major amount of potassium adipate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium adipate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

205. An environmentally-clean dry powder fire inhibiting biochemical composition for treating lignocellulosic-based wood furnish material during the production of fire-protected composite wood products, comprising:
a major amount of calcium adipate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium adipate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

206. An improved environmentally-clean dry powder fire inhibiting biochemical composition for treating lignocellulosic-based wood furnish material during the production of fire-protected composite wood products, comprising:
a major amount of sodium adipate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium adipate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

207. An environmentally-clean dry powder fire inhibiting biochemical composition for treating lignocellulosic-based wood furnish material during the production of fire-protected composite wood products, comprising:
a major amount of magnesium adipate for producing magnesium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium adipate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

208. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C6 Class of Carboxylic Acids having 6 carbon atoms, specifically, the C6 carboxylic acid, called citric acid.

209. An environmentally-clean dry powder fire inhibiting biochemical composition for treating lignocellulosic-based wood furnish material during the production of fire-protected composite wood products, comprising:
a major amount of potassium citrate for producing potassium ions when dissolved in the water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium citrate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

210. An environmentally-clean dry powder fire inhibiting biochemical composition for treating lignocellulosic-based wood furnish material during the production of fire-protected composite wood products, comprising:
a major amount of calcium citrate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium citrate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

211. An environmentally-clean dry powder fire inhibiting biochemical composition for treating lignocellulosic-based wood furnish material during the production of fire-protected composite wood products, comprising:
a major amount of sodium citrate for producing sodium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium citrate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

212. An environmentally-clean dry powder fire inhibiting biochemical composition for treating lignocellulosic-based wood furnish material during the production of fire-protected composite wood products, comprising:
a major amount of magnesium citrate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said magnesium citrate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

213. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C6 Class of Carboxylic Acids having 6 carbon atoms, specifically, the C6 carboxylic acid, d-gluconic acid.

214. An environmentally-clean dry powder fire inhibiting biochemical composition for treating lignocellulosic-based wood furnish material during the production of fire-protected composite wood products, comprising:
a major amount of potassium gluconate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium gluconate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

215. An environmentally-clean dry powder fire inhibiting biochemical composition for treating lignocellulosic-based wood furnish material during the production of fire-protected composite wood products, comprising:
a major amount of calcium gluconate for producing calcium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium gluconate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

216. An environmentally-clean dry powder fire inhibiting biochemical composition for treating lignocellulosic-based wood furnish material during the production of fire-protected composite wood products, comprising:
a major amount of sodium gluconate for producing sodium ions when dissolved in the presence of water;
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said sodium gluconate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

217. An environmentally-clean dry powder fire inhibiting biochemical composition for treating lignocellulosic-based wood furnish material during the production of fire-protected composite wood products, comprising:
a major amount of magnesium gluconate for producing magnesium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and wherein when said environmentally-clean dry powder-based fire inhibiting biochemical composition is used to treat lignocellulosic-based wood furnish material during the production of fire-protected composite wood products, said magnesium gluconate is dissolved in the presence of water, producing magnesium ions in the water which disperse and coalesce in the treated lignocellulosic-based wood furnish material and form magnesium salt crystalline structures in the treated lignocellulosic-based wood furnish material and/or magnesium salt crystalline coatings on the surfaces of treated lignocellulosic-based wood furnish material, thereby providing finished composite wood products having magnesium ion inhibitors that are available to inhibit fire ignition, flame spread and smoke development.

218. An environmentally-clean dry powder fire inhibiting biochemical composition for treating lignocellulosic-based wood furnish material during the production of fire-protected composite wood products, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

219. An environmentally-clean dry powder fire inhibiting biochemical composition for treating lignocellulosic-based wood furnish material during the production of fire-protected composite wood products, comprising:
a major amount of potassium benzoate for producing potassium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said potassium benzoate is dissolved in the presence of water, producing potassium ions in the water which disperse and coalesce in the treated lignocellulosic-based wood furnish material and form potassium salt crystalline structures in the treated lignocellulosic-based wood furnish material and/or potassium salt crystalline coatings on the surfaces of treated lignocellulosic-based wood furnish material, thereby providing finished composite wood products having potassium ion inhibitors that are available to inhibit fire ignition, flame spread and smoke development.

220. An environmentally-clean dry powder fire inhibiting biochemical composition for treating lignocellulosic-based wood furnish material during the production of fire-protected composite wood products, comprising:
a major amount of calcium benzoate for producing calcium ions when dissolved in the presence of water; and
a minor amount of alkali metal salt derived from benzoic acid for producing benzoate ions when dissolved in the presence of water that form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium;
wherein when said environmentally-clean dry powder-based fire inhibiting biochemical composition is used to treat lignocellulosic-based wood furnish material during the production of fire-protected composite wood products, said calcium benzoate is dissolved in the presence of water, producing calcium ions in the water which disperse and coalesce in the treated lignocellulosic-based wood furnish material and form calcium salt crystalline structures in the treated lignocellulosic-based wood furnish material and/or calcium salt crystalline coatings on the surfaces of treated lignocellulosic-based wood furnish material, thereby providing finished composite wood products having calcium ion inhibitors that are available to inhibit fire ignition, flame spread and smoke development.

221. An environmentally-clean dry powder fire inhibiting biochemical composition for treating lignocellulosic-based wood furnish material during the production of fire-protected composite wood products, comprising:
a major amount of sodium benzoate for producing sodium ions when dissolved in the presence of water; and
a minor amount of alkali metal salt derived from benzoic acid for producing benzoate ions when dissolved in the presence of water that form a protective coating on selected metals and/or metallic alloys, wherein the alkali metals from which the alkali metal salts are derived, are selected from group consisting of potassium, sodium, calcium and magnesium; and
wherein when said environmentally-clean dry powder-based fire inhibiting biochemical composition is used to treat lignocellulosic-based wood furnish material during the production of fire-protected composite wood products, said sodium benzoate is dissolved in the presence of water, producing sodium ions in the water which disperse and coalesce in the treated lignocellulosic-based wood furnish material and form sodium salt crystalline structures in the treated lignocellulosic-based wood furnish material and/or sodium salt crystalline coatings on the surfaces of treated lignocellulosic-based wood furnish material, thereby providing finished composite wood products having sodium ion inhibitors that are available to inhibit fire ignition, flame spread and smoke development.

222. An environmentally-clean fire inhibiting biochemical composition for treating pDMI polymeric resin binder material used to bind together lignocellulosic-based wood furnish material during composite wood product manufacturing operations,
(i) a major amount of first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and
(ii) a minor amount of second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys;
(iii) a minor amount of water for reacting/catalyzing with a predetermined amount of pMDI resin binder material during composite wood product manufacturing operations;
wherein said major amount of first alkali metal salt powder particles are mixed with said minor amount of second alkali metal salt powder particles and said minor amount of water for reacting/catalyzing, and blended with a major amount of pMDI-based polymeric resin binder material for biochemical treatment of said pMDI-based polymeric resin binder material, prior to use in binding together lignocellulosic-based wood furnish material used in the production of composite wood products during a composite wood product manufacturing process, whereby after the treated pMDI-based polymeric resin binder material is cured during the composite wood product manufacturing process, each finished composite wood product contains cured pMDI-based polymeric resin binder material, binding together lignocellulosic-based wood furnish material, and supporting said first alkali metal salt powder particles that are freely available to inhibit fire ignition, flame spread and smoke development, and said second alkali metal salt powder particles that are freely available to inhibit metal-corrosion of said selected metals and/or metallic alloys.

223. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

224. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

225. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), selected from the group consisting of: alkali metal salts of nonpolymeric saturated carboxylic acids for inclusion in the biochemical composition comprises: alkali metal salts of formic acid (i.e. methanoic acid); alkali metal salts of carbonic acid (i.e. hydroxymethanoic acid); alkali metal salts of acetic acid (i.e. ethanoic acid); alkali metal salts of glycolic acid (i.e. hydroxyacetic acid); alkali metal salts of glyoxylic acid; alkali metal salts of propionic acid; alkali metal salts of lactic acid; alkali metal salts of glyceric acid; alkali metal salts of tartaric acid, alkali metal salts of malic acid; alkali metal salts of malonic acid; alkali metal salts of caproic acid; alkali metal salts of adipic (hexanedioic) acid; alkali metal salts of citric acid; and alkali metal salts of benzoic acid.

226. An environmentally-clean dry powder fire inhibiting biochemical compositions for treating polymeric resin binder material, including pMDI resin binder material, during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate; sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri)potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

227. An environmentally-clean fire inhibiting biochemical composition for treating polymeric resin binder material used to bind together lignocellulosic-based wood furnish material during the production of fire-protected composite wood products, wherein the fire inhibiting biochemical composition contains alkali metal salts derived from C1 Class of Carboxylic Acids having 1 carbon atom, specifically, the C1 carboxylic acid, called formic acid (i.e. methanoic acid).

228. An environmentally-clean fire inhibiting biochemical composition for treating polymeric resin binder material used to bind together lignocellulosic-based wood furnish material during composite wood product manufacturing operations, comprising:
a major amount of potassium formate in the form of dry powder consisting of potassium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium formate powder particles freely available in said cured polymeric resin binder material to inhibit fire ignition, flame spread and smoke development in the finished composite wood product.

229. An environmentally-clean fire inhibiting biochemical composition for treating polymeric resin binder material used to bind together lignocellulosic-based wood furnish material during composite wood product manufacture, comprising:
a major amount of calcium formate in the form of dry powder consisting of calcium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium formate powder particles freely available in said cured polymeric resin binder material to inhibit fire ignition, flame spread and smoke development in the finished composite wood product.

230. An environmentally-clean fire inhibiting biochemical composition for treating polymeric resin binder material used to bind together lignocellulosic-based wood furnish material during composite wood product manufacture, comprising:
a major amount of sodium formate in the form of dry powder consisting of sodium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium formate powder particles freely available in said cured polymeric resin binder material to inhibit fire ignition, flame spread and smoke development in the finished composite wood product.

231. An environmentally-clean fire inhibiting biochemical composition for treating polymeric resin binder material used to bind together lignocellulosic-based wood furnish material during composite wood product manufacture, comprising:
a major amount of magnesium formate in the form of dry powder consisting of magnesium formate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium formate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium formate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium formate powder particles freely available in said cured polymeric resin binder material to inhibit fire ignition, flame spread and smoke development in the finished composite wood product.

232. An improved environmentally-clean fire inhibiting biochemical composition for treating polymeric resin binder material used to bind together lignocellulosic-based wood furnish material during composite wood product manufacture, wherein each said fire inhibiting biochemical composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

233. An environmentally-clean fire inhibiting biochemical composition for treating polymeric resin binder material used to bind together lignocellulosic-based wood furnish material during composite wood product manufacture, comprising:
a major amount of potassium formate in the form of dry powder consisting of potassium carbonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium carbonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium carbonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium carbonate powder particles freely available in said cured polymeric resin binder material to inhibit fire ignition, flame spread and smoke development in the finished composite wood product.

234. An environmentally-clean fire inhibiting biochemical composition for treating polymeric resin binder material used to bind together lignocellulosic-based wood furnish material during composite wood product manufacture, comprising:
a major amount of sodium formate in the form of dry powder consisting of carbonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium carbonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium carbonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium carbonate powder particles freely available in said cured polymeric resin binder material to inhibit fire ignition, flame spread and smoke development in the finished composite wood product.

235. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

236. An environmentally-clean fire inhibiting biochemical composition for treating polymeric resin binder material used to bind together lignocellulosic-based wood furnish material during composite wood product manufacture, comprising:
a major amount of potassium acetate in the form of dry powder consisting of potassium acetate powder particles;
a minor amount of alkali metal salt in the form of dry powder consisting of alkali metal salt powder particles, mixed and blended with said major amount of potassium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium acetate powder particles freely available in said cured polymeric resin binder material to inhibit fire ignition, flame spread and smoke development in the finished composite wood product.

237. An environmentally-clean fire inhibiting biochemical composition for treating polymeric resin binder material used to bind together lignocellulosic-based wood furnish material during composite wood product manufacture, comprising:
a major amount of calcium acetate in the form of dry powder consisting of calcium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium acetate powder particles freely available in said cured polymeric resin binder material to inhibit fire ignition, flame spread and smoke development in the finished composite wood product.

238. An environmentally-clean fire inhibiting biochemical composition for treating polymeric resin binder material used to bind together lignocellulosic-based wood furnish material during composite wood product manufacture, comprising:
a major amount of sodium acetate in the form of dry powder consisting of sodium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium acetate powder particles freely available in said cured polymeric resin binder material to inhibit fire ignition, flame spread and smoke development in the finished composite wood product.

239. An environmentally-clean fire inhibiting biochemical composition for treating polymeric resin binder material used to bind together lignocellulosic-based wood furnish material during composite wood product manufacture, comprising:
a major amount of magnesium acetate in the form of dry powder consisting of magnesium acetate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium acetate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium acetate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium acetate powder particles freely available in said cured polymeric resin binder material to inhibit fire ignition, flame spread and smoke development in the finished composite wood product.

240. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C2 Class of Carboxylic Acids having 2 carbon atoms, specifically, the C2 carboxylic acid, called glycolic acid (hydroxyacetic acid).

241. An environmentally-clean fire inhibiting biochemical composition for treating polymeric resin binder material used to bind together lignocellulosic-based wood furnish material during composite wood product manufacture, comprising:
a major amount of potassium glycolate in the form of dry powder consisting of glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glycolate powder particles freely available in said cured polymeric resin binder material to inhibit fire ignition, flame spread and smoke development in the finished composite wood product.

242. An environmentally-clean fire inhibiting biochemical composition for treating polymeric resin binder material used to bind together lignocellulosic-based wood furnish material during composite wood product manufacture, comprising:
a major amount of calcium glycolate in the form of dry powder consisting of calcium glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glycolate powder particles freely available in said cured polymeric resin binder material to inhibit fire ignition, flame spread and smoke development in the finished composite wood product.

243. An environmentally-clean fire inhibiting biochemical composition for treating polymeric resin binder material used to bind together lignocellulosic-based wood furnish material during composite wood product manufacture, comprising:
a major amount of sodium glycolate in the form of dry powder consisting of sodium glycolate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glycolate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glycolate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glycolate powder particles freely available in said cured polymeric resin binder material to inhibit fire ignition, flame spread and smoke development in the finished composite wood product.

244. An environmentally-clean fire inhibiting biochemical composition for treating polymeric resin binder material used to bind together lignocellulosic-based wood furnish material during composite wood product manufacture,
wherein said aqueous-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

245. An environmentally-clean fire inhibiting biochemical composition for treating polymeric resin binder material used to bind together lignocellulosic-based wood furnish material during composite wood product manufacture, comprising:
a major amount of potassium glyoxylate in the form of dry powder consisting of potassium glyoxylate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glyoxylate powder particles freely available in said cured polymeric resin binder material to inhibit fire ignition, flame spread and smoke development in the finished composite wood product.

246. An environmentally-clean fire inhibiting biochemical composition for treating polymeric resin binder material used to bind together lignocellulosic-based wood furnish material during composite wood product manufacture, comprising:
a major amount of calcium glyoxylate in the form of dry powder consisting of calcium glyoxylate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glyoxylate powder particles freely available in said cured polymeric resin binder material to inhibit fire ignition, flame spread and smoke development in the finished composite wood product.

247. An environmentally-clean fire inhibiting biochemical composition for treating polymeric resin binder material used to bind together lignocellulosic-based wood furnish material during composite wood product manufacture, comprising:
a major amount of sodium glyoxylate in the form of dry powder consisting of sodium glyoxylate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glyoxylate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glyoxylate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glyoxylate powder particles freely available in said cured polymeric resin binder material to inhibit fire ignition, flame spread and smoke development in the finished composite wood product.

248. Another object of the present invention is to provide new and improved environmentally-clean fire inhibiting biochemical composition for treating polymeric resin binder material used to bind together lignocellulosic-based wood furnish material during composite wood product manufacture, wherein each said liquid fire inhibiting biochemical composition contains alkali metal salts derived from C2 Class of Carboxylic Acids having 2 carbon atoms, specifically, the C2 carboxylic acid, called oxalic acid.

249. An environmentally-clean fire inhibiting biochemical composition for treating polymeric resin binder material used to bind together lignocellulosic-based wood furnish material during composite wood product manufacture, comprising:
a major amount of potassium oxalate in the form of dry powder consisting of potassium oxalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium oxalate powder particles freely available in said cured polymeric resin binder material to inhibit fire ignition, flame spread and smoke development in the finished composite wood product.

250. An environmentally-clean fire inhibiting biochemical composition for treating polymeric resin binder material used to bind together lignocellulosic-based wood furnish material during composite wood product manufacture, comprising:
a major amount of calcium oxalate in the form of dry powder consisting of calcium oxalate powder particles;
a minor amount of alkali metal salt in the form of dry powder consisting of alkali metal salt powder particles, mixed and blended with said major amount of calcium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium oxalate powder particles freely available in said cured polymeric resin binder material to inhibit fire ignition, flame spread and smoke development in the finished composite wood product.

251. An environmentally-clean fire inhibiting biochemical composition for treating polymeric resin binder material used to bind together lignocellulosic-based wood furnish material during composite wood product manufacture, comprising:
a major amount of sodium oxalate in the form of dry powder consisting of sodium oxalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium oxalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium oxalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium oxalate powder particles freely available in said cured polymeric resin binder material to inhibit fire ignition, flame spread and smoke development in the finished composite wood product.

252. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04).

253. An environmentally-clean fire inhibiting biochemical composition for treating polymeric resin binder material used to bind together lignocellulosic-based wood furnish material during composite wood product manufacture, comprising:
a major amount of potassium propionate in the form of dry powder consisting of potassium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium propionate powder particles freely available in said cured polymeric resin binder material to inhibit fire ignition, flame spread and smoke development in the finished composite wood product.

254. An environmentally-clean fire inhibiting biochemical composition for treating polymeric resin binder material used to bind together lignocellulosic-based wood furnish material during composite wood product manufacture, comprising:
a major amount of calcium propionate in the form of dry powder consisting of calcium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium propionate powder particles freely available in said cured polymeric resin binder material to inhibit fire ignition, flame spread and smoke development in the finished composite wood product.

255. An environmentally-clean fire inhibiting biochemical composition for treating polymeric resin binder material used to bind together lignocellulosic-based wood furnish material during composite wood product manufacture, comprising:
a major amount of sodium propionate in the form of dry powder consisting of sodium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium propionate powder particles freely available in said cured polymeric resin binder material to inhibit fire ignition, flame spread and smoke development in the finished composite wood product.

256. An environmentally-clean fire inhibiting biochemical composition for treating polymeric resin binder material used to bind together lignocellulosic-based wood furnish material during composite wood product manufacture, comprising:
a major amount of magnesium propionate in the form of dry powder consisting of magnesium propionate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium propionate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium propionate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium propionate powder particles freely available in said cured polymeric resin binder material to inhibit fire ignition, flame spread and smoke development in the finished composite wood product.

257. An environmentally-clean fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C3 Class of Carboxylic Acids having 3 carbon atoms, specifically, the C3 carboxylic acid, called lactic acid.

258. An environmentally-clean fire inhibiting biochemical composition for treating polymeric resin binder material used to bind together lignocellulosic-based wood furnish material during composite wood product manufacture, comprising:
a major amount of potassium lactate in the form of dry powder consisting of potassium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium lactate powder particles freely available in said cured polymeric resin binder material to inhibit fire ignition, flame spread and smoke development in the finished composite wood product.

259. An environmentally-clean fire inhibiting biochemical composition for treating polymeric resin binder material used to bind together lignocellulosic-based wood furnish material during composite wood product manufacture, comprising:
a major amount of calcium lactate in the form of dry powder consisting of calcium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium lactate powder particles freely available in said cured polymeric resin binder material to inhibit fire ignition, flame spread and smoke development in the finished composite wood product.

260. An environmentally-clean fire inhibiting composition for treating polymeric resin binder material used to bind together lignocellulosic-based wood furnish material during composite wood product manufacture, comprising:
a major amount of sodium lactate in the form of dry powder consisting of sodium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium lactate powder particles freely available in said cured polymeric resin binder material to inhibit fire ignition, flame spread and smoke development in the finished composite wood product.

261. An environmentally-clean fire inhibiting biochemical composition for treating polymeric resin binder material used to bind together lignocellulosic-based wood furnish material during composite wood product manufacture, comprising:
a major amount of magnesium lactate in the form of dry powder consisting of magnesium lactate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium lactate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium lactate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium lactate powder particles freely available in said cured polymeric resin binder material to inhibit fire ignition, flame spread and smoke development in the finished composite wood product.

262. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).
Another object of the present invention is to provide new and improved environmentally-clean fire inhibiting biochemical composition for treating polymeric resin binder material used to bind together lignocellulosic-based wood furnish material during composite wood product manufacture, comprising:
a major amount of potassium glycerate in the form of dry powder consisting of potassium glycerate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium glycerate powder particles freely available in said cured polymeric resin binder material to inhibit fire ignition, flame spread and smoke development in the finished composite wood product.

263. An environmentally-clean fire inhibitor solution for treating polymeric resin binder material used to bind together lignocellulosic-based wood furnish material during composite wood product manufacture, comprising:
a major amount of calcium glycerate in the form of dry powder consisting of calcium glycerate powder particles;
a minor amount of alkali metal salt in the form of dry powder consisting of alkali metal salt powder particles, mixed and blended with said major amount of calcium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium glycerate powder particles freely available in said cured polymeric resin binder material to inhibit fire ignition, flame spread and smoke development in the finished composite wood product.

264. An environmentally-clean fire inhibiting biochemical composition for treating polymeric resin binder material used to bind together lignocellulosic-based wood furnish material during composite wood product manufacture, comprising:
a major amount of sodium glycerate in the form of dry powder consisting of sodium glycerate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium glycerate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium glycerate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium glycerate powder particles freely available in said cured polymeric resin binder material to inhibit fire ignition, flame spread and smoke development in the finished composite wood product.

265. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

266. An environmentally-clean fire inhibiting biochemical composition for treating polymeric resin binder material used to bind together lignocellulosic-based wood furnish material during composite wood product manufacture, comprising:
a major amount of potassium pyruvate in the form of dry powder consisting of potassium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium pyruvate powder particles freely available in said cured polymeric resin binder material to inhibit fire ignition, flame spread and smoke development in the finished composite wood product.

267. An environmentally-clean fire inhibiting biochemical solution for treating polymeric resin binder material used to bind together lignocellulosic-based wood furnish material during composite wood product manufacture, comprising:
a major amount of calcium pyruvate in the form of dry powder consisting of calcium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium pyruvate powder particles freely available in said cured polymeric resin binder material to inhibit fire ignition, flame spread and smoke development in the finished composite wood product.

268. An environmentally-clean fire inhibiting biochemical composition for treating polymeric resin binder material used to bind together lignocellulosic-based wood furnish material during composite wood product manufacture, comprising:
a major amount of sodium pyruvate in the form of dry powder consisting of sodium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium pyruvate powder particles freely available in said cured polymeric resin binder material to inhibit fire ignition, flame spread and smoke development in the finished composite wood product.

269. An environmentally-clean fire inhibiting biochemical composition for treating polymeric resin binder material used to bind together lignocellulosic-based wood furnish material during composite wood product manufacture, comprising:
a major amount of magnesium pyruvate in the form of dry powder consisting of magnesium pyruvate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium pyruvate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium pyruvate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium pyruvate powder particles freely available in said cured polymeric resin binder material to inhibit fire ignition, flame spread and smoke development in the finished composite wood product.

270. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).
An environmentally-clean fire inhibiting biochemical composition for treating polymeric resin binder material used to bind together lignocellulosic-based wood furnish material during composite wood product manufacture, comprising:
a major amount of potassium tartrate in the form of dry powder consisting of potassium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium tartrate powder particles freely available in said cured polymeric resin binder material to inhibit fire ignition, flame spread and smoke development in the finished composite wood product.

271. An environmentally-clean fire inhibiting biochemical composition for treating polymeric resin binder material used to bind together lignocellulosic-based wood furnish material during composite wood product manufacture, comprising:
a major amount of calcium tartrate in the form of dry powder consisting of calcium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium tartrate powder particles freely available in said cured polymeric resin binder material to inhibit fire ignition, flame spread and smoke development in the finished composite wood product.

272. An environmentally-clean fire inhibiting biochemical composition for treating polymeric resin binder material used to bind together lignocellulosic-based wood furnish material during composite wood product manufacture, comprising:
a major amount of sodium tartrate in the form of dry powder consisting of sodium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium tartrate powder particles freely available in said cured polymeric resin binder material to inhibit fire ignition, flame spread and smoke development in the finished composite wood product.

273. An environmentally-clean fire inhibiting biochemical composition for treating polymeric resin binder material used to bind together lignocellulosic-based wood furnish material during composite wood product manufacture, comprising:
a major amount of magnesium tartrate in the form of dry powder consisting of magnesium tartrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium tartrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium tartrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium tartrate powder particles freely available in said cured polymeric resin binder material to inhibit fire ignition, flame spread and smoke development in the finished composite wood product.

274. An environmentally-clean fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

275. An environmentally-clean fire inhibiting biochemical composition for treating polymeric resin binder material used to bind together lignocellulosic-based wood furnish material during composite wood product manufacture, comprising:
a major amount of potassium butyrate in the form of dry powder consisting of potassium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium butyrate powder particles freely available in said cured polymeric resin binder material to inhibit fire ignition, flame spread and smoke development in the finished composite wood product.

276. An environmentally-clean fire inhibiting biochemical composition for treating polymeric resin binder material used to bind together lignocellulosic-based wood furnish material during composite wood product manufacture, comprising:
a major amount of calcium butyrate in the form of dry powder consisting of calcium butyrate powder particles;
a minor amount of alkali metal salt in the form of dry powder consisting of alkali metal salt powder particles, mixed and blended with said major amount of calcium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium butyrate powder particles freely available in said cured polymeric resin binder material to inhibit fire ignition, flame spread and smoke development in the finished composite wood product.

277. An environmentally-clean fire inhibiting biochemical composition for treating polymeric resin binder material used to bind together lignocellulosic-based wood furnish material during composite wood product manufacture, comprising:
a major amount of sodium butyrate in the form of dry powder consisting of sodium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium butyrate powder particles freely available in said cured polymeric resin binder material to inhibit fire ignition, flame spread and smoke development in the finished composite wood product.

278. An environmentally-clean fire inhibiting biochemical composition for treating polymeric resin binder material used to bind together lignocellulosic-based wood furnish material during composite wood product manufacture, comprising:
a major amount of magnesium butyrate in the form of dry powder consisting of magnesium butyrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium butyrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium butyrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium butyrate powder particles freely available in said cured polymeric resin binder material to inhibit fire ignition, flame spread and smoke development in the finished composite wood product.

279. An environmentally-clean fire inhibiting biochemical composition for treating lignocellulosic-based wood furnish material during the production of fire-protected composite wood products, wherein said fire inhibiting biochemical composition contains alkali metal salts derived from C4 Class of Carboxylic Acids having 4 carbon atoms, specifically, the C4 carboxylic, called malic acid. An environmentally-clean fire inhibiting biochemical composition for treating polymeric resin binder material used to bind together lignocellulosic-based wood furnish material during composite wood product manufacture, comprising:
a major amount of potassium malate in the form of dry powder consisting of potassium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium malate powder particles freely available in said cured polymeric resin binder material to inhibit fire ignition, flame spread and smoke development in the finished composite wood product.

280. An environmentally-clean fire inhibiting biochemical composition for treating polymeric resin binder material used to bind together lignocellulosic-based wood furnish material during composite wood product manufacture, comprising:
a major amount of calcium malate in the form of dry powder consisting of calcium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium malate powder particles freely available in said cured polymeric resin binder material to inhibit fire ignition, flame spread and smoke development in the finished composite wood product.

281. An environmentally-clean fire inhibiting biochemical composition for treating polymeric resin binder material used to bind together lignocellulosic-based wood furnish material during composite wood product manufacture, comprising:
a major amount of sodium malate in the form of dry powder consisting of sodium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium malate powder particles freely available in said cured polymeric resin binder material to inhibit fire ignition, flame spread and smoke development in the finished composite wood product.

282. An environmentally-clean fire inhibiting biochemical composition for treating polymeric resin binder material used to bind together lignocellulosic-based wood furnish material during composite wood product manufacture, comprising:
a major amount of magnesium malate in the form of dry powder consisting of magnesium malate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium malate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium malate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium malate powder particles freely available in said cured polymeric resin binder material to inhibit fire ignition, flame spread and smoke development in the finished composite wood product.

283. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C4 Class of Carboxylic Acids having 4 carbon atoms, specifically, the C4 carboxylic acid, called malonic acid.

284. An environmentally-clean fire inhibiting biochemical composition for treating polymeric resin binder material used to bind together lignocellulosic-based wood furnish material during composite wood product manufacture, comprising:
a major amount of potassium malonate in the form of dry powder consisting of potassium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium malonate powder particles freely available in said cured polymeric resin binder material to inhibit fire ignition, flame spread and smoke development in the finished composite wood product.

285. An environmentally-clean fire inhibiting biochemical composition for treating polymeric resin binder material used to bind together lignocellulosic-based wood furnish material during composite wood product manufacture, comprising:
a major amount of calcium malonate in the form of dry powder consisting of calcium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium malonate powder particles freely available in said cured polymeric resin binder material to inhibit fire ignition, flame spread and smoke development in the finished composite wood product.

286. An environmentally-clean fire inhibiting biochemical composition for treating polymeric resin binder material used to bind together lignocellulosic-based wood furnish material during composite wood product manufacture, comprising:
a major amount of sodium malonate in the form of dry powder consisting of sodium malonate powder particles;
a minor amount of alkali metal salt in the form of dry powder consisting of alkali metal salt powder particles, mixed and blended with said major amount of sodium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium malonate powder particles freely available in said cured polymeric resin binder material to inhibit fire ignition, flame spread and smoke development in the finished composite wood product.

287. An environmentally-clean fire inhibiting biochemical composition for treating polymeric resin binder material used to bind together lignocellulosic-based wood furnish material during composite wood product manufacture, comprising:
a major amount of (di) magnesium malonate in the form of dry powder consisting of magnesium malonate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium malonate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium malonate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium malonate powder particles freely available in said cured polymeric resin binder material to inhibit fire ignition, flame spread and smoke development in the finished composite wood product.

288. An environmentally-clean aqueous-based fire inhibiting biochemical composition for treating polymeric resin binder material used to bind together lignocellulosic-based wood furnish material during composite wood product manufacture, wherein said fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

289. An environmentally-clean fire inhibiting biochemical composition for treating polymeric resin binder material used to bind together lignocellulosic-based wood furnish material during composite wood product manufacture, comprising:
a major amount of potassium pivalate in the form of dry powder consisting of potassium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium pivalate powder particles freely available in said cured polymeric resin binder material to inhibit fire ignition, flame spread and smoke development in the finished composite wood product.

290. An environmentally-clean fire inhibiting biochemical composition for treating polymeric resin binder material used to bind together lignocellulosic-based wood furnish material during composite wood product manufacture, comprising:
a major amount of calcium pivalate in the form of dry powder consisting of calcium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium pivalate powder particles freely available in said cured polymeric resin binder material to inhibit fire ignition, flame spread and smoke development in the finished composite wood product.

291. An environmentally-clean fire inhibiting biochemical composition for treating polymeric resin binder material used to bind together lignocellulosic-based wood furnish material during composite wood product manufacture, comprising:
a major amount of sodium pivalate in the form of dry powder consisting of sodium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium pivalate powder particles freely available in said cured polymeric resin binder material to inhibit fire ignition, flame spread and smoke development in the finished composite wood product.

292. An environmentally-clean fire inhibiting biochemical composition for treating polymeric resin binder material used to bind together lignocellulosic-based wood furnish material during composite wood product manufacture, comprising:
a major amount of magnesium pivalate in the form of dry powder consisting of magnesium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium pivalate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium pivalate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium pivalate powder particles freely available in said cured polymeric resin binder material to inhibit fire ignition, flame spread and smoke development in the finished composite wood product.

293. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, called caproic acid (hexanoic acid).

294. An environmentally-clean fire inhibiting biochemical composition for treating polymeric resin binder material used to bind together lignocellulosic-based wood furnish material during composite wood product manufacture, comprising:
a major amount of potassium caproate in the form of dry powder consisting of potassium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium caproate powder particles freely available in said cured polymeric resin binder material to inhibit fire ignition, flame spread and smoke development in the finished composite wood product.

295. An environmentally-clean fire inhibiting biochemical composition for treating polymeric resin binder material used to bind together lignocellulosic-based wood furnish material during composite wood product manufacture, comprising:
a major amount of calcium caproate in the form of dry powder consisting of calcium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium caproate powder particles freely available in said cured polymeric resin binder material to inhibit fire ignition, flame spread and smoke development in the finished composite wood product.

296. An environmentally-clean fire inhibiting biochemical composition for treating polymeric resin binder material used to bind together lignocellulosic-based wood furnish material during composite wood product manufacture, comprising:
a major amount of sodium caproate in the form of dry powder consisting of sodium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium caproate powder particles freely available in said cured polymeric resin binder material to inhibit fire ignition, flame spread and smoke development in the finished composite wood product.

297. An environmentally-clean fire inhibiting biochemical composition for treating polymeric resin binder material used to bind together lignocellulosic-based wood furnish material during composite wood product manufacture, comprising:
a major amount of magnesium caproate in the form of dry powder consisting of magnesium pivalate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium caproate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium caproate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium caproate powder particles freely available in said cured polymeric resin binder material to inhibit fire ignition, flame spread and smoke development in the finished composite wood product.

298. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, called adipic (hexanedioic) acid.

299. An environmentally-clean fire inhibiting biochemical solution for treating polymeric resin binder material used to bind together lignocellulosic-based wood furnish material during composite wood product manufacture, comprising:
a major amount of potassium adipate in the form of dry powder consisting of potassium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium adipate powder particles freely available in said cured polymeric resin binder material to inhibit fire ignition, flame spread and smoke development in the finished composite wood product.

300. An environmentally-clean fire inhibiting biochemical composition for treating polymeric resin binder material used to bind together lignocellulosic-based wood furnish material during composite wood product manufacture, comprising:
a major amount of calcium adipate in the form of dry powder consisting of calcium adipate powder particles;
a minor amount of alkali metal salt in the form of dry powder consisting of alkali metal salt powder particles, mixed and blended with said major amount of calcium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium adipate powder particles freely available in said cured polymeric resin binder material to inhibit fire ignition, flame spread and smoke development in the finished composite wood product.

301. An environmentally-clean fire inhibiting biochemical composition for treating polymeric resin binder material used to bind together lignocellulosic-based wood furnish material during composite wood product manufacture, comprising:
a major amount of sodium adipate in the form of dry powder consisting of sodium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium adipate powder particles freely available in said cured polymeric resin binder material to inhibit fire ignition, flame spread and smoke development in the finished composite wood product.

302. An environmentally-clean fire inhibiting biochemical composition for treating polymeric resin binder material used to bind together lignocellulosic-based wood furnish material during composite wood product manufacture, comprising:
a major amount of magnesium adipate in the form of dry powder consisting of magnesium adipate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium adipate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium adipate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium adipate powder particles freely available in said cured polymeric resin binder material to inhibit fire ignition, flame spread and smoke development in the finished composite wood product.

303. An environmentally-clean fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C6 Class of Carboxylic Acids having 6 carbon atoms, specifically, the C6 carboxylic acid, called citric acid.

304. An environmentally-clean fire inhibiting biochemical composition for treating polymeric resin binder material used to bind together lignocellulosic-based wood furnish material during composite wood product manufacture, comprising:
a major amount of potassium citrate in the form of dry powder consisting of potassium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium citrate powder particles freely available in said cured polymeric resin binder material to inhibit fire ignition, flame spread and smoke development in the finished composite wood product.

305. An environmentally-clean fire inhibiting biochemical composition for treating polymeric resin binder material used to bind together lignocellulosic-based wood furnish material during composite wood product manufacture, comprising:
a major amount of calcium citrate in the form of dry powder consisting of calcium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium citrate powder particles freely available in said cured polymeric resin binder material to inhibit fire ignition, flame spread and smoke development in the finished composite wood product.

306. An environmentally-clean fire inhibiting biochemical composition for treating polymeric resin binder material used to bind together lignocellulosic-based wood furnish material during composite wood product manufacture, comprising:
a major amount of sodium citrate in the form of dry powder consisting of sodium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium citrate powder particles freely available in said cured polymeric resin binder material to inhibit fire ignition, flame spread and smoke development in the finished composite wood product.

307. An environmentally-clean fire inhibiting biochemical composition for treating polymeric resin binder material used to bind together lignocellulosic-based wood furnish material during composite wood product manufacture, comprising:
a major amount of magnesium citrate in the form of dry powder consisting of magnesium citrate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium citrate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium citrate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium citrate powder particles freely available in said cured polymeric resin binder material to inhibit fire ignition, flame spread and smoke development in the finished composite wood product.

308. An environmentally-clean fire inhibiting biochemical composition for treating polymeric resin binder material used to bind together lignocellulosic-based wood furnish material during composite wood product manufacture, wherein said fire inhibiting biochemical composition contains alkali metal salts derived from C6 Class of Carboxylic Acids having 6 carbon atoms, specifically, the C6 carboxylic acid, d-gluconic acid.

309. An environmentally-clean fire inhibiting biochemical composition for treating polymeric resin binder material used to bind together lignocellulosic-based wood furnish material during composite wood product manufacture, comprising:
a major amount of potassium gluconate in the form of dry powder consisting of potassium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of potassium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium gluconate powder particles freely available in said cured polymeric resin binder material to inhibit fire ignition, flame spread and smoke development in the finished composite wood product.

310. An environmentally-clean fire inhibiting biochemical composition for treating polymeric resin binder material used to bind together lignocellulosic-based wood furnish material during composite wood product manufacture, comprising:
a major amount of calcium gluconate in the form of dry powder consisting of calcium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium gluconate powder particles freely available in said cured polymeric resin binder material to inhibit fire ignition, flame spread and smoke development in the finished composite wood product.

311. An environmentally-clean fire inhibiting biochemical composition for treating polymeric resin binder material used to bind together lignocellulosic-based wood furnish material during composite wood product manufacture, comprising:
a major amount of sodium gluconate in the form of dry powder consisting of sodium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium gluconate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the calcium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium gluconate powder particles freely available in said cured polymeric resin binder material to inhibit fire ignition, flame spread and smoke development in the finished composite wood product.

312. An environmentally-clean fire inhibiting biochemical composition for treating polymeric resin binder material used to bind together lignocellulosic-based wood furnish material during composite wood product manufacture, comprising:
a major amount of magnesium gluconate in the form of dry powder consisting of magnesium gluconate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium gluconate and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium gluconate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium gluconate powder particles freely available in said cured polymeric resin binder material to inhibit fire ignition, flame spread and smoke development in the finished composite wood product.

313. An environmentally-clean fire inhibiting biochemical composition for treating polymeric resin binder material used to bind together lignocellulosic-based wood furnish material during composite wood product manufacture, wherein said aqueous-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

314. An environmentally-clean fire inhibiting biochemical composition for treating polymeric resin binder material used to bind together lignocellulosic-based wood furnish material during composite wood product manufacture, comprising:
a major amount of potassium benzoate in the form of dry powder consisting of potassium benzoate powder particles;
a minor amount of alkali metal salt in the form of dry powder consisting of alkali metal salt powder particles, mixed and blended with said major amount of potassium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of potassium benzoate powder particles freely available in said cured polymeric resin binder material to inhibit fire ignition, flame spread and smoke development in the finished composite wood product.

315. An environmentally-clean fire inhibiting biochemical composition for treating polymeric resin binder material used to bind together lignocellulosic-based wood furnish material during composite wood product manufacture, comprising:
a major amount of calcium benzoate in the form of dry powder consisting of calcium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of calcium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the potassium powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of calcium benzoate powder particles freely available in said cured polymeric resin binder material to inhibit fire ignition, flame spread and smoke development in the finished composite wood product.

316. An environmentally-clean fire inhibiting biochemical composition for treating polymeric resin binder material used to bind together lignocellulosic-based wood furnish material during composite wood product manufacture, comprising:
a major amount of sodium benzoate in the form of dry powder consisting of sodium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of sodium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the sodium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of sodium benzoate powder particles freely available in said cured polymeric resin binder material to inhibit fire ignition, flame spread and smoke development in the finished composite wood product.

317. An environmentally-clean fire inhibiting biochemical composition for treating polymeric resin binder material used to bind together lignocellulosic-based wood furnish material during composite wood product manufacture, comprising:
a major amount of magnesium benzoate in the form of dry powder consisting of magnesium benzoate powder particles;
a minor amount of water for reacting/catalyzing with a predetermined amount of pMDI resin binder material during composite wood product manufacturing operations; and
a minor amount of alkali metal salt in the form of dry powder consisting of alkali metal salt powder particles, mixed and blended with said major amount of magnesium benzoate, and derived from benzoic acid for producing benzoate ions when dissolved in the presence of water so to form a protective coating on the surface of selected metals and/or metallic alloys that protects against corrosion of said selected metals and/or metallic alloys, wherein the alkali metals from which the alkali metal salts are derived, are selected from group consisting of potassium, sodium, calcium and magnesium; and
wherein as water molecules in said environmentally-clean fire inhibiting biochemical composition react with the polymeric resin binder material and/or evaporate to the environment during composite wood product manufacture operations, the magnesium benzoate powder particles are well dispersed in the polymeric resin binder material that has been treated by said environmentally-clean fire inhibiting biochemical composition and cured during said composite wood product manufacture operations, thereby producing cured polymeric resin binder material that binds together lignocellulosic-based wood furnish material after completion of the composite wood product manufacturing operations, with a sufficient amount of magnesium benzoate powder particles freely available in said cured polymeric resin binder material to inhibit fire ignition, flame spread and smoke development in the finished composite wood product.

318. An environmentally-clean dry-powder-based fire inhibiting biochemical composition for treating polymeric resin binder material used to bind together lignocellulosic-based wood furnish material during the production of fire-protected composite wood products, comprising:
a major amount of alkali metal salt in dry powder form consisting of alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium;
wherein said alkali metal salt powder particles are in dry powder form adapted for blending with a major amount of polymeric resin binder material, that is capable of binding lignocellulosic-based wood furnish material when cured during composite wood product manufacture; and
wherein when said polymeric resin binder material is cured to bind said lignocellulosic-based wood furnish material during composite wood product manufacture, the alkali metal salt powder particles are well dispersed within the cured polymeric resin binder material, and available to inhibit fire ignition, flame spread and smoke development.

319. An environmentally-clean dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), selected from the group consisting of formic acid (i.e. methanoic acid); carbonic acid (i.e. hydroxymethanoic acid);
acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

320. An environmentally-clean dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid, (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

321. An environmentally-clean dry-powder-based fire inhibiting biochemical composition for treating polymeric resin binder material used to bind together lignocellulosic-based wood furnish material during the production of fire-protected composite wood products, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate), calcium tartrate; sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri)potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

322. An environmentally-clean dry-powder-based fire inhibiting biochemical composition for treating polymeric resin binder material used to bind together lignocellulosic-based wood furnish material during the production of fire-protected composite wood products, wherein the dry powder fire inhibiting biochemical composition contains alkali metal salts derived from C1 Class of Carboxylic Acids having 1 carbon atom, specifically, the C1 carboxylic acid, called formic acid (i.e. methanoic acid).

323. An environmentally-clean dry powder-based fire inhibiting biochemical composition for treating polymeric resin binder material used to bind together lignocellulosic-based wood furnish material during composite wood product manufacture, comprising:
a minor amount of potassium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium formate powder particles are well dispersed within the cured polymeric resin binder material, and available to inhibit fire ignition, flame spread and smoke development.

324. An environmentally-clean dry powder-based fire inhibiting biochemical composition for treating polymeric resin binder material used to bind together lignocellulosic-based wood furnish material during composite wood product manufacture, comprising:
a minor amount of calcium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium formate powder particles are well dispersed within the cured polymeric resin binder material, and available to inhibit fire ignition, flame spread and smoke development.

325. An environmentally-clean dry powder-based fire inhibiting biochemical composition
a minor amount of sodium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium formate powder particles are well dispersed within the cured polymeric resin binder material, and available to inhibit fire ignition, flame spread and smoke development.

326. An environmentally-clean dry powder-based fire inhibiting biochemical composition for treating polymeric resin binder material used to bind together lignocellulosic-based wood furnish material during composite wood product manufacture, comprising:
a minor amount of magnesium formate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium formate powder particles are well dispersed within the cured polymeric resin binder material, and available to inhibit fire ignition, flame spread and smoke development.

327. An environmentally-clean dry powder-based fire inhibiting biochemical composition for treating polymeric resin binder material used to bind together lignocellulosic-based wood furnish material during composite wood product manufacture, wherein each said dry-powder fire inhibitor composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9):

328. An environmentally-clean dry powder-based fire inhibiting biochemical composition for treating polymeric resin binder material used to bind together lignocellulosic-based wood furnish material during composite wood product manufacture, comprising:
a minor amount of potassium carbonate (bicarbonate) in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium carbonate powder particles are well dispersed within the cured polymeric resin binder material, and available to inhibit fire ignition, flame spread and smoke development.

329. An environmentally-clean dry powder-based fire inhibiting biochemical composition for treating polymeric resin binder material used to bind together lignocellulosic-based wood furnish material during composite wood product manufacture, comprising:
a minor amount of sodium (bi) carbonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium (bi) carbonate powder particles are well dispersed within the cured polymeric resin binder material, and available to inhibit fire ignition, flame spread and smoke development.

330. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

331. An environmentally-clean dry powder-based fire inhibiting biochemical composition for treating polymeric resin binder material used to bind together lignocellulosic-based wood furnish material during composite wood product manufacture, comprising:
a minor amount of potassium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium acetate powder particles are well dispersed within the cured polymeric resin binder material, and available to inhibit fire ignition, flame spread and smoke development.

332. An environmentally-clean dry powder-based fire inhibiting biochemical composition for treating polymeric resin binder material used to bind together lignocellulosic-based wood furnish material during composite wood product manufacture, comprising:
a minor amount of calcium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium acetate powder particles are well dispersed within the cured polymeric resin binder material, and available to inhibit fire ignition, flame spread and smoke development.

333. An environmentally-clean dry powder-based fire inhibiting biochemical composition
a minor amount of sodium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium acetate powder particles are well dispersed within the cured polymeric resin binder material, and available to inhibit fire ignition, flame spread and smoke development.

334. An environmentally-clean dry powder-based fire inhibiting biochemical composition for treating polymeric resin binder material used to bind together lignocellulosic-based wood furnish material during composite wood product manufacture, comprising:
a minor amount of magnesium acetate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium acetate powder particles are well dispersed within the cured polymeric resin binder material, and available to inhibit fire ignition, flame spread and smoke development.

335. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glycolic acid (hydroxyacetic acid).

336. An environmentally-clean dry powder-based fire inhibiting biochemical composition
a minor amount of potassium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycolate powder particles are well dispersed within the cured polymeric resin binder material, and available to inhibit fire ignition, flame spread and smoke development.

337. An environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycolate powder particles are well dispersed within the cured polymeric resin binder material, and available to inhibit fire ignition, flame spread and smoke development.

338. An environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glycolate powder particles are well dispersed within the cured polymeric resin binder material, and available to inhibit fire ignition, flame spread and smoke development.

339. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

340. An environmentally-clean dry powder-based fire inhibiting biochemical composition for treating polymeric resin binder material used to bind together lignocellulosic-based wood furnish material during composite wood product manufacture, comprising:
a minor amount of potassium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycolate powder particles are well dispersed within the cured polymeric resin binder material, and available to inhibit fire ignition, flame spread and smoke development.

341. An environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycolate powder particles are well dispersed within the cured polymeric resin binder material, and available to inhibit fire ignition, flame spread and smoke development.

342. An environmentally-clean dry powder-based fire inhibiting biochemical composition for treating polymeric resin binder material used to bind together lignocellulosic-based wood furnish material during composite wood product manufacture, comprising:
a minor amount of sodium glyoxylate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glyoxylate powder particles are well dispersed within the cured polymeric resin binder material, and available to inhibit fire ignition, flame spread and smoke development.

343. An environmentally-clean dry powder-based fire inhibiting biochemical composition for treating polymeric resin binder material used to bind together lignocellulosic-based wood furnish material during composite wood product manufacture, wherein each said dry-powder fire inhibiting composition contains alkali metal salts derived from C2 Class of Carboxylic Acids having 2 carbon atoms, specifically, the C2 carboxylic acid, called oxalic acid.
An environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium oxalate powder particles are well dispersed within the cured polymeric resin binder material, and available to inhibit fire ignition, flame spread and smoke development.

344. An environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium oxalate powder particles are well dispersed within the cured polymeric resin binder material, and available to inhibit fire ignition, flame spread and smoke development.

345. An environmentally-clean dry powder-based fire inhibiting biochemical composition for treating polymeric resin binder material used to bind together lignocellulosic-based wood furnish material during composite wood product manufacture, comprising:
a minor amount of sodium oxalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium oxalate powder particles are well dispersed within the cured polymeric resin binder material, and available to inhibit fire ignition, flame spread and smoke development.

346. An environmentally-clean dry powder-based fire inhibiting biochemical composition wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04).

347. An environmentally-clean dry powder-based fire inhibiting biochemical composition for treating polymeric resin binder material used to bind together lignocellulosic-based wood furnish material during composite wood product manufacture, comprising:
a minor amount of potassium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium propionate powder particles are well dispersed within the cured polymeric resin binder material, and available to inhibit fire ignition, flame spread and smoke development.

348. An environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium propionate powder particles are well dispersed within the cured polymeric resin binder material, and available to inhibit fire ignition, flame spread and smoke

349. An environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium propionate powder particles are well dispersed within the cured polymeric resin binder material, and available to inhibit fire ignition, flame spread and smoke development.

350. An environmentally-clean dry powder-based fire inhibiting biochemical composition for treating polymeric resin binder material used to bind together lignocellulosic-based wood furnish material during composite wood product manufacture, comprising:
a minor amount of magnesium propionate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium propionate powder particles are well dispersed within the cured polymeric resin binder material, and available to inhibit fire ignition, flame spread and smoke development.

351. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

352. An environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium lactate powder particles are well dispersed within the cured polymeric resin binder material, and available to inhibit fire ignition, flame spread and smoke development.

353. An environmentally-clean dry powder-based fire inhibiting biochemical composition for treating polymeric resin binder material used to bind together lignocellulosic-based wood furnish material during composite wood product manufacture, comprising:
a minor amount of calcium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium lactate powder particles are well dispersed within the cured polymeric resin binder material, and available to inhibit fire ignition, flame spread and smoke development.

354. An environmentally-clean dry powder-based fire inhibiting biochemical composition
a minor amount of sodium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium lactate powder particles are well dispersed within the cured polymeric resin binder material, and available to inhibit fire ignition, flame spread and smoke development.

355. An environmentally-clean dry powder-based fire inhibiting biochemical composition for treating polymeric resin binder material used to bind together lignocellulosic-based wood furnish material during composite wood product manufacture, comprising:
a minor amount of magnesium lactate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium lactate powder particles are well dispersed within the cured polymeric resin binder material, and available to inhibit fire ignition, flame spread and smoke development.

356. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

357. An environmentally-clean dry powder-based fire inhibiting biochemical composition
minor amount of potassium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium glycerate powder particles are well dispersed within the cured polymeric resin binder material, and available to inhibit fire ignition, flame spread and smoke development.

358. An environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium glycerate powder particles are well dispersed within the cured polymeric resin binder material, and available to inhibit fire ignition, flame spread and smoke development.

359. An environmentally-clean dry powder-based fire inhibiting biochemical composition for treating polymeric resin binder material used to bind together lignocellulosic-based wood furnish material during composite wood product manufacture, comprising:
a minor amount of sodium glycerate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium glycerate powder particles are well dispersed within the cured polymeric resin binder material, and available to inhibit fire ignition, flame spread and smoke development.

360. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

361. An environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium pyruvate powder particles are well dispersed within the cured polymeric resin binder material, and available to inhibit fire ignition, flame spread and smoke development.

362. An environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium pyruvate powder particles are well dispersed within the cured polymeric resin binder material, and available to inhibit fire ignition, flame spread and smoke development.

363. An environmentally-clean dry powder-based fire inhibiting biochemical composition for treating polymeric resin binder material used to bind together lignocellulosic-based wood furnish material during composite wood product manufacture, comprising:
a minor amount of sodium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium pyruvate powder particles are well dispersed within the cured polymeric resin binder material, and available to inhibit fire ignition, flame spread and smoke development.
An environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium pyruvate powder particles are well dispersed within the cured polymeric resin binder material, and available to inhibit fire ignition, flame spread and smoke

364. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

365. An environmentally-clean dry powder-based fire inhibiting biochemical composition for treating polymeric resin binder material used to bind together lignocellulosic-based wood furnish material during composite wood product manufacture, comprising:
a minor amount of potassium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium tartrate powder particles are well dispersed within the cured polymeric resin binder material, and available to inhibit fire ignition, flame spread and smoke development.

366. An environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium tartrate powder particles are well dispersed within the cured polymeric resin

367. An environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium tartrate powder particles are well dispersed within the cured polymeric resin binder material, and available to inhibit fire ignition, flame spread and smoke development.

368. An environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium tartrate powder particles are well dispersed within the cured polymeric resin binder material, and available to inhibit fire ignition, flame spread and smoke development.

369. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

370. An environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium butyrate powder particles are well dispersed within the cured polymeric resin binder material, and available to inhibit fire ignition, flame spread and smoke development.

371. An environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium butyrate powder particles are well dispersed within the cured polymeric resin binder material, and available to inhibit fire ignition, flame spread and smoke development.

372. An environmentally-clean dry powder-based fire inhibiting biochemical composition for treating polymeric resin binder material used to bind together lignocellulosic-based wood furnish material during composite wood product manufacture, comprising:
a minor amount of sodium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium butyrate powder particles are well dispersed within the cured polymeric resin binder material, and available to inhibit fire ignition, flame spread and smoke development.

373. An environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium butyrate powder particles are well dispersed within the cured polymeric resin binder material, and available to inhibit fire ignition, flame spread and smoke development.

374. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic, called malic acid. An environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium butyrate powder particles are well dispersed within the cured polymeric resin binder material, and available to inhibit fire ignition, flame spread and smoke development.

375. An environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium malate powder particles are well dispersed within the cured polymeric resin binder material, and available to inhibit fire ignition, flame spread and smoke development.

376. An environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium malate powder particles are well dispersed within the cured polymeric resin binder material, and available to inhibit fire ignition, flame spread and smoke development.

377. An environmentally-clean dry powder-based fire inhibiting biochemical composition for treating polymeric resin binder material used to bind together lignocellulosic-based wood furnish material during composite wood product manufacture, comprising:
a minor amount of magnesium malate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium malate powder particles are well dispersed within the cured polymeric resin binder material, and available to inhibit fire ignition, flame spread and smoke development.

378. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called malonic acid.

379. An environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium malonate powder particles are well dispersed within the cured polymeric resin binder material, and available to inhibit fire ignition, flame spread and smoke development.

380. An environmentally-clean dry powder-based fire inhibiting biochemical composition for treating polymeric resin binder material used to bind together lignocellulosic-based wood furnish material during composite wood product manufacture, comprising:
a minor amount of calcium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium malonate powder particles are well dispersed within the cured polymeric resin binder material, and available to inhibit fire ignition, flame spread and smoke development.

381. An environmentally-clean dry powder-based fire inhibiting biochemical composition for treating polymeric resin binder material used to bind together lignocellulosic-based wood furnish material during composite wood product manufacture, comprising:
a minor amount of sodium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium malonate powder particles are well dispersed within the cured polymeric resin binder material, and available to inhibit fire ignition, flame spread and smoke development.

382. An environmentally-clean dry powder-based fire inhibiting biochemical composition
a minor amount of dimagnesium malonate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the dimagnesium malonate powder particles are well dispersed within the cured polymeric resin binder material, and available to inhibit fire ignition, flame spread and smoke development.

383. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

384. An environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium pivalate powder particles are well dispersed within the cured polymeric resin

385. An environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium pivalate powder particles are well dispersed within the cured polymeric resin binder material, and available to inhibit fire ignition, flame spread and smoke development.

386. An environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium pivalate powder particles are well dispersed within the cured polymeric resin binder material, and available to inhibit fire ignition, flame spread and smoke development.

387. An environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium pivalate powder particles are well dispersed within the cured polymeric resin binder material, and available to inhibit fire ignition, flame spread and smoke development.

388. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

389. An environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium caproate powder particles are well dispersed within the cured polymeric resin binder material, and available to inhibit fire ignition, flame spread and smoke development.

390. An environmentally-clean dry powder-based fire inhibiting biochemical composition for treating polymeric resin binder material used to bind together lignocellulosic-based wood furnish material during composite wood product manufacture, comprising:
a minor amount of calcium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium caproate powder particles are well dispersed within the cured polymeric resin binder material, and available to inhibit fire ignition, flame spread and smoke development.

391. An environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium caproate powder particles are well dispersed within the cured polymeric resin binder material, and available to inhibit fire ignition, flame spread and smoke development.

392. An environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium caproate powder particles are well dispersed within the cured polymeric resin binder material, and available to inhibit fire ignition, flame spread and smoke

393. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

394. An environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium adipate powder particles are well dispersed within the cured polymeric resin binder material, and available to inhibit fire ignition, flame spread and smoke development.

395. An environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium adipate powder particles are well dispersed within the cured polymeric resin

396. An environmentally-clean dry powder-based fire inhibiting biochemical composition for treating polymeric resin binder material used to bind together lignocellulosic-based wood furnish material during composite wood product manufacture, comprising:
a minor amount of sodium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium adipate powder particles are well dispersed within the cured polymeric resin binder material, and available to inhibit fire ignition, flame spread and smoke development.

397. An environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium adipate powder particles are well dispersed within the cured polymeric resin binder material, and available to inhibit fire ignition, flame spread and smoke development.

398. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid.

399. An environmentally-clean dry powder-based fire inhibiting biochemical composition for treating polymeric resin binder material used to bind together lignocellulosic-based wood furnish material during composite wood product manufacture, comprising:
a minor amount of potassium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium citrate powder particles are well dispersed within the cured polymeric resin binder material, and available to inhibit fire ignition, flame spread and smoke development.

400. An environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium citrate powder particles are well dispersed within the cured polymeric resin binder material, and available to inhibit fire ignition, flame spread and smoke development.

401. An environmentally-clean dry powder-based fire inhibiting biochemical composition
a minor amount of sodium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium citrate powder particles are well dispersed within the cured polymeric resin binder material, and available to inhibit fire ignition, flame spread and smoke development.

402. An environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium citrate powder particles are well dispersed within the cured polymeric resin binder material, and available to inhibit fire ignition, flame spread and smoke development.

403. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid. An environmentally-clean dry powder-based fire inhibiting biochemical composition for treating polymeric resin binder material used to bind together lignocellulosic-based wood furnish material during composite wood product manufacture, comprising:
a minor amount of potassium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium gluconate powder particles are well dispersed within the cured polymeric resin binder material, and available to inhibit fire ignition, flame spread and smoke development.

404. An environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium gluconate powder particles are well dispersed within the cured polymeric resin binder material, and available to inhibit fire ignition, flame spread and smoke development.

405. An environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium gluconate powder particles are well dispersed within the cured polymeric resin binder material, and available to inhibit fire ignition, flame spread and smoke development.

406. An environmentally-clean dry powder-based fire inhibiting biochemical composition for treating polymeric resin binder material used to bind together lignocellulosic-based wood furnish material during composite wood product manufacture, comprising:
a minor amount of magnesium gluconate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium gluconate powder particles are well dispersed within the cured polymeric resin binder material, and available to inhibit fire ignition, flame spread and smoke development.

407. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

408. An environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the potassium benzoate powder particles are well dispersed within the cured polymeric resin binder material, and available to inhibit fire ignition, flame spread and smoke development.

409. An environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the calcium benzoate powder particles are well dispersed within the cured polymeric resin binder material, and available to inhibit fire ignition, flame spread and smoke development.

410. An environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the sodium benzoate powder particles are well dispersed within the cured polymeric resin

411. An environmentally-clean dry powder-based fire inhibiting biochemical composition for treating polymeric resin binder material used to bind together lignocellulosic-based wood furnish material during composite wood product manufacture, comprising:
a minor amount of magnesium benzoate in dry powder form having powder particles for blending with a major amount of polymeric resin binder material, that is capable of binding lignocellulosic-based wood furnish material when cured during composite wood product manufacture;
wherein when said polymeric resin binder material is cured to bind said lignocellulosic-based wood furnish material during composite wood product manufacture, the magnesium benzoate powder particles are well dispersed within the cured polymeric resin binder material, and available to inhibit fire ignition, flame spread and smoke development.

412. An environmentally-clean dry powder-based fire inhibiting biochemical composition for treating polymeric resin binder material used to bind together lignocellulosic-based wood furnish material during composite wood product manufacture, comprising:
(i) a major amount of a first alkali metal salt in powder form consisting of first alkali metal salt powder particles functioning as fire inhibitors, and derived from a saturated non-polymerized carboxylic acid, wherein the carbon chain length of the carboxylic acid is less than eight (C1-C7), wherein the first alkali metal from which said alkali metal salt is derived is selected from the group consisting of potassium, calcium, sodium and magnesium; and
(ii) a minor amount of a second alkali metal salt in powder form particles consisting of second alkali metal salt powder particles, and derived from benzoic acid, wherein the second alkali metal from which said second alkali metal salt is derived is selected from the group consisting of potassium, calcium, sodium and magnesium, and said second alkali metal salt powder particles producing benzoate ions when dissolved in the presence of water so to form a protective coating on the surface of selected metals and/or metallic alloys that protects against corrosion of said selected metals and/or metallic alloys; and
wherein said major amount of first alkali metal salt powder particles are mixed with said minor amount of second alkali metal salt powder particles, and blended together into a dry biochemical treatment powder consisting of fine powder or granular particles;
wherein when said dry biochemical treatment powder is blended with a major amount of polymeric resin binder material, for binding lignocellulosic-based wood furnish material during composite wood product manufacture, the first alkali metal salt powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting first alkali metal salt powder particles that are freely available to inhibit fire ignition, flame spread and smoke development, and second alkali metal salt powder particles that are freely available to form a protective coating on the surface of selected metals and/or metallic alloys that protects against corrosion of said selected metals and/or metallic alloys.

413. An environmentally-clean dry powder-based fire inhibiting biochemical composition for treating polymeric resin binder material used to bind together lignocellulosic-based wood furnish material during composite wood product manufacture, using alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

414. An environmentally-clean dry powder-based fire inhibiting biochemical composition for treating polymeric resin binder material used to bind together lignocellulosic-based wood furnish material during composite wood product manufacture, using alkali metal salts derived from a carboxylic acid (R—COOH), selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

415. An environmentally-clean dry powder-based fire inhibiting biochemical composition for treating polymeric resin binder material used to bind together lignocellulosic-based wood furnish material during composite wood product manufacture, using alkali metal salts derived from a carboxylic acid (R—COOH), and selected from the group consisting of: (i) Alkali metal salts produced from the C1 carboxylic acid called formic acid (i.e. methanoic acid), specifically: potassium formate; calcium formate; sodium formate; and magnesium formate (dihydrate); (ii) Alkali metal salts produced from the C1 carboxylic acid called carbonic acid (i.e. hydroxymethanoic acid); specifically: potassium carbonate; sodium bicarbonate; magnesium carbonate; (iii) Alkali metal salts produced from the C2 carboxylic acid called acetic acid (ethanoic acid), specifically: potassium acetate; calcium acetate; sodium acetate; and magnesium acetate; (iv) Alkali metal salts produced from the C2 carboxylic acid called glycolic acid (hydroxyacetic acid); specifically: potassium glycolate; calcium glycolate; sodium glycolate; (v) Alkali metal salts produced from the C2 carboxylic acid called glyoxylic acid, specifically: potassium glyoxylate; calcium glyoxylate; sodium glyoxylate (monohydrate); (vi) Alkali metal salts produced from the C3 carboxylic acid called propionic acid, specifically: potassium propionate; calcium propionate; sodium propionate; and magnesium propionate; (vii) Alkali metal salts produced from the C3 carboxylic acid called lactic acid, specifically: potassium lactate; calcium lactate; sodium lactate; and magnesium lactate; (viii) Alkali metal salts produced from the C3 carboxylic acid called glyceric acid, specifically: potassium glycerate; calcium glycerate; and sodium glycerate; (ix) Alkali metal salts produced from the C3 carboxylic acid, pyruvic acid, specifically: potassium pyruvate; calcium pyruvate; sodium pyruvate; and magnesium pyruvate; (x) Alkali metal salts produced from the C3 carboxylic acid called, tartaric acid, specifically: potassium tartrate (potassium bitartrate); calcium tartrate; sodium tartrate; and magnesium tartrate; (xi) Alkali metal salts produced from the carboxylic acid called butyric acid, specifically: potassium butyrate (or butanoate); calcium butyrate; sodium butyrate; and magnesium butyrate; (xii) Alkali metal salts produced from the C4 carboxylic acid called malic acid, specifically: potassium malate; calcium malate; sodium malate; and magnesium malate; (xiii) Alkali metal salts produced from the C4 carboxylic acid called malonic acid, specifically: potassium malonate; calcium malonate; sodium malonate; and di-magnesium malonate; (xiv) Alkali metal salts produced from the C5 carboxylic acid called pivalic acid, specifically: potassium pivalate; calcium pivalate; sodium pivalate; and magnesium pivalate; (xv) Alkali metal salts produced from the C6 carboxylic acid called caproic acid, specifically: potassium caproate (hexanoate); calcium caproate; sodium caproate; magnesium caproate; (xvi) Alkali metal salts produced from the C6 carboxylic acid called adipic (hexanedioic) acid, specifically: potassium adipate; calcium adipate; sodium adipate; and magnesium adipate; (xvii) Alkali metal salts produced from the C6 carboxylic acid called citric acid, specifically: (tri)potassium citrate; calcium citrate; sodium citrate; and magnesium citrate; (xviii) Alkali metal salts produced from the C6 carboxylic acid called d-gluconic acid, specifically: potassium gluconate; calcium gluconate; sodium gluconate; and magnesium gluconate; and (xix) Alkali metal salts produced from the C7 carboxylic acid called benzoic acid, specifically: potassium benzoate; calcium benzoate; sodium benzoate; and magnesium benzoate.

416. An environmentally-clean dry powder-based fire inhibiting biochemical composition for treating polymeric resin binder material used to bind together lignocellulosic-based wood furnish material during composite wood product manufacture, comprising:
a minor amount of calcium formate in dry powder form; and
a minor amount of an alkali metal salt of benzoic acid in dry powder form, mixed with said calcium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium formate and said alkali metal salt of benzoic acid, are blended with a major amount of polymeric resin binder material, for binding lignocellulosic-based wood furnish material during composite wood product manufacture, the calcium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium formate powder particles that are freely available to inhibit fire ignition, flame spread and smoke development.

417. An environmentally-clean dry powder-based fire inhibiting biochemical composition for treating polymeric resin binder material used to bind together lignocellulosic-based wood furnish material during composite wood product manufacture, comprising:
a minor amount of sodium formate in dry powder form; and
a minor amount of an alkali metal salt of benzoic acid in dry powder form, mixed with said sodium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium formate and said alkali metal salt of benzoic acid, are blended with a major amount of polymeric resin binder material, for binding lignocellulosic-based wood furnish material during composite wood product manufacture, the sodium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium formate powder particles that are freely available to inhibit fire ignition, flame spread and smoke development.

418. An environmentally-clean dry powder-based fire inhibiting biochemical composition for treating polymeric resin binder material used to bind together lignocellulosic-based wood furnish material during composite wood product manufacture, comprising:
a minor amount of magnesium formate in dry powder form; and
a minor amount of an alkali metal salt of benzoic acid in dry powder form, mixed with said magnesium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium formate and said alkali metal salt of benzoic acid, are blended with a major amount of polymeric resin binder material, for binding lignocellulosic-based wood furnish material during composite wood product manufacture, the magnesium formate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium formate powder particles that are freely available to inhibit fire ignition, flame spread and smoke development.

419. An environmentally-clean dry powder-based fire inhibiting biochemical composition for treating polymeric resin binder material used to bind together lignocellulosic-based wood furnish material during composite wood product manufacture, wherein each said dry-powder fire inhibitor composition contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

420. An environmentally-clean dry powder-based fire inhibiting biochemical composition for treating polymeric resin binder material used to bind together lignocellulosic-based wood furnish material during composite wood product manufacture, comprising:
a minor amount of potassium carbonate (bicarbonate) in dry powder form; and
a minor amount of an alkali metal salt of benzoic acid in dry powder form, mixed with said potassium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium carbonate and said alkali metal salt of benzoic acid, are blended with a major amount of polymeric resin binder material, for binding lignocellulosic-based wood furnish material during composite wood product manufacture, the potassium carbonate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium carbonate powder particles that are freely available to inhibit fire ignition, flame spread and smoke development.

421. An environmentally-clean dry powder-based fire inhibiting biochemical composition for treating polymeric resin binder material used to bind together lignocellulosic-based wood furnish material during composite wood product manufacture, comprising:
a minor amount of sodium carbonate (bicarbonate) in dry powder form; and
a minor amount of an alkali metal salt of benzoic acid in dry powder form, mixed with said sodium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium carbonate and said alkali metal salt of benzoic acid, are blended with a major amount of polymeric resin binder material, for binding lignocellulosic-based wood furnish material during composite wood product manufacture, the sodium carbonate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium carbonate powder particles that are freely available to inhibit fire ignition, flame spread and smoke development.

422. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

423. An environmentally-clean dry powder-based fire inhibiting biochemical composition for treating polymeric resin binder material used to bind together lignocellulosic-based wood furnish material during composite wood product manufacture, comprising:
a minor amount of potassium acetate in dry powder form; and
a minor amount of an alkali metal salt of benzoic acid in dry powder form, mixed with said potassium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium acetate and said alkali metal salt of benzoic acid, are blended with a major amount of polymeric resin binder material, for binding lignocellulosic-based wood furnish material during composite wood product manufacture, the potassium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium acetate powder particles that are freely available to inhibit fire ignition, flame spread and smoke development, and available to inhibit fire ignition, flame spread and smoke development.

424. An environmentally-clean dry powder-based fire inhibiting biochemical composition for treating polymeric resin binder material used to bind together lignocellulosic-based wood furnish material during composite wood product manufacture, comprising:
a minor amount of calcium acetate in dry powder form; and
a minor amount of an alkali metal salt of benzoic acid in dry powder form, mixed with said calcium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium acetate and said alkali metal salt of benzoic acid, are blended with a major amount of polymeric resin binder material, for binding lignocellulosic-based wood furnish material during composite wood product manufacture, the calcium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium acetate powder particles that are freely available to inhibit fire ignition, flame spread and smoke development.

425. An environmentally-clean dry powder-based fire inhibiting biochemical composition for treating polymeric resin binder material used to bind together lignocellulosic-based wood furnish material during composite wood product manufacture, comprising:
a minor amount of sodium acetate in dry powder form; and
a minor amount of an alkali metal salt of benzoic acid in dry powder form, mixed with said sodium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium acetate and said alkali metal salt of benzoic acid, are blended with a major amount of polymeric resin binder material, for binding lignocellulosic-based wood furnish material during composite wood product manufacture, the sodium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium acetate powder particles that are freely available to inhibit fire ignition, flame spread and smoke development.

426. An environmentally-clean dry powder-based fire inhibiting biochemical composition for treating polymeric resin binder material used to bind together lignocellulosic-based wood furnish material during composite wood product manufacture, comprising:
a minor amount of magnesium acetate in dry powder form; and
a minor amount of an alkali metal salt of benzoic acid in dry powder form, mixed with said magnesium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium acetate and said alkali metal salt of benzoic acid, are blended with a major amount of polymeric resin binder material, for binding lignocellulosic-based wood furnish material during composite wood product manufacture, the magnesium acetate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium acetate powder particles that are freely available to inhibit fire ignition, flame spread and smoke development.

427. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glycolic acid (hydroxyacetic acid).

428. An environmentally-clean dry powder-based fire inhibiting biochemical composition for treating polymeric resin binder material used to bind together lignocellulosic-based wood furnish material during composite wood product manufacture, comprising:
a minor amount of potassium glycolate in dry powder form; and
a minor amount of an alkali metal salt of benzoic acid in dry powder form, mixed with said potassium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glycolate and said alkali metal salt of benzoic acid, are blended with a major amount of polymeric resin binder material, for binding lignocellulosic-based wood furnish material during composite wood product manufacture, the potassium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glycolate powder particles that are freely available to inhibit fire ignition, flame spread and smoke development.

429. An environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form; and
a minor amount of an alkali metal salt of benzoic acid in dry powder form, mixed with said calcium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glycolate and said alkali metal salt of benzoic acid, are blended with a major amount of polymeric resin binder material, for binding lignocellulosic-based wood furnish material during composite wood product manufacture, the calcium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glycolate powder

430. An environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form; and
a minor amount of an alkali metal salt of benzoic acid in dry powder form, mixed with said sodium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycolate and said alkali metal salt of benzoic acid, are blended with a major amount of polymeric resin binder material, for binding lignocellulosic-based wood furnish material during composite wood product manufacture, the sodium glycolate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium glycolate powder particles that are freely available to inhibit fire ignition, flame spread and smoke development.

431. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic glyoxylic acid (i.e. oxoacetic acid).

432. An environmentally-clean dry powder-based fire inhibiting biochemical composition for treating polymeric resin binder material used to bind together lignocellulosic-based wood furnish material during composite wood product manufacture, comprising:
a minor amount of potassium glyoxylate in dry powder form; and
a minor amount of an alkali metal salt of benzoic acid in dry powder form, mixed with said powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glyoxylate and said alkali metal salt of benzoic acid, are blended with a major amount of polymeric resin binder material, for binding lignocellulosic-based wood furnish material during composite wood product manufacture, the potassium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glyoxylate powder particles that are freely available to inhibit fire ignition, flame spread and smoke development.

433. An environmentally-clean dry powder-based fire inhibiting biochemical composition for treating polymeric resin binder material used to bind together lignocellulosic-based wood furnish material during composite wood product manufacture, comprising:
a minor amount of calcium glyoxylate in dry powder form; and
a minor amount of an alkali metal salt of benzoic acid in dry powder form, mixed with said calcium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glyoxylate and said alkali metal salt of benzoic acid, are blended with a major amount of polymeric resin binder material, for binding lignocellulosic-based wood furnish material during composite wood product manufacture, the calcium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glyoxylate powder particles that are freely available to inhibit fire ignition, flame spread and smoke development.

434. An environmentally-clean dry powder-based fire inhibiting biochemical composition for treating polymeric resin binder material used to bind together lignocellulosic-based wood furnish material during composite wood product manufacture, comprising:
a minor amount of sodium glyoxylate in dry powder form; and
a minor amount of an alkali metal salt of benzoic acid in dry powder form, mixed with said sodium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxylate and said alkali metal salt of benzoic acid, are blended with a major amount of polymeric resin binder material, for binding lignocellulosic-based wood furnish material during composite wood product manufacture, the sodium glyoxylate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium glyoxylate powder particles that are freely available to inhibit fire ignition, flame spread and smoke development.

435. An environmentally-clean dry powder-based fire inhibiting biochemical composition for treating polymeric resin binder material used to bind together lignocellulosic-based wood furnish material during composite wood product manufacture, wherein each said dry-powder fire inhibiting composition contains alkali metal salts derived from C2 Class of Carboxylic Acids having 2 carbon atoms, specifically, the C2 carboxylic acid, called oxalic acid. An environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form; and
a minor amount of an alkali metal salt of benzoic acid in dry powder form, mixed with said potassium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium oxalate and said alkali metal salt of benzoic acid, are blended with a major amount of polymeric resin binder material, for binding lignocellulosic-based wood furnish material during composite wood product manufacture, the potassium oxalate powder particles are well dispersed within the material is cured during composite wood product manufacture, the finished composite wood product contains cured polymeric resin binder material binding together lignocellulosic-based wood furnish material, and supporting potassium oxalate powder particles that are freely available to inhibit fire ignition, flame spread and smoke development.

436. An environmentally-clean dry powder-based fire inhibiting biochemical composition for treating polymeric resin binder material used to bind together lignocellulosic-based wood furnish material during composite wood product manufacture, comprising:
a minor amount of calcium oxalate in dry powder form; and
a minor amount of an alkali metal salt of benzoic acid in dry powder form, mixed with said calcium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium oxalate and said alkali metal salt of benzoic acid, are blended with a major amount of polymeric resin binder material, for binding lignocellulosic-based wood furnish material during composite wood product manufacture, the calcium oxalate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium oxalate powder particles that are freely available to inhibit fire ignition, flame spread and smoke development.

437. An environmentally-clean dry powder-based fire inhibiting biochemical composition for treating polymeric resin binder material used to bind together lignocellulosic-based wood furnish material during composite wood product manufacture, comprising:
a minor amount of sodium oxalate in dry powder form; and
a minor amount of an alkali metal salt of benzoic acid in dry powder form, mixed with said sodium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxalate and said alkali metal salt of benzoic acid, are blended with a major amount of polymeric resin binder material, for binding lignocellulosic-based wood furnish material during composite wood product manufacture, the sodium oxalate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium oxalate powder particles that are freely available to inhibit fire ignition, flame spread and smoke development.

438. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04):

439. An environmentally-clean dry powder-based fire inhibiting biochemical composition for treating polymeric resin binder material used to bind together lignocellulosic-based wood furnish material during composite wood product manufacture, comprising:
a minor amount of potassium propionate in dry powder form; and
a minor amount of an alkali metal salt of benzoic acid in dry powder form, mixed with said potassium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium propionate and said alkali metal salt of benzoic acid, are blended with a major amount of polymeric resin binder material, for binding lignocellulosic-based wood furnish material during composite wood product manufacture, the potassium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium propionate powder particles that are freely available to inhibit fire ignition, flame spread and smoke development.

440. An environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form; and
a minor amount of an alkali metal salt of benzoic acid in dry powder form, mixed with said calcium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium propionate and said alkali metal salt of benzoic acid, are blended with a major amount of polymeric resin binder material, for binding lignocellulosic-based wood furnish material during composite wood product manufacture, the calcium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium propionate powder particles that are freely available to inhibit fire ignition, flame spread and smoke development.

441. An environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form; and
a minor amount of an alkali metal salt of benzoic acid in dry powder form, mixed with said sodium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium propionate and said alkali metal salt of benzoic acid, are blended with a major amount of polymeric resin binder material, for binding lignocellulosic-based wood furnish material during composite wood product manufacture, the sodium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium propionate powder

442. An environmentally-clean dry powder-based fire inhibiting biochemical composition for treating polymeric resin binder material used to bind together lignocellulosic-based wood furnish material during composite wood product manufacture, comprising:
a minor amount of magnesium propionate in dry powder form; and
a minor amount of an alkali metal salt of benzoic acid in dry powder form, mixed with said magnesium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium propionate and said alkali metal salt of benzoic acid, are blended with a major amount of polymeric resin binder material, for binding lignocellulosic-based wood furnish material during composite wood product manufacture, the magnesium propionate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium propionate powder particles that are freely available to inhibit fire ignition, flame spread and smoke development.

443. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

444. An environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form; and
a minor amount of an alkali metal salt of benzoic acid in dry powder form, mixed with said potassium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium lactate and said alkali metal salt of benzoic acid, are blended with a major amount of polymeric resin binder material, for binding lignocellulosic-based wood furnish material during composite wood product manufacture, the potassium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium lactate powder particles that are freely available to inhibit fire ignition, flame spread and smoke development.

445. An environmentally-clean dry powder-based fire inhibiting biochemical composition for treating polymeric resin binder material used to bind together lignocellulosic-based wood furnish material during composite wood product manufacture, comprising:
a minor amount of calcium lactate in dry powder form; and
a minor amount of an alkali metal salt of benzoic acid in dry powder form, mixed with said calcium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium lactate and said alkali metal salt of benzoic acid, are blended with a major amount of polymeric resin binder material, for binding lignocellulosic-based wood furnish material during composite wood product manufacture, the calcium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium lactate powder particles that are freely available to inhibit fire ignition, flame spread and smoke development.

446. An environmentally-clean dry powder-based fire inhibiting biochemical composition for treating polymeric resin binder material used to bind together lignocellulosic-based wood furnish material during composite wood product manufacture, comprising:
a minor amount of sodium lactate in dry powder form; and
a minor amount of an alkali metal salt of benzoic acid in dry powder form, mixed with said sodium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium lactate and said alkali metal salt of benzoic acid, are blended with a major amount of polymeric resin binder material, for binding lignocellulosic-based wood furnish material during composite wood product manufacture, the sodium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium lactate powder particles that are freely available to inhibit fire ignition, flame spread and smoke development.

447. An environmentally-clean dry powder-based fire inhibiting biochemical composition for treating polymeric resin binder material used to bind together lignocellulosic-based wood furnish material during composite wood product manufacture, comprising:
a minor amount of magnesium lactate in dry powder form; and
a minor amount of an alkali metal salt of benzoic acid in dry powder form, mixed with said magnesium powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium lactate and said alkali metal salt of benzoic acid, are blended with a major amount of polymeric resin binder material, for binding lignocellulosic-based wood furnish material during composite wood product manufacture, the magnesium lactate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium lactate powder particles that are freely available to inhibit fire ignition, flame spread and smoke development.

448. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

449. An environmentally-clean dry powder-based fire inhibiting biochemical composition for treating polymeric resin binder material used to bind together lignocellulosic-based wood furnish material during composite wood product manufacture, comprising:
a minor amount of potassium glycerate in dry powder form; and
a minor amount of an alkali metal salt of benzoic acid in dry powder form, mixed with said potassium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium glycerate and said alkali metal salt of benzoic acid, are blended with a major amount of polymeric resin binder material, for binding lignocellulosic-based wood furnish material during composite wood product manufacture, the potassium glycerate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium glycerate powder particles that are freely available to inhibit fire ignition, flame spread and smoke development.

450. An environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form; and
a minor amount of an alkali metal salt of benzoic acid in dry powder form, mixed with said calcium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium glycerate and said alkali metal salt of benzoic acid, are blended with a major amount of polymeric resin binder material, for binding lignocellulosic-based wood furnish material during composite wood product manufacture, the calcium glycerate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium glycerate powder particles that are freely available to inhibit fire ignition, flame spread and smoke development.

451. An environmentally-clean dry powder-based fire inhibiting biochemical composition for treating polymeric resin binder material used to bind together lignocellulosic-based wood furnish material during composite wood product manufacture, comprising:
a minor amount of sodium glycerate in dry powder form; and
a minor amount of an alkali metal salt of benzoic acid in dry powder form, mixed with said sodium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycerate and said alkali metal salt of benzoic acid, are blended with a major amount of polymeric resin binder material, for binding lignocellulosic-based wood furnish material during composite wood product manufacture, the sodium glycerate powder particles are well dispersed within the wood product contains cured polymeric resin binder material binding together lignocellulosic-based wood furnish material, and supporting sodium glycerate powder particles that are freely available to inhibit fire ignition, flame spread and smoke development.

452. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

453. An environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form; and
a minor amount of an alkali metal salt of benzoic acid in dry powder form, mixed with said potassium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium pyruvate and said alkali metal salt of benzoic acid, are blended with a major amount of polymeric resin binder material, for binding lignocellulosic-based wood furnish material during composite wood product manufacture, the potassium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting potassium pyruvate powder

454. An environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form; and
a minor amount of an alkali metal salt of benzoic acid in dry powder form, mixed with said calcium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium pyruvate and said alkali metal salt of benzoic acid, are blended with a major amount of polymeric resin binder material, for binding lignocellulosic-based wood furnish material during composite wood product manufacture, the calcium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium pyruvate powder particles that are freely available to inhibit fire ignition, flame spread and smoke development.

455. An environmentally-clean dry powder-based fire inhibiting biochemical composition for treating polymeric resin binder material used to bind together lignocellulosic-based wood furnish material during composite wood product manufacture, comprising:
a minor amount of sodium pyruvate in dry powder form; and
a minor amount of an alkali metal salt of benzoic acid in dry powder form, mixed with said pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium pyruvate and said alkali metal salt of benzoic acid, are blended with a major amount of polymeric resin binder material, for binding lignocellulosic-based wood furnish material during composite wood product manufacture, the sodium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium pyruvate powder particles that are freely available to inhibit fire ignition, flame spread and smoke development.

456. An environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form; and
a minor amount of an alkali metal salt of benzoic acid in dry powder form, mixed with said magnesium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium pyruvate and said alkali metal salt of benzoic acid, are blended with a major amount of polymeric resin binder material, for binding lignocellulosic-based wood furnish material during composite wood product manufacture, the magnesium pyruvate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium pyruvate powder particles that are freely available to inhibit fire ignition, flame spread and smoke development.

457. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid).

458. An environmentally-clean dry powder-based fire inhibiting biochemical composition for treating polymeric resin binder material used to bind together lignocellulosic-based wood furnish material during composite wood product manufacture, comprising:
a minor amount of potassium tartrate in dry powder form; and
a minor amount of an alkali metal salt of benzoic acid in dry powder form, mixed with said potassium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium tartrate and said alkali metal salt of benzoic acid, are blended with a major amount of polymeric resin binder material, for binding lignocellulosic-based wood furnish material during composite wood product manufacture, the potassium tartrate powder particles are well dispersed within the wood product contains cured polymeric resin binder material binding together lignocellulosic-based wood furnish material, and supporting potassium tartrate powder particles that are freely available to inhibit fire ignition, flame spread and smoke development.

459. An environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form; and
a minor amount of an alkali metal salt of benzoic acid in dry powder form, mixed with said calcium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium tartrate and said alkali metal salt of benzoic acid, are blended with a major amount of polymeric resin binder material, for binding lignocellulosic-based wood furnish material during composite wood product manufacture, the calcium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium tartrate powder particles that are freely available to inhibit fire ignition, flame spread and smoke development.

460. An environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form; and
a minor amount of an alkali metal salt of benzoic acid in dry powder form, mixed with said sodium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium tartrate and said alkali metal salt of benzoic acid, are blended with a major amount of polymeric resin binder material, for binding lignocellulosic-based wood furnish material during composite wood product manufacture, the sodium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium tartrate powder particles that are freely available to inhibit fire ignition, flame spread and smoke development.

461. An environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form; and
a minor amount of an alkali metal salt of benzoic acid in dry powder form, mixed with said magnesium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium tartrate and said alkali metal salt of benzoic acid, are blended with a major amount of polymeric resin binder material, for binding lignocellulosic-based wood furnish material during composite wood product manufacture, the magnesium tartrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting magnesium tartrate powder particles that are freely available to inhibit fire ignition, flame spread and smoke development.

462. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

463. An environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form; and
a minor amount of an alkali metal salt of benzoic acid in dry powder form, mixed with said potassium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium butyrate and said alkali metal salt of benzoic acid, are blended with a major amount of polymeric resin binder material, for binding lignocellulosic-based wood furnish material during composite wood product manufacture, the potassium butyrate powder particles are well dispersed within the material is cured during composite wood product manufacture, the finished composite wood product contains cured polymeric resin binder material binding together lignocellulosic-based wood furnish material, and supporting potassium butyrate powder particles that are freely available to inhibit fire ignition, flame spread and smoke development.

464. An environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form; and
a minor amount of an alkali metal salt of benzoic acid in dry powder form, mixed with said calcium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium butyrate and said alkali metal salt of benzoic acid, are blended with a major amount of polymeric resin binder material, for binding lignocellulosic-based wood furnish material during composite wood product manufacture, the calcium butyrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting calcium butyrate powder particles that are freely available to inhibit fire ignition, flame spread and smoke development.

465. An environmentally-clean dry powder-based fire inhibiting biochemical composition
a minor amount of sodium butyrate in dry powder form; and
a minor amount of an alkali metal salt of benzoic acid in dry powder form, mixed with said sodium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium butyrate and said alkali metal salt of benzoic acid, are blended with a major amount of polymeric resin binder material, for binding lignocellulosic-based wood furnish material during composite wood product manufacture, the sodium butyrate powder particles are well dispersed within the treated polymeric resin binder material, and after the treated polymeric resin binder material is cured during composite wood product manufacture, the finished composite wood product contains cured polymeric resin binder material binding together lignocellulosic-based wood furnish material, and supporting sodium butyrate powder particles that are freely available to inhibit fire ignition, flame spread and smoke development.

466. An environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form; and
a minor amount of an alkali metal salt of benzoic acid in dry powder form, mixed with said magnesium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium butyrate and said alkali metal salt of benzoic acid, are blended with a major amount of polymeric resin binder material, for binding lignocellulosic-based wood furnish material during composite wood product manufacture, the magnesium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium butyrate powder particles that are freely available to inhibit fire ignition, flame spread and smoke development.

467. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic, called malic acid.

468. An environmentally-clean dry powder-based fire inhibiting biochemical composition for treating polymeric resin binder material used to bind together lignocellulosic-based wood furnish material during composite wood product manufacture, comprising:
a minor amount of potassium malate in dry powder form; and
a minor amount of an alkali metal salt of benzoic acid in dry powder form, mixed with said potassium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium malate and said alkali metal salt of benzoic acid, are blended with a major amount of polymeric resin binder material, for binding lignocellulosic-based wood furnish material during composite wood product manufacture, the potassium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malate powder particles that are freely available to inhibit fire ignition, flame spread and smoke development.

469. An environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form; and
a minor amount of an alkali metal salt of benzoic acid in dry powder form, mixed with said calcium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium malate and said alkali metal salt of benzoic acid, are blended with a major amount of polymeric resin binder material, for binding lignocellulosic-based wood furnish material during composite wood product manufacture, the calcium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malate powder particles that are freely available to inhibit fire ignition, flame spread and smoke development.

470. An environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form; and
a minor amount of an alkali metal salt of benzoic acid in dry powder form, mixed with said sodium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium malate and said alkali metal salt of benzoic acid, are blended with a major amount of polymeric resin binder material, for binding lignocellulosic-based wood furnish material during composite wood product manufacture, the sodium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malate powder particles that are freely available to inhibit fire ignition, flame spread and smoke development.

471. An environmentally-clean dry powder-based fire inhibiting biochemical composition for treating polymeric resin binder material used to bind together lignocellulosic-based wood furnish material during composite wood product manufacture, comprising:
a minor amount of magnesium malate in dry powder form; and
a minor amount of an alkali metal salt of benzoic acid in dry powder form, mixed with said magnesium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium malate and said alkali metal salt of benzoic acid, are blended with a major amount of polymeric resin binder material, for binding lignocellulosic-based wood furnish material during composite wood product manufacture, the magnesium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malate powder particles that are freely available to inhibit fire ignition, flame spread and smoke development.

472. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called malonic acid.

473. An environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form; and
a minor amount of an alkali metal salt of benzoic acid in dry powder form, mixed with said potassium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium malonate and said alkali metal salt of benzoic acid, are blended with a major amount of polymeric resin binder material, for binding lignocellulosic-based wood furnish material during composite wood product manufacture, the potassium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malonate powder particles that are freely available to inhibit fire ignition, flame spread and smoke development.

474. An environmentally-clean dry powder-based fire inhibiting biochemical composition for treating polymeric resin binder material used to bind together lignocellulosic-based wood furnish material during composite wood product manufacture, comprising:
a minor amount of calcium malonate in dry powder form; and
a minor amount of an alkali metal salt of benzoic acid in dry powder form, mixed with said calcium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium malonate and said alkali metal salt of benzoic acid, are blended with a major amount of polymeric resin binder material, for binding lignocellulosic-based wood furnish material during composite wood product manufacture, the calcium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malonate powder

475. An environmentally-clean dry powder-based fire inhibiting biochemical composition for treating polymeric resin binder material used to bind together lignocellulosic-based wood furnish material during composite wood product manufacture, comprising:
a minor amount of sodium malonate in dry powder form; and
a minor amount of an alkali metal salt of benzoic acid in dry powder form, mixed with said sodium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium malonate and said alkali metal salt of benzoic acid, are blended with a major amount of polymeric resin binder material, for binding lignocellulosic-based wood furnish material during composite wood product manufacture, the sodium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malonate powder particles that are freely available to inhibit fire ignition, flame spread and smoke development.

476. An environmentally-clean dry powder-based fire inhibiting biochemical composition for treating polymeric resin binder material used to bind together lignocellulosic-based wood furnish material during composite wood product manufacture, comprising:
a minor amount of dimagnesium malonate in dry powder form; and
a minor amount of an alkali metal salt of benzoic acid in dry powder form, mixed with said dimagnesium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said dimagnesium malonate and said alkali metal salt of benzoic acid, are blended with a major amount of polymeric resin binder material, for binding lignocellulosic-based wood furnish material during composite wood product manufacture, the dimagnesium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malonate powder particles that are freely available to inhibit fire ignition, flame spread and smoke development.

477. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

478. An environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form; and
a minor amount of an alkali metal salt of benzoic acid in dry powder form, mixed with said potassium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium pivalate and said alkali metal salt of benzoic acid, are blended with a major amount of polymeric resin binder material, for binding lignocellulosic-based wood furnish material during composite wood product manufacture, the potassium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pivalate powder particles that are freely available to inhibit fire ignition, flame spread and smoke development.

479. An environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form; and
a minor amount of an alkali metal salt of benzoic acid in dry powder form, mixed with said calcium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium pivalate and said alkali metal salt of benzoic acid, are blended with a major amount of polymeric resin binder material, for binding lignocellulosic-based wood furnish material during composite wood product manufacture, the calcium pivalate powder particles are well dispersed within the lignocellulosic-based wood furnish material, and supporting calcium pivalate powder particles that are freely available to inhibit fire ignition, flame spread and smoke development.

480. An environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form; and
a minor amount of an alkali metal salt of benzoic acid in dry powder form, mixed with said sodium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium pivalate and said alkali metal salt of benzoic acid, are blended with a major amount of polymeric resin binder material, for binding lignocellulosic-based wood furnish material during composite wood product manufacture, the sodium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pivalate powder particles that are freely available to inhibit fire ignition, flame spread and smoke development.

481. An environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form; and
a minor amount of an alkali metal salt of benzoic acid in dry powder form, mixed with said magnesium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium pivalate and said alkali metal salt of benzoic acid, are blended with a major amount of polymeric resin binder material, for binding lignocellulosic-based wood furnish material during composite wood product manufacture, the magnesium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium pivalate powder particles that are freely available to inhibit fire ignition, flame spread and smoke development.

482. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

483. An environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form; and
a minor amount of an alkali metal salt of benzoic acid in dry powder form, mixed with said potassium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium caproate and said alkali metal salt of benzoic acid, are blended with a major amount of polymeric resin binder material, for binding lignocellulosic-based wood furnish material during composite wood product manufacture, the potassium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium caproate powder particles that are freely available to inhibit fire ignition, flame spread and smoke development.

484. An environmentally-clean dry powder-based fire inhibiting biochemical composition for treating polymeric resin binder material used to bind together lignocellulosic-based wood furnish material during composite wood product manufacture, comprising:
a minor amount of calcium caproate in dry powder form; and
a minor amount of an alkali metal salt of benzoic acid in dry powder form, mixed with said calcium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium caproate and said alkali metal salt of benzoic acid, are blended with a major amount of polymeric resin binder material, for binding lignocellulosic-based wood furnish material during composite wood product manufacture, the calcium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium caproate powder particles that are freely available to inhibit fire ignition, flame spread and smoke development.

485. An environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form; and
a minor amount of an alkali metal salt of benzoic acid in dry powder form, mixed with said sodium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium caproate and said alkali metal salt of benzoic acid, are blended with a major amount of polymeric resin binder material, for binding lignocellulosic-based wood furnish material during composite wood product manufacture, the sodium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium caproate powder

486. An environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form; and
a minor amount of an alkali metal salt of benzoic acid in dry powder form, mixed with said magnesium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium caproate and said alkali metal salt of benzoic acid, are blended with a major amount of polymeric resin binder material, for binding lignocellulosic-based wood furnish material during composite wood product manufacture, the magnesium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium caproate powder particles that are freely available to inhibit fire ignition, flame spread and smoke development.

487. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

488. An environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form; and
a minor amount of an alkali metal salt of benzoic acid in dry powder form, mixed with said potassium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium adipate and said alkali metal salt of benzoic acid, are blended with a major amount of polymeric resin binder material, for binding lignocellulosic-based wood furnish material during composite wood product manufacture, the potassium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium adipate powder particles that are freely available to inhibit fire ignition, flame spread and smoke development.

489. An environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form; and
a minor amount of an alkali metal salt of benzoic acid in dry powder form, mixed with said calcium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium adipate and said alkali metal salt of benzoic acid, are blended with a major amount of polymeric resin binder material, for binding lignocellulosic-based wood furnish material during composite wood product manufacture, the calcium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium adipate powder particles that are freely available to inhibit fire ignition, flame spread and smoke development.

490. An environmentally-clean dry powder-based fire inhibiting biochemical composition for treating polymeric resin binder material used to bind together lignocellulosic-based wood furnish material during composite wood product manufacture, comprising:
a minor amount of sodium adipate in dry powder form; and
a minor amount of an alkali metal salt of benzoic acid in dry powder form, mixed with said sodium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium adipate and said alkali metal salt of benzoic acid, are blended with a major amount of polymeric resin binder material, for binding lignocellulosic-based wood furnish material during composite wood product manufacture, the sodium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium adipate powder particles that are freely available to inhibit fire ignition, flame spread and smoke development.

491. An environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form; and
a minor amount of an alkali metal salt of benzoic acid in dry powder form, mixed with said magnesium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium adipate and said alkali metal salt of benzoic acid, are blended with a major amount of polymeric resin binder material, for binding lignocellulosic-based wood furnish material during composite wood product manufacture, the magnesium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium adipate powder particles that are freely available to inhibit fire ignition, flame spread and smoke development.

492. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid.

493. An environmentally-clean dry powder-based fire inhibiting biochemical composition for treating polymeric resin binder material used to bind together lignocellulosic-based wood furnish material during composite wood product manufacture, comprising:
a minor amount of potassium citrate in dry powder form; and
a minor amount of an alkali metal salt of benzoic acid in dry powder form, mixed with said potassium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium citrate and said alkali metal salt of benzoic acid, are blended with a major amount of polymeric resin binder material, for binding lignocellulosic-based wood furnish material during composite wood product manufacture, the potassium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium citrate powder particles that are freely available to inhibit fire ignition, flame spread and smoke development.

494. An environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form; and
a minor amount of an alkali metal salt of benzoic acid in dry powder form, mixed with said calcium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium citrate and said alkali metal salt of benzoic acid, are blended with a major amount of polymeric resin binder material, for binding lignocellulosic-based wood furnish material during composite wood product manufacture, the calcium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium citrate powder particles that are freely available to inhibit fire ignition, flame spread and smoke development.

495. An environmentally-clean dry powder-based fire inhibiting biochemical composition for treating polymeric resin binder material used to bind together lignocellulosic-based wood furnish material during composite wood product manufacture, comprising:
a minor amount of sodium citrate in dry powder form; and
a minor amount of an alkali metal salt of benzoic acid in dry powder form, mixed with said sodium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium citrate and said alkali metal salt of benzoic acid, are blended with a major amount of polymeric resin binder material, for binding lignocellulosic-based wood furnish material during composite wood product manufacture, the sodium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium citrate powder particles that are freely available to inhibit fire ignition, flame spread and smoke development.

496. An environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form; and
a minor amount of an alkali metal salt of benzoic acid in dry powder form, mixed with said magnesium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium citrate and said alkali metal salt of benzoic acid, are blended with a major amount of polymeric resin binder material, for binding lignocellulosic-based wood furnish material during composite wood product manufacture, the magnesium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium citrate powder particles that are freely available to inhibit fire ignition, flame spread and smoke development.

497. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid.

498. An environmentally-clean dry powder-based fire inhibiting biochemical composition for treating polymeric resin binder material used to bind together lignocellulosic-based wood furnish material during composite wood product manufacture, comprising:
a minor amount of potassium gluconate in dry powder form; and
a minor amount of an alkali metal salt of benzoic acid in dry powder form, mixed with said potassium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium gluconate and said alkali metal salt of benzoic acid, are blended with a major amount of polymeric resin binder material, for binding lignocellulosic-based wood furnish material during composite wood product manufacture, the potassium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium gluconate powder particles that are freely available to inhibit fire ignition, flame spread and smoke development.

499. An environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form; and
a minor amount of an alkali metal salt of benzoic acid in dry powder form, mixed with said calcium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium gluconate and said alkali metal salt of benzoic acid, are blended with a major amount of polymeric resin binder material, for binding lignocellulosic-based wood furnish material during composite wood product manufacture, the calcium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium gluconate powder particles that are freely available to inhibit fire ignition, flame spread and smoke development.

500. An environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form; and
a minor amount of an alkali metal salt of benzoic acid in dry powder form, mixed with said sodium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium gluconate and said alkali metal salt of benzoic acid, are blended with a major amount of polymeric resin binder material, for binding lignocellulosic-based wood furnish material during composite wood product manufacture, the sodium gluconate powder particles are well dispersed within the lignocellulosic-based wood furnish material, and supporting sodium gluconate powder particles that are freely available to inhibit fire ignition, flame spread and smoke development.

501. An environmentally-clean dry powder-based fire inhibiting biochemical composition for treating polymeric resin binder material used to bind together lignocellulosic-based wood furnish material during composite wood product manufacture, comprising:
a minor amount of magnesium gluconate in dry powder form; and
a minor amount of an alkali metal salt of benzoic acid in dry powder form, mixed with said magnesium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium gluconate and said alkali metal salt of benzoic acid, are blended with a major amount of polymeric resin binder material, for binding lignocellulosic-based wood furnish material during composite wood product manufacture, the magnesium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium gluconate powder particles that are freely available to inhibit fire ignition, flame spread and smoke development.

502. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

503. An environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form; and
a minor amount of an alkali metal salt of benzoic acid in dry powder form, mixed with said potassium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium benzoate and said alkali metal salt of benzoic acid, are blended with a major amount of polymeric resin binder material, for binding lignocellulosic-based wood furnish material during composite wood product manufacture, the potassium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium benzoate powder particles that are freely available to inhibit fire ignition, flame spread and smoke development.

504. An environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form; and
a minor amount of an alkali metal salt of benzoic acid in dry powder form, mixed with said calcium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium benzoate and said alkali metal salt of benzoic acid, are blended with a major amount of polymeric resin binder material, for binding lignocellulosic-based wood furnish material during composite wood product manufacture, the calcium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium benzoate powder particles that are freely available to inhibit fire ignition, flame spread and smoke development.

505. An environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form; and
a minor amount of an alkali metal salt of benzoic acid in dry powder form, mixed with said sodium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium benzoate and said alkali metal salt of benzoic acid, are blended with a major amount of polymeric resin binder material, for binding lignocellulosic-based wood furnish material during composite wood product manufacture, the sodium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium benzoate powder particles that are freely available to inhibit fire ignition, flame spread and smoke development.

506. An environmentally-clean dry powder-based fire inhibiting biochemical composition for treating polymeric resin binder material used to bind together lignocellulosic-based wood furnish material during composite wood product manufacture, comprising:
a minor amount of magnesium benzoate in dry powder form; and
a minor amount of an alkali metal salt of benzoic acid in dry powder form, mixed with said magnesium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium benzoate and said alkali metal salt of benzoic acid, are blended with a major amount of polymeric resin binder material, for binding lignocellulosic-based wood furnish material during composite wood product manufacture, the magnesium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium benzoate powder

507. An environmentally-clean fire inhibiting pMDI resin binder material used to bind together lignocellulosic-based wood furnish material during the production of fire-protected composite wood products, wherein the fire inhibiting pMDI resin binder material contains alkali metal salts derived from C1 Class of Carboxylic Acids having 1 carbon atom, specifically, the C1 carboxylic acid, called formic acid (i.e. methanoic acid).

508. An environmentally-clean fire inhibiting pMDI resin binder material for binding together lignocellulosic-based wood furnish material during composite wood product manufacture, comprising:
a minor amount of potassium formate in dry powder form; and
a minor amount of an alkali metal salt of benzoic acid in dry powder form, mixed with said potassium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium formate and said alkali metal salt of benzoic acid, are blended with a major amount of polymeric resin binder material, for binding lignocellulosic-based wood furnish material during composite wood product manufacture, the potassium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium formate powder

509. An environmentally-clean fire inhibiting pMDI resin binder material for binding together lignocellulosic-based wood furnish material during composite wood product manufacture, comprising:
a minor amount of calcium formate in dry powder form; and
a minor amount of an alkali metal salt of benzoic acid in dry powder form, mixed with said calcium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium formate and said alkali metal salt of benzoic acid, are blended with a major amount of polymeric resin binder material, for binding lignocellulosic-based wood furnish material during composite wood product manufacture, the calcium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium formate powder particles that are freely available to inhibit fire ignition, flame spread and smoke development.

510. An environmentally-clean fire inhibiting pMDI resin binder material for binding together lignocellulosic-based wood furnish material during composite wood product manufacture, comprising:
a minor amount of sodium formate in dry powder form; and
a minor amount of an alkali metal salt of benzoic acid in dry powder form, mixed with said sodium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium formate and said alkali metal salt of benzoic acid, are blended with a major amount of polymeric resin binder material, for binding lignocellulosic-based wood furnish material during composite wood product manufacture, the sodium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium formate powder particles that are freely available to inhibit fire ignition, flame spread and smoke development.

511. An environmentally-clean fire inhibiting pMDI resin binder material for binding together lignocellulosic-based wood furnish material during composite wood product manufacture, comprising:
a minor amount of magnesium formate in dry powder form; and
a minor amount of an alkali metal salt of benzoic acid in dry powder form, mixed with said magnesium formate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium formate and said alkali metal salt of benzoic acid, are blended with a major amount of polymeric resin binder material, for binding lignocellulosic-based wood furnish material during composite wood product manufacture, the magnesium formate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium formate powder

512. An environmentally-clean fire inhibiting pMDI resin binder material for binding together lignocellulosic-based wood furnish material during composite wood product manufacture, which contains alkali metal salts derived from C1 Class of Carboxylic Acids having 1 carbon atom, specifically, the C1 carboxylic acid (R—COOH), called carbonic acid (i.e. hydroxymethanoic acid), H₂CO₃ (CAS RN: 3159-41-9).

513. An environmentally-clean fire inhibiting pMDI resin binder material for binding together lignocellulosic-based wood furnish material during composite wood product manufacture, comprising:
a minor amount of potassium carbonate (bicarbonate) in dry powder form; and
a minor amount of an alkali metal salt of benzoic acid in dry powder form, mixed with said potassium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium carbonate and said alkali metal salt of benzoic acid, are blended with a major amount of polymeric resin binder material, for binding lignocellulosic-based wood furnish material during composite wood product manufacture, the potassium carbonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium carbonate powder

514. An environmentally-clean fire inhibiting pMDI resin binder material for binding together lignocellulosic-based wood furnish material during composite wood product manufacture, comprising:
a minor amount of sodium carbonate (bicarbonate) in dry powder form; and
a minor amount of an alkali metal salt of benzoic acid in dry powder form, mixed with said sodium carbonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium carbonate and said alkali metal salt of benzoic acid, are blended with a major amount of polymeric resin binder material, for binding lignocellulosic-based wood furnish material during composite wood product manufacture, the sodium carbonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium carbonate powder particles that are freely available to inhibit fire ignition, flame spread and smoke development.

515. An environmentally-clean fire inhibiting pMDI resin binder material for binding together lignocellulosic-based wood furnish material during composite wood product manufacture, which contains alkali metal salts derived from C1 Class of Carboxylic Acids having 1 carbon atom, specifically, the C1 carboxylic acid (R—COOH), called acetic acid (i.e. ethanoic acid), CH₃CO₂H (CAS RN: 64-19-7).

516. An environmentally-clean fire inhibiting pMDI resin binder material for binding together lignocellulosic-based wood furnish material during composite wood product manufacture, comprising:
a minor amount of potassium acetate in dry powder form; and
a minor amount of an alkali metal salt of benzoic acid in dry powder form, mixed with said potassium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium acetate and said alkali metal salt of benzoic acid, are blended with a major amount of polymeric resin binder material, for binding lignocellulosic-based wood furnish material during composite wood product manufacture, the potassium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium acetate powder particles that are freely available to inhibit fire ignition, flame spread and smoke development.

517. An environmentally-clean dry powder-based fire inhibiting biochemical composition for treating polymeric resin binder material used to bind together lignocellulosic-based wood furnish material during composite wood product manufacture, comprising:
a major amount of calcium acetate in dry powder form; and
a minor amount of an alkali metal salt of benzoic acid in dry powder form, mixed with said calcium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium acetate and said alkali metal salt of benzoic acid, are blended with a major amount of polymeric resin binder material, for binding lignocellulosic-based wood furnish material during composite wood product manufacture, the calcium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium acetate powder particles that are freely available to inhibit fire ignition, flame spread and smoke development.

518. An environmentally-clean fire inhibiting pMDI resin binder material for binding together lignocellulosic-based wood furnish material during composite wood product manufacture, comprising:
a minor amount of sodium acetate in dry powder form; and
a minor amount of an alkali metal salt of benzoic acid in dry powder form, mixed with said sodium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium acetate and said alkali metal salt of benzoic acid, are blended with a major amount of polymeric resin binder material, for binding lignocellulosic-based wood furnish material during composite wood product manufacture, the sodium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium acetate powder particles that are freely available to inhibit fire ignition, flame spread and smoke development.

519. An environmentally-clean fire inhibiting pMDI resin binder material for binding together lignocellulosic-based wood furnish material during composite wood product manufacture, comprising:
a major amount of magnesium acetate in dry powder form; and
a minor amount of an alkali metal salt of benzoic acid in dry powder form, mixed with said magnesium acetate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium acetate and said alkali metal salt of benzoic acid, are blended with a major amount of polymeric resin binder material, for binding lignocellulosic-based wood furnish material during composite wood product manufacture, the magnesium acetate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium acetate powder particles that are freely available to inhibit fire ignition, flame spread and smoke development.

520. An environmentally-clean fire inhibiting pMDI resin binder material for binding together lignocellulosic-based wood furnish material during composite wood product manufacture, which contains alkali metal salts derived from C2 Class of Carboxylic Acids having 2 carbon atoms, specifically, the C2 carboxylic acid, called glycolic acid (hydroxyacetic acid).

521. An environmentally-clean fire inhibiting pMDI resin binder material for binding together lignocellulosic-based wood furnish material during composite wood product manufacture, comprising:
a minor amount of potassium glycolate in dry powder form; and
a minor amount of an alkali metal salt of benzoic acid in dry powder form, mixed with said potassium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glycolate and said alkali metal salt of benzoic acid, are blended with a major amount of polymeric resin binder material, for binding lignocellulosic-based wood furnish material during composite wood product manufacture, the potassium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glycolate powder particles that are freely available to inhibit fire ignition, flame spread and smoke development.

522. An environmentally-clean dry powder-based fire inhibiting biochemical composition for treating polymeric resin binder material used to bind together lignocellulosic-based wood furnish material during composite wood product manufacture, comprising:
a minor amount of calcium glycolate in dry powder form; and
a minor amount of an alkali metal salt of benzoic acid in dry powder form, mixed with said calcium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glycolate and said alkali metal salt of benzoic acid, are blended with a major amount of polymeric resin binder material, for binding lignocellulosic-based wood furnish material during composite wood product manufacture, the calcium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glycolate powder particles that are freely available to inhibit fire ignition, flame spread and smoke development.

523. An environmentally-clean dry powder-based fire inhibiting biochemical composition for treating polymeric resin binder material used to bind together lignocellulosic-based wood furnish material during composite wood product manufacture, comprising:
a minor amount of sodium glycolate in dry powder form; and
a minor amount of an alkali metal salt of benzoic acid in dry powder form, mixed with said sodium glycolate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycolate and said alkali metal salt of benzoic acid, are blended with a major amount of polymeric resin binder material, for binding lignocellulosic-based wood furnish material during composite wood product manufacture, the sodium glycolate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium glycolate powder

524. An environmentally-clean dry powder-based fire inhibiting biochemical composition for treating polymeric resin binder material used to bind together lignocellulosic-based wood furnish material during composite wood product manufacture, wherein said dry powder-based fire inhibiting biochemical composition contains alkali metal salts derived from C2 Class of Carboxylic Acids having 2 carbon atoms, specifically, the C2 carboxylic acid, called glyoxylic acid (i.e. oxoacetic acid).

525. An environmentally-clean dry powder-based fire inhibiting biochemical composition for treating polymeric resin binder material used to bind together lignocellulosic-based wood furnish material during composite wood product manufacture, comprising:
a minor amount of potassium glyoxylate in dry powder form; and
a minor amount of an alkali metal salt of benzoic acid in dry powder form, mixed with said powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glyoxylate and said alkali metal salt of benzoic acid, are blended with a major amount of polymeric resin binder material, for binding lignocellulosic-based wood furnish material during composite wood product manufacture, the potassium glyoxylate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glyoxylate powder

526. An environmentally-clean dry powder-based fire inhibiting biochemical composition for treating polymeric resin binder material used to bind together lignocellulosic-based wood furnish material during composite wood product manufacture, comprising:
a minor amount of calcium glyoxylate in dry powder form; and
a minor amount of an alkali metal salt of benzoic acid in dry powder form, mixed with said calcium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glyoxylate and said alkali metal salt of benzoic acid, are blended with a major amount of polymeric resin binder material, for binding lignocellulosic-based wood furnish material during composite wood product manufacture, the calcium glyoxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glyoxylate powder particles that are freely available to inhibit fire ignition, flame spread and smoke development.

527. An environmentally-clean dry powder-based fire inhibiting biochemical composition for treating polymeric resin binder material used to bind together lignocellulosic-based wood furnish material during composite wood product manufacture, comprising:
a minor amount of sodium glyoxylate in dry powder form; and
a minor amount of an alkali metal salt of benzoic acid in dry powder form, mixed with said sodium glyoxylate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium glyoxylate and said alkali metal salt of benzoic acid, are blended with a major amount of polymeric resin binder material, for binding lignocellulosic-based wood furnish material during composite wood product manufacture, the sodium glyoxylate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium glyoxylate powder particles that are freely available to inhibit fire ignition, flame spread and smoke development.

528. An environmentally-clean dry powder-based fire inhibiting biochemical composition for treating polymeric resin binder material used to bind together lignocellulosic-based wood furnish material during composite wood product manufacture, comprising:
a minor amount of potassium oxalate in dry powder form; and
a minor amount of an alkali metal salt of benzoic acid in dry powder form, mixed with said potassium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium oxalate and said alkali metal salt of benzoic acid, are blended with a major amount of polymeric resin binder material, for binding lignocellulosic-based wood furnish material during composite wood product manufacture, the potassium oxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium oxalate powder particles that are freely available to inhibit fire ignition, flame spread and smoke development.

529. An environmentally-clean dry powder-based fire inhibiting biochemical composition for treating polymeric resin binder material used to bind together lignocellulosic-based wood furnish material during composite wood product manufacture, comprising:
a major amount of calcium oxalate in dry powder form; and
a minor amount of an alkali metal salt of benzoic acid in dry powder form, mixed with said calcium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium oxalate and said alkali metal salt of benzoic acid, are blended with a major amount of polymeric resin binder material, for binding lignocellulosic-based wood furnish material during composite wood product manufacture, the calcium oxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium oxalate powder particles that are freely available to inhibit fire ignition, flame spread and smoke development.

530. An environmentally-clean dry powder-based fire inhibiting biochemical composition
a minor amount of sodium oxalate in dry powder form; and
a minor amount of an alkali metal salt of benzoic acid in dry powder form, mixed with said sodium oxalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium oxalate and said alkali metal salt of benzoic acid, are blended with a major amount of polymeric resin binder material, for binding lignocellulosic-based wood furnish material during composite wood product manufacture, the sodium oxalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium oxalate powder particles that are freely available to inhibit fire ignition, flame spread and smoke development.

531. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid (R—COOH), called propionic acid (i.e. ethanecarboxylic acid), C₃H₆O (CAS RN: 79-09-04):

532. An environmentally-clean dry powder-based fire inhibiting biochemical composition for treating polymeric resin binder material used to bind together lignocellulosic-based wood furnish material during composite wood product manufacture, comprising:
a minor amount of potassium propionate in dry powder form; and
a minor amount of an alkali metal salt of benzoic acid in dry powder form, mixed with said potassium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium propionate and said alkali metal salt of benzoic acid, are blended with a major amount of polymeric resin binder material, for binding lignocellulosic-based wood furnish material during composite wood product manufacture, the potassium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium propionate powder particles that are freely available to inhibit fire ignition, flame spread and smoke development.

533. An environmentally-clean dry powder-based fire inhibiting biochemical composition for treating polymeric resin binder material used to bind together lignocellulosic-based wood furnish material during composite wood product manufacture, comprising:
a minor amount of calcium propionate in dry powder form; and
a minor amount of an alkali metal salt of benzoic acid in dry powder form, mixed with said calcium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium propionate and said alkali metal salt of benzoic acid, are blended with a major amount of polymeric resin binder material, for binding lignocellulosic-based wood furnish material during composite wood product manufacture, the calcium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium propionate powder particles that are freely available to inhibit fire ignition, flame spread and smoke development.

534. An environmentally-clean dry powder-based fire inhibiting biochemical composition for treating polymeric resin binder material used to bind together lignocellulosic-based wood furnish material during composite wood product manufacture, comprising:
a minor amount of sodium propionate in dry powder form; and
a minor amount of an alkali metal salt of benzoic acid in dry powder form, mixed with said sodium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium propionate and said alkali metal salt of benzoic acid, are blended with a major amount of polymeric resin binder material, for binding lignocellulosic-based wood furnish material during composite wood product manufacture, the sodium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium propionate powder

535. An environmentally-clean dry powder-based fire inhibiting biochemical composition for treating polymeric resin binder material used to bind together lignocellulosic-based wood furnish material during composite wood product manufacture, comprising:
a minor amount of magnesium propionate in dry powder form; and
a minor amount of an alkali metal salt of benzoic acid in dry powder form, mixed with said magnesium propionate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium propionate and said alkali metal salt of benzoic acid, are blended with a major amount of polymeric resin binder material, for binding lignocellulosic-based wood furnish material during composite wood product manufacture, the magnesium propionate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium propionate powder particles that are freely available to inhibit fire ignition, flame spread and smoke development.

536. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called lactic acid.

537. An environmentally-clean dry powder-based fire inhibiting biochemical composition for treating polymeric resin binder material used to bind together lignocellulosic-based wood furnish material during composite wood product manufacture, comprising:
a minor amount of potassium lactate in dry powder form; and
a minor amount of an alkali metal salt of benzoic acid in dry powder form, mixed with said potassium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium lactate and said alkali metal salt of benzoic acid, are blended with a major amount of polymeric resin binder material, for binding lignocellulosic-based wood furnish material during composite wood product manufacture, the potassium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium lactate powder particles that are freely available to inhibit fire ignition, flame spread and smoke development.

538. An environmentally-clean dry powder-based fire inhibiting biochemical composition for treating polymeric resin binder material used to bind together lignocellulosic-based wood furnish material during composite wood product manufacture, comprising:
a major amount of calcium lactate in dry powder form; and
a minor amount of an alkali metal salt of benzoic acid in dry powder form, mixed with said calcium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium lactate and said alkali metal salt of benzoic acid, are blended with a major amount of polymeric resin binder material, for binding lignocellulosic-based wood furnish material during composite wood product manufacture, the calcium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium lactate powder particles that are freely available to inhibit fire ignition, flame spread and smoke development.

539. An environmentally-clean dry powder-based fire inhibiting biochemical composition for treating polymeric resin binder material used to bind together lignocellulosic-based wood furnish material during composite wood product manufacture, comprising:
a major amount of sodium lactate in dry powder form; and
a minor amount of an alkali metal salt of benzoic acid in dry powder form, mixed with said sodium lactate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium lactate and said alkali metal salt of benzoic acid, are blended with a major amount of polymeric resin binder material, for binding lignocellulosic-based wood furnish material during composite wood product manufacture, the sodium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium lactate powder particles that are freely available to inhibit fire ignition, flame spread and smoke development.

540. An environmentally-clean dry powder-based fire inhibiting biochemical composition for treating polymeric resin binder material used to bind together lignocellulosic-based wood furnish material during composite wood product manufacture, comprising:
a minor amount of magnesium lactate in dry powder form; and
a minor amount of an alkali metal salt of benzoic acid in dry powder form, mixed with said magnesium powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium lactate and said alkali metal salt of benzoic acid, are blended with a major amount of polymeric resin binder material, for binding lignocellulosic-based wood furnish material during composite wood product manufacture, the magnesium lactate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium lactate powder particles that are freely available to inhibit fire ignition, flame spread and smoke development.

541. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called glyceric acid (2,3-dihydroxypropanoic acid).

542. An environmentally-clean dry powder-based fire inhibiting biochemical composition for treating polymeric resin binder material used to bind together lignocellulosic-based wood furnish material during composite wood product manufacture, comprising:
a minor amount of potassium glycerate in dry powder form; and
a minor amount of an alkali metal salt of benzoic acid in dry powder form, mixed with said potassium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium glycerate and said alkali metal salt of benzoic acid, are blended with a major amount of polymeric resin binder material, for binding lignocellulosic-based wood furnish material during composite wood product manufacture, the potassium glycerate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium glycerate powder particles that are freely available to inhibit fire ignition, flame spread and smoke development.

543. An environmentally-clean dry powder-based fire inhibiting biochemical composition for treating polymeric resin binder material used to bind together lignocellulosic-based wood furnish material during composite wood product manufacture, comprising:
a minor amount of calcium glycerate in dry powder form; and
a minor amount of an alkali metal salt of benzoic acid in dry powder form, mixed with said calcium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium glycerate and said alkali metal salt of benzoic acid, are blended with a major amount of polymeric resin binder material, for binding lignocellulosic-based wood furnish material during composite wood product manufacture, the calcium glycerate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium glycerate powder particles that are freely available to inhibit fire ignition, flame spread and smoke development.

544. An environmentally-clean dry powder-based fire inhibiting biochemical composition for treating polymeric resin binder material used to bind together lignocellulosic-based wood furnish material during composite wood product manufacture, comprising:
a minor amount of sodium glycerate in dry powder form; and
a minor amount of an alkali metal salt of benzoic acid in dry powder form, mixed with said sodium glycerate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said sodium glycerate and said alkali metal salt of benzoic acid, are blended with a major amount of polymeric resin binder material, for binding lignocellulosic-based wood furnish material during composite wood product manufacture, the sodium glycerate powder particles are well dispersed within the lignocellulosic-based wood furnish material, and supporting sodium glycerate powder particles that are freely available to inhibit fire ignition, flame spread and smoke development.

545. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called pyruvic acid (i.e. 2-oxopropanoic acid).

546. An environmentally-clean dry powder-based fire inhibiting biochemical composition for treating polymeric resin binder material used to bind together lignocellulosic-based wood furnish material during composite wood product manufacture, comprising:
a minor amount of potassium pyruvate in dry powder form; and
a minor amount of an alkali metal salt of benzoic acid in dry powder form, mixed with said potassium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium pyruvate and said alkali metal salt of benzoic acid, are blended with a major amount of polymeric resin binder material, for binding lignocellulosic-based wood furnish material during composite wood product manufacture, the potassium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pyruvate powder

547. An environmentally-clean dry powder-based fire inhibiting biochemical composition for treating polymeric resin binder material used to bind together lignocellulosic-based wood furnish material during composite wood product manufacture, comprising:
a minor amount of calcium pyruvate in dry powder form; and
a minor amount of an alkali metal salt of benzoic acid in dry powder form, mixed with said calcium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium pyruvate and said alkali metal salt of benzoic acid, are blended with a major amount of polymeric resin binder material, for binding lignocellulosic-based wood furnish material during composite wood product manufacture, the calcium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium pyruvate powder particles that are freely available to inhibit fire ignition, flame spread and smoke development.

548. An environmentally-clean dry powder-based fire inhibiting biochemical composition for treating polymeric resin binder material used to bind together lignocellulosic-based wood furnish material during composite wood product manufacture, comprising:
a major amount of sodium pyruvate in dry powder form; and
a minor amount of an alkali metal salt of benzoic acid in dry powder form, mixed with said pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium pyruvate and said alkali metal salt of benzoic acid, are blended with a major amount of polymeric resin binder material, for binding lignocellulosic-based wood furnish material during composite wood product manufacture, the sodium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pyruvate powder particles that are freely available to inhibit fire ignition, flame spread and smoke development.

549. An environmentally-clean dry powder-based fire inhibiting biochemical composition for treating polymeric resin binder material used to bind together lignocellulosic-based wood furnish material during composite wood product manufacture, comprising:
a minor amount of magnesium pyruvate in dry powder form; and
a minor amount of an alkali metal salt of benzoic acid in dry powder form, mixed with said magnesium pyruvate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium pyruvate and said alkali metal salt of benzoic acid, are blended with a major amount of polymeric resin binder material, for binding lignocellulosic-based wood furnish material during composite wood product manufacture, the magnesium pyruvate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium pyruvate powder particles that are freely available to inhibit fire ignition, flame spread and smoke development.

550. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C3 Class of Carboxylic Acids having 3 carbon atoms, specifically, the C3 carboxylic acid, called tartaric acid, (i.e. 2-hydroxypropanedioic acid). An environmentally-clean dry powder-based fire inhibiting biochemical composition for treating polymeric resin binder material used to bind together lignocellulosic-based wood furnish material during composite wood product manufacture, comprising:
a minor amount of potassium tartrate in dry powder form; and
a minor amount of an alkali metal salt of benzoic acid in dry powder form, mixed with said potassium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium tartrate and said alkali metal salt of benzoic acid, are blended with a major amount of polymeric resin binder material, for binding lignocellulosic-based wood furnish material during composite wood product manufacture, the potassium tartrate powder particles are well dispersed within the lignocellulosic-based wood furnish material, and supporting potassium tartrate powder particles that are freely available to inhibit fire ignition, flame spread and smoke development.

551. An environmentally-clean dry powder-based fire inhibiting biochemical composition for treating polymeric resin binder material used to bind together lignocellulosic-based wood furnish material during composite wood product manufacture, comprising:
a minor amount of calcium tartrate in dry powder form; and
a minor amount of an alkali metal salt of benzoic acid in dry powder form, mixed with said calcium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium tartrate and said alkali metal salt of benzoic acid, are blended with a major amount of polymeric resin binder material, for binding lignocellulosic-based wood furnish material during composite wood product manufacture, the calcium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium tartrate powder particles that are freely available to inhibit fire ignition, flame spread and smoke development.

552. An environmentally-clean dry powder-based fire inhibiting biochemical composition for treating polymeric resin binder material used to bind together lignocellulosic-based wood furnish material during composite wood product manufacture, comprising:
a minor amount of sodium tartrate in dry powder form; and
a minor amount of an alkali metal salt of benzoic acid in dry powder form, mixed with said sodium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium tartrate and said alkali metal salt of benzoic acid, are blended with a major amount of polymeric resin binder material, for binding lignocellulosic-based wood furnish material during composite wood product manufacture, the sodium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium tartrate powder particles that are freely available to inhibit fire ignition, flame spread and smoke development.

553. An environmentally-clean dry powder-based fire inhibiting biochemical composition for treating polymeric resin binder material used to bind together lignocellulosic-based wood furnish material during composite wood product manufacture, comprising:
a minor amount of magnesium tartrate in dry powder form; and
a minor amount of an alkali metal salt of benzoic acid in dry powder form, mixed with said magnesium tartrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium tartrate and said alkali metal salt of benzoic acid, are blended with a major amount of polymeric resin binder material, for binding lignocellulosic-based wood furnish material during composite wood product manufacture, the magnesium tartrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium tartrate powder particles that are freely available to inhibit fire ignition, flame spread and smoke development.

554. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called butyric acid (butanoic acid, propanecarboxylic acid).

555. An environmentally-clean dry powder-based fire inhibiting biochemical composition for treating polymeric resin binder material used to bind together lignocellulosic-based wood furnish material during composite wood product manufacture, comprising:
a minor amount of potassium butyrate in dry powder form; and
a minor amount of an alkali metal salt of benzoic acid in dry powder form, mixed with said potassium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium butyrate and said alkali metal salt of benzoic acid, are blended with a major amount of polymeric resin binder material, for binding lignocellulosic-based wood furnish material during composite wood product manufacture, the potassium butyrate powder particles are well dispersed within the material is cured during composite wood product manufacture, the finished composite wood product contains cured polymeric resin binder material, binding together lignocellulosic-based wood furnish material, and supporting potassium butyrate powder particles that are freely available to inhibit fire ignition, flame spread and smoke development.

556. An environmentally-clean dry powder-based fire inhibiting biochemical composition for treating polymeric resin binder material used to bind together lignocellulosic-based wood furnish material during composite wood product manufacture, comprising:
a minor amount of calcium butyrate in dry powder form; and
a minor amount of an alkali metal salt of benzoic acid in dry powder form, mixed with said calcium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium butyrate and said alkali metal salt of benzoic acid, are blended with a major amount of polymeric resin binder material, for binding lignocellulosic-based wood furnish material during composite wood product manufacture, the calcium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium butyrate powder particles that are freely available to inhibit fire ignition, flame spread and smoke development.

557. An environmentally-clean dry powder-based fire inhibiting biochemical composition
a minor amount of sodium butyrate in dry powder form; and
a minor amount of an alkali metal salt of benzoic acid in dry powder form, mixed with said sodium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium butyrate and said alkali metal salt of benzoic acid, are blended with a major amount of polymeric resin binder material, for binding lignocellulosic-based wood furnish material during composite wood product manufacture, the sodium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium butyrate powder particles that are freely available to inhibit fire ignition, flame spread and smoke development.

558. An environmentally-clean dry powder-based fire inhibiting biochemical composition for treating polymeric resin binder material used to bind together lignocellulosic-based wood furnish material during composite wood product manufacture, comprising:
a minor amount of magnesium butyrate in dry powder form; and
a minor amount of an alkali metal salt of benzoic acid in dry powder form, mixed with said magnesium butyrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium butyrate and said alkali metal salt of benzoic acid, are blended with a major amount of polymeric resin binder material, for binding lignocellulosic-based wood furnish material during composite wood product manufacture, the magnesium butyrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium butyrate powder particles that are freely available to inhibit fire ignition, flame spread and smoke development.

559. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic, called malic acid.

560. An environmentally-clean dry powder-based fire inhibiting biochemical composition for treating polymeric resin binder material used to bind together lignocellulosic-based wood furnish material during composite wood product manufacture, comprising:
a minor amount of potassium malate in dry powder form; and
a minor amount of an alkali metal salt of benzoic acid in dry powder form, mixed with said potassium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium malate and said alkali metal salt of benzoic acid, are blended with a major amount of polymeric resin binder material, for binding lignocellulosic-based wood furnish material during composite wood product manufacture, the potassium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malate powder particles that are freely available to inhibit fire ignition, flame spread and smoke development.

561. An environmentally-clean dry powder-based fire inhibiting biochemical composition for treating polymeric resin binder material used to bind together lignocellulosic-based wood furnish material during composite wood product manufacture, comprising:
a minor amount of calcium malate in dry powder form; and
a minor amount of an alkali metal salt of benzoic acid in dry powder form, mixed with said calcium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium malate and said alkali metal salt of benzoic acid, are blended with a major amount of polymeric resin binder material, for binding lignocellulosic-based wood furnish material during composite wood product manufacture, the calcium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malate powder particles that are freely available to inhibit fire ignition, flame spread and smoke development.

562. An environmentally-clean dry powder-based fire inhibiting biochemical composition for treating polymeric resin binder material used to bind together lignocellulosic-based wood furnish material during composite wood product manufacture, comprising:
a minor amount of sodium malate in dry powder form; and
a minor amount of an alkali metal salt of benzoic acid in dry powder form, mixed with said sodium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium malate and said alkali metal salt of benzoic acid, are blended with a major amount of polymeric resin binder material, for binding lignocellulosic-based wood furnish material during composite wood product manufacture, the sodium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malate powder particles that are freely available to inhibit fire ignition, flame spread and smoke development.

563. An environmentally-clean dry powder-based fire inhibiting biochemical composition for treating polymeric resin binder material used to bind together lignocellulosic-based wood furnish material during composite wood product manufacture, comprising:
a minor amount of magnesium malate in dry powder form; and
a minor amount of an alkali metal salt of benzoic acid in dry powder form, mixed with said magnesium malate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium malate and said alkali metal salt of benzoic acid, are blended with a major amount of polymeric resin binder material, for binding lignocellulosic-based wood furnish material during composite wood product manufacture, the magnesium malate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium malate powder particles that are freely available to inhibit fire ignition, flame spread and smoke development.

564. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C4 Class of Carboxylic Acids having 4 carbon atoms, specifically, the C4 carboxylic acid, called malonic acid.

565. An environmentally-clean dry powder-based fire inhibiting biochemical composition for treating polymeric resin binder material used to bind together lignocellulosic-based wood furnish material during composite wood product manufacture, comprising:
a minor amount of potassium malonate in dry powder form; and
a minor amount of an alkali metal salt of benzoic acid in dry powder form, mixed with said potassium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium malonate and said alkali metal salt of benzoic acid, are blended with a major amount of polymeric resin binder material, for binding lignocellulosic-based wood furnish material during composite wood product manufacture, the potassium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium malonate powder particles that are freely available to inhibit fire ignition, flame spread and smoke development.

566. An environmentally-clean dry powder-based fire inhibiting biochemical composition for treating polymeric resin binder material used to bind together lignocellulosic-based wood furnish material during composite wood product manufacture, comprising:
a minor amount of calcium malonate in dry powder form; and
a minor amount of an alkali metal salt of benzoic acid in dry powder form, mixed with said calcium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium malonate and said alkali metal salt of benzoic acid, are blended with a major amount of polymeric resin binder material, for binding lignocellulosic-based wood furnish material during composite wood product manufacture, the calcium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium malonate powder

567. An environmentally-clean dry powder-based fire inhibiting biochemical composition for treating polymeric resin binder material used to bind together lignocellulosic-based wood furnish material during composite wood product manufacture, comprising:
a minor amount of sodium malonate in dry powder form; and
a minor amount of an alkali metal salt of benzoic acid in dry powder form, mixed with said sodium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium malonate and said alkali metal salt of benzoic acid, are blended with a major amount of polymeric resin binder material, for binding lignocellulosic-based wood furnish material during composite wood product manufacture, the sodium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium malonate powder particles that are freely available to inhibit fire ignition, flame spread and smoke development.

568. An environmentally-clean dry powder-based fire inhibiting biochemical composition for treating polymeric resin binder material used to bind together lignocellulosic-based wood furnish material during composite wood product manufacture, comprising:
a minor amount of dimagnesium malonate in dry powder form; and
a minor amount of an alkali metal salt of benzoic acid in dry powder form, mixed with said dimagnesium malonate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said dimagnesium malonate and said alkali metal salt of benzoic acid, are blended with a major amount of polymeric resin binder material, for binding lignocellulosic-based wood furnish material during composite wood product manufacture, the dimagnesium malonate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting dimagnesium malonate powder particles that are freely available to inhibit fire ignition, flame spread and smoke development.

569. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C5 Class of Carboxylic Acids having 5 carbon atoms, specifically, the C5 carboxylic acid, called pivalic acid (i.e. trimethylacetic acid; neopentanoic acid).

570. An environmentally-clean dry powder-based fire inhibiting biochemical composition for treating polymeric resin binder material used to bind together lignocellulosic-based wood furnish material during composite wood product manufacture, comprising:
a minor amount of potassium pivalate in dry powder form; and
a minor amount of an alkali metal salt of benzoic acid in dry powder form, mixed with said potassium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium pivalate and said alkali metal salt of benzoic acid, are blended with a major amount of polymeric resin binder material, for binding lignocellulosic-based wood furnish material during composite wood product manufacture, the potassium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium pivalate powder particles that are freely available to inhibit fire ignition, flame spread and smoke development.

571. An environmentally-clean dry powder-based fire inhibiting biochemical composition for treating polymeric resin binder material used to bind together lignocellulosic-based wood furnish material during composite wood product manufacture, comprising:
a minor amount of calcium pivalate in dry powder form; and
a minor amount of an alkali metal salt of benzoic acid in dry powder form, mixed with said calcium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium pivalate and said alkali metal salt of benzoic acid, are blended with a major amount of polymeric resin binder material, for binding lignocellulosic-based wood furnish material during composite wood product manufacture, the calcium pivalate powder particles are well dispersed within the lignocellulosic-based wood furnish material, and supporting calcium pivalate powder particles that are freely available to inhibit fire ignition, flame spread and smoke development.

572. An environmentally-clean dry powder-based fire inhibiting biochemical composition for treating polymeric resin binder material used to bind together lignocellulosic-based wood furnish material during composite wood product manufacture, comprising:
a minor amount of sodium pivalate in dry powder form; and
a minor amount of an alkali metal salt of benzoic acid in dry powder form, mixed with said sodium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium pivalate and said alkali metal salt of benzoic acid, are blended with a major amount of polymeric resin binder material, for binding lignocellulosic-based wood furnish material during composite wood product manufacture, the sodium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium pivalate powder particles that are freely available to inhibit fire ignition, flame spread and smoke development.

573. An environmentally-clean dry powder-based fire inhibiting biochemical composition for treating polymeric resin binder material used to bind together lignocellulosic-based wood furnish material during composite wood product manufacture, comprising:
a minor amount of magnesium pivalate in dry powder form; and
a minor amount of an alkali metal salt of benzoic acid in dry powder form, mixed with said magnesium pivalate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium pivalate and said alkali metal salt of benzoic acid, are blended with a major amount of polymeric resin binder material, for binding lignocellulosic-based wood furnish material during composite wood product manufacture, the magnesium pivalate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium pivalate powder particles that are freely available to inhibit fire ignition, flame spread and smoke development.

574. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called caproic acid (hexanoic acid).

575. An environmentally-clean dry powder-based fire inhibiting biochemical composition for treating polymeric resin binder material used to bind together lignocellulosic-based wood furnish material during composite wood product manufacture, comprising:
a minor amount of potassium caproate in dry powder form; and
a minor amount of an alkali metal salt of benzoic acid in dry powder form, mixed with said potassium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said potassium caproate and said alkali metal salt of benzoic acid, are blended with a major amount of polymeric resin binder material, for binding lignocellulosic-based wood furnish material during composite wood product manufacture, the potassium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium caproate powder particles that are freely available to inhibit fire ignition, flame spread and smoke development.

576. An environmentally-clean dry powder-based fire inhibiting biochemical composition for treating polymeric resin binder material used to bind together lignocellulosic-based wood furnish material during composite wood product manufacture, comprising:
a minor amount of calcium caproate in dry powder form; and
a minor amount of an alkali metal salt of benzoic acid in dry powder form, mixed with said calcium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium caproate and said alkali metal salt of benzoic acid, are blended with a major amount of polymeric resin binder material, for binding lignocellulosic-based wood furnish material during composite wood product manufacture, the calcium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium caproate powder particles that are freely available to inhibit fire ignition, flame spread and smoke development.

577. An environmentally-clean dry powder-based fire inhibiting biochemical composition for treating polymeric resin binder material used to bind together lignocellulosic-based wood furnish material during composite wood product manufacture, comprising:
a minor amount of sodium caproate in dry powder form; and
a minor amount of an alkali metal salt of benzoic acid in dry powder form, mixed with said sodium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium caproate and said alkali metal salt of benzoic acid, are blended with a major amount of polymeric resin binder material, for binding lignocellulosic-based wood furnish material during composite wood product manufacture, the sodium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium caproate powder

578. An environmentally-clean dry powder-based fire inhibiting biochemical composition for treating polymeric resin binder material used to bind together lignocellulosic-based wood furnish material during composite wood product manufacture, comprising:
a minor amount of magnesium caproate in dry powder form; and
a minor amount of an alkali metal salt of benzoic acid in dry powder form, mixed with said magnesium caproate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said magnesium caproate and said alkali metal salt of benzoic acid, are blended with a major amount of polymeric resin binder material, for binding lignocellulosic-based wood furnish material during composite wood product manufacture, the magnesium caproate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium caproate powder particles that are freely available to inhibit fire ignition, flame spread and smoke development.

579. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called adipic (hexanedioic) acid.

580. An environmentally-clean dry powder-based fire inhibiting biochemical composition for treating polymeric resin binder material used to bind together lignocellulosic-based wood furnish material during composite wood product manufacture, comprising:
a minor amount of potassium adipate in dry powder form; and
a minor amount of an alkali metal salt of benzoic acid in dry powder form, mixed with said potassium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium adipate and said alkali metal salt of benzoic acid, are blended with a major amount of polymeric resin binder material, for binding lignocellulosic-based wood furnish material during composite wood product manufacture, the potassium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium adipate powder particles that are freely available to inhibit fire ignition, flame spread and smoke development.

581. An environmentally-clean dry powder-based fire inhibiting biochemical composition for treating polymeric resin binder material used to bind together lignocellulosic-based wood furnish material during composite wood product manufacture, comprising:
a minor amount of calcium adipate in dry powder form; and
a minor amount of an alkali metal salt of benzoic acid in dry powder form, mixed with said calcium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium; and
wherein when said dry powder mixture of said calcium adipate and said alkali metal salt of benzoic acid, are blended with a major amount of polymeric resin binder material, for binding lignocellulosic-based wood furnish material during composite wood product manufacture, the calcium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium adipate powder particles that are freely available to inhibit fire ignition, flame spread and smoke development.

582. An environmentally-clean dry powder-based fire inhibiting biochemical composition for treating polymeric resin binder material used to bind together lignocellulosic-based wood furnish material during composite wood product manufacture, comprising:
a minor amount of sodium adipate in dry powder form; and
a minor amount of an alkali metal salt of benzoic acid in dry powder form, mixed with said sodium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium adipate and said alkali metal salt of benzoic acid, are blended with a major amount of polymeric resin binder material, for binding lignocellulosic-based wood furnish material during composite wood product manufacture, the sodium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium adipate powder particles that are freely available to inhibit fire ignition, flame spread and smoke development.

583. An environmentally-clean dry powder-based fire inhibiting biochemical composition for treating polymeric resin binder material used to bind together lignocellulosic-based wood furnish material during composite wood product manufacture, comprising:
a minor amount of magnesium adipate in dry powder form; and
a minor amount of an alkali metal salt of benzoic acid in dry powder form, mixed with said magnesium adipate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium adipate and said alkali metal salt of benzoic acid, are blended with a major amount of polymeric resin binder material, for binding lignocellulosic-based wood furnish material during composite wood product manufacture, the magnesium adipate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium adipate powder particles that are freely available to inhibit fire ignition, flame spread and smoke development.

584. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called citric acid.

585. An environmentally-clean dry powder-based fire inhibiting biochemical composition for treating polymeric resin binder material used to bind together lignocellulosic-based wood furnish material during composite wood product manufacture, comprising:
a minor amount of potassium citrate in dry powder form; and
a minor amount of an alkali metal salt of benzoic acid in dry powder form, mixed with said potassium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium citrate and said alkali metal salt of benzoic acid, are blended with a major amount of polymeric resin binder material, for binding lignocellulosic-based wood furnish material during composite wood product manufacture, the potassium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium citrate powder particles that are freely available to inhibit fire ignition, flame spread and smoke development.

586. An environmentally-clean dry powder-based fire inhibiting biochemical composition for treating polymeric resin binder material used to bind together lignocellulosic-based wood furnish material during composite wood product manufacture, comprising:
a minor amount of calcium citrate in dry powder form; and
a minor amount of an alkali metal salt of benzoic acid in dry powder form, mixed with said calcium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium citrate and said alkali metal salt of benzoic acid, are blended with a major amount of polymeric resin binder material, for binding lignocellulosic-based wood furnish material during composite wood product manufacture, the calcium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium citrate powder particles that are freely available to inhibit fire ignition, flame spread and smoke development.

587. An environmentally-clean dry powder-based fire inhibiting biochemical composition for treating polymeric resin binder material used to bind together lignocellulosic-based wood furnish material during composite wood product manufacture, comprising:
a minor amount of sodium citrate in dry powder form; and
a minor amount of an alkali metal salt of benzoic acid in dry powder form, mixed with said sodium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium citrate and said alkali metal salt of benzoic acid, are blended with a major amount of polymeric resin binder material, for binding lignocellulosic-based wood furnish material during composite wood product manufacture, the sodium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium citrate powder particles that are freely available to inhibit fire ignition, flame spread and smoke development.

588. An environmentally-clean dry powder-based fire inhibiting biochemical composition for treating polymeric resin binder material used to bind together lignocellulosic-based wood furnish material during composite wood product manufacture, comprising:
a minor amount of magnesium citrate in dry powder form; and
a minor amount of an alkali metal salt of benzoic acid in dry powder form, mixed with said magnesium citrate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium citrate and said alkali metal salt of benzoic acid, are blended with a major amount of polymeric resin binder material, for binding lignocellulosic-based wood furnish material during composite wood product manufacture, the magnesium citrate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium citrate powder particles that are freely available to inhibit fire ignition, flame spread and smoke development.

589. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, d-gluconic acid.

590. An environmentally-clean dry powder-based fire inhibiting biochemical composition for treating polymeric resin binder material used to bind together lignocellulosic-based wood furnish material during composite wood product manufacture, comprising:
a major amount of potassium gluconate in dry powder form;
a minor amount of an alkali metal salt of benzoic acid in dry powder form, mixed with said potassium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium gluconate and said alkali metal salt of benzoic acid, are blended with a major amount of polymeric resin binder material, for binding lignocellulosic-based wood furnish material during composite wood product manufacture, the potassium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium gluconate powder particles that are freely available to inhibit fire ignition, flame spread and smoke development.

591. An environmentally-clean dry powder-based fire inhibiting biochemical composition for treating polymeric resin binder material used to bind together lignocellulosic-based wood furnish material during composite wood product manufacture, comprising:
a minor amount of calcium gluconate in dry powder form;
a minor amount of an alkali metal salt of benzoic acid in dry powder form, mixed with said calcium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium gluconate and said alkali metal salt of benzoic acid, are blended with a major amount of polymeric resin binder material, for binding lignocellulosic-based wood furnish material during composite wood product manufacture, the calcium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium gluconate powder particles that are freely available to inhibit fire ignition, flame spread and smoke development.

592. An environmentally-clean dry powder-based fire inhibiting biochemical composition for treating polymeric resin binder material used to bind together lignocellulosic-based wood furnish material during composite wood product manufacture, comprising:
a minor amount of sodium gluconate in dry powder form;
a minor amount of an alkali metal salt of benzoic acid in dry powder form, mixed with said sodium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium gluconate and said alkali metal salt of benzoic acid, are blended with a major amount of polymeric resin binder material, for binding lignocellulosic-based wood furnish material during composite wood product manufacture, the sodium gluconate powder particles are well dispersed within the lignocellulosic-based wood furnish material, and supporting sodium gluconate powder particles that are freely available to inhibit fire ignition, flame spread and smoke development.

593. An environmentally-clean dry powder-based fire inhibiting biochemical composition for treating polymeric resin binder material used to bind together lignocellulosic-based wood furnish material during composite wood product manufacture, comprising:
a minor amount of magnesium gluconate in dry powder form;
a minor amount of an alkali metal salt of benzoic acid in dry powder form, mixed with said magnesium gluconate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium gluconate and said alkali metal salt of benzoic acid, are blended with a major amount of polymeric resin binder material, for binding lignocellulosic-based wood furnish material during composite wood product manufacture, the magnesium gluconate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium gluconate powder particles that are freely available to inhibit fire ignition, flame spread and smoke development.

594. An environmentally-clean dry powder-based fire inhibiting biochemical composition for treating polymeric resin binder material used to bind together lignocellulosic-based wood furnish material during composite wood product manufacture, wherein said dry-powder-based fire inhibiting biochemical composition contains alkali metal salts derived from C6 Class of Carboxylic Acids having 6 carbon atoms, specifically, the C6 carboxylic acid, called benzoic acid (benzenecarboxylic acid).

595. An environmentally-clean dry powder-based fire inhibiting biochemical composition for treating polymeric resin binder material used to bind together lignocellulosic-based wood furnish material during composite wood product manufacture, comprising:
a minor amount of potassium benzoate in dry powder form;
a minor amount of an alkali metal salt of benzoic acid in dry powder form, mixed with said potassium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said potassium benzoate and said alkali metal salt of benzoic acid, are blended with a major amount of polymeric resin binder material, for binding lignocellulosic-based wood furnish material during composite wood product manufacture, the potassium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting potassium benzoate powder particles that are freely available to inhibit fire ignition, flame spread and smoke development.

596. An environmentally-clean dry powder-based fire inhibiting biochemical composition for treating polymeric resin binder material used to bind together lignocellulosic-based wood furnish material during composite wood product manufacture, comprising:
a minor amount of calcium benzoate in dry powder form;
a minor amount of an alkali metal salt of benzoic acid in dry powder form, mixed with said calcium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said calcium benzoate and said alkali metal salt of benzoic acid, are blended with a major amount of polymeric resin binder material, for binding lignocellulosic-based wood furnish material during composite wood product manufacture, the calcium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting calcium benzoate powder particles that are freely available to inhibit fire ignition, flame spread and smoke development.

597. An environmentally-clean dry powder-based fire inhibiting biochemical composition for treating polymeric resin binder material used to bind together lignocellulosic-based wood furnish material during composite wood product manufacture, comprising:
a minor amount of sodium benzoate in dry powder form;
a minor amount of an alkali metal salt of benzoic acid in dry powder form, mixed with said sodium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said sodium benzoate and said alkali metal salt of benzoic acid, are blended with a major amount of polymeric resin binder material, for binding lignocellulosic-based wood furnish material during composite wood product manufacture, the sodium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting sodium benzoate powder particles that are freely available to inhibit fire ignition, flame spread and smoke development.

598. An environmentally-clean dry powder-based fire inhibiting biochemical composition for treating polymeric resin binder material used to bind together lignocellulosic-based wood furnish material during composite wood product manufacture, comprising:
a minor amount of magnesium benzoate in dry powder form;
a minor amount of an alkali metal salt of benzoic acid in dry powder form, mixed with said magnesium benzoate powder, wherein said alkali metal salt of benzoic acid is derived from benzoic acid and capable of producing benzoate ions when dissolved in the presence of water so as to form a protective coating on the surface of selected metals and/or metallic alloys, that protects said selected metals and/or metallic alloys against corrosion, wherein the alkali metals from which the alkali metal salts are derived, are selected from group consisting of potassium, sodium, calcium and magnesium;
wherein when said dry powder mixture of said magnesium benzoate and said alkali metal salt of benzoic acid, are blended with a major amount of polymeric resin binder material, for binding lignocellulosic-based wood furnish material during composite wood product manufacture, the magnesium benzoate powder particles are well dispersed within the treated polymeric resin binder material, and after the treated polymeric resin binder material is cured during composite wood product manufacture, the finished composite wood product contains cured polymeric resin binder material, binding together lignocellulosic-based wood furnish material, and supporting magnesium benzoate powder particles that are freely available to inhibit fire ignition, flame spread and smoke development.

599. An environmentally-clean aqueous-based fire inhibiting biochemical composition for treating lignocellulosic-based wood furnish material used during the production of composite wood products to be protected against fire ignition, comprising: (a) a dispersing agent realized in the form of a quantity of water, for dispersing alkali metal ions dissolved in water; (b) a fire inhibiting agent in the form of at least one alkali metal salt of a nonpolymeric saturated carboxylic acid, for providing metal ions dispersed in the water when the at least one alkali metal salt is dissolved in the water; and (c) a dispersing and coalescing agent in the form of an organic compound containing three carboxylic acid groups (or salt/ester derivatives thereof), such as triethyl citrate, an ester of citric acid, for dispersing and coalescing the metal ions when the fire inhibiting liquid composition is applied to lignocellulosic-based wood furnish surfaces during the production of composite wood products, while water molecules in the water evaporate during drying, and the alkali metal ions cooperate to form an alkali metal salt crystalline structure on the lignocellulosic-based wood furnish surfaces.

600. An environmentally-clean aqueous-based fire inhibiting biochemical composition for treating lignocellulosic-based wood furnish material used during the production of composite wood products to be protected against fire ignition, flame spread and smoke production, wherein the composite wood products are products selected from the group consisting of: oriented strand board (OSB) panels produced from long, slender strands that are aligned crosswise for a higher flexural strength than particleboard; oriented strands longer (OSL) panels with strands up to two times longer than for classic OSB are used for the production of OSL; Container OSB with a high-density, low-cost OSB core; Fine Surface OSB panels, wherein a OSB core layer is coated on both sides with a particleboard surface layer; and OSB panel with advanced core layer.

601. An environmentally-clean biochemical wood treatment composition (i.e. solution) for treating lignocellulosic-based (wood) furnish material, as well as solid wood materials such as lumber, during the manufacture of solid, composite and/or engineering wood based products used in the building, construction and/or home improvement industry, so as to provide fire inhibiting or fire resistant performance characteristics, comprising (i) a major amount of water, (ii) a major amount of metal alkali salt dissolved in the water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, (iii) a minor amount of alkali metal salt derived from of benzoic acid, wherein the alkali metal is selected from group consisting of potassium, sodium, calcium and magnesium, (iv) a minor amount of one or more esters derived from the saturated non-polymerized carboxylic acid and/or another saturated non-polymerized carboxylic acid, promoting dispersing and/or coalescing properties of metal alkali ions in the aqueous solution and formation of alkali metal salt crystalline structures and/or coatings on and/or within combustible materials upon the evaporation of water molecules from applied aqueous solution, and esterification of the lignocellulosic material being treated, and (iv) minor amount of metal salt derived from carboxylic acid for inhibiting metal corrosion, mold and microbial life.

602. An environmentally-clean biochemical wood treatment composition (i.e. solution) for treating lignocellulosic-based (wood) furnish material, as well as solid wood materials such as lumber, during the manufacture of solid, composite and/or engineering wood based products used in the building, construction and/or home improvement industry, so as to provide fire inhibiting or fire resistant performance characteristics, comprising (i) a major amount of water, (ii) a major amount of metal alkali salt dissolved in the water, and derived from a saturated non-polymerized carboxylic acid, wherein the carbon chain length of the carboxylic acid is C=6 (C6), and the resulting water-based liquid solution is stable when mixed so that its chemical components do not precipitate in the aqueous solution when stored in a storage container, (iii) a minor amount of alkali metal salt derived from of benzoic acid, wherein the alkali metal is selected from group consisting of potassium, sodium, calcium and magnesium, specifically potassium benzoate (SB), (iv) a minor amount of one or more esters derived from the saturated non-polymerized carboxylic acid and/or another saturated non-polymerized carboxylic acid, specifically triethyl citrate (TEC), promoting dispersing and/or coalescing properties of metal alkali ions in the aqueous solution and formation of alkali metal salt crystalline structures and/or coatings on or within combustible materials upon the evaporation of water molecules from applied aqueous solution, and esterification of the lignocellulosic material being treated, and (iv) minor amount of metal salt derived from carboxylic acid for inhibiting metal corrosion, mold and/or microbial life.

603. An environmentally-clean dry powder biochemical wood treatment compositions, for treating lignocellulosic material (i.e. wood furnish material) during factory-based wood product manufacture, and consisting of major amounts of dry tripotassium citrate monohydrate (TPC), minor amounts of triethyl citrate (TEC), and minor amounts of potassium benzoate, with these components prepared and ready for mixing with a predetermined quantity of polymeric resin in an uncured liquid state during wood furnish resination operations, to make up a fire inhibiting polymeric resin composition for use in mixing with and binding together lignocellulosic (wood) furnish material that is molded into wood products and subject to pressure and heat energy to cure the fire inhibiting polymeric resin composition and produce fire-protected finished wood products.

604. An environmentally-clean aqueous-based liquid biochemical wood treatment composition derived from the C1-Class of saturated non-polymerized carboxylic acid called formic acid, consisting of (i) a major amount of potassium formate, (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

605. An environmentally-clean aqueous-based liquid biochemical wood treatment composition derived from the C1-Class of saturated non-polymerized carboxylic acid called formic acid, consisting of (i) major amounts of calcium formate, and (ii) a minor amount of methyl formate or triethyl citrate (TEC) formulated with and dissolved in (iii) a major amount of water functioning as a solvent, carrier and dispersant to produce an environmentally-clean aqueous-based fire biochemical wood treatment solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

606. An environmentally-clean aqueous-based liquid biochemical wood treatment composition derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, application to lignocellulosic furnish material during the composite wood panel manufacturing process to inhibit fire ignition of wood material, flame spread, smoke development, metal corrosion of mounted fasteners, and decomposition of composite wood material.

607. An environmentally-clean aqueous-based liquid biochemical wood treatment composition derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid-called formic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

608. An environmentally-clean aqueous-based liquid biochemical wood treating composition derived from the C1-Class of saturated non-polymerized carboxylic acid called carbonic acid, consisting of (i) a major amount of potassium carbonate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

609. An environmentally-clean aqueous-based biochemical wood treatment composition derived from the C1-Class of saturated non-polymerized carboxylic acid called carbonic acid, consisting of (i) a major amount of sodium (bi) carbonate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C1-class of carboxylic acid-called carbonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

610. An environmentally-clean aqueous-based biochemical wood treatment composition derived from the C2-Class of saturated non-polymerized carboxylic acid called acetic acid, consisting of (i) a major amount of potassium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

611. An environmentally-clean aqueous-based biochemical wood treatment composition derived from the C2-Class of saturated non-polymerized carboxylic acid called acetic acid, consisting of (i) a major amount of calcium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

612. An environmentally-clean aqueous-based biochemical wood treatment composition derived from the C2-Class of saturated non-polymerized carboxylic acid called acetic acid, consisting of (i) a major amount of sodium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C12-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

613. An environmentally-clean aqueous-based biochemical wood treatment composition derived from the C2-Class of saturated non-polymerized carboxylic acid called acetic acid, consisting of (i) a major amount of magnesium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called acetic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

614. An environmentally-clean aqueous-based biochemical wood treatment composition derived from the C2-Class of saturated non-polymerized carboxylic acid called glycolic acid, consisting of (i) a major amount of potassium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

615. An environmentally-clean aqueous-based biochemical wood treatment composition derived from the C2-Class of saturated non-polymerized carboxylic acid called glycolic acid, consisting of (i) a major amount of calcium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

616. An environmentally-clean aqueous-based biochemical wood treatment composition derived from the C2-Class of saturated non-polymerized carboxylic acid called glycolic acid, consisting of (i) a major amount of sodium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glycolic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, flame spread, smoke development, metal corrosion of mounted fasteners, and decomposition of composite wood material.

617. An environmentally-clean aqueous-based biochemical wood treatment composition derived from the C2-Class of saturated non-polymerized carboxylic acid called glyoxylic acid, consisting of (i) a major amount of potassium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

618. An environmentally-clean aqueous-based biochemical wood treatment composition derived from the C2-Class of saturated non-polymerized carboxylic acid called glyoxylic acid, consisting of (i) a major amount of calcium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

619. An environmentally-clean aqueous-based biochemical wood treatment composition derived from the C2-Class of saturated non-polymerized carboxylic acid called glyoxylic acid, consisting of (i) a major amount of sodium glyoxylate, and (ii) a minor amount of triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called glyoxylic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

620. An environmentally-clean aqueous-based biochemical wood treatment composition derived from the C2-Class of saturated non-polymerized carboxylic acid called oxalic acid, consisting of (i) a major amount of potassium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

621. An environmentally-clean aqueous-based biochemical wood treatment composition derived from the C2-Class of saturated non-polymerized carboxylic acid called oxalic acid, consisting of (i) a major amount of calcium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

622. An environmentally-clean aqueous-based biochemical wood treatment composition derived from the C2-Class of saturated non-polymerized carboxylic acid called oxalic acid, consisting of (i) a major amount of sodium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based biochemical wood treatment solution based on the C2-class of carboxylic acid-called oxalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

623. An environmentally-clean aqueous-based biochemical wood treatment composition derived from the C3-Class of saturated non-polymerized carboxylic acid called propionic acid, consisting of (i) a major amount of potassium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

624. An environmentally-clean aqueous-based biochemical wood treatment composition derived from the C3-Class of saturated non-polymerized carboxylic acid called propionic acid, consisting of (i) a major amount of calcium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

625. An environmentally-clean aqueous-based fire inhibiting liquid biochemical composition derived from the C3-Class of saturated non-polymerized carboxylic acid called propionic acid, consisting of (i) a major amount of sodium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

626. An environmentally-clean aqueous-based biochemical wood treatment composition derived from the C3-Class of saturated non-polymerized carboxylic acid called propionic acid, consisting of (i) a major amount of magnesium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called propionic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

627. An environmentally-clean aqueous-based biochemical wood treatment composition derived from the C3-Class of saturated non-polymerized carboxylic acid called lactic acid, consisting of (i) a major amount of potassium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

628. An environmentally-clean aqueous-based biochemical wood treatment composition derived from the C3-Class of saturated non-polymerized carboxylic acid called lactic acid, consisting of (i) a major amount of calcium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

629. An environmentally-clean aqueous-based biochemical wood treatment composition derived from the C3-Class of saturated non-polymerized carboxylic acid called lactic acid, consisting of (i) a major amount of sodium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

630. An environmentally-clean aqueous-based biochemical wood treatment composition derived from the C3-Class of saturated non-polymerized carboxylic acid called lactic acid, consisting of (i) a major amount of magnesium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called lactic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of fasteners, and decomposition of wood material.

631. An environmentally-clean aqueous-based biochemical wood treatment composition derived from the C3-Class of saturated non-polymerized carboxylic acid called glyceric acid, consisting of (i) a major amount of potassium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

632. An environmentally-clean aqueous-based biochemical wood treatment composition derived from the C3-Class of saturated non-polymerized carboxylic acid called glyceric acid, consisting of (i) a major amount of calcium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

633. An environmentally-clean aqueous-based biochemical wood treatment composition derived from the C3-Class of saturated non-polymerized carboxylic acid called glyceric acid, consisting of (i) a major amount of sodium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called glyceric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

634. An environmentally-clean aqueous-based biochemical wood treatment composition derived from the C3-Class of saturated non-polymerized carboxylic acid called pyruvic acid, consisting of (i) a major amount of potassium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

635. An environmentally-clean aqueous-based biochemical wood treatment composition derived from the C3-Class of saturated non-polymerized carboxylic acid called pyruvic acid, consisting of (i) a major amount of calcium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

636. An environmentally-clean aqueous-based biochemical wood treatment composition derived from the C3-Class of saturated non-polymerized carboxylic acid called pyruvic acid, consisting of (i) a major amount of sodium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

637. An environmentally-clean aqueous-based biochemical wood treatment composition derived from the C3-Class of saturated non-polymerized carboxylic acid called pyruvic acid, consisting of (i) a major amount of magnesium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called pyruvic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

638. An environmentally-clean aqueous-based biochemical wood treatment composition derived from the C3-Class of saturated non-polymerized carboxylic acid called tartaric acid, consisting of (i) a major amount of potassium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

639. An environmentally-clean aqueous-based biochemical wood treatment composition derived from the C3-Class of saturated non-polymerized carboxylic acid called tartaric acid, consisting of (i) a major amount of calcium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

640. An environmentally-clean aqueous-based biochemical wood treatment composition derived from the C3-Class of saturated non-polymerized carboxylic acid called tartaric acid, consisting of (i) a major amount of sodium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

641. An environmentally-clean aqueous-based biochemical wood treatment composition derived from the C3-Class of saturated non-polymerized carboxylic acid called tartaric acid, consisting of (i) a major amount of magnesium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based biochemical wood treatment solution based on the C3-class of carboxylic acid-called tartaric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

642. An environmentally-clean aqueous-based biochemical wood treatment composition derived from the C4-Class of saturated non-polymerized carboxylic acid called butyric acid, consisting of (i) a major amount of potassium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

643. An environmentally-clean aqueous-based biochemical wood treatment composition derived from the C4-Class of saturated non-polymerized carboxylic acid called butyric acid, consisting of (i) a major amount of calcium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

644. An environmentally-clean aqueous-based biochemical wood treatment composition derived from the C4-Class of saturated non-polymerized carboxylic acid called butyric acid, consisting of (i) a major amount of sodium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

645. An environmentally-clean aqueous-based biochemical wood treatment composition derived from the C4-Class of saturated non-polymerized carboxylic acid called butyric acid, consisting of (i) a major amount of magnesium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called butyric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

646. An environmentally-clean aqueous-based biochemical wood treatment composition derived from the C4-Class of saturated non-polymerized carboxylic acid called malic acid, consisting of (i) a major amount of potassium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

647. An environmentally-clean aqueous-based biochemical wood treatment composition derived from the C4-Class of saturated non-polymerized carboxylic acid called malic acid, consisting of (i) a major amount of calcium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

648. An environmentally-clean aqueous-based biochemical wood treatment composition derived from the C4-Class of saturated non-polymerized carboxylic acid called malic acid, consisting of (i) a major amount of sodium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

649. An environmentally-clean aqueous-based biochemical wood treatment composition derived from the C4-Class of saturated non-polymerized carboxylic acid called malic acid, consisting of (i) a major amount of magnesium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

650. An environmentally-clean aqueous-based biochemical wood treatment composition derived from the C4-Class of saturated non-polymerized carboxylic acid called malonic acid, consisting of (i) a major amount of potassium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

651. An environmentally-clean aqueous-based biochemical wood treatment composition derived from the C4-Class of saturated non-polymerized carboxylic acid called malonic acid, consisting of (i) a major amount of calcium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

652. An environmentally-clean aqueous-based biochemical wood treatment composition derived from the C4-Class of saturated non-polymerized carboxylic acid called malonic acid, consisting of (i) a major amount of sodium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

653. An environmentally-clean aqueous-based biochemical wood treatment composition derived from the C4-Class of saturated non-polymerized carboxylic acid called malonic acid, consisting of (i) a major amount of magnesium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based biochemical wood treatment solution based on the C4-class of carboxylic acid-called malonic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

654. An environmentally-clean aqueous-based biochemical wood treatment composition derived from the C5-Class of saturated non-polymerized carboxylic acid called pivalic acid, consisting of (i) a major amount of potassium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

655. An environmentally-clean aqueous-based biochemical wood treatment composition derived from the C5-Class of saturated non-polymerized carboxylic acid called pivalic acid, consisting of (i) a major amount of calcium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

656. An environmentally-clean aqueous-based biochemical wood treatment composition derived from the C5-Class of saturated non-polymerized carboxylic acid called pivalic acid, consisting of (i) a major amount of sodium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of fasteners, and decomposition of wood material.

657. An environmentally-clean aqueous-based biochemical wood treatment composition derived from the C5-Class of saturated non-polymerized carboxylic acid called pivalic acid, consisting of (i) a major amount of magnesium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based biochemical wood treatment solution based on the C5-class of carboxylic acid-called pivalic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

658. An environmentally-clean aqueous-based biochemical wood treatment composition derived from the C6-Class of saturated non-polymerized carboxylic acid called caproic acid, consisting of (i) a major amount of potassium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

659. An environmentally-clean aqueous-based biochemical wood treatment composition derived from the C6-Class of saturated non-polymerized carboxylic acid called caproic acid, consisting of (i) a major amount of calcium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

660. An environmentally-clean aqueous-based biochemical composition derived from the C6-Class of saturated non-polymerized carboxylic acid called caproic acid, consisting of (i) a major amount of sodium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called caproic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

661. An environmentally-clean aqueous-based biochemical wood treatment composition derived from the C6-Class of saturated non-polymerized carboxylic acid called caproic acid, consisting of (i) a major amount of magnesium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based wood treatment biochemical solution based on the C6-class of carboxylic acid-called caproic acid, and a minor amount of metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

662. An environmentally-clean aqueous-based biochemical composition derived from the C6-Class of saturated non-polymerized carboxylic acid called caproic acid, consisting of (i) a major amount of potassium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

663. An environmentally-clean aqueous-based biochemical composition derived from the C6-Class of saturated non-polymerized carboxylic acid called caproic acid, consisting of (i) a major amount of calcium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

664. An environmentally-clean aqueous-based biochemical wood treatment composition derived from the C6-Class of saturated non-polymerized carboxylic acid called caproic acid, consisting of (i) a major amount of sodium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

665. An environmentally-clean aqueous-based biochemical wood treatment composition derived from the C6-Class of saturated non-polymerized carboxylic acid called caproic acid, consisting of (i) a major amount of magnesium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called adipic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

666. An environmentally-clean aqueous-based biochemical composition derived from the C6-Class of saturated non-polymerized carboxylic acid called citric acid, consisting of (i) a major amount of tripotassium citrate (TPC), and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

667. An environmentally-clean aqueous-based biochemical wood treatment composition derived from the C6-Class of saturated non-polymerized carboxylic acid called citric acid, consisting of (i) a major amount of calcium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

668. An environmentally-clean aqueous-based biochemical wood treatment composition derived from the C6-Class of saturated non-polymerized carboxylic acid called citric acid, consisting of (i) a major amount of sodium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

669. An environmentally-clean aqueous-based biochemical wood treatment composition derived from the C6-Class of saturated non-polymerized carboxylic acid called citric acid, consisting of (i) a major amount of magnesium citrate, and (ii) a minor amount triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called citric acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

670. An environmentally-clean aqueous-based biochemical wood treatment composition derived from the C6-Class of saturated non-polymerized carboxylic acid called d-gluconic acid, consisting of (i) a major amount of potassium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

671. An environmentally-clean aqueous-based biochemical wood treatment composition derived from the C6-Class of saturated non-polymerized carboxylic acid called d-gluconic acid, consisting of (i) a major amount of calcium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

672. An environmentally-clean aqueous-based biochemical wood treatment composition derived from the C6-Class of saturated non-polymerized carboxylic acid called d-gluconic acid, consisting of (i) a major amount of sodium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

673. An environmentally-clean aqueous-based biochemical composition derived from the C6-Class of saturated non-polymerized carboxylic acid called d-gluconic acid, consisting of (i) a major amount of magnesium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based biochemical solution based on the C6-class of carboxylic acid-called d-gluconic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

674. An environmentally-clean aqueous-based biochemical wood treatment composition derived from the C6-Class of saturated non-polymerized carboxylic acid called benzoic acid, consisting of (i) a major amount of potassium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

675. An environmentally-clean aqueous-based biochemical wood treatment composition derived from the C6-Class of saturated non-polymerized carboxylic acid called benzoic acid, consisting of (i) a major amount of calcium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

676. An environmentally-clean aqueous-based biochemical wood treatment composition derived from the C6-Class of saturated non-polymerized carboxylic acid called benzoic acid, consisting of (i) a major amount of sodium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

677. An environmentally-clean aqueous-based biochemical wood treatment composition derived from the C6-Class of saturated non-polymerized carboxylic acid called benzoic acid, consisting of (i) a major amount of magnesium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based biochemical wood treatment solution based on the C6-class of carboxylic acid-called benzoic acid, and a minor amount of alkali metal salt derived from carboxylic acid for inhibiting metal corrosion, mold and/or microbial life, for application to lignocellulosic furnish material during the composite wood panel manufacturing process to inhibit fire ignition of wood material, flame spread, smoke development, metal corrosion of mounted fasteners, and decomposition of composite wood material.

678. A method of producing treated wood products with fire, metal-corrosion, mold and moisture protection according to the present invention, comprising the steps of:
(a) producing or procuring a supply of environmentally clean wood treatment composition for use in treating wood (i.e. lignocellulosic) material in treated wood products to provide fire, metal-corrosion, mold and moisture protection, wherein the environmentally-clean liquid wood treatment composition comprises environmentally-clean inhibiting biochemicals selected from the group consisting of metal alkali carboxylic acid salt based biochemicals;
(b) applying the environmentally-clean biochemical wood treatment composition over the exterior surfaces of the wood products to be treated with class-a fire and metal-corrosion protection′
(c) allowing water molecules in the applied environmentally-clean biochemical wood treatment composition to evaporate to the environment and Class-A fire and metal-corrosion inhibiting coatings to form over the treated wood surfaces
and
(d) applying a polymeric-based mold inhibiting and moisture protecting coating(s) over the Class-A fire-protected, metal-corrosion and mold/mildew inhibiting wood surfaces of the treated wood products.

679. A method of producing composite wood products with fire, metal-corrosion, mold and moisture protection according to the present invention, comprising the steps of:
(a) producing or procuring a supply of environmentally-clean biochemical wood treatment composition for use in treating wood (i.e. lignocellulosic) furnish material to produce composite wood products having fire, metal-corrosion, mold and moisture protection, wherein the environmentally-clean liquid wood treatment composition comprises environmentally-clean fire inhibiting biochemicals selected from the group consisting of metal alkali carboxylic acid salt based biochemicals;
(b) applying the environmentally-clean biochemical wood treatment composition to wood furnish material prior to or during the manufacturing of composite wood components so that fire, metal-corrosion and mold protection is provided within and over the exterior surfaces of the wood furnish material during manufacture
(c) adding biochemical additives, also selected from the group consisting of metal alkali carboxylic acid salt based biochemicals, to a polymeric resin compound so as to produce an enhanced polymeric resin, then applying the same to wood furnish material, and molding a composite wood product under pressure and curing the polymeric resin during molding and compression operations so as to provide the molded composite wood product with fire, metal-corrosion and mold protection throughout composite wood products; and
(d) applying a polymeric-based (mold inhibiting and) moisture protective coating over the exterior wood surfaces of the Class-A fire protected wood products.

680. A method of producing treated engineered wood products (EWPs) with fire, metal-corrosion, mold and moisture protection according to the present invention, comprising the steps of:
(a) producing or procuring a supply of environmentally-clean liquid biochemical wood treatment solution for use in treating wood furnish used in engineered wood products (EWPs), wherein the environmentally-clean liquid wood treatment composition comprises environmentally-clean fire inhibiting biochemicals selected from the group consisting of metal alkali carboxylic acid salt based biochemicals
(b) applying the environmentally-clean biochemical liquid wood treatment solution to (i.e. wood/lignocellulosic) material prior to or during the manufacturing of the engineered wood product to produce treated wood furnish material that is protected against fire, metal corrosion and mold/mildew;
(c) during manufacture of the EWP, binding the treated wood material using a polymeric resin compound infused with fire and metal-corrosion inhibiting biochemicals for producing an engineered wood product (EWP) provided with fire protection, metal-corrosion and mold/mildew protection throughout the corpus of the EWP; and
(d) applying a polymeric-based (mold-inhibiting and) moisture-protecting coating over the treated wood surfaces of the fire protected EWP.

681. An automated lumber factory supporting an automated process for continuously fabricating Class-A fire-protected finger-jointed lumber products which, after the planning and dimensioning stage, are automatically treated by coating the products in a bath or reservoir of environmentally-clean fire inhibiting biochemical liquid of the present invention, and then automatically packaged, stack-dried and wrapped in a high-speed and economical manner.

682. An automated wood product fabrication factory supporting an automated process for continuously fabricating cross-laminated timber (CLT) products which, after the planning and dimensioning stage, are automatically dip-coated in a bath of clean fire inhibiting chemical (CFIC) liquid, and then stacked, packaged, and wrapped in a high-speed manner to produce Class-A fire-protected CLT products.

683. An automated MDF/HDF panel fabrication factory, wherein each of the stages of manufacture are performed along the multi-stage fabrication process, including the treatment of wood furnish materials (e.g. wood particles) and polymeric resin adhesives (e.g. pDMI resin binders) used during the manufacturing process.

684. An automated plywood panel fabrication factory, wherein each of the stages of plywood manufacture are performed along a multi-stage fabrication process, including the treatment of wood furnish materials (e.g. wood particles) and polymeric resin adhesives (e.g. pDMI resin binders) used during the manufacturing process.

685. An environmentally-clean Class-A fire protected multi-ply bamboo plywood panel produced using environmentally-clean fire inhibiting biochemicals applied in an automated factory.

686. An environmentally-clean Class-A fire-protected bamboo strand board (BSB) panels produced according to a process using environmentally-clean fire inhibiting biochemicals applied in the automated factory.

687. A Class-A fire-protected bamboo strand board (BSB) panel produced using a factory-based process comprising the steps of:
(1) preparing raw material (bamboo strands-having a desired length, width and moisture content);
(2) treating prepared bamboo strands with biochemical salts according to present invention to impart properties against fire, mold/mildew and/or moisture;
(3) blending pMDI polymeric resin binder with biochemical salts of the present invention to produce treated resin emulsion;
(4) mixing bamboo strands with treated resin emulsion with treated bamboo strands, (5) forming sheet of bamboo strands mixed with treated polymeric resin emulsion to form a bamboo strand mat);
(6) hot pressing the formed mat under compression to produce bamboo strand board (BSB); and
(7) trimming and cutting bamboo strand board (BSB) panel into bamboo strand board (BSB) sheets.

688. A system for producing multi-ply fire-protected composite wood products (i.e. OSB panels) using environmentally-clean liquid fire inhibiting biochemicals and resin binder chemicals, and comprising:
a supply of wet lignocellulosic furnish material (e.g. wood strands, chips, particles, etc.);
a supply of environmentally-clean liquid fire inhibiting biochemicals of the present invention; and
a supply of liquid resin binder (e.g. pMDI resin) chemical are supplied and provide to several pipelines and used to support
(i) fire inhibiting treatment of the wood furnish material,
(ii) biochemical treatment of the resin binder chemicals, and
(iii) resinating the treated wood furnish material before being processed and formed into layers (e.g. mats) that are then stacked into a stacked layer assembly, and then molded and compressed under heat and pressure to cure the applied binder resin chemicals,
whereupon the molded wood product is released from the molds, and then sprayed with a polymer-based moisture protection top coating to produce finished final engineering wood product (EWP) in the form of a panel or other building construction component.

689. A method of producing multi-ply fire-protected composite wood products (i.e. OSB panels) using liquid resin binder biochemicals mixed with environmentally-clean liquid fire inhibiting chemicals, comprising the steps of:
(a) providing a supply of wet lignocellulosic (wood) furnish material (i.e. strands, chips, fibers, particles, etc.) for use in producing composite engineered wood products (EWPs), (b) providing a supply of environmentally-clean liquid fire inhibiting biochemical, and applying the environmentally-clean liquid fire inhibiting biochemical to the lignocellulosic furnish material to provide fire protection to the treated lignocellulosic furnish material, and inhibition against corrosion of metal(s) in contact with the treated furnish material;
(c) providing a supply of liquid polymeric resin binder (e.g. pMDI resin) for use in binding together the treated wood furnish material during the production of fire-protected composite wood products;
(d) mixing a minor amount of environmentally-clean fire inhibiting chemical with a major amount of liquid resin binder, before applying the mixed treated polymeric resin binder to the treated wood furnish material;
(e) using a particle-binder mixing/resinating module to apply the mixture of resin binder and fire inhibiting biochemical, to a supply of treated wood furnish material, and produce a supply of resinated treated wood furnish material;
(f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product; and
(g) applying a mold and moisture protection coating over said fire-protected composite wood product so as to produce a finished engineered wood product (EWP) having fire, metal-corrosion, mold and moisture protection.

690. A factory-based system for producing multi-ply fire-protected composite wood products (i.e. OSB panels) using environmentally-clean liquid fire inhibiting and resin binder chemicals (e.g. single component binder system comprising uncatalyzed PMDI prepolymeric resins), comprising:
a supply of wet lignocellulosic furnish material (e.g. wood strands, chips, particles, etc.), a supply of environmentally-clean liquid fire inhibiting biochemicals of the present invention, and
a supply of liquid resin binder (e.g. pMDI resin) chemical are supplied and provided to several pipelines and used to support
(i) fire inhibiting treatment of the wood furnish material,
(ii) treating the liquid resin binder chemicals, and
(iii) resinating the treated wood furnish material before being processed and formed into layers that are then stacked into a stacked layer assembly, and then molded and compressed under heat and pressure to cure the applied binder resin,
whereupon the molded wood product is released from the molds, and thereafter sprayed with a polymer-based moisture protection top coating to produce finished final engineering wood product (EWP) in the form of a panel or other building construction component.

691. A method of producing multi-ply fire-protected composite wood products (i.e. OSB panels) using one-component liquid resin binder chemicals mixed with environmentally-clean dry fire inhibiting chemicals, comprising the steps of:
(a) providing a supply of wet lignocellulosic (wood) furnish material (i.e. strands, chips, fibers, particles, etc.) for use in producing composite engineered wood products (EWPs);
(b) providing a supply of environmentally-clean dry fire inhibiting chemical powder and applying the environmentally-clean dry fire inhibiting chemical powder to the lignocellulosic furnish material provide Class-A fire protection to the treated lignocellulosic furnish material, and inhibition against corrosion of metal in contact with the treated furnish material;
(c) providing a supply of liquid resin binder (e.g. pMDI polymeric resin) for use in binding wood furnish material together when producing fire-protected wood products;
(d) mixing a minor amount of environmentally-clean dry powder fire inhibiting biochemical with a major amount of liquid resin binder chemical, before applying treated binder resin to treated wood furnish material;
(e) using a particle-binder mixing/resinating module to apply the mixture of liquid resin binder and dry fire inhibiting chemical powder, to a supply of wood furnish material, to produce a supply of resinated treated wood furnish;
(f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product; and
(g) applying a mold and moisture protection coating over said fire-protected composite wood product so as to produce a finished engineered wood product (EWP) having fire, metal-corrosion, mold and moisture protection.

692. A factory-based system for producing multi-ply fire-protected composite wood products (i.e. OSB panels) using environmentally-clean liquid fire inhibiting and one-component resin binder chemicals (e.g. two component binder system comprising catalyzed PMDI polymeric resins), comprising:
a supply of wet lignocellulosic furnish material (e.g. wood strands, chips, particles, etc.);a supply of environmentally-clean liquid fire inhibiting biochemicals of the present invention,
a supply of liquid resin binder (e.g. pMDI resin); and
a supply of liquid binder catalyst (e.g. HCL), are supplied to several pipelines and used to support
(i) fire inhibiting treatment of the wood furnish material, and
(ii) resinating the treated wood furnish material before being processed and formed into layers (e.g. mats) that are then stacked into a stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

693. A method of producing multi-ply fire-protected composite wood products (i.e. OSB panels) using one-component liquid resin binder chemicals mixed with environmentally-clean liquid fire inhibiting biochemicals, comprising the steps of:
(a) providing a supply of wet lignocellulosic (wood) furnish material (i.e. strands, chips, fibers, particles, etc.) for use in producing composite engineered wood products (EWPs);
(b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material;
(c) providing a supply of liquid polymeric resin binder (e.g. pMDI resin) for use in binding together treated wood furnish material when producing fire-protected wood products;
(d) mixing a minor amount of environmentally-clean liquid fire inhibiting biochemical with a major amount of liquid resin binder chemical, before applying treated binder resin to treated wood furnish material;
(e) using a particle-binder mixing/resinating module to apply, the mixture of liquid resin binder and liquid fire inhibiting chemical, to a supply of wood furnish material to produce a supply of resinated treated wood furnish material;
(f) molding the resinated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and
(g) applying a mold and moisture protection coating over said fire-protected composite wood product so as to produce a finished engineered wood product (EWP) having fire, metal-corrosion, mold and moisture protection.

694. A factory-based system for producing multi-ply fire-protected composite wood products (i.e. MDF, HDF and PB panels) using environmentally-clean liquid fire inhibiting and one-component resin binder chemicals (e.g. single component binder system comprising uncatalyzed PMDI prepolymeric resins), comprising:
a supply of wet lignocellulosic furnish material (e.g. wood strands, chips, particles, etc.);
a supply of environmentally-clean liquid fire inhibiting biochemicals of the present invention; and
a supply of liquid resin binder (e.g. pMDI resin) are supplied to several (e.g. three) pipelines and used to support
(i) fire inhibiting treatment of the wood furnish material,
(ii) treating resin binder chemicals with environmentally-clean biochemicals, and
(iii) resinating the treated wood furnish material before being processed and formed into layers (e.g. mats) that are then stacked into an stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

695. A method of producing multi-ply fire-protected composite wood products (i.e. OSB panels) using one-component liquid resin binder chemicals mixed with environmentally-clean dry fire inhibiting chemicals, comprising the steps of:
(a) providing a supply of wet lignocellulosic (wood) furnish (i.e. strands, chips, fibers, particles, etc.) for use in producing composite engineered wood products (EWPs);
(b) providing a supply of environmentally-clean liquid fire inhibiting chemical and applying the environmentally-clean liquid fire inhibiting chemical to the lignocellulosic furnish material to provide Class-A fire protection to the treated lignocellulosic furnish material, and inhibition against corrosion of metal in contact with the treated furnish material;
(c) providing a supply of liquid resin binder (e.g. pMDI resin) for use in binding wood furnish material together when producing fire-protected wood products;
(d) mixing a minor amount of environmentally-clean liquid fire inhibiting biochemical with a major amount of liquid resin binder chemical, before applying treated binder resin to treated wood furnish material, (e) using a particle-binder mixing/resinating module to apply the mixture of liquid resin binder and liquid fire inhibiting chemical, to a supply of wood furnish material in the rotating drum to produce a supply of resinated treated wood furnish material;
(f) molding the resinated treated wood furnish material to form a bottom composite wood layer, a core composite wood layer and a top composite wood layer,
whereafter the core composite wood layer is stacked between the top and bottom composite wood layers, and then the stacked layer assembly cured under pressure to the form a fire-protected composite wood product; and
(g) applying a mold and moisture protection coating over the fire-protected composite wood product so as to produce a finished engineered wood product (EWP) having fire, metal-corrosion, mold and moisture protection.

696. A factory-based system for producing multi-ply fire-protected composite wood products (i.e. MDF, HDF, PB panels) using environmentally-clean liquid fire inhibiting biochemical and resin binder chemicals (e.g. two component binder system comprising catalyzed PMDI prepolymeric resins), comprising:
a supply of wet lignocellulosic furnish material (e.g. wood strands, chips, particles, etc.), a supply of environmentally-clean liquid fire inhibiting biochemicals of the present invention;
a supply of liquid resin binder (e.g. pMDI resin); and
a supply of liquid binder catalyst (e.g. HCL), are supplied to several (e.g. three) pipelines and used to support
(i) fire inhibiting treatment of the wood furnish material,
(ii) treating the resin binder chemicals with environmentally-clean biochemicals, and
(iii) resinating (i.e. applying pDMI polymeric resin binder material to) the treated wood furnish material before being processed and formed into layers (e.g. mats) that are then stacked into a stacked layer assembly, and then molded and compressed under heat and pressure to cure the applied binder resin,
whereupon the molded wood product is released from the molds, and thereafter sprayed with a polymer-based moisture protection top coating to produce finished final engineering wood product (EWP) in the form of a panel or other building construction component.

697. A method of producing fire-protected composite wood products (e.g. HDF, MDF and PB panels) using liquid resin binder chemicals mixed with environmentally-clean liquid fire inhibiting chemicals, comprising the steps of:
(a) providing a supply of wet lignocellulosic (wood) furnish (i.e. strands, chips, fibers, particles, etc.) for use in producing composite engineered wood products (EWPs);
(b) providing a supply of environmentally-clean liquid fire inhibiting chemical and applying the environmentally-clean liquid fire inhibiting chemical to the lignocellulosic furnish material to provide fire protection to the treated lignocellulosic furnish material, and inhibition against corrosion of metal in contact with the treated furnish material;
(c) providing a supply of liquid resin binder (e.g. pMDI resin) for use in binding treated wood furnish material together when producing fire-protected wood products;
(d) mixing a minor amount of environmentally-clean liquid fire inhibiting biochemical with a major amount of liquid resin binder chemical, before applying treated binder resin to treated wood furnish material
(e) using a particle-binder mixing/resinating module to apply the mixture of liquid resin binder and liquid fire inhibiting, to a supply of wood furnish material to produce a supply of resinated treated wood furnish material;
(f) molding the resinated wood furnish material to form a bottom composite wood layer, a core composite wood layer and a top composite wood layer, whereafter the core composite wood layer is stacked between the top and bottom composite wood layers, and then the assembly is cured under pressure to the form a fire-protected composite wood product; and
(g) applying a mold and moisture protection coating over said fire-protected composite wood product so as to produce a finished engineered wood product (EWP) having fire, metal-corrosion, mold and moisture protection.

698. A factory-based system for producing multi-ply fire-protected composite wood products (i.e. OSB panels) using environmentally-clean dry powder and liquid fire inhibiting biochemicals and resin binder chemicals mixed and blended together, comprising:
a supply of wet lignocellulosic furnish material (e.g. wood strands, chips, particles, etc.);
a supply of environmentally-clean liquid and dry powder fire inhibiting biochemicals of the present invention; and
a supply of liquid resin binder (e.g. pMDI polymeric resin binder) for supply to several pipelines and used to support
(i) fire inhibiting (dry powder) treatment of the wood furnish material,
(ii) treating liquid resin binder chemicals with environmentally-clean biochemicals, and
(iii) resinating the treated wood furnish material with treated liquid resin binder before being processed and formed into layers (e.g. mats) that are then stacked into a stacked layer assembly, and then molded and compressed under heat and pressure to cure the applied binder resin,
whereupon the molded wood product is released from the molds, and then sprayed with a polymer-based moisture protection top coating to produce finished final engineering wood product (EWP) in the form of a panel or other building construction component.

699. A method of producing multi-ply fire-protected composite wood products (i.e. OSB panels) using liquid resin binder chemicals mixed with environmentally-clean liquid fire inhibiting biochemicals, comprising the steps of:
(a) providing a supply of wet lignocellulosic (wood) furnish material (i.e. strands, chips, fibers, particles, etc.) for use in producing composite engineered wood products (EWPs);
(b) providing a supply of environmentally-clean dry powder fire inhibiting biochemical, and applying the environmentally-clean dry powder fire inhibiting biochemical to the lignocellulosic furnish material to provide fire protection to the treated lignocellulosic furnish material, and inhibition against corrosion of metal(s) in contact with the treated furnish material;
(c) providing a supply of liquid resin binder (e.g. pMDI polymeric resin binder material) for use in binding together the treated wood furnish material, when producing fire-protected wood products;
(d) mixing a minor amount of environmentally-clean fire inhibiting biochemical with a major amount of liquid resin binder, before applying the mixed biochemically-treated binder resin to the biochemically-treated wood furnish material;
(e) using a particle-binder mixing/resinating module to apply the mixture of resin binder and fire inhibiting biochemical, to a supply of biochemically-treated wood furnish material, and produce a supply of resinated treated wood furnish material;
(f) molding the resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product; and
(g) applying a mold and moisture protection coating over said fire-protected composite wood product so as to produce a finished engineered wood product (EWP) having fire, metal-corrosion, mold and moisture protection.

700. A factory-based system for producing multi-ply fire-protected composite wood products (i.e. OSB panels) using environmentally-clean dry powder and liquid fire inhibiting biochemicals and resin binder chemicals (e.g. single component binder system comprising uncatalyzed PMDI prepolymeric resins), comprising:
a supply of wet lignocellulosic furnish material (e.g. wood strands, chips, particles, etc.);
a supply of environmentally-clean liquid fire inhibiting biochemicals; and
a supply of liquid resin binder (e.g. pMDI resin) supplied to several pipelines and used to support
(i) fire inhibiting treatment of the wood furnish material,
(ii) treating resin binder chemical with environmentally-clean biochemicals, and
(iii) resinating the treated wood furnish material before being processed and formed into layers (e.g. mats) that are then stacked into a stacked layer assembly, and then molded and compressed under heat and pressure to cure the applied binder resin,
(iv) whereupon the molded wood product is released from the molds, and thereafter sprayed with a polymer-based moisture protection top coating to produce finished final engineering wood product (EWP) in the form of a panel or other building construction component.

701. A method of producing multi-ply fire-protected composite wood products (i.e. OSB panels) using dry power biochemicals to treat wood furnish material and environmentally-clean liquid fire inhibiting biochemicals to treat resin binder chemicals, comprising the steps of:
(a) providing a supply of wet lignocellulosic (wood) furnish material (i.e. strands, chips, fibers, particles, etc.) for use in producing composite engineered wood products (EWPs);
(b) providing a supply of environmentally-clean dry power fire inhibiting biochemical and applying the environmentally-clean dry powder fire inhibiting biochemical powder to the wet lignocellulosic furnish material provide Class-A fire-protection to the treated lignocellulosic furnish material, and inhibition against corrosion of metal in contact with the treated furnish material;
(c) providing a supply of liquid resin binder (e.g. pMDI resin) for use in binding wood furnish material together when producing fire-protected wood products;
(d) mixing a minor amount of environmentally-clean dry fire inhibiting chemical powder with a major amount of liquid resin binder, before applying binder resin to wood furnish material;
(e) using a particle-binder mixing/resinating module to apply the mixture of liquid resin binder and dry fire inhibiting chemical powder, to a supply of wood furnish material, to produce a supply of resinated treated wood furnish;
(f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to form a fire-protected composite wood product; and
(g) applying a mold and moisture protection coating over said fire-protected composite wood product so as to produce a finished engineered wood product (EWP) having fire, metal-corrosion, mold and moisture protection.

702. A factory-based system for producing multi-ply fire-protected composite wood products (i.e. OSB panels) using environmentally-clean liquid and dry powder fire inhibiting biochemicals to treat wood furnish material and resin binder chemicals (e.g. two component binder system comprising catalyzed PMDI prepolymeric resins), comprising:
a supply of wet lignocellulosic furnish material (e.g. wood strands, chips, particles, etc.);
a supply of environmentally-clean liquid fire inhibiting biochemicals of the present invention;
a supply of liquid resin binder (e.g. pMDI resin); and
a supply of liquid binder catalyst (e.g. HCL), are supplied to several pipelines and used to support
(i) fire inhibiting treatment of the wood furnish material,
(ii) treating of liquid resin binder with the biochemicals, and
(iii) resinating the treated wood furnish material before being processed and formed into layers (e.g. mats) that are then stacked into a stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

703. A method of producing multi-ply fire-protected composite wood products (i.e. OSB panels) using liquid resin binder chemicals mixed with environmentally-clean liquid fire inhibiting chemicals, comprising the steps of:
(a) providing a supply of wet lignocellulosic (wood) furnish material (i.e. strands, chips, fibers, particles, etc.) for use in producing composite engineered wood products (EWPs);
(b) providing a supply of environmentally-clean liquid fire inhibiting chemical and applying the environmentally-clean liquid fire inhibiting chemical to lignocellulosic furnish material to provide fire protection to treated lignocellulosic (wood) furnish material, and inhibition against corrosion of metal in contact with the treated furnish material;
(c) providing a supply of liquid resin binder (e.g. pMDI resin) for use in binding together treated wood furnish material when producing fire-protected wood products;
(d) mixing a minor amount of environmentally-clean liquid fire inhibiting chemical with a major amount of liquid resin binder, before applying binder resin to wood furnish material;
(e) using a particle-binder mixing/resinating module to apply, the mixture of liquid resin binder and liquid fire inhibiting chemical, to a supply of wood furnish material to produce a supply of resinated treated wood furnish material;
(f) molding the resinated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and
(g) applying a mold and moisture protection coating over said fire-protected composite wood product so as to produce a finished engineered wood product (EWP) having fire, metal-corrosion, mold and moisture protection.

704. A factory-based system for producing multi-ply fire-protected composite wood products (i.e. MDF, HDF and PB panels) using environmentally-clean liquid fire inhibiting and resin binder chemicals (e.g. single component binder system comprising uncatalyzed PMDI prepolymeric resins), comprising:
a supply of wet lignocellulosic furnish material (e.g. wood strands, chips, particles, etc.);
a supply of environmentally-clean liquid fire inhibiting biochemicals; and
a supply of liquid resin binder (e.g. pMDI resin) are supplied to several pipelines and used to support
(i) fire inhibiting treatment of the wood furnish material,
(ii) treating of liquid resin binder with the biochemicals, and
(iii) resinating the treated wood furnish material before being processed and formed into layers (e.g. mats) that are then stacked into a stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

705. A method of producing multi-ply fire-protected composite wood products (i.e. OSB panels) using liquid resin binder chemicals mixed with environmentally-clean dry powder and liquid fire inhibiting biochemicals, comprising the steps of:
(a) providing a supply of wet lignocellulosic (wood) furnish (i.e. strands, chips, fibers, particles, etc.) for use in producing composite engineered wood products (EWPs);
(b) providing a supply of environmentally-clean dry powder fire inhibiting biochemical and applying the environmentally-clean dry powder fire inhibiting biochemical to the lignocellulosic furnish material to provide Class-A fire protection to the treated lignocellulosic furnish material, and inhibition against corrosion of metal in contact with the treated furnish material;
(c) providing a supply of liquid resin binder (e.g. pMDI resin) for use in binding wood furnish material together when producing fire-protected wood products;
(d) mixing a minor amount of environmentally-clean liquid fire inhibiting chemical with a major amount of the liquid resin binder, before applying treated binder resin to treated wood furnish material;
(e) using a particle-binder mixing/resinating module to apply the mixture of liquid resin binder and liquid fire inhibiting chemical, and treat a supply of wood furnish material in the rotating drum to produce a supply of resinated treated wood furnish material;
(f) molding the (pMDI) resinated treated wood furnish material to form a bottom composite wood layer, a core composite wood layer and a top composite wood layer, whereafter the core composite wood layer is stacked between the top and bottom composite wood layers, and then the stacked layer assembly is pressed and cured under pressure to the form a fire-protected composite wood product; and
(g) applying a mold and moisture protection coating over the fire-protected composite wood product so as to produce a finished engineered wood product (EWP) having fire, metal-corrosion, mold and moisture protection.

706. A factory-based system for producing multi-ply fire-protected composite wood products (i.e. MDF, HDF, PB panels) using environmentally-clean dry powder fire inhibiting biochemical to treat wood furnish materials, and environmentally-clean dry powder fire inhibiting biochemical to treat liquid resin binder chemicals (e.g. two component binder system comprising catalyzed PMDI prepolymeric resins) comprising:
a supply of wet lignocellulosic furnish material (e.g. wood strands, chips, particles, etc.);
a supply of environmentally-clean liquid fire inhibiting biochemicals of the present invention;
a supply of liquid resin binder (e.g. pMDI resin); and
a supply of liquid binder hardener/catalyst, are supplied to several pipelines and used to support
(i) fire inhibiting treatment of the wood furnish material,
(ii) treating of liquid resin binder with the biochemicals, and
(iii) resinating the treated wood furnish material before being processed and formed into layers (e.g. mats) that are then stacked into a stacked layer assembly, and then molded and compressed under heat and pressure to cure the applied binder resin, whereupon the molded wood product is released from the molds, and thereafter sprayed with a polymer-based moisture protection top coating to produce finished final engineering wood product (EWP) in the form of a panel or other building construction component.

707. A method of producing fire-protected composite wood products (e.g. HDF, MDF and PB panels) using liquid resin binder chemicals mixed with environmentally-clean dry powder fire inhibiting biochemicals, comprising the steps of:
(a) providing a supply of wet lignocellulosic (wood) furnish (i.e. strands, chips, fibers, particles, etc.) for use in producing composite engineered wood products (EWPs);
(b) providing a supply of environmentally-clean dry powder fire inhibiting biochemical and applying the environmentally-clean dry powder fire inhibiting biochemical to the lignocellulosic furnish material to provide fire protection to treated lignocellulosic furnish material, and inhibition against corrosion of metal in contact with treated furnish material;
(c) providing a supply of liquid resin binder (e.g. pMDI resin) for use in binding together treated wood furnish material when producing fire-protected wood products;
(d) mixing a minor amount of environmentally-clean dry powder fire inhibiting biochemical, with a major amount of liquid resin binder, before applying treated binder resin to treated wood furnish material;
(e) using a particle-binder mixing/resinating module to apply the (treated) mixture of liquid resin binder and dry fire inhibiting chemical powder to a supply of treated wood furnish material to produce a supply of resinated treated wood furnish material for molding purposes;
(f) molding the resinated treated wood furnish material to form a bottom composite wood layer, a core composite wood layer and a top composite wood layer, whereafter the core composite wood layer is stacked between the top and bottom composite wood layers, and then the stacked layer assembly is cured under pressure to the form a fire-protected composite wood product (e.g. fire-protected OSB panel); and
(g) applying a mold and moisture protection coating over the fire-protected composite wood product so as to produce a finished engineered wood product (EWP) having fire, metal-corrosion, mold and moisture protection.

708. A Class-A fire-protected wood by undergoing pressurized treatment contained within a pressurized tank holding untreated lumber and/or wood products and filled with environmentally-clean biochemical liquid according to the present invention that is used to impregnate wood fibers within the treated wood products and provide fire, mold/mildew and moisture protection to the treated wood products.

709. A system adapted for pressure treating untreated wood within a pressurized tank filled with biochemical liquid according to the present invention, wherein environmentally clean wood treating biochemical liquid is pumped by a pressure pump into the treatment tank containing pieces of untreated wood, so as to impregnate wood fibers with the biochemical liquid and provide fire, mold/mildew and moisture protection.
